(19) United States
(12) Patent Application Publication
(10) Pub. No.: US 2023/0259265 A1
(43) Pub. Date: Aug. 17, 2023

(54) DEVICES, METHODS, AND GRAPHICAL USER INTERFACES FOR NAVIGATING AND INPUTTING OR REVISING CONTENT

(71) Applicant: Apple Inc., Cupertino, CA (US)

(72) Inventors: Evgenii KRIVORUCHKO, Cupertino, CA (US); Kristi E. BAUERLY, Los Altos, CA (US); Stephen O. LEMAY, Palo Alto, CA (US); Israel PASTRANA VICENTE, Spring, TX (US)

(21) Appl. No.: 18/149,640

(22) Filed: Jan. 3, 2023

Related U.S. Application Data
(60) Provisional application No. 63/266,357, filed on Jan. 3, 2022.
(60) Provisional application No. 63/337,539, filed on May 2, 2022.
(60) Provisional application No. 63/377,025, filed on Sep. 24, 2022.

(51) Int. Cl. G06F 3/0485; G06F 3/01; G06F 3/04883; G06F 3/16

(52) U.S. Cl. CPC G06F 3/0485; G06F 3/013; G06F 3/017; G06F 3/04883; G06F 3/167; G06F 2203/04808

(57) ABSTRACT

In some embodiments, a computer system scrolls scrollable content in response to a variety of user inputs. In some embodiments, a computer system enters text into a text entry field in response to voice inputs. In some embodiments, a computer system facilitates interactions with a soft keyboard. In some embodiments, a computer system facilitates interactions with a cursor. In some embodiments, a computer system facilitates deletion of text. In some embodiments, a computer system facilitates interactions with hardware input devices.

### CROSS-REFERENCE TO RELATED APPLICATIONS

This application claims the benefit of U.S. Provisional Application No. 63/266,357, filed Jan. 3, 2022, U.S. Provisional Application No. 63/337,539, filed May 2, 2022, and U.S. Provisional Application No. 63/377,025, filed Sep. 24, 2022, the contents of which are incorporated herein by reference in their entireties for all purposes.

### TECHNICAL FIELD

The present disclosure relates generally to computer systems that provide computer-generated experiences, including, but not limited to, electronic devices that provide reality and mixed reality experiences via a display generation component.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for navigating and editing content are cumbersome, inefficient, and limited. For example, systems for scrolling content, adding and editing text, and performing operations with a cursor are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for scrolling, creating, editing, and navigating content that are more efficient and intuitive for a user. Such methods and interfaces optionally complement or replace conventional methods for performing such operations. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with content as described above. Such methods and interfaces may complement or replace conventional methods for interacting with content. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system scrolls scrollable content in response to a variety of user inputs. In some embodiments, a computer system enters text into a text entry field in response to voice inputs. In some embodiments, a computer system facilitates interactions with a soft keyboard. In some embodiments, a computer system facilitates interactions with a cursor. In some embodiments, a computer system facilitates deletion of text from a text entry field. In some embodiments, a computer system facilitates interactions with a hardware input device.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7H illustrate example techniques for scrolling scrollable content in response to a variety of user inputs in accordance with some embodiments.

FIGS. 8A-8L is a flow diagram of methods of scrolling scrollable content in response to a variety of user inputs, in accordance with various embodiments.

FIGS. 9A-9N illustrate example techniques for entering text into text entry fields in response to voice inputs in accordance with some embodiments.

FIGS. 10A-10R is a flow diagram of methods of entering text into text entry fields, in accordance with various embodiments.

FIGS. 11A-11O illustrate example techniques of facilitating interactions with a soft keyboard in accordance with some embodiments.

FIGS. 12A-12P is a flow diagram of methods of facilitating interactions with a soft keyboard, in accordance with some embodiments.

FIGS. 13A-13E illustrate example techniques of facilitating interactions with a soft keyboard in accordance with some embodiments.

FIGS. 14A-14J is a flow diagram of methods of facilitating interactions with a soft keyboard in accordance with some embodiments.

FIGS. 15A-15F illustrate example techniques of facilitating interactions with a soft keyboard in accordance with some embodiments.

FIGS. 16A-16K is a flow diagram of methods of facilitating interactions with a soft keyboard in accordance with some embodiments.

FIGS. 17A-17F illustrate example techniques of facilitating interactions with a cursor in accordance with some embodiments.

FIGS. 18A-18E is a flow diagram of methods of facilitating interactions with a cursor in accordance with some embodiments.

FIGS. 19A-19G illustrate example techniques of entering text into a text entry field in response to receiving a speech input in accordance with some embodiments.

FIGS. 20A-20M is a flow diagram of methods of entering text into a text entry field in response to receiving a speech input in accordance with some embodiments.

FIGS. 21A-21G illustrate example techniques of revising text included in a text entry field in accordance with some embodiments.

FIGS. 22A-22H is a flow diagram of methods of revising text included in a text entry field in accordance with some embodiments.

FIGS. 23A-23I illustrate example techniques of updating user interface elements in accordance with a status of a hardware input device in communication with the computer system in accordance with some embodiments.

FIGS. 24A-24I is a flow diagram of methods of updating user interface elements in accordance with a status of a hardware input device in communication with the computer system in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system scrolls content in response to a variety of user inputs, such as a gaze-based user inputs, and gesture-based user inputs (e.g., air gesture inputs, described in more detail below). In some embodiments, the computer system presents scrollable content that includes a first region of the scrollable content and a second region of scrollable content. In response to detecting the attention of the user directed to the second region of scrollable content, the computer system optionally scrolls the scrollable content to advance the content displayed in the second region towards the first region. In some embodiments, the computer system scrolls the content in response to detecting an air gesture input that includes a pinch and drag gesture while the attention of the user is directed towards the content.

In some embodiments, a computer system enters text into text entry fields in response to voice inputs in accordance with some embodiments. In response to detecting the attention of the user directed to a text entry field, the computer system optionally initiates a process to accept dictation input directed to the text entry field. The computer system optionally presents (e.g., visual, audio) feedback and displays a text representation of a speech input in the text entry field in response to the speech input directed to the text entry field.

In some embodiments, a computer system facilitates interactions with a soft keyboard. The computer system optionally displays an object (e.g., a user interface, a window, or another container) including a text entry field that is further than a threshold distance from a viewpoint of the user in a three-dimensional environment. In response to an input directed to the text entry field, the computer system displays a soft keyboard. In some embodiments, the computer system displays the soft keyboard within the threshold distance of the user.

In some embodiments, the computer system facilitates interactions with a soft keyboard. The computer system optionally displays the soft keyboard without displaying one or more cursors for interacting with the soft keyboard. In some embodiments, the computer system detects a user input directed to one or more keys of the soft keyboard provided by a respective portion of the user (e.g., the user's hand(s)). The computer system optionally displays movement of the one or more keys away from the respective portion of the user and towards a surface of the keyboard and performs one or more operations associated with the one or more keys of the keyboard in response to the user input directed to the one or more keys of the keyboard.

In some embodiments, a computer system facilitates interactions with a soft keyboard. The computer system optionally displays the soft keyboard with one or more cursors for interacting with the soft keyboard. The computer system optionally moves the cursors in response to detecting movement of one or more respective portions (e.g., hand(s)) of the user. In some embodiments, in response to detecting an input provided by the one or more respective portions of the user corresponding to making a selection with the one or more cursors, the computer system activates one or more keys of the soft keyboard that correspond to the one or more cursors.

In some embodiments, a computer system facilitates interactions with a cursor. The computer system optionally displays the cursor in a respective region of a three-dimensional environment. In some embodiments, the computer system updates the position of the cursor in accordance with movement of a respective portion (e.g., a hand) of the user and the attention of the user. While the attention of the user is directed to the respective region of the three-dimensional environment while the cursor is displayed in the respective region of the three-dimensional environment, the computer system moves the cursor within the respective region in response to movement of the respective portion of the user. In some embodiments, in response to detecting coordinated movement of the respective portion of the user and movement of the attention of the user from the respective region to another location in the three-dimensional environment, the computer system displays the cursor in a new region in accordance with the attention and movement of the respective portion of the user.

In some embodiments, a computer system facilitates text entry in response to speech inputs. The computer system optionally displays a dictation user interface element at least partially overlaid on a text entry field to enable dictation of text to the text entry field. In some embodiments, the computer system enters the text into the text entry field in response to a confirmation input confirming the text in the dictation user interface element should be entered into the text entry field. In some embodiments, the computer system forgoes entering the text into the text entry field unless and until the confirmation input is received.

In some embodiments, a computer system facilitates deletion of text from a text entry field. The computer system optionally displays a user interface element in association with a soft keyboard that includes a text entry field including a copy of text included in a second text entry field in the user interface of an application that has the current focus of the soft keyboard. In some embodiments, in response to detecting attention of the user directed to a portion of the text entry field included in the user interface element, the computer system displays an option to delete one or more characters from the text entry field. In response to detecting selection of the option and/or selection of a portion of the text entry field included in user interface element, the computer system deletes one or more characters from the text.

In some embodiments, a computer system facilitates interactions with a hardware input device. The computer system optionally displays a user interface element with a predefined spatial relationship relative to a hardware input device that is in the field of view of the computer system and in communication with the computer system. In some embodiments, the user interface element includes a text entry field including a representation of text included in a second text entry field of a user interface of an application that has the current focus of the hardware input device, an option to display a software input element, a dictation option, and options to insert recommended text into the text entry field.

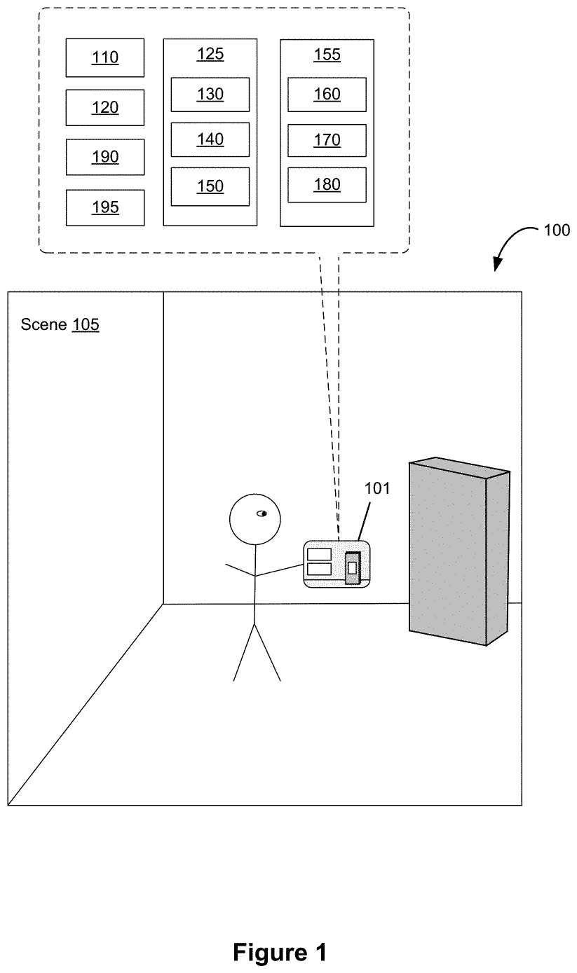

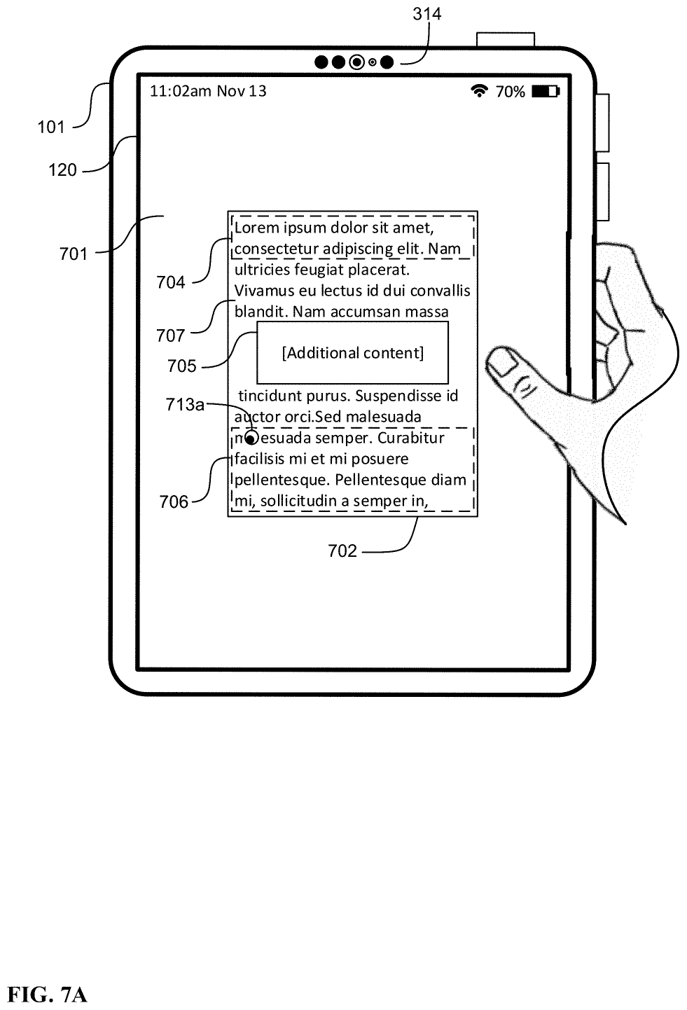

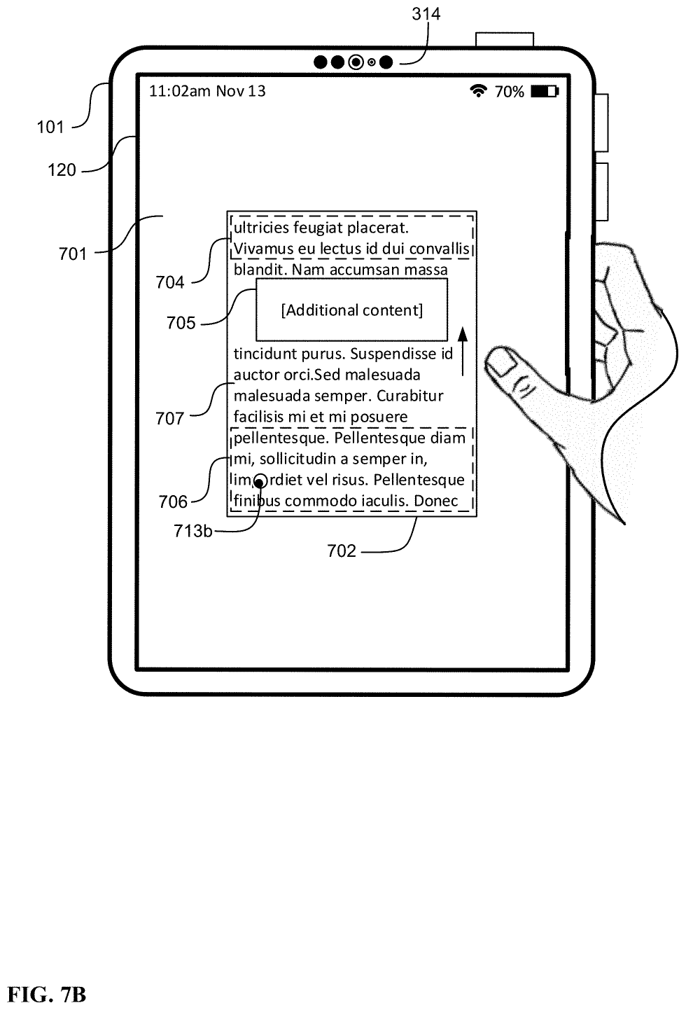

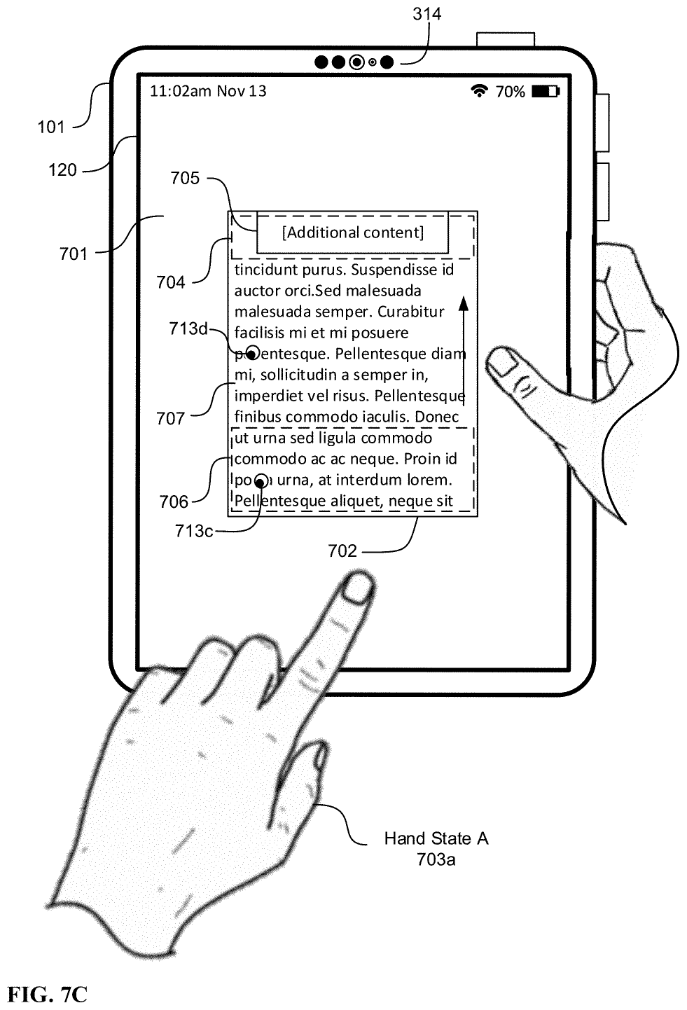

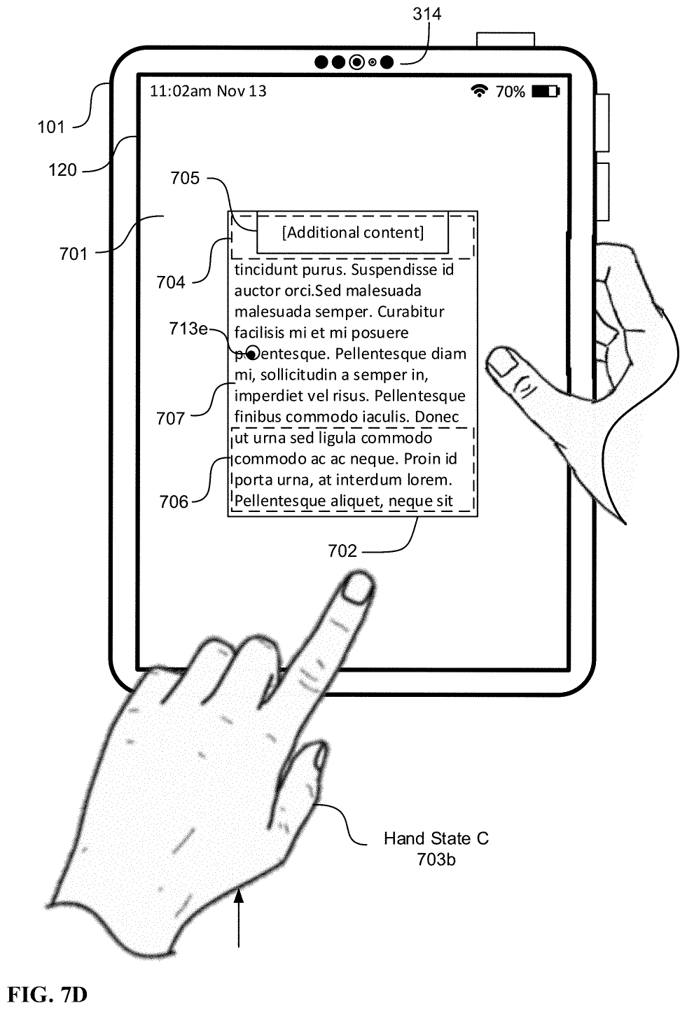

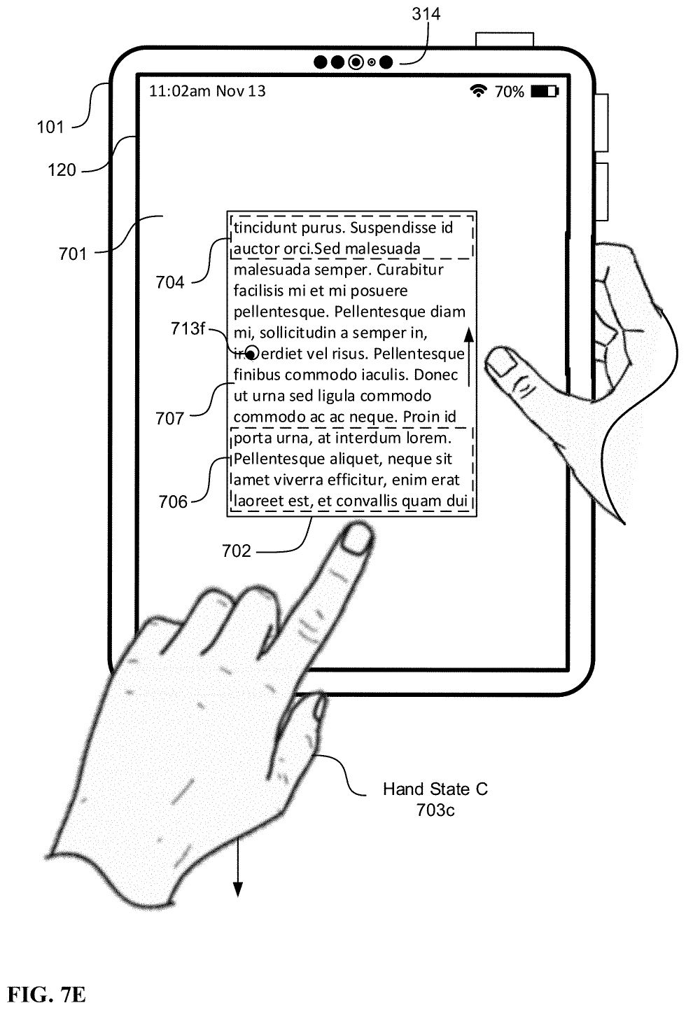

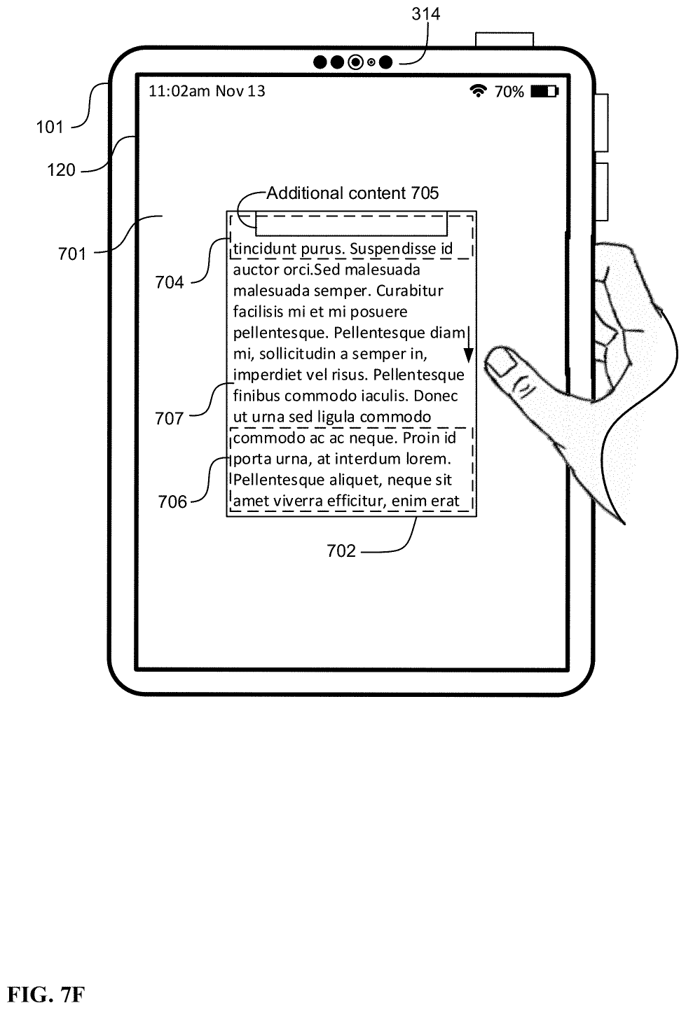

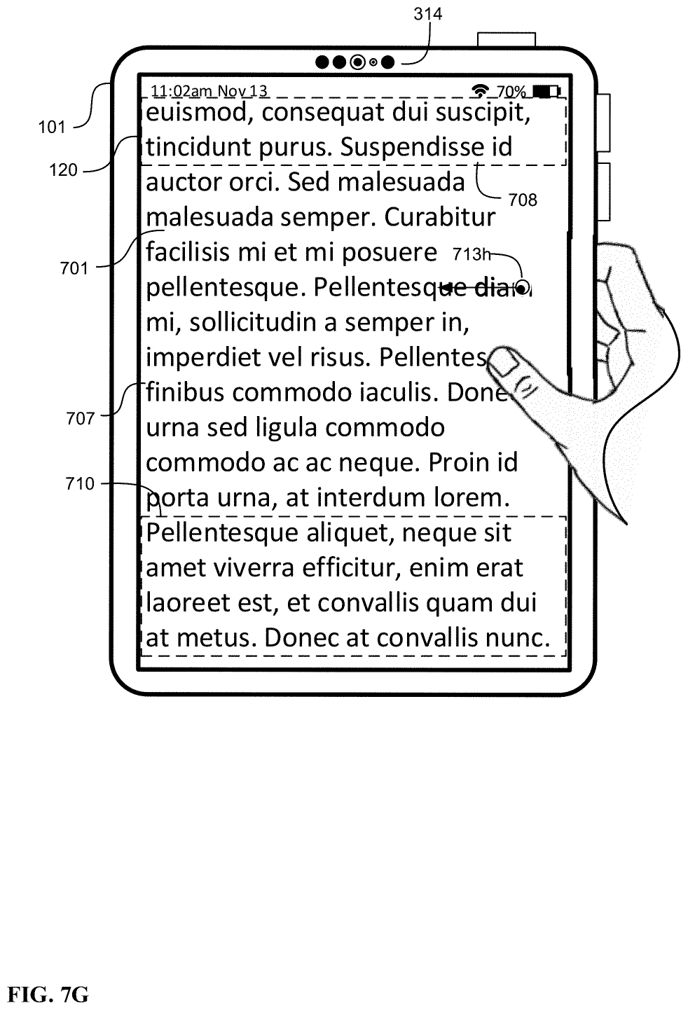

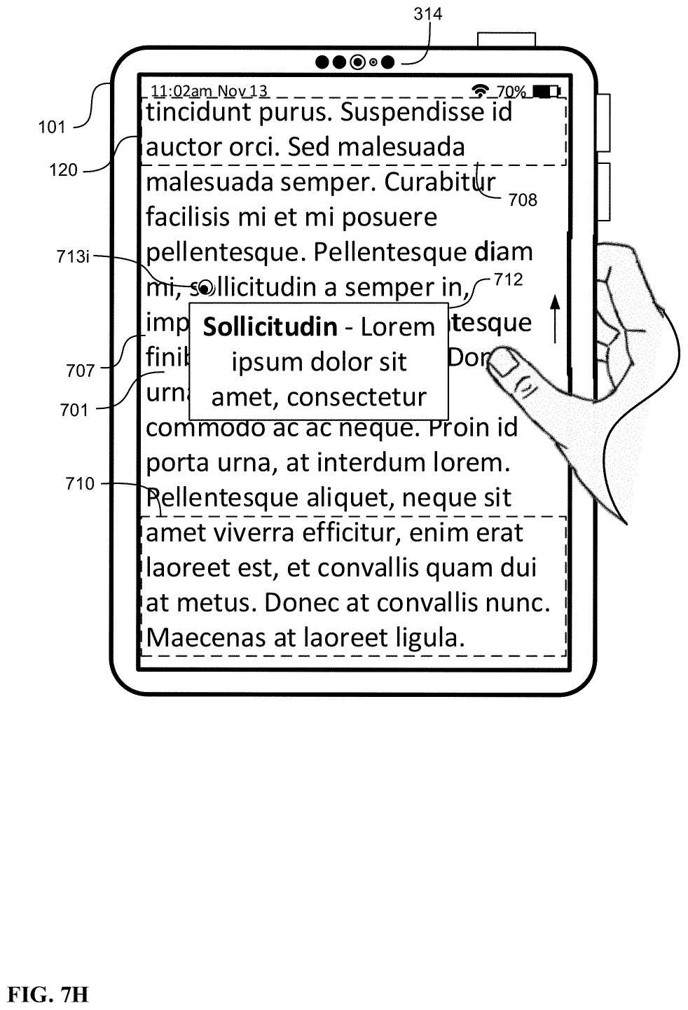

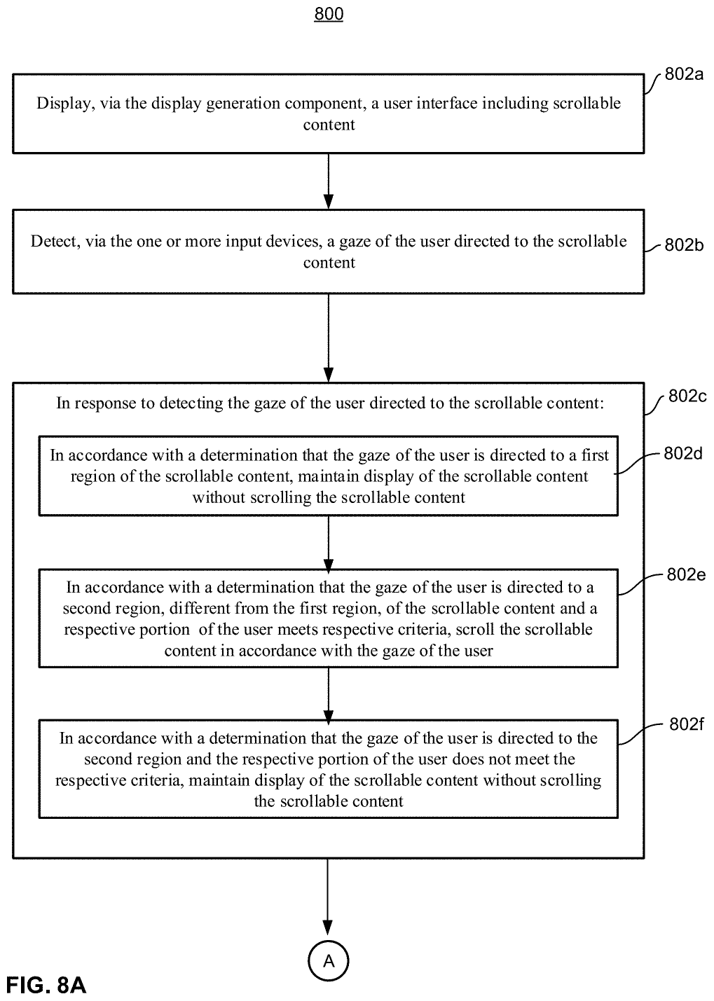

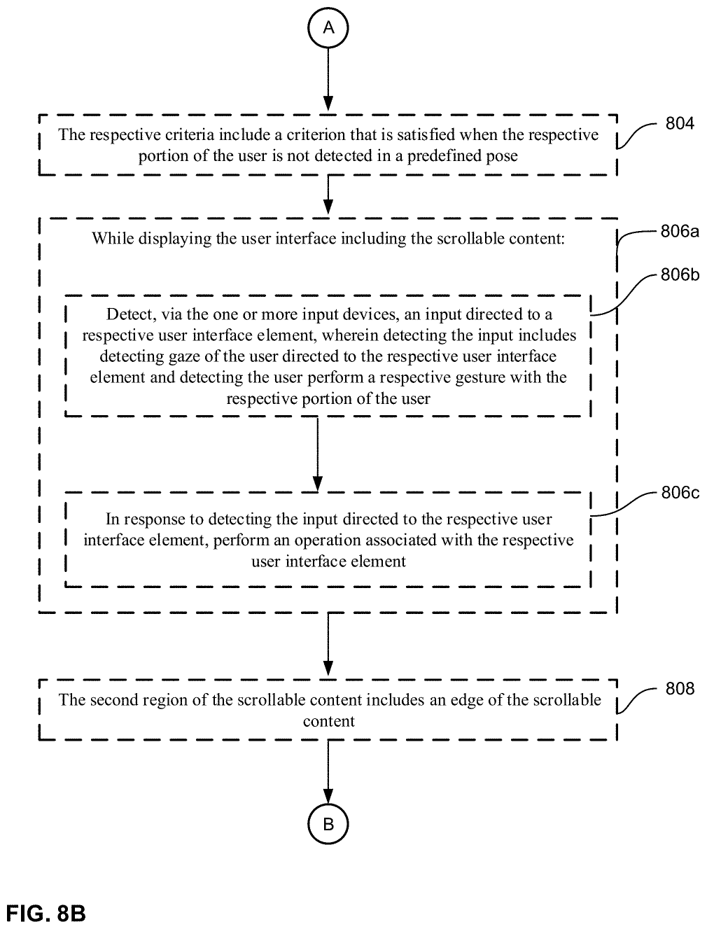

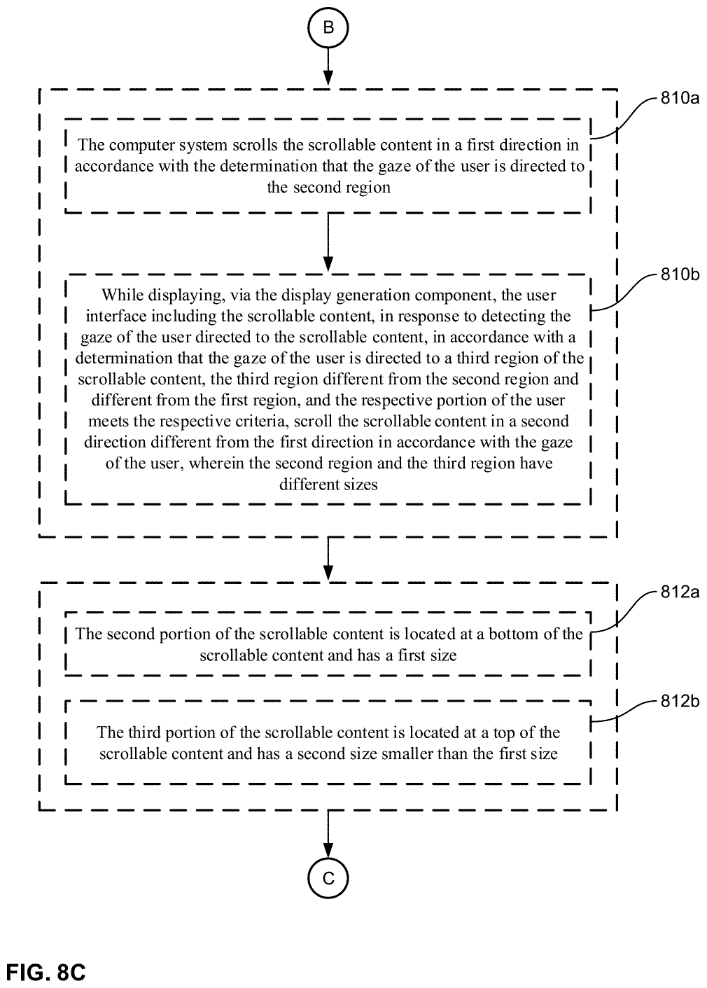

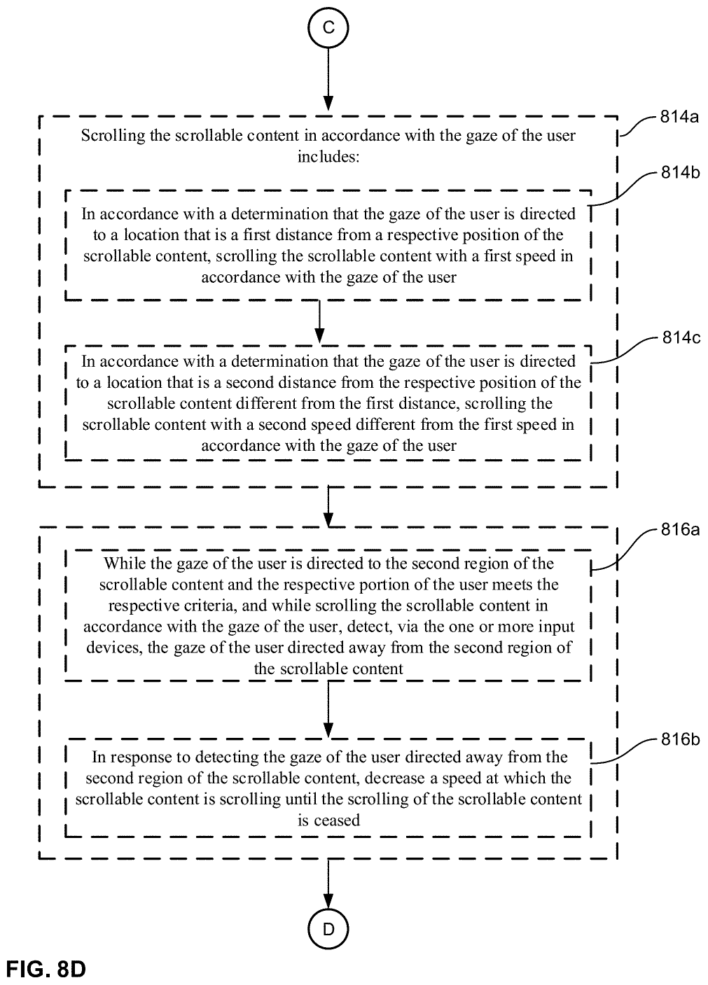

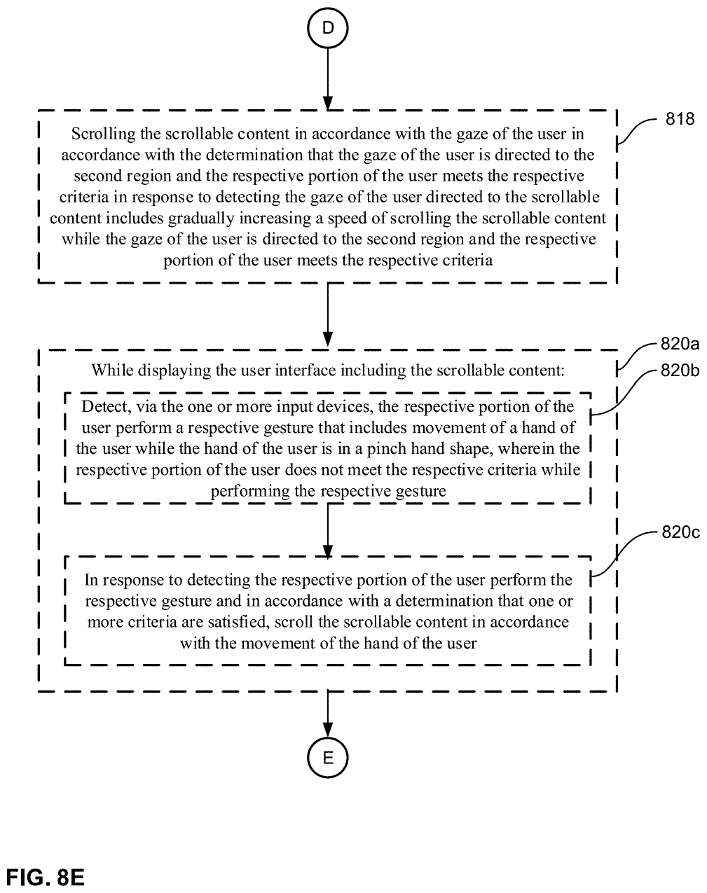

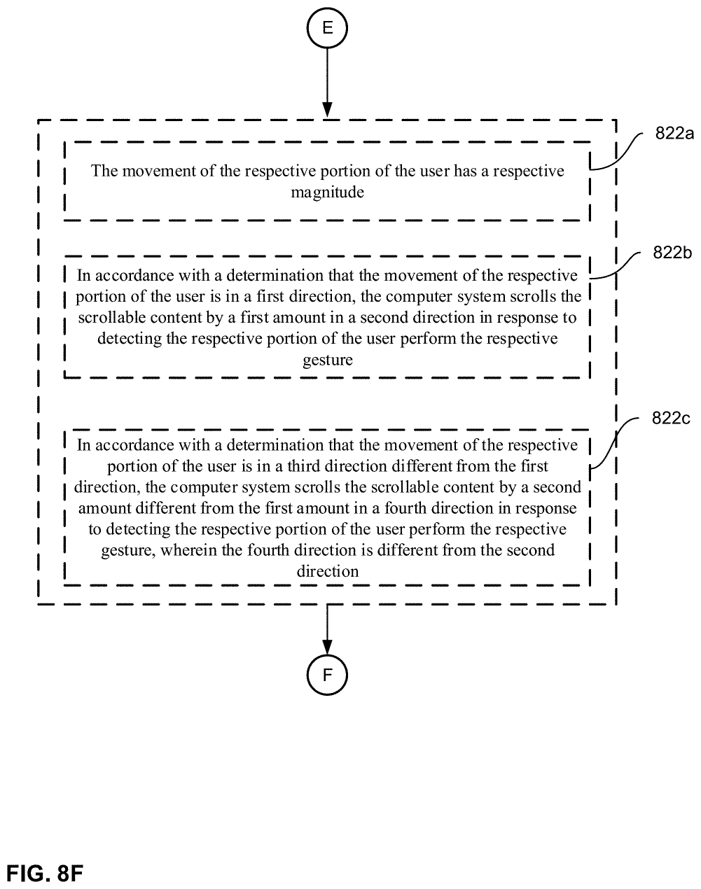

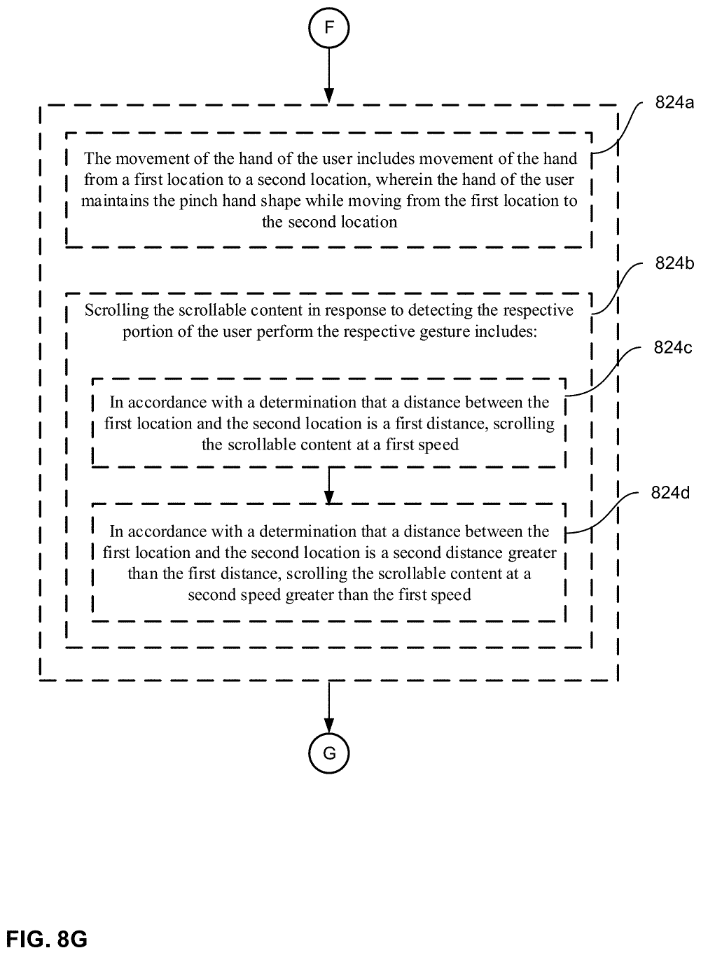

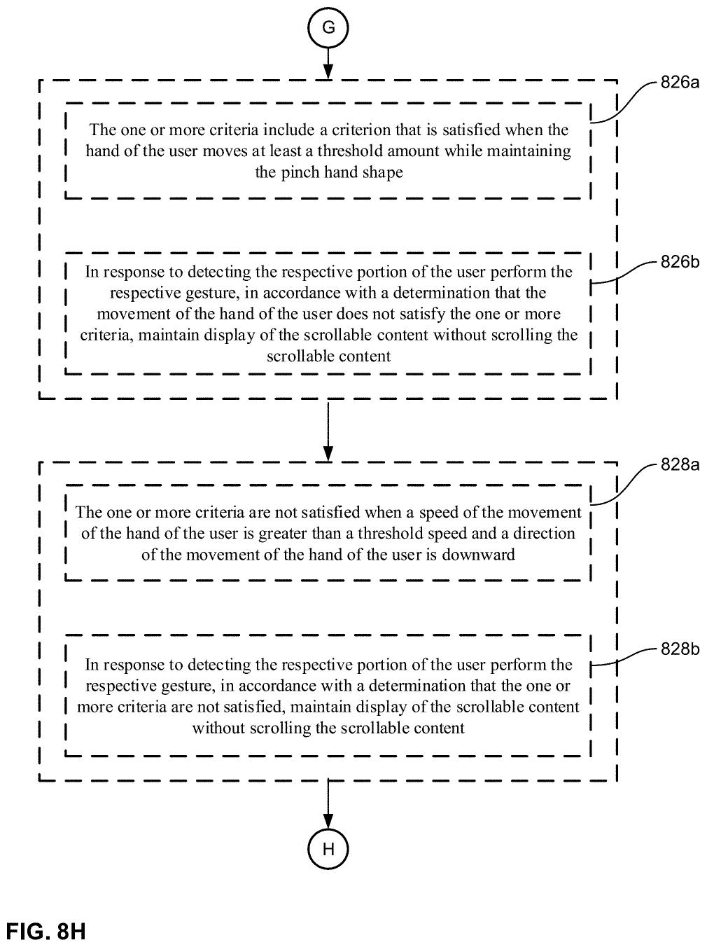

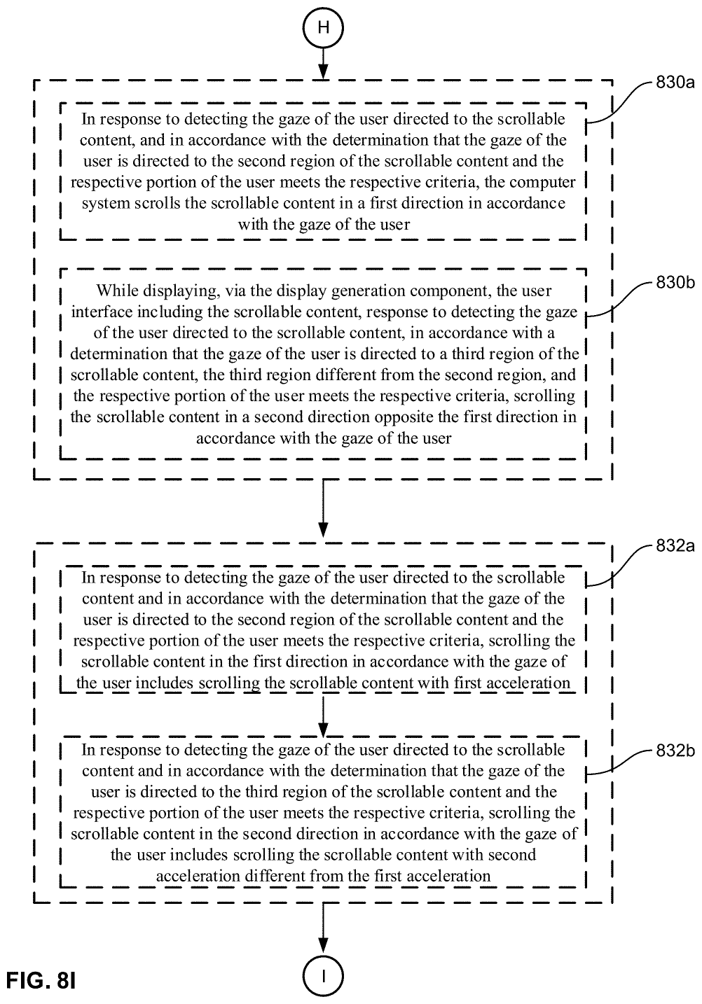

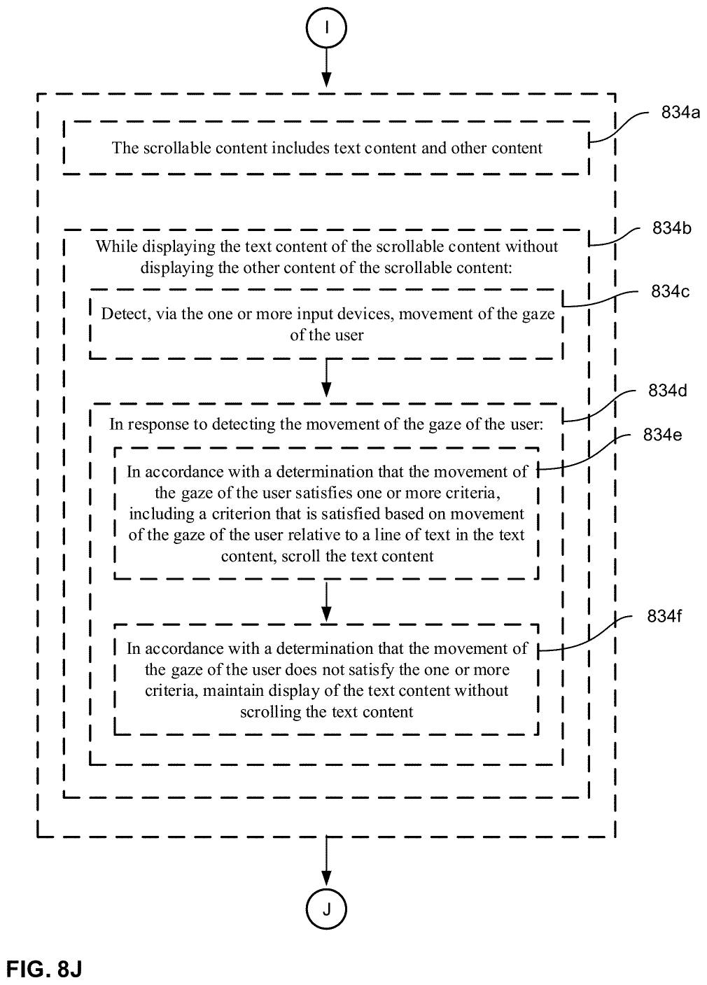

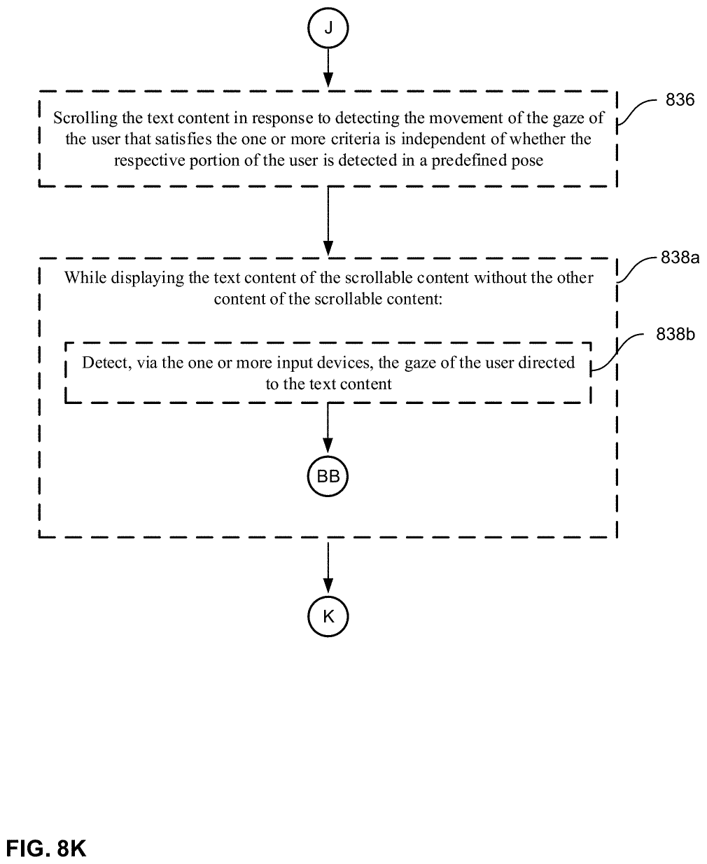

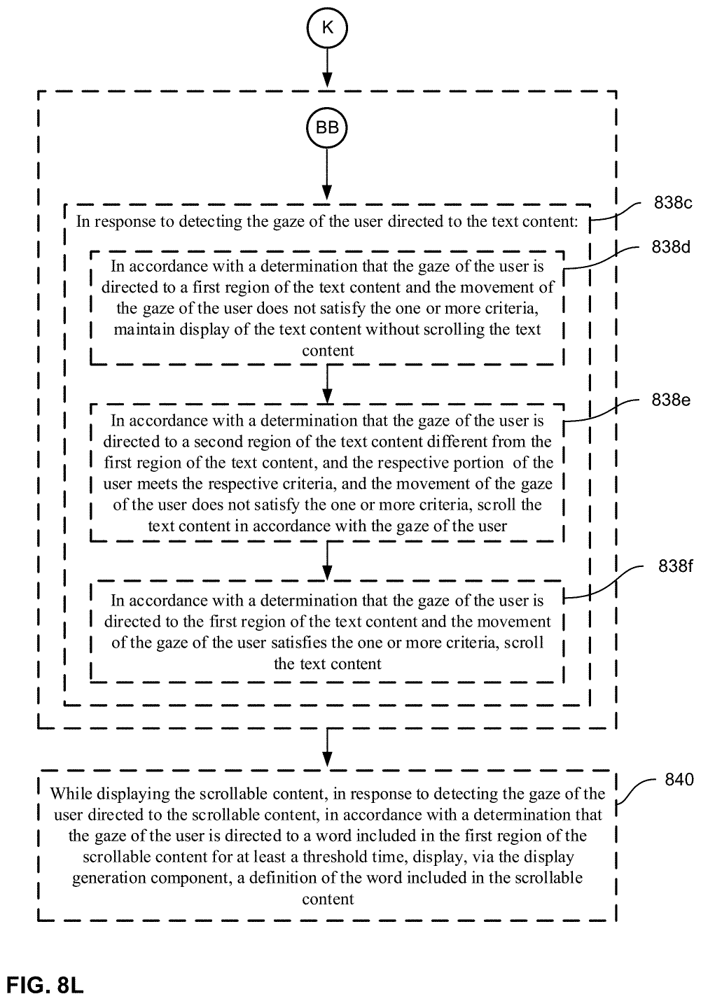

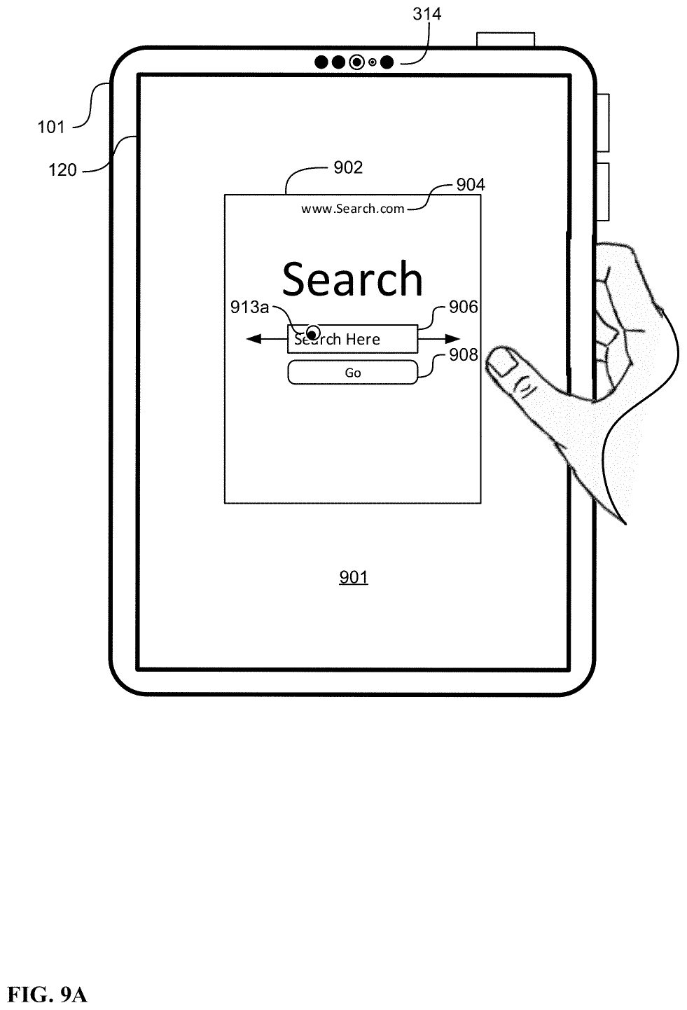

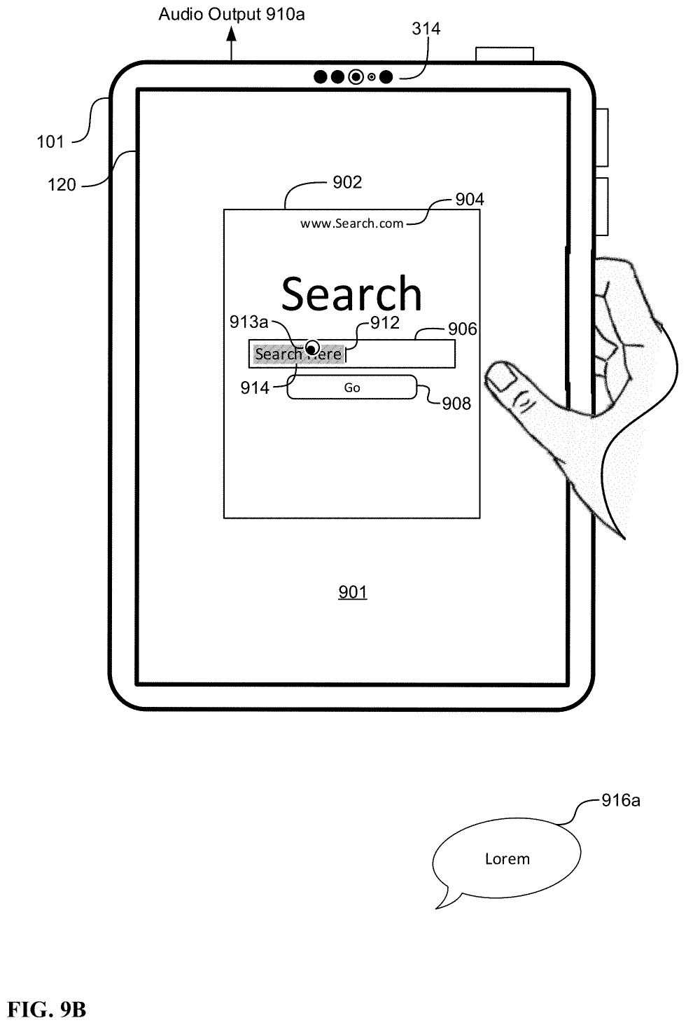

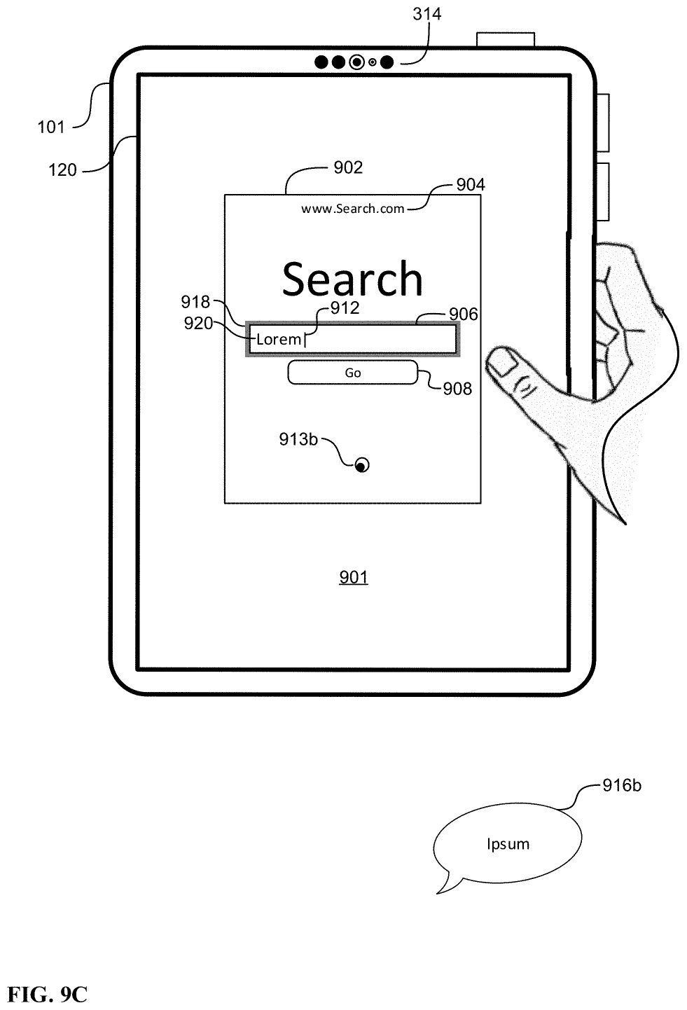

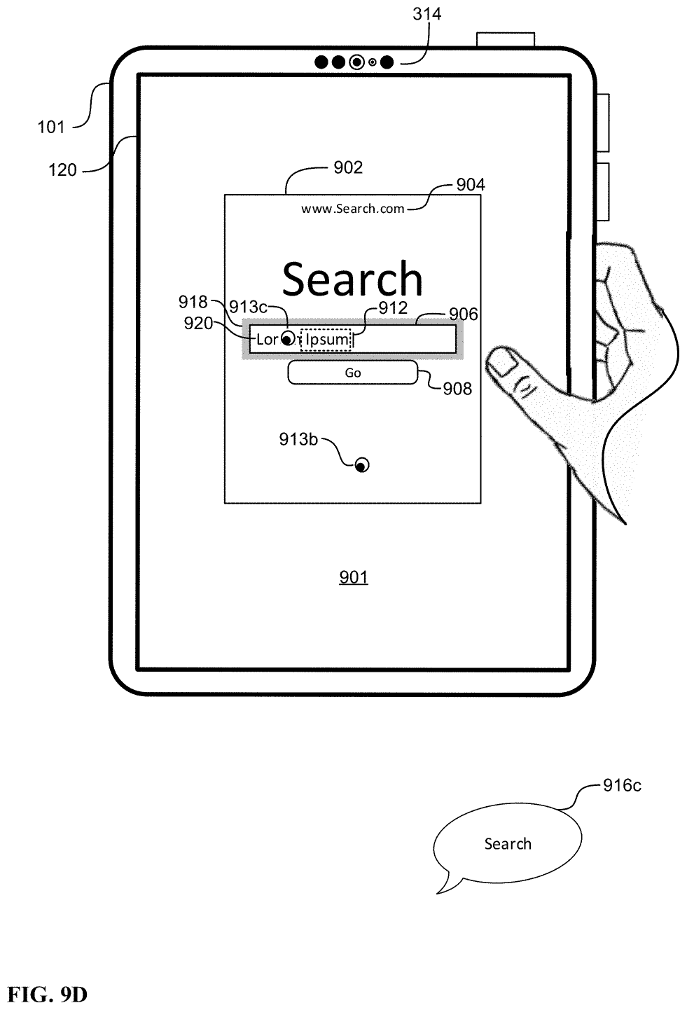

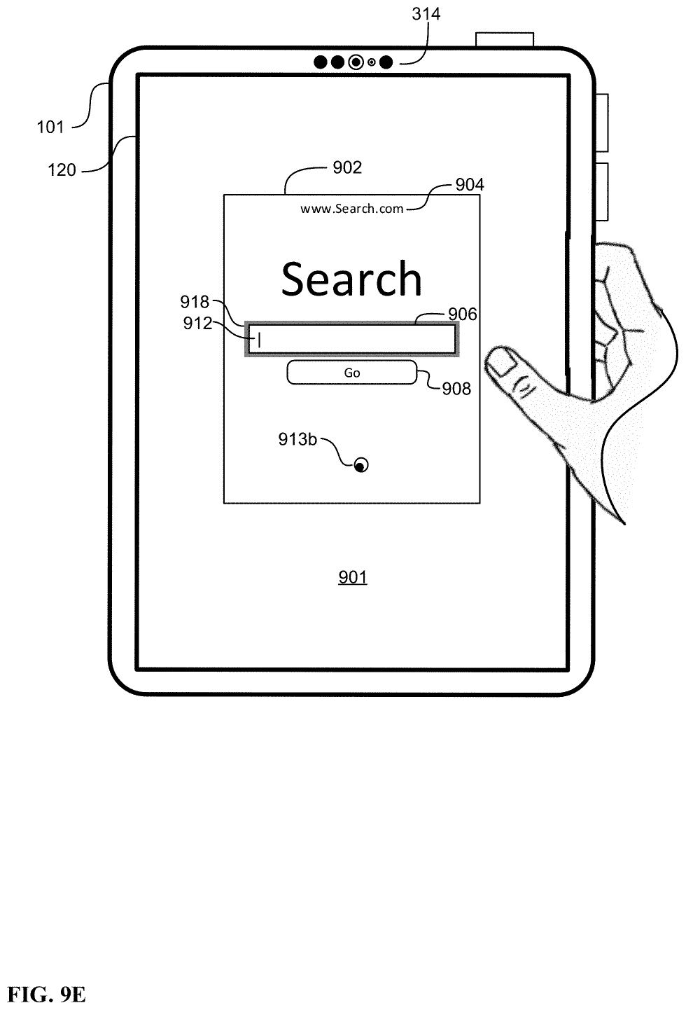

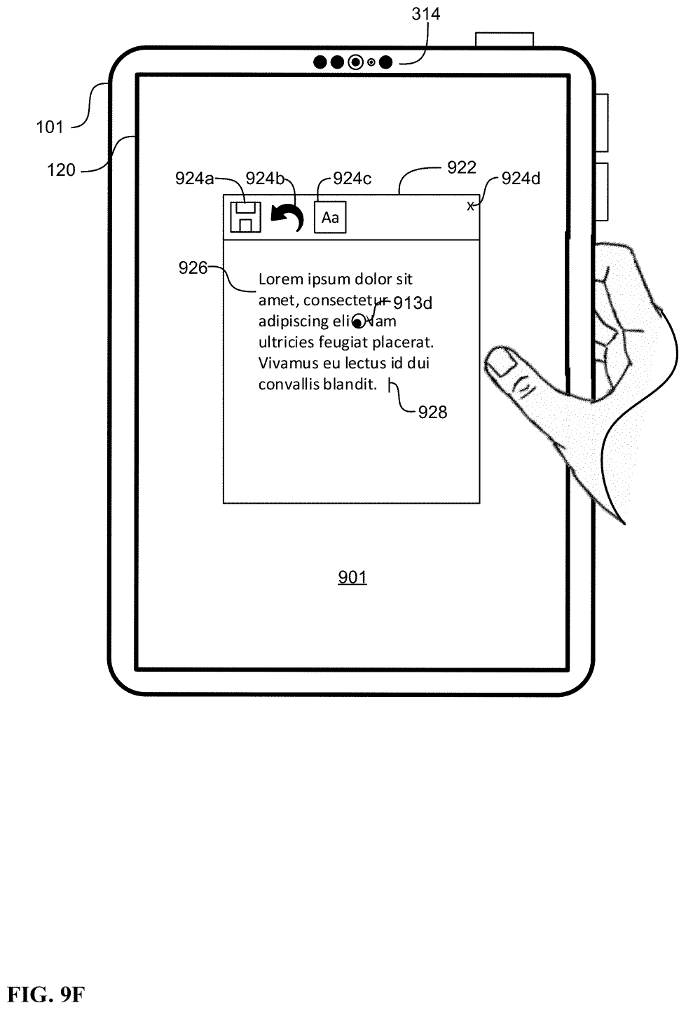

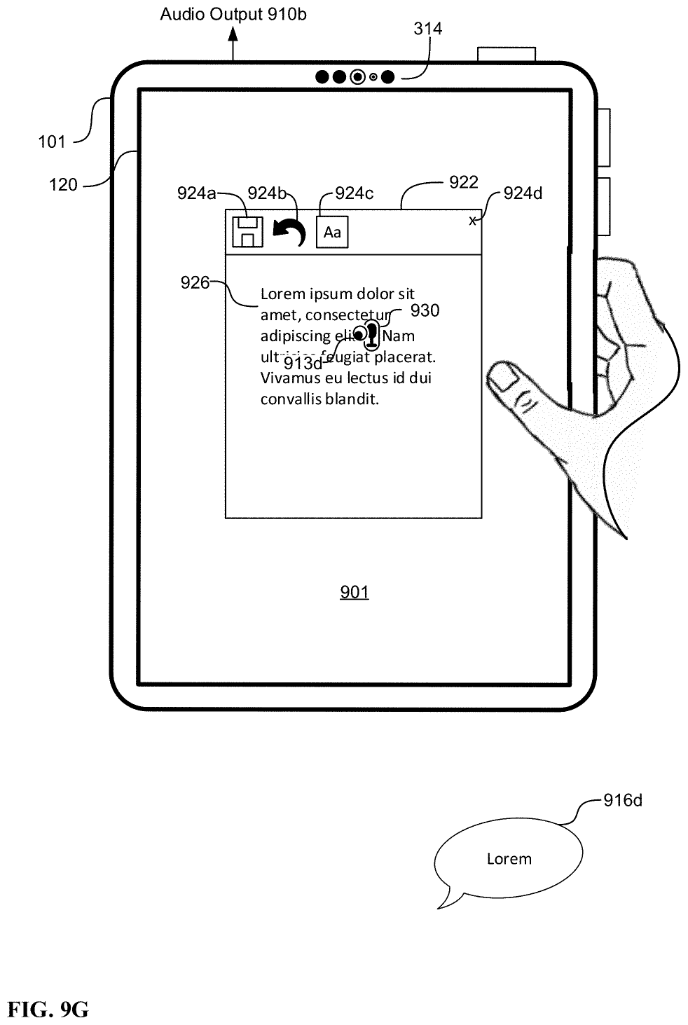

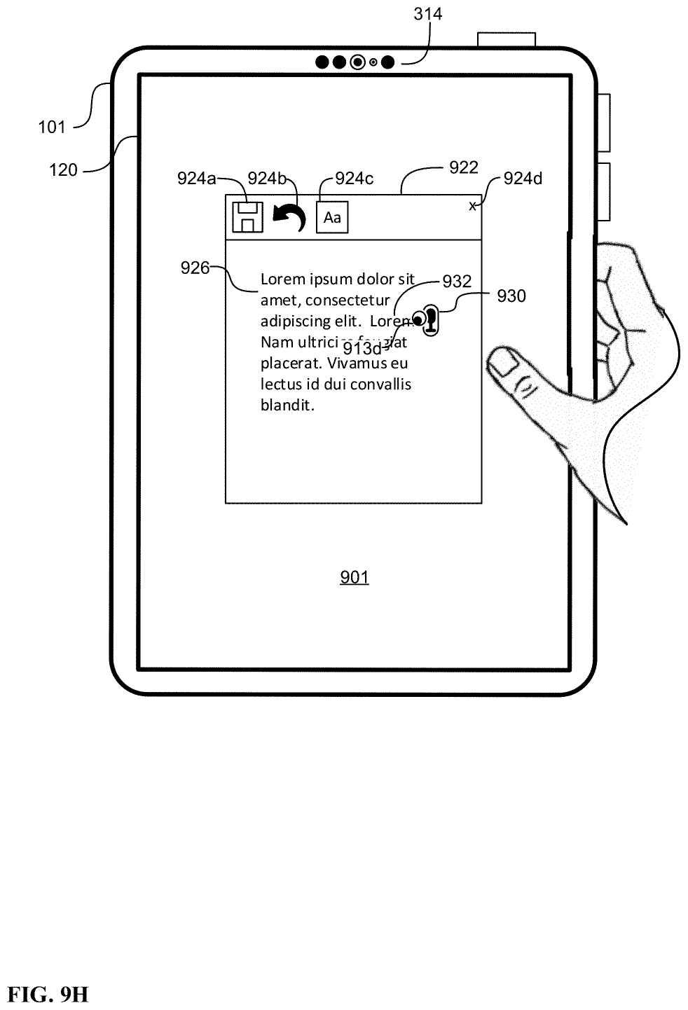

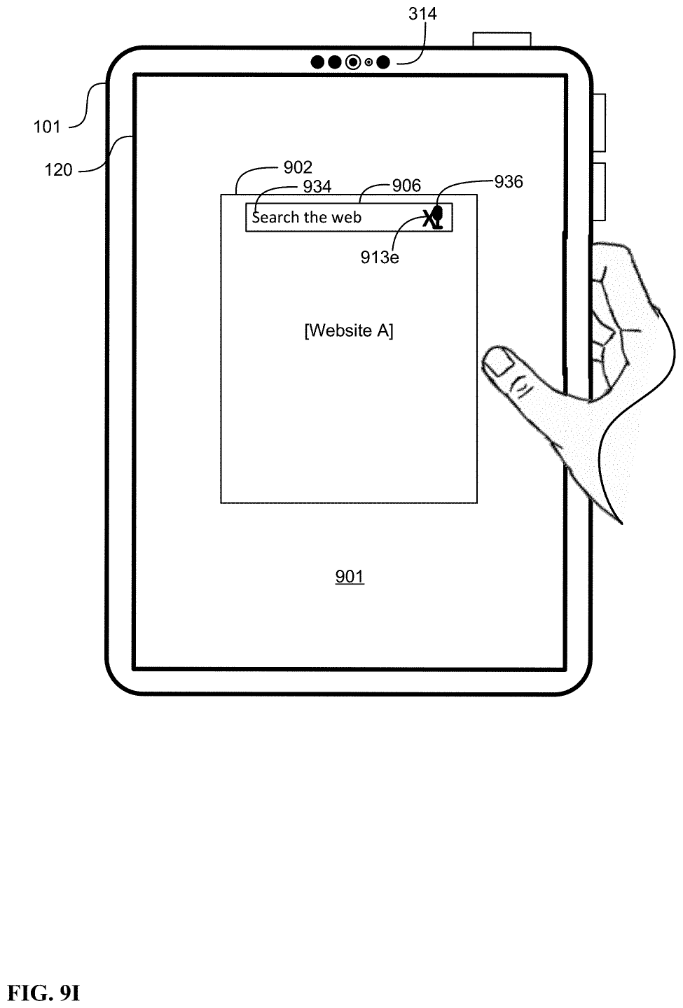

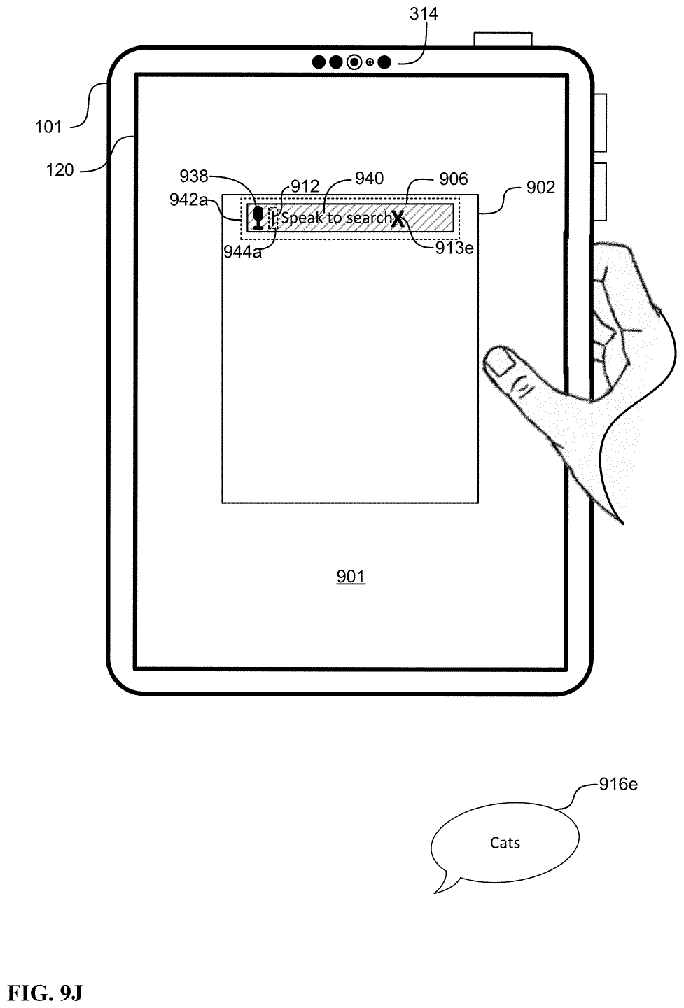

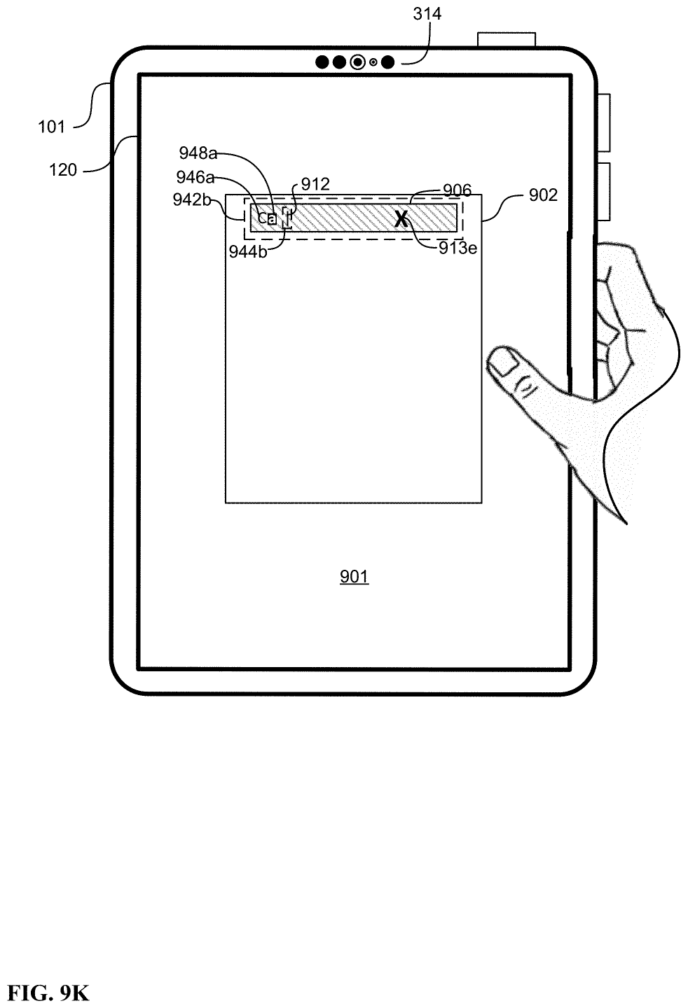

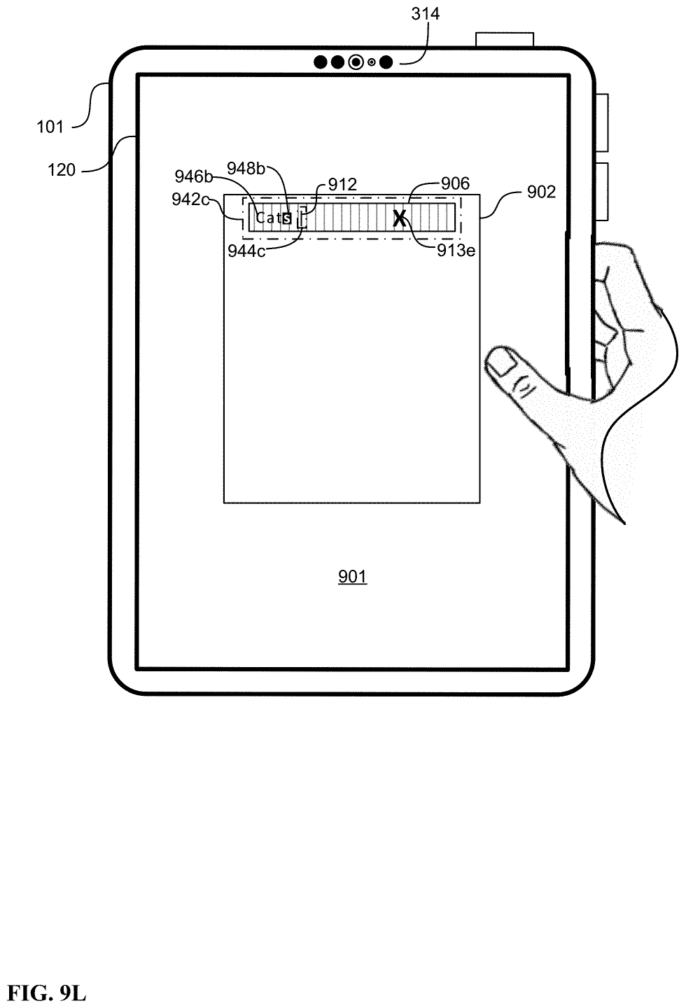

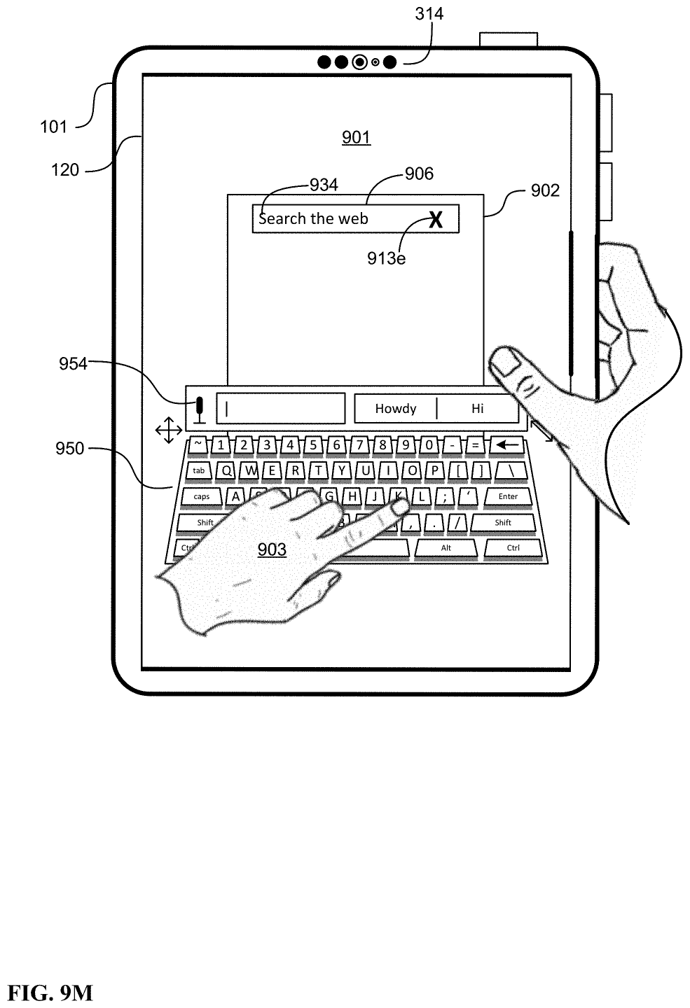

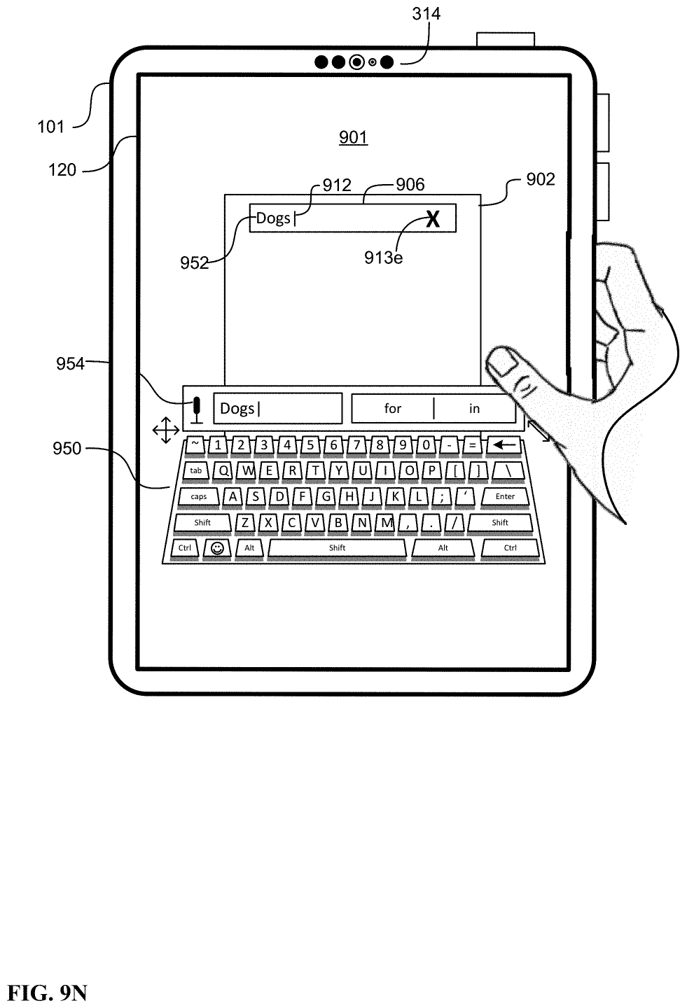

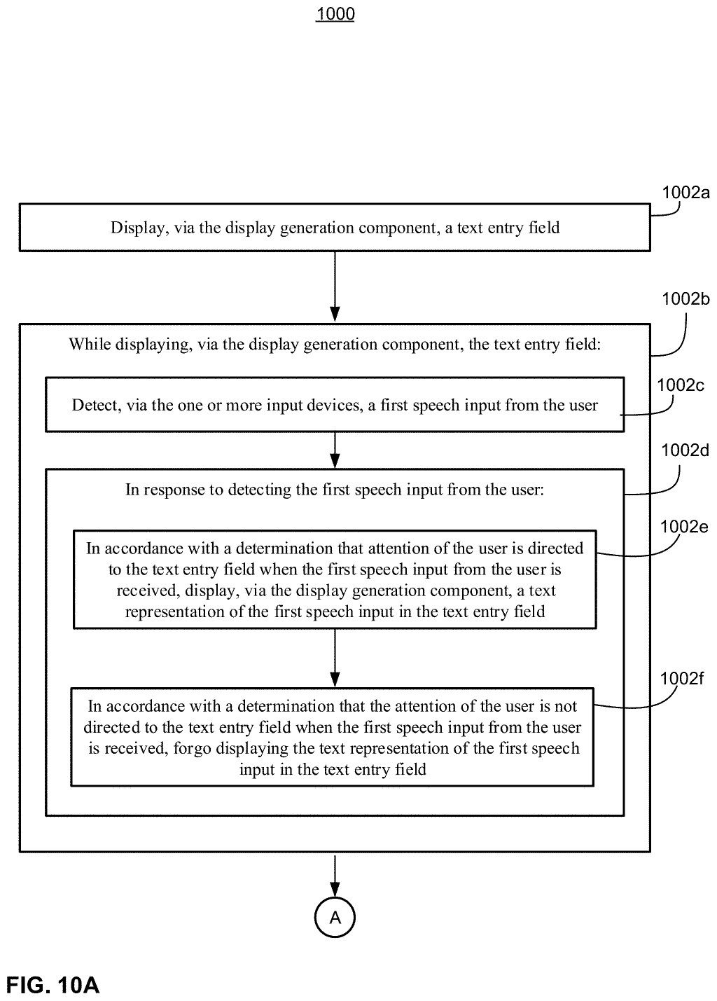

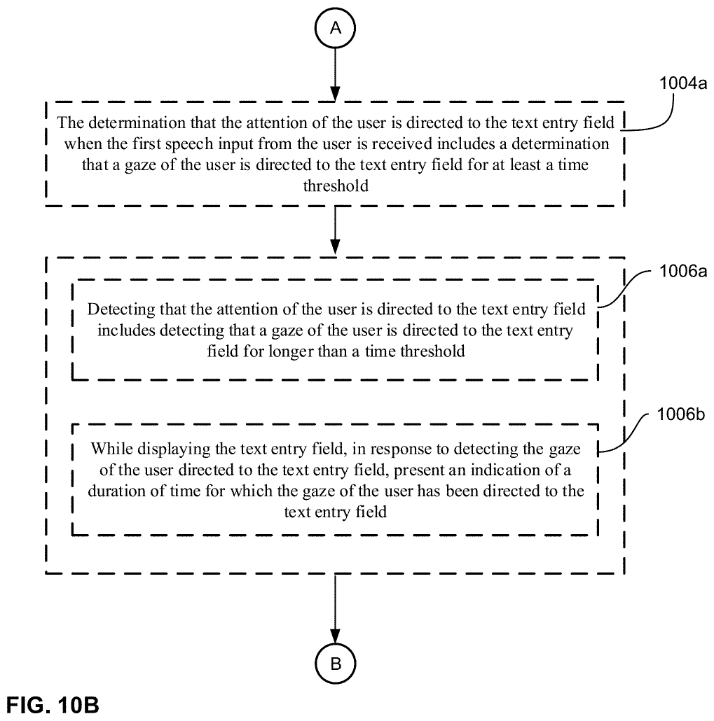

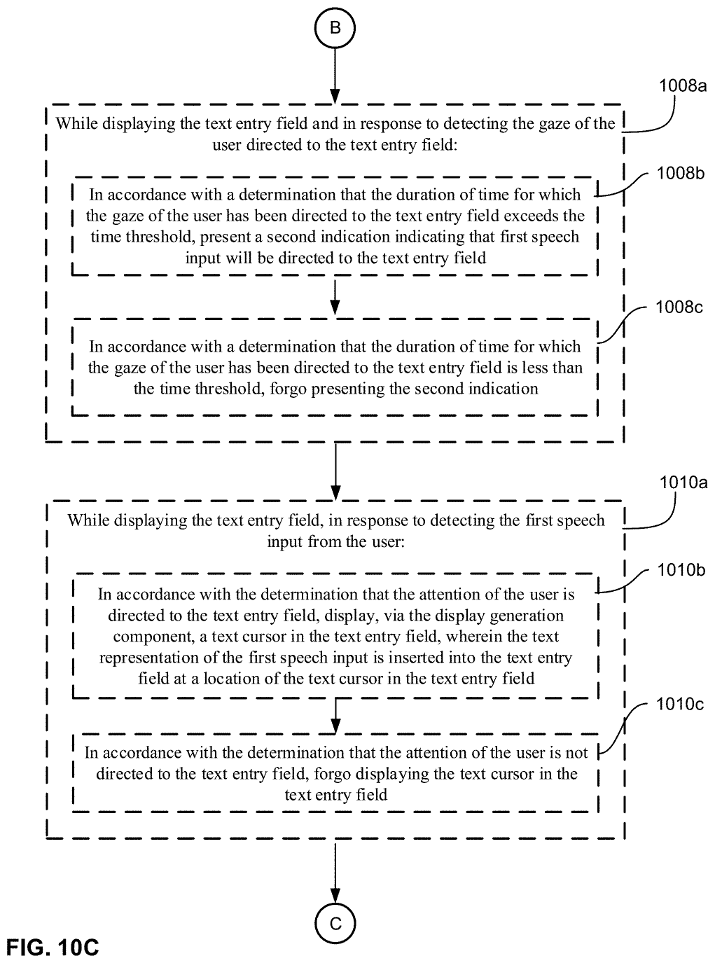

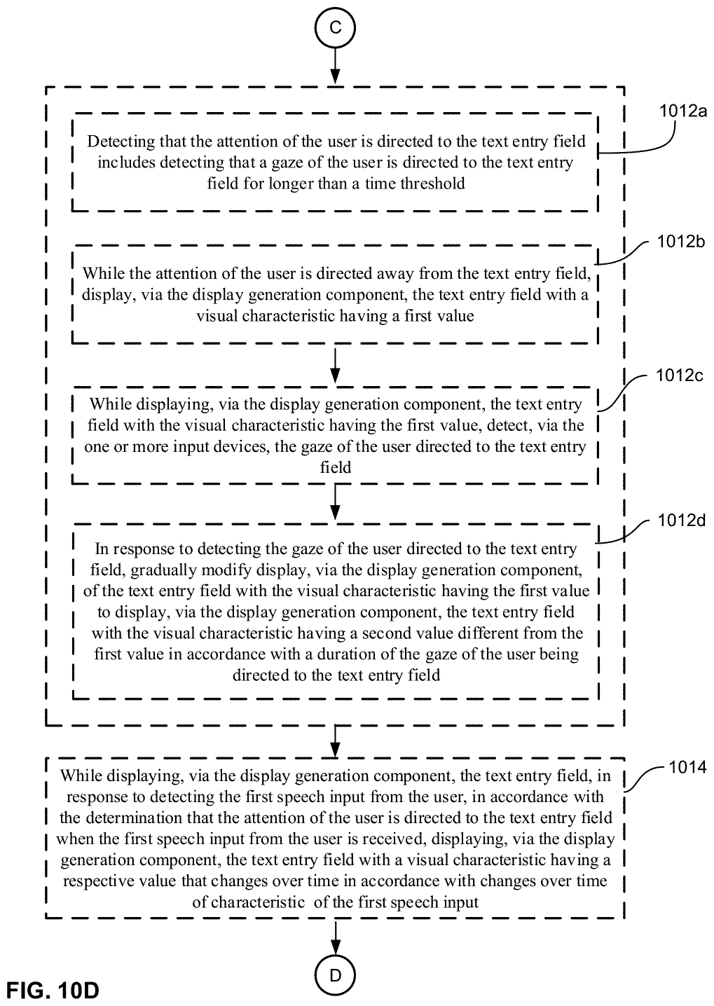

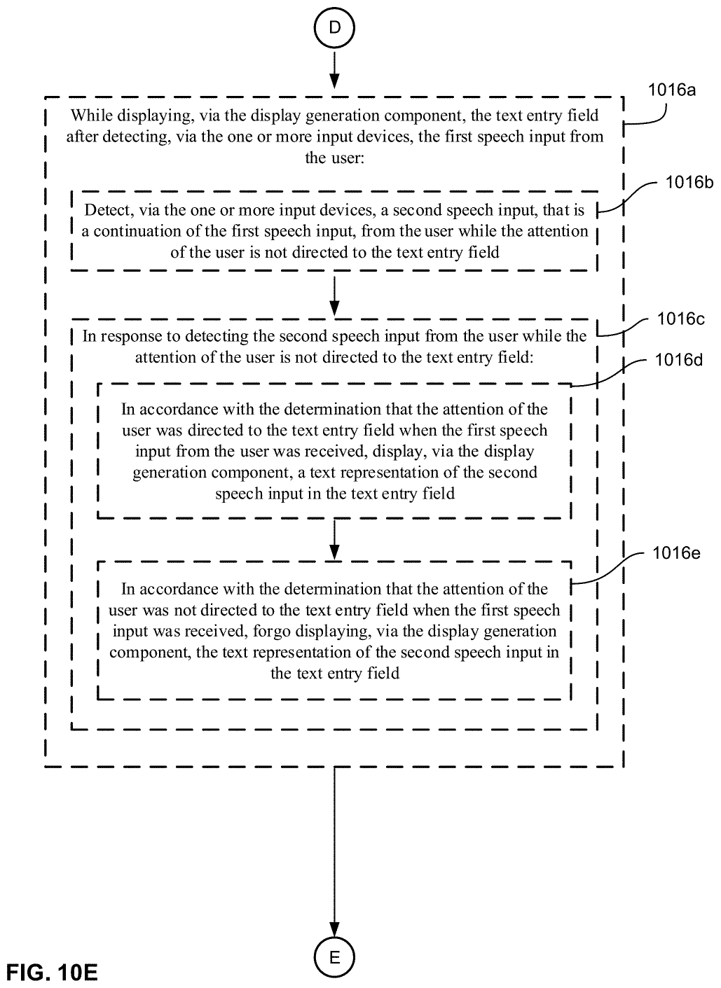

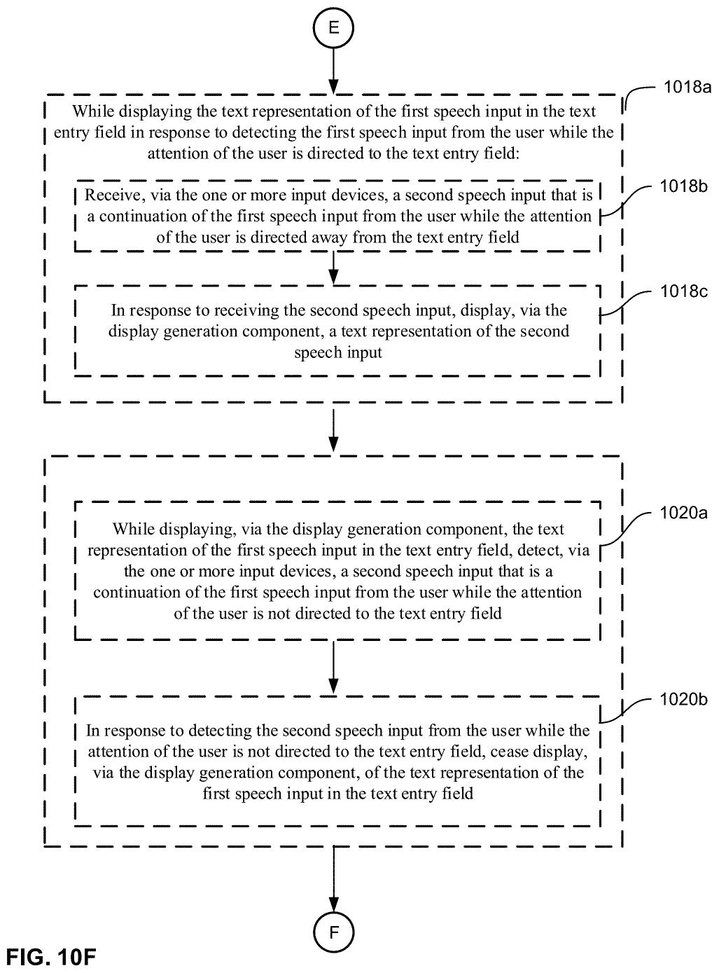

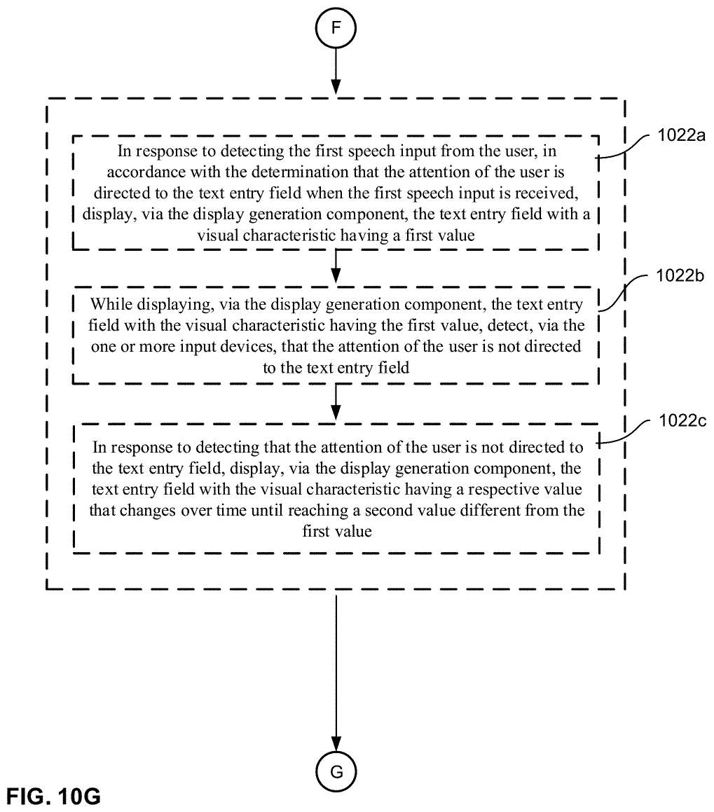

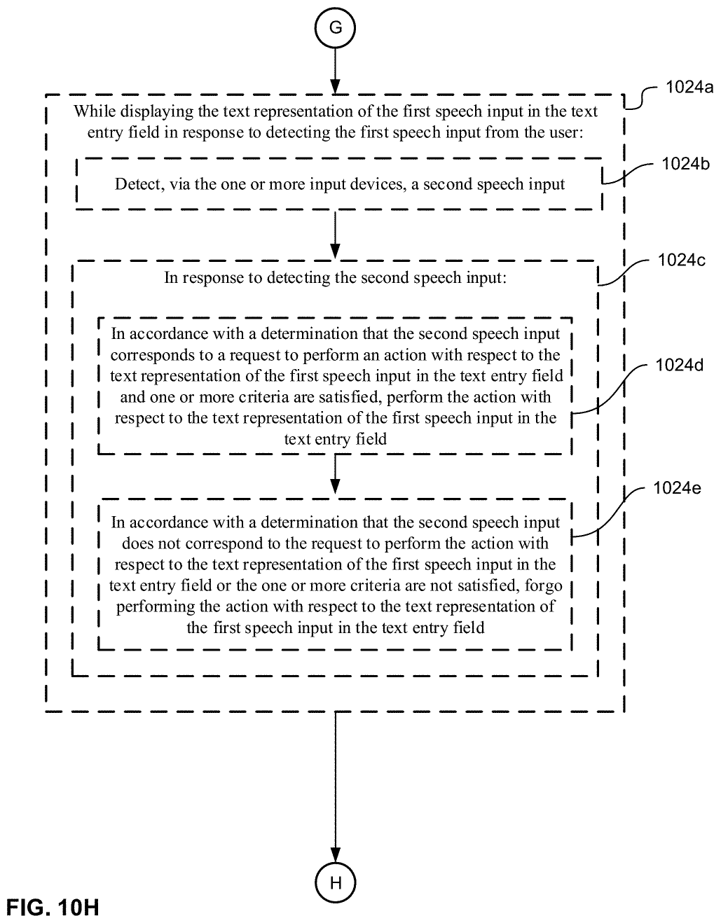

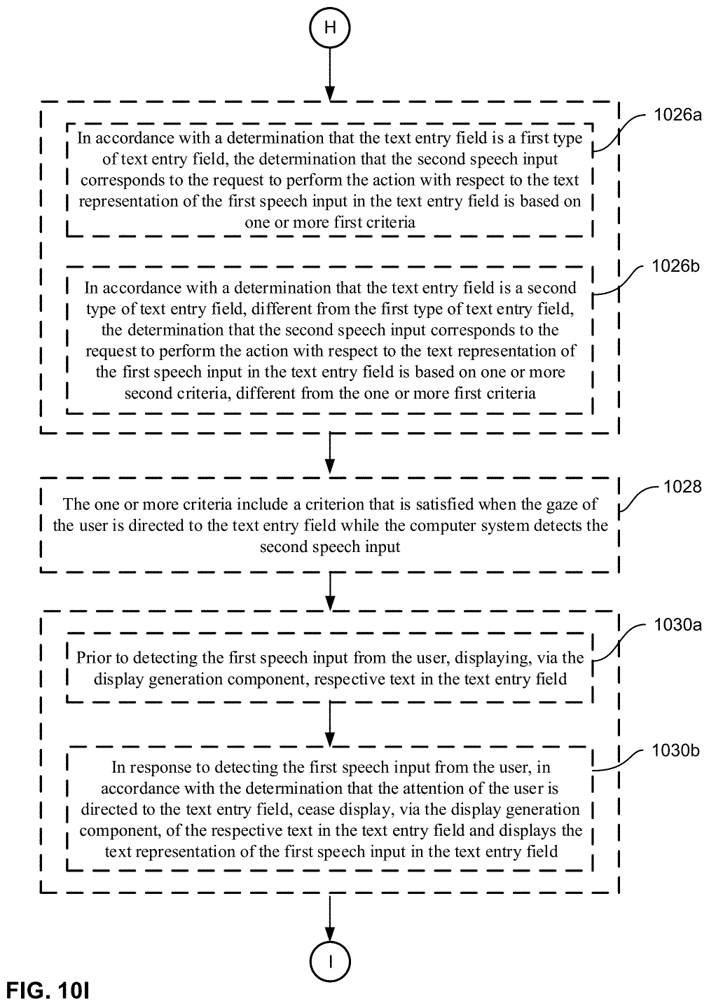

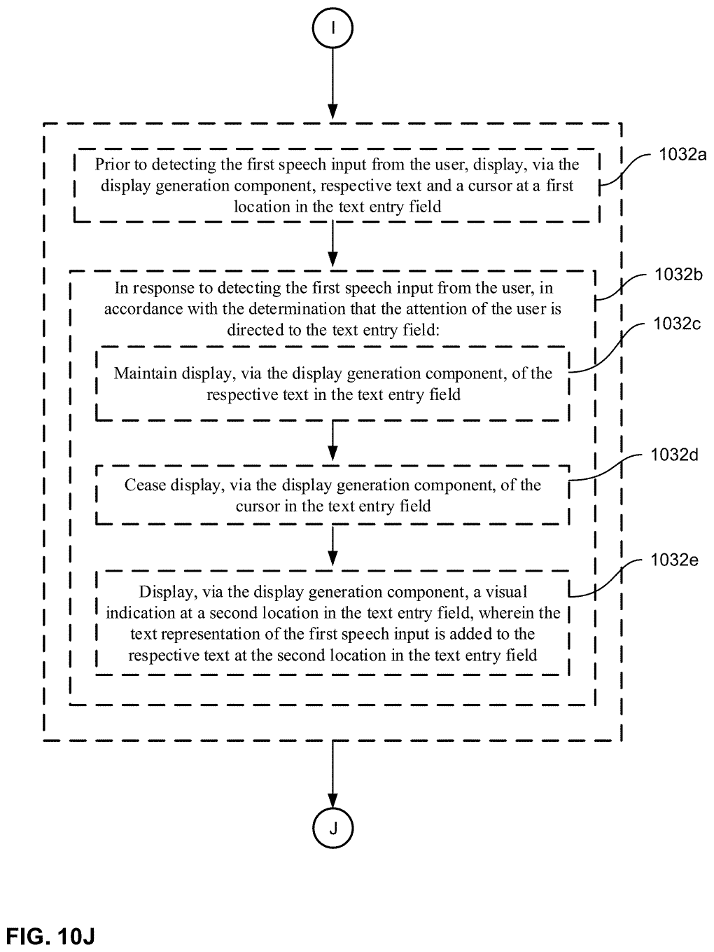

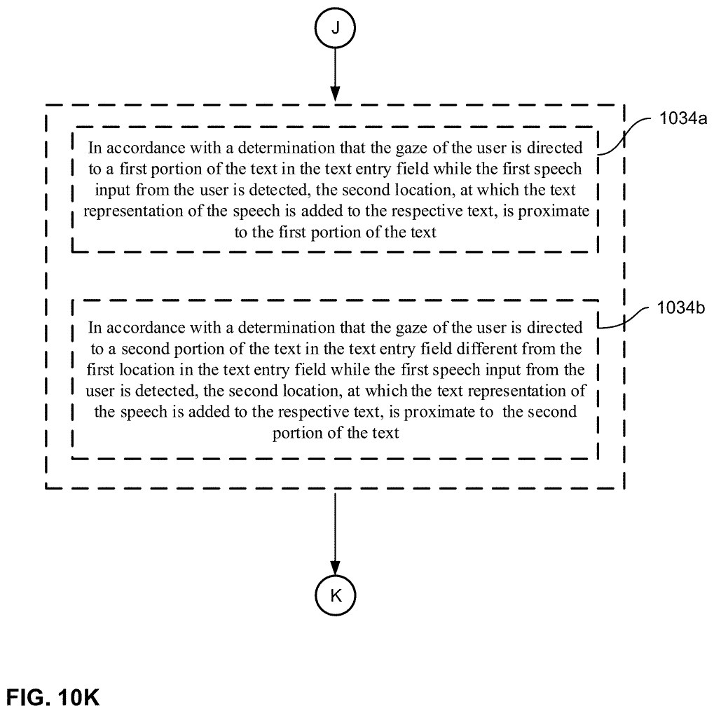

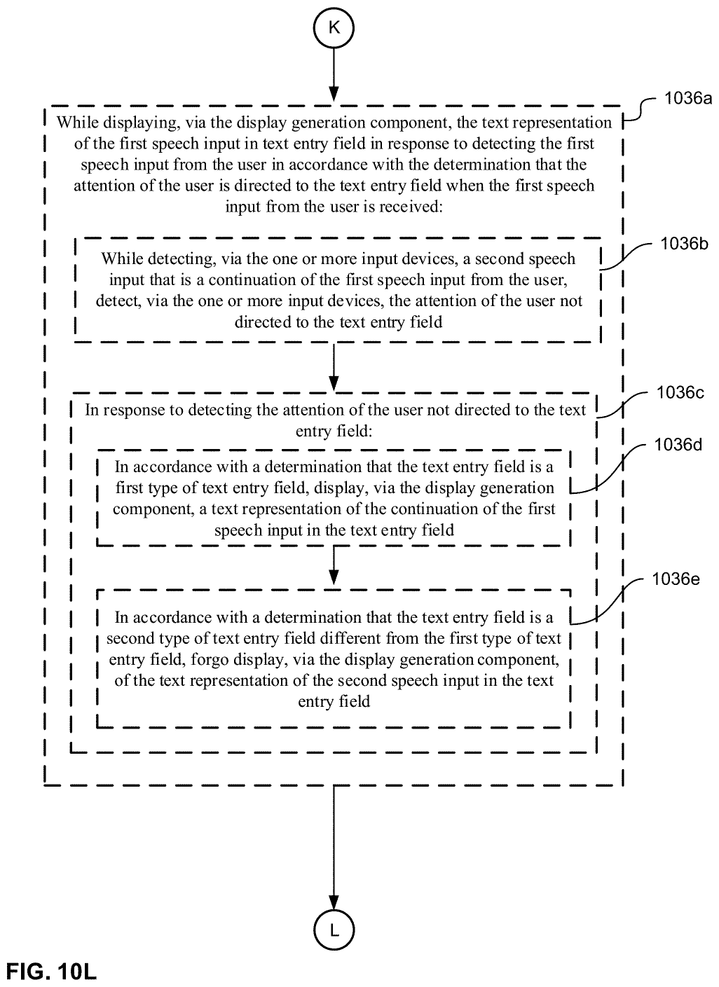

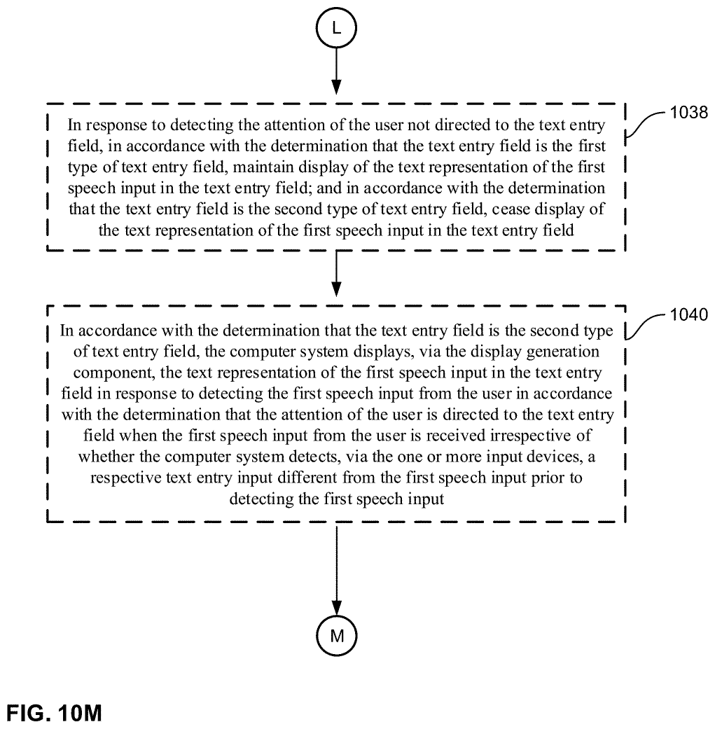

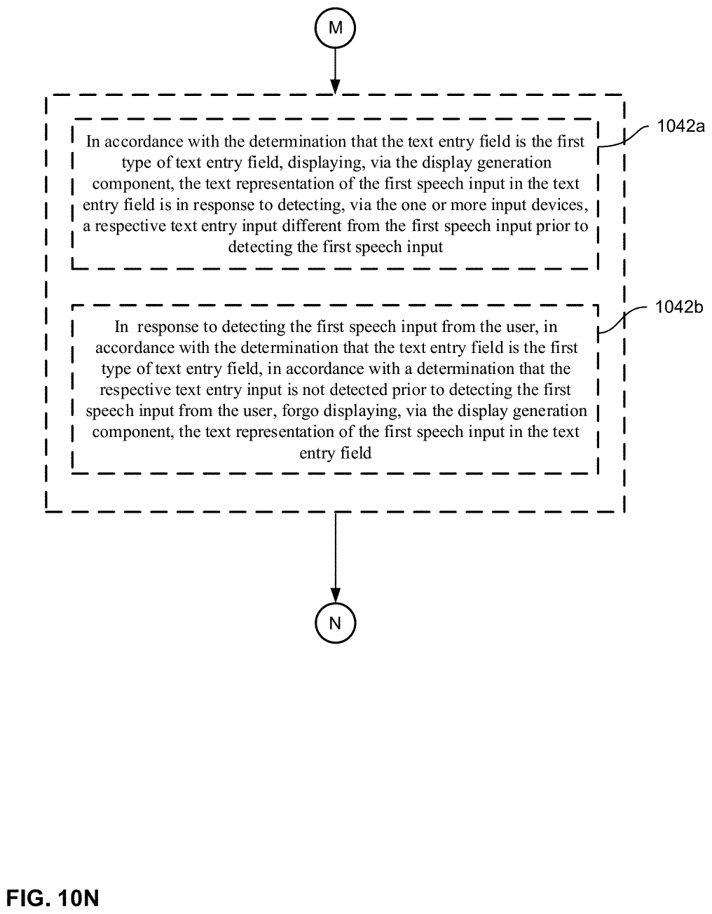

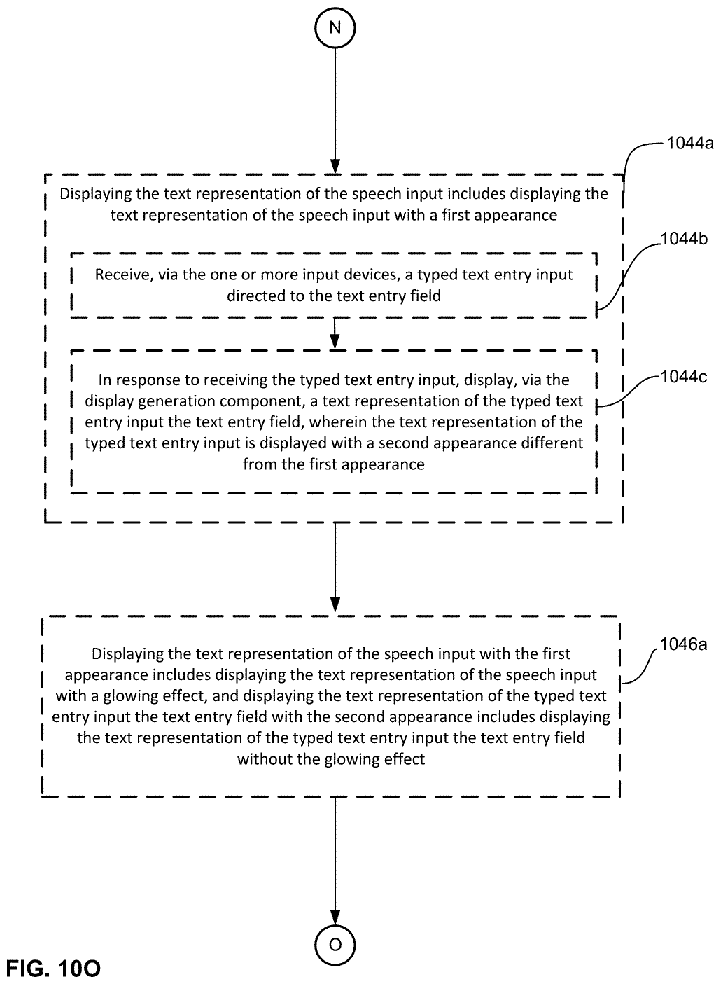

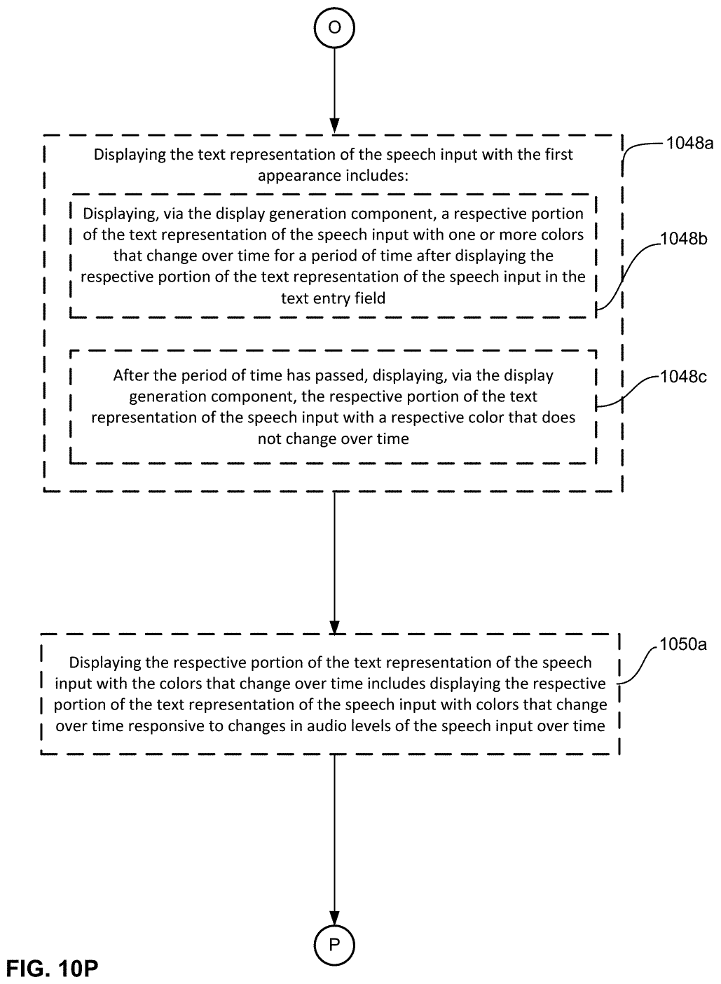

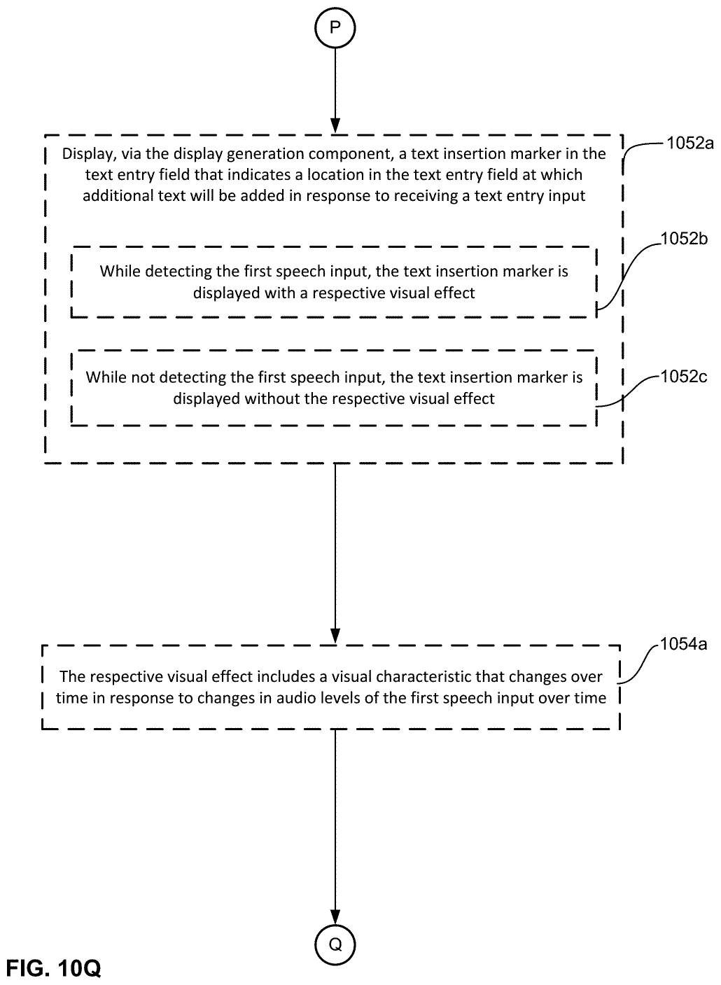

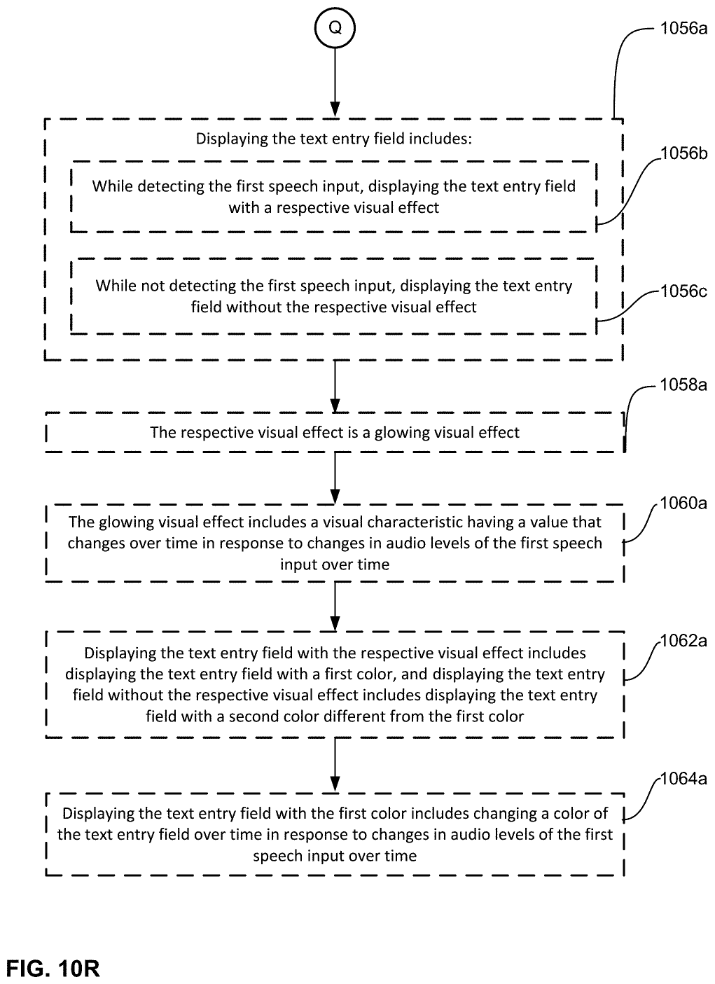

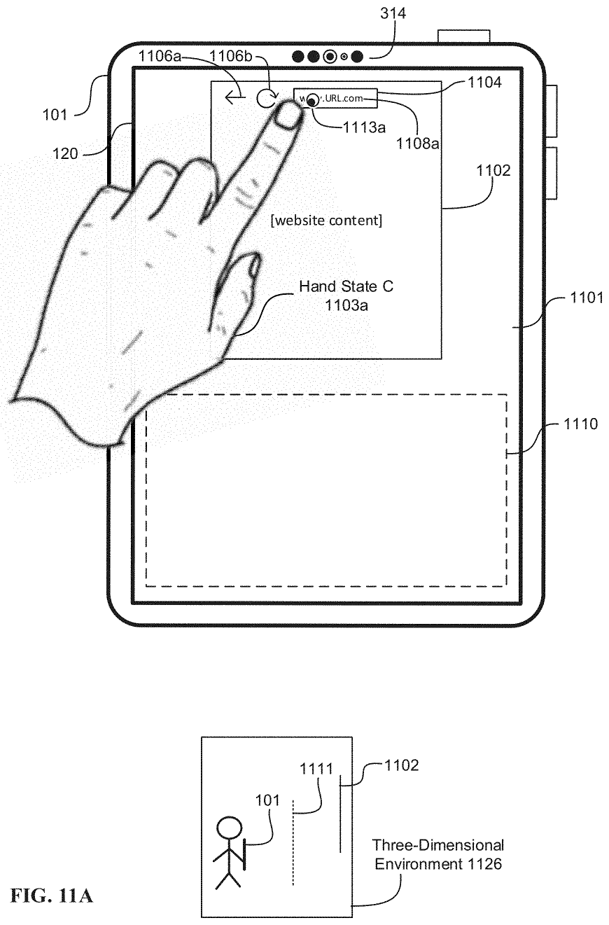

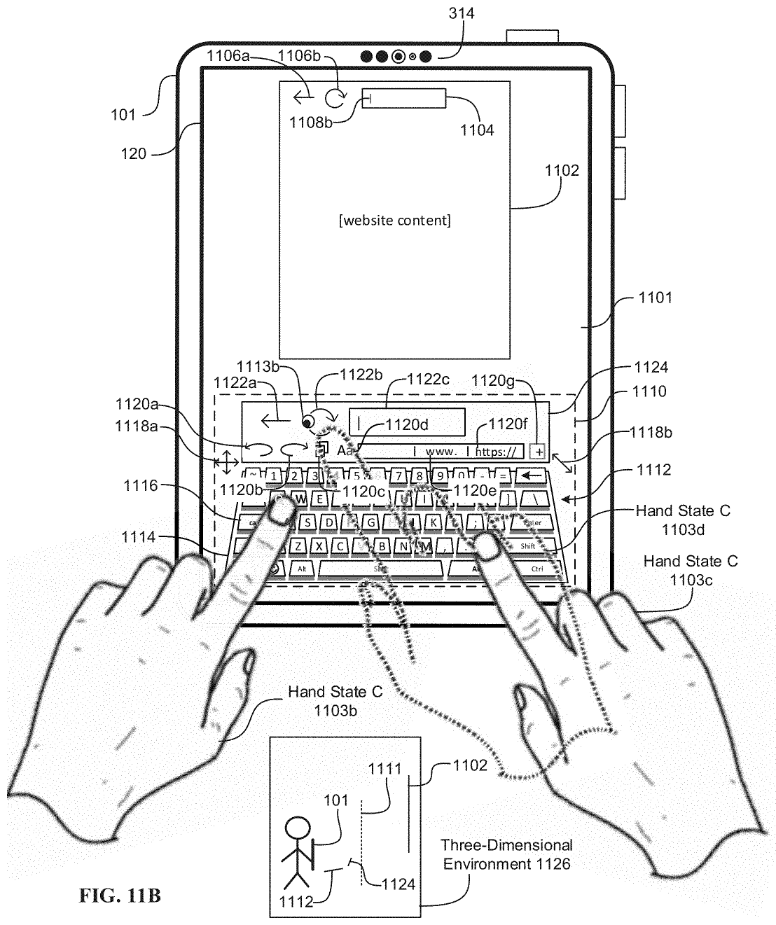

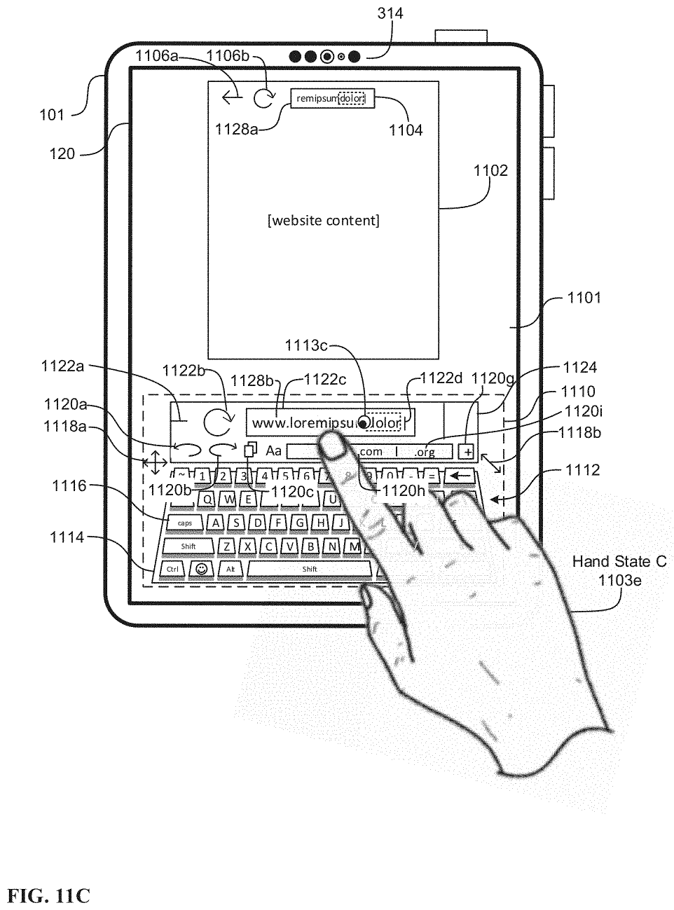

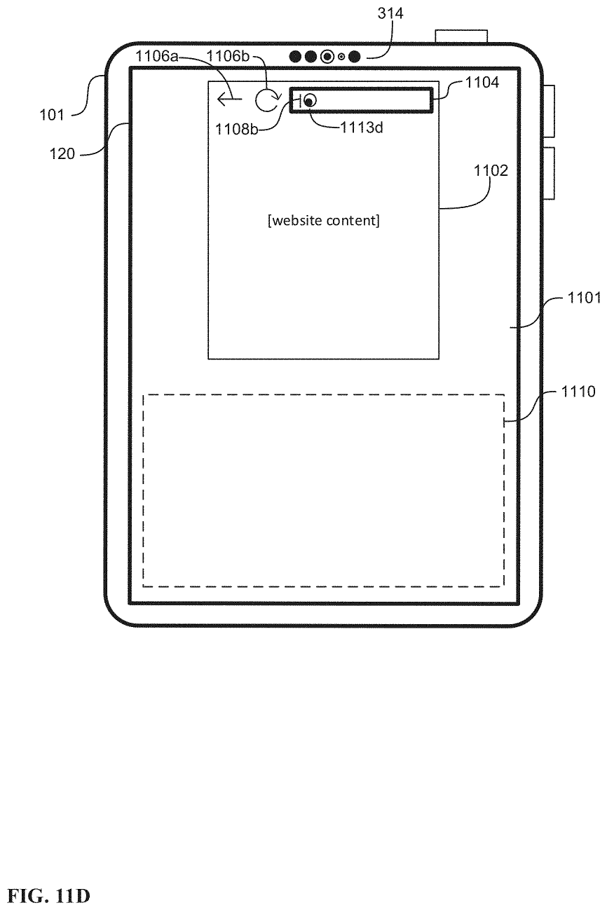

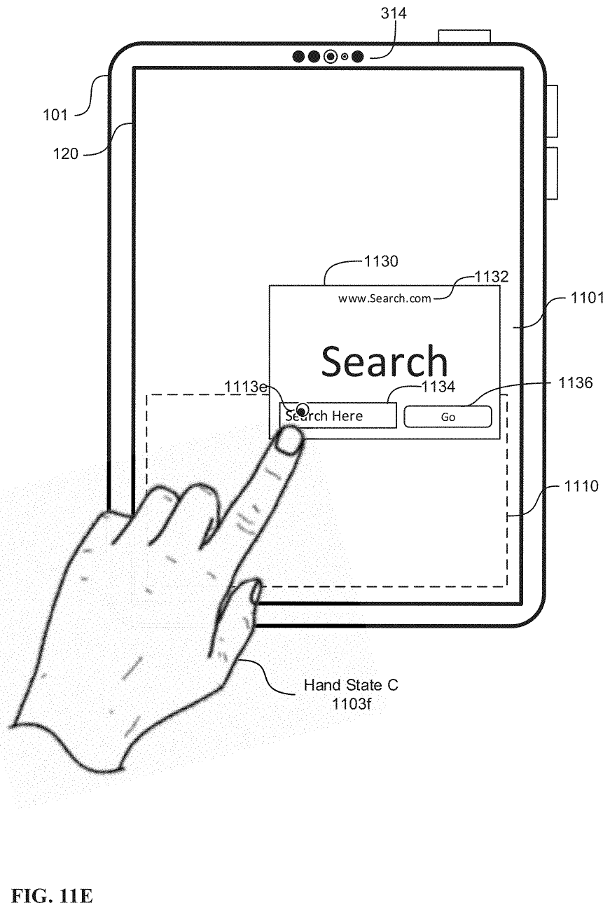

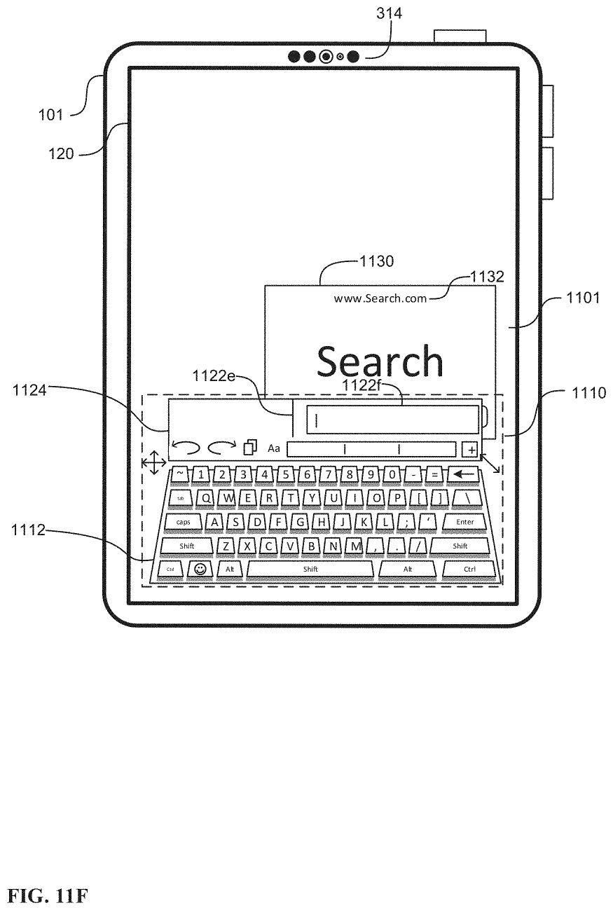

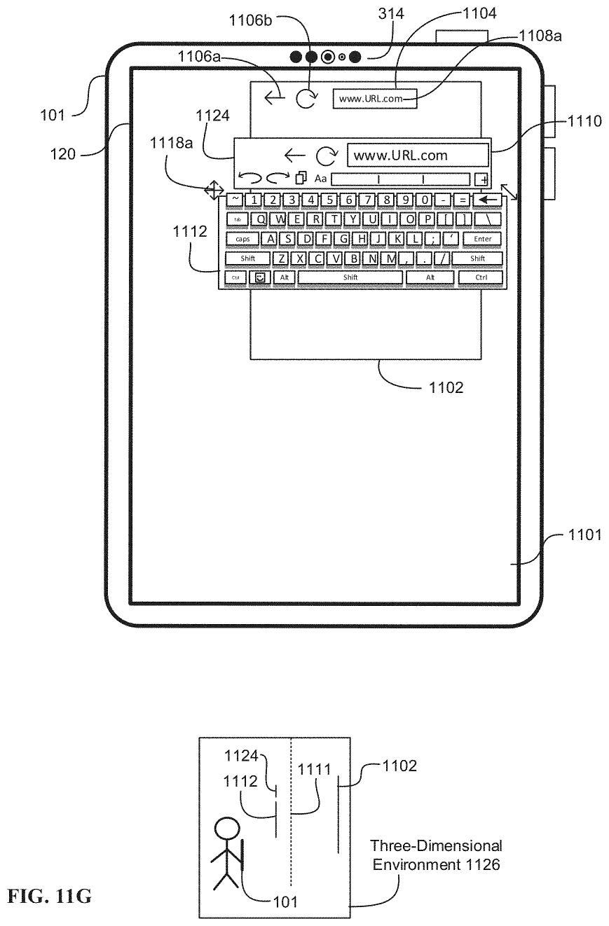

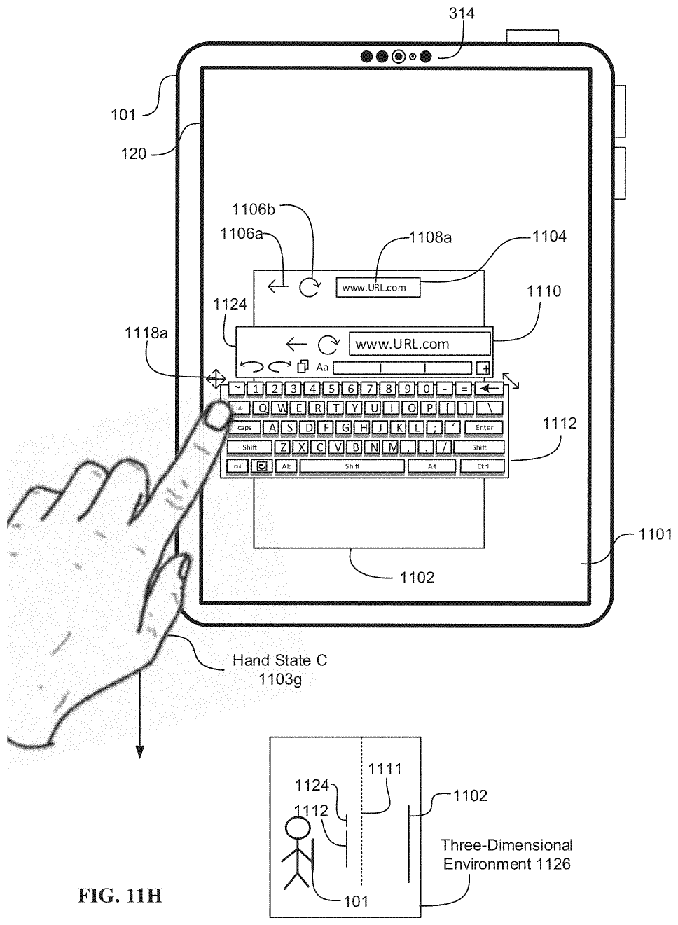

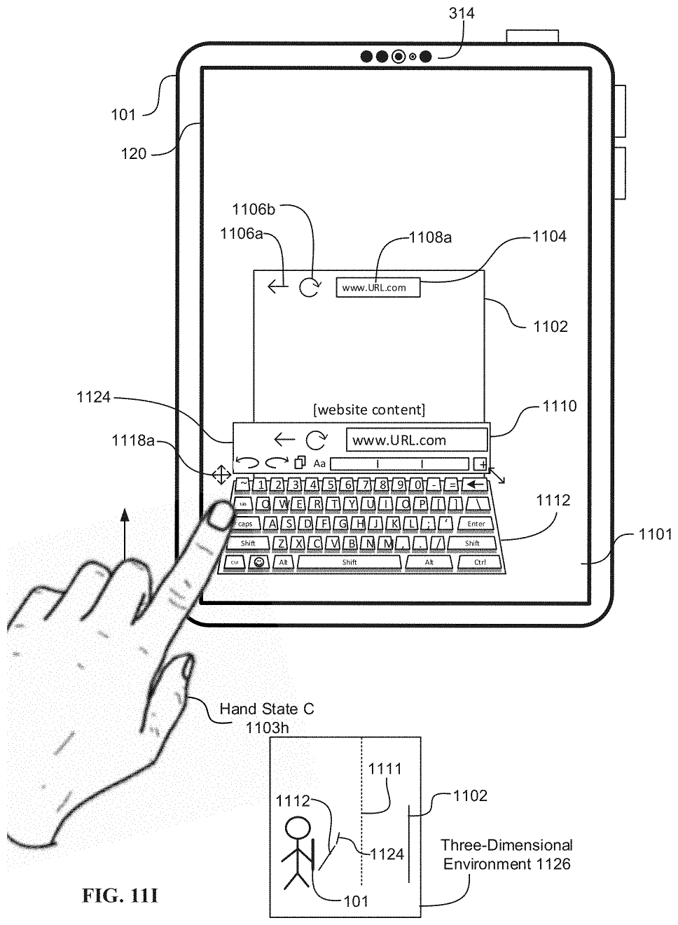

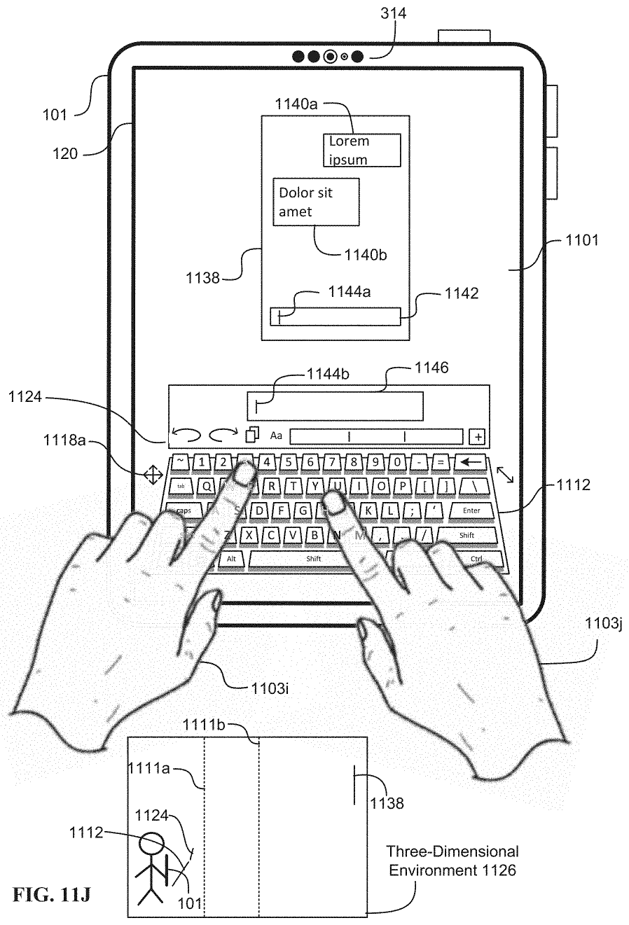

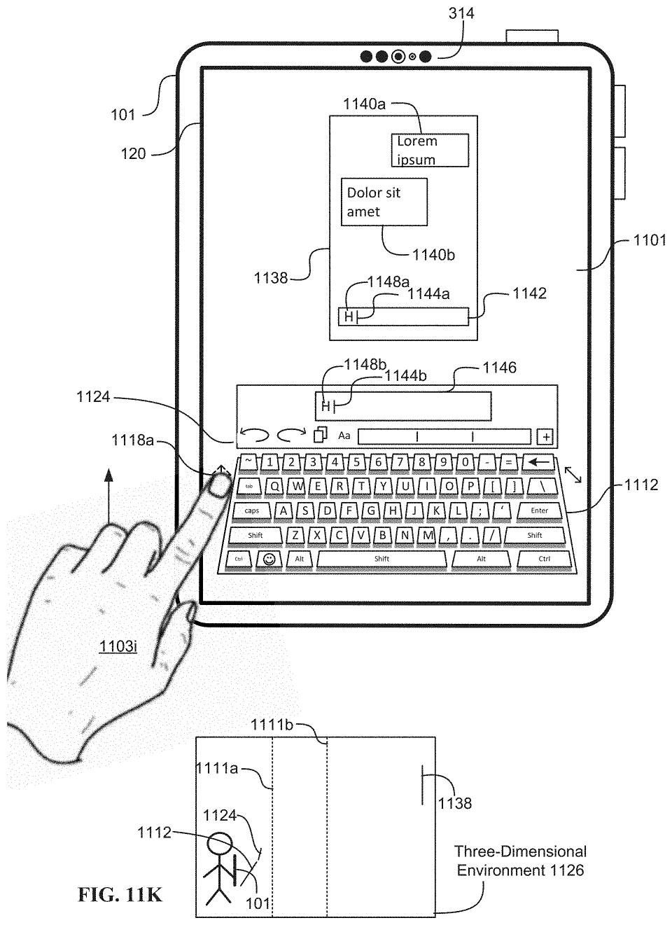

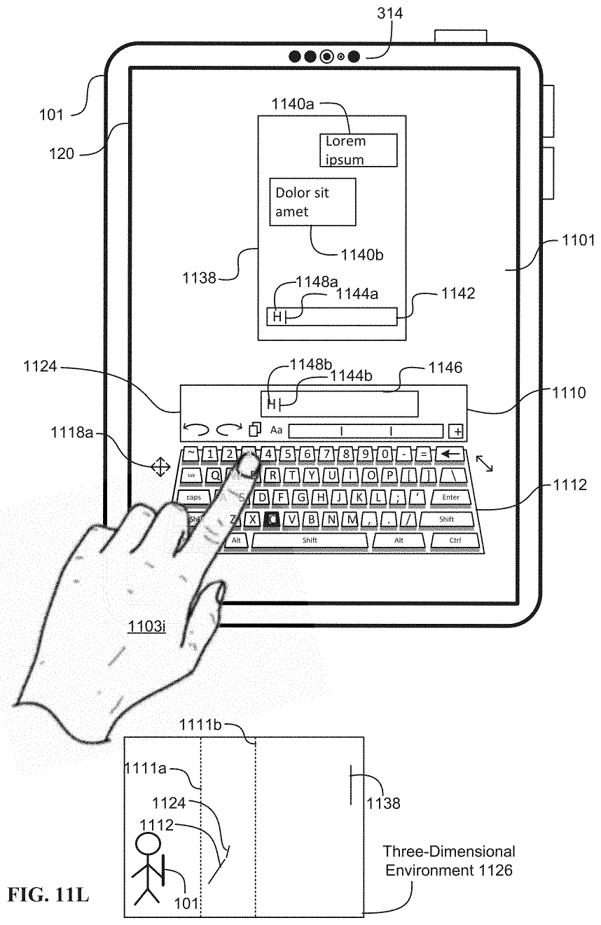

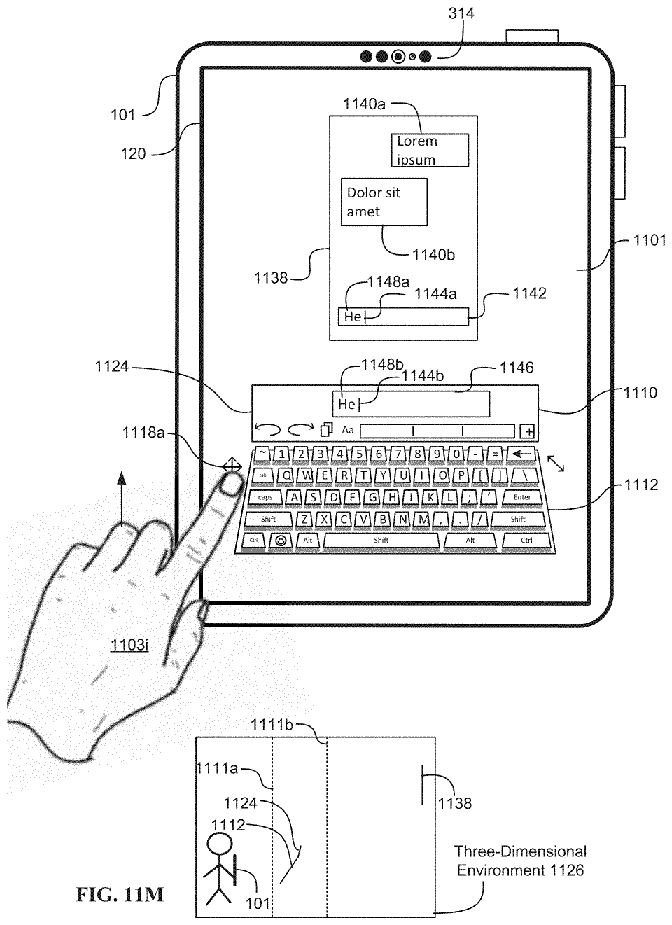

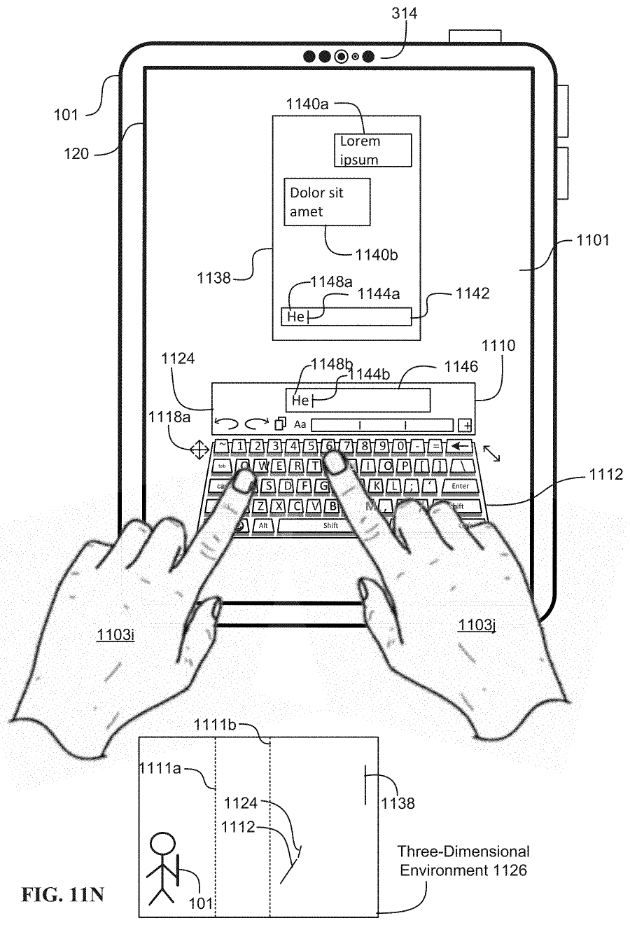

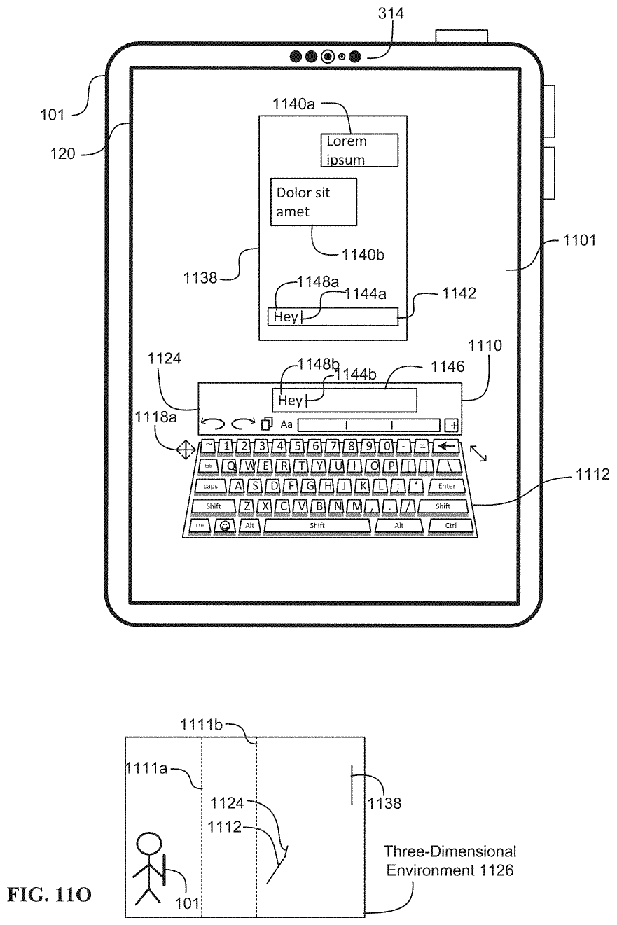

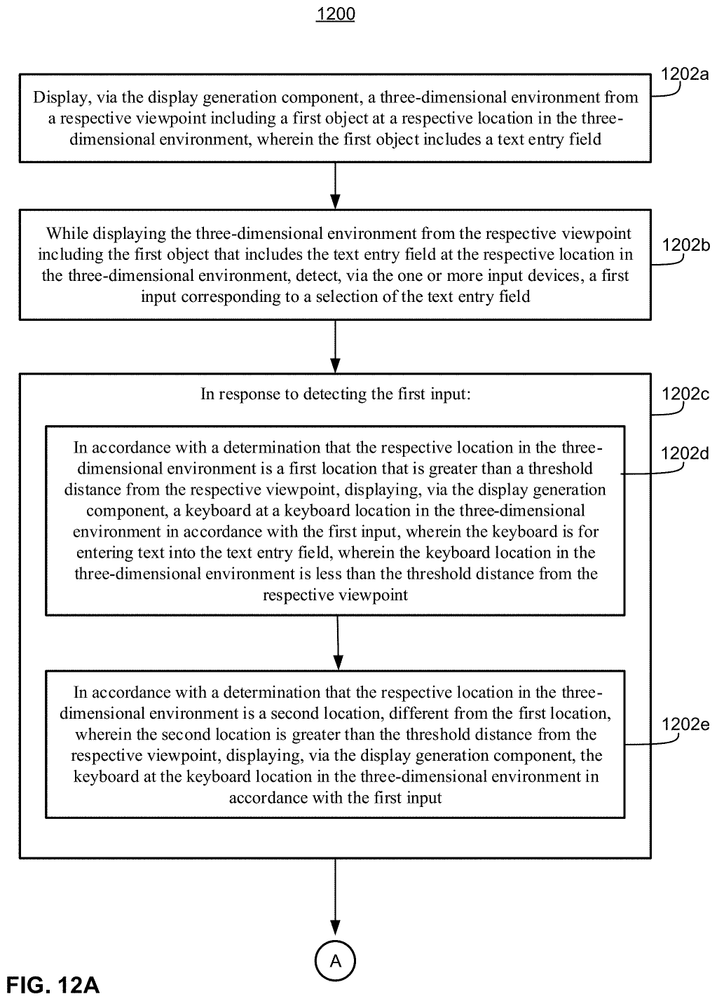

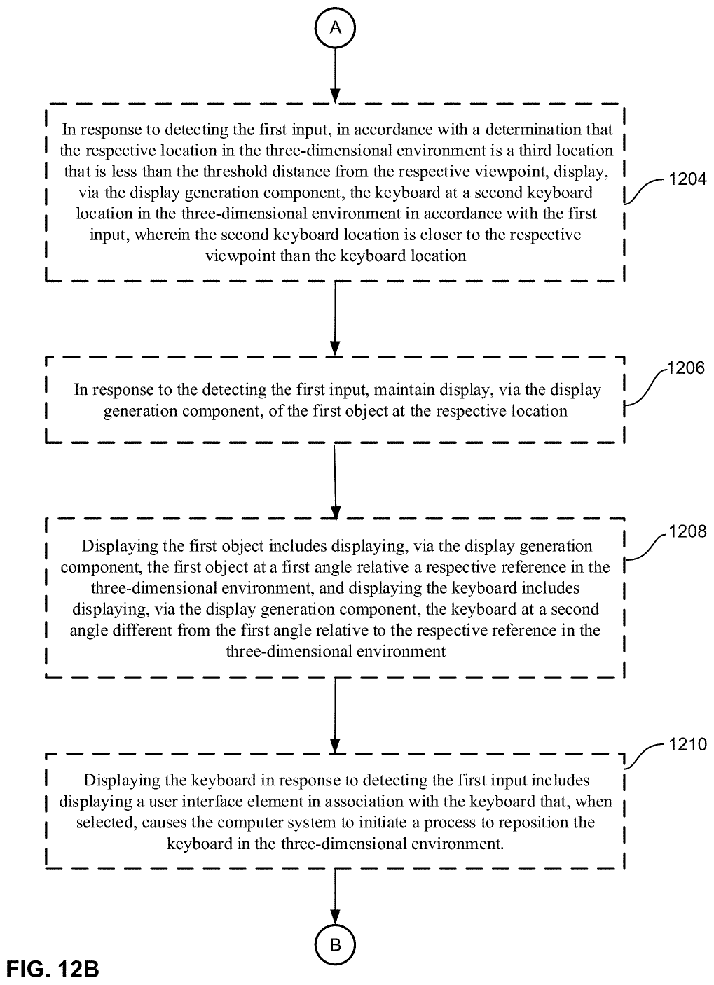

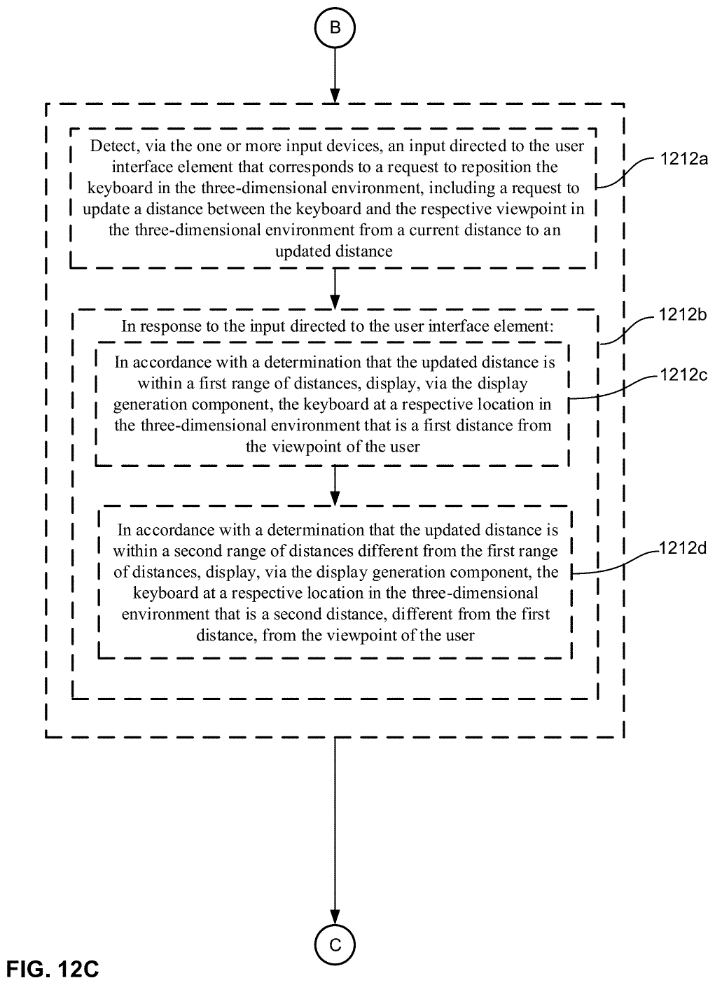

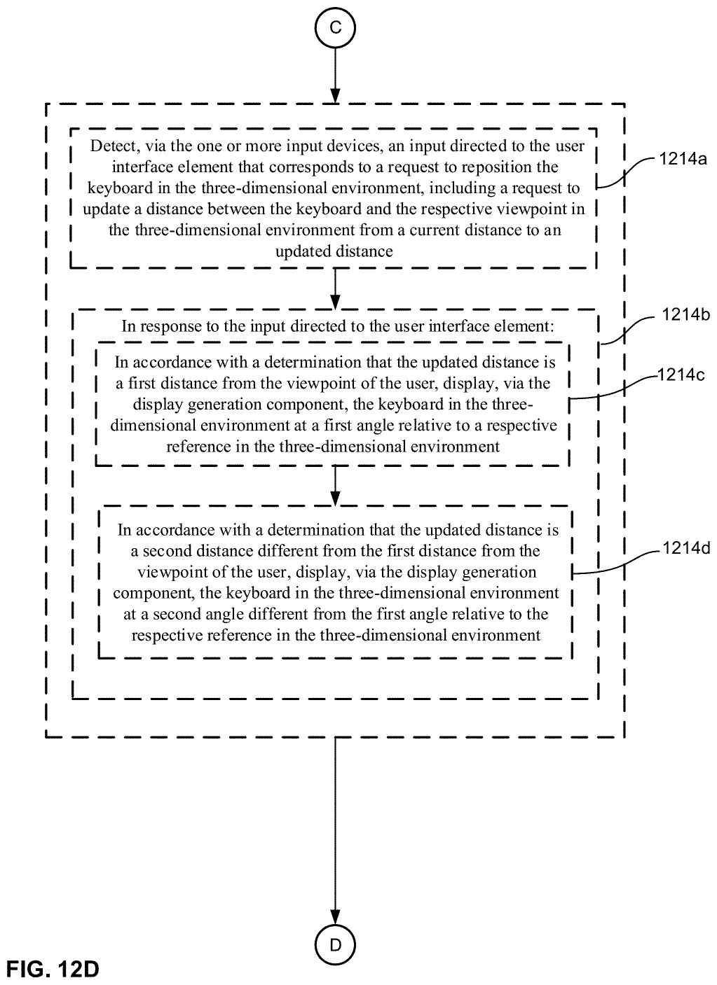

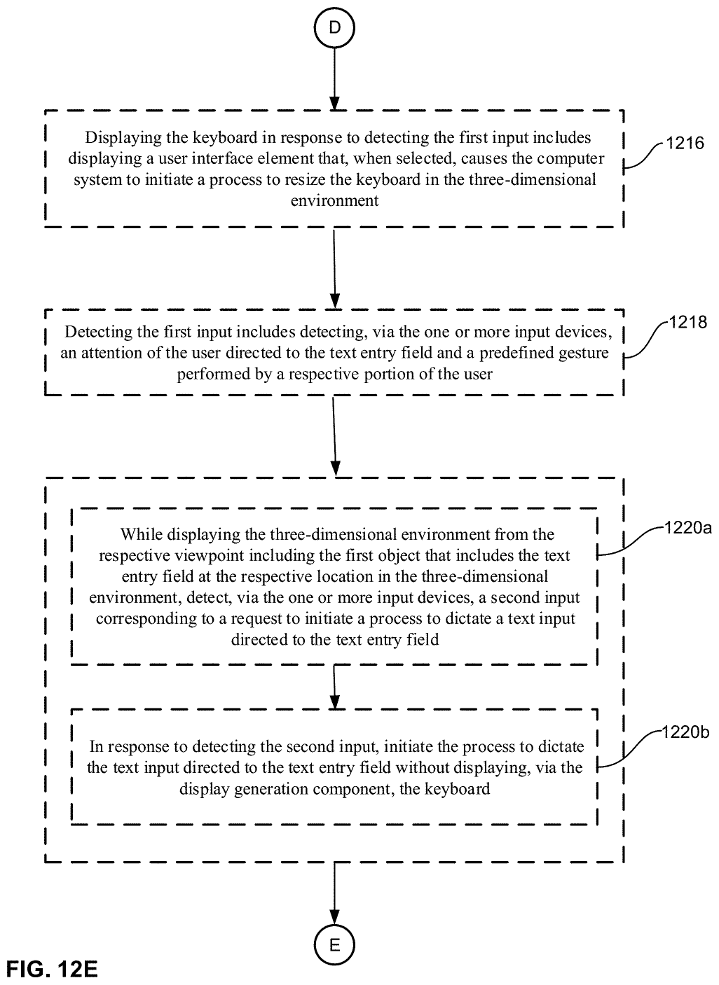

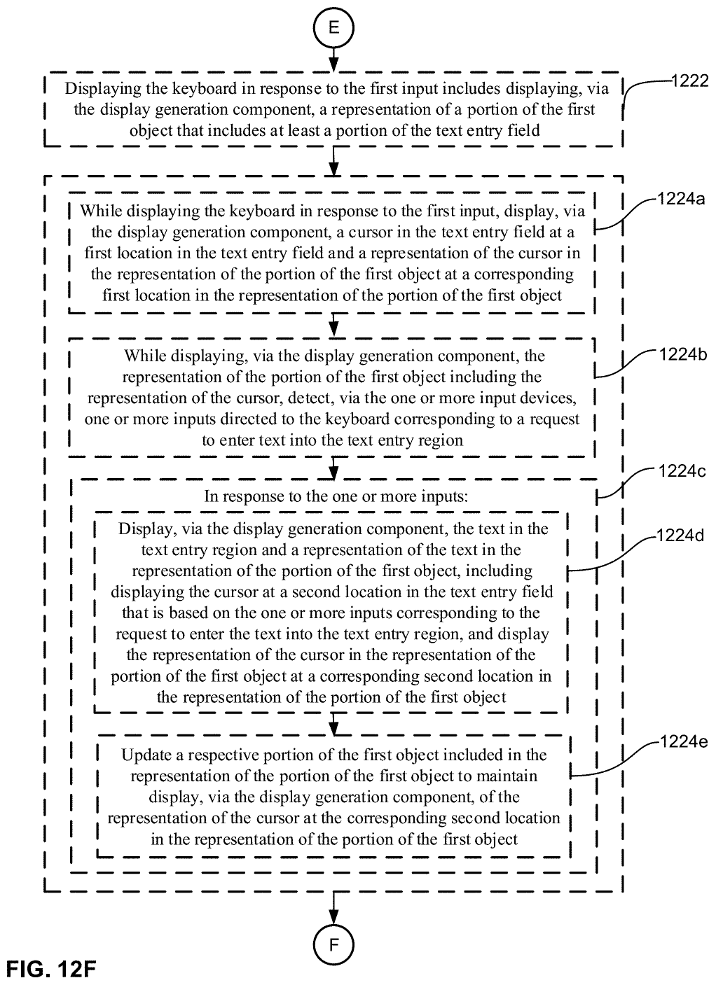

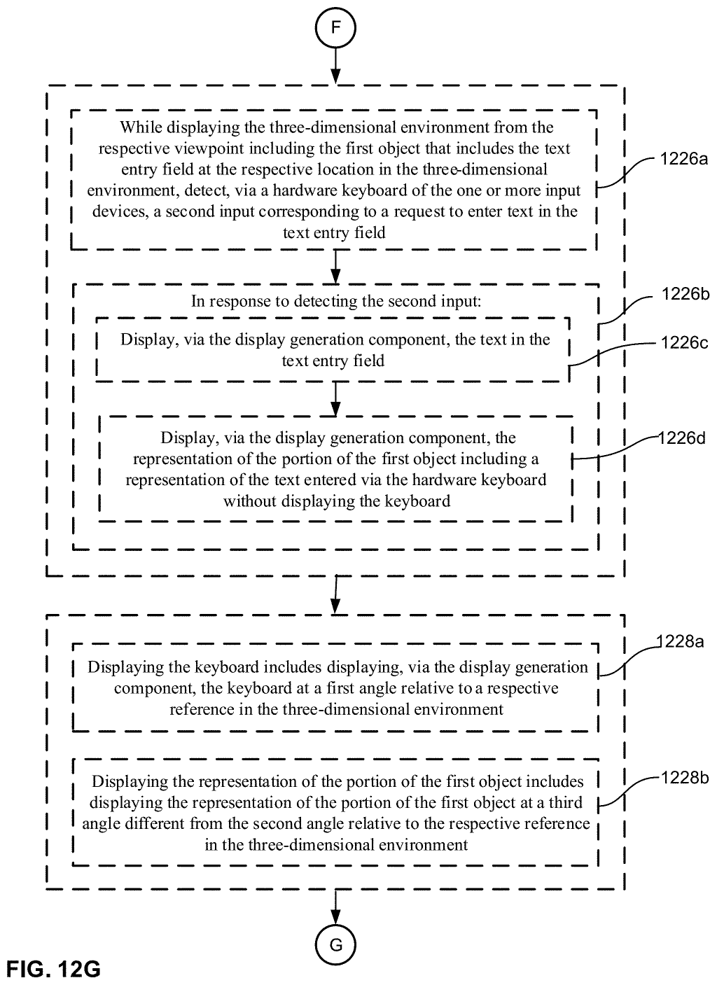

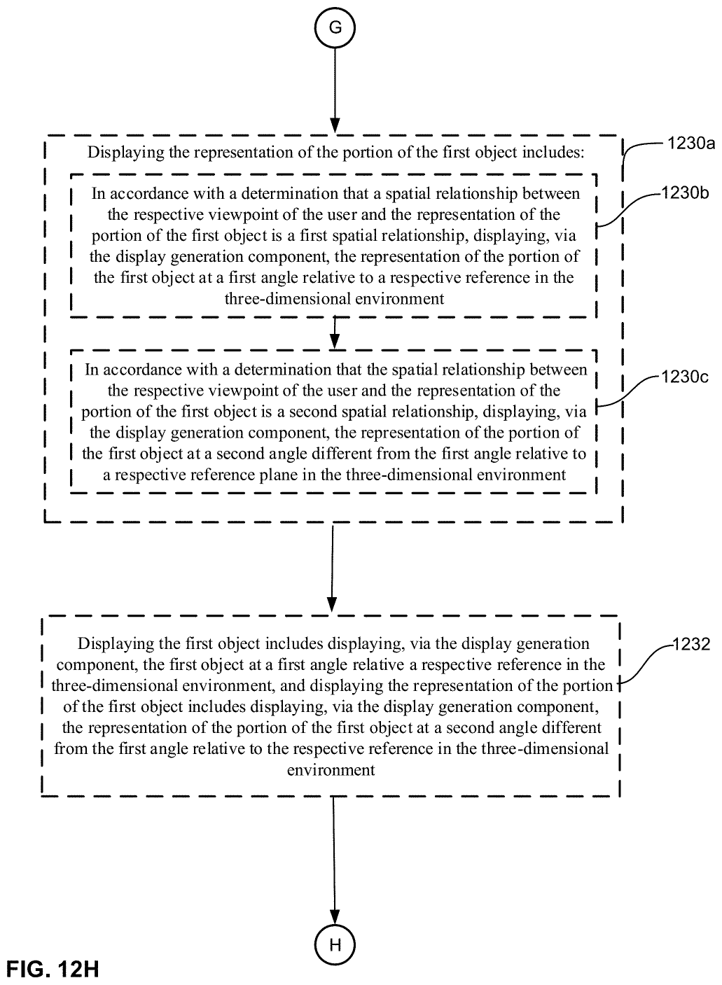

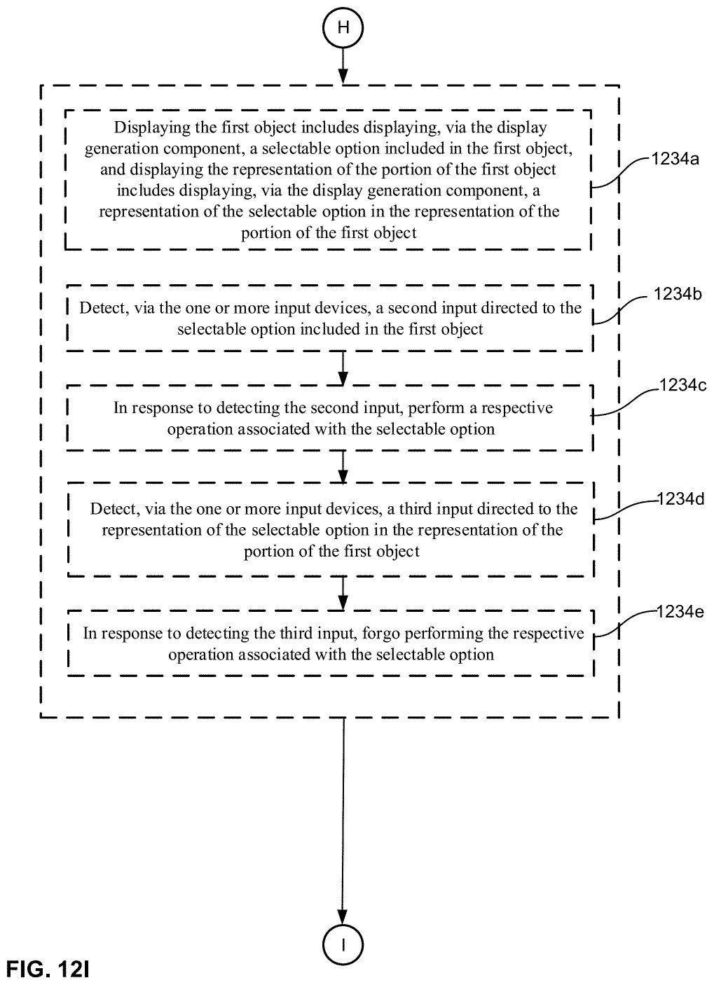

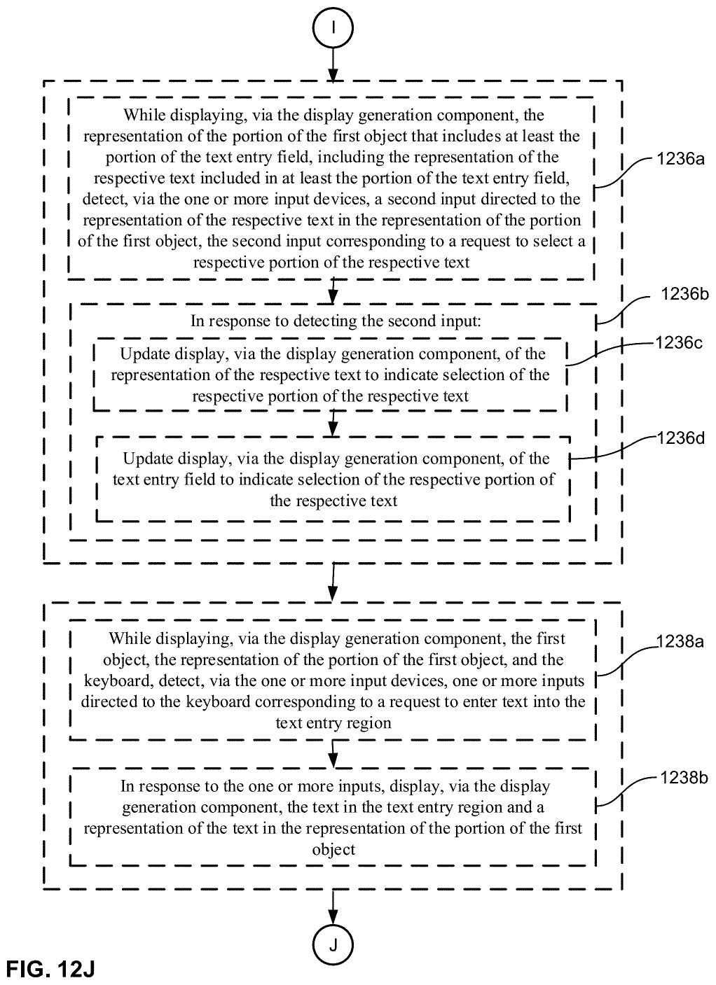

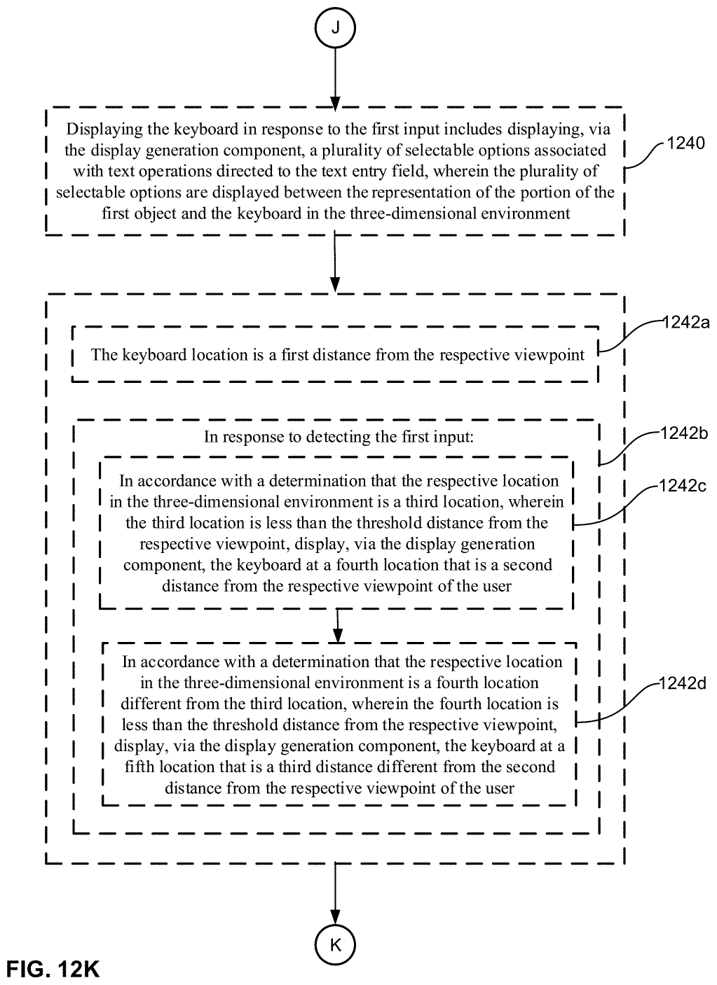

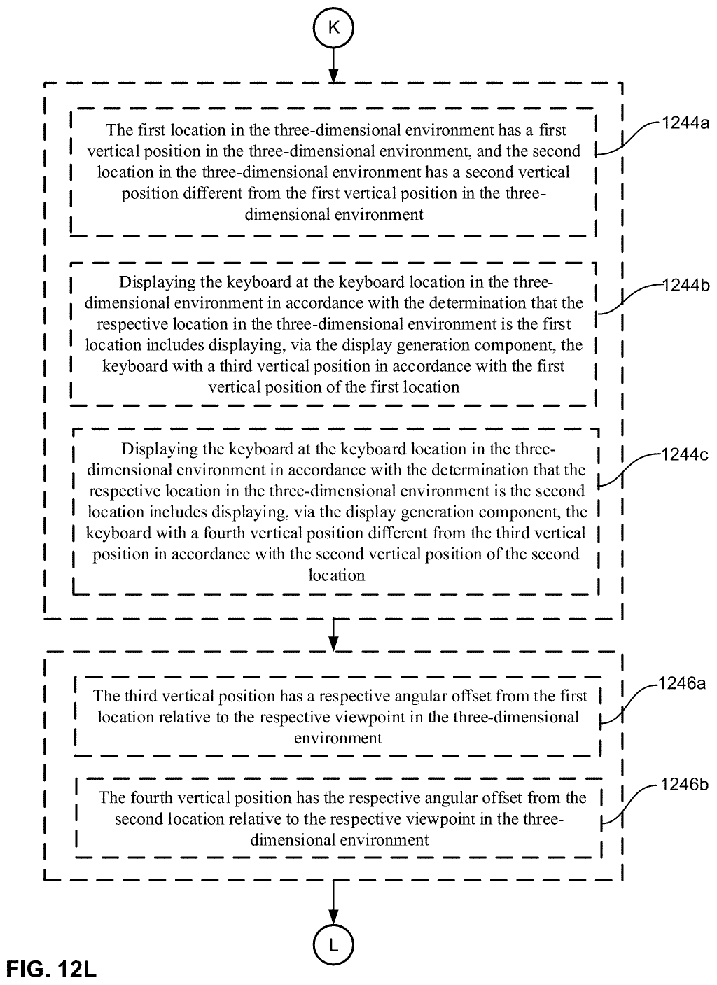

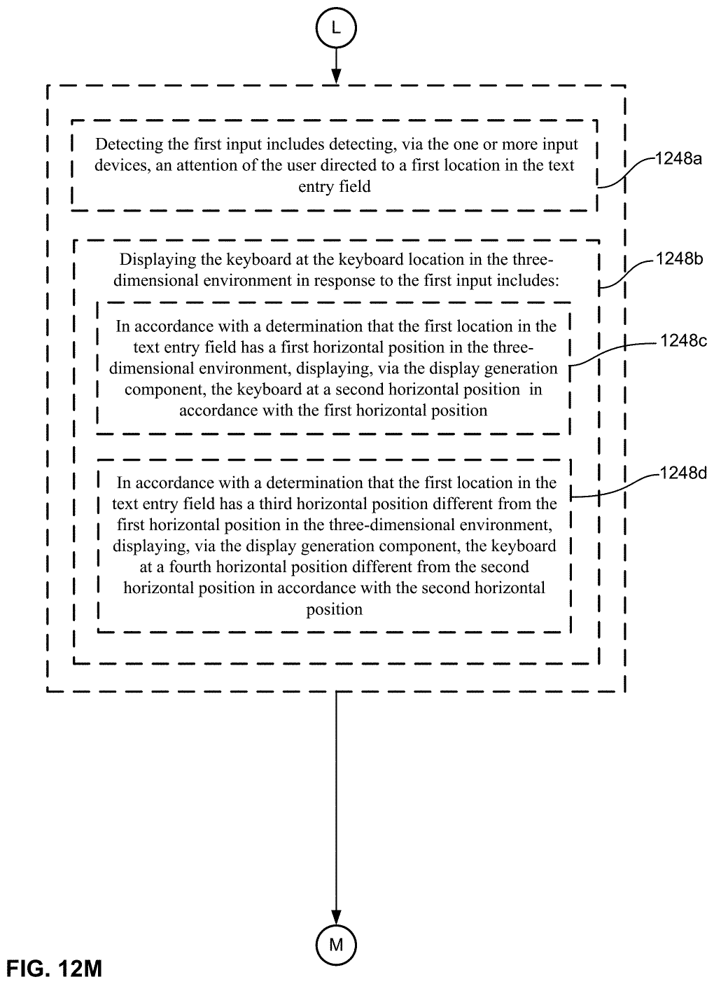

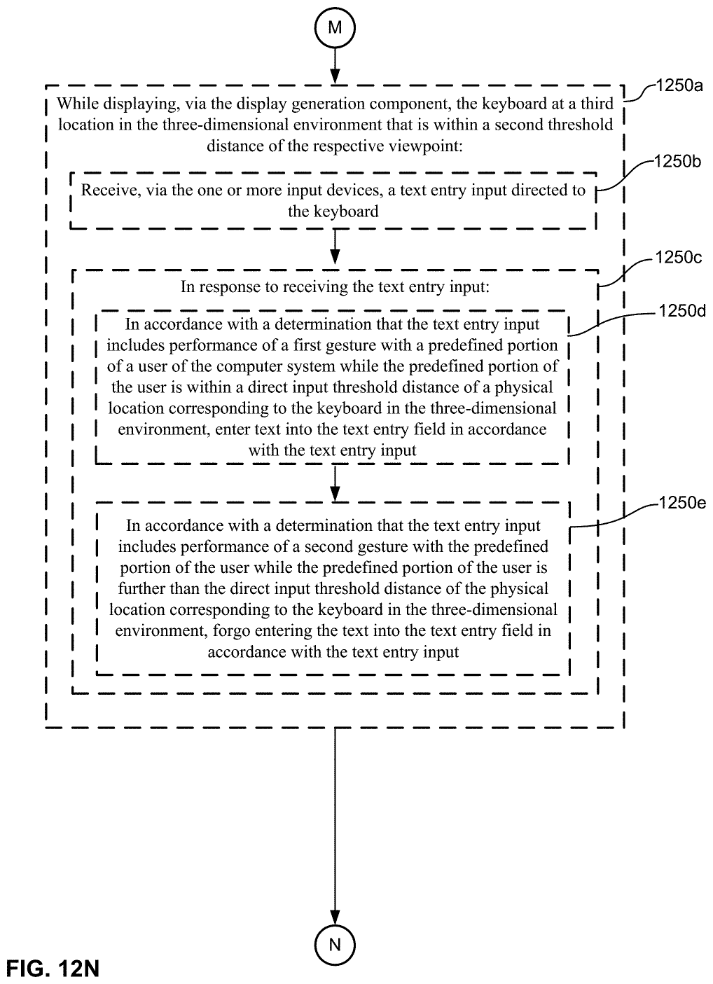

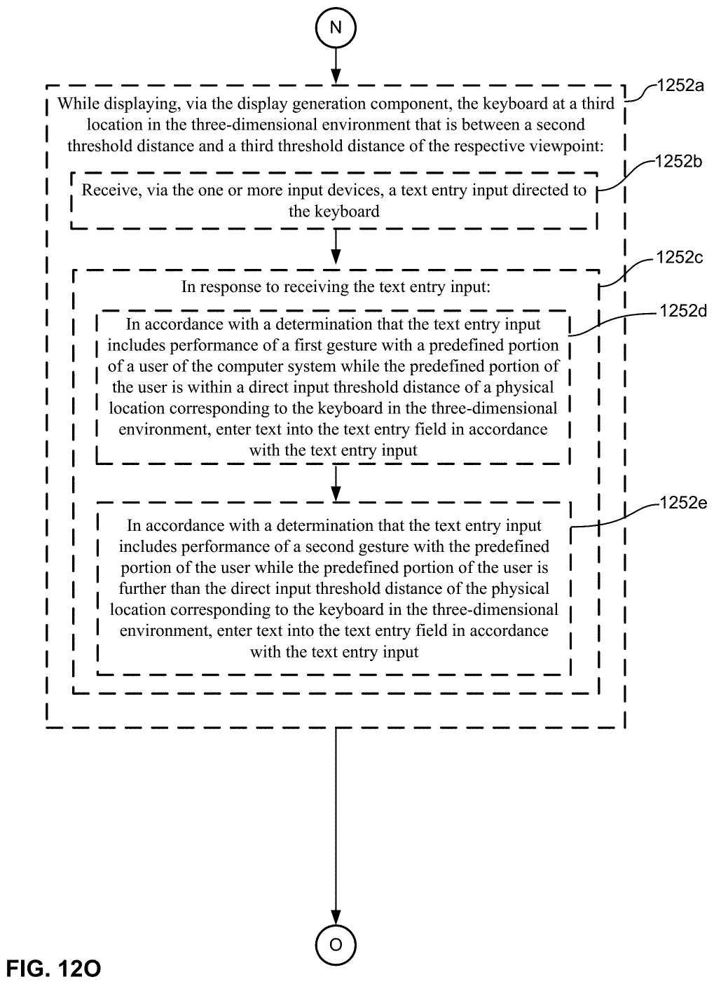

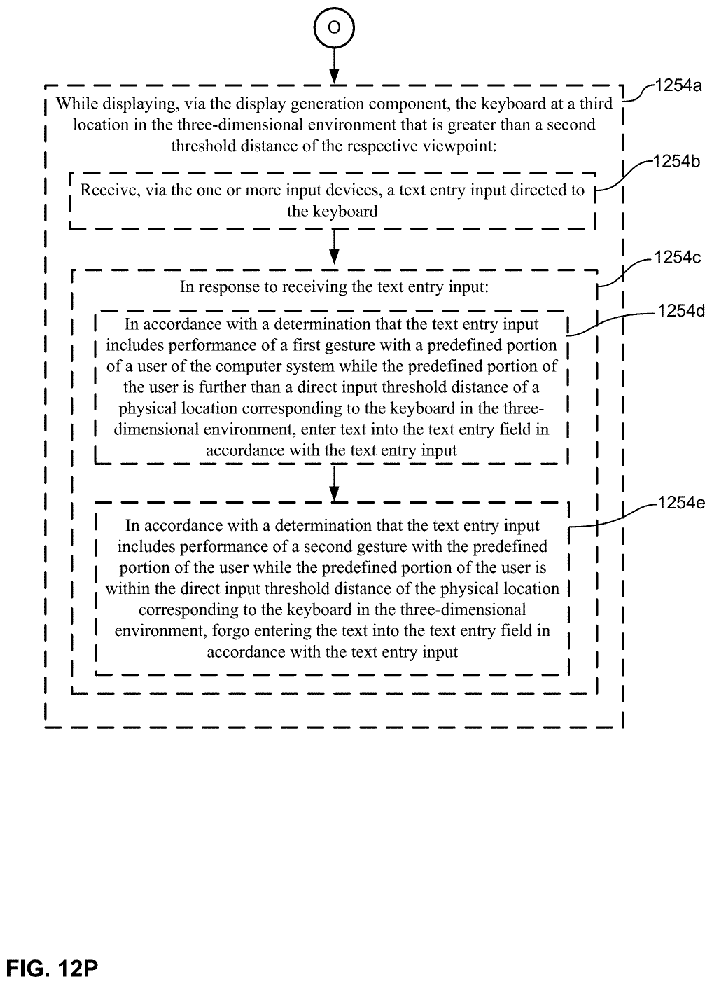

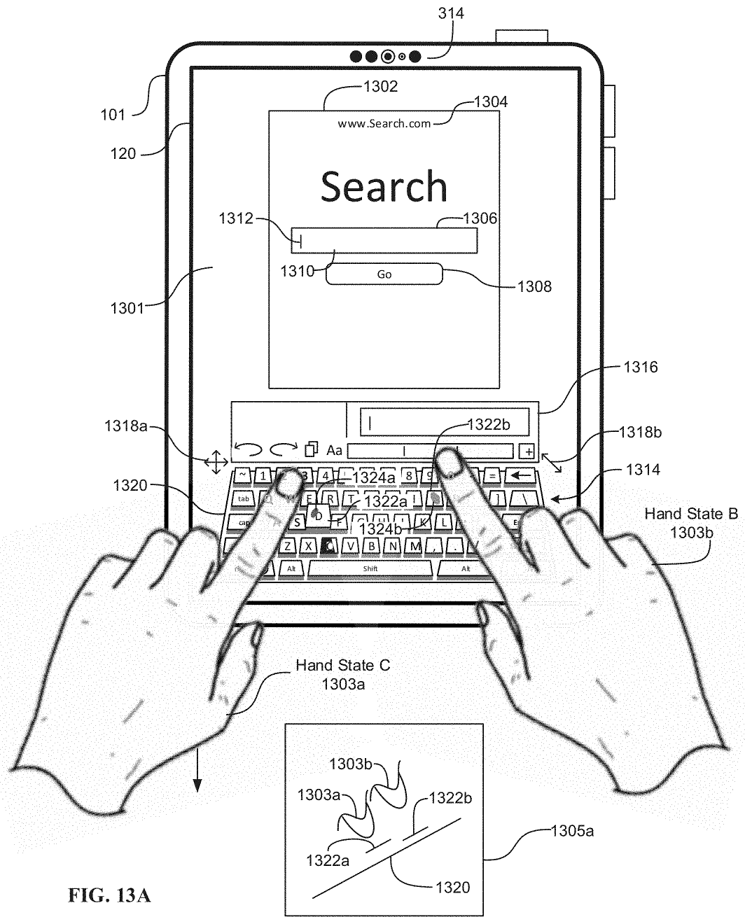

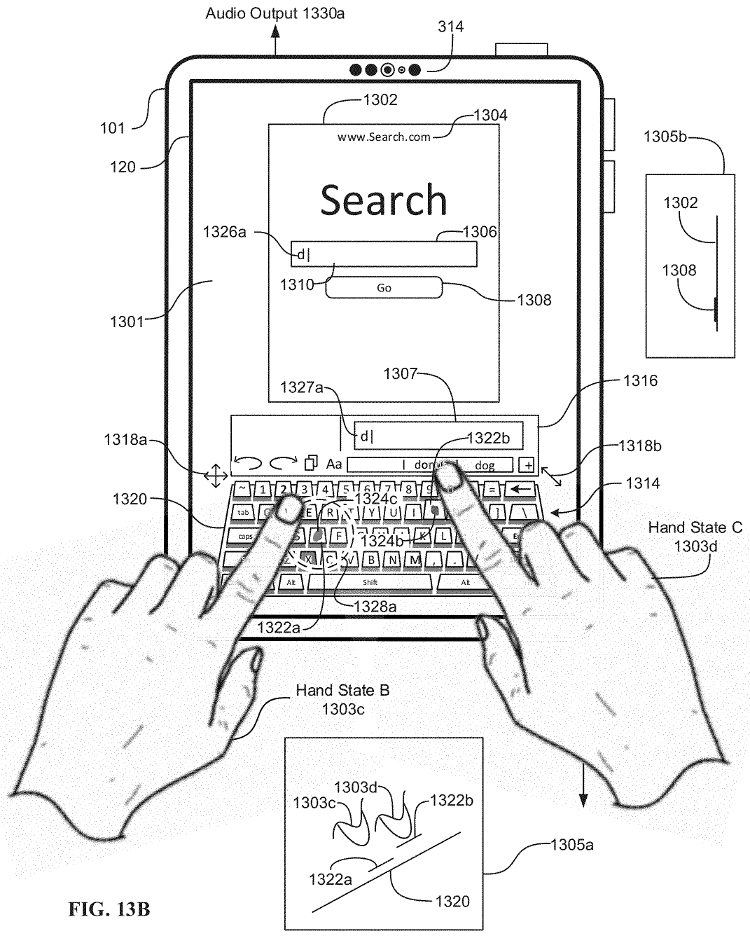

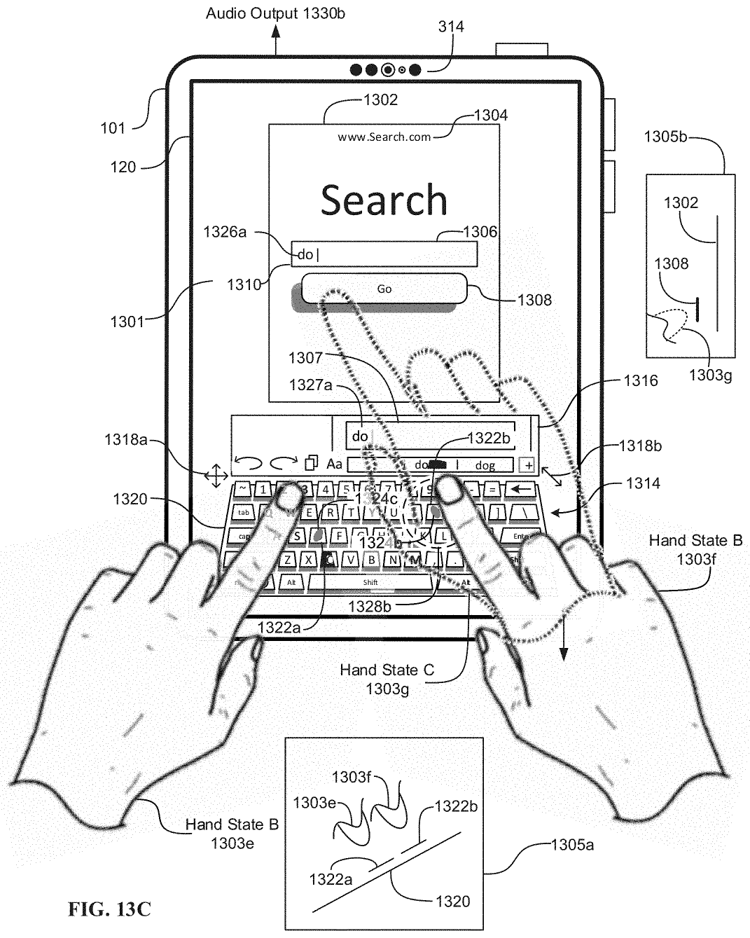

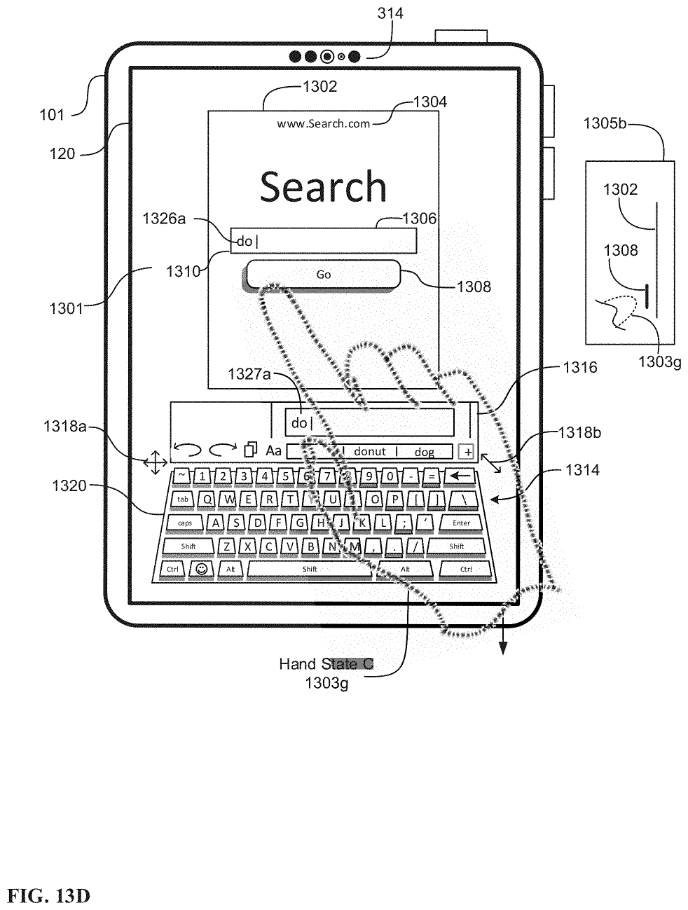

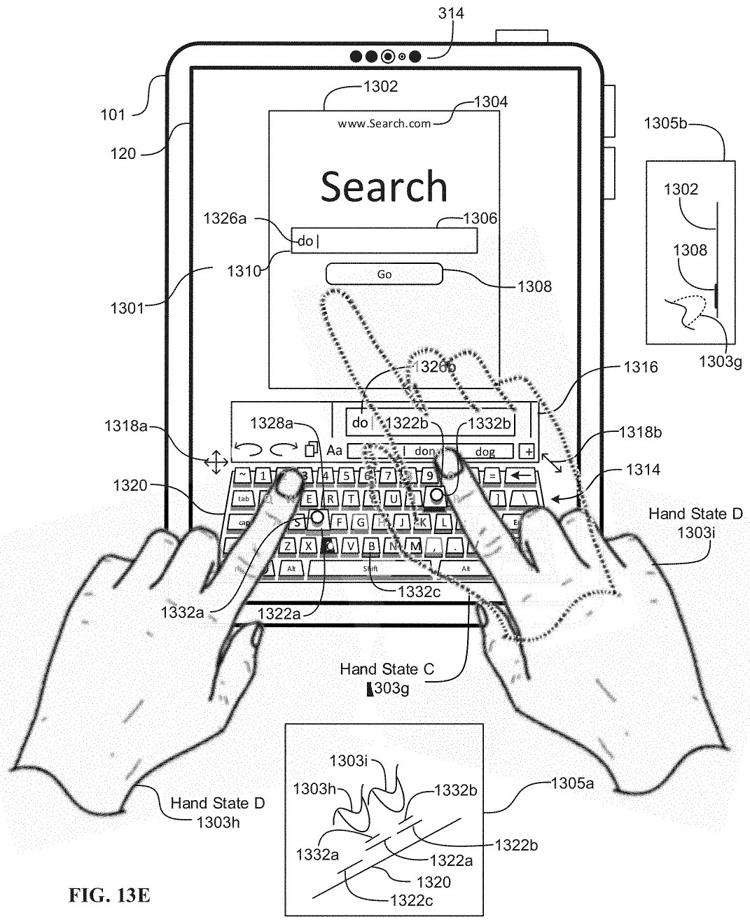

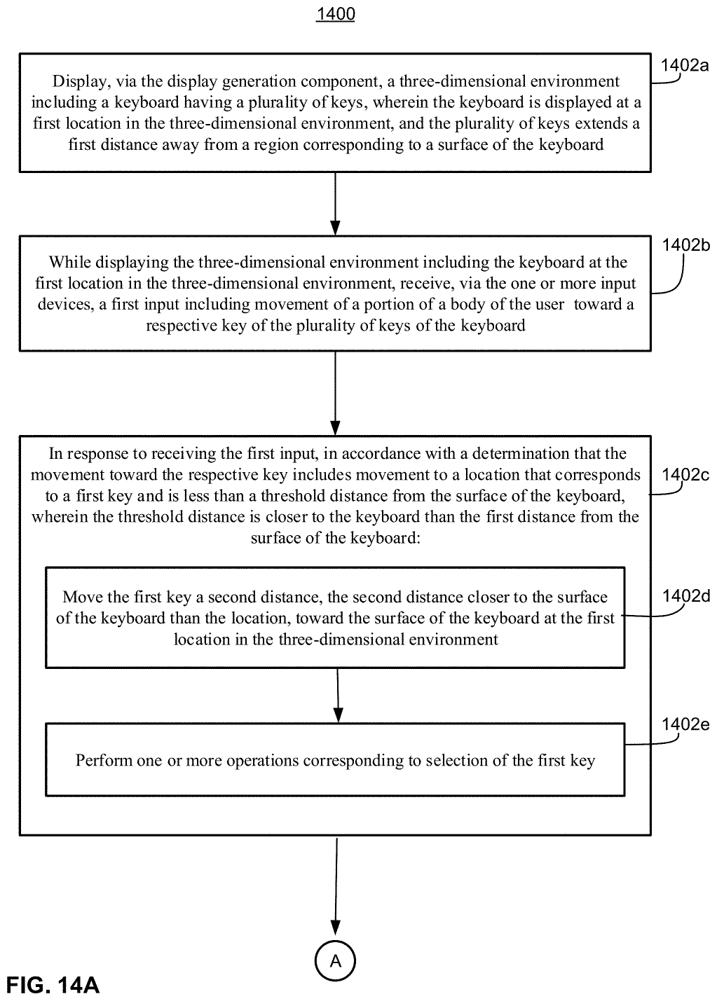

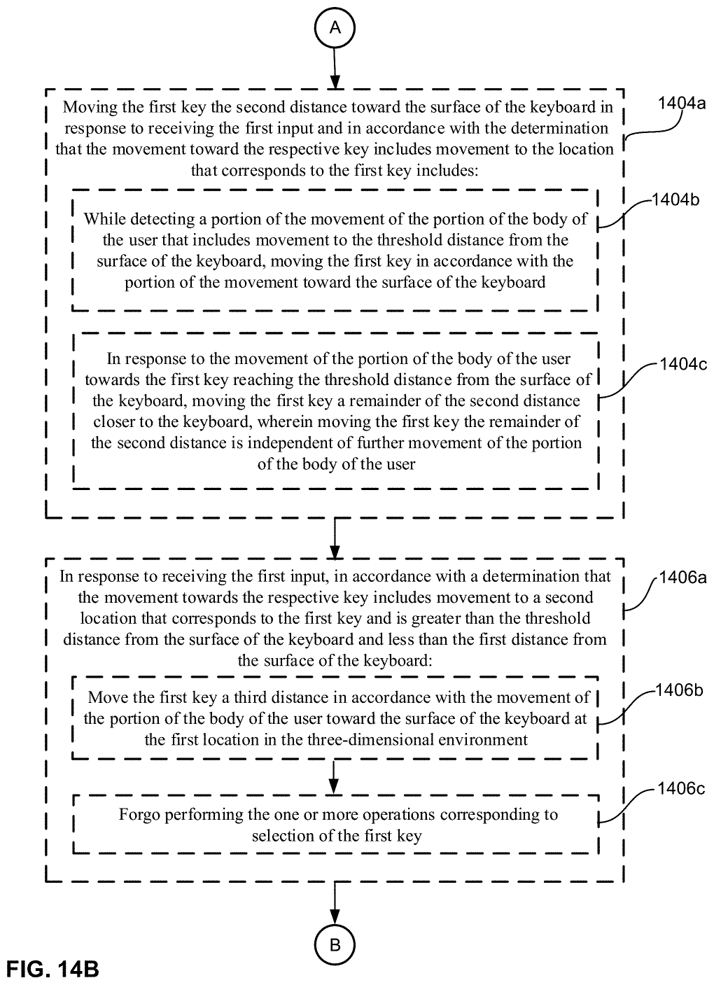

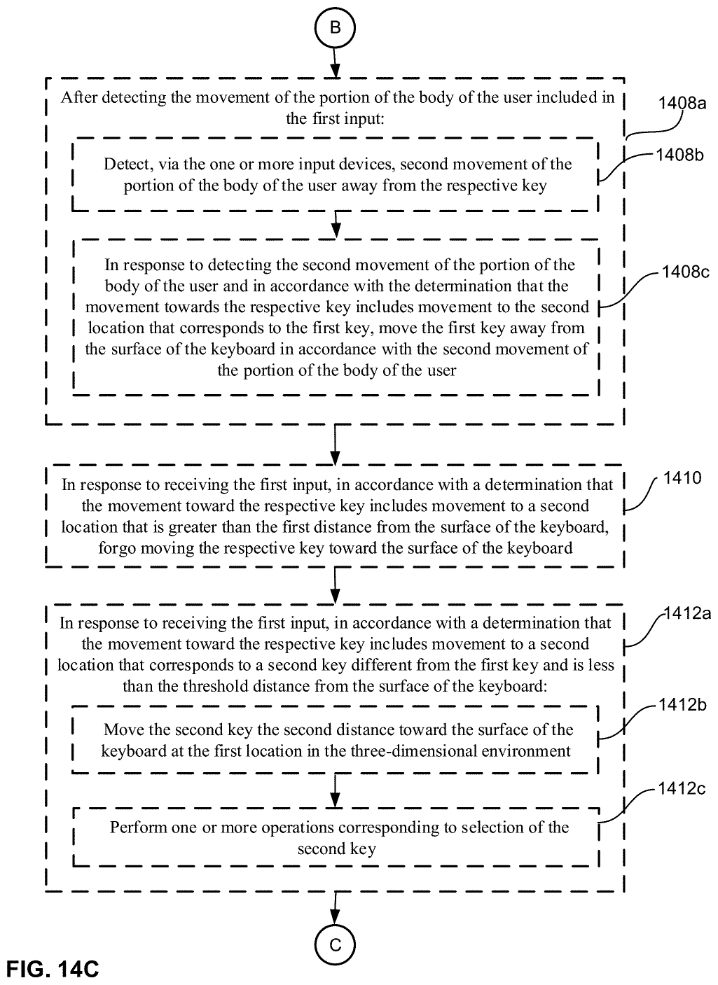

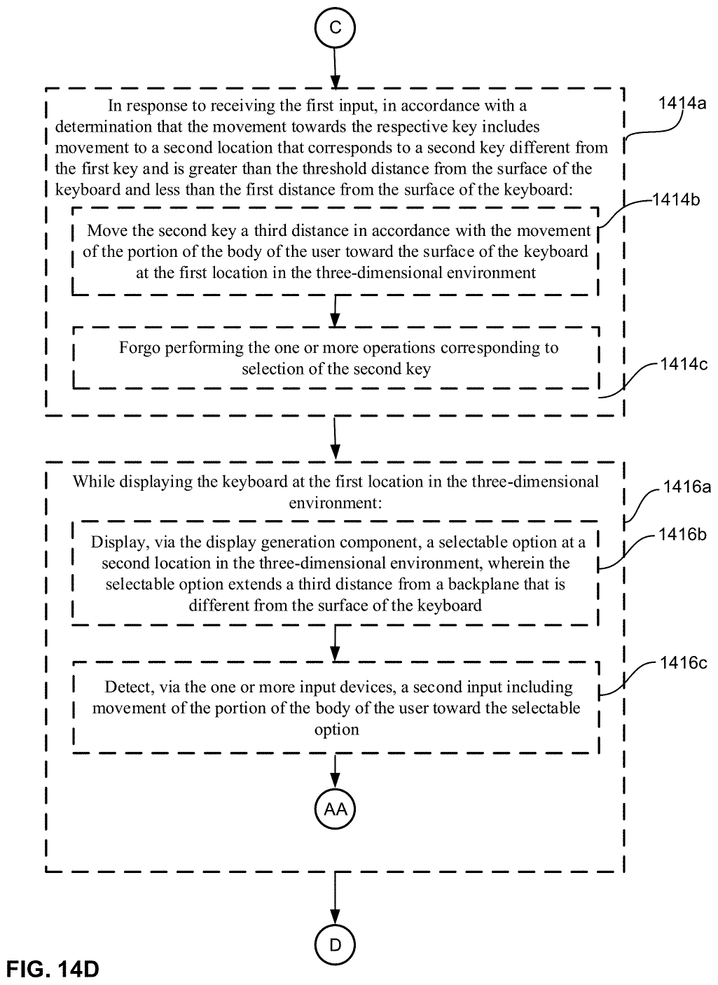

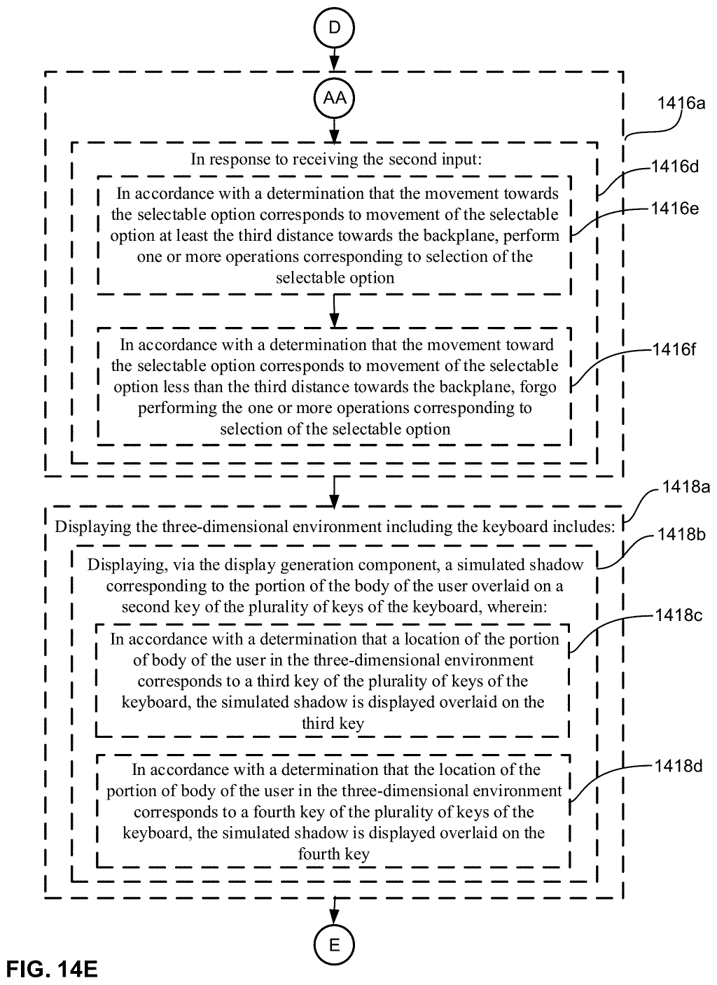

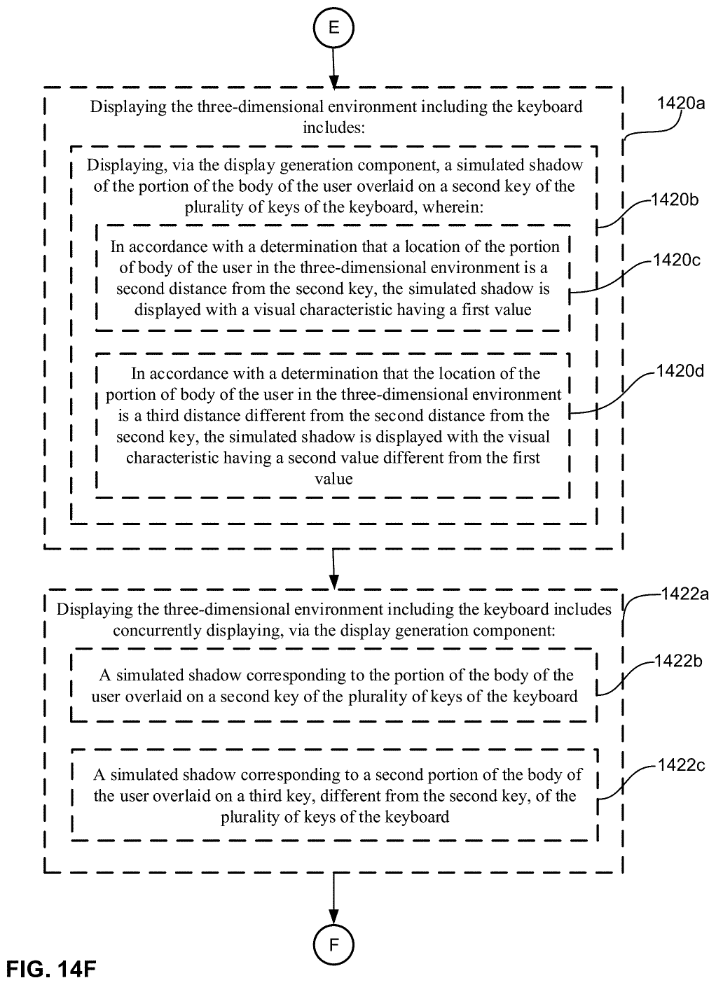

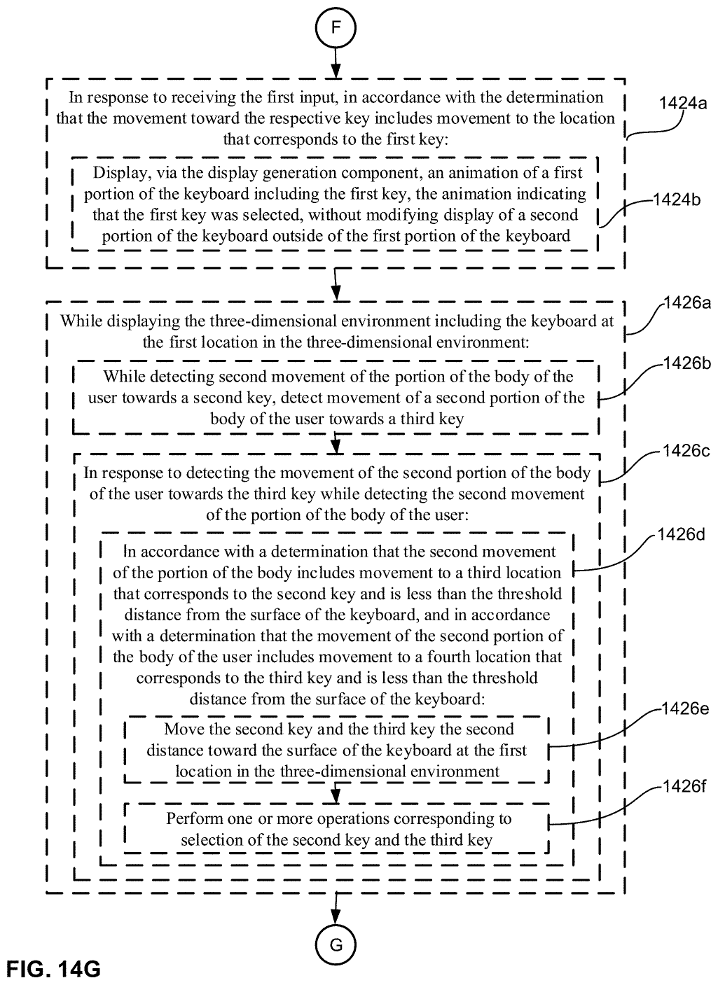

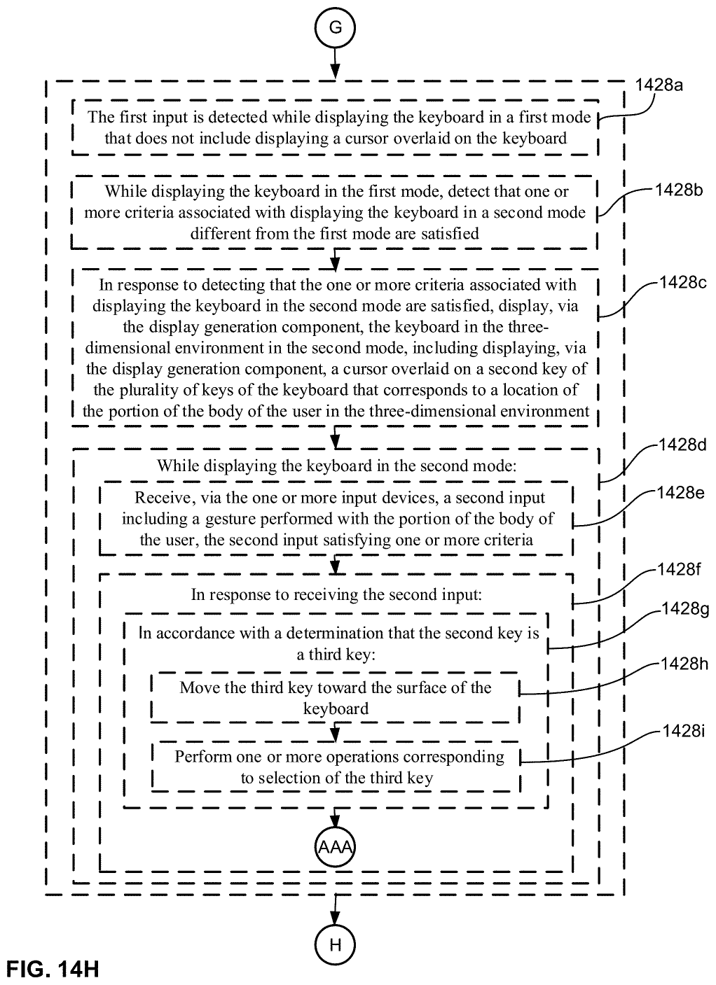

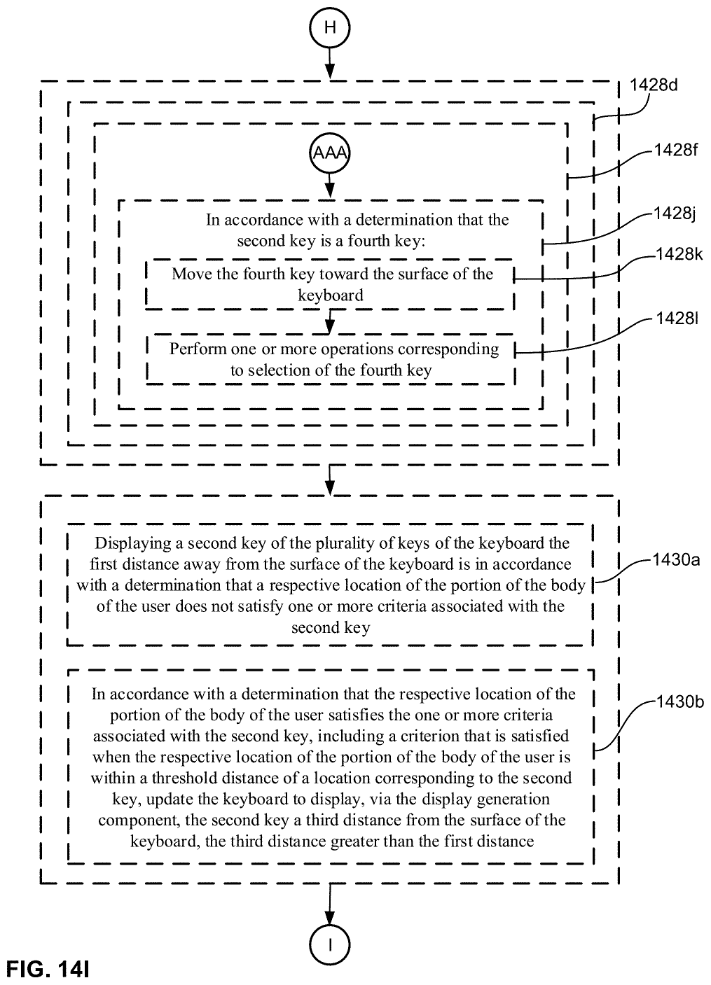

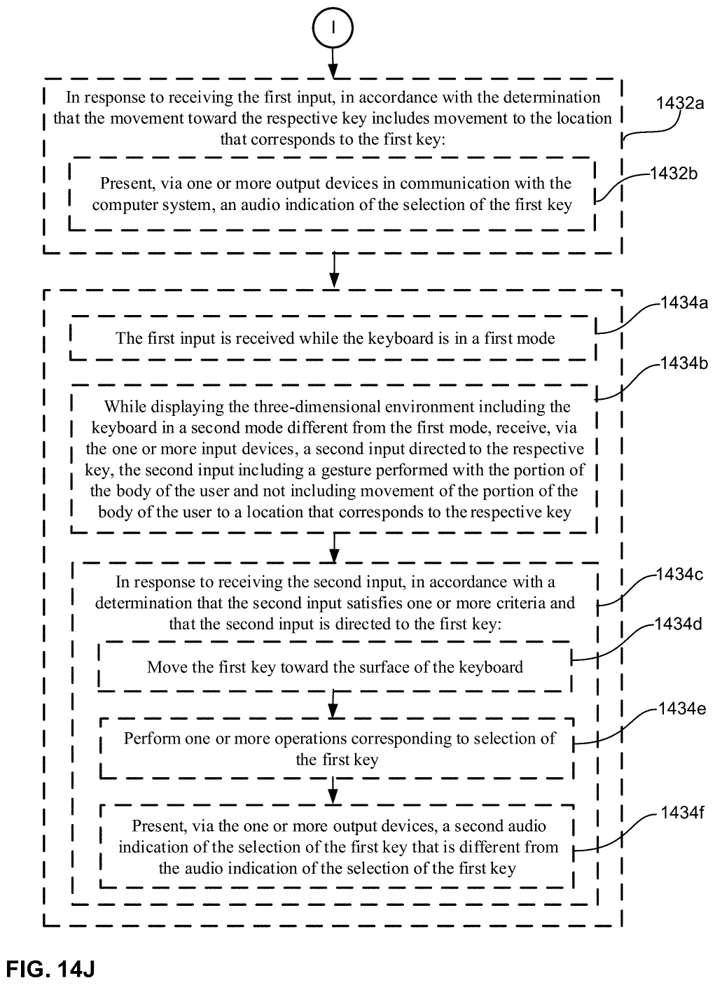

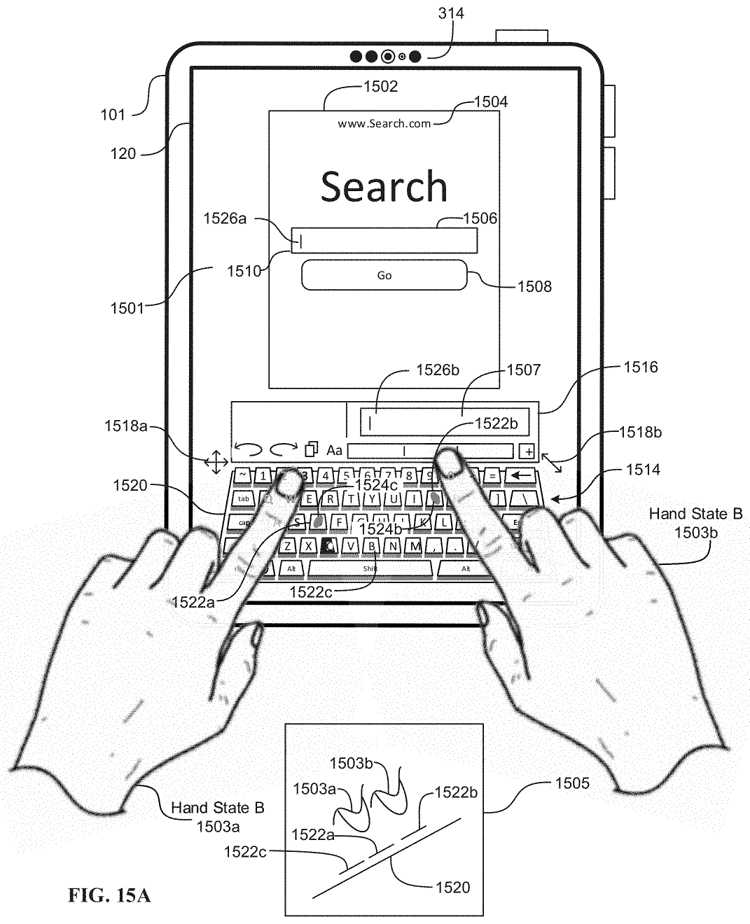

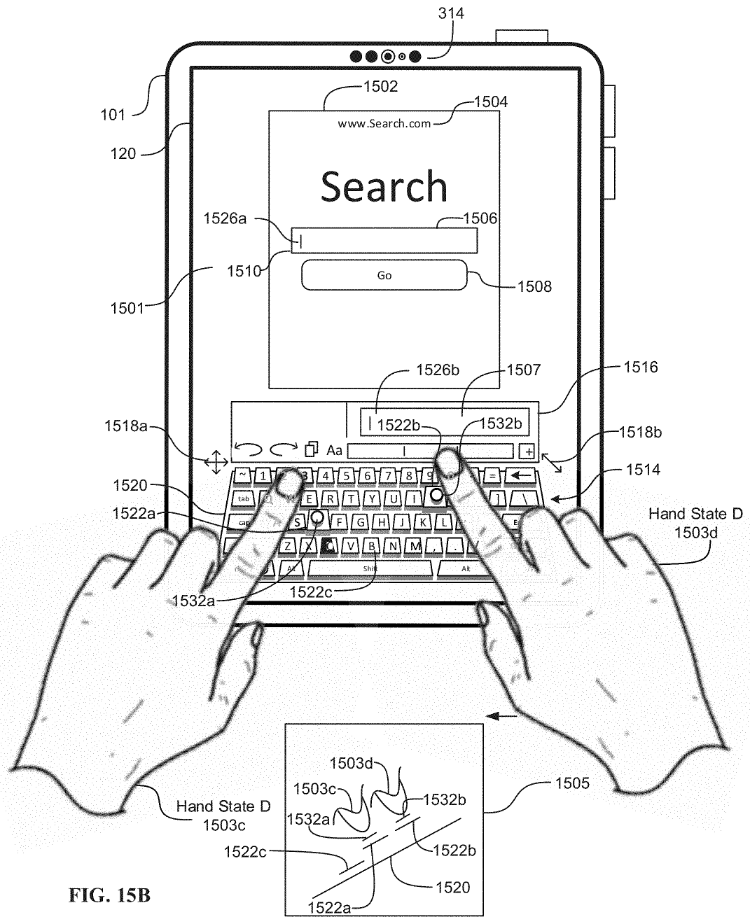

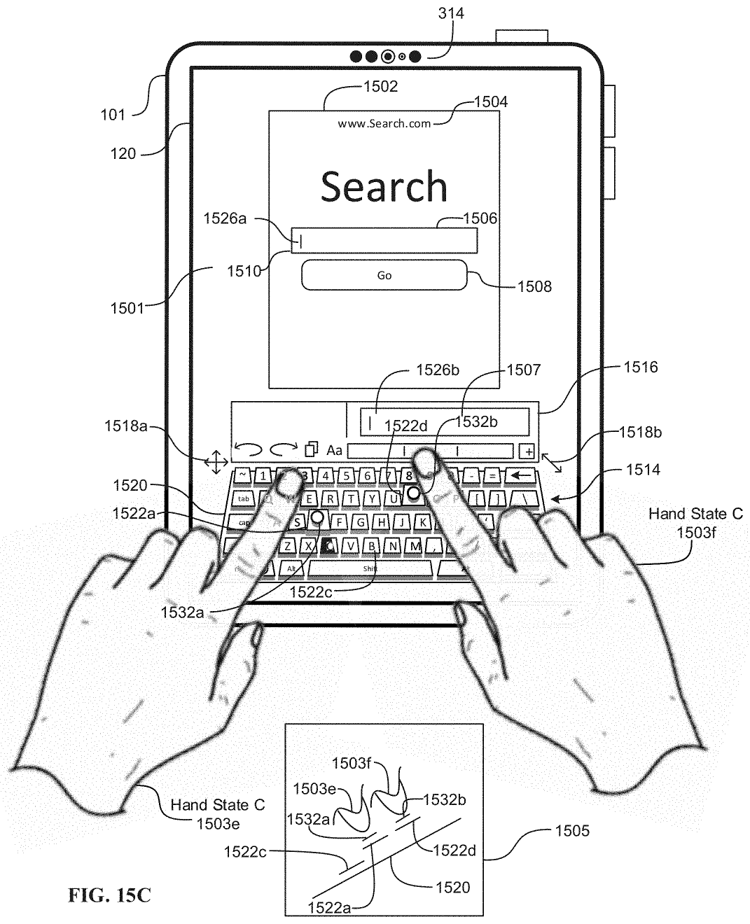

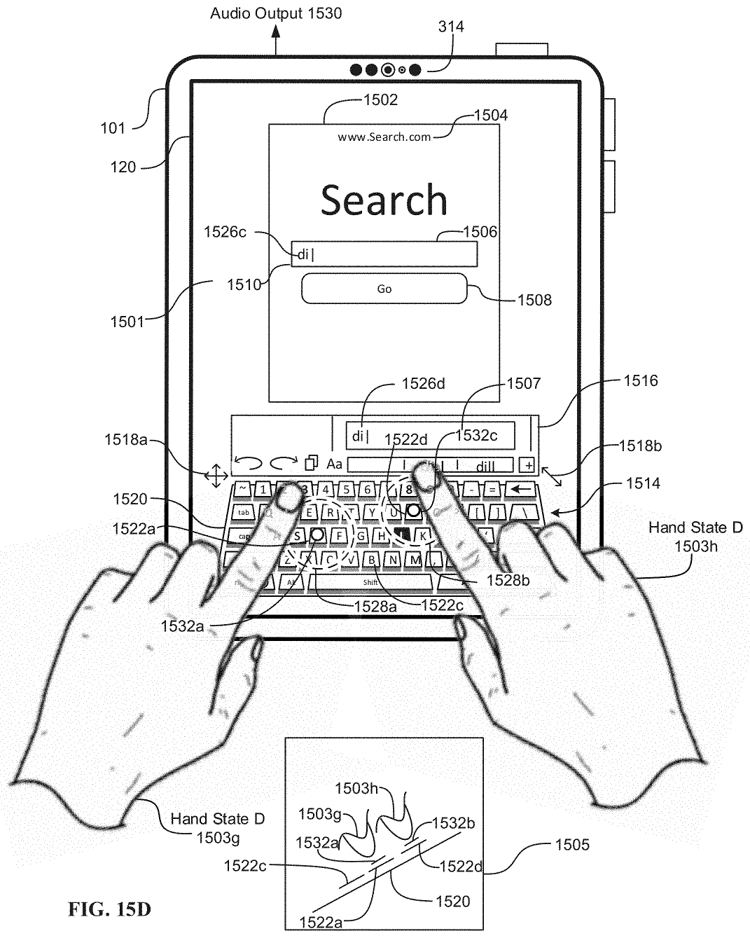

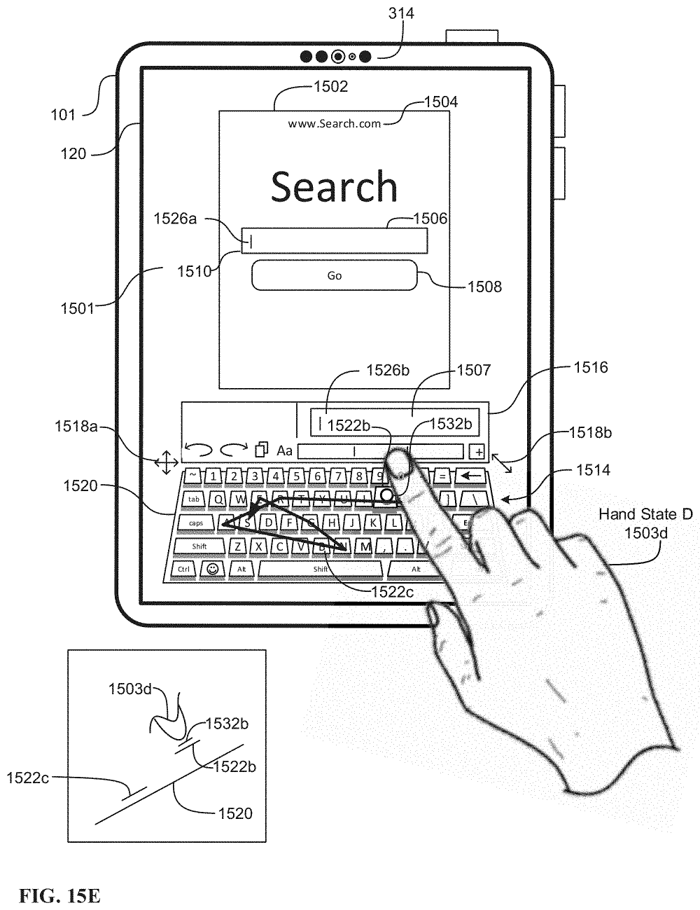

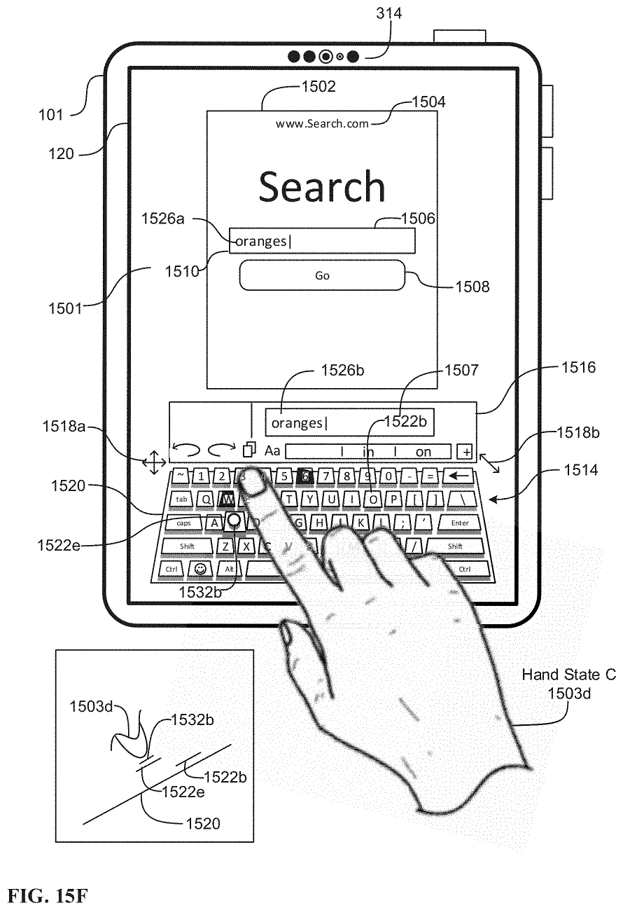

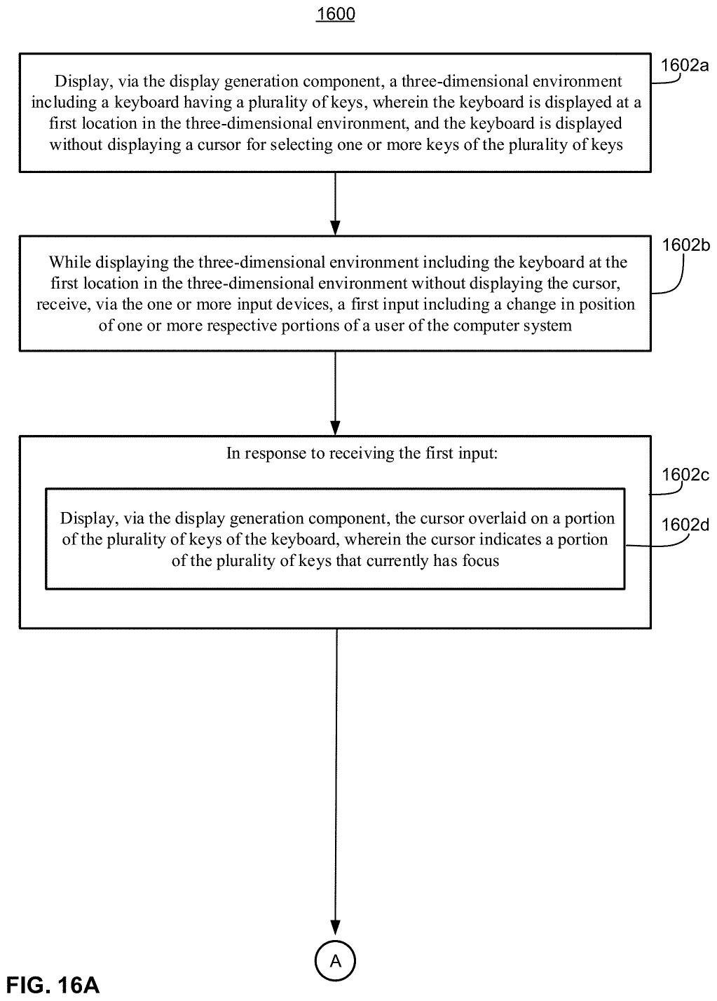

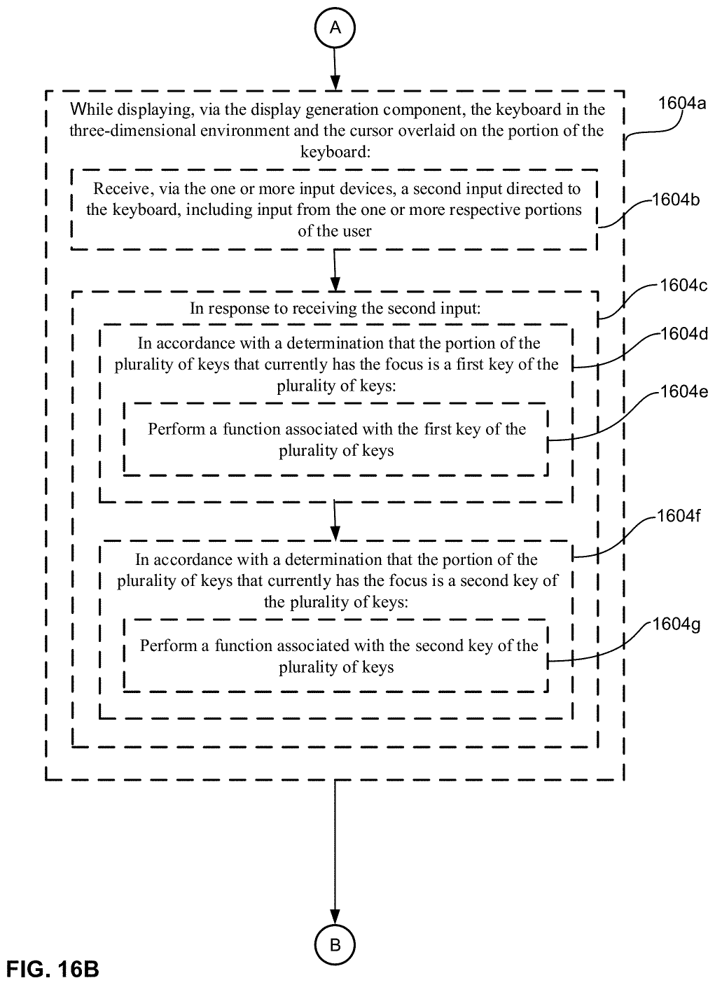

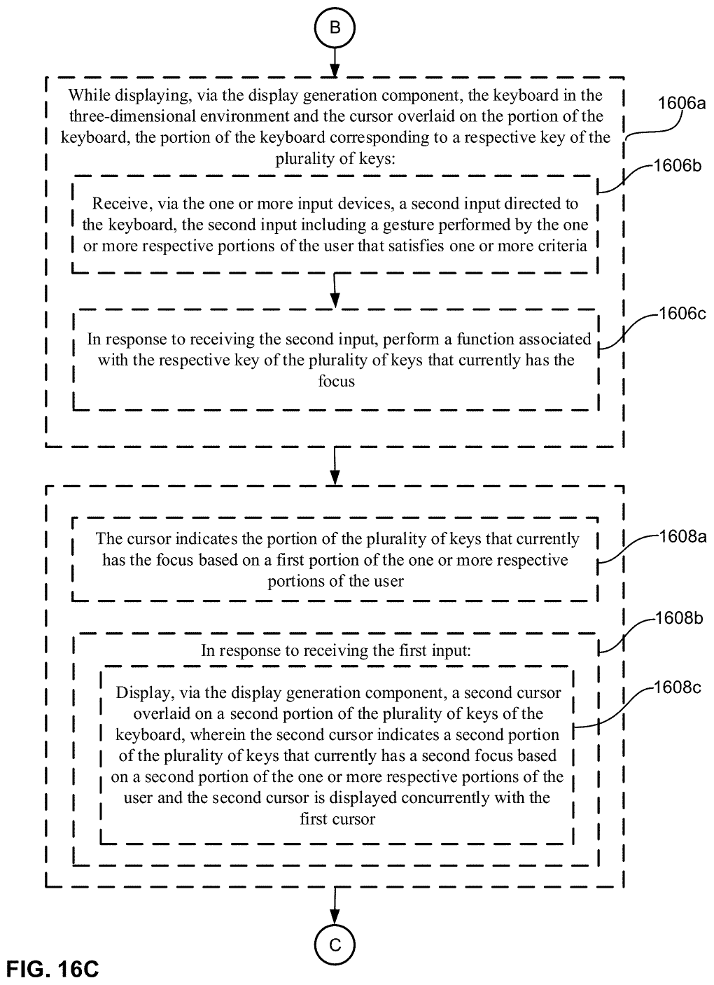

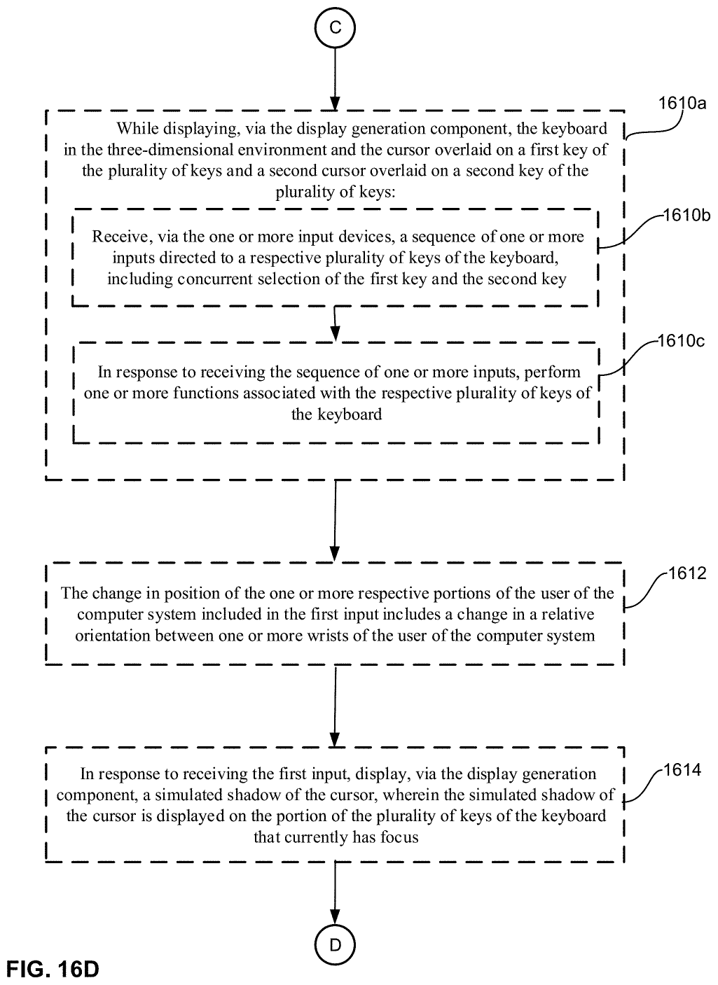

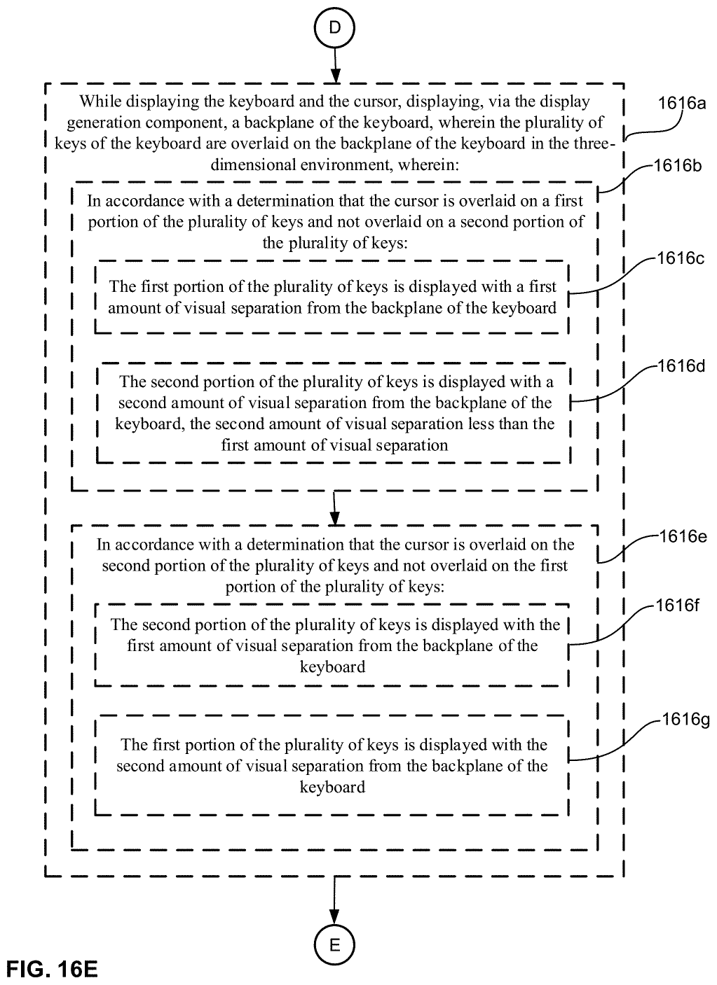

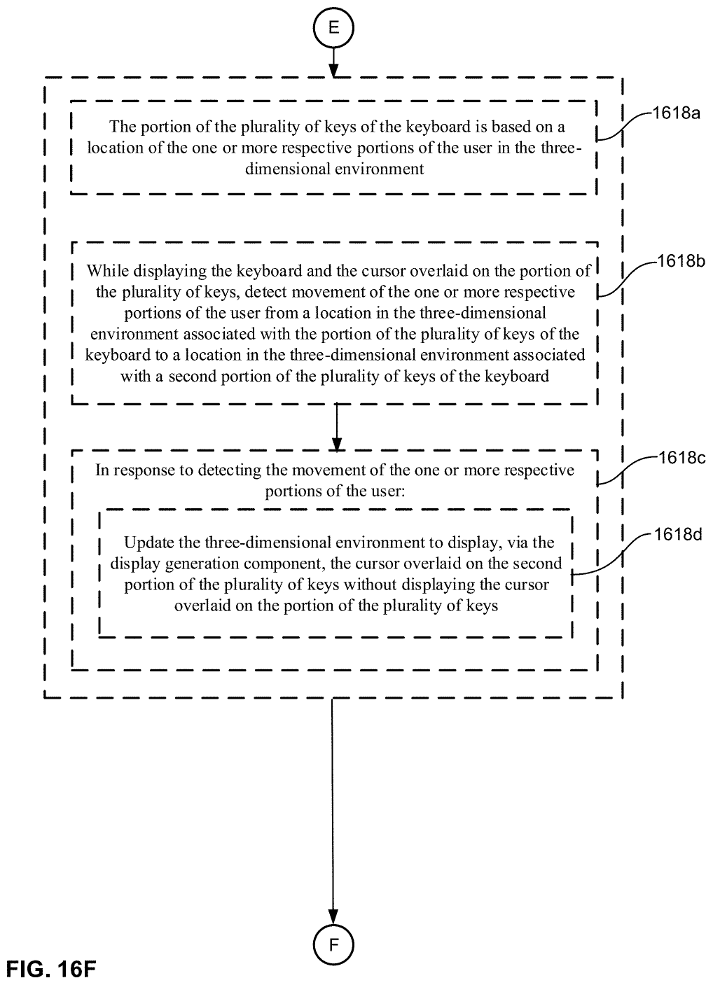

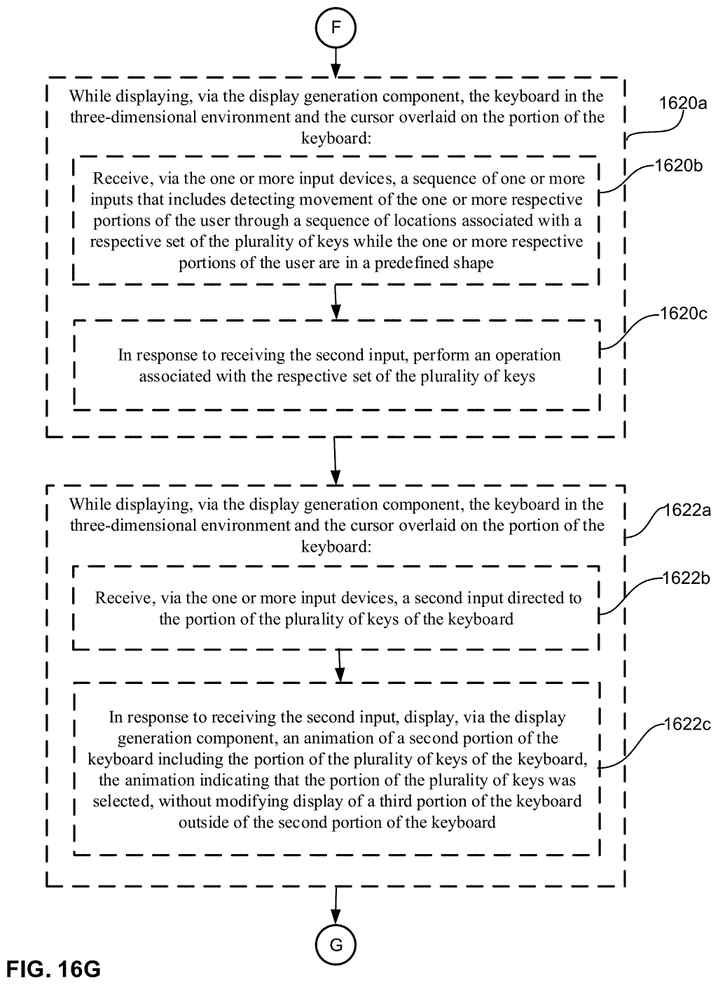

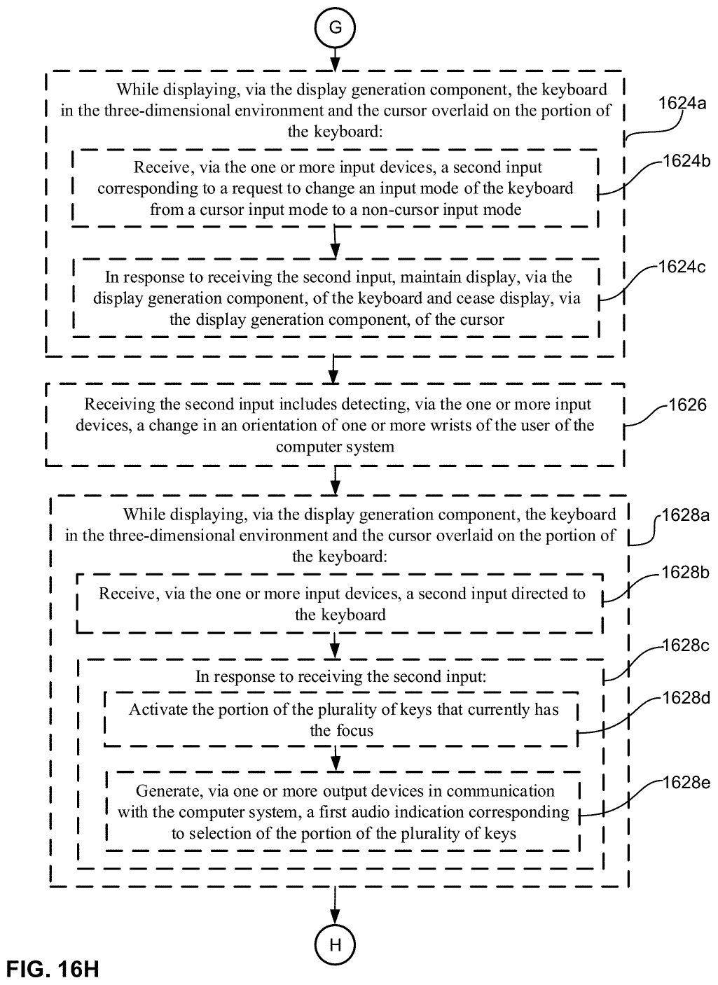

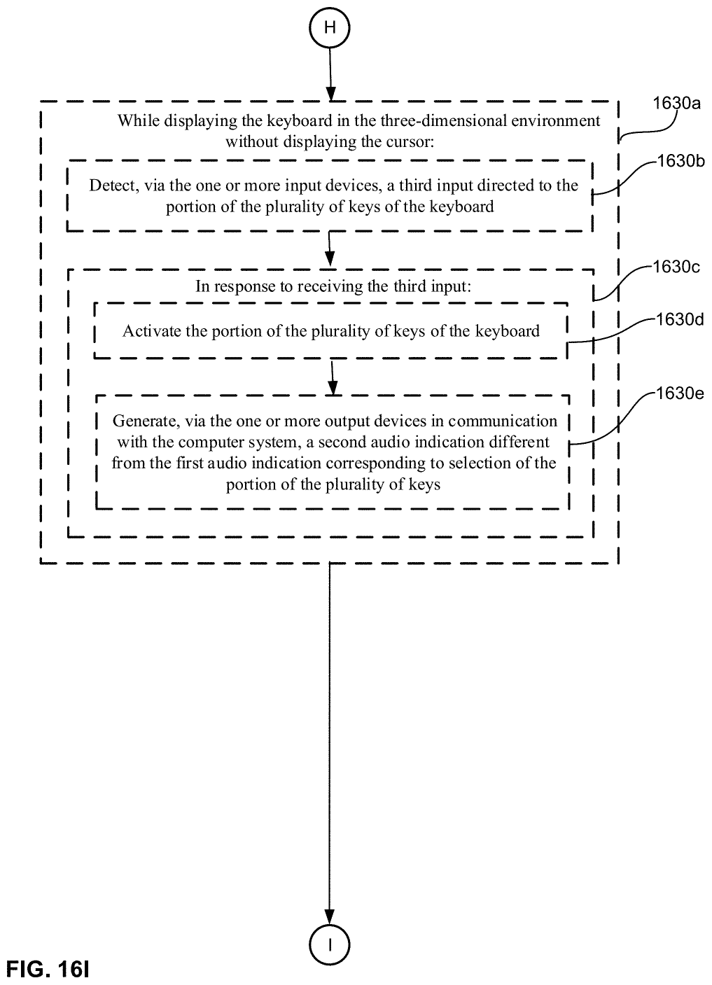

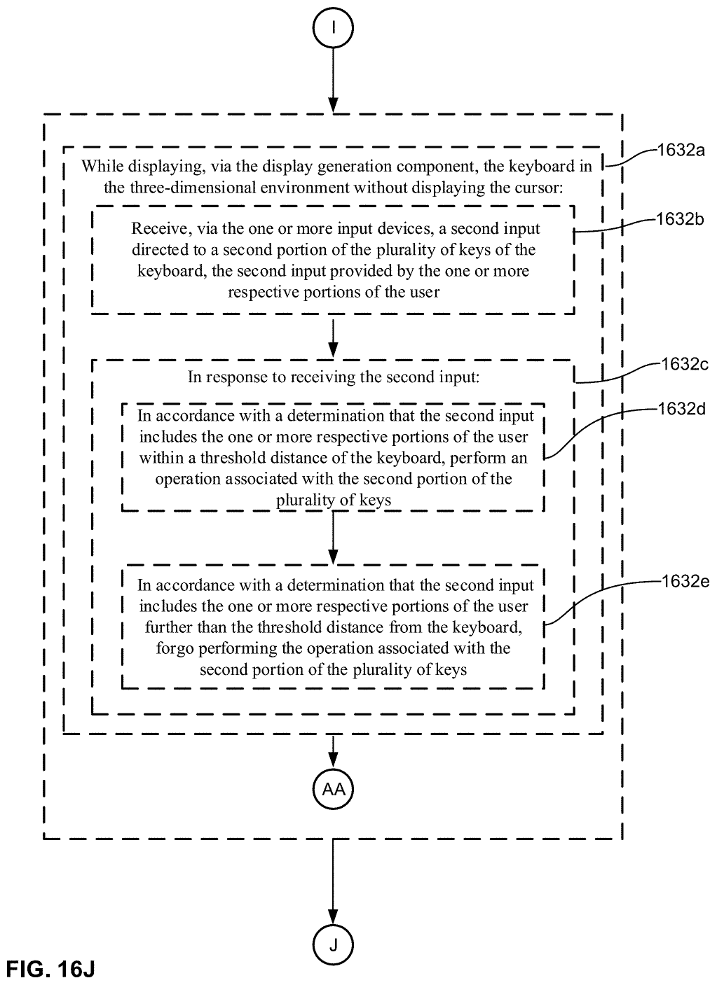

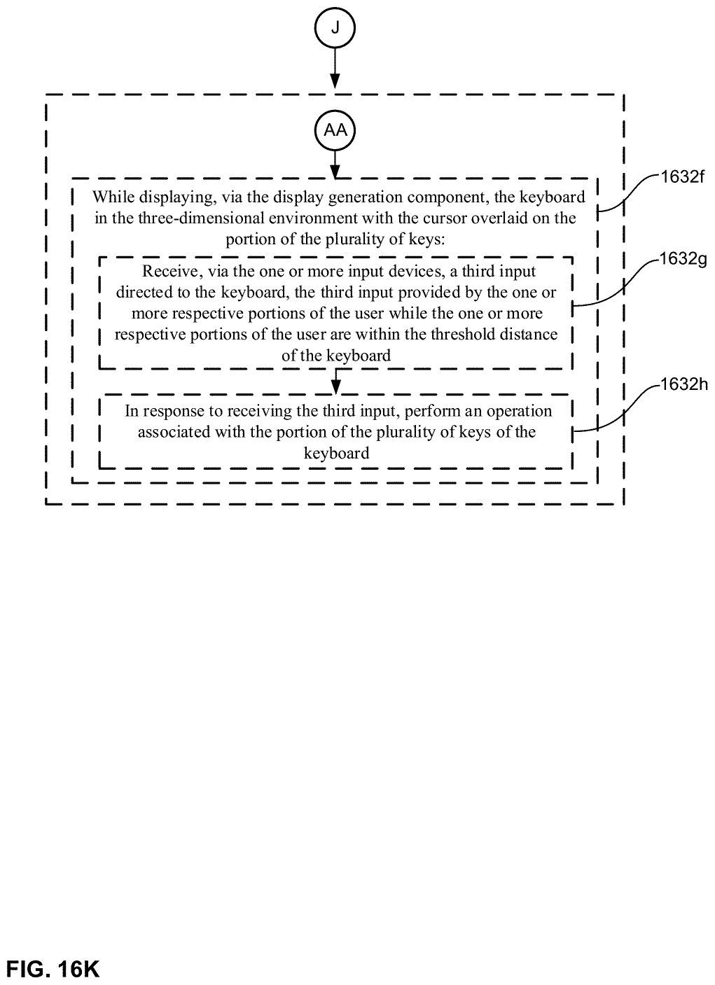

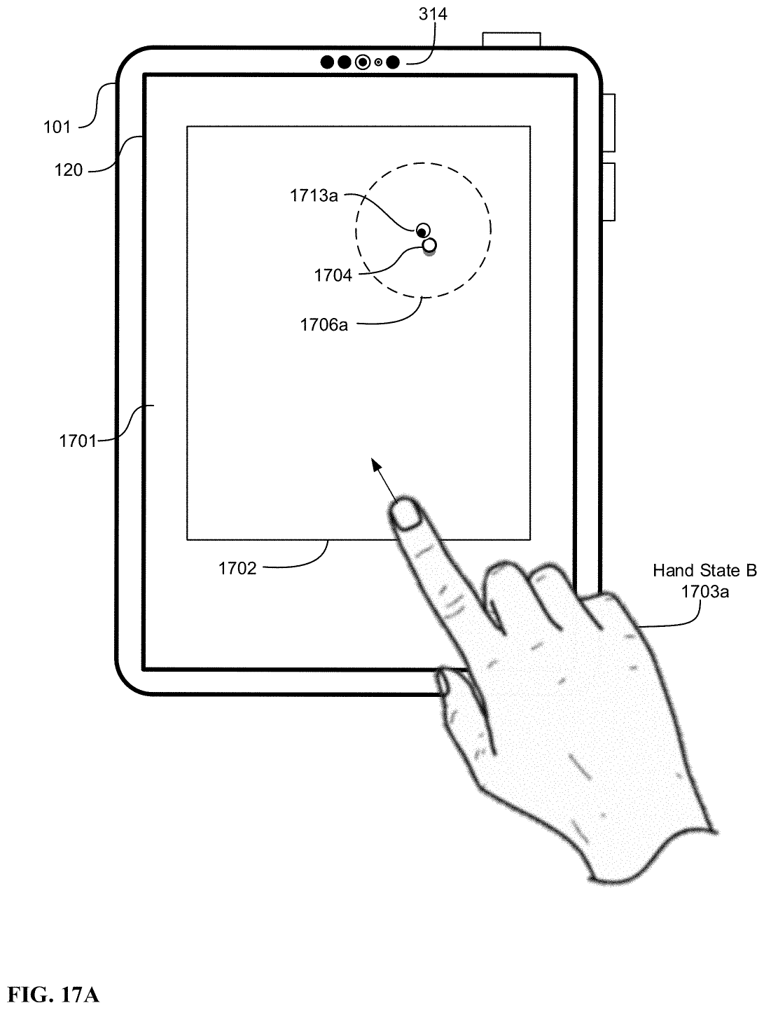

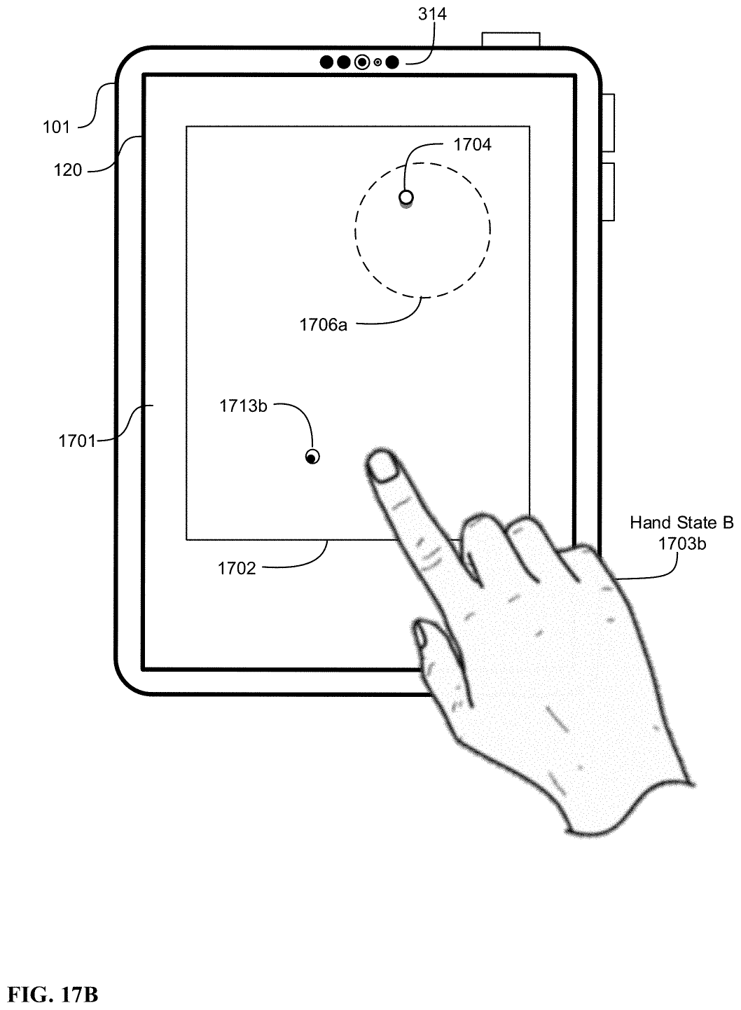

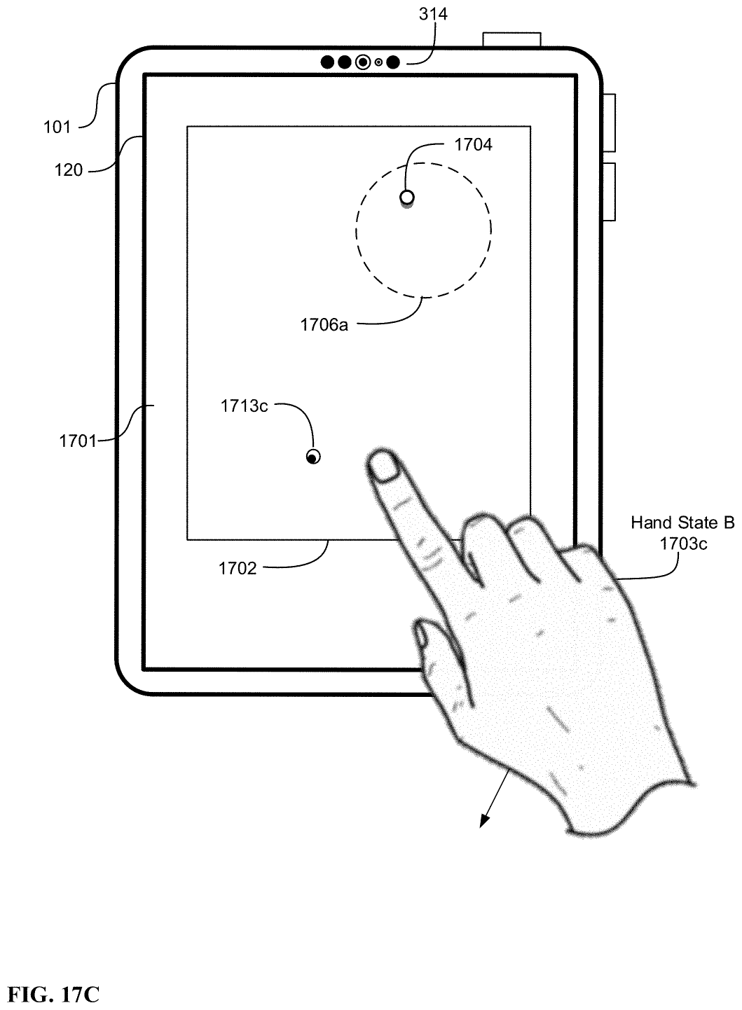

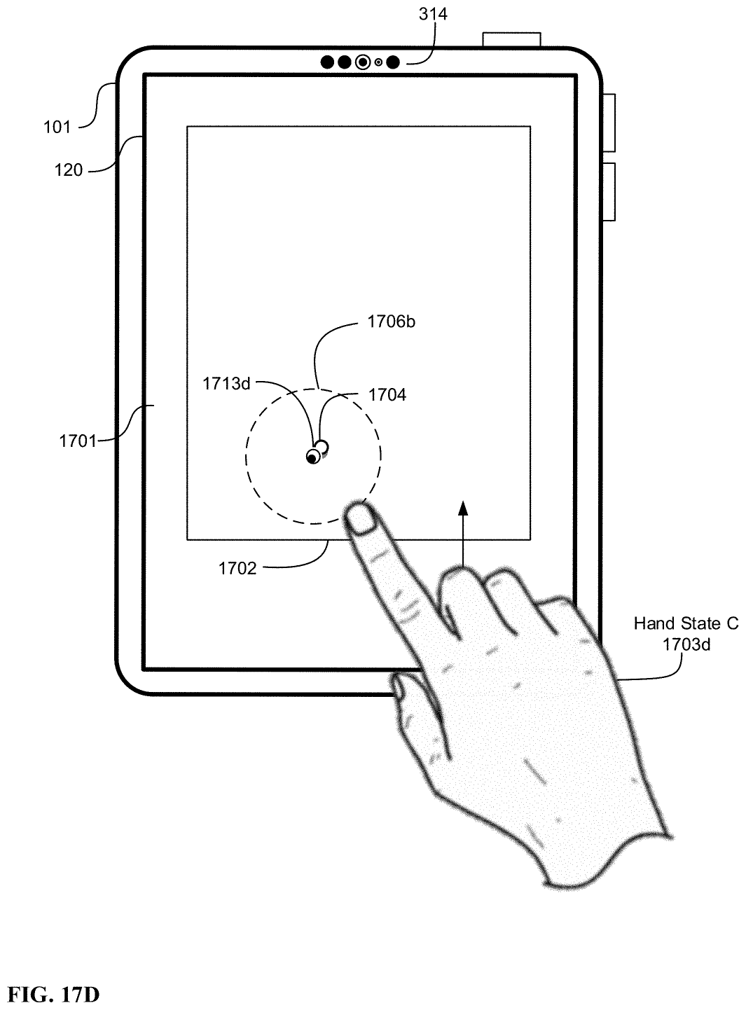

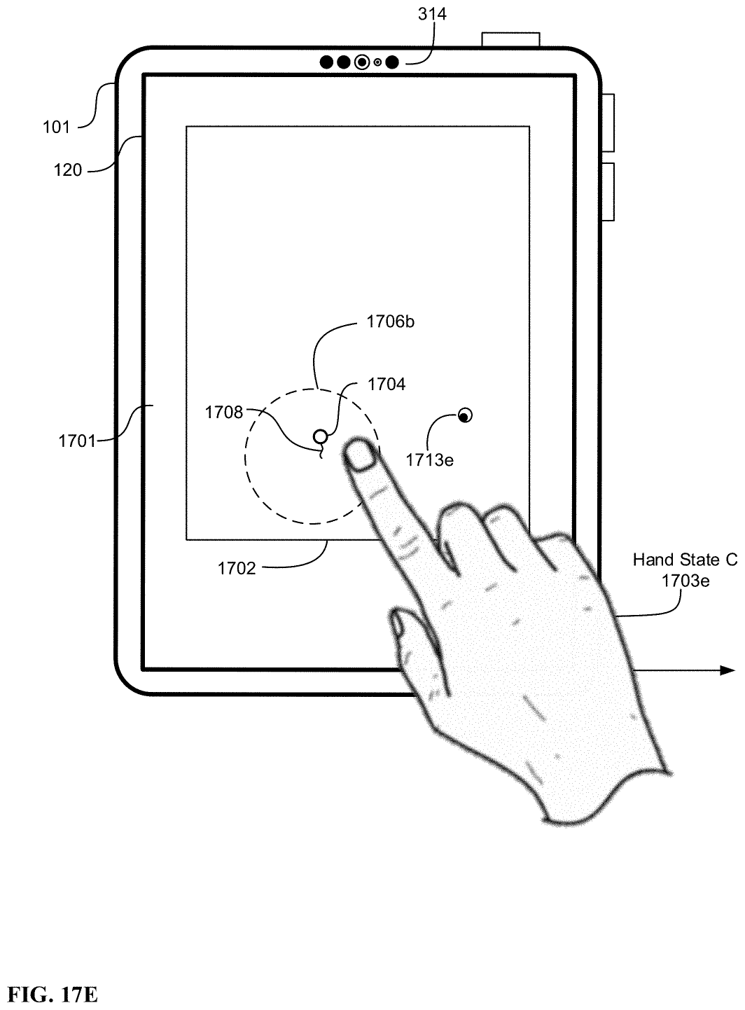

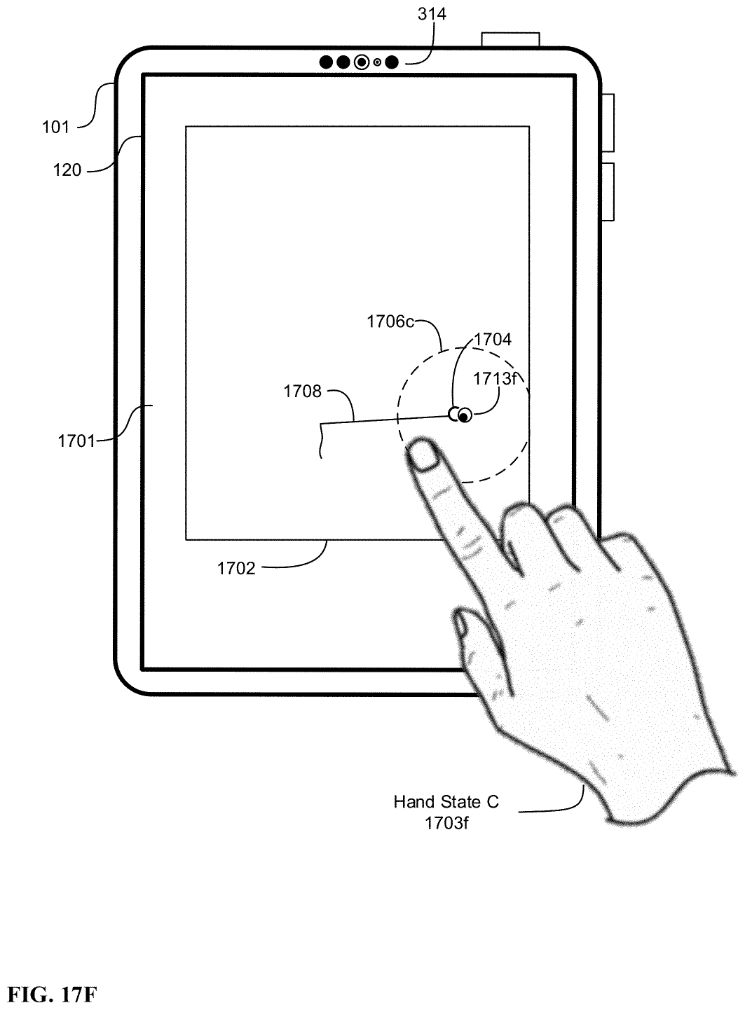

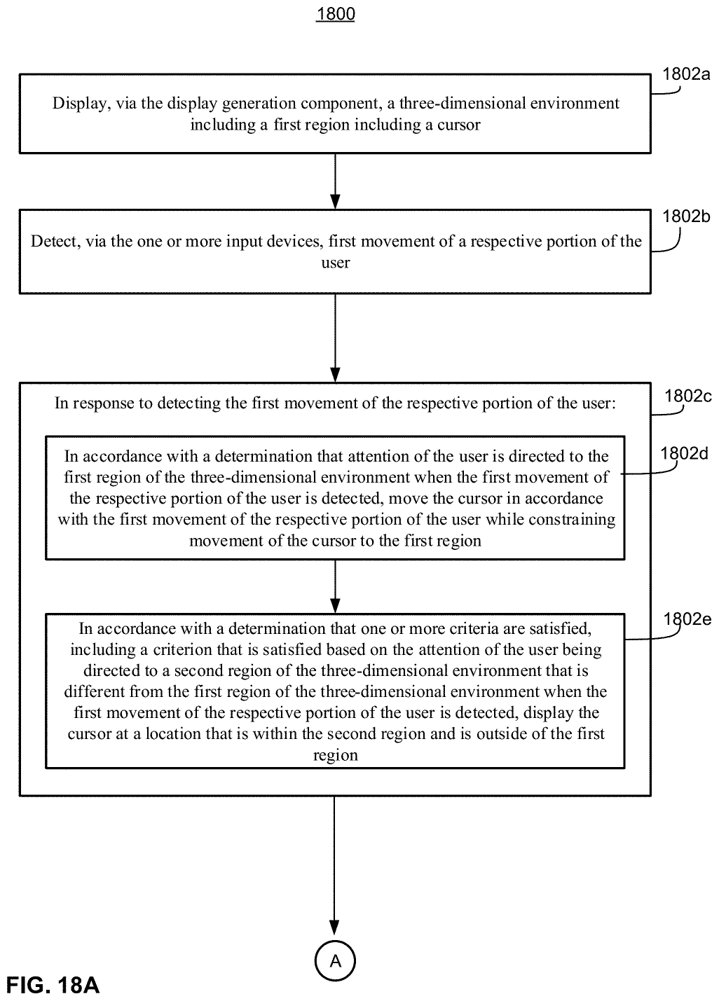

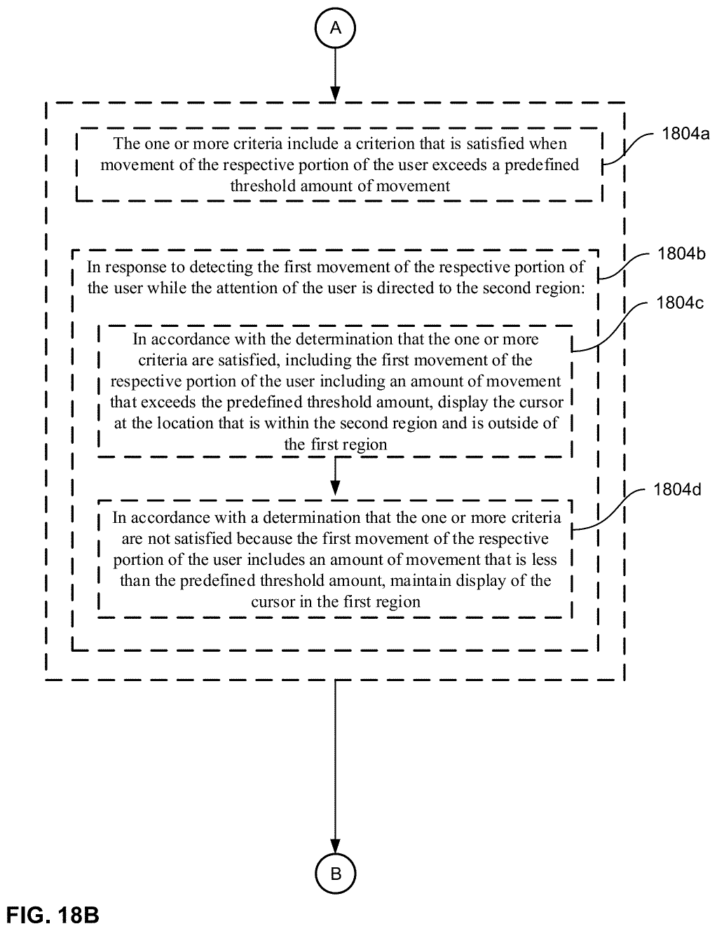

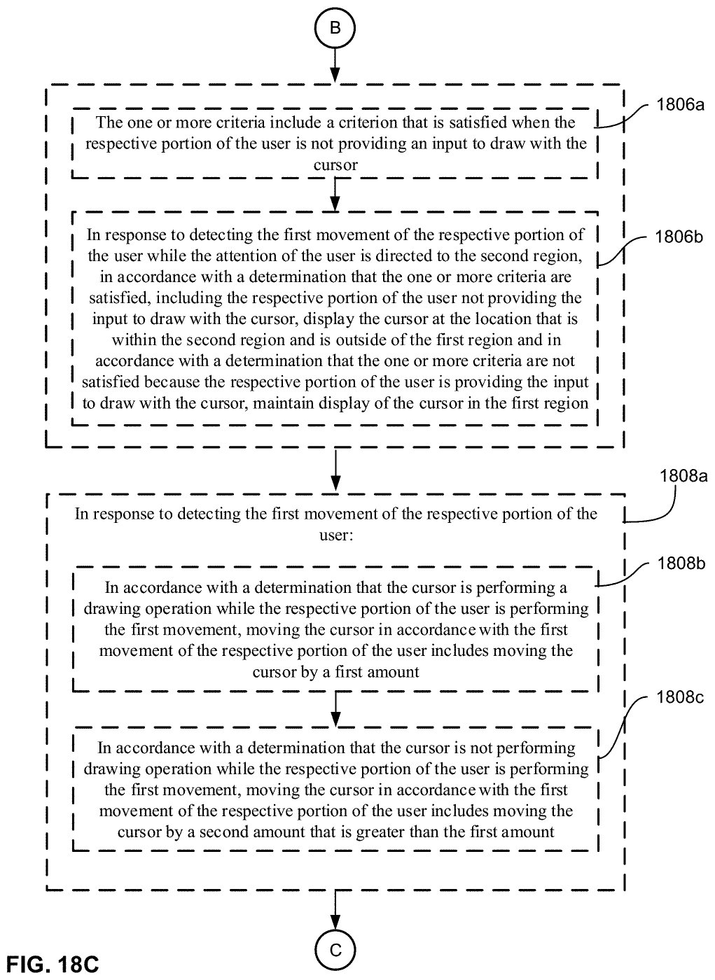

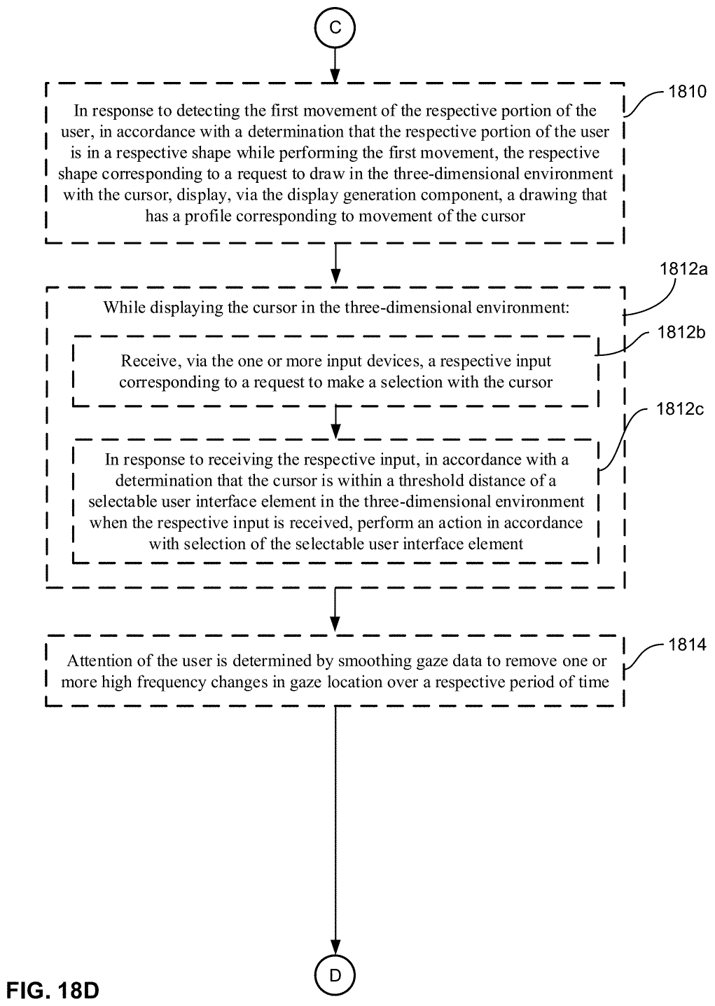

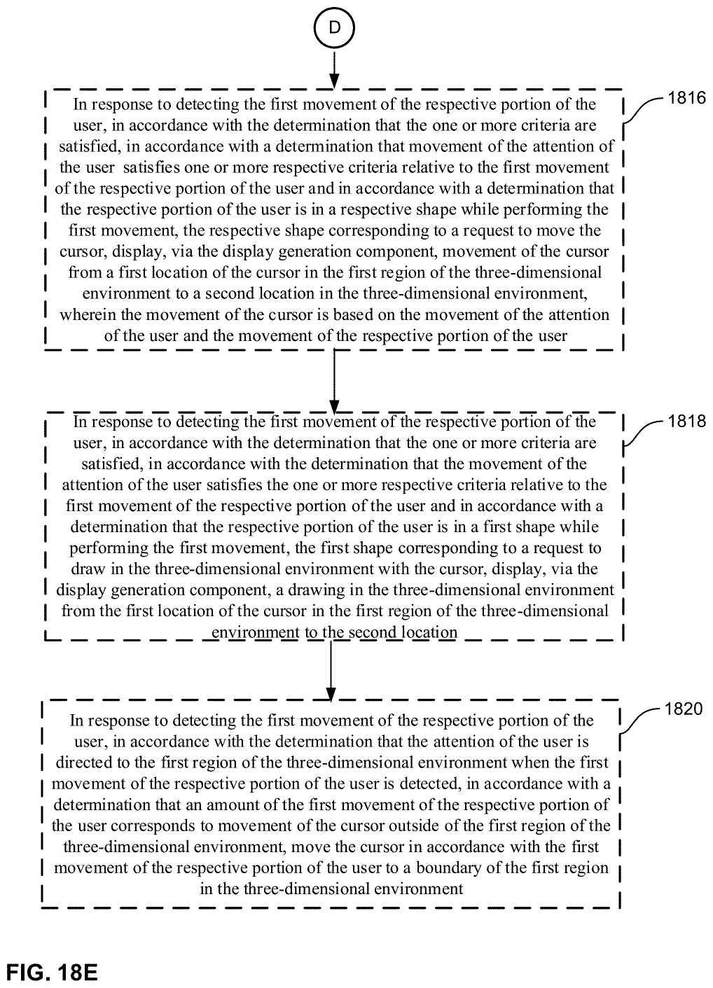

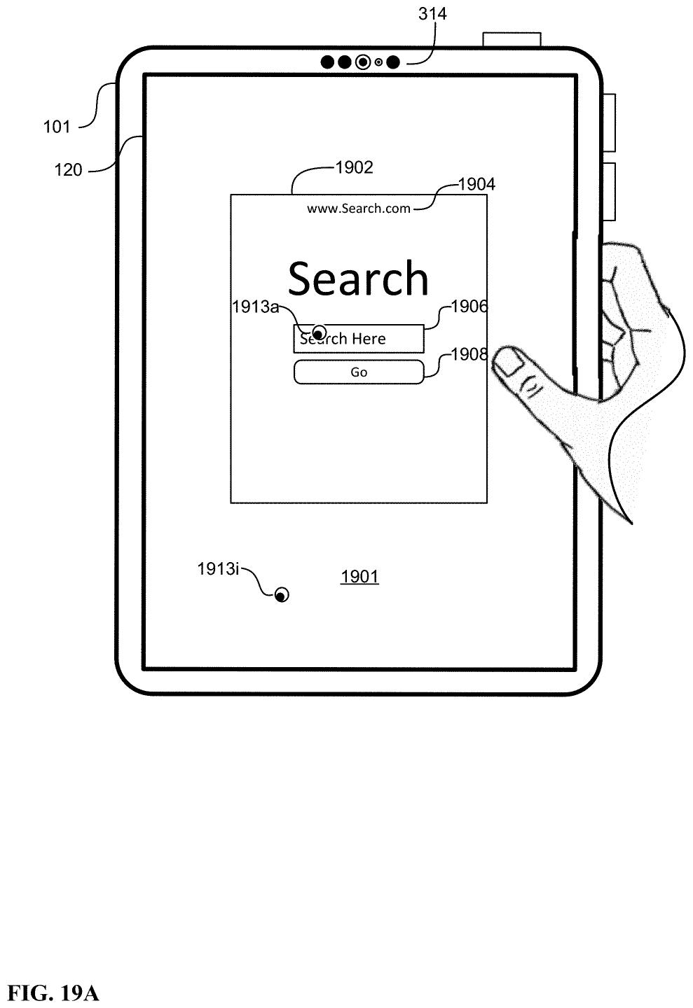

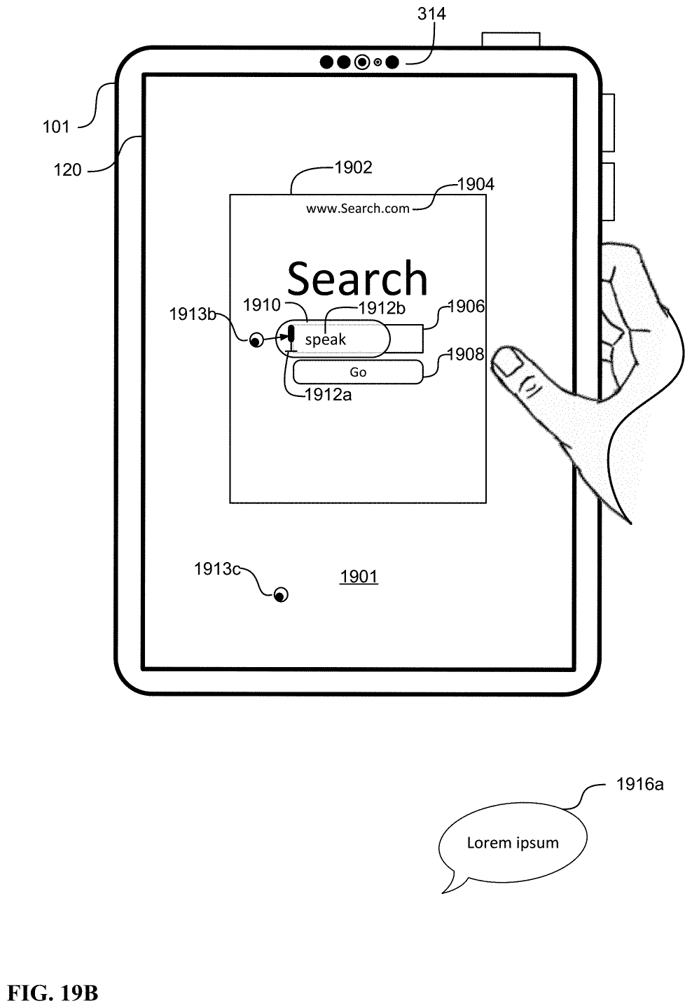

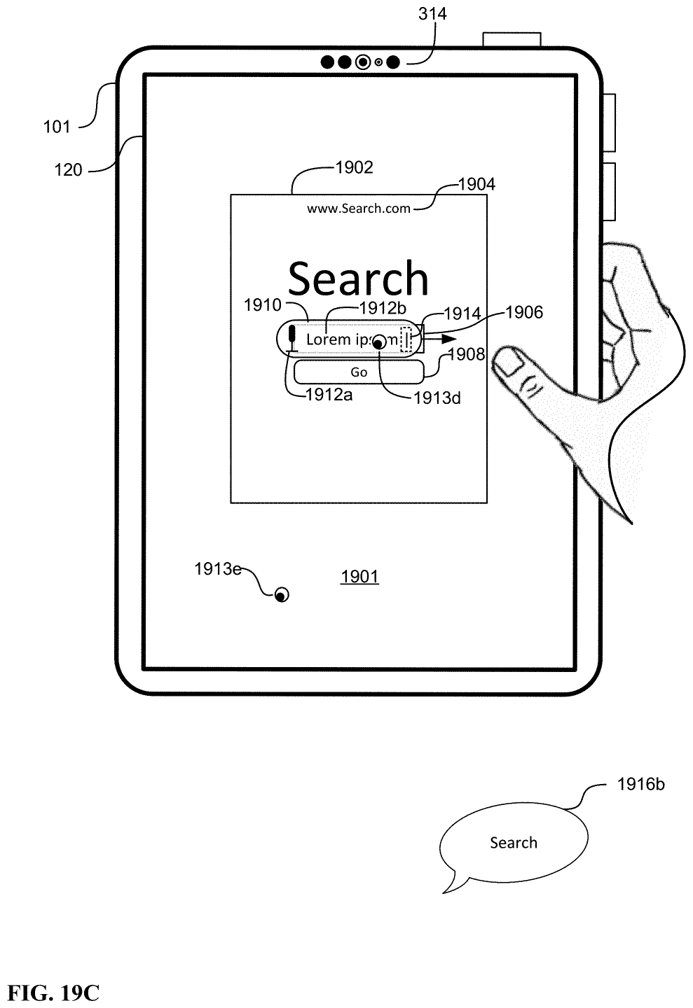

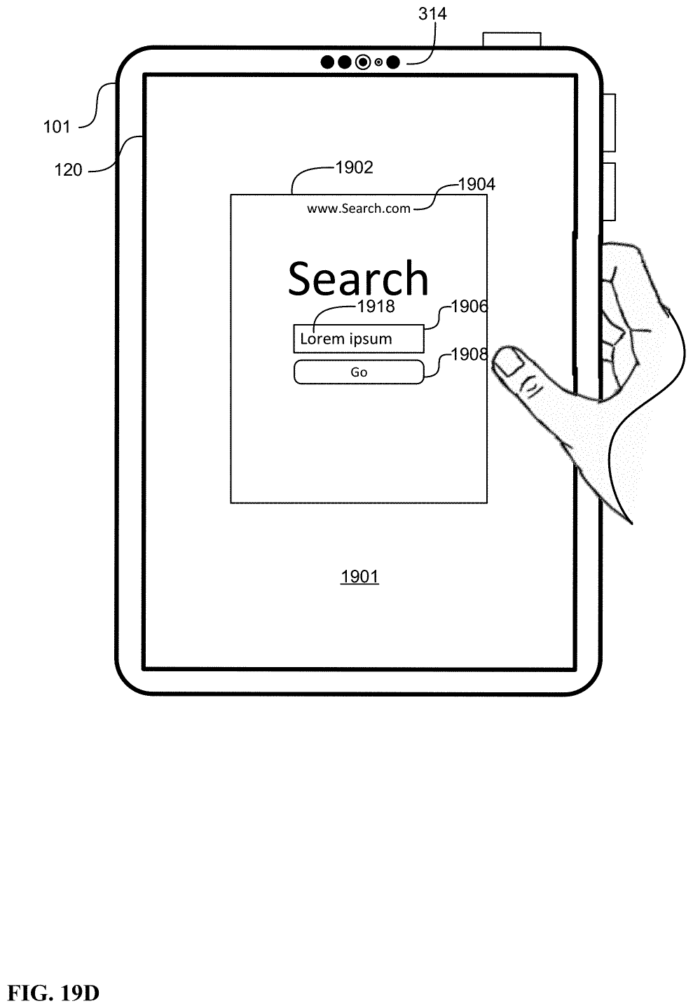

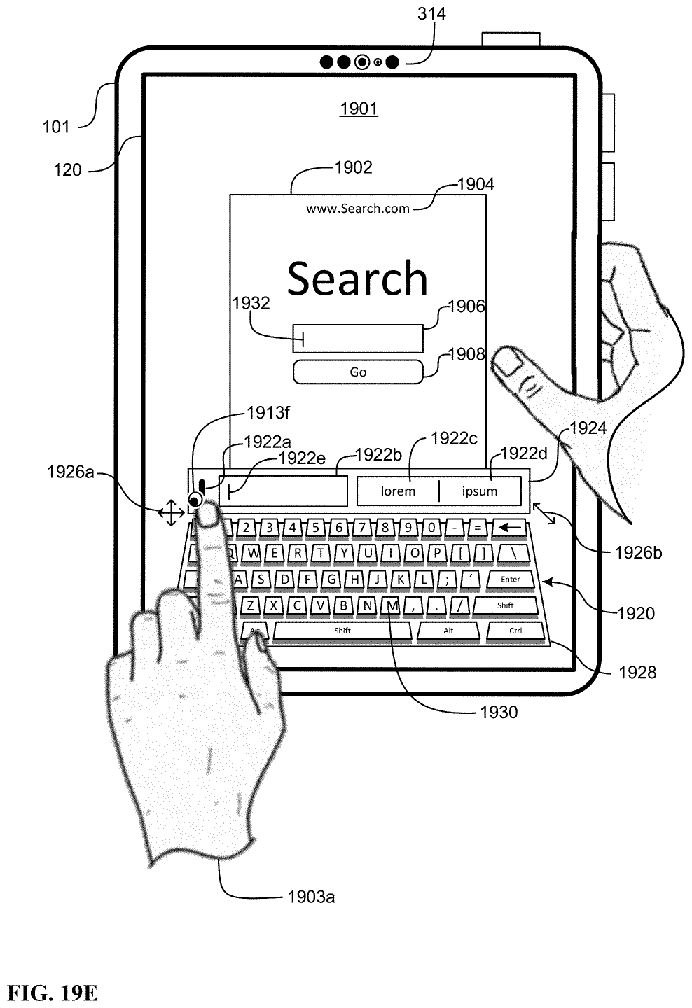

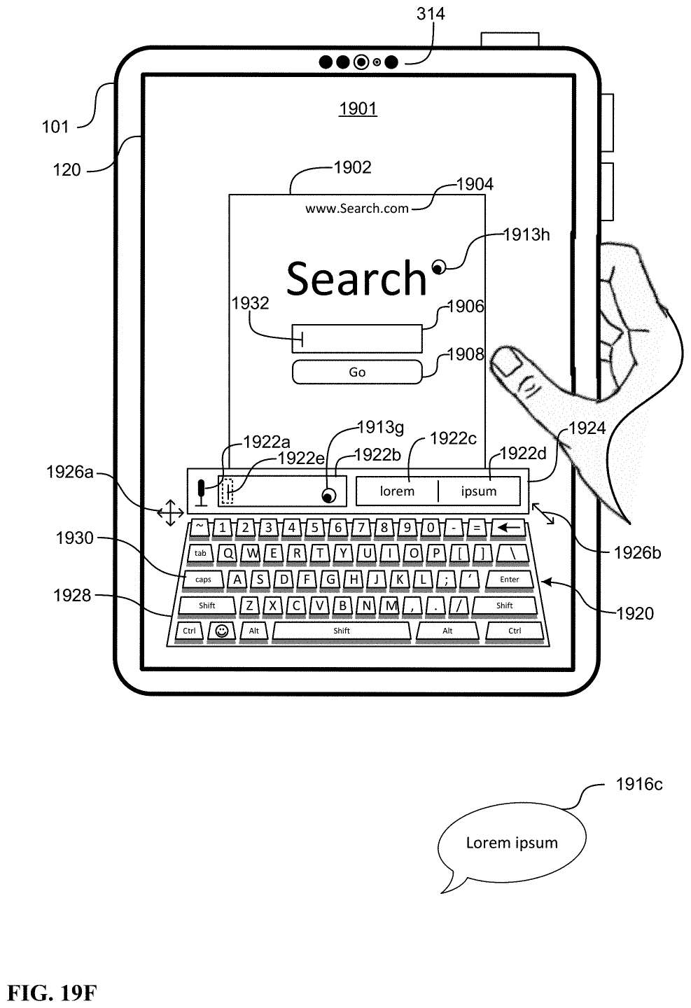

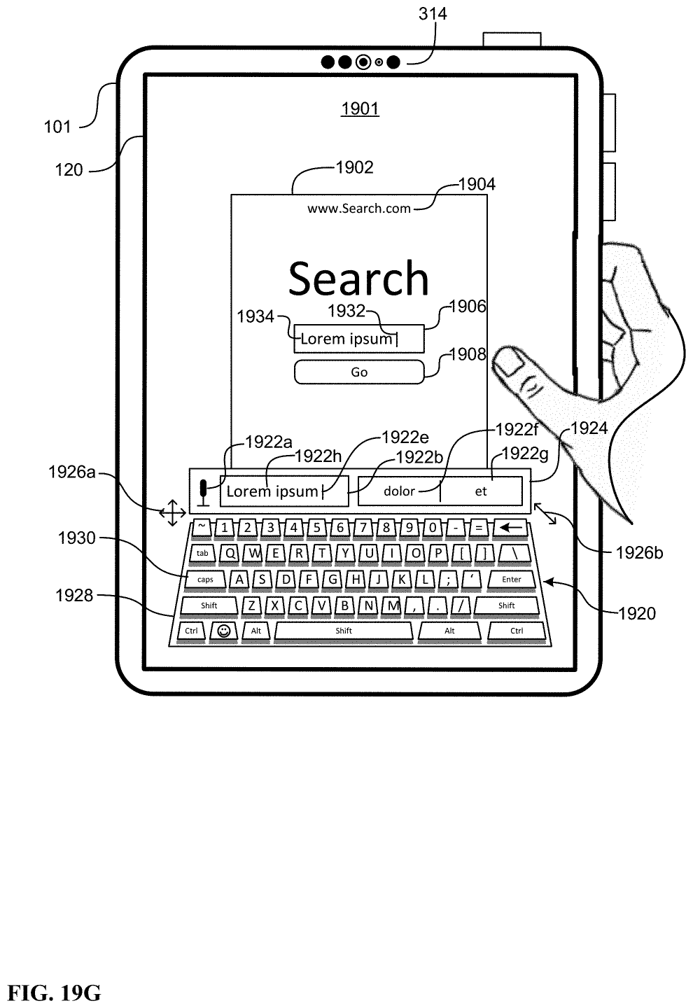

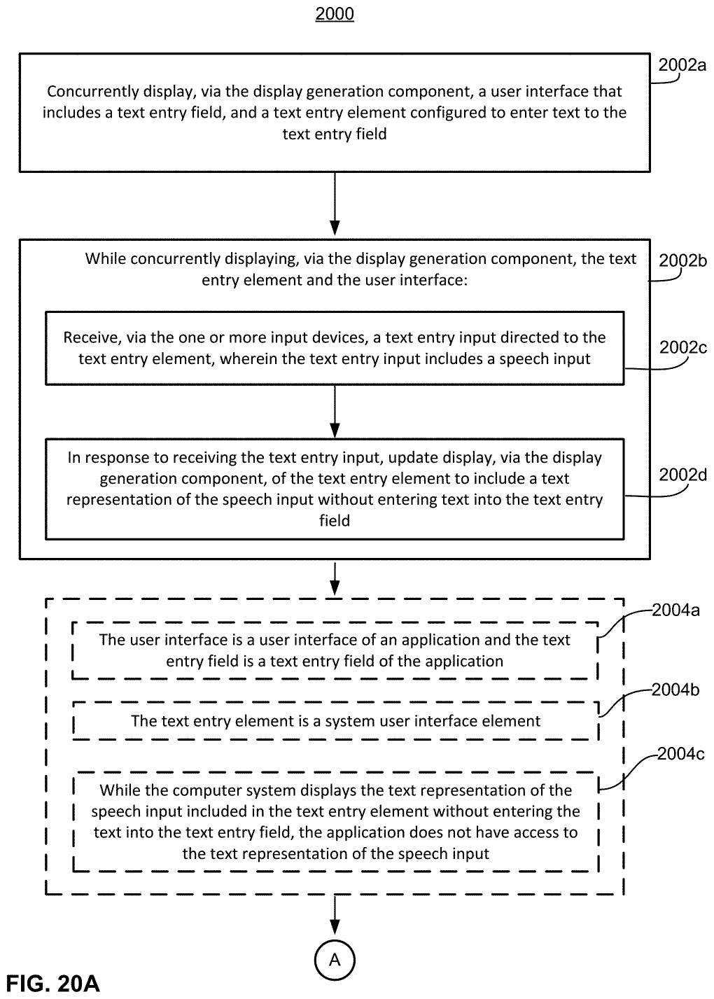

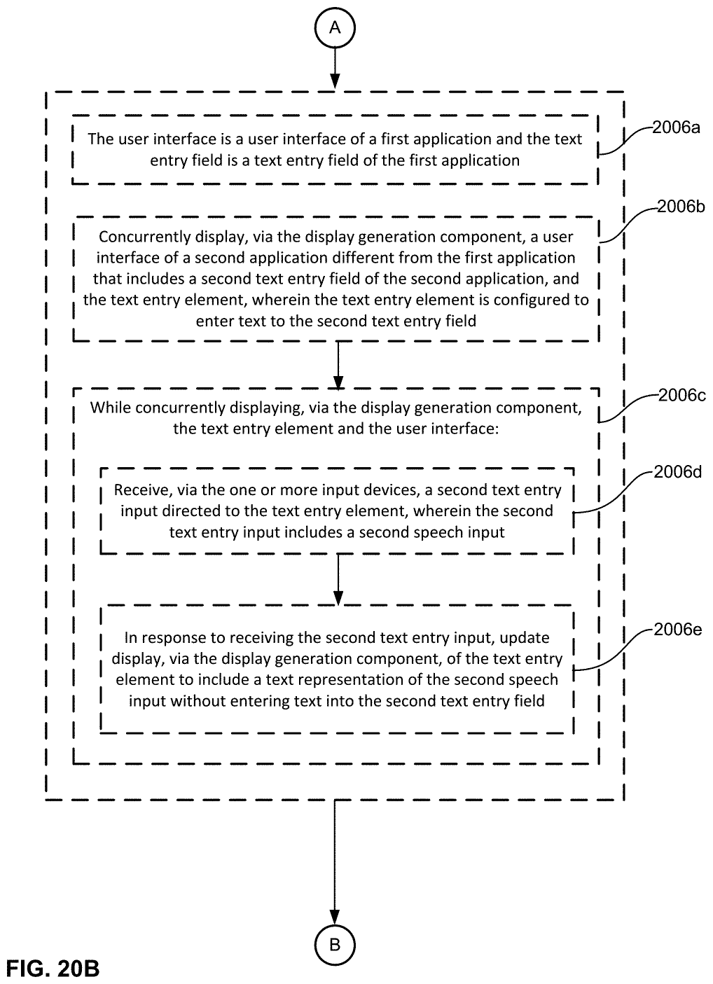

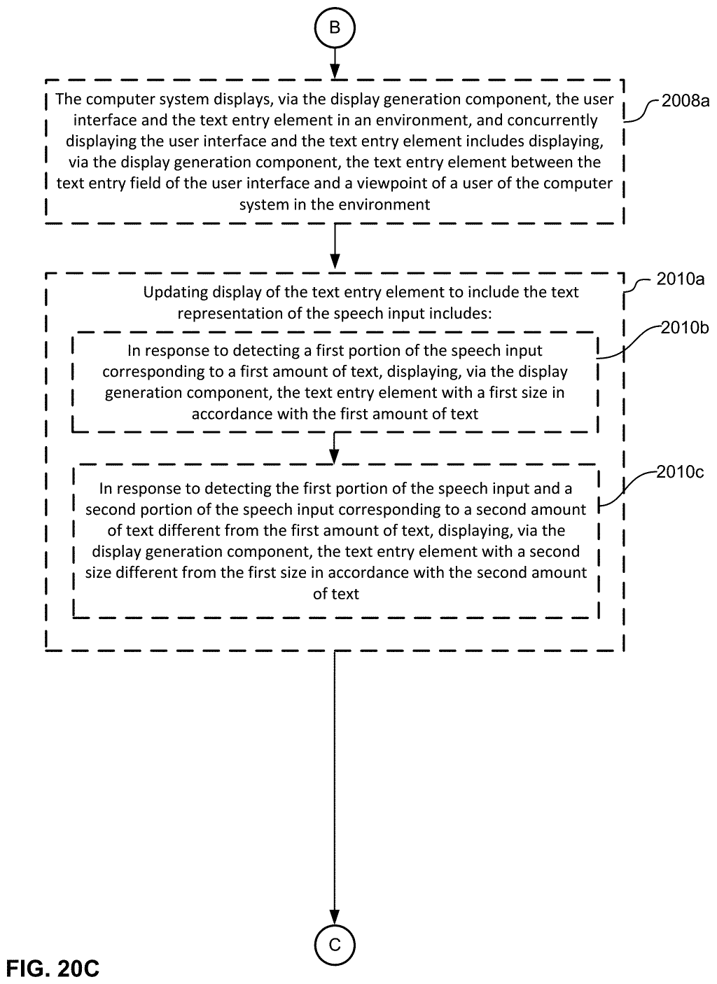

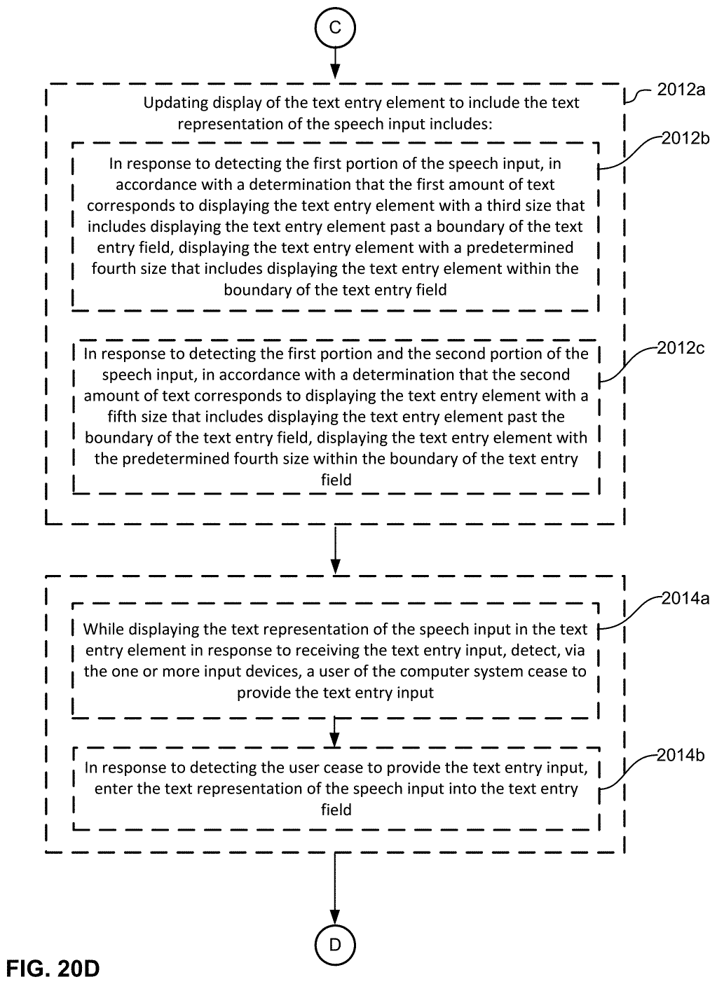

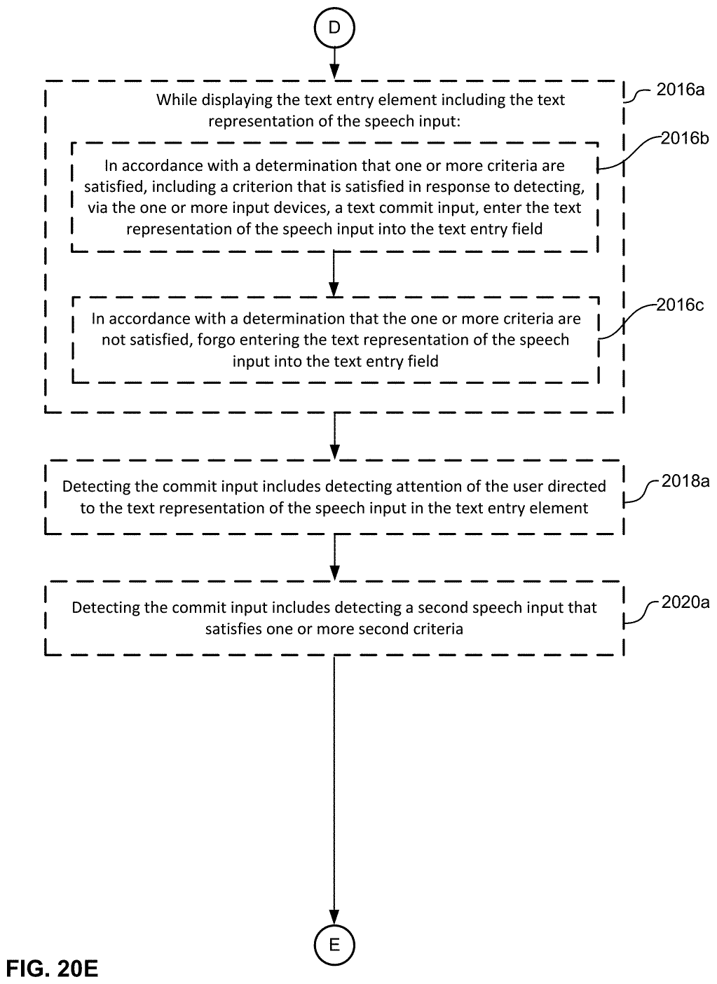

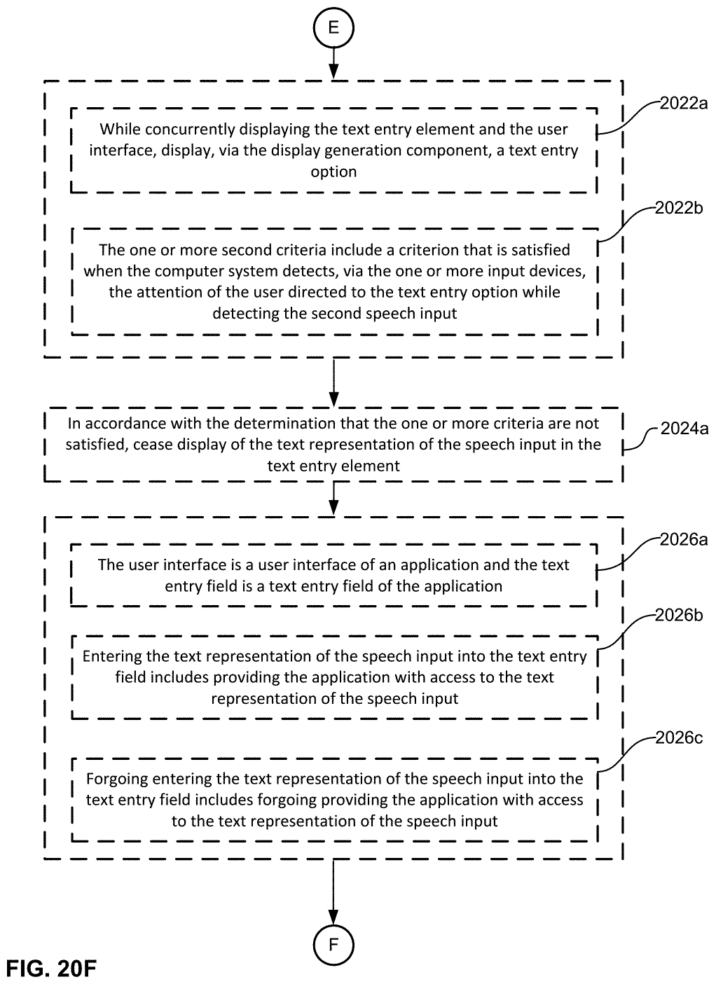

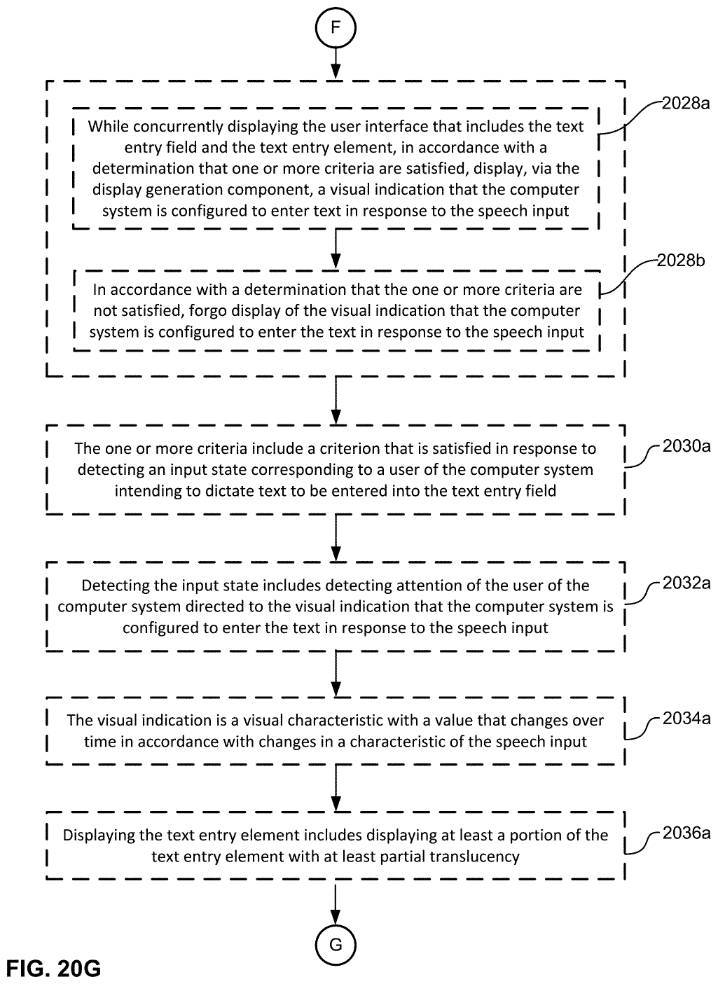

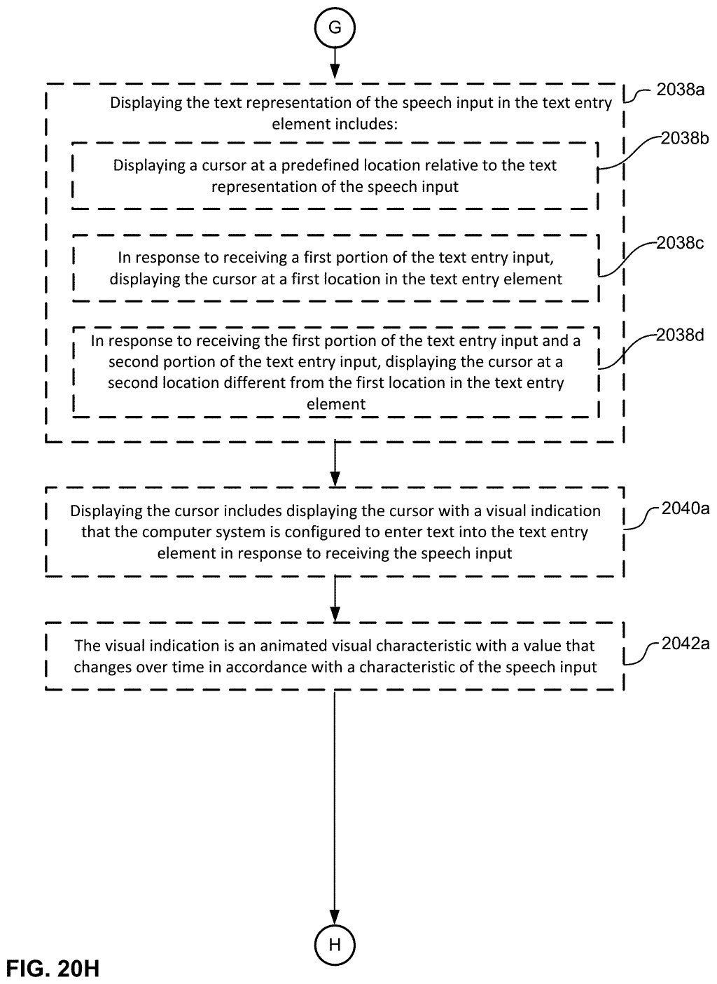

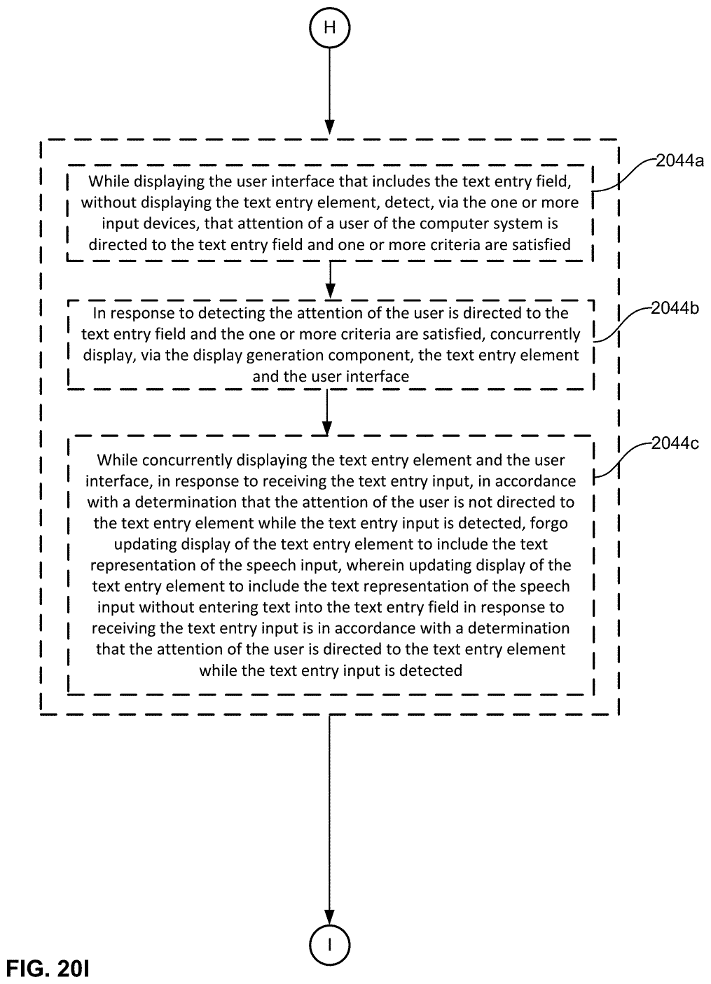

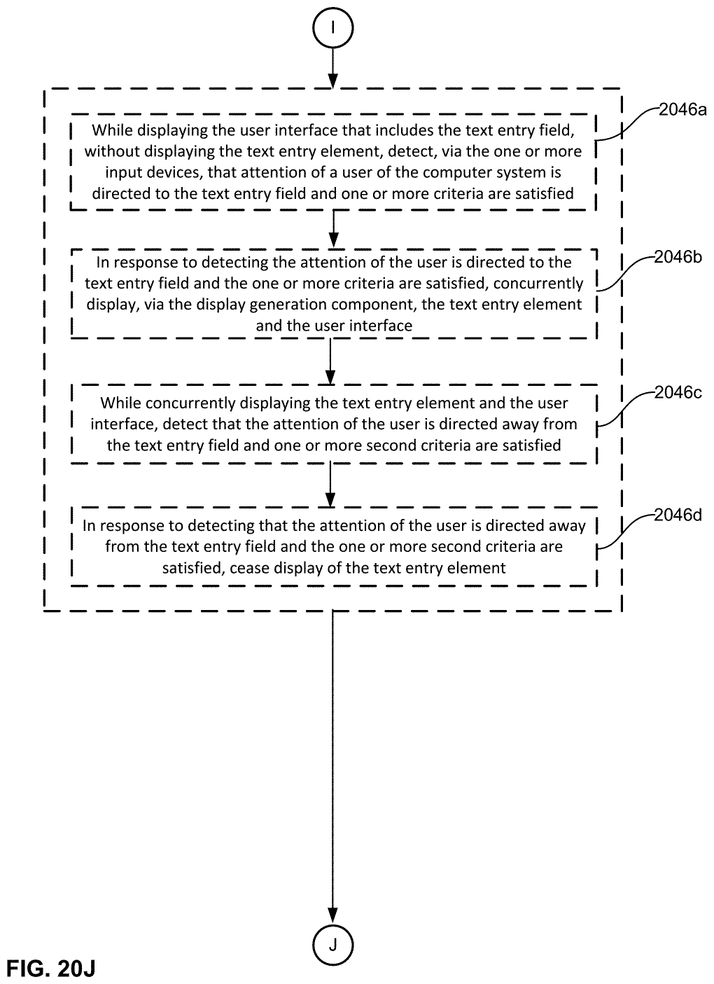

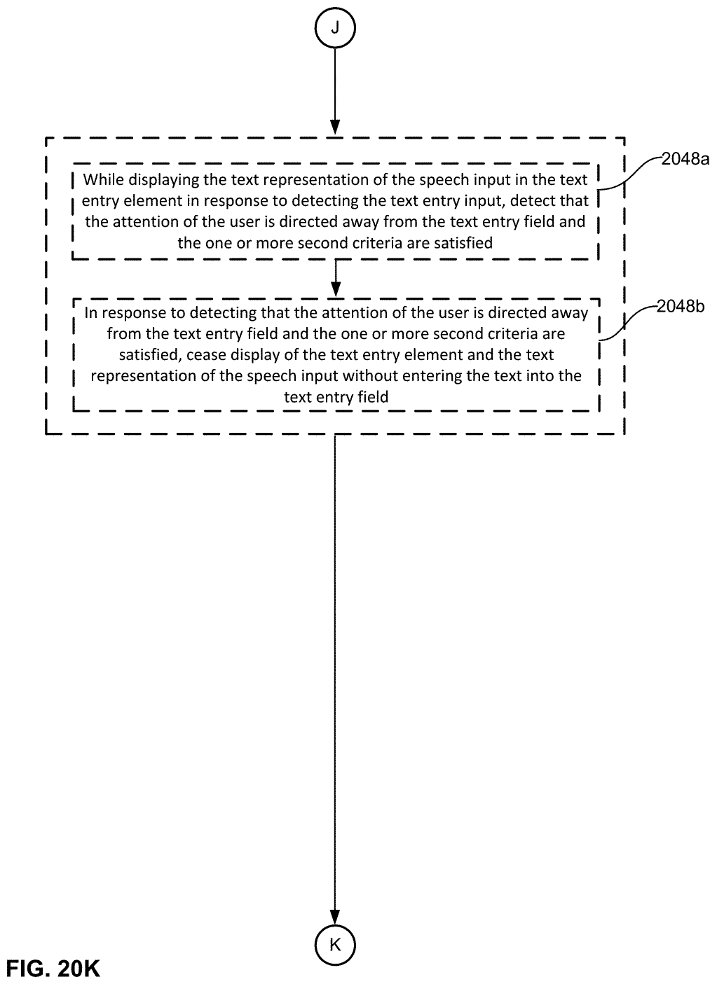

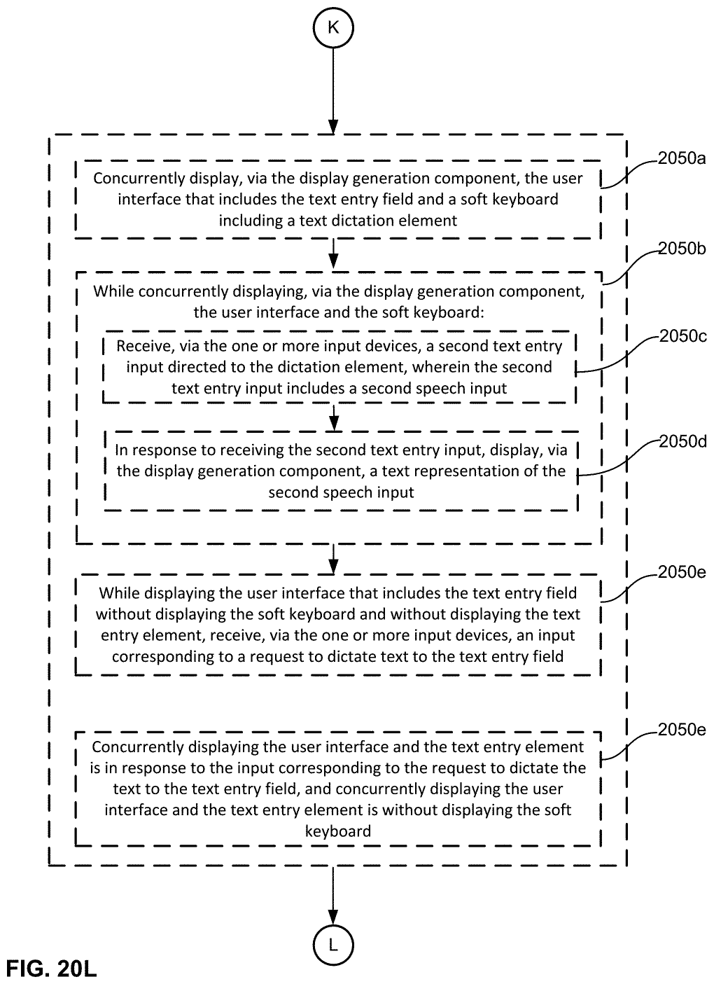

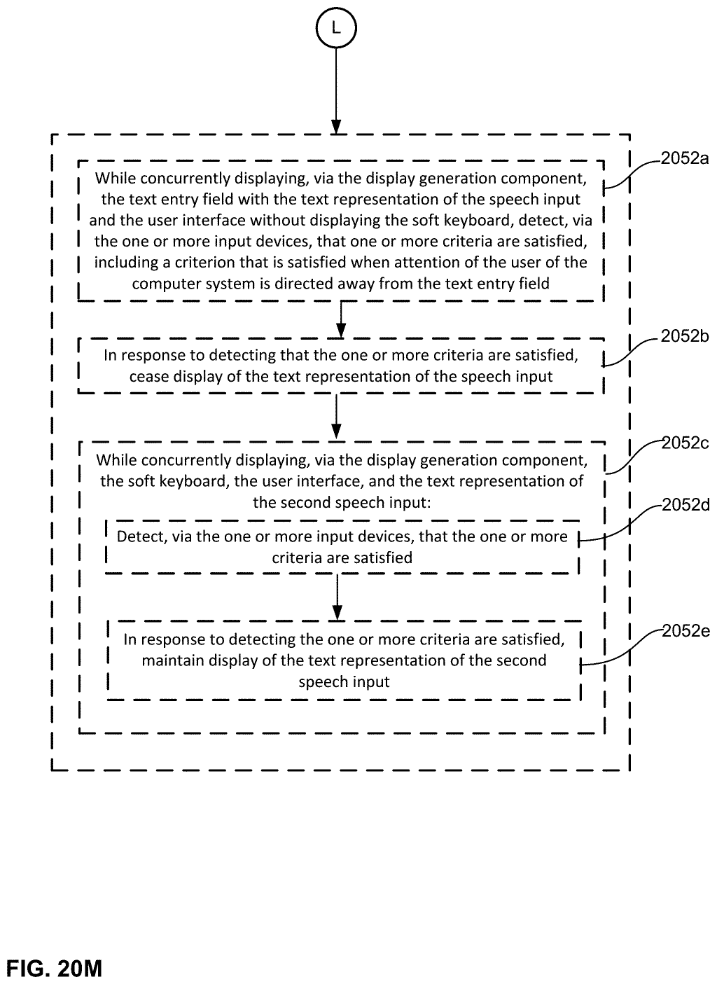

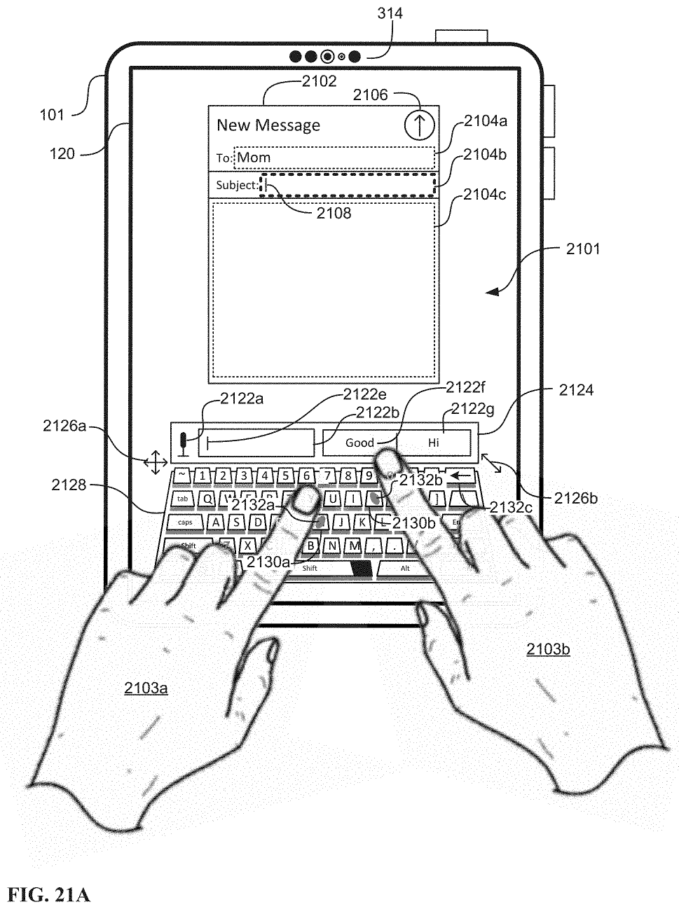

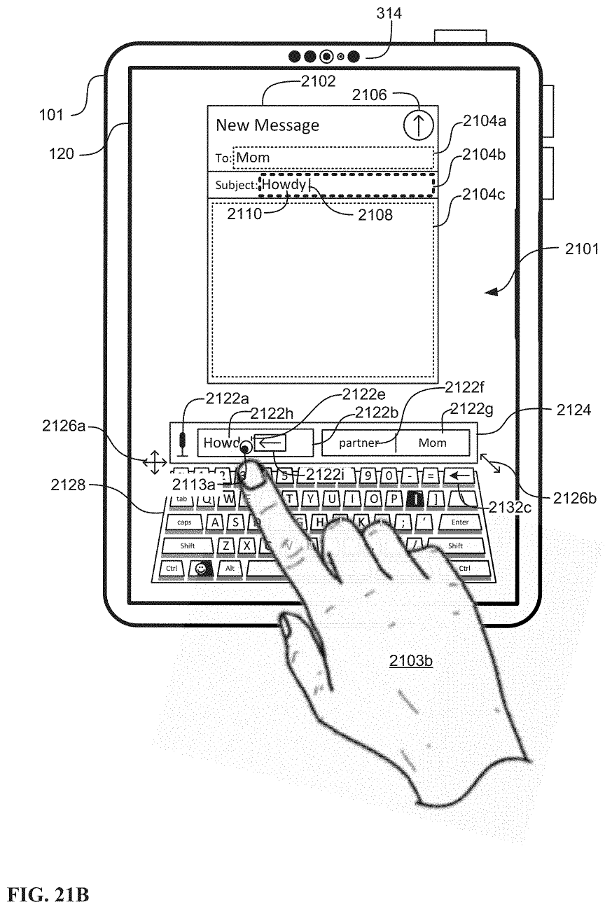

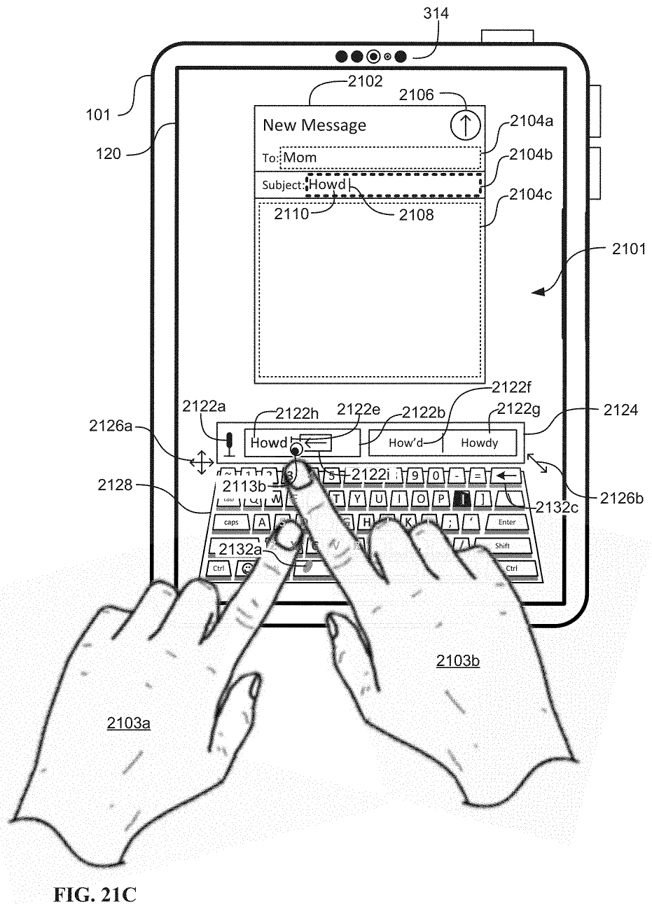

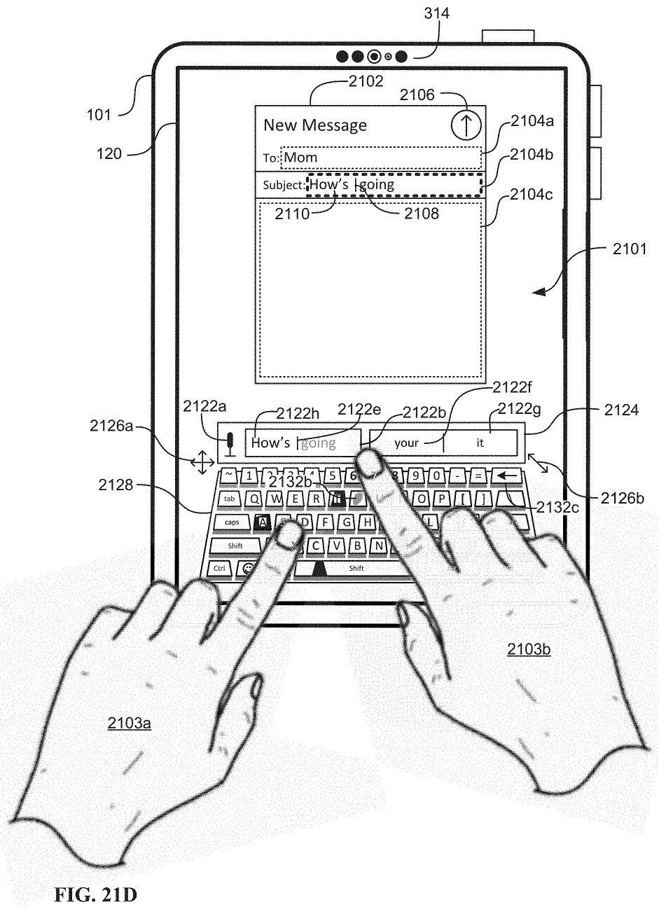

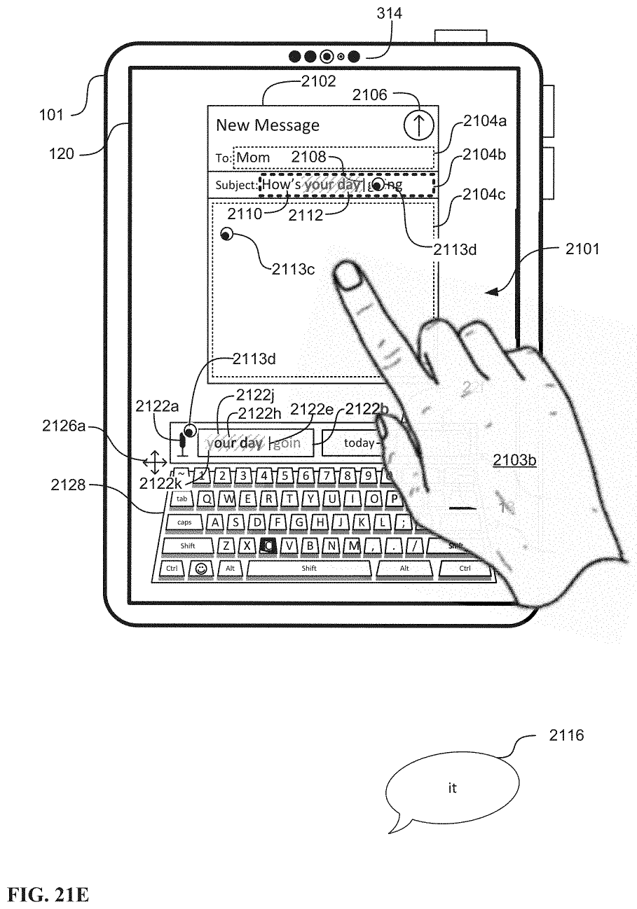

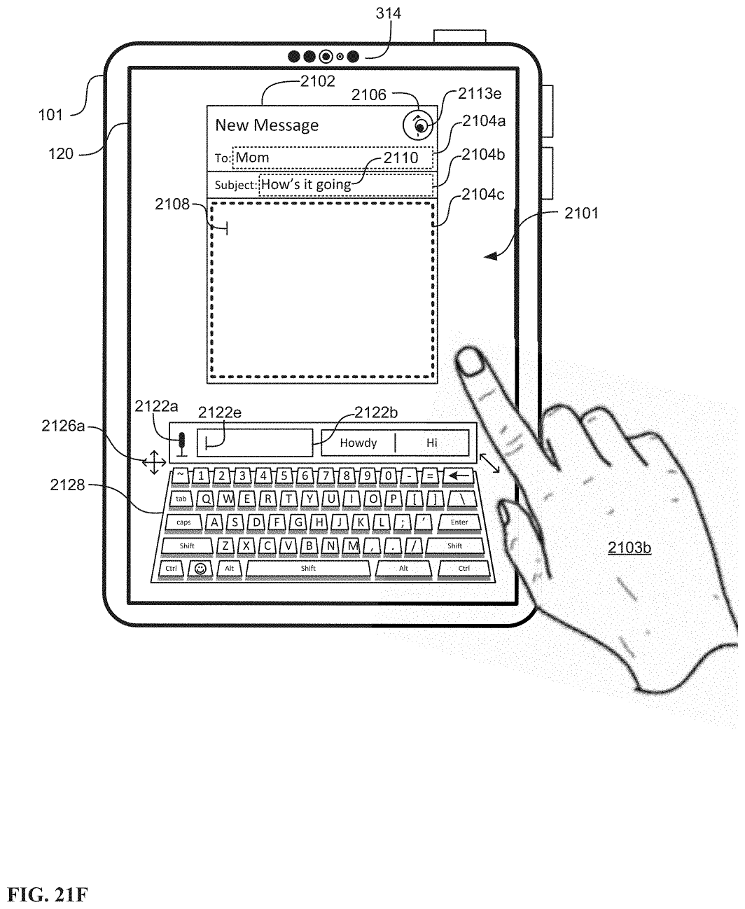

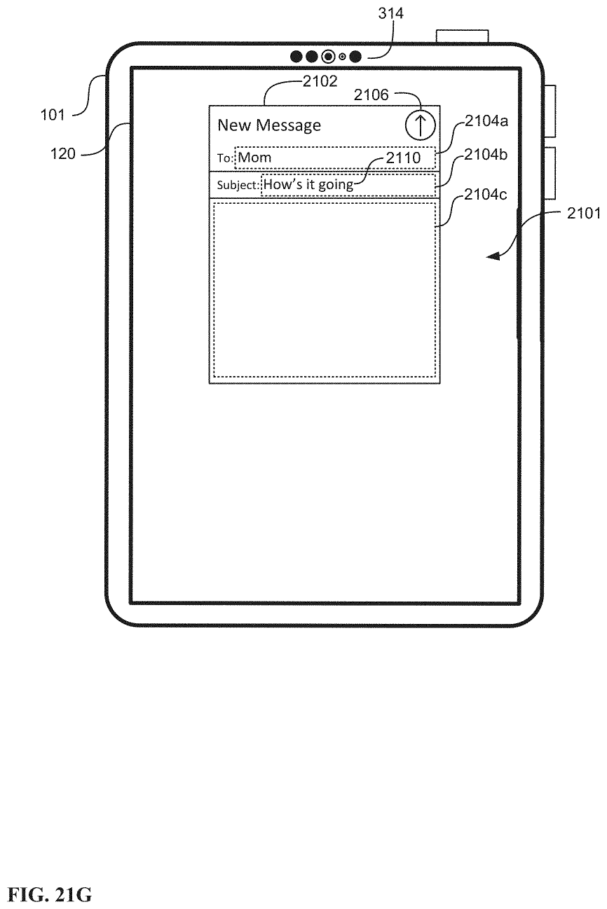

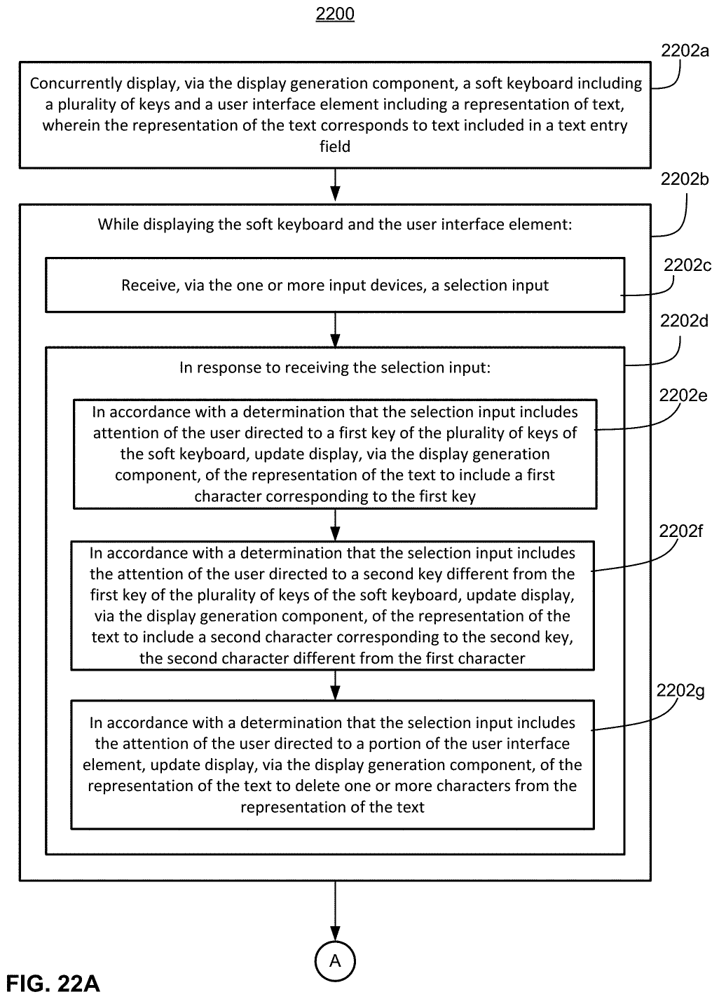

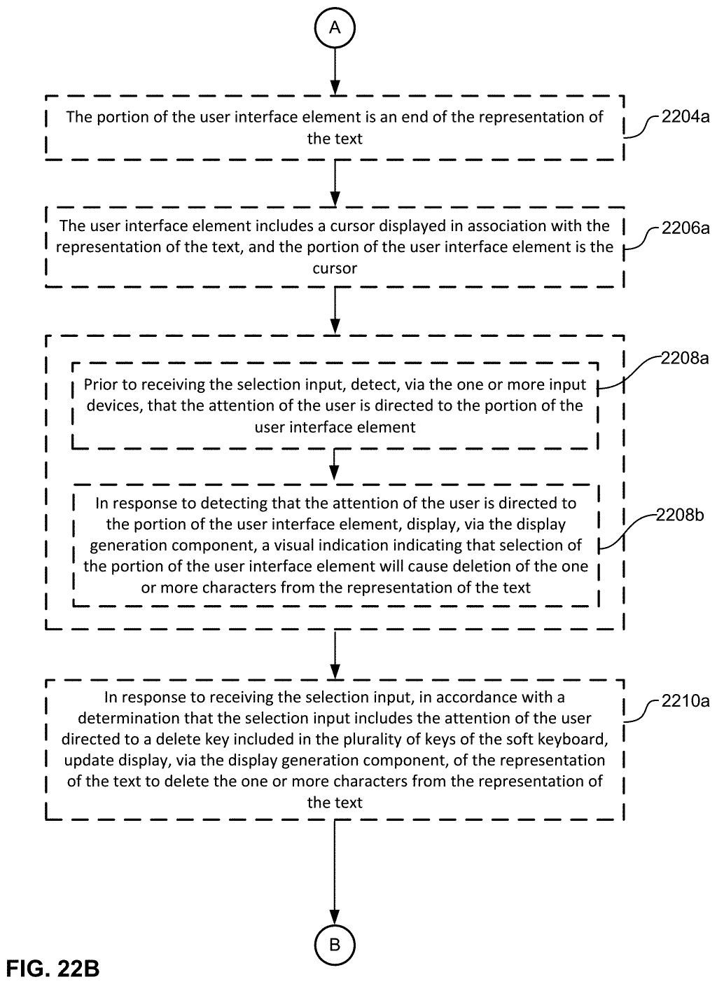

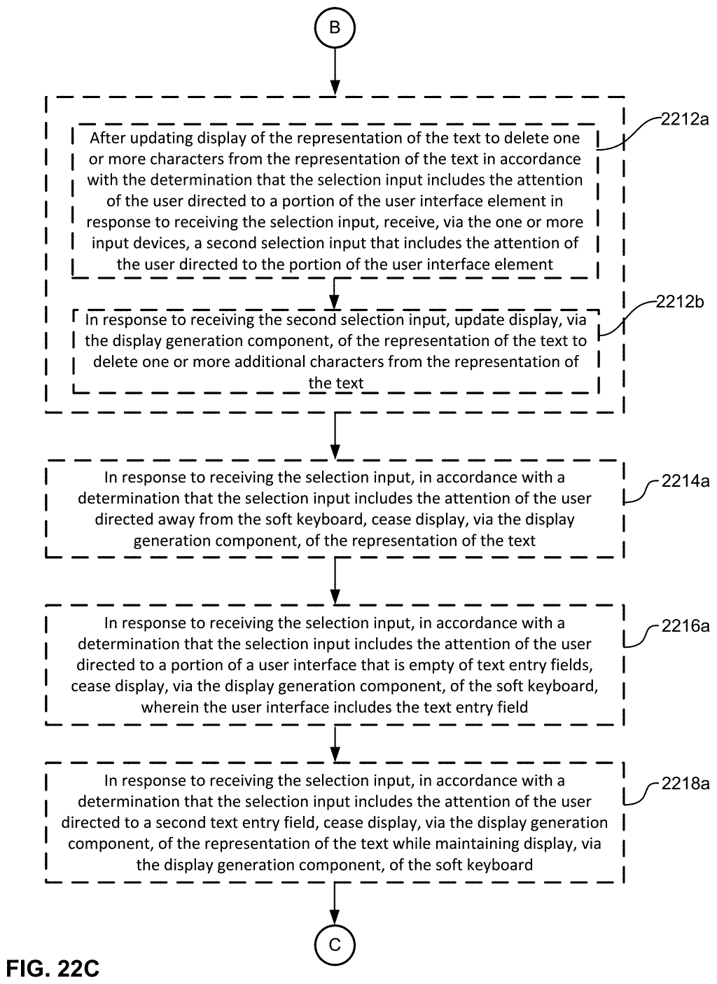

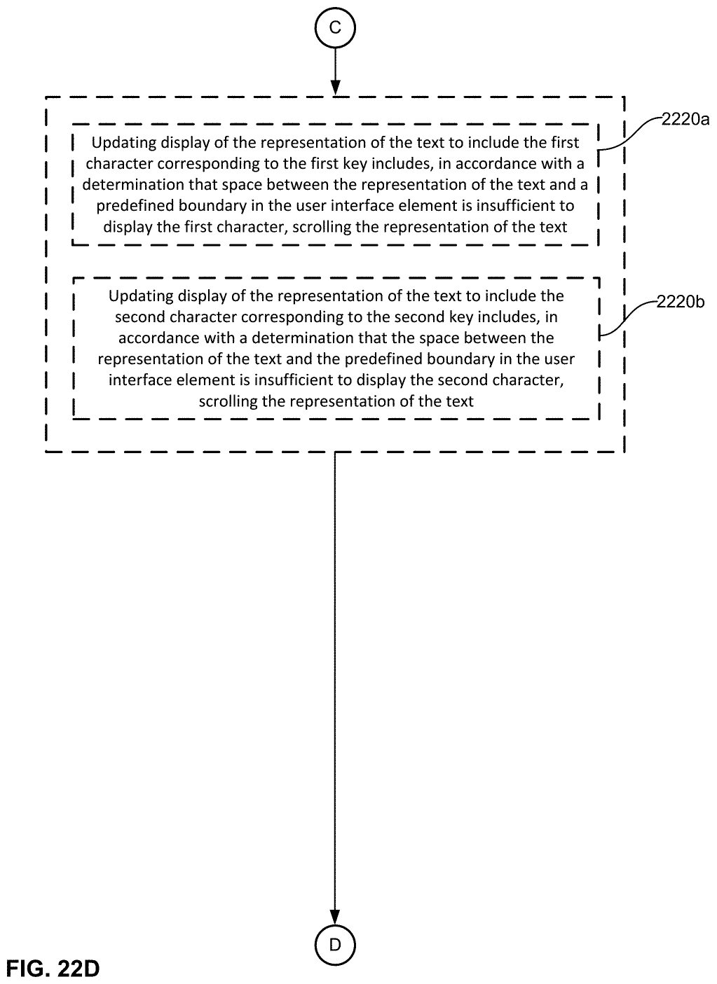

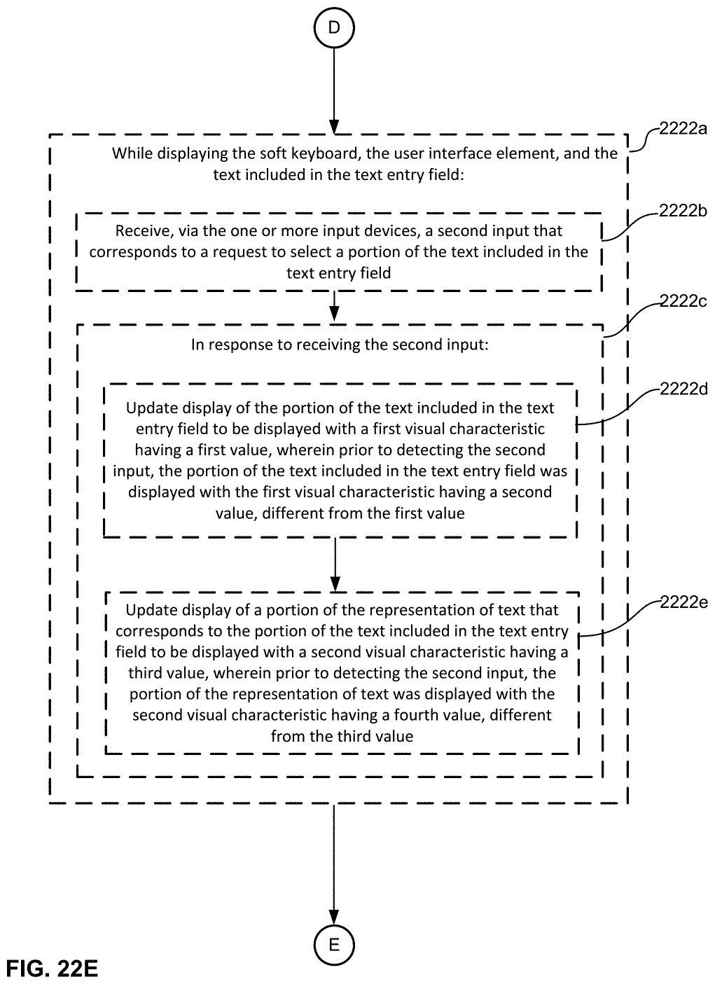

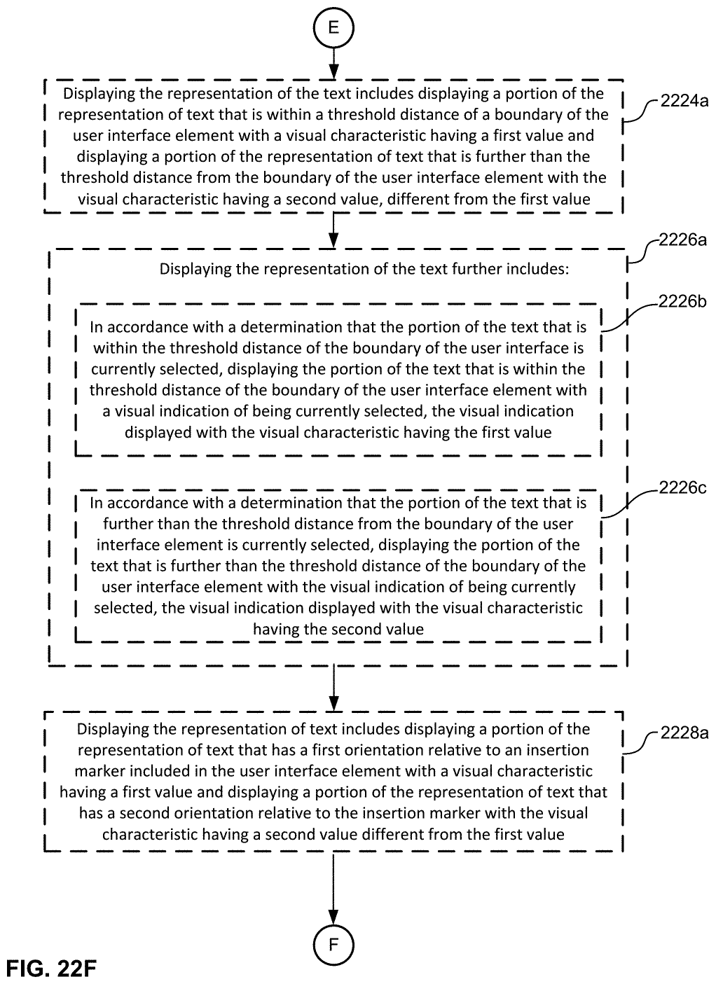

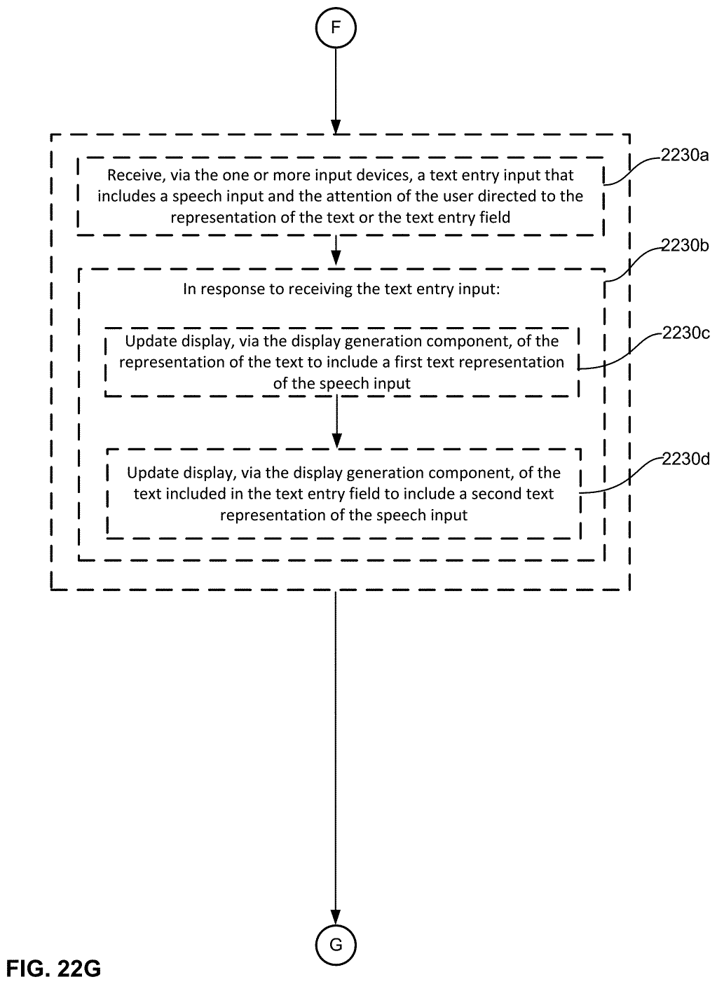

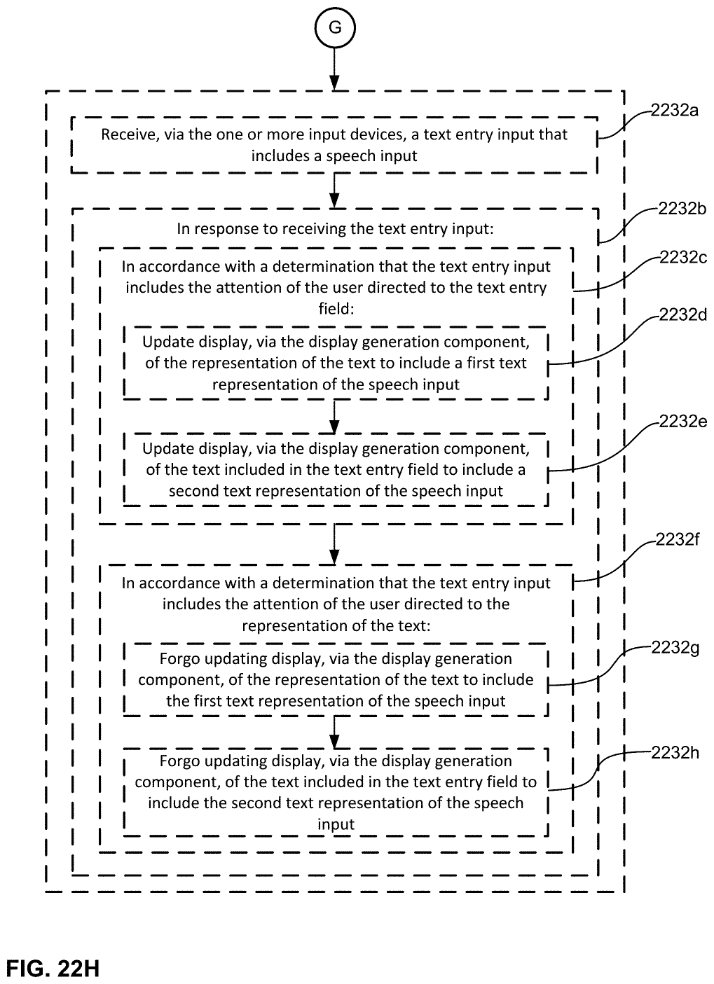

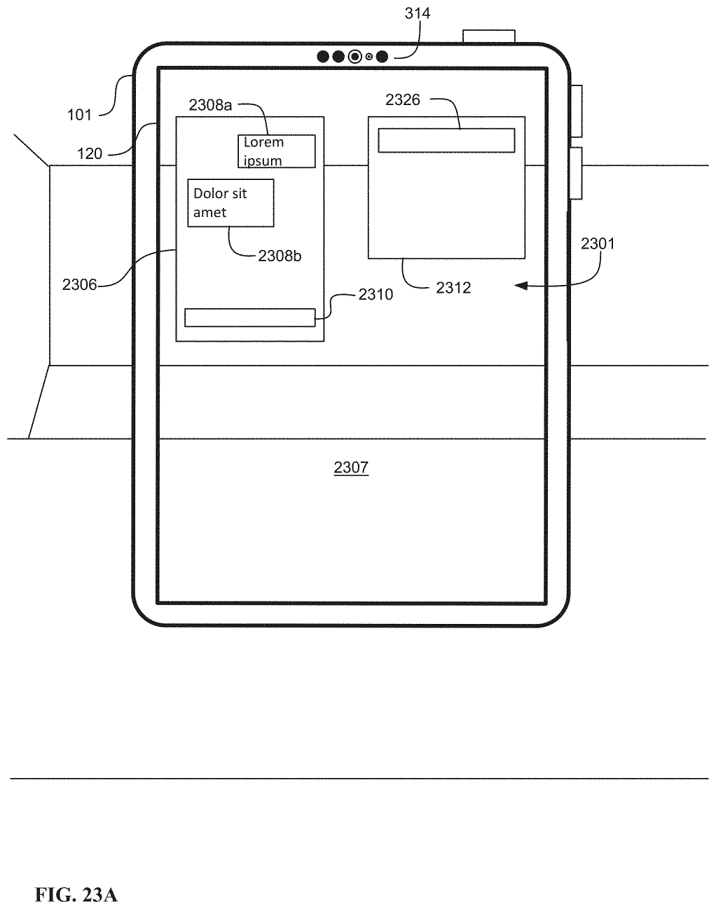

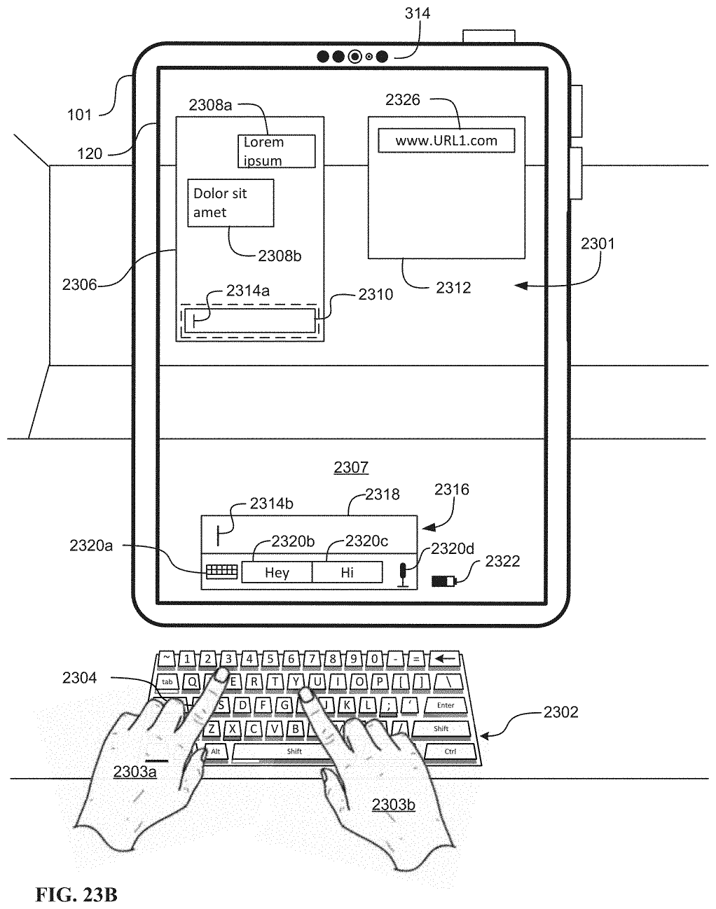

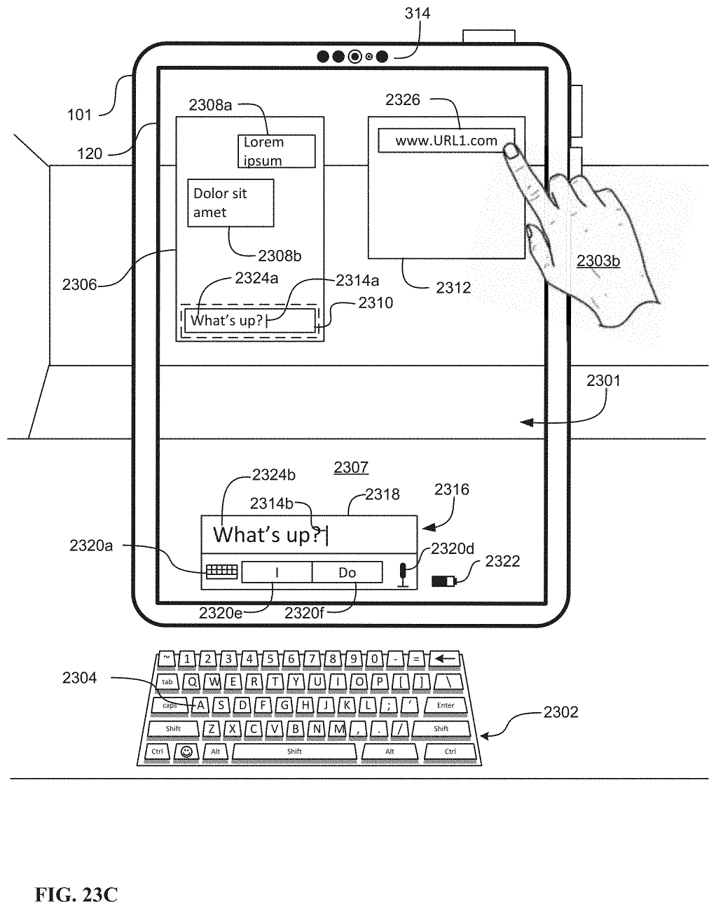

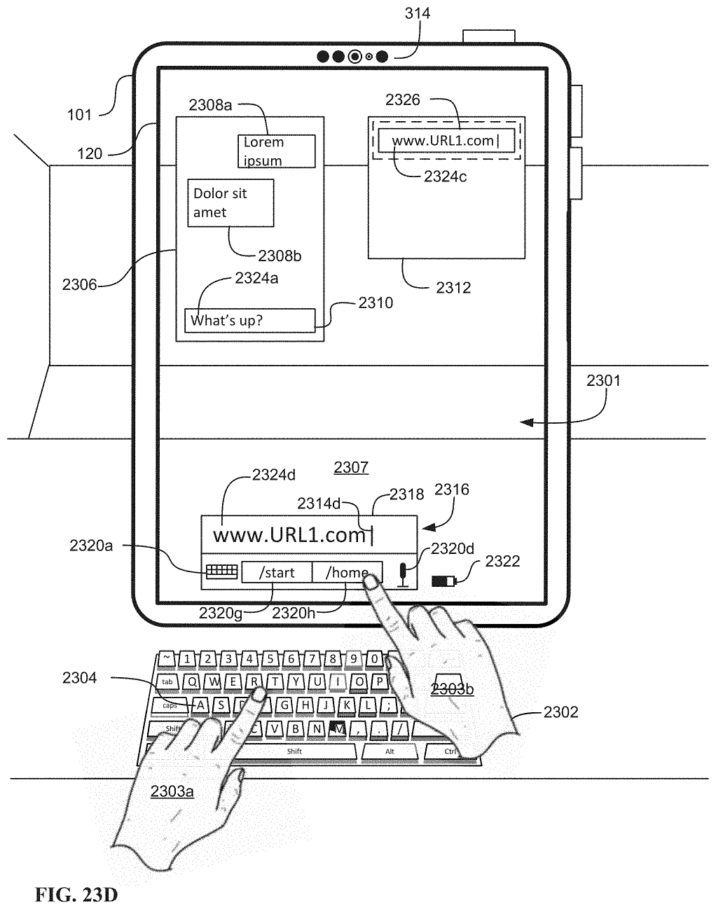

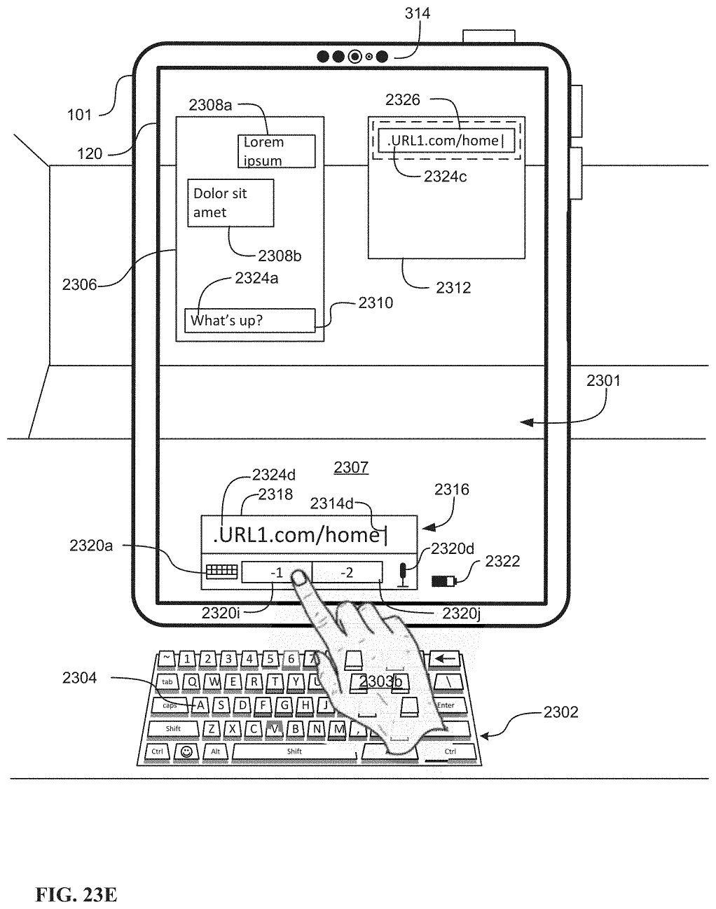

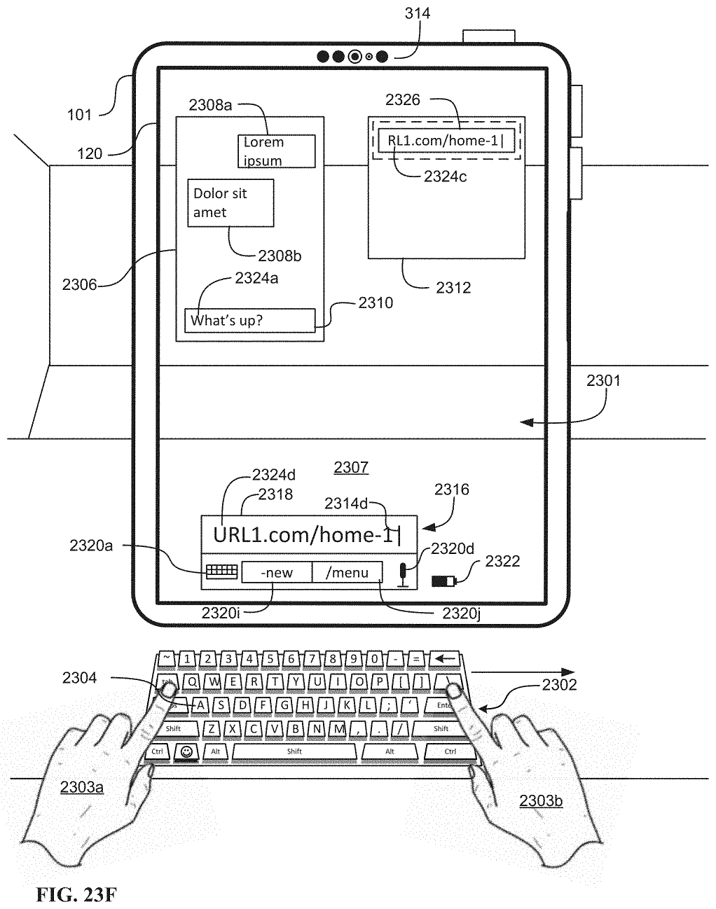

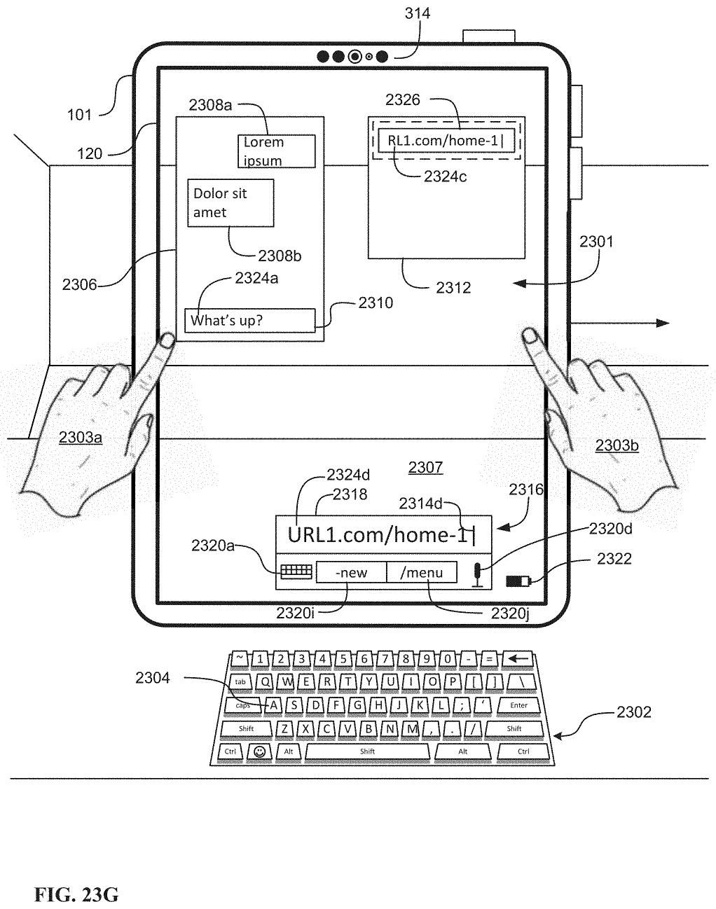

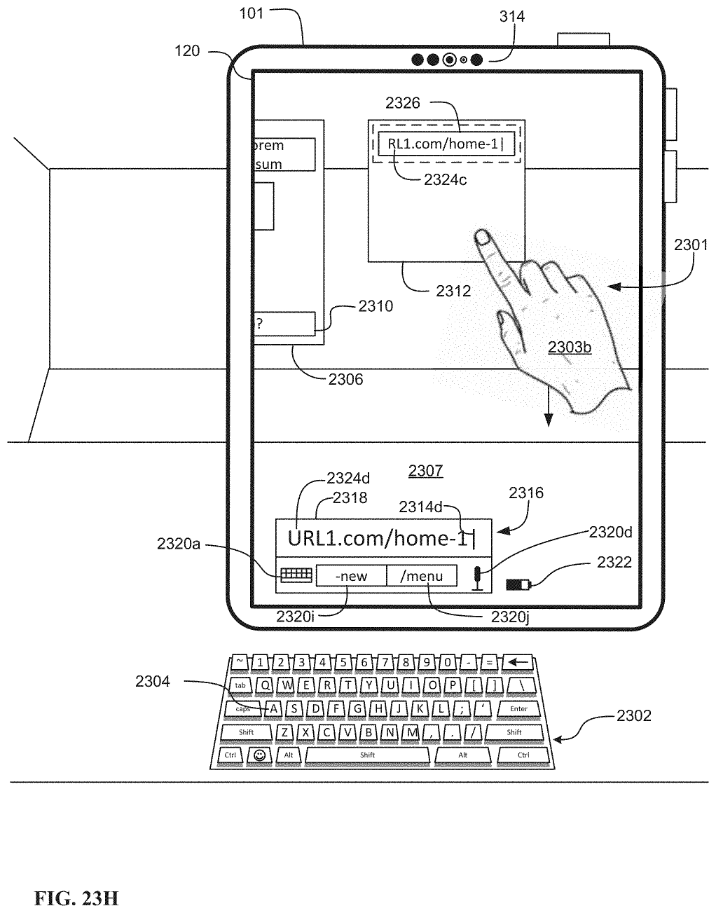

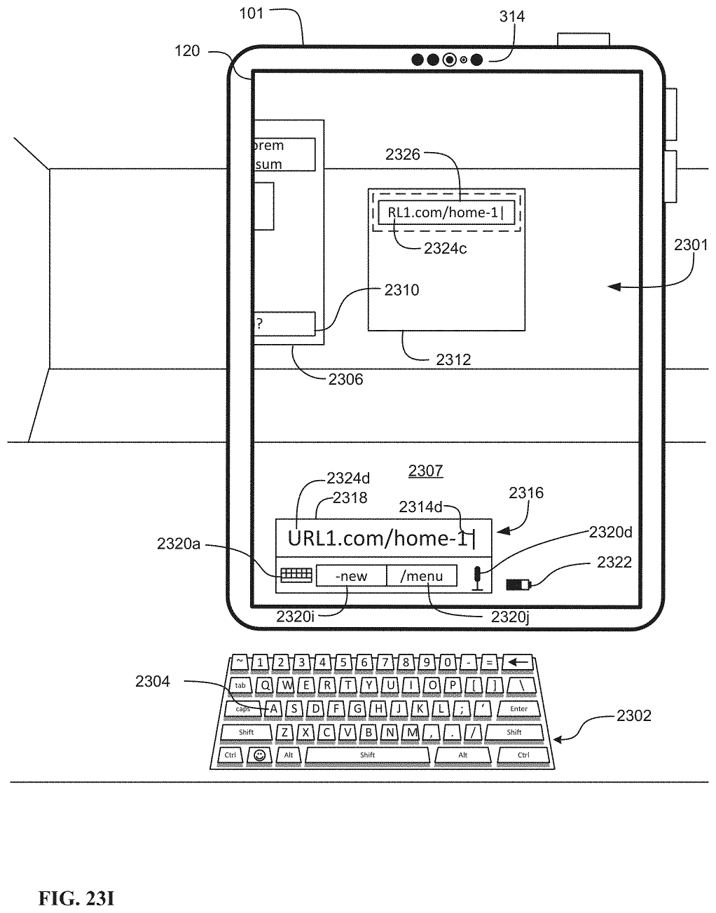

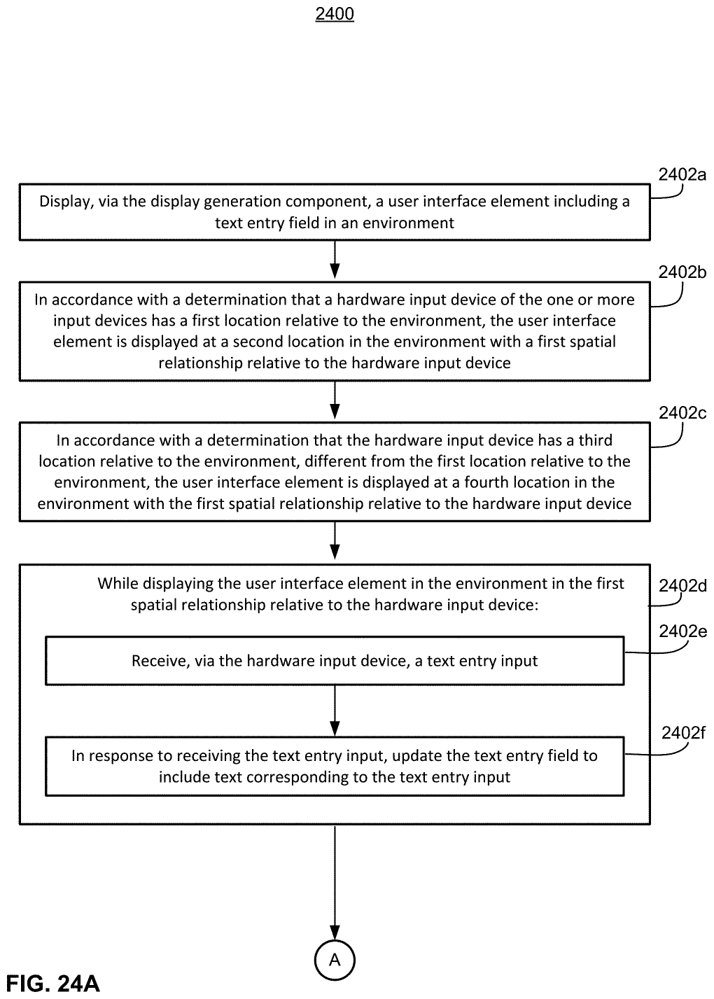

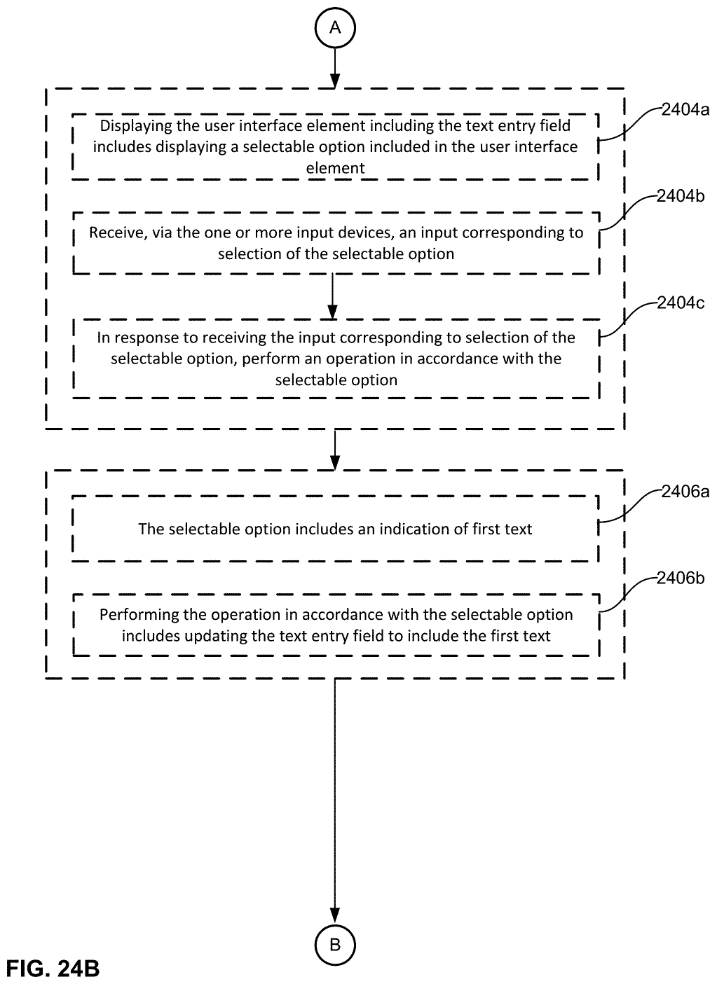

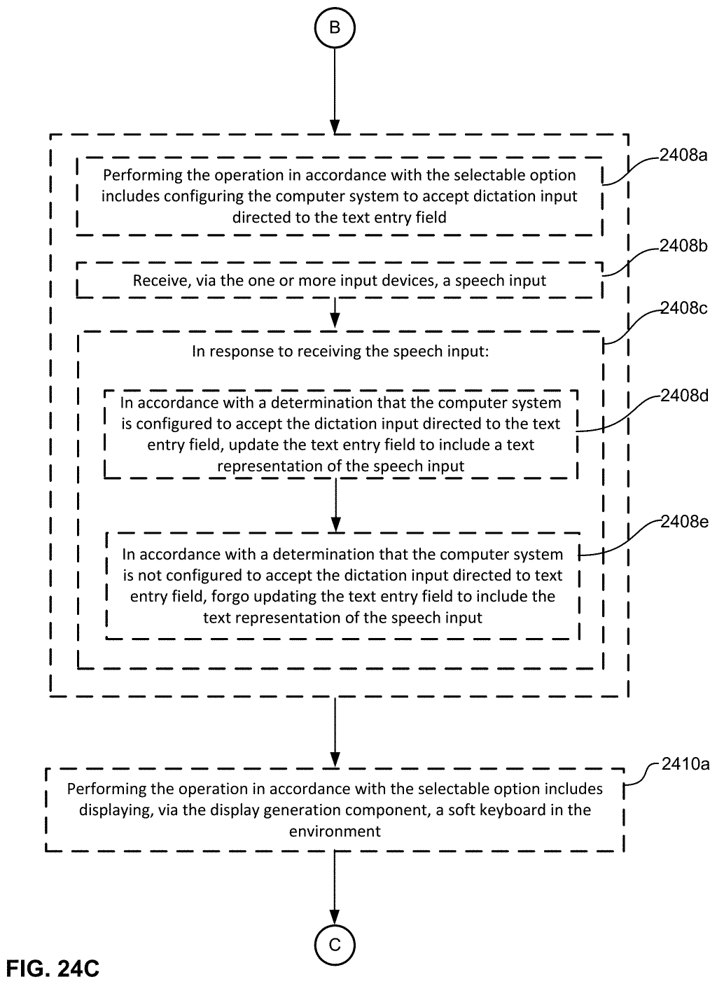

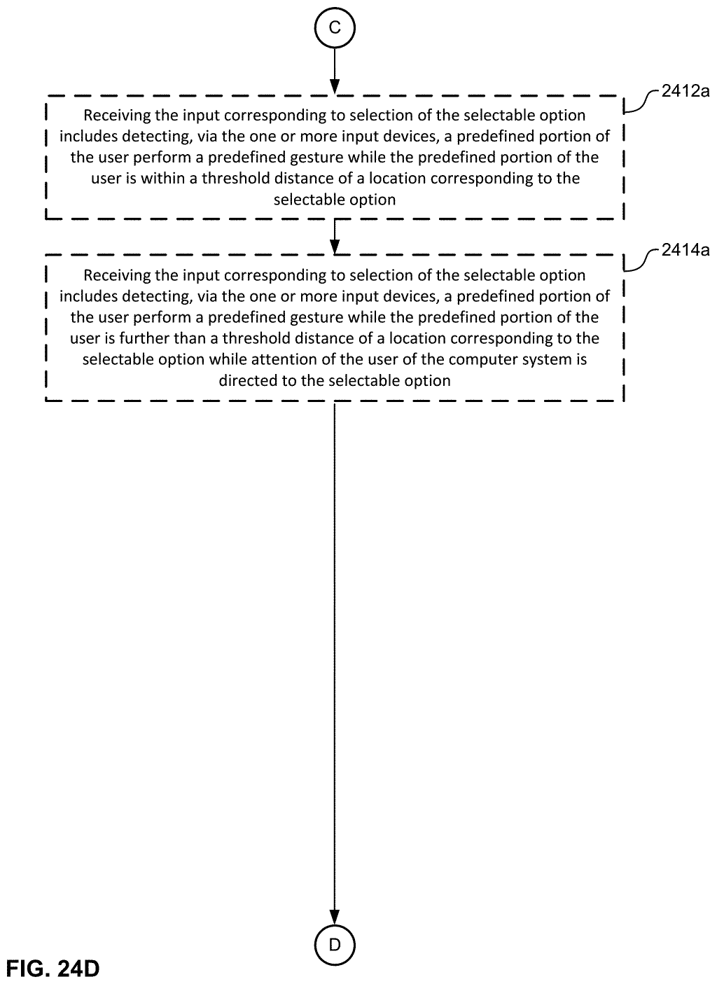

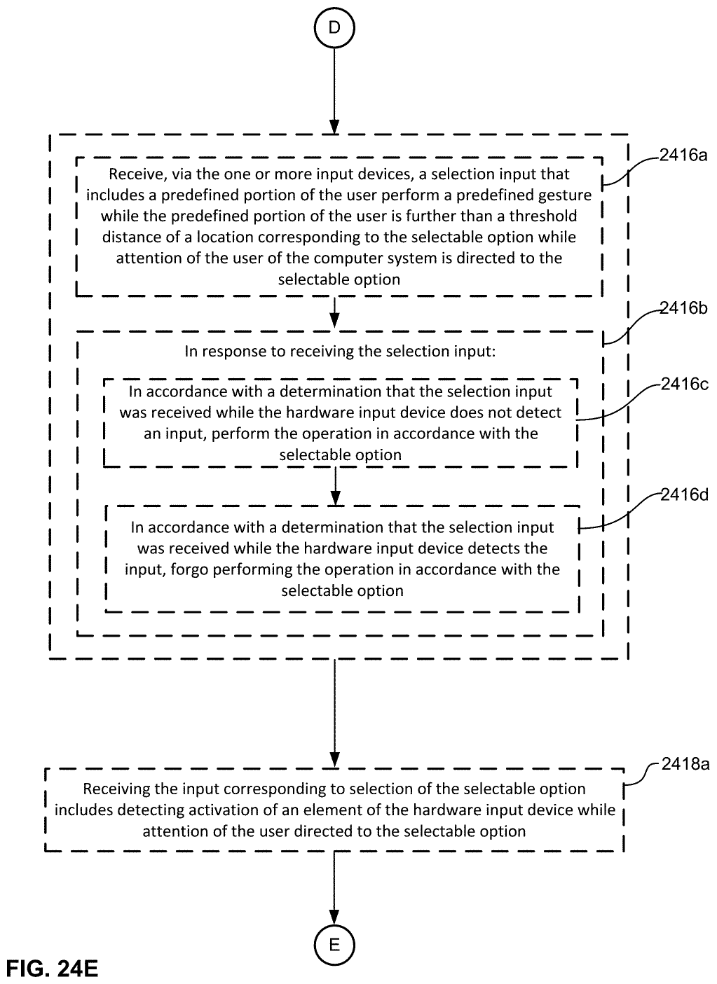

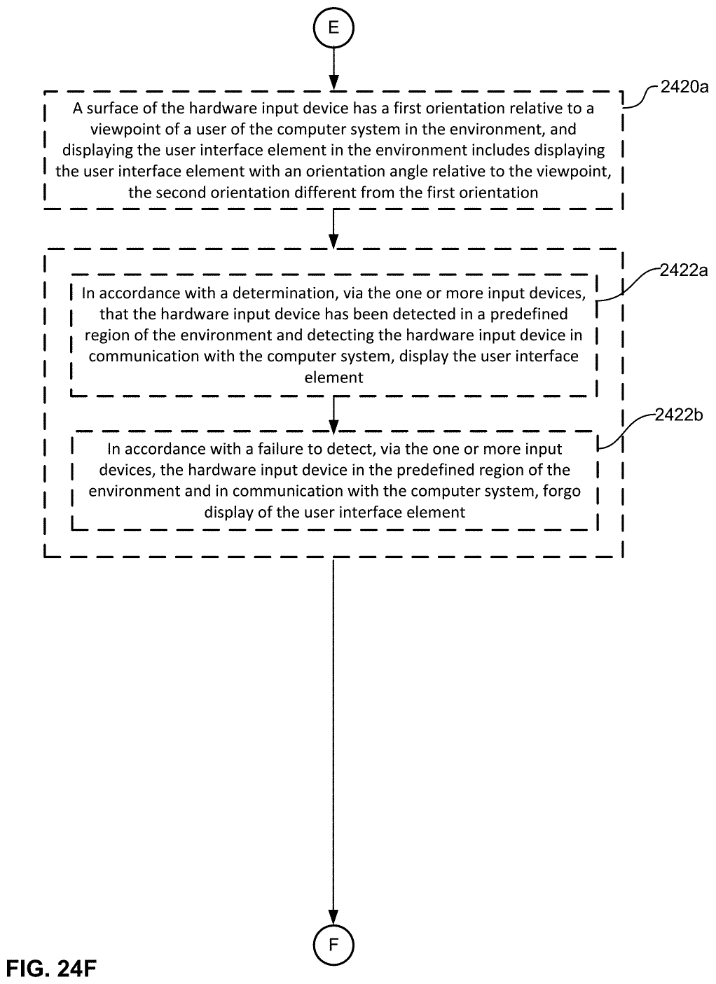

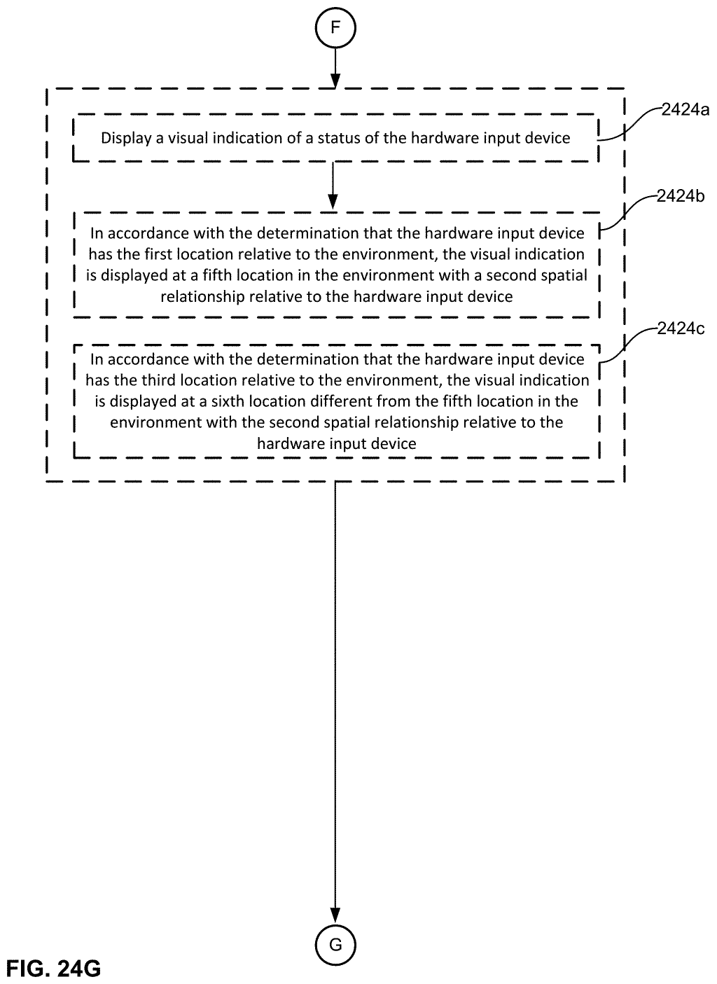

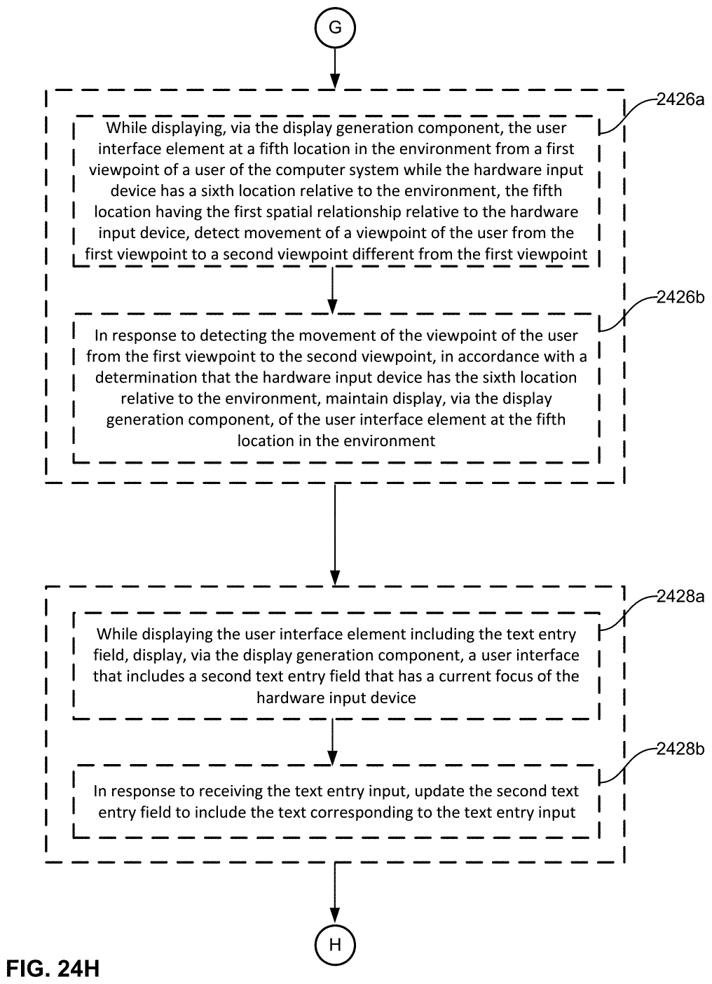

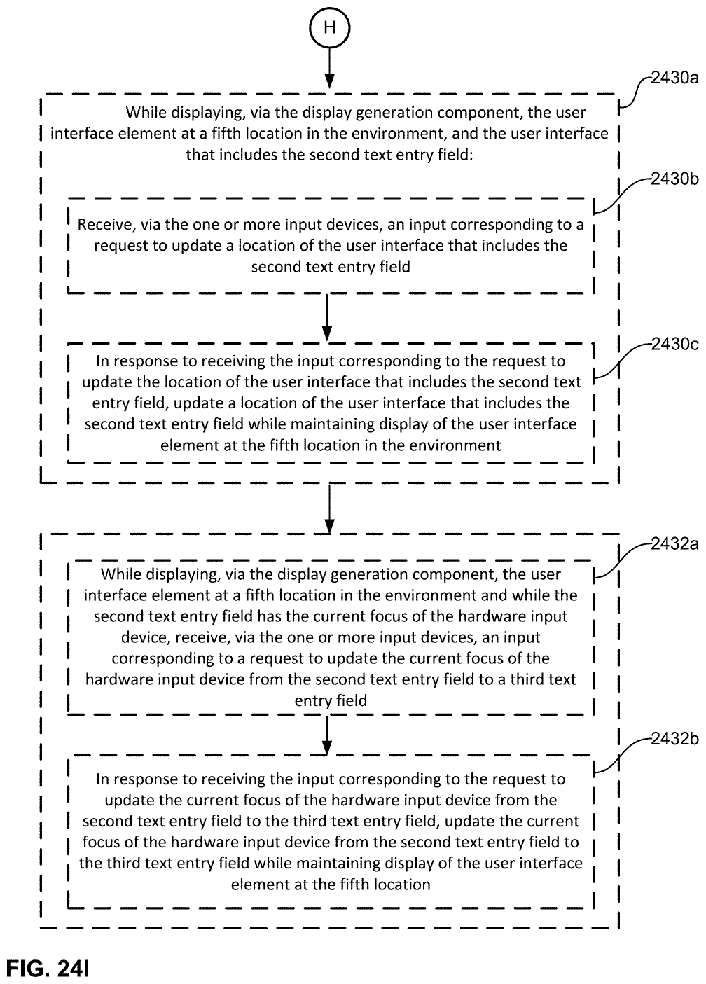

FIGS. 1-6 provide a description of example computer systems for providing XR experiences to users. FIGS. 7A-7H illustrate example techniques for scrolling scrollable content in response to a variety of user inputs in accordance with some embodiments. FIGS. 8A-8L is a flow diagram of methods of scrolling scrollable content in response to a variety of user inputs, in accordance with various embodiments. The user interfaces in FIGS. 7A-7H are used to illustrate the processes in FIGS. 8A-8L. FIGS. 9A-9N illustrate example techniques for entering text into text entry fields in response to voice inputs in accordance with some embodiments. FIGS. 10A-10R is a flow diagram of methods of entering text into text entry fields, in accordance with various embodiments. The user interfaces in FIGS. 9A-9N are used to illustrate the processes in FIGS. 10A-10R. FIGS. 11A-11O illustrate example techniques of facilitating interactions with a soft keyboard in accordance with some embodiments. FIGS. 12A-12P is a flow diagram of methods of facilitating interactions with a soft keyboard, in accordance with some embodiments. The user interfaces in FIGS. 11A-11O are used to illustrate the processes in FIGS. 12A-12P. FIGS. 13A-13E illustrate example techniques of facilitating interactions with a soft keyboard in accordance with some embodiments. FIG. 14A-14J is a flow diagram of methods of facilitating interactions with a soft keyboard in accordance with some embodiments. The user interfaces in FIGS. 13A-13E are used to illustrate the processes in FIGS. 14A-14J. FIGS. 15A-15F illustrate example techniques of facilitating interactions with a soft keyboard in accordance with some embodiments. FIGS. 16A-16K is a flow diagram of methods of facilitating interactions with a soft keyboard in accordance with some embodiments. The user interfaces in FIGS. 15A-15F are used to illustrate the processes in FIGS. 16A-16K. FIGS. 17A-17F illustrate example techniques of facilitating interactions with a cursor in accordance with some embodiments. FIGS. 18A-18E is a flow diagram of methods of facilitating interactions with a cursor in accordance with some embodiments. The user interfaces in FIGS. 17A-17F are used to illustrate the processes in FIGS. 18A-18E. FIGS. 19A-19G illustrate example techniques of entering text into a text entry field in response to receiving a speech input in accordance with some embodiments. FIGS. 20A-20M is a flow diagram of methods of entering text into a text entry field in response to receiving a speech input in accordance with some embodiments. The user interfaces in FIGS. 19A-19G are used to illustrate the processes in FIGS. 20A-20M. FIGS. 21A-21G illustrate example techniques of revising text included in a text entry field in accordance with some embodiments. FIGS. 22A-22H is a flow diagram of methods of revising text included in a text entry field in accordance with some embodiments. The user interfaces in FIGS. 21A-21G are used to illustrate the processes in FIGS. 22A-22H. FIGS. 23A-23I illustrate example techniques of updating user interface elements in accordance with a status of a hardware input device in communication with the computer system in accordance with some embodiments. FIGS. 24A-24I is a flow diagram of methods of updating user interface elements in accordance with a status of a hardware input device in communication with the computer system in accordance with some embodiments. The user interfaces in FIGS. 23A-23I are used to illustrate the processes in FIGS. 24A-24I.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.
In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, and/or a touch-screen), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, and/or velocity sensors), and optionally one or more peripheral devices 195 (e.g., home appliances and/or wearable devices). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands) A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

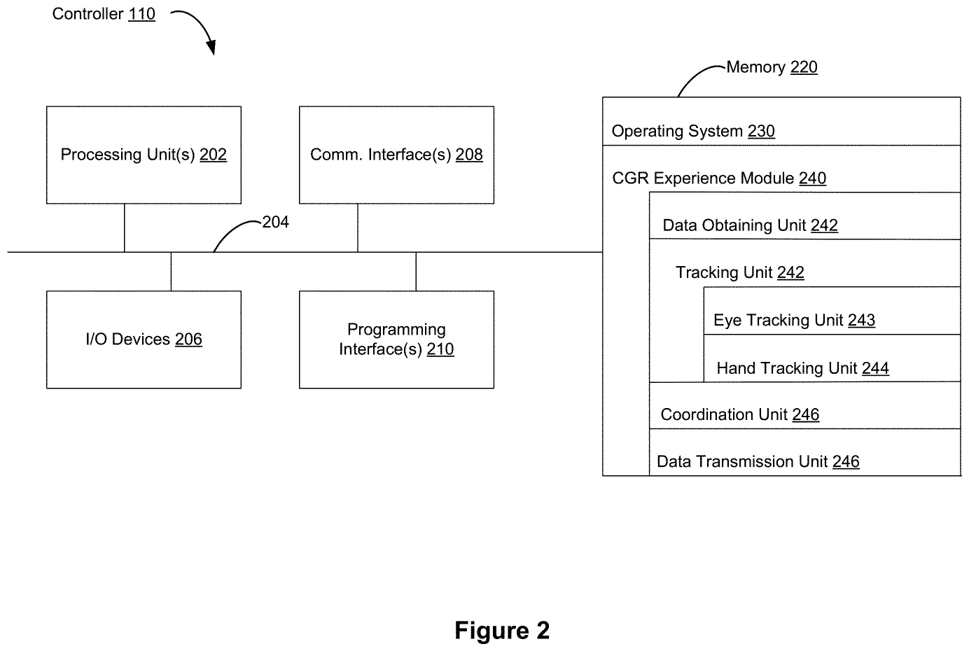

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server or central server). In some embodiments, the controller 110 is communicatively coupled with the display generation component 120 (e.g., an HMD, a display, a projector, and/or a touch-screen) via one or more wired or wireless communication channels 144 (e.g., BLUETOOTH, IEEE 802.11x, IEEE 802.16x, and/or IEEE 802.3x). In another example, the controller 110 is included within the enclosure (e.g., a physical housing) of the display generation component 120 (e.g., an HMD, or a portable electronic device that includes a display and one or more processors), one or more of the input devices 125, one or more of the output devices 155, one or more of the sensors 190, and/or one or more of the peripheral devices 195, or share the same physical enclosure or support structure with one or more of the above.

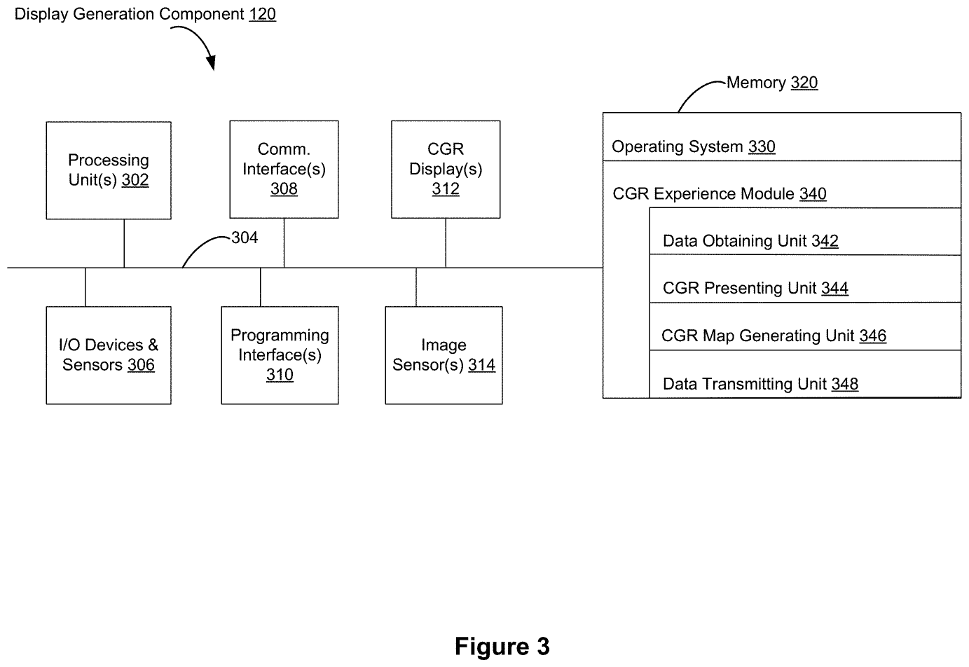

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head or on his/her hand). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, and/or location data) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

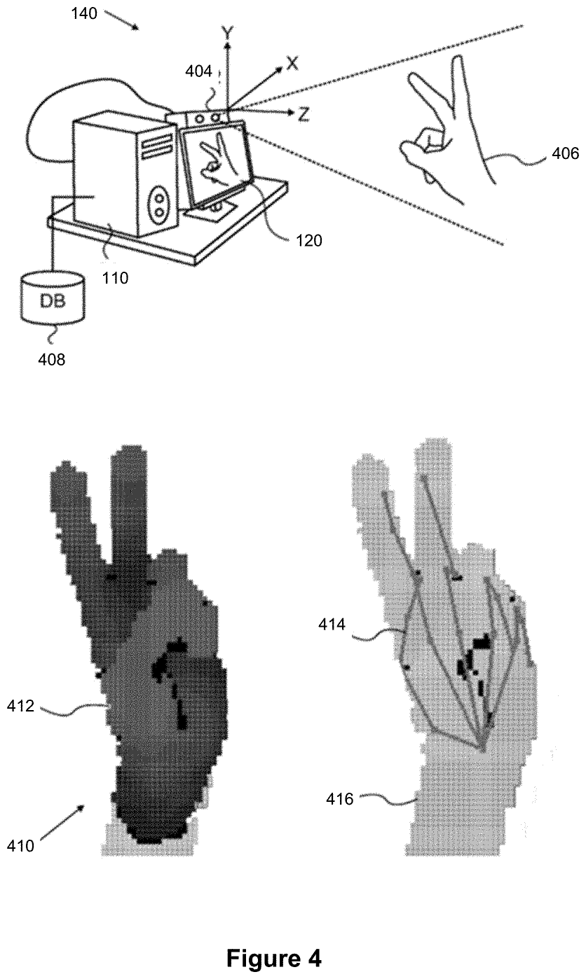

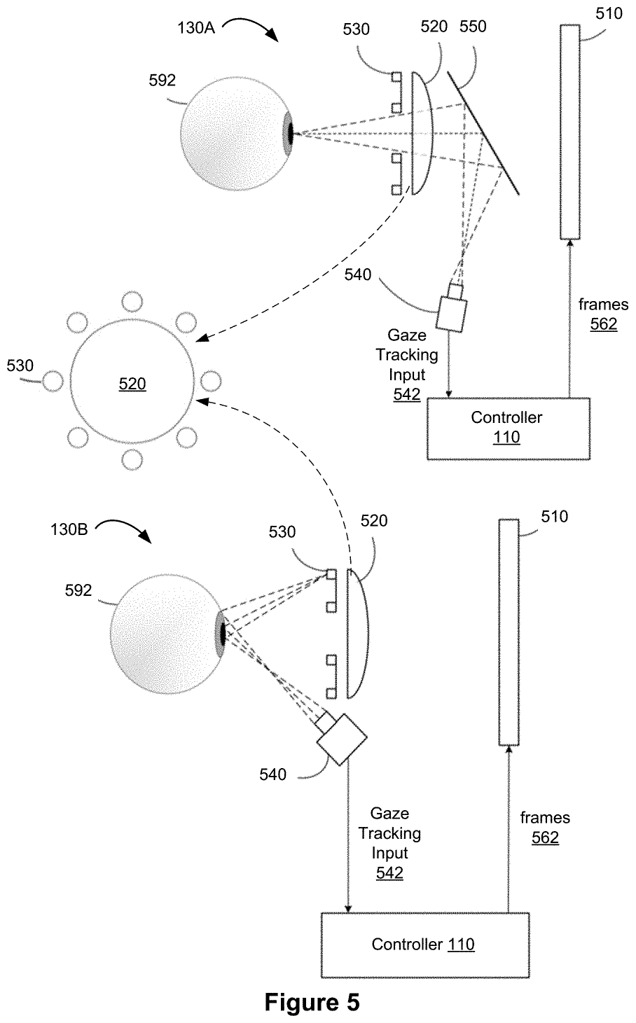

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data and/or location data) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, and/or blood glucose sensor), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, and/or waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, and/or location data) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data and/or location data) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands)

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, and/or end of the hand connecting to wrist) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, and/or eye spacing. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, and/or a projector) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

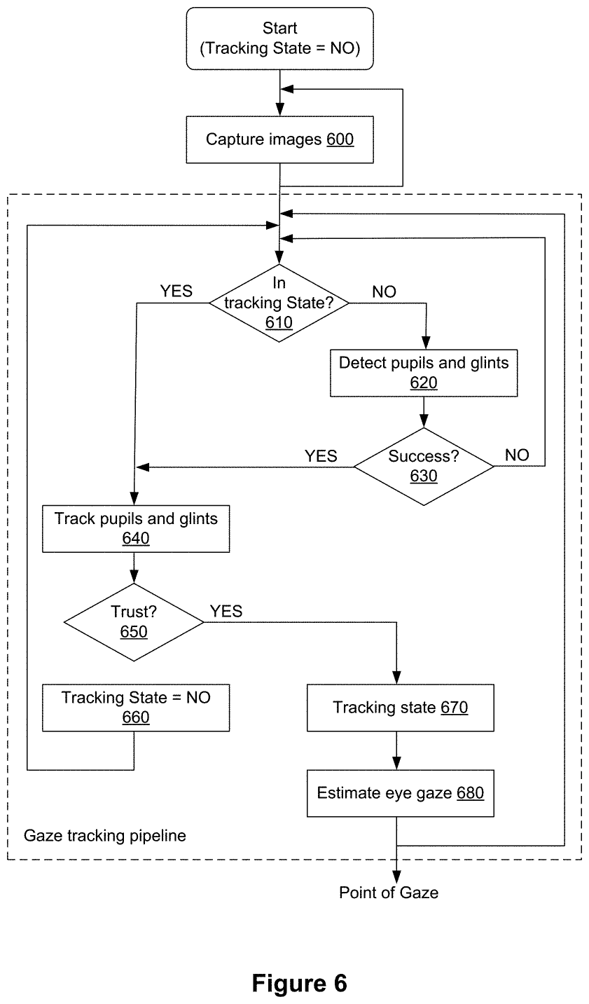

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of an computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

Similarly, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, and/or holding a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, and one or more input devices.

FIGS. 7A-7H illustrate example techniques for scrolling scrollable content in response to a variety of user inputs in accordance with some embodiments. The user interfaces in FIGS. 7A-7H are used to illustrate the processes described below, including the processes in FIGS. 8A-8L.

FIG. 7A illustrates a computer system 101 displaying, via a display generation component (e.g., display generation component 120 of FIG. 1), a three-dimensional environment 701 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

In FIG. 7A, the computer system 101 presents, via display generation component 120, scrollable content 702. In some embodiments, the scrollable content 702 includes text content 707 and additional content 705. For example, the scrollable content 702 is an article, the text content 707 is the text of the article, and the additional content 705 is an embedded advertisement, and/or one or more links to related articles. In some embodiments, the scrollable content includes a first scrolling region 704 and a second scrolling region 706. As will be described in more detail below, in response to detecting the gaze of the user directed to the first scrolling region 704 or second scrolling region 706 without detecting a ready state of a hand of the user, the computer system 101 scrolls the scrollable content 702. In some embodiments, detecting the ready state of the hand of the user includes detecting a ready state associated with an air gesture as described in more detail above. In some embodiments, in response to detecting the gaze of the user directed to region of the scrollable content 702 between scrolling regions 704 and 706, the computer system maintains display of the scrollable content 702 without scrolling the scrollable content.

As shown in FIG. 7A, in some embodiments, the scrolling regions 704 and 706 are proximate to the boundary of the scrollable content 702. For example, the scrollable content 702 is vertically scrollable, so the first scrolling region 704 is at the top of the scrollable content 702 and the second scrolling region 706 is at the bottom of the scrollable content 702. As shown in FIG. 7A, the first scrolling region 704 at the top of the scrollable content 702 is smaller than the second scrolling region 706 at the bottom of the scrollable content 702. In some embodiments, if the scrollable content 702 was horizontally scrollable, the scrollable content 702 would include a left scrolling region and a right scrolling region (e.g., instead of or in addition to a top scrolling region such as first scrolling region 704 and a bottom scrolling region such as second scrolling region 706).

As shown in FIG. 7A, the computer system 101 detects the gaze 713a of the user directed to the second scrolling region 706. In some embodiments, in response to detecting the gaze 713a of the user directed to the second scrolling region 706, the computer system 101 scrolls the scrollable content 702 down, as shown in FIG. 7B.

FIG. 7B illustrates how the computer system 101 scrolls the scrollable content 702 in response to detecting the gaze 713a of the user directed to the second scrolling region 706 in FIG. 7A. As shown in FIG. 7B, in response to detecting the gaze 713a of the user in FIG. 7A directed to the second scrolling region 706 at the bottom of the scrollable content 702, the computer system 101 scrolls the scrollable content 702 down (e.g., moves the scrollable content 702 up to reveal additional scrollable content 702 at the bottom of the scrollable content 702). In some embodiments, if the user's gaze had been directed to the first scrolling region 704 at the top of the scrollable content 702, the computer system 101, the computer system would scroll the scrollable content 702 up (e.g., move the scrollable content 702 down to reveal additional scrollable content 702 at the top of the scrollable content 702).

In some embodiments, the acceleration and/or speed of scrolling is different when scrolling up (e.g., in response to detecting the user's gaze directed to the first scrolling region 704) versus when scrolling down (e.g., in response to detecting the user's gaze directed to the second scrolling region 706). In some embodiments, the acceleration and/or speed of scrolling is faster when scrolling up (e.g., in response to detecting the user's gaze directed to the first scrolling region 704) than when scrolling down (e.g., in response to detecting the user's gaze directed to the second scrolling region 706). In some embodiments, the acceleration and/or speed of scrolling is slower when scrolling up (e.g., in response to detecting the user's gaze directed to the first scrolling region 704) than when scrolling down (e.g., in response to detecting the user's gaze directed to the second scrolling region 706).

In some embodiments, the computer system 101 gradually increases the scrolling speed of the scrollable content 702 from not scrolling to scrolling at a respective scrolling speed in response to detecting the gaze 713a of the user transition from not being directed to one of the scrolling regions 704 or 706 to being directed to one of the scrolling regions 704 or 706. As described above, the respective scrolling speed is based on which of the two scrolling regions 704 or 706 the gaze of the user is directed to. In some embodiments, the respective scrolling speed is based on the distance from the edge of the scrollable content 702 within scrolling region 704 or 706 to which the gaze of the user is detected. For example, in response to detecting the gaze 713a of the user at the position shown in FIG. 7A within the second scrolling region 706, the computer system 101 scrolls the scrollable content 702 at a first speed. In FIG. 7B, the computer system 101 detects the gaze 713b of the user directed to a different location within the second scrolling region 706 that is closer to the (e.g., bottom) edge of the scrollable content 702 compared to the location of the gaze 713a of the user as shown in FIG. 7A. In some embodiments, in response to detecting the gaze 713b of the user at the position within the second scrolling region 706 shown in FIG. 7B, the computer system 101 scrolls the scrollable content 702 at a higher speed than the speed of scrolling in response to the gaze 713a in the second scrolling region 706 as shown in FIG. 7A.

FIG. 7C illustrates the computer system 101 scrolling the scrollable content 702 in response to the gaze 713b of the user directed to the position in the second scrolling region 706 illustrated in FIG. 7B. The amount of scrolling shown in FIG. 7C is greater than the amount of scrolling shown in FIG. 7B because the gaze 713b of the user in FIG. 7B is closer to the boundary (e.g., bottom edge) of the scrollable content 702 than the location of the gaze 713a of the user in FIG. 7A.

In some embodiments, the computer system 101 ceases scrolling the scrollable content 702 in response to detecting the gaze of the user directed to a portion of the scrollable content 702 outside of the scrolling regions 704 or 706 or in response to detecting the hand of the user in the ready state while the gaze of the user is directed to one of the scrolling regions 704 or 706. For example, FIG. 7C illustrates the gaze 713d of the user directed to a portion of the scrollable content 702 that is not included in the first scrolling region 704 or the second scrolling region 706. FIG. 7C also illustrates a hand 703a of the user in the ready state (e.g., “Hand State A”) while the gaze 713c of the user is directed to the second scrolling region 706 of the scrollable content 702. In response to detecting the gaze 713d of the user illustrated in FIG. 7C or the gaze 713c of the user and ready state of the hand 703a illustrated in FIG. 7C, the computer system 101 ceases scrolling the scrollable content, as shown in FIG. 7D.

FIG. 7D illustrates the computer system 101 maintaining display of the scrollable content 702 without scrolling the scrollable content 702 in response to one of the inputs described above with respect to FIG. 7C. In some embodiments, when ceasing to scroll the scrollable content 702, the computer system 101 gradually decelerates scrolling of the scrollable content 702 until the scrolling ceases.

FIG. 7D also illustrates the computer system 101 detecting an input to scroll the scrollable content 702 provided by the hand 703b of the user. In some embodiments, the input to scroll the scrollable content 702 includes detecting the gaze 713e of the user directed to the scrollable content 702 and movement of the hand (e.g., air gesture, touch input, or other hand input) 703b while the hand 703b is in the pinch hand shape in which the thumb touches or is within a threshold distance (e.g., 0.05, 0.1, 0.2, 0.3, 0.5, or 1 centimeter) of touching another finger of the hand 703b (“Hand State C”). For example, in FIG. 7D, the computer system 101 detects the hand 703b move upwards while in the pinch hand shape while the gaze 713e of the user is directed to the scrollable content 702 and, in response, scrolls the scrollable content 702 down (e.g., by moving the scrollable content 702 up to reveal additional scrollable content 702 at the bottom of the scrollable content 702) as shown in FIG. 7E. Although FIG. 7D illustrates the gaze 713e of the user directed to a portion of the scrollable content 702 that is not in the scrolling regions 704 or 706, in some embodiments, the computer system scrolls the scrollable content 702 in response to an input including the movement of hand 703b and the gaze of the user directed to one of the scrolling regions 704 or 706 of the scrollable content 702.

FIG. 7E illustrates how the computer system 101 updates display of the scrollable content 702 by scrolling the scrollable content 702 in response to the input illustrated in FIG. 7D as described above. In FIG. 7E, the computer system 101 detects an input to scroll the scrollable content 702 up that is provided by hand 703c of the user while the gaze 713f of the user is directed to the scrollable content 702. As shown in FIG. 7E, the computer system 101 detects the hand 703c move down while in the pinch hand shape (e.g., “Hand State C”) while the gaze 713f of the user is directed to the scrollable content 702. In response to the scrolling input illustrated in FIG. 7E, the computer system 101 scrolls the scrollable content 702 up (e.g., by moving the scrollable content 702 down to reveal additional scrollable content 702 at the top of the scrollable content 702), as shown in FIG. 7F. Although FIG. 7E illustrates the gaze 713f of the user directed to a portion of the scrollable content 702 that is not in the scrolling regions 704 or 706, in some embodiments, the computer system scrolls the scrollable content 702 in response to an input including the movement of hand 703c and the gaze of the user directed to one of the scrolling regions 704 or 706 of the scrollable content 702.

FIG. 7F illustrates how the computer system 101 updates display of the scrollable content 702 by scrolling the scrollable content 702 in response to the input illustrated in FIG. 7E, as described above. In some embodiments, the computer system 101 scrolls the scrollable content 702 down by a greater amount in response to a scrolling input provided by the user's hand than the amount the computer system 101 scrolls the scrollable content 702 up in response to a scrolling input provided by the user's hand for the same amount of hand movement (e.g., air gesture, touch input, or other hand input) in opposite directions. For example, the amount of movement of the hand (e.g., air gesture, touch input, or other hand input) 703b illustrated in FIG. 7D is the same as the amount of movement of the hand (e.g., air gesture, touch input, or other hand input) 703c in FIG. 7E, but the amount of scrolling of the scrollable content 702 in FIG. 7E in response to the input in FIG. 7D is greater than the amount of scrolling of the scrollable content 702 in FIG. 7F in response to the input in FIG. 7E. In some embodiments, the “amount” of hand movement (e.g., air gesture, touch input, or other hand input) includes an amount of distance, duration, and/or speed of the movement of the hand (e.g., air gesture, touch input, or other hand input) while in the pinch shape while the gaze of the user is directed to the scrollable content 702 to provide a scrolling input directed to the scrollable content 702.

In some embodiments, the computer system 101 increases the speed of scrolling in response to an input to scroll the scrollable content 702 provided by the hand of the user, such as the inputs illustrated in FIG. 7D or 7E the further the hand moves from a location at which the pinch hand shape was initiated. For example, in response to detecting a first amount of movement of the hand (e.g., air gesture, touch input, or other hand input) from the location of the hand when the pinch hand shape was initiated, the computer system 101 scrolls the scrollable content 702 at a first speed and optionally continues to scroll at the first speed while the hand remains at the updated location following the first amount of movement. In this example, in response to detecting a second amount of movement greater than the first amount of movement of the hand (e.g., air gesture, touch input, or other hand input) from the location of the hand when the pinch hand shape was initiated, the computer system 101 scrolls the scrollable content 702 at a second speed that is greater than the first speed and optionally continues to scroll at the second speed while the hand remains at the updated location following the second amount of movement.

In some embodiments, the computer system 101 scrolls the scrollable content 702 in response to detecting the hand movement (e.g., air gesture, touch input, or other hand input) in the pinch hand shape while the gaze of the user is directed to the scrollable content 702 in accordance with a determination that the movement of the hand (e.g., air gesture, touch input, or other hand input) while the hand is in the pinch hand shape satisfies one or more criteria. In some embodiments, if the amount of movement (e.g., speed, distance, and/or duration of movement) is less than a predetermined threshold amount, the computer system 101 maintains display of the scrollable content 702 without scrolling the scrollable content 702. Example thresholds are provided below with reference to method 800 and FIGS. 8A-8L. In some embodiments, if the movement of the hand (e.g., air gesture, touch input, or other hand input) in the pinch shape is downward and exceeds a threshold speed, the computer system 101 maintains display of the scrollable content 702 without scrolling the scrollable content 702. Example threshold speeds are provided below with reference to method 800 and FIGS. 8A-8L.

In some embodiments, the computer system 101 selects one or more selectable user interface elements displayed via display generation component 120 in response to detecting the gaze of the user directed to the selectable user interface element while detecting a pinch gesture performed with the hand of the user. In some embodiments, the one or more selectable user interface elements are selectable options, representations of content items, application icons, user interface containers (e.g., windows), hyperlinks, and the like. Example actions performed in response to selection of these elements include navigating the user interface, presenting an item of content, saving or opening a file or document, initiating communication with another computer system, changing a setting of the computer system, updating the current input focus, and the like.

FIG. 7G illustrates the computer system 101 presenting the text content 707 of the scrollable content without displaying the additional content 705 of the scrollable content 702 in a reader mode of the computer system 101. The examples illustrated in FIGS. 7A-7F above are examples of the computer system 101 presenting the scrollable content 702 including the text content 707 and the additional content 705 in a browsing mode. In some embodiments, the computer system 101 transitions between displaying the content in the reader mode and displaying the content in the browsing mode in response to one or more user inputs.

In some embodiments, while the computer system 101 displays the text content 707 of the scrollable content in the reader mode as shown in FIG. 7G, the computer system 101 is configured to scroll the text content 707 in accordance with the gaze of the user being directed to a first scrolling region 708 or a second scrolling region 710 in a manner similar to the manner described above with reference to FIGS. 7A-7D with respect to the browsing mode. In some embodiments, the computer system 101 is also configured to scroll the text content 707 line by line in response to detecting the user reading the text content 707. In some situations, when people read text, once they finish reading a line of text, they direct their gaze towards the beginning of the next line by moving their gaze along the line they just read from the end of the line they just read to the beginning of the line they just read before looking at the next line. In FIG. 7G, the computer system 101 detects the gaze 713h of the user moving from the end of a line of the text content 707 to towards the beginning of the line. In response to detecting the movement of gaze 713h illustrated in FIG. 7G, the computer system 101 scrolls the text content 707 (e.g., by one line), as shown in FIG. 7H. In some embodiments, the computer system 101 scrolls the text content 707 in response to the movement of gaze 713h illustrated in FIG. 7G irrespective of whether the hand of the user is detected in the ready state or not detected.

FIG. 7H illustrates the computer system 101 displaying the text content 707 after scrolling the text content 707 in accordance with the movement of the gaze 713h of the user illustrated in FIG. 7G. As shown in FIG. 7H, the computer system 101 scrolls the text content 707 by one line of the text content 707 in response to the movement of the gaze 713h illustrated in FIG. 7G in some embodiments.

In some embodiments, the computer system 101 displays a definition 712 of a word in response to detecting the gaze of the user directed to the word for at least a predetermined threshold time. Example time thresholds are provided below with reference to method 800 and FIGS. 8A-8L. For example, in FIG. 7H, the computer system 101 detects the gaze 713i of the user directed to a word for the time threshold and, in response, displays the definition 712 of the word overlaid on the text content 707. In some embodiments, the computer system 101 similarly displays definitions of words while displaying the scrollable content 702 including the text content 707 and additional content 705 in the browsing mode illustrated in FIGS. 7A-7F. Additional descriptions regarding FIGS. 7A-7H are provided below in reference to method 800 described with respect to FIGS. 7A-7H.

FIGS. 8A-8L is a flow diagram of methods of scrolling scrollable content in response to a variety of user inputs, in accordance with various embodiments. In some embodiments, method 800 is performed at a computer system (e.g., computer system 101 in FIG. 1) including a display generation component (e.g., display generation component 120 in FIGS. 1, 3, and 4). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

In some embodiments, method 800 is performed at a computer system (e.g., 101) in communication with a display generation component and one or more input devices (e.g., 314), such as in FIG. 7A (e.g., a mobile device (e.g., a tablet, a smartphone, a media player, or a wearable device), or a computer). In some embodiments, the display generation component is a display integrated with the computer system (optionally a touch screen display), external display such as a monitor, projector, television, or a hardware component (optionally integrated or external) for projecting a user interface or causing a user interface to be visible to one or more users. In some embodiments, the one or more input devices include a computer system or component capable of receiving a user input (e.g., capturing a user input and/or detecting a user input) and transmitting information associated with the user input to the computer system. Examples of input devices include a touch screen, mouse (e.g., external), trackpad (optionally integrated or external), touchpad (optionally integrated or external), remote control device (e.g., external), another mobile device (e.g., separate from the computer system), a handheld device (e.g., external), a controller (e.g., external), a camera, a depth sensor, an eye tracking device, and/or a motion sensor (e.g., a hand tracking device and/or a hand motion sensor). In some embodiments, the computer system is in communication with a hand tracking device (e.g., one or more cameras, depth sensors, proximity sensors, and/or touch sensors (e.g., a touch screen or trackpad). In some embodiments, the hand tracking device is a wearable device, such as a smart glove. In some embodiments, the hand tracking device is a handheld input device, such as a remote control or stylus.

In some embodiments, such as in FIG. 7A, the computer system (e.g., 101) displays (802a), via the display generation component, a user interface (e.g., 702) including scrollable content (e.g., 705 or 707). In some embodiments, the scrollable content includes text and/or images. In some embodiments, the scrollable content exceeds the size of a scrollable user interface element in which the scrollable content is displayed. In some embodiments, in response to a request to scroll the scrollable content, the computer system ceases display of a first portion of the scrollable content and initiates display of a second portion of the content, optionally while maintaining display of a third portion of content within the scrollable user interface element. In some embodiments, the scrollable content is displayed within a three-dimensional environment. In some embodiments, the three-dimensional environment includes virtual objects, such as application windows, operating system elements, representations of other users, and/or content items and representations of physical objects in the physical environment of the computer system. In some embodiments, the representations of physical objects are displayed in the three-dimensional environment via the display generation component (e.g., virtual or video passthrough). In some embodiments, the representations of physical objects are views of the physical objects in the physical environment of the computer system visible through a transparent portion of the display generation component (e.g., true or real passthrough). In some embodiments, the computer system displays the three-dimensional environment from the viewpoint of the user at a location in the three-dimensional environment corresponding to the physical location of the computer system in the physical environment of the computer system. In some embodiments, the three-dimensional environment is generated, displayed, or otherwise caused to be viewable by the device (e.g., a computer-generated reality (CGR) environment such as a virtual reality (VR) environment, a mixed reality (MR) environment, or an augmented reality (AR) environment).

In some embodiments, such as in FIG. 7A, the computer system (e.g., 101) detects (802b), via the one or more input devices (e.g., an eye tracking device 314), a gaze (e.g., 713a) of the user directed to the scrollable content (e.g., 705 or 707).

In some embodiments, such as in FIG. 7C, in response to detecting the gaze (e.g., 713d) of the user directed to the scrollable content (802c), in accordance with a determination that the gaze (e.g., 713d) of the user is directed to a first region of the scrollable content (e.g., 707), the computer system (e.g., 101) maintains (802d) display of the scrollable content (e.g., 707) without scrolling the scrollable content (e.g., 707). In some embodiments, the first region of the scrollable content is away from one or more directions in which the scrollable content is scrollable. For example, if the scrollable content is vertically scrollable, the first region of the scrollable content is a region of the scrollable content between a top portion and a bottom portion of the scrollable content. As another example, if the scrollable content is horizontally scrollable, the first region of the scrollable content is a region of the scrollable content between a left portion and a right portion of the scrollable content. In some embodiments, while the computer system detects the gaze of the user directed to the scrollable content, the computer system does not detect an additional input (e.g., via one or more input devices other than the eye tracking device) corresponding to a request to scroll the content.

In some embodiments, such as in FIG. 7B, in response to detecting the gaze (e.g., 713b) of the user directed to the scrollable content (e.g., 707) (802c), in accordance with a determination that the gaze (e.g., 713b) of the user is directed to a second region (e.g., 706), different from the first region, of the scrollable content (e.g., 707) and a respective portion (e.g., hand or head) of the user meets respective criteria, the computer system (e.g., 101) scrolls (802e) the scrollable content (e.g., 707) in accordance with the gaze (e.g., 713b) of the user. In some embodiments, the respective portion of the user meets the respective criteria when the respective portion of the user is in a predefined pose relative to the torso of the user or another reference point (e.g., in the three-dimensional environment). For example, the hand of the user satisfies the respective criteria when it is at the user's side, in the user's lap, or otherwise not raised (e.g., outside of a predefined region of the three-dimensional environment with a respective spatial orientation relative to the torso of the user).

In some embodiments, such as in FIG. 7C, in response to detecting the gaze (e.g., 713c) of the user directed to the scrollable content (e.g., 707) (802c), in accordance with a determination that the gaze (e.g., 713c) of the user is directed to the second region (e.g., 706) and the respective portion (e.g., 703a) of the user does not meet the respective criteria, the computer system (e.g., 101) maintains (8020 display of the scrollable content (e.g., 707) without scrolling the scrollable content (e.g., 707). In some embodiments, the second region is towards one or more directions in which the scrollable content is scrollable. For example, if the scrollable content is vertically scrollable, the second region of the scrollable content is a top or bottom region of the scrollable content. As another example, if the scrollable content is horizontally scrollable, the second region of the scrollable content is a left or right region of the scrollable content. In some embodiments, the computer system scrolls the scrollable content to reveal a portion of the scrollable content that was not displayed when the gaze of the user was (e.g., initially) detected and displays the portion of the scrollable content in the second region or in a region proximate to the second region. In some embodiments, in response to detecting the gaze of the user directed to the first region of the scrollable content, the computer system scrolls the content in a first direction to reveal a new portion of the content at a location at or proximate to the first region. In some embodiments, in response to detecting the gaze of the user directed to the second region of the scrollable content, the computer system scrolls the content in a second direction to reveal the new portion of the content at a location at or proximate to the second region, as will be described in more detail below.

Scrolling the scrollable content in accordance with the gaze of the user provides an efficient way of navigating the scrollable content and enhances user interactions with the computer system by reducing the number of inputs needed to perform an operation (e.g., scrolling in response to gaze instead of scrolling in response to an input in addition to or instead of gaze detection).

In some embodiments, such as in FIG. 7B, the respective criteria include a criterion that is satisfied when the respective portion (e.g., 703a) of the user is not detected in a predefined pose (804) (e.g., a hand of the user is not in the ready state and/or a hand of the user is not visible). In some embodiments, detecting the predefined pose includes detecting the respective portion of the user in the ready state. In some embodiments, the criterion is satisfied when the respective portion of the user is in a resting pose and/or in a pose that does not indicate intent to interact with the computer system. For example, the respective portion of the user is the hand of the user and the criterion is satisfied when the hand is in the user's lap, at the user's side, not in a field of view of a hand tracking device, or otherwise not raised and/or not in the ready state. In some embodiments, while scrolling the scrollable content in accordance with the gaze of the user, in response to detecting the respective portion of the user in the predefined pose (e.g., detecting the ready state) while the user continues to look at the second region, the computer system ceases scrolling the scrollable content.

Displaying the scrollable content without scrolling the scrollable content in response to detecting the respective portion of the user in a pose other than the predefined pose enhances user interactions with the computer system by providing additional control options without cluttering the user interface with additional displayed controls.

In some embodiments, while displaying the user interface including the scrollable content (e.g., 707) (806a), the computer system (e.g., 101) detects (806b), via the one or more input devices, an input directed to a respective user interface element (e.g., a user interface element in the scrollable content), wherein detecting the input includes detecting gaze of the user directed to the respective user interface element and detecting the user perform a respective gesture with the respective portion of the user, such as detecting gaze 713e in FIG. 7D directed to a selectable user interface element and detecting hand 703b make the respective gesture. In some embodiments, the input is an air gesture. In some embodiments, detecting the user perform a respective gesture with the respective portion of the user includes detecting the user perform a gesture with their hand included in an air gesture input (e.g., pinch gesture or tap gesture). In some embodiments, the respective portion of the user does not meet the respective criteria when the computer system detects the respective gesture. in some embodiments, the input corresponds to a request to select the respective user interface element.

In some embodiments, while displaying the user interface including the scrollable content (806a), in response to detecting the input directed to the respective user interface element, the computer system (e.g., 101) performs (806c) an operation associated with the respective user interface element. In some embodiments, the operation associated with the respective user interface element is an operation performed in response to detecting selection of the respective user interface element. For example, in response to detecting the input directed to an option to navigate to a respective user interface, the computer system presents the respective user interface. As another example, in response to detecting the input directed to an option to play or pause a content item, the computer system plays or pauses the content item.

Performing an operation associated with the respective user interface element in response to detecting the input directed to the respective user interface element that includes detection of the gaze of the user and the respective gesture with the respective portion of the user enhances user interactions with the computer system by providing additional control options without cluttering the user interface with additional displayed controls.

In some embodiments, such as in FIG. 7A, the second region (e.g., 706) of the scrollable content includes an edge of the scrollable content (e.g., 707) (808). In some embodiments, the second region includes and/or is located proximate to a top, bottom, left, or right edge of the scrollable content. In some embodiments, the second region includes and/or is located at an edge corresponding to a direction in which the scrollable content is scrollable. For example, the second region includes or is proximate to a top or bottom edge of vertically scrollable content or the second region includes or is proximate to a left or right edge of horizontally scrollable content. Including an edge of the scrollable content in the second region enhances user interactions with the computer system by providing additional control options without cluttering the user interface.

In some embodiments, such as in FIGS. 7A-7B, the computer system (e.g., 101) scrolls the scrollable content (e.g., 707) in a first direction in accordance with the determination that the gaze of the user is directed to the second region (e.g., 706). For example, the computer system scrolls the scrollable content down in accordance with a determination the gaze of the user is directed to a region along the bottom of the scrollable content. As another example, the computer system scrolls the scrollable content up in accordance with a determination that the gaze of the user is directed to a region along the top of the scrollable content.

In some embodiments, while displaying, via the display generation component (e.g., 120), the user interface (e.g., 702) including the scrollable content (e.g., 707), in response to detecting the gaze of the user directed to the scrollable content (e.g., 707), in accordance with a determination that the gaze of the user is directed to a third region (e.g., region 704 in FIG. 7B) of the scrollable content, the third region (e.g., 704) different from the second region (e.g., 706) and different from the first region, and the respective portion of the user meets the respective criteria, the computer system (e.g., 101) scrolls (810b) the scrollable content (e.g., 707) in a second direction different from the first direction, such as in FIG. 7F, in accordance with the gaze of the user, wherein the second region (e.g., 706) and the third region (e.g., 704) have different sizes. In some embodiments, the second direction is opposite from the first direction and the third region is disposed along an opposite edge of the scrollable content than an edge of the scrollable content along which the second region is disposed. In some embodiments, the second region and third region have a same size along a first direction (e.g., width, length and/or height) and a different size along a second direction (e.g., width, length and/or height). For example, the second region and third region have the same widths and different heights.

Scrolling the scrollable content in different directions depending on whether the gaze of the user is directed to the second region or the third region enhances user interactions with the computer system by providing additional control options without cluttering the user interface with additional displayed controls.

In some embodiments, such as in FIG. 7A, the second portion (e.g., 706) of the scrollable content (e.g., 707) is located at a bottom of the scrollable content (e.g., 707) and has a first size (812a) (e.g., height, width, or length). In some embodiments, in response to detecting the gaze of the user directed to the second region while the respective portion of the user meets the respective criteria, the computer system scrolls the scrollable content down.

In some embodiments, such as in FIG. 7A, the third portion (e.g., 704) of the scrollable content (e.g., 707) is located at a top of the scrollable content (e.g., 707) and has a second size (e.g., height, width, or length) smaller than the first size (812b). In some embodiments, in response to detecting the gaze of the user directed to the third region while the respective portion of the user meets the respective criteria, the computer system scrolls the scrollable content up. In some embodiments, the height of the third region is smaller than the height of the second region. In some embodiments, the widths of the second region and third region are the same. In some embodiments, the widths of the second region and third region are different.

Providing the third region at the top of the scrollable content that is smaller than the second region of the scrollable content at the bottom of the scrollable content enhances user interactions with the computer system by providing additional control options to the user without cluttering the user interface.

In some embodiments, scrolling the scrollable content (e.g., 707) in accordance with the gaze of the user includes (814a), in accordance with a determination that the gaze (e.g., 713a) of the user is directed to a location that is a first distance from a respective position of the scrollable content (e.g., 707), such as in FIG. 7A, scrolling (814b) the scrollable content (e.g., 707) with a first speed in accordance with the gaze of the user, such as in FIG. 7B. In some embodiments, the respective position of the scrollable content is a boundary of the second region and/or the start/end of the scrollable content. In some embodiments, the boundary of the second region of the scrollable content is a boundary of the second region or is proximate to the boundary of the second region. For example, if the second region is along the bottom of the scrollable content, the boundary is the bottom region of the scrollable content.

In some embodiments, scrolling the scrollable content (e.g., 707) in accordance with the gaze of the user includes (814a), in accordance with a determination that the gaze (e.g., 713b) of the user is directed to a location that is a second distance from the respective position of the scrollable content (e.g., 707) different from the first distance, such as in FIG. 7B, scrolling (814c) the scrollable content (e.g., 707) with a second speed different from the first speed in accordance with the gaze of the user, such as in FIG. 7C. In some embodiments, the scrolling speed is greater the closer the gaze is to the boundary of the scrollable content. In some embodiments, the speed of scrolling changes as the gaze of the user moves within the second region of the scrollable content. For example, the scrolling speed gradually increases as the gaze of the user moves towards the respective position of the scrollable content.

Scrolling the scrollable content at different speeds depending on the distance between the gaze of the user and the respective position of the scrollable content enhances user interactions with the computer system by providing additional control options without cluttering the user interface with additional displayed controls.

In some embodiments, while the gaze (e.g., 713b) of the user is directed to the second region (e.g., 706) of the scrollable content (e.g., 707) and the respective portion of the user meets the respective criteria, and while scrolling the scrollable content (e.g., 707) in accordance with the gaze of the user, such as in FIG. 7B, the computer system (e.g., 101) detects (816a), via the one or more input devices, the gaze (e.g., 713d) of the user directed away from the second region of the scrollable content, such as in FIG. 7C. In some embodiments, the computer system detects the gaze of the user directed to the first region of the scrollable content. In some embodiments, the computer system detects the gaze of the user directed to a region of the three-dimensional environment that does not include the scrollable content. In some embodiments, the computer system detects the user direct their gaze away from the three-dimensional environment or close their eyes for more than a threshold time (e.g., 0.1, 0.2, 0.3, 0.5, 1, 2, or 3 seconds) associated with blinking.

In some embodiments, in response to detecting the gaze (e.g., 713d) of the user directed away from the second region (e.g., 706) of the scrollable content (e.g., 707), such as in FIG. 7C, the computer system (e.g., 101) decreases (816b) a speed at which the scrollable content is scrolling until the scrolling of the scrollable content (e.g., 707) is ceased, such as in FIG. 7D. In some embodiments, the computer system ceases scrolling the scrollable content in response to detecting the gaze of the user directed away from the second region of the scrollable content by decelerating the speed of scrolling with simulated inertia until the scrolling ceases. In some embodiments, in response to detecting the gaze of the user directed to the second region of the scrollable content while the respective portion of the user meets the respective criteria while decelerating the scrolling speed of the scrollable content and continuing to scroll the scrollable content, the computer system accelerates the scrolling speed of the scrollable content. In some embodiments, in this situation, the computer system increases the scrolling speed until the scrolling speed reaches a predetermined speed (e.g., a speed associated with the location within the second region at which the user is looking as described above).

Decelerating the scrolling of the scrollable content until the scrolling is ceased in response to detecting the gaze of the user directed away from the second region of the scrollable content enhances user interactions with the computer system by providing improved visual feedback to the user (e.g., indicating to the user that the scrolling will cease if the user continues to look away from the second region).

In some embodiments, scrolling the scrollable content (e.g., 707) in accordance with the gaze of the user in accordance with the determination that the gaze (e.g., 713a) of the user is directed to the second region (e.g., 706) and the respective portion of the user meets the respective criteria in response to detecting the gaze (e.g., 713a) of the user directed to the scrollable content (e.g., 707), such as in FIG. 7A, includes gradually increasing a speed of scrolling the scrollable content (e.g., 707) while the gaze (e.g., 713a) of the user is directed to the second region (e.g., 706) and the respective portion of the user meets the respective criteria (818). In some embodiments, the computer system gradually increases the scrolling speed until the scrolling speed reaches a predetermined speed (e.g., a speed associated with the location within the second region at which the user is looking, as described above). In some embodiments, the computer system gradually decreases scrolling speed to zero in response to the user directing their gaze from the second region to the first region as described above. In some embodiments, the computer system gradually changes the scrolling speed in response to the user updating their gaze to a location a different distance from the edge of the content within the second region.

Gradually increasing the scrolling speed of the scrollable content in response to detecting the gaze of the user directed to the second region of the scrollable content enhances user interactions with the computer system by providing improved visual feedback to the user (e.g., indicating to the user that the scrolling will continue if the user continues to look at the second region).

In some embodiments, while displaying the user interface (e.g., 702) including the scrollable content (e.g., 707) (820a) (e.g., without scrolling the scrollable content), the computer system (e.g., 101) detects (820b), via the one or more input devices (e.g., a hand tracking device), the respective portion of the user perform a respective gesture that includes movement of a hand (e.g., 703b) of the user while the hand of the user is in a pinch hand shape, such as in FIG. 7D, wherein the respective portion of the user does not meet the respective criteria while performing the respective gesture. In some embodiments, the respective gesture includes detecting the user make the pinch shape (e.g., a hand shape in which the thumb is within a threshold distance (e.g., 0.1, 0.2, 0.3, 0.5 or 1 centimeter) of or touching another finger of the hand) with their hand and move their hand while maintaining the pinch shape. In some embodiments, in response to detecting the user cease making the pinch gesture with their hand, the computer system ceases scrolling the scrollable content in accordance with further movement of the hand (e.g., air gesture, touch input, or other hand input) detected while the hand is not in the pinch shape.

In some embodiments, while displaying the user interface (e.g., 702) including the scrollable content (e.g., 707) (820a) (e.g., without scrolling the scrollable content), in response to detecting the respective portion (e.g., 703b) of the user perform the respective gesture and in accordance with a determination that one or more criteria are satisfied, the computer system (e.g., 101) scrolls (820c) the scrollable content (e.g., 707) in accordance with the movement of the hand (e.g., air gesture, touch input, or other hand input) (e.g., 703c) of the user, such as in FIG. 7E. In some embodiments, the computer system scrolls the scrollable content in accordance with movement of the hand (e.g., air gesture, touch input, or other hand input) while the hand is in a pinch shape. For example, the computer system scrolls the content in the same direction as the direction in which the hand moves while in the pinch shape and by an amount that corresponds to an amount of the (e.g., speed, duration, and/or distance of the) movement. In some embodiments, while scrolling the scrollable content in accordance with an air gesture input, the computer system does not scroll the scrollable content in accordance with gaze. For example, in response to detecting the gaze of the user directed to the second region of the scrollable content while detecting an air gesture input (e.g., corresponding to a request to scroll the scrollable content, corresponding to a different request with respect to the scrollable content, or corresponding to a request independent from the scrollable content), the computer system forgoes scrolling the scrollable content in accordance with the gaze being directed to the second region of the scrollable content.

Scrolling the scrollable content in accordance with the movement of the hand (e.g., air gesture, touch input, or other hand input) of the user while the hand of the user is in the pinch hand shape enhances user interactions with the computer system by providing additional control options without cluttering the user interface with additional displayed controls.

In some embodiments, such as in FIG. 7D, the (e.g., speed, distance, and/or duration) movement of the respective portion (e.g., 703b) of the user has a respective magnitude (822a).

In some embodiments, in accordance with a determination that the movement of the respective portion (e.g., 703b) of the user is in a first direction, such as in FIG. 7D, the computer system (e.g., 101) scrolls the scrollable content (e.g., 707) by a first amount in a second direction in response to detecting the respective portion (e.g., 703b) of the user perform the respective gesture (822b), such as in FIG. 7E. In some embodiments, the second direction in which the computer system scrolls the scrollable content corresponds to the first direction of movement of the respective portion of the user. In some embodiments, the second direction and first direction are the same direction (e.g., move the respective portion of the user up to scroll up or move the respective portion of the user down to scroll down). In some embodiments, the second direction and first direction in opposite directions (e.g., move the respective portion of the user up to scroll down or move the respective portion of the user down to scroll up). In some embodiments, the first amount corresponds to the respective magnitude; if the respective magnitude is larger, the first amount is larger and if the respective magnitude is smaller, the first amount is smaller.

In some embodiments, in accordance with a determination that the movement of the respective portion (e.g., 703c) of the user is in a third direction different from the first direction, such as in FIG. 7E, the computer system (e.g., 101) scrolls the scrollable content (e.g., 70) by a second amount different from the first amount in a fourth direction in response to detecting the respective portion (e.g., 703c) of the user perform the respective gesture, wherein the fourth direction is different from the second direction (822c), such as in FIG. 7F. In some embodiments, the fourth direction in which the computer system scrolls the scrollable content corresponds to the third direction of movement of the respective portion of the user. In some embodiments, the fourth direction and third direction are the same direction (e.g., move the respective portion of the user up to scroll up or move the respective portion of the user down to scroll down). In some embodiments, the fourth direction and third are in opposite directions (e.g., move the respective portion of the user up to scroll down or move the respective portion of the user down to scroll up). In some embodiments, the second amount corresponds to the respective magnitude; if the respective magnitude is larger, the second amount is larger and if the respective magnitude is smaller, the second amount is smaller. In some embodiments, in response to detecting downward movement of the respective portion of the user with the respective magnitude, the computer system scrolls the scrollable content by a smaller amount than the amount the computer system scrolls the scrollable content in response to detecting upward movement of the respective portion of the user with the same respective magnitude.

Scrolling the scrollable content by different amounts in response to movement of the respective portion of the user with the respective magnitude in different directions enhances user interactions with the computer system by providing additional control options without cluttering the user interface with additional displayed controls.

In some embodiments, such as in FIG. 7E, the movement of the hand (e.g., air gesture, touch input, or other hand input) (e.g., 703c) of the user includes movement of the hand (e.g., air gesture, touch input, or other hand input) (e.g., 703c) from a first location to a second location, wherein the hand (e.g., 703c) of the user maintains the pinch hand shape while moving from the first location to the second location (824a). In some embodiments, the first location is the location of the respective portion of the user when the respective portion of the user initially makes the pinch hand shape, such as when the thumb and index finger of the hand of the user come together and touch.

In some embodiments, scrolling the scrollable content (e.g., 707) in response to detecting the respective portion (e.g., 703c) of the user perform the respective gesture, such as in FIG. 7E, includes (824b), in accordance with a determination that a distance between the first location and the second location is a first distance, scrolling the scrollable content (e.g., 707) at a first speed (824c). In some embodiments, the computer system continues to scroll the scrollable content at the first speed while continuing to detect the predefined portion of the user at the second location that is the first distance from the first location.

In some embodiments, scrolling the scrollable content (e.g., 707) in response to detecting the respective portion (e.g., 703c) of the user perform the respective gesture, such as in FIG. 7E, includes (824b), in accordance with a determination that a distance between the first location and the second location is a second distance greater than the first distance, scrolling the scrollable content (e.g., 707) at a second speed greater than the first speed (824d). In some embodiments, the computer system continues to scroll the scrollable content at the second speed while continuing to detect the predefined portion of the user at the second location that is the second distance from the first location. In some embodiments, as the hand of the user moves while the hand is in the pinch shape, the computer system changes the scrolling speed of the scrollable content in accordance with the distance between the current location of the hand of the user and the first location of the hand of the user.

Scrolling the scrollable content at a speed that depends on the distance between the first location of the hand of the user and the second location of the hand of the user enhances user interactions with the computer system by providing additional control options without cluttering the user interface with additional displayed controls.

In some embodiments, the one or more criteria include a criterion that is satisfied when the hand (e.g., 703b) of the user moves at least a threshold amount, such as in FIG. 7D (e.g., speed (e.g., 0.05, 0.1, 0.2, 0.3, 0.5, 1, 2, 3, or 5 centimeters per second), distance (e.g., 0.05, 0.1, 0.2, 0.3, 0.5, 1, 2, or 3 centimeters), and/or duration (e.g., 0.05, 0.1, 0.2, 0.3, 0.5, or 1 second)) while maintaining the pinch hand shape (826a).

In some embodiments, in response to detecting the respective portion (e.g., 703a) of the user perform the respective gesture, in accordance with a determination that the movement of the hand (e.g., air gesture, touch input, or other hand input) (e.g., 703a) of the user does not satisfy the one or more criteria, the computer system (e.g., 101) maintains (826b) display of the scrollable content (e.g., 707) without scrolling the scrollable content (e.g., 707), such as in FIG. 7C. In some embodiments, if the movement of the hand (e.g., air gesture, touch input, or other hand input) while the hand is in the pinch shape is by an amount that is less than the threshold, the computer system forgoes scrolling the scrollable content in accordance with the movement of the hand (e.g., air gesture, touch input, or other hand input) while the hand is in the pinch shape.

Maintaining display of the scrollable content without scrolling the scrollable content in response to detecting the respective portion of the user perform the respective gesture that does not satisfy the one or more criteria because movement of the hand (e.g., air gesture, touch input, or other hand input) is less than the threshold amount enhances user interactions with the computer system by reducing user mistakes when interacting with the computer system.

In some embodiments, the one or more criteria are not satisfied when a speed of the movement of the hand (e.g., air gesture, touch input, or other hand input) (e.g., hand 703a in FIG. 7C) of the user is greater than a threshold speed (e.g., 1, 2, 3, 5, 10, 15, 30, or 50 centimeters per second) and a direction of the movement of the hand (e.g., air gesture, touch input, or other hand input) (e.g., 703a) of the user is downward (828a). In some embodiments, the threshold speed is associated with a speed of the user dropping their hand without the intention of continuing to scroll the scrollable content.

In some embodiments, in response to detecting the respective portion of the user perform the respective gesture, in accordance with a determination that the one or more criteria are not satisfied, the computer system (e.g., 101) maintains (828b) display of the scrollable content (e.g., 707) without scrolling the scrollable content (e.g., 707), such as in FIG. 7C. In some embodiments, the computer system scrolls the scrollable content in accordance with a portion of downward movement of the hand (e.g., air gesture, touch input, or other hand input) at a speed that is less than the threshold speed. For example, if the movement of the hand (e.g., air gesture, touch input, or other hand input) includes a first portion of downward movement at less than the threshold speed and a second portion of downward movement at greater than the threshold speed, the computer system scrolls the scrollable content in accordance with the first portion of the downward movement without further scrolling the scrollable content in accordance with the second portion of the downward movement.

Maintaining display of the scrollable content without scrolling the scrollable content in response to detecting the respective portion of the user perform the respective gesture that does not satisfy the one or more criteria because movement of the hand (e.g., air gesture, touch input, or other hand input) is downward at a speed exceeding a threshold speed enhances user interactions with the computer system by reducing user mistakes when interacting with the computer system.

In some embodiments, in response to detecting the gaze (e.g., 713a) of the user directed to the scrollable content (e.g., 707), and in accordance with the determination that the gaze (e.g., 713a) of the user is directed to the second region (e.g., 706) of the scrollable content (e.g., 707) and the respective portion of the user meets the respective criteria, such as in FIG. 7A, the computer system (e.g., 101) scrolls the scrollable content (e.g., 707) in a first direction in accordance with the gaze (e.g., 713a) of the user (830a). In some embodiments, the first direction of scrolling corresponds to the location of the second region of the scrollable content within the scrollable content. For example, if the second region is at the bottom of the scrollable content, the computer system scrolls the content down (e.g., reveals additional content at the bottom of the scrollable content).

In some embodiments, while displaying, via the display generation component (e.g., 120), the user interface (e.g., 120) including the scrollable content (e.g., 707), in response to detecting the gaze of the user directed to the scrollable content, in accordance with a determination that the gaze of the user is directed to a third region (e.g., region 704 in FIG. 7A) of the scrollable content (e.g., 707), the third region (e.g., 704) different from the second region (e.g., 706), and the respective portion of the user meets the respective criteria, the computer system (e.g., 101) scrolls (830b) the scrollable content (e.g., 707) in a second direction opposite the first direction in accordance with the gaze of the user, such as in FIG. 7F. In some embodiments, the second direction of scrolling corresponds to the location of the third region of the scrollable content within the scrollable content. For example, if the third region is at the top of the scrollable content, the computer system scrolls the content up (e.g., reveals additional content at the top of the scrollable content). In some embodiments, scrolling the scrollable content in response to detecting the gaze of the user directed to the third region of the content includes scrolling the content along a different axis than the axis along which the computer system scrolls the scrollable content in response to detecting the gaze of the user directed to the second region of the scrollable content. For example, the computer system scrolls the scrollable content vertically in response to detecting the gaze of the user directed to a region along the top or bottom of the content and scrolls the scrollable content horizontally in response to detecting gaze of the user directed to a region along the left or the right of the scrollable content (e.g., while the respective portion of the user satisfies the one or more criteria).

Scrolling the scrollable content in different directions depending on which region to gaze of the user is directed to enhances user interactions with the computer system by providing additional control options without cluttering the user interface with additional displayed controls.

In some embodiments, in response to detecting the gaze (e.g., 713a) of the user directed to the scrollable content (e.g., 707) and in accordance with the determination that the gaze (e.g., 713a) of the user is directed to the second region (e.g., 706) of the scrollable content (e.g., 707) and the respective portion of the user meets the respective criteria, such as in FIG. 7F, scrolling (832a) the scrollable content (e.g., 707) in the first direction, such as in FIG. 7B, in accordance with the gaze of the user includes scrolling the scrollable content with first acceleration. In some embodiments, the first direction of scrolling corresponds to the location of the second region of the scrollable content within the scrollable content. For example, if the second region is at the bottom of the scrollable content, the computer system scrolls the content down (e.g., reveals additional content at the bottom of the scrollable content). In some embodiments, the first acceleration is the acceleration with which the computer system initiates scrolling the scrollable content in response to detecting the gaze of the user directed to the second region of the scrollable content in accordance with the determination that the respective portion of the user meets the respective criteria. In some embodiments, the computer system scrolls the scrollable content with a first velocity in response to detecting the gaze of the user directed to the second region of the scrollable content while the respective portion of the user meets the respective criteria.

In some embodiments, in response to detecting the gaze of the user directed to the scrollable content (e.g., 707) and in accordance with the determination that the gaze of the user is directed to the third region (e.g., region 704 in FIG. 7A) of the scrollable content (e.g., 707) and the respective portion of the user meets the respective criteria, scrolling (832b) the scrollable content in the second direction, such as in FIG. 7F, in accordance with the gaze of the user includes scrolling the scrollable content (e.g., 707) with second acceleration different from (e.g., larger than or smaller than) the first acceleration. In some embodiments, the second direction of scrolling corresponds to the location of the third region of the scrollable content within the scrollable content. For example, if the third region is at the top of the scrollable content, the computer system scrolls the content up (e.g., reveals additional content at the top of the scrollable content). In some embodiments, the second acceleration is the acceleration with which the computer system initiates scrolling the scrollable content in response to detecting the gaze of the user directed to the third region of the scrollable content in accordance with the determination that the respective portion of the user meets the respective criteria. In some embodiments, the computer system scrolls the scrollable content with a second velocity different from the first velocity referenced above in response to detecting the gaze of the user directed to the third region of the scrollable content while the respective portion of the user meets the respective criteria.

Scrolling the scrollable content with different acceleration when the gaze of the user is directed to different regions of the scrollable content enhances user interactions with the computer system by providing additional control options without cluttering the user interface with displayed controls.

In some embodiments, such as in FIG. 7A, the scrollable content includes text content (e.g., 707) and other content (e.g., 705) (834a) (e.g., images, interactive content, and/or interactive user interface elements). In some embodiments, the other content includes additional text content not included in the text content of the scrollable content. For example, an article includes text content including the text of the article and other content including advertisements that include text content of the advertisements. In some embodiments, the other content includes multimedia and/or interactive content such as selectable options for navigating a user interface including the scrollable content (e.g., links to other content). In some embodiments, the computer system displays the scrollable content including the text content and the other content in a first mode (e.g., a browsing mode) and displays the text content without the other content in a second mode (e.g., a reader mode). In some embodiments, the computer system transitions between displaying the scrollable content in the first mode and displaying the text content of the scrollable content in the second mode in response to one or more user inputs corresponding to a request to change presentation modes (e.g., selection of one or more user interface elements, a voice input, and/or a predefined gesture performed by a portion of the body of the user).

In some embodiments, while displaying the text content (e.g., 707) of the scrollable content without displaying the other content of the scrollable content (834b), the computer system (e.g., 101) detects (834c), via the one or more input devices, movement of the gaze (e.g., 713h) of the user, such as in FIG. 7G. In some embodiments, the movement of the gaze of the user corresponds to the user reading the text content of the scrollable content.

In some embodiments, while displaying the text content (e.g., 707) of the scrollable content without displaying the other content of the scrollable content (834b), in response to detecting the movement of the gaze (e.g., 713h) of the user (834d), in accordance with a determination that the movement of the gaze (e.g., 713h) of the user satisfies one or more criteria, including a criterion that is satisfied based on movement of the gaze (e.g., 713h) of the user relative to a line of text in the text content (e.g., 707), such as in FIG. 7G, the computer system (e.g., 101) scrolls (834e) the text content (e.g., 707), such as in FIG. 7H. In some embodiments, the one or more criteria are associated with the user finishing reading a line of the text content. In some embodiments, the computer system is able to detect whether the user is merely looking at the first portion of text or whether the user is reading the first portion of the text item based on detected movement of the user's eyes. The computer system optionally compares one or more captured images of the user's eyes to determine whether the movement of the user's eyes matches movement that is consistent with reading. In some embodiments, people tend to move their gaze from the end of a line they finished reading to the front of the line or to the front of the next line after finishing reading the line of text. In some embodiments, the one or more criteria include a criterion that is satisfied when the gaze of the user moves in a direction from the end of a line to the beginning of the line or to the beginning of the next line. In some embodiments, in response to detecting movement of the gaze of the user that corresponds to the user finishing reading the line of text, the computer system scrolls the text content. In some embodiments, the computer system scrolls the text content by one line to display the next line at a location in the three-dimensional environment at which the line of text the user just read was displayed while the user was reading the line of the text the user just read. For example, the computer system scrolls the text vertically to display a respective line of text at the height at which a line of text the user previously read had previously been displayed. As another example, the electronic device scrolls the text horizontally to display the respective line of text at the horizontal location at which the line of text previously read by the user had previously been displayed. Scrolling the text content optionally includes updating the location of a line of text previously read by the user (e.g., moving the first portion of text vertically or horizontally to make room for the second portion of text) or ceasing to display the line of text previously read by the user. In some embodiments, the computer system scrolls the text content in response to data collected by an eye tracking device without receiving additional input from another input device in communication with the computer system (e.g., an air gesture input or an input detected via a hardware input device).

In some embodiments, while displaying the text content (e.g., 707) of the scrollable content without displaying the other content of the scrollable content (834b), such as in FIG. 7G, in response to detecting the movement of the gaze (e.g., 713h) of the user (834d), in accordance with a determination that the movement of the gaze (e.g., 713h) of the user does not satisfy the one or more criteria, the computer system (e.g., 101) maintains (8340 display of the text content (e.g., 707) without scrolling the text content. In some embodiments, the gaze of the user does not satisfy the one or more criteria while the user is reading (e.g., a portion towards the beginning or middle of) a respective line the scrollable content. In some embodiments, the gaze of the user does not satisfy the one or more criteria when the gaze of the user reaches the end of the line of the text content without moving towards the beginning of the line of the text content. For example, the user reads the line of text content and then directs their gaze to another portion of the three-dimensional environment different from the beginning of the line of text content or the beginning of the next line of text content.

Scrolling the text content in accordance with the determination that the movement of the gaze of the user satisfies the one or more criteria enhances user interactions with the computer system by providing additional control options without cluttering the user interface with additional displayed controls.

In some embodiments, scrolling the text content (e.g., 707) in response to detecting the movement of the gaze (e.g., 713h) of the user that satisfies the one or more criteria, such as in FIG. 7G, is independent of whether the respective portion of the user is detected in a predefined pose (836). In some embodiments, the respective portion of the user is in the predefined pose when the hand of the user is in the ready state. In some embodiments, while the computer system displays the text content of the scrollable content without displaying the additional content of the scrollable content (e.g., in the reader mode), the computer system scrolls the text content in accordance with the gaze of the user irrespective of the pose and/or location of the hand of the user. In some embodiments, the computer system scrolls the text content in response to detecting the movement of the gaze of the user that satisfies the one or more criteria while the respective portion of the user meets the respective criteria. In some embodiments, the computer system scrolls the text content in response to detecting the movement of the gaze of the user that satisfies the one or more criteria while the respective portion of the user does not meet the respective criteria.

Scrolling the text content in accordance with the determination that the movement of the gaze of the user satisfies the one or more criteria irrespective of whether or not the respective portion of the user is in the predefined pose enhances user interactions with the computer system by providing additional control options without cluttering the user interface with additional displayed controls.

In some embodiments, while displaying the text content of the scrollable content without the other content of the scrollable content (838a) (e.g., while displaying the text content in the reader mode described above), the computer system (e.g., 101) detects (838b), via the one or more input devices, the gaze of the user directed to the text content.

In some embodiments, while displaying the text content of the scrollable content without the other content of the scrollable content (838a) (e.g., while displaying the text content in the reader mode described above), in response to detecting the gaze of the user directed to the text content (838c), in accordance with a determination that the gaze of the user is directed to a first region of the text content and the movement of the gaze of the user does not satisfy the one or more criteria, the computer system (e.g., 101) maintains (838d) display of the text content without scrolling the text content. In some embodiments, the first region of the text content is away from one or more directions in which the text content is scrollable. For example, if the text content is vertically scrollable, the first region of the text content is a region of the text content between a top portion and a bottom portion of the text content. As another example, if the text content is horizontally scrollable, the first region of the text content is a region of the text content between a left portion and a right portion of the text content. In some embodiments, the first region of the text content is analogous to the first region of the scrollable content described above. In some embodiments, the computer system maintains display of the text content without scrolling the text content in response to detecting the gaze of the user directed to the first region of the text content while the movement of the gaze of the user does not correspond to the user reading the text content.

In some embodiments, while displaying the text content (e.g., 707) of the scrollable content without the other content of the scrollable content (838a) (e.g., while displaying the text content in the reader mode described above), such as in FIG. 7G, in response to detecting the gaze of the user directed to the text content (838c), in accordance with a determination that the gaze of the user is directed to a second region (e.g., 710) of the text content different from the first region of the text content, and the respective portion (e.g., hand or head) of the user meets the respective criteria (e.g., the hand of the user is not in the ready state), and the movement of the gaze of the user does not satisfy the one or more criteria, the computer system (e.g., 101) scrolls (838e) the text content in accordance with the gaze of the user. In some embodiments, scrolling the text content in accordance with the gaze of the user in accordance with the determination that the gaze of the user is directed to the second region of the text content and the respective portion of the user meets the respective criteria has one or more characteristics in common with the techniques described above for scrolling the scrollable content in response to detecting the gaze of the user directed to the second region of the scrollable content while the respective portion of the user meets the respective criteria. In some embodiments, the computer system scrolls the text content in response to detecting the gaze of the user directed to the second region of the text content while the movement of the gaze of the user corresponds to the user reading the text content. In some embodiments, the computer system scrolls the text content in response to detecting the gaze of the user directed to the second region of the text content while the movement of the gaze of the user does not correspond to the user reading the text content. In some embodiments, the second region of the text content is analogous to the second region of the scrollable content described above.

In some embodiments, while displaying the text content (e.g., 707) of the scrollable content without the other content of the scrollable content (838a) (e.g., while displaying the text content in the reader mode described above), such as in FIG. 7G, in response to detecting the gaze (e.g., 713h) of the user directed to the text content (838c), in accordance with a determination that the gaze (e.g., 713h) of the user is directed to the first region of the text content and the movement of the gaze (e.g., 713h) of the user satisfies the one or more criteria, the computer system (e.g., 101) scrolls (8380 the text content, such as in FIG. 7H. In some embodiments, the computer system scrolls the text content in accordance with the gaze of the user being directed to the second region of the text content and scrolls the text content in accordance with movement of the gaze of the user with respect to a line of the text content as described above while the computer system displays the text content of the scrollable content without the other content of the scrollable content as described above. In some embodiments, there are at least two ways to scroll the text content based on gaze.

Scrolling the text content in accordance with the gaze of the user enhances user interactions with the computer system by providing additional control options without cluttering the user interface with additional displayed controls.

In some embodiments, while displaying the scrollable content (e.g., 707), such as in FIG. 7H, in response to detecting the gaze (e.g., 713i) of the user directed to the scrollable content (e.g., 707), in accordance with a determination that the gaze (e.g., 713i) of the user is directed to a word included in the first region of the scrollable content (e.g., 707) for at least a threshold time (e.g., 0.1, 0.2, 0.3, 0.5, 1, 2, or 3 seconds), the computer system (e.g., 101) displays (840), via the display generation component (e.g., 120), a definition (e.g., 712) of the word included in the scrollable content (e.g., 707). In some embodiments, the definition of the word is displayed overlaid on the scrollable content. In accordance with a determination that the gaze of the user is directed to the word included in the first region of the scrollable content for less than the threshold time, the computer system forgoes displaying the definition of the word. In accordance with a determination that the gaze of the user is not directed to the word included in the first region of the scrollable content, the computer system forgoes displaying the definition of the word.

Displaying the definition of the word in accordance with the gaze of the user enhances user interactions with the computer system by providing additional control options without cluttering the user interface with additional displayed controls.

In some embodiments, aspects/operations of methods 1000, 1200, 1400, 1600, 1800, 2000, 2200, and/or 2400 may be interchanged, substituted, and/or added between these methods. For example, the computer system optionally scrolls content that was generated via speech inputs according to method 1000 according to one or more steps of method 800. For example, the computer system optionally scrolls content that was generated via soft keyboards according to methods 1200, 1400, and/or 1600 according to one or more steps of method 800. For brevity, these details are not repeated here.

FIGS. 9A-9N illustrate example techniques for entering text into text entry fields in response to voice inputs in accordance with some embodiments. The user interfaces in FIGS. 9A-9N are used to illustrate the processes described below, including the processes in FIGS. 10A-10R.

FIG. 9A illustrates a computer system 101 displaying, via a display generation component (e.g., display generation component 120 of FIG. 1), a three-dimensional environment 901 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments (e.g., on a touch-sensitive display or other display) without departing from the scope of the disclosure.

FIG. 9A illustrates the computer system 101 displaying a web browsing user interface 902 via display generation component 120. In some embodiments, the web browsing user interface 902 includes an indication 904 of a URL of a website that the web browser is currently presenting. For example, in FIG. 9A, the web browsing user interface 902 includes a web search website that includes a text entry field 906 to which an input specifying one or more search terms is to be directed and a selectable option 908 that, when selected, causes the computer system 101 to conduct a search using the one or more search terms provided to the text entry field 906. In some embodiments, the computer system 101 is configured to detect inputs to enter text into the text entry field 906 via a soft keyboard according to one or more steps of methods 1200, 1400, and 1600, via a hardware keyboard, or via dictation, as will now be described.

In some embodiments, the computer system 101 initiates a process to accept dictation inputs directed to the text entry field 906 in response to detecting, via the one or more input devices (e.g., image sensors 314), the attention of the user, including the gaze 913a of the user, directed to the text entry field 906. In some embodiments, the computer system 101 initiates the process to accept dictation inputs in response to detecting the attention of the user directed to the text entry field 906 without or irrespective of detecting an additional input, such as an air gesture or an input provided with a hardware input device. In some embodiments, in response to detecting the gaze 913a of the user directed to the text entry field 906, the computer system 101 gradually expands the text entry field. For example, as shown in FIGS. 9A-9B, in response to the gaze 913a of the user being directed to the text entry field 906, the computer system 101 gradually increases the width of the text entry field 906 while the gaze 913a of the user is directed to the text entry field 906. In some embodiments, once the gaze 913a of the user has been directed to the text entry field 906 for a threshold amount of time, the computer system 101 stops expanding the text entry field 906 and initiates a process to accept speech input directed to the text entry field. Example time thresholds are provided below in the description of method 1000 with reference to FIGS. 10A-10R.

FIG. 9B illustrates the updated web browsing user interface 902 in response to the computer system 101 detecting the gaze 913a of the user directed to the text entry field 906 for the threshold amount of time referenced above. As shown in FIG. 9B, the computer system 101 displays the text entry field 906 with a larger width than the width of the text entry field in FIG. 9A when the computer system 101 first detected the gaze 913a of the user directed to the text entry field 906. FIG. 9B also illustrates the computer system 101 generating an audio output 910a that indicates that the computer system 101 is configured to accept a speech input to dictate text directed to the text entry field 906 in response to the gaze 913a of the user being directed to the text entry field 906 for the threshold time. The computer system 101 also highlights placeholder text 914 that was displayed in the text entry field 906 prior to the computer system 101 detecting the gaze 913a of the user directed to the text entry field 906 in response to the gaze 913a of the user being directed to the text entry field 906 for the threshold amount of time.

Although FIG. 9B illustrates the computer system 101 displaying a cursor 912 in response to the gaze 913a of the user being directed to the text entry field 906 for the threshold time, in some embodiments, the computer system 101 does not display the cursor 912 unless and until the user provides a speech input dictating text to be entered in the text entry field 906. In some embodiments, in response to detecting the gaze 913a of the user directed to the text entry field 906 for at least the threshold time (e.g., without or irrespective of detecting an additional input, such as an air gesture or an input detected via a hardware input device), the computer system 101 displays an additional visual indication indicating that the computer system 101 is configured to enter dictated text provided via speech input into the text entry field 906 in a manner similar to the manner in which the computer system 101 displays microphone icon 930 in FIGS. 9G and 9H below.

In FIG. 9B, while continuing to detect the gaze 913a of the user directed to the text entry field 906, the computer system 101 receives a speech input 916a from the user. In response to the input illustrated in FIG. 9B, the computer system 101 displays a text representation of the speech input 916a in the text entry field 906 to enter the text of the speech input into the text entry field 906, as shown in FIG. 9C.

FIG. 9C illustrates the computer system 101 displaying a text representation 920 of the speech input illustrated in FIG. 9B in the text entry field 906 in response to the input illustrated in FIG. 9B. In some embodiments, the computer system 101 initiates a process to accept dictation inputs for entering text into text entry field 906 in response to detecting the gaze of the user, as described above with reference to FIGS. 9A-9B without or irrespective of detecting a speech input. In some embodiments, while the computer system 101 is configured to accept dictation inputs for entering text into the text entry field 906, the computer system 101 enters text into the text entry field 906 in response to speech inputs as shown in FIGS. 9B-9C without or irrespective of detecting air gesture inputs and/or inputs detected via hardware input devices. In some embodiments, while detecting the speech input, the computer system 101 generates a glow effect 918 around the text entry field 906 that changes over time based on the volume of the received speech input. For example, the computer system 101 modifies the size, translucency, color, darkness, or another visual characteristic of the glow effect 918 in accordance with the audio volume of the speech input while the speech input is being received by the computer system 101. In some embodiments, the computer system 101 displays a cursor 912 in the text entry field 906 while the speech input is being received.

In FIG. 9C, the computer system 101 detects a continuation of the speech input 916b while the gaze 913b of the user is no longer directed to the text entry field 906. Although FIG. 9C illustrates the gaze 913b of the user as being directed to a region of the web browsing user interface that does not include the text entry field 906, in some embodiments, the gaze of the user is directed away from the web browsing user interface 902, such as being directed to a different portion of the display generation component 120 than the portion of the display generation component 120 that includes the text entry field 906 or being directed away from the display generation component 120. In some embodiments, the computer system 101 detects the continuation of the speech input 916b while the user closes their eyes for more than a time threshold associated with the user blinking. Example time thresholds are provided below in the description of method 1000 with reference to FIGS. 10A-10R.

In some embodiments, in response to detecting the continuation of the speech input 916b while the gaze 913b of the user is not directed to the text entry field 906, the computer system 101 enters a text-based representation of the continuation of the speech input 916b, as will be described below with reference to FIG. 9D. In some embodiments, in response to detecting the continuation of the speech input 916b while the gaze 913b of the user is not directed to the text entry field 906, the computer system 101 maintains display of the text representation 920 of previously-entered text without displaying a text representation of the continuation of the speech input 916b, as also described below with reference to FIG. 9D. In some embodiments, in response to detecting the continuation of the speech input 916b while the gaze 913b of the user is not directed to the text entry field 906, the computer system 101 removes (e.g., some, all) text from the text entry field 906 and stops accepting dictation input directed to the text entry field 906, as will be described below with reference to FIG. 9E.

In some embodiments, in response to detecting the continuation of the speech input 916b while the gaze 913b of the user is not directed to the text entry field 906, the computer system 101 displays the text representation of the continuation of the speech input 916b in the text entry field as shown in FIG. 9D if the computer system 101 had already started accepting dictation inputs and forgoes displaying the text representation of the continuation of the speech input 916b as shown in FIG. 9E if the computer system 101 was not already accepting dictation inputs. In some embodiments, the computer system 101 removes (e.g., some, all) text from the text entry field 906 and forgoes displaying the text representation of the continuation of the speech input 916b in the text entry field as shown in FIG. 9E because the text entry field 906 is a search text entry field. In some embodiments, the search text entry field is included in a first type of text entry fields that also includes messaging text entry fields and web browser address fields. In some embodiments, if the text entry field is a long-form text entry field, such as the text entry field illustrated in FIGS. 9F-9H, and/or requires an input in addition to detecting the attention of the user directed to the text entry field in order to accept speech inputs for providing text to the text entry field, the computer system 101 continues to display previously-dictated text but does not display a text representation of a continuation of a speech input detected while the gaze of the user is not directed to the text entry field.

FIG. 9D illustrates the computer system 101 updating the text entry field 906 in response to the continuation of the speech input illustrated in FIG. 9C according to some embodiments. As described above, in some embodiments, in response to the continuation of the speech input illustrated in FIG. 9C, the computer system 101 maintains display of the text representation 920 of the speech input (e.g., the word “Lorem”) in the text entry field 906. In some embodiments, the computer system 101 also displays a text representation of the continuation of the speech input illustrated in FIG. 9C (e.g., the word “Ipsum”). FIG. 9D includes a dashed box around the text representation of the continuation of the speech input 916b illustrated in FIG. 9C (e.g., the word “Ipsum”) because, in some embodiments, as described above, the computer system 101 forgoes displaying the text representation of the continuation of the speech input 916b illustrated in FIG. 9C. It should be understood that, in some embodiments, the computer system 101 displays the text representation of the continuation of the speech input 916b without displaying the dashed box around the text representation of the continuation of the speech input 916b. In some embodiments, the computer system 101 forgoes display of the text representation of the continuation of the speech input 916b and forgoes display of the dashed box. As described above, in some embodiments, the computer system 101 displays the text representation of the continuation of the speech input 916b in the text entry field 906 in FIG. 9D because dictation was already initiated when the continuation of the speech input in FIG. 9C was received, even though the gaze of the user was not directed to the text entry field 906 while the continuation of the speech input 916b was detected.

In FIG. 9D, the computer system 101 displays the glow effect 918 around the text entry field 906 with updated visual characteristics in accordance with changes in the volume level of the speech input 916b illustrated in FIG. 9C. In some embodiments, the computer system 101 displays the glow effect 918 if the computer system 101 displays the text representation of the continuation of the speech input and does not display the glow effect 918 if the computer system 101 forgoes display of the text representation of the continuation of the speech input.

In some embodiments, while displaying text 920 in the text entry field 906, the computer system 101 detects a speech input 916c corresponding to a command associated with the text entry field 906. For example, because the text entry field 906 is a search field, the speech input 916c includes the word “search.” Other examples of speech commands and their associated text entry fields are provided below in the description of method 1000 with reference to FIGS. 10A-10R. In some embodiments, if the speech input 916c corresponding to the command is received while the gaze 913c is directed to the text entry field 906, the computer system 101 performs the operation corresponding to the text entry field 906, such as conducting the search on the search term(s) included in the text entry field when the command is received. In some embodiments, if the speech input 916c corresponding to the command is received while the gaze 913b is not directed to the text entry field 906, the computer system 101 forgoes performing the operation corresponding to the text entry field 906. In some embodiments, the computer system 101 performs the operation corresponding to the text entry field 906, such as conducting the search on the search term(s) included in the text entry field when the command is received, irrespective of whether the speech input 916c corresponding to the command is received while the gaze 913c is directed to the text entry field 906 or while the gaze 913b is not directed to the text entry field 906.

FIG. 9E illustrates the computer system 101 updating the text entry field in response to the continuation of the speech input illustrated in FIG. 9C according to some embodiments. As described above, in some embodiments, the computer system 101 removes the text corresponding to the speech input illustrated in FIG. 9B from the text entry field 906 in response to the continuation of the speech input that is detected while the gaze of the user is not directed to the text entry field 906 illustrated in FIG. 9C. In some embodiments, the computer system 101 removes the text corresponding to the speech input illustrated in FIG. 9B from the text entry field 906 because the text entry field is a search field of a website or another text entry field of the same type as the search field, as described above with reference to FIG. 9C and below in the description of method 1000 with reference to FIGS. 10A-10R. In some embodiments, by removing the text corresponding to the speech input illustrated in FIG. 9B from the text entry field 906, the computer system 101 cancels the dictation input. In some embodiments, the computer system updates the appearance of the text entry field 906 to indicate that the dictation input has been canceled, such as by deleting the text from the text entry field, or reverting the text entry field 906 to the appearance of the text entry field 906 in FIG. 9A (e.g., reducing the width of the text entry field 906).

FIGS. 9F-9H illustrate the computer system 101 displaying a word processing user interface 922 including text entry field 926, save option 924a, undo option 924b, font option 924c, and an option 924d to cease display of the word processing user interface 922. In some embodiments, the text entry field 926 of the word processing user interface 922 is a longform text entry field. In some embodiments, the computer system 101 initiates the process to accept dictation inputs directed to the longform text entry field 926 in response to an additional input to initiate dictation into the text entry field 926, such as an air gesture or an input detected via a hardware input device. Example inputs are described in the description of method 1000 below with reference to FIGS. 10A-10R. In some embodiments, the computer system initiates dictation in response to detecting the attention of the user directed to the text entry field 926, including detecting the gaze 913d of the user directed to the text entry field 926 for a threshold time without or irrespective of receiving an additional input such as an air gesture or an input detected via a hardware input device. Example threshold times are described below in the description of method 1000 with reference to FIGS. 10A-10R. In some embodiments, before dictation is initiated, the computer system 101 displays a cursor 928 in the text entry field 926 indicating the location at which text will be inserted in response to an input provided via a soft keyboard according to methods 1200, 1400, and/or 1600 and/or a hardware keyboard. As will be described with reference to FIGS. 9G-9H, once dictation is initiated, the computer system 101 ceases display of the cursor 928.

FIG. 9G illustrates how the computer system 101 updates the word processing user interface 922 in response to initiation of dictation. In some embodiments, dictation is initiated based on detecting the gaze of the user directed to the text entry field 926 as illustrated in FIG. 9F without or irrespective of detecting an additional input, such as an air gesture or an input detected via a hardware input device. In some embodiments, dictation is initiated in response to an additional input as described below in the description of method 1000 with reference to FIGS. 10A-10R. As shown in FIG. 9G, when dictation is initiated, the computer system 101 generates an audio output 910b that is the same as or different from audio output 910a described above with reference to FIG. 9B. FIG. 9G also shows the computer system 101 display a microphone icon 930 at a location in the text entry field 926 at which dictated text will be inserted in response to detecting a speech input provided by the user. In some embodiments, the microphone icon 930 is displayed at the location in the text entry field to which the user's gaze was directed when dictation was initiated. Thus, in some embodiments, if the user had been looking at a different location in the text entry field 926, then the computer system 101 would display the microphone icon 930 at that location instead of the location shown in FIG. 9G. As shown in FIG. 9G, once dictation is initiated, and the computer system 101 displays the microphone icon 930 the location at which will be inserted, the computer system 101 ceases display of cursor 928 illustrated in FIG. 9F. In some embodiments, instead of displaying a microphone icon 930 as shown in FIG. 9G, the computer system 101 displays a different visual indication at the location in the text entry field 926 at which dictated text will be inserted.

In FIG. 9G, the computer system detects a voice input 916d provided by the user while the gaze 913d of the user is directed to the text entry field 926. In some embodiments, in response to receiving the voice input 926d, the computer system 101 displays text corresponding to the voice input 926d in the text entry field 926, as shown in FIG. 9H.

FIG. 9H illustrates the computer system 101 displaying text 932 corresponding to the voice input illustrated in FIG. 9G in the text entry field. In some embodiments, while displaying the text 932 corresponding to the voice input, the computer system continues to display the microphone icon 930 (e.g., if dictation is still active). As shown in FIG. 9H, the microphone icon 930 is displayed after the text 932 corresponding to the voice input because text corresponding to additional voice inputs will be displayed after the text 932 corresponding to the voice input. In some embodiments, if the gaze of the user is directed away from the text entry field 926 while the user continues to dictate text, the computer system 101 maintains display of the text 932 corresponding to the voice input and, optionally, enters text corresponding to subsequent voice inputs detected while the gaze of the user is directed away from the text entry field 926 because the text entry field 926 is the longform type of text entry field, as described previously and in more detail below in the description of method 1000 with reference to FIGS. 10A-10R.

FIGS. 9I-9N illustrate an example of the computer system 101 entering text into text entry field 906 in response to voice inputs. In FIG. 9I, the computer system 101 displays a web browsing user interface 902 that includes a text entry field 906 into which user inputs specifying website addresses and/or search terms for a web search are accepted. For example, in response to detecting the user enter a text into the text entry field 906 followed by detecting an input to conduct a web search using the text (e.g., selection of a search option, performance of a search gesture, and/or a search voice command), the computer system 101 initiates a web search for content on the internet that corresponds to the text. As shown in FIG. 9I, the text entry field 906 includes placeholder text 934. In some embodiments, the placeholder text 934 is displayed in colors that animate changing hue, darkness, and/or saturation over time in a predetermined pattern or in accordance with changing audio levels of detected sound (e.g., speech, music, and/or other noise in the environment of the computer system 101). In some embodiments, the computer system 101 displays the placeholder text 934 in the text entry field 906 prior to receiving an input entering text into the text entry field. In some embodiments, the computer system 101 displays the placeholder text 934 in the text entry field 906 in response to receiving one or more inputs corresponding to a request to delete existing text from the text entry field, such as a URL of Website A, which is currently displayed in the internet browsing user interface 902.

As shown in FIG. 9I, the text entry field 906 is displayed with a background that does not change color in accordance with changing audio levels of detected audio (e.g., ambient noise or speech) and is displayed without a glowing appearance around the edge of the text entry field 906. In some embodiments, this appearance of the text entry field 906 illustrated in FIG. 9I indicates that the computer system will not enter text in the text entry field 906 corresponding to speech input in response to receiving a speech input. For example, if the user speaks one or more words while the computer system 101 displays the text entry field 906 as shown in FIG. 9I, the computer system 101 maintains display of the placeholder text 934 in the text entry field 90

FIG. 9I illustrates a dictation icon 936 included in the text entry field 906. In some embodiments, the computer system 101 displays the dictation icon 936 in the text entry field 906 in response to detecting the attention of the user, as described above, directed to the text entry field 906. As shown in FIG. 9I, the computer system 101 detects the attention 913e of the user directed to the dictation icon 936. In response to detecting the attention of the user directed to the dictation icon 936 in FIG. 9I, the computer system updates the appearance of the text entry field 906 and enters text corresponding to speech input in response to detecting speech inputs, as described with reference at least to FIG. 9J.

FIG. 9J illustrates the computer system 101 displaying the text entry field 906 with the updated appearance in response to detecting the attention 913e of the user directed to the dictation icon 936 as described above with reference to FIG. 9I. In some embodiments, as shown in FIG. 9I, the computer system 101 updates the text entry field 906 to include the dictation icon 938 at a different location in the text entry field 906 than the location illustrated in FIG. 9I. In some embodiments, as shown in FIG. 9J, the computer system 101 updates the text entry field 906 to be displayed with a background that changes color in accordance with changing audio levels of detected audio, including voice input 916e. In some embodiments, as shown in FIG. 9J, the computer system 101 updates the text entry field 906 to be displayed with a glowing outline 942a that changes color, intensity, and/or radius in accordance with changing audio levels of detected audio, including voice input 916e. In some embodiments, as shown in FIG. 9J, the computer system 101 updates the text entry field 906 to include an insertion marker 944a that changes color and/or has a glowing effect that changes color, intensity, and/or radius in accordance with changing audio levels of detected audio, including voice input 916e.

In some embodiments, while displaying the text entry field 906 with the appearance illustrated in FIG. 9J, the computer system 101 receives a speech input 916e while the attention 913e of the user is directed to the text entry field 906. In some embodiments, in response to receiving the speech input 916e while displaying the text entry field 906 with the appearance illustrated in FIG. 9J and while the attention 913e of the user is directed to the text entry field 906, the computer system 101 enters text into the text entry field 906 that corresponds to the speech input, as shown in FIG. 9K. In some embodiments, if the attention 913e of the user is not directed to the text entry field 906 while the computer system 101 detects the speech input 916e, the computer system 101 forgoes entering text corresponding to the speech input 916e into the text entry field. In some embodiments, in response to detecting the attention of the user directed away from the text entry field 906, the computer system 101 ceases displaying the text entry field 906 with the appearance shown in FIG. 9J and displays the text entry field 906 with the appearance illustrated in FIG. 9I.

FIGS. 9K and 9L illustrate the computer system 101 entering text corresponding to speech input 916e in FIG. 9J in response to the speech input 916e described above with reference to FIG. 9J. In some embodiments, the computer system 101 animates entering the text letter by letter as shown in FIGS. 9K and 9L. As shown in FIG. 9K, while entering the text corresponding to the speech input, the computer system 101 updates the background color of the text entry field 906, the glow effect 942b around the text entry field 906, and/or the color and/or glow of insertion marker 912 in accordance with detected audio levels (e.g., of the speech input 916e). FIG. 9K illustrates displaying a first portion 946a of the text corresponding to the speech input 916e with a first color and a second portion 948a of the text corresponding to the speech input 916e with a second color and/or glow effect while entering the text corresponding to the speech input 916e. For example, as the computer system 101 displays additional letters corresponding to the speech input 916e, the computer system 101 displays the letters in colors and/or with a glow effect that changes in accordance with the detected audio levels and then transition to the first color, which is a solid color. In some embodiments, the color of the background of the text entry field 906, the glow effect 942b around the text entry field 906, the color and/or glow of the insertion marker 912, and the color of the second portion 948a change in a coordinated manner in response to the detected audio levels.

FIG. 9L illustrates continued entry of text in response to the speech input 916e illustrated in FIG. 9J. As shown in FIG. 9L, as the detected audio levels continue to change (e.g., the electronic device continues to detect the speech input 916e), the computer system 101 updates the background color of the text entry field 906, the glow effect 942c around the text entry field 906, and/or the color and/or glow of insertion marker 912 in accordance with detected audio levels (e.g., of the speech input 916e). As shown in FIG. 9L, as the computer system 101 adds characters to the entered text, the portion 946b of the text that is displayed in a solid color includes additional characters and displays characters 948b with color and/or glow corresponding to the audio levels before being displayed with the solid color as the characters are added to the text entry field 906.

In some embodiments, once the computer system 101 no longer detects the speech input 916e, the computer system 101 displays the text entry filed 906 with the text corresponding to the speech input with the appearance shown in FIG. 9I. For example, the computer system 101 displays the text entry field 906 with a solid background color that stays the same irrespective of detected audio levels, ceases to display a glowing effect around the text entry field 906, and ceases display of the insertion marker 912 in the text entry field 906. In some embodiments, while displaying the text corresponding to the speech input 916e in the text entry field, the computer system 101 receives an input corresponding to a request to conduct an internet search based on the text in the text entry field. In some embodiments, in response to the input, the computer system 101 displays search results related to the text in the text entry field (e.g., text corresponding to speech input 916e).

In some embodiments, while the computer system 101 enters text to the text entry field 906 in response to one or more typed text entry inputs, the computer system 101 displays the text entry field 906 with the appearance illustrated in FIG. 9I instead of the appearance illustrated in FIGS. 9J-9L. For example, FIGS. 9M-9N illustrate an example of the computer system 101 entering text to the text entry field 906 in response to inputs received using a soft keyboard 950. In some embodiments, the computer system 101 similarly enters text to the text entry field 906 in response to inputs received using a hardware keyboard. In some embodiments, the computer system 101 enters text in the text entry field 906 in response to inputs directed to a soft keyboard according to one or more steps of method(s) 1200, 1400, 1600 and/or 2200. In some embodiments, the computer system 101 enters text in the text entry field 906 in response to inputs directed to a hardware keyboard according to one or more steps of method 2400.

In FIG. 9M, the computer system 101 concurrently displays the text entry field 906 with a soft keyboard 950. In some embodiments, the soft keyboard 950 is displayed with an option 954 that, when selected, causes the computer system 101 to enter text in the text entry field 906 in response to speech inputs. In some embodiments, as shown in FIG. 9M, the computer system 101 displays the text entry field 906 with a background color that does not change in accordance with detected audio levels without a glow effect. In some embodiments, the text entry field 906 does not include a dictation icon. FIG. 9M illustrates the text entry field 906 being displayed without an insertion marker, but in some embodiments, the text entry field 906 includes an insertion marker. In FIG. 9M, the computer system 101 receives an input directed to the soft keyboard 950 provided with hand 903. In response to the input illustrated in FIG. 9M, the computer system 101 enters text corresponding to the input directed to the soft keyboard, as shown in FIG. 9N.

FIG. 9N illustrates the computer system 101 displaying the text entry field 906 with the text 952 corresponding to the input illustrated in FIG. 9M. In some embodiments, the computer system 101 displays the text 952 in a color that does not change over time and/or in response to detected audio levels as the computer system enters the text 952 and/or after the computer system 952 enters the text. In some embodiments, while and after entering text 952 in the text entry field 906, the computer system 101 displays the text entry field 906 with a background color that does not change in accordance with detected audio levels without a glow effect. In some embodiments, while displaying the text 952 in the text entry field 906, the computer system 101 receives an input corresponding to a request to conduct an internet search based on the text 952 in the text entry field 906 and, in response to the input, displays search results corresponding to text 952.

Additional descriptions regarding FIGS. 9A-9N are provided below in reference to method 1000 described with respect to FIGS. 9A-9N.

FIGS. 10A-10R is a flow diagram of methods of entering text into text entry fields, in accordance with various embodiments. In some embodiments, method 1000 is performed at a computer system (e.g., computer system 101 in FIG. 1) including a display generation component (e.g., display generation component 120 in FIGS. 1, 3, and 4) (e.g., a heads-up display, a display, a touchscreen, and/or a projector) and one or more input devices. In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1000 are, optionally, combined and/or the order of some operations is, optionally, changed.

In some embodiments, such as in FIG. 9A, method 1000 is performed at a computer system (e.g., 101) in communication with a display generation component (e.g., 120) and one or more input devices. In some embodiments, the computer system is the same as or similar to the computer system described above with reference to method 800. In some embodiments, the one or more input devices are the same as or similar to the one or more input devices described above with reference to method 800. In some embodiments, the display generation component is the same as or similar to the display generation component described above with reference to method 800.

In some embodiments, the computer system (e.g., 101) displays (1002a), via the display generation component (e.g., 120), a text entry field (e.g., 906), such as in FIG. 9A. In some embodiments, the text entry field is displayed in a three-dimensional environment the same as or similar to the three-dimensional environment described above with reference to method 800. In some embodiments, the text entry field is an interactive user interface element that accepts text input. In some embodiments, the three-dimensional environment includes a selectable option that, when selected, causes the computer system to perform an operation with respect to the text (e.g., previously) entered into the text entry field. For example, the text entry field is a web address bar, a search box, a field that accepts a file name, a message field, or a word processor and the selectable option is a navigation option, a search option, a save or load option, an option to send a message, or an option to save the entered text as a document, respectively. In some embodiments, the text entry field has one or more of the features of text entry fields described below with reference to methods 1200, 1400, and/or 1600.

In some embodiments, while displaying, via the display generation component (e.g., 120), the text entry field (1002b), such as in FIG. 9A, the computer system (e.g., 101) detects (1002c), via the one or more input devices (e.g., a microphone), a first speech input (e.g., 916a) from the user, such as in FIG. 9B. In some embodiments, receiving the first speech input includes detecting the user speaking words, numbers, letters and/or special characters (e.g., non-letter symbols included in written text). In some embodiments, while detecting the gaze of the user directed to the text entry field and the first speech input, the computer system does not detect an additional input (e.g., via one or more input devices other than the eye tracking device and/or microphone) corresponding to a request to enter text into the text entry field.

In some embodiments, while displaying, via the display generation component (e.g., 120), the text entry field (1002b), in response to detecting the first speech input (e.g., 916a) from the user, such as in FIG. 9A (1002d), in accordance with a determination that attention (e.g., including gaze 913a) of the user is directed to the text entry field (e.g., 906), such as in FIG. 9B (e.g., gaze of the user or a proxy for gaze of the user is maintained for a threshold period of time as described in more detail below and before detecting the first speech input) when the first speech input (e.g., 916a) from the user is received, the computer system displays (1002e), via the display generation component (e.g., 120), a text representation (e.g., 920) of the first speech input in the text entry field (e.g., 906), such as in FIG. 9C. In some embodiments, the text representation of the first speech input is a written representation of the words and/or characters spoken by the user. In some embodiments, prior to receiving the first speech input, the computer system presents respective text in the text entry field and, displaying the font-based text representation of the first speech input includes replacing the respective text with the text representation of the first speech input. For example, the respective text indicates the purpose of the text entry field (e.g., “message” or similar text in a messaging text entry field, “search” or “enter search term here” in a search text entry field) or includes text associated with previous or current functionality of an application associated with the text entry field (e.g., the URL of a website that is presented in a web browser when the first speech input is received). In some embodiments, the font-based text representation of the first speech input in the text entry field is added to the respective text, such as adding text to a document in a word processing application.

In some embodiments, while displaying, via the display generation component (e.g., 120), the text entry field (1002b), in response to detecting the first speech input (e.g., 916a) from the user, such as in FIG. 9A (1002d), in accordance with a determination that the attention (e.g., 913b) of the user is not directed to the text entry field (e.g., 902) when the first speech input (e.g., 916b) from the user is received (e.g., gaze of the user is not directed to the text entry field or the gaze has been maintained for less than the threshold period of time described in more detail below and before detecting the first speech input), such as in FIG. 9C, the computer system (e.g., 101) forgoes (e.g., 10020 displaying the text representation of the first speech input in the text entry field (e.g., 906), such as in FIG. 9E. In some embodiments, forgoing displaying the text representation of the first speech input in the text entry field includes maintaining display of respective text displayed in the text entry field while the first speech input was detected.

Displaying the text representation of the first speech input in the text entry field as described above enhances user interactions with the computer system by providing additional control techniques (e.g., speech input) without cluttering the user interface with additional displayed controls.

In some embodiments, the determination that the attention (e.g., 913a) of the user is directed to the text entry field (e.g., 906) when the first speech input from the user (e.g., 916a) is received includes a determination that a gaze (e.g., 913a) of the user is directed to the text entry field (e.g., 906) for at least a time threshold (1004a) (e.g., 0.1, 0.2, 0.3, 0.5, 1, 2, or 3 seconds), such as in FIG. 9B. In some embodiments, the computer system determines the location of the user's gaze using an eye tracking device included in the one or more input devices. In some embodiments, the determination that the attention of the user is not directed to the text entry field includes a determination that the gaze of the user is not directed to the text entry field or a determination that the gaze of the user is directed to the text entry field for less than the time threshold. Displaying the text representation of the first speech input in the text entry field based on detecting the gaze of the user directed to the text entry field for a time threshold enhances user interactions with the computer system by providing additional control options without cluttering the user interface with additional displayed controls.

In some embodiments, such as in FIG. 9A, detecting that the attention (e.g., 913a) of the user is directed to the text entry field (e.g., 906) includes detecting that a gaze (e.g., 913a) of the user is directed to the text entry field (e.g., 906) for longer than a time threshold (e.g., 0.1, 0.2, 0.3 0.5, 1, 2, or 3 seconds) (1006a). In some embodiments, such as in FIG. 9B, while displaying the text entry field (e.g., 906), in response to detecting the gaze (e.g., 913a) of the user directed to the text entry field (e.g., 906), the computer system (e.g., 101) presents (1006b) an indication (e.g., 910a and/or 914) of a duration of time for which the gaze of the user has been directed to the text entry field. In some embodiments, the computer system modifies the indication of the duration of time for which the gaze of the user has been directed to the text entry field as the user's gaze continues to be directed to the text entry field. In some embodiments, the computer system presents the indication in response to detecting the gaze of the user directed to the text entry field for the time threshold. In some embodiments, the indication is a visual indication displayed via the display generation component. In some embodiments, the indication is an audio indication presented via one or more audio output devices in communication with the computer system. In some embodiments, the visual indication is gradual expansion of the text entry field (e.g., horizontally). In some embodiments, the visual indication is a progress bar. In some embodiments, the visual indication is a gradual change in color of the text entry field and/or the outline of the text entry field.

Presenting the indication of the duration of time for which the gaze of the user has been directed to the text entry field enhances user interactions with the computer system by providing improved feedback to the user.

In some embodiments, while displaying the text entry field (e.g., 906) and in response to detecting the gaze (e.g., 913a) of the user directed to the text entry field (e.g., 906) (1008a), such as in FIG. 9B, in accordance with a determination that the duration of time for which the gaze (e.g., 913a) of the user has been directed to the text entry field (e.g., 906) (e.g., meets or) exceeds the time threshold, the computer system (e.g., 101) presents (1008b) a second indication (e.g., 910a and/or 914) indicating that first speech input (e.g., 916a) will be directed to the text entry field (e.g., 906). In some embodiments, presenting the second indication indicating that the first speech input will be directed to the text entry field includes expanding the text entry field. For example, the computer system increases the width of the text entry field. In some embodiments, presenting the second indication indicating that the first speech input will be directed to the text entry field includes initiating display of a visual indication (e.g., an icon or image, such as an image of a microphone or speech bubble). In some embodiments, the second indication indicating that the first speech input will be directed to the text entry field is displayed at an insertion location in the text in the text entry field at which the text of the first speech input will be entered in response to the first speech input. In some embodiments, the second indication indicating that the first speech input will be directed to the text entry field is an audio indication presented via one or more audio output devices in communication with the computer system.

In some embodiments, while displaying the text entry field (e.g., 906) and in response to detecting the gaze (e.g., 913a) of the user directed to the text entry field (e.g., 906) (1008a), such as in FIG. 9A, in accordance with a determination that the duration of time for which the gaze (e.g., 913a) of the user has been directed to the text entry field (e.g., 906) is less than the time threshold, the computer system (e.g., 101) forgoes (1008c) presenting the second indication. In some embodiments, the computer system maintains display of the visual indication in response to detecting the gaze of the user directed to the text entry field irrespective of whether the gaze of the user has been directed to the text entry field for the time threshold. In some embodiments, the computer system ceases display of the visual indication that the gaze of the user is directed to the text entry field in response to detecting the gaze of the user directed to the text entry field for the time threshold.

Presenting the second indication indicating that the first speech input will be directed to the text entry field in response to the gaze of the user being directed to the text entry field for the time threshold enhances user interactions with the computer system by providing enhanced feedback to the user.

In some embodiments, while displaying the text entry field (e.g., 906), in response to detecting the first speech input (e.g., 916a) from the user (1010a), such as in FIG. 9B, in accordance with the determination that the attention (e.g., 913a) of the user is directed to the text entry field (e.g., 906), the computer system (e.g., 101) displays (1010b), via the display generation component (e.g., 120), a text cursor (e.g., 912) in the text entry field (e.g., 906), wherein the text representation (e.g., 920) of the first speech input is inserted into the text entry field (e.g., 906) at a location of the text cursor (e.g., 912) in the text entry field (e.g., 906), such as in FIG. 9C. In some embodiments, the computer system does not display the text cursor in the text entry field unless and until detecting the first speech input from the user while the attention of the user is directed to the text entry field. In some embodiments, the text cursor is an insertion marker. In some embodiments, after displaying the text representation of the first speech input in the text entry field, in accordance with a determination that the attention of the user is still directed to the text entry field, the computer system maintains display of the text cursor at an updated location in the text entry field (e.g., at the end of the text representation of the first speech input). In some embodiments, the text cursor is a visual indication displayed via the display generation component that indicates a location in the text entry field at which text will be entered in response to an input corresponding to a request to enter text in the text entry field (e.g., a dictation input, a soft keyboard input in accordance with methods 1200, 1400, and/or 1600, or a hardware keyboard input). In some embodiments, the computer system updates the position of the text cursor in the text entry field while entering respective text into the text entry field in response to the input corresponding to the request to enter text to indicate that subsequent text entered in response to subsequent inputs corresponding to requests to enter text to the text entry field will be entered after the respective text.

In some embodiments, while displaying the text entry field (e.g., 906), in response to detecting the first speech input (e.g., 916a) from the user (1010a), such as in FIG. 9B, in accordance with the determination that the attention (e.g., 913b) of the user is not directed to the text entry field (e.g., 906), such as in FIG. 9C, the computer system (e.g., 101) forgoes (1010c) displaying the text cursor in the text entry field (e.g., 906), such as in FIG. 9A.

Displaying the text cursor in the text entry field enhances user interactions with the computer system by providing improved visual feedback to the user.

In some embodiments, detecting that the attention (e.g., 913a) of the user is directed to the text entry field (e.g., 906) includes detecting that a gaze (e.g., 913a) of the user is directed to the text entry field (e.g., 906) for longer than a time threshold (e.g., 0.1, 0.2, 0.3, 0.5, 1, 2, or 3 seconds) (1012a), such as in FIG. 9A.

In some embodiments, while the attention (e.g., 913a) of the user is directed away from the text entry field (e.g., 906), the computer system (e.g., 101) displays (1012b), via the display generation component (e.g., 120), the text entry field (e.g., 906) with a visual characteristic (e.g., color, opacity, line style, and/or size) having a first value, such as in FIG. 9A.

In some embodiments, while displaying, via the display generation component (e.g., 120), the text entry field (e.g., 906) with the visual characteristic having the first value, such as in FIG. 9A, the computer system (e.g., 101) detects (1012c), via the one or more input devices (e.g., 314), the gaze (e.g., 913a) of the user directed to the text entry field (e.g., 913a), such as in FIG. 9A.

In some embodiments, in response to detecting the gaze (e.g., 913a) of the user directed to the text entry field (e.g., 906), the computer system (e.g., 101) gradually modifies (1012d) display, via the display generation component (e.g., 120), of the text entry field (e.g., 906) with the visual characteristic having the first value to display, via the display generation component (e.g., 120), the text entry field (e.g., 906) with the visual characteristic having a second value different from the first value in accordance with a duration of the gaze (e.g., 913a) of the user being directed to the text entry field (e.g., 906), such as in FIG. 9B. In some embodiments, the value of the visual characteristic changes over time as the gaze of the user remains directed to the text entry field. For example, the visual characteristic is color, size, border, or brightness and the computer system displays the text entry field with a first color, size, border, or brightness while the gaze of the user is not directed to the text entry field and gradually changes the color, size, border, or brightness of the text entry field while the gaze of the user remains directed to the text entry field to transition to displaying the text entry field in a second color, size, border, or brightness in response to detecting the gaze of the user directed to the text entry field for the time threshold.

Gradually modifying the value of the visual characteristic of the text entry field in response to detecting the gaze of the user directed to the text entry field enhances user interactions with the computer system by providing enhanced visual feedback to the user.

In some embodiments, while displaying, via the display generation component (e.g., 120), the text entry field (e.g., 906), in response to detecting the first speech input (e.g., 916b) from the user, in accordance with the determination that the attention (e.g., 913a) of the user is directed to the text entry field (e.g., 906) when the first speech input (e.g., 916a) from the user is received, such as in FIG. 9B, the computer system (e.g., 101) displays (1014), via the display generation component (e.g., 120), the text entry field (e.g., 906) with a visual characteristic (e.g., size, color, opacity, outline style, and/or a visual effect such as a glow or shadow) having a respective value that changes over time in accordance with changes over time of characteristic (e.g., a volume, tone, and/or frequency) of the first speech input (e.g., 916a), such as in FIGS. 9B-9C. In some embodiments, the visual characteristic is a glow effect displayed around the text entry field. In some embodiments, the intensity (e.g., color darkness, brightness, saturation, thickness, and/or opacity) of the glow (and/or other visual characteristic) changes over time in accordance with the audio level of the first speech input.

Displaying the text entry field with the visual characteristic with the respective value that changes over time in accordance with a characteristic of the first speech input enhances user interactions with the computer system by providing improved visual feedback to the user.

In some embodiments, while displaying, via the display generation component (e.g., 120), the text entry field (e.g., 906) after detecting, via the one or more input devices, the first speech input (e.g., 916a) from the user (1016a), such as in FIG. 9B, the computer system (e.g., 101) detects (1016b), via the one or more input devices (e.g., 314), a second speech input (e.g., 916b), that is a continuation of the first speech input, from the user while the attention (e.g., 913b) of the user is not directed to the text entry field, such as in FIG. 9C. In some embodiments, the beginning of the second speech input from the user is detected within a time threshold (e.g., 0.5, 1, 2, 3, 4, or 5 seconds) of detecting the end of the first speech input. For example, the computer system detects the user not speaking for less than the time threshold between the first speech input and the second speech input. In some embodiments, the attention of the user is directed to an area of the three-dimensional environment other than the text entry field. In some embodiments, the attention of the user is not directed to the three-dimensional environment. In some embodiments, the user's eyes are closed for longer than a time threshold (e.g., 0.1, 0.2, 0.3, 0.5, 1, 2, or 3 seconds) associated with blinking.

In some embodiments, while displaying, via the display generation component (e.g., 120), the text entry field (e.g., 906) after detecting, via the one or more input devices, the first speech input (e.g., 916a) from the user (1016a), such as in FIG. 9B, in response to detecting the second speech input (e.g., 916b) from the user while the attention (e.g., 913b) of the user is not directed to the text entry field (e.g., 906) (1016c), such as in FIG. 9C, in accordance with the determination that the attention (e.g., 913a) of the user was directed to the text entry field (e.g., 906) when the first speech input (e.g., 916a) from the user was received, such as in FIG. 9B, the computer system (e.g., 101) displays (1016d), via the display generation component (e.g., 120), a text representation (e.g., 920) of the second speech input in the text entry field (e.g., 906), such as in FIG. 9D. In some embodiments, the computer system displays the text representation of the first speech input in the text entry field while the user provides the second speech input. In some embodiments, the computer system displays the text representation of the second speech input concurrently with the text representation of the first speech input in the text entry field. In some embodiments, the computer system initiates a process to present text representations of speech inputs in the text entry field in response to detecting the attention of the user directed to the text entry field and continues to enter text representations of additional speech inputs even if the additional speech inputs are detected while the attention of the user is no longer directed to the text entry field.

In some embodiments, while displaying, via the display generation component (e.g., 120), the text entry field (e.g., 906) after detecting, via the one or more input devices, the first speech input (e.g., 916a) from the user (1016a), such as in FIG. 9B, in response to detecting the second speech input (e.g., 916b) from the user while the attention (e.g., 913b) of the user is not directed to the text entry field (e.g., 906) (1016c), such as in FIG. 9C, in accordance with the determination that the attention of the user was not directed to the text entry field (e.g., 906) when the first speech input was received, the computer system (e.g., 101) forgoes (1016e) displaying, via the display generation component (e.g., 120), the text representation of the second speech input in the text entry field (e.g., 906), such as in FIG. 9E. In some embodiments, because the attention of the user was not directed to the text entry field when the first speech input was received, the computer system forgoes displaying the text representation of the first speech input in the text entry field and displays the text entry field without the text representation of the first speech input while the second speech input is received (e.g., irrespective of where the user is looking while the computer system detects the second speech input). In some embodiments, the computer system does not initiate the process to enter text representations of speech inputs into the text entry field unless and until the computer system detects the attention of the user directed to the text entry field.

Displaying the text representation of the second speech input in the text entry field enhances user interactions with the computer system by performing an operation when a set of conditions has been met without requiring further user input.

In some embodiments, while displaying the text representation (e.g., 920) of the first speech input in the text entry field (e.g., 906) in response to detecting the first speech input from the user while the attention of the user is directed to the text entry field (1018a), such as in FIG. 9C, the computer system (e.g., 101) receives (1018b), via the one or more input devices (e.g., 120), a second speech input (e.g., 916b) that is a continuation of the first speech input from the user while the attention (e.g., 906) of the user is directed away from the text entry field, such as in FIG. 9C. In some embodiments, the second speech input received while the attention of the user is directed away from the text entry field is similar to the second speech input received while the attention of the user is directed away from the text entry field described above.

In some embodiments, while displaying the text representation (e.g., 920) of the first speech input in the text entry field (e.g., 906) in response to detecting the first speech input from the user while the attention of the user is directed to the text entry field (1018a), such as in FIG. 9C,

in response to receiving the second speech input (e.g., 916b in FIG. 9C), the computer system (e.g., 101) displays (1018c), via the display generation component (e.g., 120), a text representation (e.g., 920) of the second first speech input, such as in FIG. 9D. In some embodiments, the computer system continues to enter text representations of user speech after entering the text representation of the first speech input in response to detecting the attention of the user directed to the text entry field while providing the first speech input as described above.

Displaying the text representation of the continuation of the first speech input in the text entry field enhances user interactions with the computer system by performing an operation when a set of conditions has been met without requiring further user input.

In some embodiments, while displaying, via the display generation component, the text representation (e.g., 920) of the first speech input in the text entry field (e.g., 906) (e.g., after detecting the first speech input while the attention of the user is directed to the text entry field), the computer system (e.g., 101) detects (1020a), via the one or more input devices (e.g., 314), a second speech input (e.g., 916b) that is a continuation of the first speech input from the user while the attention (e.g., 913b) of the user is not directed to the text entry field (e.g., 906), such as in FIG. 9C). In some embodiments, the second speech input from the user that is detected while the attention of the user is not directed to the text entry field is similar to the second speech input from the user that is detected while the attention of the user is not directed to the text entry field described above.

In some embodiments, in response to detecting the second speech input (e.g., 916b) from the user while the attention (e.g., 913b) of the user is not directed to the text entry field (e.g., 906), the computer system (e.g., 101) ceases (1020b) display, via the display generation component (e.g., 120), of the text representation (e.g., 920) of the first speech input in the text entry field (e.g., 906), such as in FIG. 9E. In some embodiments, in response to detecting the user's attention directed away from the text entry field (e.g., detecting the user look away from the text entry field), the computer system deletes text in the text entry field that was previously entered via dictation. In some embodiments, in response to detecting the user's attention directed away from the text entry field (e.g., detecting the user look away from the text entry field), the computer system deletes text in the text entry field that was entered via dictation without performing an operation associated with the text entry field (e.g., searching for a search term entered into the text entry field, sending a message entered into the text entry field, and/or navigating to a website entered in the text entry field).

Ceasing display of the text representation of the first speech input in the text entry field in response to detecting the second speech input while the attention of the user is directed away from the text entry field enhances user interactions with the computer system by reducing the number of inputs needed to perform an operation (e.g., removing the text representation of the first speech input from the text entry field).

In some embodiments, in response to detecting the first speech input (e.g., 916a) from the user, in accordance with the determination that the attention (e.g., 913a) of the user is directed to the text entry field (e.g., 906) when the first speech input (e.g., 916a) is received, the computer system (e.g., 101) displays (1022a), via the display generation component (e.g., 120), the text entry field (e.g., 906) with a visual characteristic (e.g., color, size, opacity, text style such as font style, text size, and/or text highlighting, and/or border style) having a first value, such as in FIG. 9B. In some embodiments, the computer system displays the text entry field with the visual characteristic having the first value while detecting the voice input while the attention of the user is directed to the text entry field. In some embodiments, the computer system displays the text representation of the voice input with highlighting in response to (e.g., and while) detecting the voice input while the attention of the user is directed to the text entry field. In some embodiments, the computer system displays.

In some embodiments, while displaying, via the display generation component (e.g., 120), the text entry field (e.g., 906) with the visual characteristic having the first value, the computer system (e.g., 101) detects (1022b), via the one or more input devices (e.g., 314), that the attention (e.g., 913b) of the user is not directed to the text entry field (e.g., 906), such as in FIG. 9C. In some embodiments, the attention of the user is directed to a region of the three-dimensional environment other than the text entry field. In some embodiments, the attention of the user is directed away from the three-dimensional environment (e.g., away from the display generation component). In some embodiments, the user closes their eyes for more than a time threshold (e.g., 0.5, 1, 2, 3, or 5 seconds) associated with blinking.

In some embodiments, in response to detecting that the attention of the user is not directed to the text entry field (e.g., 906), the computer system (e.g., 101) displays (1022c), via the display generation component (e.g., 120), the text entry field (e.g., 906) with the visual characteristic having a respective value that changes over time until reaching a second value different from the first value, such as in FIG. 9A. In some embodiments, the value of the visual characteristic gradually changes over time until reaching the second value in response to detecting the attention of the user not directed to the text entry field. For example, highlighting over text included in the text entry field gradually fades away. Transitioning to displaying the text entry field with the visual characteristic having the second value in response to detecting the attention of the user not directed to the text entry field enhances user interactions with the computer system by providing enhanced visual feedback to the user.

In some embodiments, while displaying the text representation (e.g., 920) of the first speech input in the text entry field (e.g., 906) in response to detecting the first speech input from the user (1024a), such as in FIG. 9D, the computer system (e.g., 101) detects (1024b), via the one or more input devices (e.g., 314), a second speech input (e.g., 916c).

In some embodiments, while displaying the text representation (e.g., 920) of the first speech input in the text entry field (e.g., 906) in response to detecting the first speech input from the user (1024a), such as in FIG. 9D, in response to detecting the second speech input (e.g., 916c), in accordance with a determination that the second speech input (e.g., 916c) corresponds to a request to perform an action with respect to the text representation (e.g., 920) of the first speech input in the text entry field (e.g., 906) and one or more criteria are satisfied (e.g., including a criterion that is satisfied when the attention of the user is directed to the text entry field), such as in FIG. 9D, the computer system (e.g., 101) performs (1024d) the action with respect to the text representation (e.g., 920) of the first speech input in the text entry field (e.g., 906). In some embodiments, the second speech input is or includes predetermined speech associated with the action. For example, the text entry field is a message composition field, the second speech input is “send,” “send it,” or similar, and the action is sending a message including the text representation of the first speech input. As another example, the text entry field is a search field, the second speech input is “search,” “go,” or similar, and the action is conducting a search that includes the text representation of the first speech input as the search term.

In some embodiments, while displaying the text representation (e.g., 920) of the first speech input in the text entry field (e.g., 906) in response to detecting the first speech input from the user (1024a), such as in FIG. 9D, in response to detecting the second speech input (e.g., 916c), in accordance with a determination that the second speech input does not correspond to the request to perform the action with respect to the text representation (e.g., 920) of the first speech input in the text entry field (e.g., 906) or the one or more criteria are not satisfied, the computer system (e.g., 101) forgoes (1024e) performing the action with respect to the text representation (e.g., 920) of the first speech input in the text entry field (e.g., 906). In some embodiments, the second speech input does not include the predetermined speech associated with the action. In some embodiments, the computer displays a text representation of the second speech input in the text entry field in response to the second speech input that does not correspond to the request to perform the action (e.g., instead of or in addition to the text representation of the first speech input).

Performing the action with respect to the text representation of the first speech input in the text entry field in response to the second speech input enhances user interactions with the computer system by providing additional controls without cluttering the user interface with additional displayed controls.

In some embodiments, such as in FIG. 9D, in accordance with a determination that the text entry field (e.g., 906) is a first type of text entry field, the determination that the second speech input (e.g., 916c) corresponds to the request to perform the action with respect to the text representation (e.g., 920) of the first speech input in the text entry field (e.g., 906) is based on one or more first criteria (1026a). In some embodiments, the one or more first criteria include a criterion that is satisfied when the second speech input includes first speech. For example, if the text entry field is a search field, the one or more first criteria include a criterion that is satisfied when the second speech input includes “search,” “go,” or similar. In some embodiments, in accordance with a determination that the second speech input corresponds to an action associated with a second type of text entry field different from the first type of text entry field, the computer system forgoes performing the action with respect to the text representation of the first speech input in the text entry field.

In some embodiments, in accordance with a determination that the text entry field is a second type of text entry field, different from the first type of text entry field (e.g., a text entry field different form the text entry field 906 in FIG. 9D), the determination that the second speech input (e.g., 916c) corresponds to the request to perform the action with respect to the text representation (e.g., 920) of the first speech input in the text entry field is based on one or more second criteria, different from the one or more first criteria (1026b). In some embodiments, the one or more second criteria include a criterion that is satisfied when the second speech input includes second speech. For example, if the text entry field is a messaging field, the one or more first criteria include a criterion that is satisfied when the second speech input includes “send,” “send it,” or similar. In some embodiments, in accordance with a determination that the second speech input corresponds to an action associated with the first type of text entry field different from the second type of text entry field, the computer system forgoes performing the action with respect to the text representation of the first speech input in the text entry field.

Evaluating the second speech input according to different criteria depending on a type of the text entry field enhances user interactions with the computer system by providing additional control options without cluttering the user interface with additional displayed controls.

In some embodiments, the one or more criteria include a criterion that is satisfied when the gaze (e.g., 913c) of the user is directed to the text entry field (e.g., 906) (e.g., for at least a time threshold (e.g., 0.1, 0.2, 0.3, 0.5, 1, 2, or 3 seconds)) while the computer system (e.g., 101) detects the second speech input (e.g., 916c) (1028), such as in FIG. 9D. In some embodiments, in accordance with a determination that the gaze of the user is not directed to the text entry field while the computer system detects the second input, the computer system forgoes performing the action with respect to the text representation of the first speech input in the text entry field irrespective of whether or not the second speech input satisfies one or more additional criteria for determining that the second speech input corresponds to the request to perform the action with respect to the text representation of the first speech input in the text entry field, such as the first speech input including predefined speech associated with the action.

Determining that the second speech input corresponds to a request to perform the action with respect to the text representation of the first speech input in the text entry field based on the gaze of the user being directed to the text entry field while detecting the second speech input enhances user interactions with the computer system by providing additional control options without cluttering the user interface with additional displayed controls.

In some embodiments, such as in FIG. 9A, prior to detecting the first speech input (e.g., 916a) from the user, such as in FIG. 9B, the computer system (e.g., 101) displays (1030a), via the display generation component (e.g., 120), respective text in the text entry field (e.g., 906), such as in FIG. 9A. In some embodiments, the respective text was previously entered in response to a second speech input similar to the first speech input described above and according to the same or similar conditions as the conditions described above. In some embodiments, the respective text was previously entered by the user via a different input modality, such as using a soft keyboard according to one or more of methods 1200, 1400, or 1600 described below or using a hardware keyboard. In some embodiments, the respective text is placeholder text automatically displayed by the computer system without receiving an input corresponding to a request to enter the placeholder text in the text entry field.

In some embodiments, in response to detecting the first speech input (e.g., 916a) from the user, such as in FIG. 9B, in accordance with the determination that the attention (e.g., 913a) of the user is directed to the text entry field (e.g., 906), the computer system (e.g., 101) ceases (1030b) display, via the display generation component (e.g., 120), of the respective text in the text entry field (e.g., 906) and displays the text representation (e.g., 920) of the first speech input in the text entry field (e.g., 906), such as in FIG. 9C. In some embodiments, the computer system replaces the respective text with the text representation of the first speech input in the text entry field in response to detecting the first speech input from the user while the attention of the user is directed to the text entry field. In some embodiments, the computer system ceases display of the respective text in the text entry field in response to the first speech input without detecting an additional input corresponding to a request to cease display of the respective text in the text entry field. Ceasing display of the respective text and displaying the text representation of the first speech input in the text entry field in response to detecting the first speech input enhances user interactions with the computer system by performing an operation when a set of conditions has been met without requiring further user input.

In some embodiments, prior to detecting the first speech input from the user, the computer system (e.g., 101) displays (1032a), via the display generation component (e.g., 120), respective text and a cursor (e.g., 928) at a first location in the text entry field (e.g., 926), such as in FIG. 9F. In some embodiments, the computer system displays the cursor in accordance with a determination that is it possible to edit the respective text. In some embodiments, the computer system displays the cursor in accordance with a determination that is it possible to edit the respective text in a manner other than replacing the entirety of the respective text (e.g., adding text or deleting a portion of the respective text without detecting the entirety of the respective text). In some embodiments, in accordance with a determination that it is not possible to edit the respective text, (optionally in response to detecting the first speech input while the attention of the user is directed to the text entry field) the computer system forgoes display of the cursor prior to detecting the first speech input.

In some embodiments, in response to detecting the first speech input (e.g., 916d) from the user, in accordance with the determination that the attention (e.g., 913d) of the user is directed to the text entry field (e.g., 926) (1032a), such as in FIG. 9G, the computer system (e.g., 101) maintains (1032b) display, via the display generation component (e.g., 120), of the respective text in the text entry field (e.g., 926). In some embodiments, in accordance with the determination that it is not possible to edit the respective text, in response to detecting the first speech input while the attention of the user is directed to the text entry field, the computer system ceases display of the respective text in the text entry field and displays the cursor or the visual indication described in more detail below.

In some embodiments, in response to detecting the first speech input (e.g., 916d) from the user, in accordance with the determination that the attention (e.g., 913d) of the user is directed to the text entry field (e.g., 926) (1032a), such as in FIG. 9G, the computer system (e.g., 101) cease (1032d) display, via the display generation component (e.g., 120), of the cursor in the text entry field (e.g., 926).

In some embodiments, in response to detecting the first speech input (e.g., 916d) from the user, in accordance with the determination that the attention (e.g., 913d) of the user is directed to the text entry field (e.g., 926) (1032a), such as in FIG. 9G, the computer system (e.g., 101) displays (1032e), via the display generation component (e.g., 120), a visual indication (e.g., 930) at a second location (e.g., the same as the first location or different from the first location) in the text entry field (e.g., 926), wherein the text representation of the first speech input is added to the respective text at the second location in the text entry field (e.g., 926). In some embodiments, the visual indication is different from the cursor. In some embodiments, the visual indication is the same as the cursor. In some embodiments, after entering the text representation of the first speech input to the text entry field, the computer system displays the visual indication (e.g., immediately) adjacent to (e.g., after) the text representation of the first speech input. In some embodiments, the visual indication is an image of a microphone or speech bubble or talking person. In some embodiments, in response to detecting the attention of the user directed away from the text entry field without detecting continuation of the first speech input, the computer system ceases displaying the visual indication and initiates display of the cursor (e.g., at a location in the text entry field corresponding to the text representation of the first speech input).

Displaying the visual indication at the location in the text entry field at which the text representation of the first speech input is to be added in response to detecting the first speech input from the user enhances user interactions with the computer system by providing improved visual feedback to the user.

In some embodiments, in accordance with a determination that the gaze (e.g., 913d) of the user is directed to a first portion of the text in the text entry field (e.g., 926) while the first speech input (e.g., 916d) from the user is detected, the second location, at which the text representation of the speech is added to the respective text, is proximate to (e.g., near or adjacent to) the first portion of the text (1034a), such as in FIGS. 9G-9H.

In some embodiments, in accordance with a determination that the gaze of the user is directed to a second portion of the text in the text entry field (e.g., 926) different from the first location in the text entry field while the first speech input from the user is detected (e.g., the gaze 913d of the user in FIG. 9G is at a location other than the location shown in FIG. 9G), the second location, at which the text representation of the speech is added to the respective text, is proximate to (e.g., near or adjacent to) the second portion of the text (1034b). In some embodiments, the computer system displays the visual indication at the location in the text entry field at which the user is looking while the attention of the user is directed to the text entry field. In some embodiments, the computer system updates the position of the position of the visual indication in accordance with the user's gaze moving from one location in the text entry field to another location in the text entry field prior to the user providing the first speech input. In some embodiments, once the computer system displays the visual indication at the second location, the computer system maintains display of the visual indication at the second location even if the gaze of the user moves from the second location until ceasing display of the visual indication in accordance with one or more criteria being met (e.g., the user directing their attention away from the text entry field or the user providing an input to a user interface element other than the text entry field, the user providing an input to cease entering text in the text entry field based on first speech inputs).

Displaying the visual indication and entering text at a location based on the gaze of the user enhances user interactions with the computer system by providing additional control options without cluttering the user interface with additional displayed controls.

In some embodiments, such as in FIG. 9C, while displaying, via the display generation component (e.g., 120), the text representation (e.g., 920) of the first speech input in text entry field (e.g., 906) in response to detecting the first speech input from the user in accordance with the determination that the attention of the user is directed to the text entry field (e.g., 906) when the first speech input from the user is received (1036a), while detecting, via the one or more input devices, a second speech input (e.g., 916b) that is a continuation of the first speech input from the user, the computer system (e.g., 101) detects (1036b), via the one or more input devices (e.g., 314), the attention (e.g., 913b) of the user not directed to the text entry field (e.g., 906), such as in FIG. 9C. In some embodiments, the second speech input that is a continuation of the first speech input detected while the attention of the user is not directed to the text entry field is similar to the second speech input that is a continuation of the first speech input detected while the attention of the user is not directed to the text entry field described in more detail above.

In some embodiments, such as in FIG. 9C, while displaying, via the display generation component (e.g., 120), the text representation (e.g., 920) of the first speech input in text entry field (e.g., 906) in response to detecting the first speech input from the user in accordance with the determination that the attention of the user is directed to the text entry field (e.g., 906) when the first speech input from the user is received (1036a), in response to detecting the attention (e.g., 913b) of the user not directed to the text entry field (e.g., 906), in accordance with a determination that the text entry field (e.g., 926) is a first type of text entry field, such as in FIG. 9G, the computer system (e.g., 101) displays (1036d), via the display generation component (e.g., 120), a text representation (e.g., 920) of the continuation of the first speech input (e.g., 920) in the text entry field (e.g., 906), such as in FIG. 9D. In some embodiments, the computer system maintains display of the text representation of the first speech input in the text entry field concurrently while displaying the text representation of the second speech input. In some embodiments, the computer system ceases display of the text representation of the first speech input in the text entry field and replaces it with the text representation of the second speech input in the text entry field. In some embodiments, the first type of text entry field is a longform text entry field that the computer system requires an input in addition to detecting the gaze of the user directed to the text entry field to initiate dictation, such as a notes field, a word processing application field, an e-mail composition field, and the like. In some embodiments, the input in addition to detecting the gaze of the user directed to the text entry field is selection of a user interface element associated with dictation input, a respective gesture performed with a portion of the body of the user, and/or a respective speech input (e.g., “Hey voice assistant, initiate dictation,” or similar).

In some embodiments, such as in FIG. 9C, while displaying, via the display generation component (e.g., 120), the text representation (e.g., 920) of the first speech input in text entry field (e.g., 906) in response to detecting the first speech input from the user in accordance with the determination that the attention of the user is directed to the text entry field (e.g., 906) when the first speech input from the user is received (1036a), in response to detecting the attention (e.g., 913b) of the user not directed to the text entry field (e.g., 906), in accordance with a determination that the text entry field (e.g., 906) is a second type of text entry field different from the first type of text entry field, such as in FIG. 9E, the computer system (e.g., 101) forgoes (1036e) display, via the display generation component (e.g., 120), of the text representation of the second speech input in the text entry field, such as in FIG. 9E. In some embodiments, the computer system ceases display of the text representation of the first speech input. In some embodiments, the computer system maintains display of the text representation of the first speech input. In some embodiments, the second type of text entry field is a short-form text entry field that the computer system initiates dictation into in response to the attention of the user being directed to the text entry field without detecting an additional input to initiate dictation, such as a messaging field, a message or notification quick-reply field, a search field, a web browser search, browse, or address field, and the like.

Selectively displaying the text representation of the second speech input in the text entry field in response to detecting the second speech input while the attention of the user is directed away from the text entry field enhances user interactions with the computer system by providing additional control options without cluttering the user interface with additional displayed controls.

In some embodiments, in response to detecting the attention (e.g., 913b) of the user not directed to the text entry field (e.g., 906), such as in FIG. 9C, in accordance with the determination that the text entry field (e.g., 926) is the first type of text entry field, such as in FIG. 9F, the computer system (e.g., 101) maintains (1038) display of the text representation of the first speech input in the text entry field (e.g., 926) and in accordance with the determination that the text entry field (e.g., 906) is the second type of text entry field, such as in FIG. 9E, the computer system (e.g., 101) cease display of the text representation of the first speech input in the text entry field (e.g., 906). In some embodiments, the computer system displays the text representation of the second speech input that is a continuation of the first speech input concurrently with the text representation of the first speech input in the text entry field in accordance with the determination that the text entry field is the first type of text entry field. In some embodiments, in accordance with the determination that the text entry field is the first type of text entry field, the computer system displays text representations of continuations of speech inputs in the text entry field in response to continuations of speech inputs even if the attention of the user is directed away from the text entry field while the continuation of the speech input is detected. In some embodiments, in accordance with the determination that the text entry field is the second type of text entry field, the computer system cancels dictation input into the text entry field in response to detecting the attention of the user directed away from the text entry field. For example, the computer system deletes the text entered in response to the voice input and forgoes entering additional text in response to the continuation of the voice input.

Selectively maintaining or ceasing display of the text representation of the first speech input depending on the type of the text entry field in response to detecting the attention of the user not directed to the text entry field enhances user interactions with the computer system by reducing the number of inputs needed to perform an operation.

In some embodiments, in accordance with the determination that the text entry field (e.g., 906) is the second type of text entry field, the computer system (e.g., 101) displays (1040), via the display generation component (e.g., 120), the text representation (e.g., 920) of the first speech input in the text entry field (e.g., 906) in response to detecting the first speech input from the user, such as in FIG. 9C, in accordance with the determination that the attention (e.g., 913a) of the user is directed to the text entry field (e.g., 906) when the first speech input (e.g., 916a) from the user is received irrespective of whether the computer system (e.g., 101) detects, via the one or more input devices (e.g., 314), a respective text entry input different from the first speech input prior to detecting the first speech input, such as in FIG. 9B. In some embodiments, in accordance with a determination that the text entry field is the second type of text entry field, the computer system initiates the process to enable the user to dictate text to the text entry field (e.g., displaying the text representation of the first speech input in the text entry field in response to the first speech input) in response to detecting the voice input while the attention of the user is directed to the text entry field without detecting an additional input. In some embodiments, the additional input is a voice input including a request to initiate dictation. In some embodiments, the additional input is selection of a selectable option that, when selected, causes the computer system to initiate dictation. In some embodiments, the text entry field of the second type is one of a messaging field, a message or notification quick-reply field, a search field, or a web browser search, browse, or address field.

Displaying the text representation of the first speech input in the text entry field in response to detecting the first speech input from the user in accordance with the determination that the attention of the user is directed to the text entry field when the first speech input is received irrespective of receiving a respective text entry input in accordance with the determination that the text entry field is the first type of text entry field enhances user interactions with the computer system by reducing the number of inputs needed to perform an operation.

In some embodiments, in accordance with the determination that the text entry field is the first type of text entry field, displaying (1042a), via the display generation component (e.g., 120), the text representation (e.g., 932) of the first speech input in the text entry field (e.g., 926), such as in FIG. 9H, is in response to detecting, via the one or more input devices (e.g., 314), a respective text entry input different from the first speech input prior to detecting the first speech input. In some embodiments, the respective text entry input is a voice input including a request to initiate dictation. In some embodiments, the respective text entry input is selection of a selectable option that, when selected, causes the computer system to initiate dictation. In some embodiments, the text entry field of the first type is one of an editable word processing document, an e-mail composition field, a notes application note, and the like.

In some embodiments, in response to detecting the first speech input from the user, in accordance with the determination that the text entry field (e.g., 926) is the first type of text entry field, such as in FIG. 9G, in accordance with a determination that the respective text entry input is not detected prior to detecting the first speech input (e.g., 916d) from the user, the computer system (e.g., 101) forgoes (1042b) displaying, via the display generation component (e.g., 120), the text representation of the first speech input in the text entry field (e.g., 926).

Selectively displaying the text representation of the first speech input in the text entry field in response to the first speech input based on whether or not the respective text entry input is detected enhances user interactions with the computer system by reducing user errors, such as entering text into a text entry field that the user did not intend to enter.

In some embodiments, such as in FIG. 9L, displaying the text representation of the speech input (e.g., 946b and/or 948b) includes displaying the text representation of the speech input (e.g., 946b and/or 948b) with a first appearance (e.g., a visual characteristic having a first value or first range of values, where the first visual characteristic is independent of a content of the text) (1044a). In some embodiments, the first value for the visual characteristic is a value that changes over time in accordance with detected audio (e.g., the speech input). In some embodiments, the visual characteristic is color, line thickness, position, size, and/or styling of the text representation of the speech input. In some embodiments, the computer system displays the text representation of the speech input with the visual characteristic having the first value while the speech input is being provided, and displays the text representation of the speech input with the visual characteristic having the second value or a third value after detecting the end of the speech input. In some embodiments, detecting the end of the speech input includes detecting the user cease speaking. In some embodiments, detecting the end of the speech input includes detecting confirmation of entering the text representation of the speech input, such as detecting the user speak a predefined word to end the speech input and/or perform a predefined gesture (e.g., with a hand) and/or direct attention to a predefined portion of the user interface.

In some embodiments, such as in FIG. 9M, the computer system (e.g., 101) receives (1044b), via the one or more input devices, a typed text entry input directed to the text entry field (e.g., 906). In some embodiments, the typed text entry input is detected using a hardware keyboard included in the one or more input devices according to one or more steps of method 2400. In some embodiments, the typed text entry input is detected using a soft keyboard displayed using the display generation component according to one or more steps of method(s) 1200, 1400, and/or 1600.

In some embodiments, such as in FIG. 9N, in response to receiving the typed text entry input, the computer system (e.g., 101) displays (1044c), via the display generation component (e.g., 120), a text representation of the typed text entry input (e.g., 952) the text entry field (e.g., 906), wherein the text representation of the typed text entry input (e.g., 952) is displayed with a second appearance different from the first appearance (e.g., the visual characteristic having a second value or second range of values different from the first value or first range of values). In some embodiments, displaying the text representation of the typed text entry input with the visual characteristic having the second value includes displaying the text representation of the typed text entry input in a solid color while receiving the typed text entry input. In some embodiments, after detecting an end of the typed text entry input (e.g., detecting no further typing after a threshold time of 0.1, 0.2, 0.3, 0.5, 1, 2, 3, or 5 seconds), the computer system continues to display the text representation of the typed text entry input with the visual characteristic having the second value. In some embodiments, after detecting an end of the typed text entry input (e.g., detecting no further typing after the threshold time), the computer system displays the text representation of the typed text entry input with the visual characteristic having a third value different from the first and second values. In some embodiments, even if the contents of the speech input and typed text entry input are the same, the appearances of the text representation of the speech input and the text representation of the typed text entry inputs are different (e.g., different text style, color, and/or size). In some embodiments, in response to receiving a text entry input corresponding to first text, in accordance with a determination that the text entry input includes a speech input (e.g., dictation input), the computer system displays the first text with the first appearance, and in accordance with a determination that the text entry input is a typed text entry input, the computer system displays the first text with the second appearance. Displaying the text representation of the speech input with the visual characteristic having the first value and displaying the text representation of the typed text entry input with the visual characteristic having the second value enhances user interactions with the computer system by providing enhanced visual feedback to the user and improved user privacy by indicating to the user when speech input is being received by the computer system.

In some embodiments, displaying the text representation of the speech input (e.g., 946b and/or 948b) with the first appearance includes displaying the text representation of the speech input (e.g., 946b and/or 948b) with a glowing effect, such as in FIG. 9L, and displaying the text representation of the typed text entry input (e.g., 952) in the text entry field (e.g., 906) with the second appearance includes displaying the text representation of the typed text entry input (e.g., 952) in the text entry field (e.g., 906) without the glowing effect, such as in FIG. 9N (1046a). In some embodiments, displaying the text representation of the typed text entry input with the visual characteristic having the second value includes displaying the text representation of the typed text entry input without the glowing effect. In some embodiments, displaying the text representation of the speech input with the glowing effect includes displaying an outline around the text representation with a color gradient that fades with respect to distance from the text representation. In some embodiments, displaying the text representation of typed text entry input without the glowing effect includes displaying the text representation with an outline that is a solid, non-gradient color or without an outline. In some embodiments, the color of the glow changes over time responsive to detected audio (e.g., the speech input). Displaying the text representation of the speech input with the glowing effect enhances user interactions with the computer system by providing improved visual feedback to the user and improved user privacy by indicating to the user when speech input is being received by the computer system.

In some embodiments, displaying the text representation of the speech input (e.g., 946b and/or 948b) with the first appearance includes (1048a) displaying (1048b), via the display generation component, a respective portion (e.g., 948b) of the text representation of the speech input with one or more colors that change over time for a period of time after displaying the respective portion of the text representation of the speech input in the text entry field, such as in FIG. 9L. In some embodiments, the colors are colors of a glow around the text representation of the speech input. In some embodiments, the colors are colors of the text of the text representation of the speech input. In some embodiments, as the computer system continues to detect the speech input, the computer system adds text to the text representation of the speech input by initially displaying the added text with the colors that vary over time for the threshold period of time.

In some embodiments, displaying the text representation of the speech input (e.g., 946b and/or 948b) with the first appearance includes (1048a), after the period of time has passed, displaying (1048c), via the display generation component (e.g., 120), the respective portion (e.g., 946b) of the text representation of the speech input with a respective color that does not change over time, such as in FIG. 9L. In some embodiments, the respective color is the same color as the color in which the computer system displays the text representation of the typed text input (e.g., the visual characteristic having the second value). In some embodiments, while continuing to detect the speech input, and while displaying a portion of the text representation of the speech input with the respective color, the computer system initiates display of additional portions of the text representation of the speech input (e.g., as additional portions of the speech input are detected) initially with the colors that change over time for the threshold period of time. In some embodiments, after the threshold period of time has passed, the computer system displays the text representation of the speech input with the second appearance (e.g., with the same appearance as text entered in response to a typed text entry input). Displaying the respective portion of the text representation of the speech input with colors that change over time for the threshold time followed by displaying the portion of the text representation of the speech input with the respective color that does not change over time enhances user interactions with the computer system by providing improved visual feedback to the user and improved user privacy by indicating to the user when speech input is being received by the computer system.

In some embodiments, such as in FIG. 9L, displaying the respective portion (e.g., 948b) of the text representation of the speech input with the colors that change over time includes displaying the respective portion (e.g., 948b) of the text representation of the speech input with colors that change over time responsive to changes in audio (e.g., volume, pitch, and/or timbre) levels of the speech input (1050a) over time. In some embodiments, the colors change in response to detecting a change in the audio levels of the speech input. Displaying the respective portion of the text representation of the speech input with colors that change responsive to the audio levels of the speech input enhances user interactions with the computer system by providing improved visual feedback to the user and improved user privacy by indicating to the user when speech input is being received by the computer system.

In some embodiments, the computer system (e.g., 101) displays (1052a), via the display generation component (e.g., 120), a text insertion marker (e.g., 912) in the text entry field that indicates a location in the text entry field at which additional text will be added in response to receiving a text entry input, such as in FIG. 9J-9L. In some embodiments, text entry inputs include the first speech input, other dictation inputs, and/or typed text entry inputs described above with reference to step 1044b. In some embodiments, as the computer system adds text to the text entry field in response to receiving a text entry input, the computer system updates the position of the text insertion marker to be after the text representation of the text entry input. In some embodiments, while the user is providing the first speech input, the computer system displays the text representation of the speech input as the speech input is received, and updates the position of the text insertion marker to remain after the text representation of the speech input in the text entry field. In some embodiments, the computer system moves the text insertion marker within the text entry field in response to receiving an input moving the insertion marker without adding text to the text entry field.

In some embodiments, while detecting the first speech input (e.g., 916e), the text insertion marker (e.g., 912) is displayed with a respective visual effect (e.g., 944a) (1052b), such as in FIG. 9J. In some embodiments, the respective visual effect is a highlight, glow, bold, glittering, and/or shimmering effect and/or displaying the text insertion marker with a different size, shape, color, or line style than the size, shape, color or line style used while the first speech input is not detected.

In some embodiments, such as in FIG. 9N, while not detecting the first speech input (or another dictation input directed to the text entry field), the text insertion marker (e.g., 912) is displayed without the respective visual effect (1052c). In some embodiments, while detecting typed text entry input or while not detecting a text entry input, the computer system displays the text insertion marker without the respective visual effect. Displaying the text insertion marker with the respective visual effect while detecting the first speech input and without the respective visual effect while not detecting the first speech input enhances user interactions with the computer system by providing improved visual feedback and improved user privacy by indicating to the user when speech input is being received by the computer system.

In some embodiments, such as in FIG. 9J, the respective visual effect (e.g., 944a) includes a visual characteristic that changes over time in response to changes in audio (e.g., volume, pitch, and/or timbre) levels of the first speech input (e.g., 916e) (1054a) over time. In some embodiments, the visual characteristic is color hue, color darkness, color saturation, translucency, size, and/or intensity of the visual effect. For example, the visual effect is a glowing effect similar to the glowing effect described above with reference to step 1046a with a color hue that changes over time in response to audio levels of the first speech input. In some embodiments, the change in color of the text insertion marker in response to audio levels of the speech input is coordinated with the change in color of the text representation of the first speech input in response to audio levels of the first speech input described above with reference to step 1050a. Displaying the text insertion marker with a respective visual effect that includes a visual characteristic that changes over time in response to audio levels of the first speech input enhances user interactions with the computer system by providing improved visual feedback to the user and improving user privacy by indicating to the user when speech input is being received by the computer system.

In some embodiments, such as in FIG. 9J, displaying the text entry field (e.g., 906) includes (1056a), while detecting the first speech input (e.g., 916e), displaying (1056b) the text entry field (e.g., 906) with a respective visual effect. In some embodiments, the respective visual effect is one or more of the visual effects described above with reference to step 1052b.

In some embodiments, such as in FIG. 9I, displaying the text entry field (e.g., 906) includes (1056a), while not detecting the first speech input (or another dictation input directed to the text entry field), displaying (1056c) the text entry field (e.g., 906) without the respective visual effect (1052c). In some embodiments, while detecting typed text entry input or while not detecting a text entry input, the computer system displays the text entry field without the respective visual effect. In some embodiments, the computer system displays the text entry field without the respective visual effect while receiving typed text entry input. Displaying the text entry field with the respective visual effect while detecting the first speech input and without the respective visual effect while not detecting the first speech input enhances user interactions with the computer system by providing improved visual feedback and improved user privacy by indicating to the user when speech input is being received by the computer system.

In some embodiments, such as in FIG. 9J, the respective visual effect is a glowing visual effect (e.g., 942a) (1058a). In some embodiments, the glowing visual effect is displayed around the edges of the text entry field. In some embodiments, the glowing visual effect is the same as or similar to the glowing visual effect described above with reference to step 1046a. Displaying the text entry field with the glowing visual effect while detecting the first speech input and without the respective visual effect while not detecting the first speech input enhances user interactions with the computer system by providing improved visual feedback and improved user privacy by indicating to the user when speech input is being received by the computer system.

In some embodiments, such as in FIG. 9J the glowing visual effect (e.g., 942a) includes a visual characteristic having a value that changes over time in response to changes in audio (e.g., volume, pitch, and/or timbre) levels of the first speech input (e.g., 916e) (1060a) over time. In some embodiments, the visual characteristic is color hue, color darkness, color saturation, translucency, size, and/or intensity of the visual effect. For example, the glowing effect changes color hue over time in response to audio levels of the first speech input, such as in step 1050a and/or 1054a. In some embodiments, the change in color of the text insertion marker in response to audio levels of the speech input is coordinated with the change in color of the text representation of the first speech input in response to audio levels of the first speech input described above with reference to step 1050a and/or with the change in color of the text representation of the first speech input in response to audio levels of the first speech input described above with reference to step 1054a. Displaying the text entry field with the glowing visual effect with the visual characteristic that changes over time in response to changes in audio levels of the first speech input enhances user interactions with the computer system by providing improved visual feedback and improved user privacy by indicating to the user when speech input is being received by the computer system.

In some embodiments, such as in FIG. 9J, displaying the text entry field (e.g., 906) with the respective visual effect includes displaying the text entry field (e.g., 906) with a first color (1062a). In some embodiments, the first color is applied to the background of the text entry field.

In some embodiments, such as in FIG. 9I, displaying the text entry field (e.g., 906) without the respective visual effect includes displaying the text entry field (e.g., 906) with a second color different from the first color (1062b). In some embodiments, the second color is applied to the background of the text entry field. Changing the color of the text entry field while receiving the first speech input enhances user interactions with the computer system by providing improved visual feedback and improved user privacy by indicating to the user when speech input is being received by the computer system.

In some embodiments, such as in FIG. 9J, displaying the text entry field (e.g., 906) with the first color includes changing a color (e.g., hue, darkness, and/or saturation) of the text entry field (e.g., 906) over time in response to changes in audio (e.g., volume, pitch, and/or timbre) levels of the first speech input (e.g., 916e) over time (1064a). In some embodiments, the change in color of the text entry field in response to audio levels of the speech input is coordinated with the change in color of the text representation of the first speech input in response to audio levels of the first speech input described above with reference to step 1050a and/or with the change in color of the text representation of the first speech input in response to audio levels of the first speech input described above with reference to step 1054a and/or with the change in color of glowing effect around the text entry field described above with reference to step 1060a. Displaying the text entry field with the color that changes over time in response to changes in audio levels of the first speech input enhances user interactions with the computer system by providing improved visual feedback and improved user privacy by indicating to the user when speech input is being received by the computer system.

In some embodiments, aspects/operations of methods 800, 1200, 1400, 1600, 1800, 2000, 2200, and/or 2400 may be interchanged, substituted, and/or added between these methods. For example, a computer system navigates content created and/or edited according to method 1000 by scrolling the content in accordance with method 800. For example, a computer system creates and/or updates content according to a combination of speech inputs according to method 1000 and soft keyboard inputs according to methods 1200, 1400, and/or 1600. For brevity, these details are not repeated here.

FIGS. 11A-11O illustrate example techniques of facilitating interactions with a soft keyboard in accordance with some embodiments. The user interfaces in FIGS. 11A-11O are used to illustrate the processes described below, including the processes in FIGS. 12A-12P.

FIG. 11A illustrates a computer system 101 displaying, via a display generation component (e.g., display generation component 120 of FIG. 1), a three-dimensional environment 1101 from a viewpoint of the user. FIG. 11A also includes a side view of the three-dimensional environment 1101 in legend 1126. Legend 1126 includes the location of the computer system 101 in the three-dimensional environment 1101 which corresponds to the viewpoint of the user in the three-dimensional environment 1101. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

FIG. 11A illustrates a computer system 101 presenting a web browsing user interface 1102 including a text entry field 1104 in a three-dimensional environment 1101 via display generation component 120. In some embodiments, the web browsing user interface 1102 further includes a back option 1106a and a refresh option 1106b. As shown in FIG. 11A, the text entry field 1104 includes text 1108a indicating the URL of the website the web browsing user interface 1102 is currently displaying.

FIG. 11A includes a legend 1126 indicating a side view of the three-dimensional environment 1101 presented via display generation component 120. The legend 1126 indicates the relative position of the computer system 101 and the web browsing user interface 1102 in the three-dimensional environment 1101. In FIG. 11A, the web browsing user interface 1102 is outside of a region 1110 of the three-dimensional environment 1101 that is within a threshold distance 1111 of the computer system 101 in the three-dimensional environment 1101. Example threshold distances are provided below in the description of method 1200 with reference to FIGS. 12A-12P. In some embodiments, the computer system 101 displays the three-dimensional environment 1101 via the display generation component 120 from a viewpoint of the user in the three-dimensional environment 1101 that corresponds to the location of the computer system 101 in the three-dimensional environment 1101 as indicated by legend 1126.

As shown in FIG. 11A, the computer system 101 detects an input directed to the text entry field 1104 that includes detecting the gaze 1113a of the user directed to the text entry field 1104 while detecting an air gesture (e.g., a direct input or an indirect input described above) performed with hand 1103a that corresponds to selection of the text entry field 1104. In some embodiments, the air gesture includes detecting the user perform a pinch gesture with hand 1103a, including moving the thumb of hand 1103a within a threshold distance (e.g., 0.05, 0.1, 0.2, 0.3, 0.5, or 1 centimeter) or touching another finger of the hand 1103a and then moving the thumb and finger apart by at least the threshold distance. In some embodiments, the air gesture includes detecting the user press the text entry field 1104 while the hand 1103a is in a pointing hand shape with one or more fingers extended and one or more fingers curled towards the palm of hand 1103a. In some embodiments, in response to the input illustrated in FIG. 11A, the computer system 101 displays a soft keyboard in the three-dimensional environment 1101 within the region 1110 that is less than the threshold distance 1111 from the viewpoint of the user in the three-dimensional environment 1101 as shown in FIG. 11B.

FIG. 11B illustrates the computer system 101 displaying the soft keyboard 1112 in the three-dimensional environment 1101 in response to the input illustrated in FIG. 11A. In some embodiments, the computer system 101 maintains display of the web browsing user interface 1102 and text entry field 1104 at the same locations in the three-dimensional environment 1101 in response to the input illustrated in FIG. 11A as the locations in the three-dimensional environment 1101 at which the web browsing user interface 1102 and text entry field 1104 were displayed when receiving the input illustrated in FIG. 11A. In some embodiments, the computer system 101 displays the soft keyboard 1112 at a position in the three-dimensional environment 1101 that is within the threshold distance 1111 of the viewpoint of the user, even though the text entry field 1104 of the web browsing user interface 1102 is further than the threshold distance 1111 of the viewpoint of the user. In some embodiments, the soft keyboard 1112 includes a plurality of keys 1116 that are displayed with visual separation from a backplane 1114 of the soft keyboard 1112. In some embodiments, the visual separation between keys 1116 of the soft keyboard 1112 and the backplane 1114 of the soft keyboard 1112 has one or more characteristics described with reference to methods 1400 and 1600.

As shown in FIG. 11B, the computer system 101 displays a repositioning option 1118a and a resizing option 1118b in association with the soft keyboard 1112. In some embodiments, in response to selection of the repositioning option 1118a, the computer system 101 initiates a process to reposition the soft keyboard 1112 in the three-dimensional environment 1101. Examples of repositioning the soft keyboard 1112 are described below with reference to FIGS. 11G-11I. In some embodiments, repositioning the soft keyboard 1112 includes repositioning user interface element 1124 and its contents, which are described in more detail below, the repositioning option 1118a, and the resizing option 1118b in accordance with the repositioning of the soft keyboard 1112. In some embodiments, in response to selection of the resizing option 1118b, the computer system 101 initiates a process to resize the soft keyboard 1112. In some embodiments, resizing the soft keyboard 1112 includes resizing user interface element 1124 and its contents, the repositioning option 1118a, and the resizing option 1118b in accordance with the resizing of the soft keyboard 1112.

In some embodiments, the computer system 101 displays a user interface element 1124 in association with the soft keyboard 1112 that includes a representation 1122a of the back option 1106a of the web browsing user interface 1102, a representation 1122b of the refresh option 1106a of the web browsing user interface 1102, and a representation 1122c of the text entry field 1104. In some embodiments, the user interface element 1124 further includes options for editing text entered into the text entry field 1104 via the soft keyboard 1112, including an undo option 1120a, a redo option 1120b, a copy option 1120c, a font menu option 1120d, first suggested text 1120e for entry into text entry field 1104, second suggested text 1120f for entry into text entry field 1104, and an option 1120g to insert an attachment (e.g., an image and/or a file) into the text entry field 1104.

In some embodiments, the representation 1122a of the back option and the representation 1122b of the refresh option displayed in user interface element 1124 are not interactive. For example, in response to detecting selection of the representation 1122b of the refresh option including the gaze 1113b of the user being directed to the representation 1122b and the user performing a selection air gesture (e.g., “Hand State C”) with hand 1103d, the computer system 101 forgoes refreshing the website currently displayed in the web browsing user interface 1102. In some embodiments, if the computer system 101 detected selection of the refresh option 1106b displayed in the web browsing user interface 1102 in a similar manner to the manner in which the computer system 101 detects selection of the representation 1122b of the refresh option, the computer system 101 would refresh the website.

In FIG. 11B, legend 1126 illustrates a side view of the soft keyboard 1112, user interface element 1124, and web browsing user interface 1102 in the three-dimensional environment 1101. As shown in legend 1126, in some embodiments, the angle of the soft keyboard 1112 is different from the angle of the web browsing user interface 1102 in the three-dimensional environment 1101. In some embodiments, the input illustrated in FIG. 11A does not include a request to display the soft keyboard 1112 at a particular angle and the angle with which the soft keyboard 1112 is displayed is automatically set by the computer system 101. The web browsing user interface 1102 is parallel to gravity, whereas the soft keyboard 1112 is not parallel to gravity and is positioned at an angle tilted towards the viewpoint of the user in the three-dimensional environment 1101. User interface element 1124 also has a different angle in the three-dimensional environment 1101 than the soft keyboard 1112, as shown in legend 1126. The user interface element 1124 has a smaller angle relative to gravity than the angle of the soft keyboard 1112 relative to gravity. In some embodiments, the angle of the user interface element 1124 is based on the viewpoint of the user such that the user interface element 1124 is oriented to face the gaze and/or head of the user. For example, if the soft keyboard 1112 and user interface element 1124 were positioned at a higher y-height in the three-dimensional environment 1101, the angle of the user interface element 1124 would be smaller relative to gravity to be oriented towards the gaze and/or head of the user at the relatively higher position in the three-dimensional environment 1101. As shown in FIG. 11B, the angle of the user interface element 1124 is different from the angle of the web browsing user interface 1102.

In some embodiments, the computer system 101 enters text into text entry field 1104 in response to a sequence of one or more inputs directed to the soft keyboard 1112. In FIG. 11B, the computer system 101 detects the user provide inputs directed to the soft keyboard 1112 provided by hands 1103b and 1103c. In some embodiments, the computer system detects inputs provided by hands 1103b and 1103c in accordance with one or more steps of methods 1400 and/or 1600 described below. In response to the inputs provided by hands 1103b and 1103c, the computer system 101 enters text into text entry field 1104, as shown in FIG. 11C. In some embodiments, the computer system 101 also accepts inputs to enter text into text entry field 1104 via dictation or a hardware keyboard. In some embodiments, in response to detecting an input to initiate dictation according to one or more steps of method 1000, the computer system 101 forgoes display of soft keyboard 1112 and, optionally, user interface element 1124. In some embodiments, in response to detecting an input to enter text into text entry field 1104 via a hardware keyboard, the computer system displays user interface element 1124 optionally without displaying soft keyboard 1112.

FIG. 11C illustrates the computer system displaying text 1128a in text entry field 1104 in response to the inputs provided by hands 1103b and 1103c in FIG. 11B. In some embodiments, as shown in FIG. 11C, the computer system 101 displays the text 1128a in the text entry field 1104 concurrently with a representation 1128b of the text in the representation 1122c of the text entry field 1104 within user interface element 1124. In some embodiments, the computer system 101 updates the text entry field 1104 and the representation 1122c of the text entry field 1104 to include the text as the text is being entered. In some embodiments, the computer system 101 shifts the location of the representation 1122a of the back option 1106a, the representation 1122b of the refresh option 1106b, and the representation 1122c of the text entry field 1104 in response to the sequence of inputs to enter the text in order to maintain display of the cursor 1122d in the user interface element 1124. As shown in FIG. 11C, the computer system 101 detects an input provided by hand 1103e and optionally gaze 1113c to highlight a portion of the text in the representation 1122c of the text entry field 1104. In some embodiments, the input includes the gaze 1113c of the user being directed to the representation 1122c of the text entry field and an air gesture performed with hand 1103e. In response to the input, as shown in FIG. 11C, the computer system 101 highlights a portion of text in the representation 1122c of the text entry field 1104 and highlights the corresponding portion of text in the text entry field 1104 in the web browsing user interface 1102. Thus, in some embodiments, although representations 1122a and 1122b are not interactive as described above with reference to FIG. 11B, the representation 1122c of the text entry field 1104 is interactive.

FIG. 11D illustrates the computer system 101 detecting an input corresponding to a request to initiate dictation to enter text into text entry field 1104 in accordance with some embodiments. In some embodiments, detecting the input includes detecting the gaze 1113d of the user directed to the text entry field 1104 for a predefined threshold time, as described above with reference to method 1000. In some embodiments, in response to receiving the input illustrated in FIG. 11D, the computer system 101 initiates a process to accept dictation directed to the text entry field 1104 in accordance with method 1000. In some embodiments, in response to the input to initiate dictation, the computer system forgoes displaying the soft keyboard 1112, user interface element 1124, repositioning option 1118a, and resizing option 1118b illustrated in FIG. 11C.

FIG. 11E illustrates the computer system 101 displaying a web browser user interface 1130 within the region 1110 of the three-dimensional environment 1101 that is within the threshold distance of the viewpoint of the user. The web browser user interface 1130 includes an indication 1132 of the address of the website that the computer system 101 currently displays in the web browser user interface 1130, a text entry field 1134, and an option 1136 associated with the text entry field 1134. In some embodiments, the website is a search website, the text entry field 1134 is a field into which one or more search terms are entered, and the option 1136 is an option to conduct the search on the search terms entered into the text entry field 1134. In some embodiments, the computer system 101 receives an input corresponding to a request to display the soft keyboard to provide text to be entered into the text entry field 1134, including detecting the gaze 1113e of the user directed to the text entry field while the user performs a selection air gesture (e.g., “Hand State C”) with hand 1103f. In some embodiments, the air gesture performed with hand 1103f is a direct input or an indirect input. In some embodiments, in response to the input corresponding to the request to display the soft keyboard, the computer system 101 displays the soft keyboard within region 1110, as shown in FIG. 11F.

FIG. 11F illustrates the computer system 101 displaying the soft keyboard 1112 and user interface element 1124 in region 1110 in response to the input described above with reference to FIG. 11E. In some embodiments, the soft keyboard 1112 and/or the user interface element 1124 are displayed between the web browser user interface 1130 and the viewpoint of the user in the three-dimensional environment 1101. In some embodiments, the computer system 101 maintains the position of the web browser user interface 1130 at the location in the three-dimensional environment 1101 that is within the threshold distance of the viewpoint of the user and/or is partially within region 1110 of the three-dimensional environment 1101. In some embodiments, the soft keyboard 1112 includes the same or similar elements as previously described with reference to FIGS. 11B-11C. In some embodiments, the user interface element 1124 includes the same or similar elements as previously described with reference to FIGS. 11B-11C. As shown in FIG. 11C, the user interface element 1124 includes a representation 1122e of the edge of the web browser user interface 1130 that is adjacent to the text entry field 1134 in the web browser user interface as shown in FIG. 11E and a representation 1122f of the text entry field.

In some embodiments, the computer system 101 displays the soft keyboard within one or more predefined distance ranges from the viewpoint of the user at a height and/or lateral position that depends on the location of the text entry field that has the current focus of the soft keyboard. In some embodiments, the predefined distance ranges include a first distance range at which the computer system 101 displays the keyboard at the angle illustrated in FIGS. 11B-11C and 11I and a second distance range, further from the viewpoint of the user than the first distance range, at which the computer system displays the soft keyboard at a different angle as shown in FIGS. 11G and 11H. In some embodiments, the angle with which the computer system 101 displays the soft keyboard 1112 is set based on the distance of the soft keyboard 1112 from the viewpoint of the user.

In FIG. 11G, the computer system 101 displays soft keyboard 1112 and user interface element 1124 in the three-dimensional environment 1101. In some embodiments, the computer system 101 displays the soft keyboard 1112 and user interface element 1124 in response to a user input that is similar to the input described above with reference to FIGS. 11A-11B. In some embodiments, in response to the input corresponding to the request to display the soft keyboard 1112 and the user interface element 1124, the computer system 101 displays the soft keyboard 1112 and user interface element 1124 at the position illustrated in FIG. 11G.

In some embodiments, the position of the soft keyboard 1112 and the user interface element 1124 illustrated in FIG. 11G has a height that is based on the height of the text entry field 1104 in the three-dimensional environment 1101. For example, the height at which the computer system 101 displays the user interface element 1124 and the soft keyboard 1112 is a height at which the angle formed from (e.g., to top edge of) the user interface element 1124, to (e.g., the center of, the bottom edge of) the text entry field 1104 is a predefined angle. Example angles are provided below in the description of method 1200 with reference to FIGS. 12A-12P.

In some embodiments, the lateral position of the soft keyboard 1112 and the user interface element 1124 illustrated in FIG. 11G is based on the position of the text entry field 1104 and/or the position of the gaze of the user when the input to display the soft keyboard 1112 and the user interface element 1124 is received. For example, the center of the user interface element 1124 and soft keyboard 1112 is the position of the gaze of the user while the computer system 101 detects the input corresponding to the request to display the user interface element 1124 and soft keyboard 1112.

In some embodiments, the distance of the soft keyboard 1112 and user interface element 1124 from the viewpoint of the user in the three-dimensional environment 1101 is a predefined distance because the user interface 1102 is more than the threshold distance 1111 from the viewpoint of the user in the three-dimensional environment 1101. For example, legend 1126 in FIG. 11G illustrates a side view of the three-dimensional environment 1101. As shown in the legend 1126, the user interface 1102 is further than the threshold distance 1111 from the viewpoint of the user (e.g., corresponding to the location of computer system 101 in the three-dimensional environment 1101) and the soft keyboard 1112 and user interface element 1124 are displayed within the threshold distance 1111 of the viewpoint of the user. In some embodiments, the soft keyboard 1112 and the user interface element 1124 are displayed at an angle corresponding to (e.g., that is the same as) the angle of the user interface 1102 and/or parallel to gravity because the soft keyboard 1112 and user interface element 1124 are displayed within the first range of distances from the viewpoint of the user as described above. In some embodiments, the first range of distances is different from the second range of distances in which the soft keyboard 1112 and user interface element 1124 are displayed in FIGS. 11B, 11C, and 11I, so the soft keyboard 1112 and user interface element 1124 are displayed at different angles in FIG. 11G than they are in FIGS. 11B, 11C, and 11I.

FIG. 11H illustrates another example of the computer system 101 displaying the soft keyboard 1112 and the user interface element 1124 within the first range of distances from the viewpoint of the user in the three-dimensional environment 1101. In some embodiments, the computer system 101 displays the soft keyboard 1112 and user interface element 1124 in FIG. 11H in response to an input similar to the input described above with reference to FIGS. 11A-11B. As shown in the legend 1126 of FIG. 11H, the user interface 1102 including the text entry field 1104 to which the input focus of the soft keyboard 1112 is directed is further than the threshold distance 1111 from the viewpoint of the user and the soft keyboard 1112 and the user interface element 1124 are within the threshold distance 1111 of the viewpoint of the user. In some embodiments, the distance from the soft keyboard 1112 and user interface element 1124 to the viewpoint of the user in the three-dimensional environment 1101 in FIG. 11H is in the same range as or is the same as the distance from the soft keyboard 1112 and user interface element 1124 to the viewpoint of the user in the three-dimensional environment 1101 in FIG. 11G because in both FIGS. 11H and 11G, the user interface 1102 is further than the threshold distance 1111 from the viewpoint of the user in the three-dimensional environment 1101.

In some embodiments, the vertical and lateral positions of the user interface element 1124 and soft keyboard 1112 are different in FIG. 11H than they were in FIG. 11G because the vertical and lateral positions of user interface 1102 (e.g., and/or text entry field 1104 and/or the gaze of the user when the input to display the soft keyboard 1112 and user interface element 1124 was provided). In some embodiments, the vertical position of the user interface element 1124 and soft keyboard 1112 is based on the vertical position of the text entry field 1104 as described above with reference to FIG. 11G. In some embodiments, the horizontal position of the user interface element 1124 and soft keyboard 1112 is based on the horizontal position of text entry field 1104 and/or the gaze of the user when the input to display the user interface element 1124 and soft keyboard 1112 was received, as described above with reference to FIG. 11G. In some embodiments, the angle of the soft keyboard 1112 in the three-dimensional environment 1101, as shown in the legend 1126, is based on (e.g., the same as) the angle of the user interface 1102 in the three-dimensional environment 1101.

In FIG. 11H, the computer system receives an input directed to repositioning option 1118a. In some embodiments, the input includes selection of the repositioning option 1118a with hand 1103g, such as an (e.g., direct or indirect) air gesture selection input (e.g., “Hand State C”) and movement of the hand (e.g., air gesture, touch input, or other hand input) 1103g. For example, the computer system 101 detects the user make a pinch hand shape while the gaze of the user is directed to the repositioning option 1118a and movement of the hand (e.g., air gesture, touch input, or other hand input) 1103g while maintaining the pinch hand shape. In some embodiments, the computer system 101 updates the position of the user interface element 1124 and soft keyboard 1112 in accordance with the movement of hand 1103g while the hand 1103g is in the pinch hand shape. In some embodiments, the movement of hand 1103g corresponds to a request to move the user interface element 1124 and soft keyboard 1112 closer to the viewpoint of the user in the three-dimensional environment 1101. In some embodiments, the computer system 101 “snaps” the user interface element 1124 and soft keyboard 1112 to a position in the three-dimensional environment 1101 that is within the first or second range of distances from the viewpoint of the user in response to a request to update the distance between the user interface element 1124 and soft keyboard 1112 and the viewpoint of the user. For example, as shown in FIG. 11I, in response to the input illustrated in FIG. 11H, the computer system 101 displays the user interface element 1124 and soft keyboard 1112 within the second range of distances from the viewpoint of the user in the three-dimensional environment 1101.

FIG. 11I illustrates the computer system 101 displaying the user interface element 1124 and soft keyboard 1112 at the updated position in the three-dimensional environment 1101 in response to the input illustrated in FIG. 11H. In some embodiments, the movement of hand 1103g in FIG. 11H corresponds to moving the soft keyboard 1112 and user interface element 1124 to a distance outside of the second range of distances, but the computer system 101 still displays the user interface element 1124 and soft keyboard 1112 within the second range of distances. While displaying the user interface element 1124 and soft keyboard 1112 within the second range of distances as shown in FIG. 11I, the computer system 101 displays the user interface element 1124 and soft keyboard 1112 at the angles shown in the legend 1126 in FIG. 11I. As described above, in some embodiments, the angles of the soft keyboard 1112 and user interface element 1124 in FIG. 11I are greater with respect to gravity than the angles of the user interface element 1124 and soft keyboard 1112 in FIG. 11H. In some embodiments, the input illustrated in FIG. 11H does not include a request to display the soft keyboard 1112 at the angle shown in FIG. 11I and the computer system displays the soft keyboard 1112 at the angle shown in FIG. 11I automatically in accordance with the request to move the soft keyboard 1112 to the position in the three-dimensional environment 1101 shown in FIG. 11I.

FIG. 11I illustrates the computer system 101 detecting an input directed to the repositioning option 1118a similar to the input described above with reference to FIG. 11H. In some embodiments, the input corresponds to a request to update the position of the user interface element 1124 and soft keyboard 1112, including moving the user interface element 1124 and soft keyboard 1112 to a location further from the viewpoint of the user in the three-dimensional environment 1101 than the location of the user interface element 1124 and soft keyboard 1112 illustrated in FIG. 11I. For example, the input corresponds to a request to move the user interface element 1124 and soft keyboard 1112 outside of the second range of distances from the viewpoint of the user in the three-dimensional environment 1101. In some embodiments, in response to the input, the computer system 101 updates the position and angle of the user interface element 1124 and soft keyboard 1112 to the position and angle illustrated in FIG. 11H. In some embodiments, the input corresponds to moving the user interface element 1124 and soft keyboard 1112 to a position outside of the first range of distances from the viewpoint of the user in the three-dimensional environment 1101, but the computer system 101 displays the user interface element 1124 and soft keyboard 1112 within the first range of distances in response to the input, as shown in FIG. 11H. In some embodiments, the input illustrated in FIG. 11I does not include a request to display the soft keyboard 1112 at the angle illustrated in FIG. 11H and the computer system 101 automatically updates the angle of the soft keyboard 1112 to the angle shown in FIG. 11H in accordance with updating the position of the soft keyboard 1112 to the position in the three-dimensional environment 1101 shown in FIG. 11H. Additional descriptions regarding FIGS. 11A-11O are provided below in reference to method 1200 described with respect to FIGS. 11A-11O.

As described above with reference to FIGS. 11G-11I, in some embodiments, the computer system 101 is able to display the soft keyboard 1112 at a variety of distances from the viewpoint of the user of the computer system 101. In some embodiments, the computer system 101 enters text in response to direct and/or indirect inputs directed to the soft keyboard 1112 depending on the distance between the soft keyboard 1112 and the viewpoint of the user of the computer system 101 in the environment 1101.

FIG. 11J illustrates the computer system 101 displaying the soft keyboard 1112 in the environment 1101 and includes a side view 1126 of the environment 1101. As shown in the side view 1126 of the environment 1101, in FIG. 11J, the soft keyboard 1112 is within a first threshold distance 1111a from the viewpoint of the user of the computer system 101. In some embodiments, the side view 1126 of the environment further includes user interface 1138, which is further than a second threshold distance 1111b from the viewpoint of the user of the computer system 101, and user interface element 1124. Example values for the first threshold 1111a and the second threshold 1111b are provided below in the description of method 1200.

In some embodiments, while the computer system 101 displays the soft keyboard 1112 within the first threshold 1111a of the viewpoint of the user of the computer system 101, the computer system 101 enters text in response to direct air gesture inputs directed to the soft keyboard 1112, but not in response to indirect air gesture inputs directed to the soft keyboard 1112. For example, in FIG. 11J, the left hand 1103i of the user provides an indirect input directed to the soft keyboard 1112 and the right hand 1103j of the user provides a direct input directed to the soft keyboard 1112. In some embodiments, in response to the inputs illustrated in FIG. 11J, the computer system 101 enters a character corresponding to the direct input provided by hand 1103j, but forgoes entering a character corresponding to the indirect input provided by hand 1103i, as shown in FIG. 11K.

FIG. 11K illustrates the computer system 101 updating text entry field 1142 to include the character corresponding to the direct input illustrated in FIG. 11J. As described above, the computer system 101 forgoes entering a character corresponding to the indirect input in FIG. 11J in text entry field 1142 because the computer system displayed the soft keyboard 1112 within the first threshold 1111a of the viewpoint of the user of the computer system 101 while detecting the inputs in FIG. 11K. In some embodiments, the computer system 101 also updates text entry field 1146 to include a representation 1148b of the updated text 1148a in text entry field 1142.

In FIG. 11K, the computer system 101 detects an input directed to the element 1118a for repositioning the soft keyboard 1112 in the environment 1101. In some embodiments, the input includes selection of the element 1118a and movement while selection of element 1118a is maintained. In FIG. 11K, the computer system 101 detects movement away from the viewpoint of the user of the computer system 101 as part of the input directed to the repositioning element 1118a. In response to the input in FIG. 11K, in some embodiments, the computer system 101 repositions the keyboard 1112 away from the viewpoint of the user of the computer system 101, as shown in FIG. 11L.

FIG. 11L illustrates the computer system 101 displaying the environment 1101 with the soft keyboard 1112 repositioned in accordance with the input illustrated in FIG. 11K. As shown in the side view 1126 of the environment 1101 in FIG. 11L, the computer system 101 displays the soft keyboard between the first threshold 1111a and the second threshold 1111b from the viewpoint of the user of the computer system 101. In some embodiments, while the computer system 101 displays the soft keyboard 1112 between the first threshold 1111a and the second threshold 1111b from the viewpoint of the user of the computer system 101, the computer system 101 enters text in response to direct and indirect inputs directed to the soft keyboard 1112. In FIG. 11L, the computer system 101 detects an air gesture input provided by hand 1103j directed to the soft keyboard. In some embodiments, the input provided by hand 1103j is a direct air gesture input. In some embodiments, the input provided by hand 1103j is an indirect air gesture input. In some embodiments, because the computer system 101 displays the soft keyboard 1112 between the first threshold 1111a and the second threshold 1111b while the input is received, the computer system 101 enters a character as shown in FIG. 11M in response to the input provided by hand 1103j irrespective of whether the input is an indirect input or the input is a direct input.

FIG. 11M illustrates the computer system 101 displaying the text entry field 1142 including updated text 1148a in accordance with the input described above with reference to FIG. 11L. In some embodiments, the computer system 101 also updates the text 1148b in text entry field 1146 to correspond to the updated text 1148a in text entry field 1142 in response to the input.

In FIG. 11M, the computer system 101 detects an input directed to repositioning element 1118a that is optionally similar to the input described above with referenced to FIG. 11K. In some embodiments, the input illustrated in FIG. 11M corresponds to a request to reposition the soft keyboard 1112 further from the viewpoint of the user of the computer system 101 in the environment 1101, as shown in FIG. 11N.

FIG. 11N illustrates the computer system 101 displaying the environment 1101 updated in response to the input described above with reference to FIG. 11M. As shown in FIG. 11N, the computer system 101 displays the soft keyboard 1112 further than the second threshold 1111b from the viewpoint of the user of the computer system 101. In some embodiments, while the computer system 101 displays the soft keyboard 1112 further than the second threshold 1111b from the viewpoint of the user of the computer system 101, the computer system 101 accepts indirect air gesture inputs directed to the soft keyboard 1112 but does not accept direct air gesture inputs directed to the soft keyboard 1112.

For example, in FIG. 11N, the computer system 101 detects a direct input provided by hand 1103i that corresponds to a request to enter text using the soft keyboard 1112 and detects an indirect input provided by hand 1103j that corresponds to a request to enter text using the soft keyboard 1112. In some embodiments, because the soft keyboard is further than the second threshold distance 1111b from the viewpoint of the user of the computer system 101 in the environment, the computer system 101 forgoes entering text in accordance with the direct input provided by hand 1103i. In some embodiments, because the soft keyboard is further than the second threshold distance 1111b from the viewpoint of the user of the computer system 101 in the environment, the computer system 101 enters text in accordance with the indirect input provided by hand 1103j, as shown in FIG. 11O.

FIG. 11O illustrates the computer system 101 displaying the text entry field 1142 with text 1148a updated to include a character in response to the indirect input described above with reference to FIG. 11N. As described above, in some embodiments, the computer system 101 does not further update the text 1148a to include a character added in response to the direct input illustrated in FIG. 11N because the soft keyboard 1112 was more than the second threshold 1111b from the viewpoint of the user when the inputs were received. In some embodiments, the computer system 101 further updates the text 1148b in text entry field 1148 to correspond to the text 1148a in text entry field 1142.

FIGS. 12A-12P is a flow diagram of methods of facilitating interactions with a soft keyboard, in accordance with some embodiments. In some embodiments, method 1200 is performed at a computer system (e.g., computer system 101 in FIG. 1) including a display generation component (e.g., display generation component 120 in FIGS. 1, 3, and 4) (e.g., a heads-up display, a display, a touchscreen, and/or a projector) and one or more input devices. In some embodiments, the method 1200 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1200 are, optionally, combined and/or the order of some operations is, optionally, changed.

In some embodiments, such as in FIG. 11A, method 1200 is performed at a computer system (e.g., computer system 101) in communication with a display generation component (e.g., 120), one or more input devices (e.g., 314). In some embodiments, the computer system is the same as or similar to the computer system described above with reference to method(s) 800 and/or 1000. In some embodiments, the one or more input devices are the same as or similar to the one or more input devices described above with reference to method(s) 800 and/or 1000. In some embodiments, the display generation component is the same as or similar to the display generation component described above with reference to method(s) 800 and/or 1000.

In some embodiments, the computer system displays (1202a), via the display generation component (e.g., 120), a three-dimensional environment (e.g., 1101) from a respective viewpoint including a first object (e.g., 1102) at a respective location in the three-dimensional environment (e.g., 1101), wherein the first object (e.g., 1102) includes a text entry field (e.g., 1104), such as in FIG. 11A. In some embodiments, the three-dimensional environment is the same as or similar to the three-dimensional environment described above with reference to method(s) 800 and/or 1000. In some embodiments, the first object is a user interface that includes the text entry field. In some embodiments, the text entry field is a text entry field with one or more characteristics of the text entry field described above with reference to method 1000. In some embodiments, the respective viewpoint is a viewpoint of the user of the computer system described above with reference to method 800.

In some embodiments, while displaying the three-dimensional environment (e.g., 1101) from the respective viewpoint including the first object (e.g., 1102) that includes the text entry field (e.g., 1104) at the respective location in the three-dimensional environment (e.g., 1101), the computer system detects (1202b), via the one or more input devices (e.g., 314), a first input corresponding to a selection of the text entry field (e.g., 1104), such as in FIG. 11A. In some embodiments, the first input is one of a direct input, an indirect input, an air tap input, and/or an input detected via a hardware input device (e.g., a button, switch, dial, keyboard, mouse, trackpad, or stylus).

In some embodiments, in response to detecting the first input (1202c), in accordance with a determination that the respective location in the three-dimensional environment (e.g., 1101) is a first location that is greater than a threshold distance (e.g., 1111) (e.g., 0.05, 0.1, 0.2, 0.3, 0.5, 1, 2, 3, or 5 meters) from the respective viewpoint, the computer system (e.g., 101) displays (1202d), via the display generation component (e.g., 120), a keyboard (e.g., 1112) at a keyboard location in the three-dimensional environment (e.g., 1101) in accordance with the first input, wherein the keyboard (e.g., 1112) is for entering text into the text entry field (e.g., 1104), such as in FIG. 11B. In some embodiments, the virtual keyboard includes a plurality of virtual keys corresponding to characters (e.g., letters, numbers, or special characters). In some embodiments, in response to detecting input(s) directed to the virtual keys, such as in the manners described below with reference to methods 1400 and 1600, the computer system displays characters corresponding to the virtual keys to which the input(s) were directed in the text entry field. In some embodiments, such as in FIG. 11B, the keyboard location in the three-dimensional environment (e.g., 1101) is less than the threshold distance (e.g., 1111) from the respective viewpoint. In some embodiments, the keyboard location is based on (e.g., has a predetermined spatial relationship relative to) the respective viewpoint. In some embodiments, the keyboard location is based on (e.g., has a predetermined spatial relationship relative to) a respective portion of the user, such as the hands, alms, head, and/or torso of the user. For example, if the torso of the user is turned to face a first direction, the keyboard location is away from the respective viewpoint in the first direction and if the torso of the user is turned to face as second direction, the keyboard location is away from the respective viewpoint in the second direction. In some embodiments, the threshold distance corresponds to a distance within the reach of the user, thus, the keyboard is displayed within reach of the user even if the respective location is not within reach of the user. In some embodiments, the respective location of the first object and the keyboard location of the keyboard are separated from each other in the three-dimensional environment by a respective distance so that the respective location is further than the threshold distance from the viewpoint and the keyboard location is within the threshold distance of the viewpoint. In some embodiments, the keyboard location is a predetermined location in the three-dimensional environment irrespective of the respective location. For example, in response to receiving an input corresponding to selection of a second text entry region displayed at a second location different from the respective location that is greater than the threshold distance from the viewpoint, the computer system displays the keyboard at the keyboard location.

In some embodiments, in accordance with a determination that the respective location in the three-dimensional environment is a second location, different from the first location (e.g., a location other than the location of object 1102 in FIG. 11B), wherein the second location is greater than the threshold distance (e.g., 1111) (e.g., 0.05, 0.1, 0.2, 0.3, 0.5, 1, 2, 3, or 5 meters) from the respective viewpoint, the computer system (e.g., 101) displays (1202e), via the display generation component (e.g., 120), the keyboard (e.g., 1112) at the keyboard location in the three-dimensional environment (e.g., 1101) in accordance with the first input, such as in FIG. 11B. In some embodiments, the computer system displays the keyboard at the keyboard location in the three-dimensional environment irrespective of the location in the three-dimensional environment greater than the threshold distance from the respective viewpoint of the text entry field is displayed. Displaying the keyboard within the threshold distance from the respective viewpoint enhances user interactions with the computer system by recuing the number of inputs needed to perform an operation (e.g., displaying the keyboard at the second location without requiring inputs to move the keyboard from a respective location further than the threshold distance from the respective viewpoint to the second location).

In some embodiments, in response to detecting the first input, in accordance with a determination that the respective location in the three-dimensional environment (e.g., 1101) is a third location that is less than the threshold distance from the respective viewpoint, such as in FIG. 11E, the computer system (e.g., 101) displays (1204), via the display generation component (e.g., 120), the keyboard (e.g., 1112) at a second keyboard location in the three-dimensional environment (e.g., 1101) in accordance with the first input, wherein the second keyboard location is closer to the respective viewpoint than the keyboard location, such as in FIG. 11F. In some embodiments, the amount of visual separation between the third location and the second keyboard location is less than the amount of visual separation between either the first location and the keyboard location or the second location and the keyboard location. Displaying the keyboard at the second keyboard location in accordance with the determination that the respective location is less than the threshold distance from the respective viewpoint enhances user interactions with the computer system by performing an operation (e.g., placing the keyboard at the second keyboard location instead of the keyboard location) when conditions have been met without requiring further user input.

In some embodiments, in response to the detecting the first input, the computer system (e.g., 101) maintains (1206) display, via the display generation component (e.g., 120), of the first object (e.g., 120) at the respective location (e.g., without regard to whether the respective location is the first location or the second location), such as in FIG. 11B. In some embodiments, the computer system does not update the location of the first object in response to the first input. In some embodiments, the computer system updates the position of the first object in response to a second input corresponding to a request to update the position of the first object, the second input different from the first input. Maintaining the position of the first object in response to detecting the second input enhances user interactions with the computer system by reducing the number of inputs needed to perform an operation (e.g., maintain display of the first object at its respective location in the three-dimensional environment).

In some embodiments, displaying the first object (e.g., 1102) includes displaying, via the display generation component, the first object (e.g., 1102) at a first angle relative a respective reference in the three-dimensional environment (e.g., 1101), and displaying the keyboard (e.g., 1112) includes displaying, via the display generation component (e.g., 120), the keyboard (e.g., 1112) at a second angle different from the first angle relative to the respective reference in the three-dimensional environment (e.g., 1102) (1208), such as in FIG. 11B. In some embodiments, the first and second angles are angles between the respective objects and a floor, gravity, or another reference in the three-dimensional environment. For example, the first object is parallel to gravity and the keyboard is not parallel to gravity. In some embodiments, the first and second angles are angles between the respective objects and the viewpoint of the user in the three-dimensional environment or another reference. For example, the surface of the keyboard is normal to the viewpoint of the user and the surface of the first object is not normal to the viewpoint of the user. As another example, the first object is normal to the viewpoint of the user and the surface of the keyboard is tilted towards the viewpoint of the user, with the edge of the surface of the keyboard that is closer to the viewpoint of the user (e.g., the front edge) is at a lower height than the edge of the surface of the keyboard that is further from the viewpoint of the user (e.g., the back edge). Displaying the keyboard at a different angle in the three-dimensional environment than the angle of the first object in the three-dimensional environment enhances user interactions with the computer system by reducing the number of inputs needed to perform an operation (e.g., displaying the keyboard at an ergonomic angle that facilitates user interaction with the keyboard).

In some embodiments, displaying the keyboard (e.g., 1112) in response to detecting the first input includes displaying a user interface element (e.g., 1118a) in association with the keyboard (e.g., 1112) that, when selected, causes the computer system (e.g., 101) to initiate a process to reposition the keyboard (e.g., 1112) in the three-dimensional environment (e.g., 1101) (1210), such as in FIG. 11B. In some embodiments, the user interface element is displayed proximate to, without overlapping, the keyboard in the three-dimensional environment. In some embodiments, the user interface element is displayed overlaid on the keyboard in the three-dimensional environment. In some embodiments, the computer system updates the position of the user interface element in the three-dimensional environment in accordance with updating the position of the keyboard in the three-dimensional environment. In some embodiments, in response to detecting a sequence of inputs including selection of the user interface element followed by a movement input (e.g., movement of the hand or air gesture of the user while the hand is in a pinch hand shape) that satisfies one or more criteria, the computer system moves the keyboard in the three-dimensional environment in accordance with the movement input (e.g., air gesture, touch input, or other hand input). Displaying the user interface element for repositioning the keyboard in the three-dimensional environment in association with the keyboard enhances user interactions with the computer system by reducing the number of inputs needed to perform an operation (e.g., repositioning the keyboard without requiring an input to cause the computer system to display the user interface element).

In some embodiments, the computer system (e.g., 101) detects (1212a), via the one or more input devices (e.g., 314), an input directed to the user interface element (e.g., 1118a) that corresponds to a request to reposition the keyboard (e.g., 1112) in the three-dimensional environment (e.g., 1101), including a request to update a distance between the keyboard (e.g., 1112) and the respective viewpoint in the three-dimensional environment (e.g., 1101) from a current distance to an updated distance, such as in FIG. 11H. In some embodiments, the input corresponding to the request to reposition the keyboard includes a movement component (e.g., of movement of a hand of the user) and the updated distance is based on an amount of (e.g., speed, distance, and/or duration of) movement of the movement component.

In some embodiments, in response to the input directed to the user interface element (e.g., 1118a) (1212b), in accordance with a determination that the updated distance is within a first range of distances, the computer system (e.g., 101) displays (1212c), via the display generation component (e.g., 120), the keyboard (e.g., 1112) at a respective location in the three-dimensional environment that is a first distance (e.g., 50, 60, 75, or 100 centimeters) from the viewpoint of the user, such as in FIG. 11I. In some embodiments, the first distance is different from the updated distance. In some embodiments, the computer system “snaps” the keyboard to a location within the first range of distances in accordance with a determination that the movement of the input corresponds to a distance closer to the first range of distances than the distance is to the second range of distances referenced below. In some embodiments, in accordance with a determination that the movement of the input corresponds to the first distance, the computer system displays the keyboard at the respective location that is the first distance from the viewpoint of the user.

In some embodiments, in accordance with a determination that the updated distance is within a second range of distances different from the first range of distances, the computer system (e.g., 101) displays (1212d), via the display generation component (e.g., 120), the keyboard (e.g., 1112) at a respective location in the three-dimensional environment (e.g., 1101) that is a second distance (e.g., a distance in the range of 15-50 centimeters, 5-50 centimeters, 15-100 centimeters, or 5-100 centimeters), different from the first distance, from the viewpoint of the user, such as in FIG. 11H. In some embodiments, the second distance is different from the updated distance. In some embodiments, the computer system “snaps” the keyboard to a location within the second range of distances in accordance with a determination that the movement of the input corresponds to a distance closer to the second range of distances than the distance is to the first range of distances referenced above. In some embodiments, in accordance with a determination that the movement of the input corresponds to the second distance, the computer system displays the keyboard at the respective location that is the second distance from the viewpoint of the user. In some embodiments, in response to the request to update the distance between the keyboard and the respective viewpoint in the three-dimensional environment, the computer system “snaps” the keyboard to the first distance or second distance (e.g., depending on which distance is closer to a distance corresponding to the input). In some embodiments, the first distance and second distances are single distances. In some embodiments, the first distance and second distance are ranges of distances. In some embodiments, one of the first and second distances is a single distance and the other is a range of distances. Displaying the keyboard at the first or second distance depending on which range of distances includes the updated distance enhances user interactions with the computer system by performing an operation when a set of conditions has been met without requiring further user input (e.g., refining the keyboard location according to ranges of distances).

In some embodiments, the computer system (e.g., 101) detects (1214a), via the one or more input devices (e.g., 314), an input directed to the user interface element (e.g., 1118a) that corresponds to a request to reposition the keyboard (e.g., 1112) in the three-dimensional environment (e.g., 1101), including a request to update a distance between the keyboard (e.g., 1112) and the respective viewpoint in the three-dimensional environment (e.g., 1101) from a current distance to an updated distance, such as in FIG. 11I. In some embodiments, the input corresponding to the request to reposition the keyboard in the three-dimensional environment is similar to the input corresponding to the request to reposition the keyboard described above.

In some embodiments, in response to the input directed to the user interface element (e.g., 1118a) (1214b), in accordance with a determination that the updated distance is a first distance from the viewpoint of the user, the computer system (e.g., 101) displays (1214c), via the display generation component (e.g., 120), the keyboard (e.g., 1112) in the three-dimensional environment (e.g., 1101) at a first angle relative to a respective reference in the three-dimensional environment (e.g., 1101), such as in FIG. 11H. In some embodiments, the first distance is within the first range of distances described above.

In some embodiments, in accordance with a determination that the updated distance is a second distance different from the first distance from the viewpoint of the user, the computer system (e.g., 101) displays (1214d), via the display generation component (e.g., 120), the keyboard (e.g., 1112) in the three-dimensional environment (e.g., 1101) at a second angle different from the first angle relative to the respective reference in the three-dimensional environment (e.g., 1101), such as in FIG. 11I. In some embodiments, the second distance is within the second range of distances described above. In some embodiments, the first range of distances is closer to the viewpoint of the user than the distance between the viewpoint of the user and the second range of distances and the first angle is a larger angle relative to gravity than the second angle relative to gravity. For example, while displaying the keyboard with the first angle, the top edge of the surface of the keyboard is further from the user than the bottom edge of the surface of the keyboard by a larger amount than is the case while displaying the keyboard with the second angle. For example, the second angle is parallel to gravity and the first angle is an angle not parallel to the gravity in which the keyboard is tilted upwards (e.g., the bottom edge is closer to the viewpoint of the user than the top edge relative to the viewpoint of the user). In some embodiments, while displaying the keyboard with the first angle, the computer system accepts inputs directed to the keyboard according to one or more steps of methods 1400 and 1600 below. In some embodiments, while displaying the keyboard with the second angle, the computer system accepts indirect inputs directed to the keyboard in a manner similar to one or more steps of method 1600. In some embodiments, in response to detecting an input corresponding to a request to move the viewpoint of the user in the three-dimensional environment (e.g., movement of the computer system, the display generation component, and/or the user in the physical environment of the computer system and/or display generation component), the computer system updates the angle at which the keyboard is displayed. In some embodiments, updating the viewpoint of the user in the three-dimensional environment causes the distance between the viewpoint of the user and the soft keyboard to change. In some embodiments, in response to the input the change the viewpoint of the user, in accordance with a determination that the updated distance is the first distance from the viewpoint of the user, the computer system displays the keyboard at the first angle relative to the respective reference in the three-dimensional environment. In some embodiments, in response to the input to change the viewpoint of the user, in accordance with a determination that the updated distance is the second distance from the viewpoint of the user, the computer system displays the keyboard in the three-dimensional environment at the second angle relative to the respective reference in the three-dimensional environment. Displaying the keyboard with a different angle depending on the distance between the keyboard and the viewpoint of the user enhances user interactions with the computer system by performing an operation (e.g., setting the angle of the keyboard) when a set of conditions (e.g., keyboard distance from the viewpoint of the user) have been met without requiring additional inputs.

In some embodiments, displaying the keyboard (e.g., 1112) in response to detecting the first input includes displaying a user interface element (e.g., 1118b) that, when selected, causes the computer system (e.g., 101) to initiate a process to resize the keyboard (e.g., 1112) in the three-dimensional environment (e.g., 1101) (1216), such as in FIG. 11B. In some embodiments, the user interface element is displayed proximate to, without overlapping, the keyboard in the three-dimensional environment. In some embodiments, the user interface element is displayed overlaid on the keyboard in the three-dimensional environment. In some embodiments, the computer system updates the size of the user interface element in the three-dimensional environment in accordance with updating the size of the keyboard in the three-dimensional environment. In some embodiments, the computer system receives a sequence of inputs including selection of the user interface element followed by a movement input that satisfies one or more criteria (e.g., movement of the hand or air gesture while the hand is in a pinch hand shape) and, in response, resizes the keyboard in accordance with the movement input (e.g., air gesture, touch input, or other hand input). In some embodiments, the sequence of inputs includes one or more air gestures described in more detail above, such as one or more direct and/or indirect inputs. Displaying the user interface element for resizing the keyboard in association with the keyboard enhances user interactions with the computer system by reducing the number of inputs needed to perform an operation (e.g., resizing the keyboard without requiring an input to cause the computer system to display the user interface element).

In some embodiments, detecting the first input includes detecting, via the one or more input devices (e.g., 314), an attention (e.g., 1113a) of the user directed to the text entry field (e.g., 1104) and a predefined gesture performed by a respective portion (e.g., 1103a) (e.g., hand, head, and/or torso) of the user (1218), such as in FIG. 11A. In some embodiments, the predefined gesture is a pinch gesture performed by one or more hands of the user. In some embodiments, the predefined gesture is associated with an air gesture described in more detail above, such as a direct or indirect input. Displaying the keyboard in response to detecting the attention of the user directed to the text entry field and a predefined gesture performed by the respective portion of the user enhances user interactions with the computing system by providing additional control options without cluttering the user interface with additional displayed controls.

In some embodiments, while displaying the three-dimensional environment (e.g., 1101) from the respective viewpoint including the first object (e.g., 1102) that includes the text entry field (e.g., 1104) at the respective location in the three-dimensional environment (e.g., 1101) (e.g., while not displaying the keyboard), such as in FIG. 11A, the computer system (e.g., 101) detects (1220a), via the one or more input devices (e.g., 314), a second input corresponding to a request to initiate a process to dictate a text input directed to the text entry field (1104). In some embodiments, the second input is an input described above with reference to method 1000. In some embodiments, the second input includes detecting the attention of the user directed to the text entry field and a voice input.

In some embodiments, in response to detecting the second input, the computer system (e.g., 101) initiates (1220b) the process to dictate the text input directed to the text entry field (e.g., 1104) without displaying, via the display generation component (e.g., 120), the keyboard, such as in FIG. 11A. In some embodiments, if the second input is detected while the keyboard is being displayed, the computer system maintains display of the keyboard. In some embodiments, if the second input is detected while the keyboard is being displayed, the computer system ceases display of the keyboard. In some embodiments, if the second input is detected while the keyboard is being displayed, the computer system forgoes initiating the process to dictate the text input. In some embodiments, the computer system concurrently displays a dictation option with the keyboard (e.g., the keyboard includes a dictation option) and the computer system initiates the process to dictate the text input in response to selection of the dictation option (e.g., instead of in response to the second input). Initiating the process to dictate the text input without displaying the keyboard enhances user interactions with the computer system by providing additional control options without cluttering the user interface with additional displayed controls.

In some embodiments, displaying the keyboard (e.g., 1112) in response to the first input includes displaying, via the display generation component (e.g., 120), a representation of a portion (e.g., 1122c) of the first object that includes at least a portion of the text entry field (1222), such as in FIG. 11B. In some embodiments, the representation of the portion of the first object that includes the text entry field includes a representation of respective text included in at least the portion of the text entry field. In some embodiments, the representation of the portion of the first object is displayed in association with the keyboard without overlapping or being included in the keyboard. In some embodiments, in response to an input to reposition and/or resize the keyboard, the computer system repositions and/or resizes the keyboard and the representation of the portion of the first object in accordance with the input. Displaying the representation of the portion of the first object with the keyboard in response to the first input enhances user interactions by reducing the number of inputs needed to perform an operation.

In some embodiments, while displaying the keyboard (e.g., 1112) in response to the first input, the computer system (e.g., 101) displays (1224a), via the display generation component (e.g., 120), a cursor (e.g., 1108b) in the text entry field at a first location in the text entry field (e.g., 1104) and a representation of the cursor in the representation (e.g., 1122c) of the portion of the first object (e.g., 1102) at a corresponding first location in the representation of the portion (e.g., 1122) of the first object (e.g., 1102), such as in FIG. 11B. In some embodiments, the cursor indicates a location in the text entry field at which text will be inserted in response to detecting one or more inputs directed to the keyboard corresponding to a request to input text into the text entry field.

In some embodiments, while displaying, via the display generation component (e.g., 120), the representation of the portion (e.g., 1122c) of the first object including the representation of the cursor, the computer system detects (1224b), via the one or more input devices, one or more inputs directed to the keyboard (e.g., 1112) corresponding to a request to enter text into the text entry region (e.g., 1104), such as in FIG. 11B. In some embodiments, the one or more inputs directed to the keyboard are one or more of the inputs described below with reference to methods 1400 and/or 1600. In some embodiments, the one or more inputs directed to the keyboard include one or more air gestures described in more detail above, such as one or more direct and/or indirect inputs.

In some embodiments, in response to the one or more inputs (1224c), the computer system displays (1224d), via the display generation component (e.g., 120), the text in the text entry region (e.g., 1104) and a representation of the text in the representation (e.g., 1122c) of the portion of the first object (e.g., 1102), including displaying the cursor at a second location in the text entry field (e.g., 1104) that is based on the one or more inputs corresponding to the request to enter the text into the text entry region (e.g., 1104), and displays the representation of the cursor in the representation (e.g., 1122c) of the portion of the first object at a corresponding second location in the representation of the portion of the first object, such as in FIG. 11C. In some embodiments, the computer system updates the position of the cursor to be displayed at the end of the text in the text entry region because the computer system will enter subsequent text after the previously-entered text. In some embodiments, the computer system updates the position of the cursor in accordance with an input corresponding to a request to update the position of the cursor. In some embodiments, the position of the representation of the cursor in the representation of the text entry field corresponds to the position of the cursor in the text entry field.

In some embodiments, the computer system (e.g., 101) updates (1224e) a respective portion of the first object (e.g., 1102) included in the representation (e.g., 1122c) of the portion of the first object to maintain display, via the display generation component (e.g., 120), of the representation of the cursor at the corresponding second location in the representation (e.g., 1122c) of the portion of the first object, such as in FIG. 11C. In some embodiments, the computer system displays a different portion of the first object in order to maintain display of the representation of the cursor in the representation of the first object. For example, the computer system initially displays a representation of the first object that does not include a representation of a respective location within the text entry field and, in response to a sequence of inputs that causes the computer system to display the cursor at the respective location in the text entry field, the computer system updates the portion of the first object included in the representation of the portion of the first object to include a representation of the respective location within the text entry field. In some embodiments, the computer system shifts the portion of the first object represented by the representation of the portion of the first object in accordance with movement of the cursor to include a representation of the cursor in the representation of the portion of the first object. In some embodiments, the representation of the cursor in the representation of the portion of the first object is maintained in the center of the representation of the portion of the first object. Updating the respective portion of the first object included in the representation of the portion of the first object to maintain display of the representation of the cursor in the representation of the portion of the first object enhances user interactions with the computer system by providing improved visual feedback to the user.

In some embodiments, while displaying the three-dimensional environment (e.g., 1101) from the respective viewpoint including the first object (e.g., 1102) that includes the text entry field (e.g., 1104) at the respective location in the three-dimensional environment (e.g., 1101), the computer system detects (1226a), such as in FIG. 11A, via a hardware keyboard of the one or more input devices, a second input corresponding to a request to enter text in the text entry field (e.g., 1104). In some embodiments, the second input includes manipulation of one or more keys of the hardware keyboard.

In some embodiments, in response to detecting the second input (1226b), the computer system (e.g., 101) displays (1226c), via the display generation component (e.g., 120), the text in the text entry field (e.g., 1104), and displays (1226d), via the display generation component (e.g., 120), the representation (e.g., 1122c) of the portion of the first object including a representation of the text entered via the hardware keyboard, such as in FIG. 11C, without displaying the keyboard (e.g., 1112). In some embodiments, the representation of the portion of the first object is displayed without the keyboard similarly to one or more techniques described herein for displaying the portion of the first object with the keyboard, such as updating the portion of the first object included in the representation and displaying the representation at an angle in the three-dimensional environment. Displaying the representation of the portion of the first object without displaying the keyboard in response to the second input detected via the hardware keyboard enhances user interactions with the computer system by providing enhanced visual feedback to the user.

In some embodiments, displaying the keyboard (e.g., 1112) includes displaying, via the display generation component (e.g., 120), the keyboard (e.g., 1112) at a first angle relative to a respective reference in the three-dimensional environment (e.g., 1101) (1228a), such as in FIG. 11B. In some embodiments, the computer system displays the keyboard at an angle according to one or more techniques described above. In some embodiments, displaying the representation (e.g., 1122c) of the portion of the first object includes displaying the representation (e.g., 1122c) of the portion of the first object (e.g., 1102) at a third angle different from the second angle relative to the respective reference in the three-dimensional environment (1228b), such as in FIG. 11B. In some embodiments, the computer system displays the text entry field at a third angle in the three-dimensional environment that is different from the first angle and different from the second angle. In some embodiments, the keyboard is displayed at a larger angle relative to gravity than the angle of the representation of the portion of the first object relative to gravity. In some embodiments, one or more of the keyboard and the representation are tilted upwards towards the viewpoint of the user (e.g., the back edge(s) are higher up in the three-dimensional environment than the front edge(s) of the keyboard and/or the representation). Displaying the representation of the portion of the first object at a different angle than the angle with which the keyboard is displayed in the three-dimensional environment enhances user interactions with the computer system by providing improved visual feedback to the user.

In some embodiments, displaying the representation (e.g., 1122c) of the portion of the first object (e.g., 1102) includes (1230a), in accordance with a determination that a spatial relationship between the respective viewpoint of the user and the representation (e.g., 1122c) of the portion of the first object is a first spatial relationship, displaying, via the display generation component (e.g., 120), the representation (e.g., 1122c) of the portion of the first object (e.g., included in object 1124) at a first angle relative to a respective reference in the three-dimensional environment (e.g., 1101) (1230b), such as in FIG. 11B. In some embodiments, the first angle is an angle that orients the representation of the portion of the first object towards the respective viewpoint of the user.

In some embodiments, in accordance with a determination that the spatial relationship between the respective viewpoint of the user and the representation (e.g., 1124) of the portion of the first object is a second spatial relationship, the representation (e.g., 1124) of the portion of the first object is displayed, via the display generation component (e.g., 120), at a second angle different from the first angle relative to a respective reference plane in the three-dimensional environment (e.g., 1101) (1230c), such as in FIG. 11G. In some embodiments, the second angle is an angle that orients the representation of the portion of the first object towards the respective viewpoint of the user. In some embodiments, in response to detecting a change in the spatial relationship between the respective viewpoint of the user and the representation of the portion of the first object, the computer system updates the angle of the representation of the portion of the first object. In some embodiments, the computer system displays the representation of the portion of the first object at an angle oriented towards the viewpoint of the user (e.g., towards the user's head or face). For example, if the user's face is a first height relative to a reference in the three-dimensional environment the computer system displays the representation of the portion of the first object at a first angle oriented towards the user's face and if the user's face is a second height relative to the reference in the three-dimensional environment that is lower than the first height, then the computer system displays the representation of the portion of the first object at a second angle oriented towards the face of the user that is a smaller angle relative to gravity. Displaying the representation of the portion of the first object at an angle that depends on the spatial relationship between the respective viewpoint of the user and the representation of the portion of the first object enhances user interactions with the computer system by providing improved visual feedback to the user.

In some embodiments, displaying the first object (e.g., 1102) includes displaying, via the display generation component (e.g., 120), the first object (e.g., 1102) at a first angle relative to a respective reference in the three-dimensional environment (e.g., 1101), and displaying the representation (e.g., 1124) of the portion of the first object includes displaying, via the display generation component (e.g., 120), the representation (e.g., 1124) of the portion of the first object at a second angle different from the first angle relative to the respective reference in the three-dimensional environment (e.g., 1101) (1232), such as in FIG. 11B. In some embodiments, the first and second angles are relative to gravity. For example, the first object is displayed parallel to gravity and oriented towards the viewpoint of the user and the representation of the portion of the first angle is not parallel to gravity and oriented towards the viewpoint of the user. In some embodiments, the first and second angles are relative to the viewpoint of the user. For example, the representation of the portion of the first object is displayed normal to the viewpoint of the user oriented towards the viewpoint of the user and the first object is not normal to the viewpoint of the user and is oriented towards the viewpoint of the user. Displaying the first object and the representation of the portion of the first object at different angles in the three-dimensional environment enhances user interactions with the computer system by providing improved visual feedback to the user.

In some embodiments, displaying the first object (e.g., 1102) includes displaying, via the display generation component, a selectable option (e.g., 1106b) included in the first object, and displaying the representation (e.g., 1124) of the portion of the first object includes displaying, via the display generation component (e.g., 120), a representation of (e.g., at least a portion of) the selectable option (e.g., 1122b) in the representation (e.g., 1124) of the portion of the first object (1234a), such as in FIG. 11B. In some embodiments, the computer system displays the representation of the selectable option at a location in the representation of the portion of the first object corresponding to the location of the selectable option in the first object.

In some embodiments, the computer system (e.g., 101) detects (1234b), via the one or more input devices, a second input directed to the selectable option (e.g., 1106b in FIG. 11B) included in the first object (e.g., 1102). In some embodiments, the second input is an air gesture or an input received via a hardware input device, such as an air gesture that includes a pinch gesture while the attention of the user is directed to the selectable option. In some embodiments, in response to detecting the second input, the computer system performs (1234c) a respective operation associated with the selectable option (e.g., 1106b in FIG. 11B).

In some embodiments, the computer system (e.g., 101) detects (1234d), via the one or more input devices (e.g., 314), a third input directed to the representation (e.g., 1122b) of the selectable option in the representation (e.g., 1124) of the portion of the first object (e.g., 1102), such as in FIG. 11B. In some embodiments, the third input is an air gesture or an input received via a hardware input device, such as an air gesture that includes a pinch gesture while the attention of the user is directed to the selectable option. In some embodiments, the third input is the same type of input as the second input. In some embodiments, the third input is a different type of input from the second type of input.

In some embodiments, in response to detecting the third input, the computer system (e.g., 101) forgoes (1234e) performing the respective operation associated with the selectable option (e.g., 1106b), such as in FIG. 11C. In some embodiments, representations of selectable options included in the representation of the portion of the first object are not interactive. Forgoing performing the respective operation associated with the selectable option in response to detecting the third input directed to the representation of the selectable option enhances user interactions with the computer system by reducing the number of inputs needed to perform an operation (e.g., reducing inputs needed to undo accidental selection of the representation of the selectable option).

In some embodiments, such as in FIG. 11C, while displaying, via the display generation component (e.g., 120), the representation (e.g., 1124) of the portion of the first object (e.g., 1102) that includes at least the portion of the text entry field (e.g., 1104), including the representation of the respective text included in at least the portion of the text entry field, the computer system detects (1236a), via the one or more input devices, a second input directed to the representation (e.g., 1128b) of the respective text in the representation of the portion of the first object (e.g., 1102), the second input corresponding to a request to select a respective portion of the respective text. In some embodiments, the second input is a direct input or an indirect input including a selection input (e.g., a pinch, a press, air pinch, or air tap) and movement of a portion of the body of the user to update the portion of text that is selected.

In some embodiments, in response to detecting the second input (1236b), the computer system (e.g., 101) updates (1236c) display, via the display generation component (e.g., 120), of the representation (e.g., 1128b) of the respective text to indicate selection of the respective portion of the respective text, such as in FIG. 11C. In some embodiments, the computer system updates a visual characteristic of the portion of the representation of the respective text that is selected, such as by changing a size, color, or other style of the text or displaying the text with a highlight effect or displaying a box or other boundary around the text. In some embodiments, the computer system detects a third input directed to the selected respective portion of the respective text in the representation of the first object to perform an action with respect to the selected respective portion of the respective text (e.g., copy, paste, and/or cut) and, in response to the third input, performs the action.

In some embodiments, the computer system (e.g., 101) updates (1236d) display, via the display generation component (e.g., 120), of the text entry field (e.g., 1104) to indicate selection of the respective portion of the respective text, such as in FIG. 11C. In some embodiments, the computer system updates a visual characteristic of the portion of the respective text that is selected, such as by changing a size, color, or other style of the text or displaying the text with a highlight effect or displaying a box or other boundary around the text. In some embodiments, the computer system updates the representation of the respective text in the representation of the first object in the same manner in which the computer system updates the respective text in the first object to indicate selection. In some embodiments, the computer system updates the representation of the respective text in the representation of the first object in a different manner from which the computer system updates the respective text in the first object to indicate selection. In some embodiments, while the respective portion of the respective text is selected, the computer system receives an input to perform an operation with respect to the respective portion of the respective text (e.g., delete, change format, cut, copy, or paste). In some embodiments, in response to receiving the input to perform the operation with respect to the respective portion of the respective text, the computer system performs the operation with respect to the respective portion of the respective text, optionally without performing the operating with respect to a portion other than the respective portion of the respective text. Updating display of the representation of the respective text and the text in the text entry field in response to detecting the second input selecting a portion of the respective text enhances user interactions with the computer system by providing enhanced visual feedback to the user (e.g., when selecting portions of text).

In some embodiments, while displaying, via the display generation component (e.g., 120), the first object (e.g., 1102), the representation (e.g., 1124) of the portion of the first object, and the keyboard (e.g., 1112), the computer system (e.g., 101) detects (1238a), via the one or more input devices (e.g., 314), one or more inputs directed to the keyboard (e.g., 1124) corresponding to a request to enter text into the text entry region (e.g., 1104), such as in FIG. 11B. In some embodiments, the one or more inputs are inputs described below with reference to methods 1400 and 1600. In some embodiments, in response to the one or more inputs, the computer system (e.g., 101) displays (1238b), via the display generation component (e.g., 120), the text in the text entry region (e.g., 1104) and a representation of the text in the representation (e.g., 1124) of the portion of the first object (e.g., 1102), such as in FIG. 11C. In some embodiments, the computer system similarly updates the text in the representation of the portion of the first object and in the first object without displaying the keyboard in response to one or more inputs directed to a hardware keyboard that correspond to a request to enter text in the text entry region of the first object. Updating the text in the text entry region and the representation of the text in the representation of the portion of the first object in response to the one or more inputs directed to the keyboard enhances user interactions with the computer system by providing enhanced visual feedback to the user.

In some embodiments, displaying the keyboard (e.g., 1112) in response to the first input includes displaying, via the display generation component (e.g., 120), a plurality of selectable options (e.g., 1120a-1120i) associated with text operations directed to the text entry field (e.g., 1104), such as in FIG. 11C, wherein the plurality of selectable options (e.g., 1120a-1120i) are displayed between the representation (e.g., 1122c) of the portion of the first object and the keyboard (e.g., 1112) in the three-dimensional environment (1240). In some embodiments, the text operations include undo, redo, copy, paste, edit font style, word suggestion and correction options, an option to add an image or other attachment, and the like. In some embodiments, the word suggestion and correction options are options that, when selected, cause the computer system to input respective text corresponding to the selected option. In some embodiments, the respective text included in the word suggestion and correction options are selected using a predictive text algorithm based on previous text-based inputs received at the computer system and/or the text already entered in the text entry region. Displaying the plurality of selectable options associated with text operations directed to the text entry field between the representation of the portion of the first object and the keyboard in the three-dimensional environment enhances user interactions with the computer system by reducing the number of inputs needed to perform operations (e.g., displaying the options without an additional input requesting display of the options).

In some embodiments, the keyboard location is a first distance from the respective viewpoint (1242a), such as in FIG. 11B. In some embodiments, as described above, the computer system displays the keyboard at the keyboard location the first distance from the respective viewpoint of the user irrespective of other attributes of the position of the first object (e.g., how far beyond the threshold distance the first object is from the viewpoint of the user, and/or the lateral and vertical position of the first object). In some embodiments, in response to detecting the first input (1242b), in accordance with a determination that the respective location in the three-dimensional environment (e.g., 1101) is a third location, wherein the third location is less than the threshold distance from the respective viewpoint, such as in FIG. 11F, the computer system (e.g., 101) displays (1242c), via the display generation component (e.g., 120), the keyboard (e.g., 1112) at a fourth location that is a second distance from the respective viewpoint of the user. In some embodiments, if the first object is less than the threshold distance from the viewpoint of the user, the distance between the keyboard and the viewpoint of the user is different from the distance between the viewpoint of the user and the keyboard when the first object is greater than the threshold distance from the viewpoint of the user. In some embodiments, the second distance corresponds to the distance between the viewpoint of the user and the third location. In some embodiments, the second distance is less than the distance between the viewpoint of the user and the third location so that the keyboard is not occluded by the first object from the viewpoint of the user.

In some embodiments, in accordance with a determination that the respective location in the three-dimensional environment is a fourth location different from the third location (e.g., in FIG. 11F), wherein the fourth location is less than the threshold distance from the respective viewpoint, the computer system (e.g., 101) displays (1242d), via the display generation component (e.g., 120), the keyboard (e.g., 1112) at a fifth location that is a third distance different from the second distance from the respective viewpoint of the user. In some embodiments, the third distance corresponds to the distance between the viewpoint of the user and the fourth location. In some embodiments, the third distance is less than the distance between the viewpoint of the user and the fourth location so that the keyboard is not occluded by the first object from the viewpoint of the user. In some embodiments, if the distance between the viewpoint of the user and the third location is greater than the distance between the viewpoint of the user and the fourth location, the second distance is greater than the third distance. In some embodiments, if the distance between the viewpoint of the user and the third location is less than the distance between the viewpoint of the user and the fourth location, the second distance is less than the third distance. Displaying the keyboard at a different respective distance from the viewpoint of the user based on the location of the first object in the three-dimensional environment when the first object is less than the threshold distance from the viewpoint of the user enhances user interactions with the computer system by reducing the number of inputs needed to perform an operation (e.g., positioning the keyboard at an appropriate location in the three-dimensional environment).

In some embodiments, the first location in the three-dimensional environment (e.g., 1101) has a first vertical position in the three-dimensional environment (e.g., 1101), such as in FIG. 11G, and the second location in the three-dimensional environment has a second vertical position different from the first vertical position in the three-dimensional environment (e.g., 1101) (1244a). In some embodiments, displaying the keyboard (e.g., 1112) at the keyboard location in the three-dimensional environment (e.g., 1101) in accordance with the determination that the respective location in the three-dimensional environment (e.g., 1101) is the first location includes displaying, via the display generation component (e.g., 120), the keyboard (e.g., 1112) with a third vertical position (e.g., vertical relative to the viewpoint of the user) in accordance with the first vertical position of the first location (1244b), such as in FIG. 11G. In some embodiments, the third vertical position is within the keyboard location. In some embodiments, the third vertical position is below the vertical position of the text entry region when the first object is displayed with the first vertical position in the three-dimensional environment. In some embodiments, the top of the keyboard, the bottom of the keyboard, the center of the keyboard, the right of the keyboard, or the left of the keyboard is displayed at the third vertical position and the rest of the keyboard is displayed accordingly.

In some embodiments, displaying the keyboard at the keyboard location in the three-dimensional environment (e.g., 1101) in accordance with the determination that the respective location in the three-dimensional environment (e.g., 1101) is the second location includes displaying, via the display generation component, the keyboard with a fourth vertical position (e.g., vertical relative to the viewpoint of the user) different from the third vertical position in accordance with the second vertical position of the second location (1244c), such as in FIG. 11H. In some embodiments, the fourth vertical position is within the keyboard location. In some embodiments, the fourth vertical position is below the vertical position of the text entry region when the first object is displayed with the second vertical position in the three-dimensional environment. In some embodiments, when the first vertical position is above the second vertical position, the third vertical position is above the fourth vertical position. In some embodiments, when the first vertical position is below the second vertical position, the third vertical position is below the fourth vertical position. In some embodiments, the top of the keyboard, the bottom of the keyboard, the center of the keyboard, the right of the keyboard, or the left of the keyboard is displayed at the fourth vertical position and the rest of the keyboard is displayed accordingly. Displaying the keyboard with a vertical position based on the vertical position of the first object enhances user interactions with the computer system by reducing the number of inputs needed to perform an operation (e.g., displaying the keyboard at an appropriate location).

In some embodiments, such as in FIG. 11G, the third vertical position has a respective angular offset from the first location relative to the respective viewpoint in the three-dimensional environment (e.g., 1101) (1246a). In some embodiments, the angle formed between the first location and the third vertical position from the viewpoint of the user is a predetermined angle (e.g., 1, 2, 3, 4, 5, or 10 degrees). In some embodiments, the third vertical position corresponds to the top of the keyboard or the top of a representation of a portion of the first object and the first location corresponds to the bottom of the text entry field. In some embodiments, the third vertical position has a respective vertical offset distance from the first location.

In some embodiments, such as in FIG. 11H, the fourth vertical position has the respective angular offset from the second location relative to the respective viewpoint in the three-dimensional environment (e.g., 1101) (1246b). In some embodiments, the angle formed between the second location and the fourth vertical position from the viewpoint of the user is the same predetermined angle as the angle formed from the viewpoint of the user, the first location, and the third vertical position. In some embodiments, the fourth vertical position corresponds to the top of the keyboard or the top of a representation of a portion of the first object and the second location corresponds to the bottom of the text entry field. In some embodiments, the fourth vertical position has the respective vertical offset distance from the second location that is the same as the respective vertical offset distance of the third vertical position relative to the first location. Displaying the keyboard at a consistent angular offset from the location of the first object relative to the respective viewpoint enhances user interactions with the computer system by reducing the number of inputs needed to perform an operation (e.g., display the keyboard at a location associated with the first object).

In some embodiments, such as in FIG. 11A, detecting the first input includes detecting, via the one or more input devices (e.g., 314), an attention (e.g., 1113a) of the user directed to a first location in the text entry field (e.g., 1104) (1248a). In some embodiments, the computer system detects the respective location to which the user's attention is directed based on the gaze of the user detected via the one or more input devices (e.g., an eye tracking device). In some embodiments, displaying the keyboard (e.g., 1112) at the keyboard location in the three-dimensional environment (e.g., 1101) in response to the first input includes (1248b), in accordance with a determination that the first location in the text entry field (e.g., 1104) has a first horizontal position in the three-dimensional environment (e.g., 1101), displaying, via the display generation component (e.g., 120), the keyboard (e.g., 1112) at a second horizontal position (e.g., horizontal relative to the viewpoint of the user) in accordance with the first horizontal position (1248c), such as in FIG. 11G. In some embodiments, the second horizontal position is the same as the first horizontal position. In some embodiments, the second horizontal position is within a threshold distance (e.g., 1, 2, 3, 4, 5, 10, 15, or 30 centimeters) of the first horizontal position. In some embodiments, the top of the keyboard, the bottom of the keyboard, the center of the keyboard, the right of the keyboard, or the left of the keyboard is displayed at the second horizontal position and the rest of the keyboard is displayed accordingly.

In some embodiments, in accordance with a determination that the first location in the text entry field (e.g., 1104) has a third horizontal position different from the first horizontal position in the three-dimensional environment (e.g., 1101), the keyboard (e.g., 1112) is displayed, via the display generation component (e.g., 120), at a fourth horizontal position (e.g., horizontal relative to the viewpoint of the user) different from the second horizontal position in accordance with the second horizontal position (1248d), such as in FIG. 11H. In some embodiments, the fourth horizontal position is the same as the second horizontal position. In some embodiments, the fourth horizontal position is within a threshold distance (e.g., 1, 2, 3, 4, 5, 10, 15, or 30 centimeters) of the second horizontal position. In some embodiments, if the first horizontal position is to the left of the third horizontal position, the second horizontal position is to the left of the fourth horizontal position. In some embodiments, if the first horizontal position is to the right of the third horizontal position, the second horizontal position is to the right of the fourth horizontal position. In some embodiments, the top of the keyboard, the bottom of the keyboard, the center of the keyboard, the right of the keyboard, or the left of the keyboard is displayed at the fourth horizontal position and the rest of the keyboard is displayed accordingly. Displaying the keyboard with a horizontal position based on the horizontal position of the attention of the user during the first input enhances user interactions with the computer system by reducing the number of inputs needed to perform an operation (e.g., displaying the keyboard at an appropriate location).

In some embodiments, while displaying, via the display generation component (e.g., 120), the keyboard (e.g., 112) at a third location in the three-dimensional environment (e.g., 1101) that is within a second threshold distance (e.g., 1111a) of the respective viewpoint (1250a), such as in FIG. 11J, the computer system (e.g., 101) receives (1250b), via the one or more input devices (e.g., 314), a text entry input directed to the keyboard (e.g., 1112), such as in FIG. 11J. In some embodiments, the computer system displays the keyboard at the third location in response to one or more inputs corresponding to a request to reposition the keyboard in the three-dimensional environment. In some embodiments, the second threshold distance is a threshold distance associated with accepting direct inputs directed to the keyboard and not accepting indirect inputs directed to the keyboard. In some embodiments, the second threshold distance is 5, 10, 15, 20, 30, 40, 50, 100, 200, 500, or 1000 centimeters.

In some embodiments, while displaying, via the display generation component (e.g., 120), the keyboard (e.g., 112) at a third location in the three-dimensional environment (e.g., 1101) that is within a second threshold distance (e.g., 1111a) of the respective viewpoint (1250a), such as in FIG. 11J, in response to receiving the text entry input (1250c), in accordance with a determination that the text entry input includes performance of a first gesture with a predefined portion (e.g., 1103i) of a user of the computer system (e.g., 101) while the predefined portion (e.g., 1103i) of the user is within a direct input threshold distance of a physical location corresponding to the keyboard (e.g., 1112) in the three-dimensional environment (e.g., 1101), the computer system (e.g., 101) enters (1250d) text (e.g., 1148b) into the text entry field (e.g., 1146) in accordance with the text entry input, such as in FIG. 11K. In some embodiments, the first gesture is an air pinch gesture or an air tapping/pushing/pressing gesture. In some embodiments, the predefined portion of the user is the user's hand. In some embodiments, the direct input threshold distance is 0.5, 1, 2, 3, 5, or 10 centimeters. In some embodiments, the determination is a determination that the input is a direct air gesture input as described above. In some embodiments, entering the text into the text entry field in accordance with the text entry input includes entering one or more characters in a sequence corresponding to a sequence in which one or more keys of the keyboard were activated in response to the text entry input. In some embodiments, the computer system presents an animation of the key activating and/or presents an audio indication of the key activating in addition to entering the text into the text entry field in accordance with the text entry input.

In some embodiments, while displaying, via the display generation component (e.g., 120), the keyboard (e.g., 112) at a third location in the three-dimensional environment (e.g., 1101) that is within a second threshold distance (e.g., 1111a) of the respective viewpoint (1250a), such as in FIG. 11J, in response to receiving the text entry input (1250c), in accordance with a determination that the text entry input includes performance of a second gesture with the predefined portion (e.g., 1103j) of the user while the predefined portion (e.g., 1103j) of the user is further than the direct input threshold distance of the physical location corresponding to the keyboard (e.g., 1112) in the three-dimensional environment (e.g., 1101), the computer system (e.g., 101) forgoes (1250e) entering the text into the text entry field in accordance with the text entry input, such as in FIG. 11K. In some embodiments, the second gesture is the same as the first gesture. In some embodiments, the second gesture is different from the first gesture. In some embodiments, the second gesture is an air pinching or tapping/pushing/pressing gesture. In some embodiments, the determination is a determination that the text entry input is an indirect air gesture input. In some embodiments, in addition to forgoing entering the text in response to the text entry input, the computer system forgoes other actions in response to the indirect text entry input, such as forgoing displaying an animation of the key activating and/or forgoing presenting an audio indication of the key activating. Forgoing entering the text in accordance with a determination that the text entry input includes the predefined portion of the user being more than the direct input threshold distance from the keyboard enhances user interactions with the computer system by preventing the computer system from activating the keyboard when the user does not intend to do so, thus reducing time and inputs used correcting errors.

In some embodiments, while displaying, via the display generation component (e.g., 120), the keyboard (e.g., 1112) at a third location in the three-dimensional environment (e.g., 1101) that is between a second threshold distance (e.g., 1111a) and a third threshold distance (e.g., 1111b) of the respective viewpoint (1252a), such as in FIG. 11L, the computer system (e.g., 101) receives (1252b), via the one or more input devices (e.g., 314), a text entry input directed to the keyboard (1112), such as in FIG. 11L. In some embodiments, the computer system displays the keyboard at the third location in response to one or more inputs corresponding to a request to reposition the keyboard in the three-dimensional environment, such as in FIG. 11K. In some embodiments, the second threshold distance is a threshold distance associated with accepting direct inputs directed to the keyboard and not accepting indirect inputs directed to the keyboard, as described above. In some embodiments, the third threshold distance is a threshold distance associated with accepting indirect inputs directed to the keyboard and not accepting direct inputs directed to the keyboard. In some embodiments, the third threshold distance is 30, 50, 60, 75, 100, 200, 300, 500, 1000, or 3000 centimeters.

In some embodiments, while displaying, via the display generation component (e.g., 120), the keyboard (e.g., 1112) at a third location in the three-dimensional environment (e.g., 1101) that is between a second threshold distance (e.g., 1111a) and a third threshold distance (e.g., 1111b) of the respective viewpoint (1252a), such as in FIG. 11L, in response to receiving the text entry input (1152c), in accordance with a determination that the text entry input includes performance of a first gesture with a predefined portion (e.g., 1103i) of a user of the computer system (e.g., 101) while the predefined portion (e.g., 1103i) of the user is within a direct input threshold distance of a physical location corresponding to the keyboard (e.g., 1112) in the three-dimensional environment (e.g., 1101), such as in FIG. 11L, the computer system (e.g., 101) enters (1252d) text (e.g., 1148b) into the text entry field (e.g., 1146) in accordance with the text entry input, such as in FIG. 11M. In some embodiments, the first gesture is a pinch gesture or a tapping/pushing/pressing gesture. In some embodiments, the predefined portion of the user is the user's hand. In some embodiments, the direct input threshold distance is the direct input threshold distance described above. In some embodiments, the determination is a determination that the input is a direct air gesture input as described above. In some embodiments, entering the text into the text entry field in accordance with the text entry input includes entering one or more characters in a sequence corresponding to a sequence in which one or more keys of the keyboard were activated in response to the text entry input. In some embodiments, the computer system presents an animation of the key activating and/or presents an audio indication of the key activating in addition to entering the text into the text entry field in accordance with the text entry input.

In some embodiments, while displaying, via the display generation component (e.g., 120), the keyboard (e.g., 1112) at a third location in the three-dimensional environment (e.g., 1101) that is between a second threshold distance (e.g., 1111a) and a third threshold distance (e.g., 1111b) of the respective viewpoint (1252a), such as in FIG. 11L, in response to receiving the text entry input (1152c), in accordance with a determination that the text entry input includes performance of a second gesture with the predefined portion (e.g., 1103i) of the user while the predefined portion (e.g., 1103i) of the user is further than the direct input threshold distance of the physical location corresponding to the keyboard (e.g., 1112) in the three-dimensional environment (e.g., 1101), the computer system (e.g., 101) enters (1252) text (e.g., 1148b) into the text entry field (e.g., 1146) in accordance with the text entry input, such as in FIG. 11M. In some embodiments, the second gesture is the same as the first gesture. In some embodiments, the second gesture is different from the first gesture. In some embodiments, the second gesture is a pinching or tapping/pushing/pressing gesture. In some embodiments, the determination is a determination that the text entry input is an indirect air gesture input. In some embodiments, entering the text into the text entry field in accordance with the text entry input includes entering one or more characters in a sequence corresponding to a sequence in which one or more keys of the keyboard were activated in response to the text entry input. In some embodiments, the computer system presents an animation of the key activating and/or presents an audio indication of the key activating in addition to entering the text into the text entry field in accordance with the text entry input. Entering text to the text entry field in response to direct or indirect inputs while the keyboard is displayed within the second and third thresholds enhances user interactions with the computer system by providing additional control options to the user, enabling the user to use the computer system quickly and efficiently.

In some embodiments, while displaying, via the display generation component (e.g., 120), the keyboard (e.g., 1112) at a third location in the three-dimensional environment (e.g., 1101) that is greater than a second threshold distance (e.g., 1111b) of the respective viewpoint (1255a), such as in FIG. 11N, the computer system (e.g., 101) receives (1254b), via the one or more input devices, a text entry input directed to the keyboard (e.g., 1112), such as in FIG. 11N. In some embodiments, the computer system displays the keyboard at the third location in response to one or more inputs corresponding to a request to reposition the keyboard in the three-dimensional environment, such as in FIG. 11M. In some embodiments, the second threshold distance is a threshold distance associated with accepting indirect inputs directed to the keyboard and not accepting direct inputs directed to the keyboard, as described in more details above. In some embodiments, the second threshold is a threshold for accepting direct inputs directed to the keyboard and is larger than the threshold described above for accepting indirect inputs. In some embodiments, the second threshold distance is 30, 50, 60, 75, 100, 200, 300, 500, 1000, or 3000 centimeters.

In some embodiments, while displaying, via the display generation component (e.g., 120), the keyboard (e.g., 1112) at a third location in the three-dimensional environment (e.g., 1101) that is greater than a second threshold distance (e.g., 1111b) of the respective viewpoint (1255a), such as in FIG. 11N, in response to receiving the text entry input (1254c), in accordance with a determination that the text entry input includes performance of a first gesture with a predefined portion (e.g., 1103j) of a user of the computer system while the predefined portion (e.g., 1103j) of the user is further than a direct input threshold distance of a physical location corresponding to the keyboard (e.g., 1112) in the three-dimensional environment (e.g., 1101), the computer system (e.g., 101) enters (1254d) text (e.g., 1148b) into the text entry field (e.g., 1146) in accordance with the text entry input, such as in FIG. 11O. In some embodiments, the first gesture is a pinching or tapping/pushing/pressing gesture. In some embodiments, the determination is a determination that the text entry input is an indirect air gesture input. In some embodiments, the direct input threshold distance is the direct input threshold distance described above. In some embodiments, entering the text into the text entry field in accordance with the text entry input includes entering one or more characters in a sequence corresponding to a sequence in which one or more keys of the keyboard were activated in response to the text entry input. In some embodiments, the computer system presents an animation of the key activating and/or presents an audio indication of the key activating in addition to entering the text into the text entry field in accordance with the text entry input.

In some embodiments, while displaying, via the display generation component (e.g., 120), the keyboard (e.g., 1112) at a third location in the three-dimensional environment (e.g., 1101) that is greater than a second threshold distance (e.g., 1111b) of the respective viewpoint (1255a), such as in FIG. 11N, in response to receiving the text entry input (1254c), in accordance with a determination that the text entry input includes performance of a second gesture with the predefined portion (e.g., 1103i) of the user while the predefined portion (e.g., 1103i) of the user is within the direct input threshold distance of the physical location corresponding to the keyboard (e.g., 1112) in the three-dimensional environment (e.g., 1101), the computer system (e.g., 101) forgoes (1254e) entering the text (e.g., 1148b) into the text entry field (e.g., 1146) in accordance with the text entry input, such as in FIG. 11O. In some embodiments, the second gesture is the same as the first gesture. In some embodiments, the second gesture is different from the first gesture. In some embodiments, the second gesture is a pinch gesture or a tapping/pushing/pressing gesture. In some embodiments, the predefined portion of the user is the user's hand. In some embodiments, the determination is a determination that the input is a direct air gesture input as described above. In some embodiments, the computer system forgoes entering text in response to the direct input because the user is physically too far from the keyboard to provide a direct input. In some embodiments, the user is close enough to the keyboard to be physically capable of providing the direct input, but the computer system does not accept the direct input. In some embodiments, in addition to forgoing entering the text in response to the text entry input, the computer system forgoes other actions in response to key activation, such as forgoing displaying an animation of the key activating and/or forgoing presenting an audio indication of the key activating. Forgoing entering the text in accordance with a determination that the text entry input includes the predefined portion of the user being less than the direct input threshold distance from the keyboard enhances user interactions with the computer system by preventing the computer system from activating the keyboard when the user does not intend to do so, thus reducing time and inputs used correcting errors.

In some embodiments, aspects/operations of methods 800, 1000, 1400, 1600, 1800, 2000, 2200, and/or 2400 may be interchanged, substituted, and/or added between these methods. For example, the computer system navigates content that was revised using a soft keyboard according to method 1200 by scrolling in accordance with method 800. As another example, the computer system accepts inputs directed to a soft keyboard presented in accordance with method 1200 according to methods 1400 and/or 1600. For brevity, these details are not repeated here.

FIGS. 13A-13E illustrate example techniques of facilitating interactions with a soft keyboard in accordance with some embodiments. The user interfaces in FIGS. 13A-13E are used to illustrate the processes described below, including the processes in FIGS. 14A-14J.

FIG. 13A illustrates a computer system 101 displaying, via a display generation component (e.g., display generation component 120 of FIG. 1), a three-dimensional environment 1301 from a viewpoint of the user. FIG. 13A also includes a side view of the three-dimensional environment 1301 in legend 1305a. Legend 1305a includes the location of the computer system 101 in the three-dimensional environment 1301 which corresponds to the viewpoint of the user in the three-dimensional environment 1301. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

In FIG. 13A, computer system 101 displays a soft keyboard 1314 via display generation component 120. In some embodiments, the soft keyboard 1314 has one or more features in common with the soft keyboard described above with reference to method 1400. While displaying the soft keyboard 1314, the computer system 101 displays a web browsing user interface 1302 that includes an indication 1304 of the website being displayed in the web browsing user interface 1302, a text entry field 1306 including a cursor 1312, and an option 1308 to conduct a search for one or more search terms entered into the text entry field 1306 (e.g., via the soft keyboard 1314). In some embodiments, the computer system 101 displays the cursor 1312 in response to an input corresponding to a request to display the soft keyboard 1314 in accordance with one or more steps of method 1200 described above.

In some embodiments, the computer system 101 is configured to accept direct inputs directed to the soft keyboard 1314 illustrated in FIG. 13A. The soft keyboard 1314 includes a plurality of keys including key 1322a and key 1322b displayed overlaid on and with visual separation from a backplane 1320. In some embodiments, the soft keyboard 1314 is displayed in association with user interface element 1316, a repositioning option 1318a, and a resizing option 1318b. In some embodiments, the computer system 101 displays one or more of user interface element 1316, repositioning option 1318a, and resizing option 1318b in accordance with one or more of the techniques described above with reference to method 1200.

In some embodiments, while the computer system 101 is configured to accept direct inputs directed to the soft keyboard 1314, the computer system displays virtual shadows 1324a and 1324b corresponding to hand 1303a and hand 1303b, respectively, overlaid on the soft keyboard 1314. In some embodiments, the computer system 101 displays the virtual shadows 1324a and 1324b at locations of the soft keyboard 1314 the correspond to locations of the hands 1303a and 1303b, respectively. Thus, in some embodiments, in response to detecting movement of hand 1303a or hand 1303b that causes the hand 1303a or hand 1303b to be overlaid on a different location of the soft keyboard 1314, the computer system 101 updates the position of virtual shadow 1324a or virtual shadow 1324b, respectively, in accordance with the movement of hand 1303a or hand 1303b.

In some embodiments, the computer system 101 detects movement of hand 1303a towards soft keyboard 1314 while the shadow 1324a associated with hand 1303a is overlaid on key 1322a. As shown in legend 1305a, hand 1303a is closer to the backplane 1320 of soft keyboard 1314 than the distance between hand 1303b and the backplane 1320 of soft keyboard 1314. In some embodiments, in response to detecting an initial portion of the movement of hand 1303a, the computer system 101 updates the position of key 1322a to increase the visual separation between key 1322a and the backplane 1320 of the keyboard and to move the key 1322a closer to the hand 1303a and/or the viewpoint of the user in the three-dimensional environment 1301. In some embodiments, because the distance between key 1322a and hand 1303a is less than the distance between key 1322b and hand 1303b, the computer system 101 displays the virtual shadow 1324a of hand 1303a on key 1322a smaller and darker than the way in which the computer system 101 displays the virtual shadow 1324b of hand 1303b on key 1322b.

In some embodiments, as shown in FIG. 13A, the computer system 101 detects movement of hand 1303a towards soft keyboard 1314, which corresponds to a request to activate key 1322a. In some embodiments, in response to detecting the hand 1303 move to a location within a threshold distance of the backplane 1320 of the soft keyboard, the computer system 101 activates the key 1322a, as shown in FIG. 13B. Example threshold distances are provided below in the description of method 1400 with reference to FIGS. 14A-14J.

In some embodiments, while detecting movement of the hand (e.g., air gesture, touch input, or other hand input) 1303a through a range of distances from the backplane 1320 of the keyboard 1314 that are greater than the threshold distance from the soft keyboard 1314, the computer system 101 moves the key 1322a towards the backplane 1320 (e.g., away from the hand 1303a and/or the viewpoint of the user) in accordance with (e.g., speed, distance, or duration of) the movement of the hand (e.g., air gesture, touch input, or other hand input) 1303a. In some embodiments, in response to movement of the hand (e.g., air gesture, touch input, or other hand input) 1303a that does not reach the threshold distance from the backplane 1320 of the soft keyboard 1314, the computer system 101 moves the key towards the backplane 1320 (e.g., away from hand 1303a and/or the viewpoint of the user) in accordance with (e.g., speed, distance, or duration) the movement of the hand (e.g., air gesture, touch input, or other hand input) 1303a and forgoes activating the key 1322a because the hand 1303a did not reach the threshold distance from the backplane 1320 of the soft keyboard 1314. In some embodiments, in response to detecting movement of the hand (e.g., air gesture, touch input, or other hand input) 1303a away from the soft keyboard 1314 after detecting the movement of the hand (e.g., air gesture, touch input, or other hand input) 1303a towards the keyboard without detecting movement of the hand (e.g., air gesture, touch input, or other hand input) 1303a to the threshold distance from the backplane 1320 of the soft keyboard 1314, the computer system moves the key 1322a away from the backplane 1320 of the soft keyboard 1314 (e.g., towards hand 1303a and/or the viewpoint of the user) in accordance with movement of the hand (e.g., air gesture, touch input, or other hand input) 1303a away from the soft keyboard 1314. In some embodiments, the computer system 101 initiates movement of the key 1322a towards the backplane 1320 of the soft keyboard 1314 in response to detecting movement of the hand (e.g., air gesture, touch input, or other hand input) 1303a to a location a second, greater threshold distance from the backplane 1320 of the soft keyboard 1314. In some embodiments, in response to movement of the hand (e.g., air gesture, touch input, or other hand input) 1303a that reaches a location further than the second threshold from the backplane 1320 of the soft keyboard 1314, the computer system 101 forgoes moving the key 1322a towards the backplane of the keyboard 1314 and optionally maintains display of the key 1322a as illustrated in FIG. 13A or maintains display of key 1322a with the amount of visual separation between key 1322b and backplane 1320 in FIG. 13A.

FIG. 13B illustrates the computer system 101 activating key 1322a in response to the input provided by hand 1303c described above with reference to FIG. 13A. In some embodiments, activating key 1322a includes entering text 1326a into text entry field 1306 and displaying a representation 1327a of the text 1326a in the representation 1307 of the text entry field 1306 in the user interface element 1316. In some embodiments, activating the key 1322a includes presenting an audio output 1320a that indicates activation of the key. In some embodiments, the audio output 1330a presented in response to the input described above with reference to FIG. 13A is different from the audio output optionally presented in response to detecting an input directed to a soft keyboard according to method 1600 described below. In some embodiments, activating key 1322a includes displaying an animation in a portion 1328a of the soft keyboard 1314, such as displaying a rippling animation of the keys included in portion 1328a of the soft keyboard 1314 that expands out from key 1322a. In some embodiments, if the computer system 101 were to detect an input similar to the input described above with reference to FIG. 13A directed to a different key, the computer system 101 would update the position of the key and activate the key in a similar manner to movement and activation of key 1322a described with reference to FIGS. 13A-13B.

In some embodiments, activating the key 1322a includes displaying the key 1322a move towards the backplane 1320 of the soft keyboard 1314 (e.g., away from hand 1303c and/or the viewpoint of the user). Legend 1305a shows the movement of key 1322a towards backplane 1320 (e.g., away from hand 1303c and/or the viewpoint of the user) in response to the input described above with reference to FIG. 13A. In some embodiments, the amount of movement of the key 1322a is to a location that is closer to the backplane 1320 of the soft keyboard (e.g., further from the viewpoint of the user) than the location the hand 1303c reaches while providing the input described above with reference to FIG. 13A. In some embodiments, the amount of movement of the key 1322a does not cause the key 1322a to reach the backplane 1320 of soft keyboard 1314, as shown in legend 1305a of FIG. 13B. In some embodiments, the amount of movement of key 1322a causes the key 1322a to reach the backplane 1320 of soft keyboard 1314. As shown in legend 1305a, the distance between hand 1303c and key 1322a is greater than the distance between hand 1303d and key 1322b, so the shadow 1324c of hand 1303c is larger and lighter than the shadow 1324b of hand 1303d.

In FIG. 13C, the computer system 101 detects an input directed to key 1322b provided by hand 1303f. In some embodiments, the input is similar to the input described above with reference to FIGS. 13A-13B. In response to the input, the computer system 101 updates the text 1326a in the text entry field 1306 and updates the representation 1327a of the text 1326a in the representation 1307 of the text entry field 1306. In some embodiments, the computer system 101 presents an audio output 1330b indicating the activation of key 1322b that is the same as or different from the audio output 1330a in FIG. 13B indicating the activation of key 1322a. In some embodiments, the computer system 101 detects concurrent activation of two or more keys. For example, the activation of two or more keys corresponds to a keyboard shortcut or the user providing inputs to enter characters corresponding to keys fully or partially simultaneously. In some embodiments, in response to detecting activation of two or more keys at the same time, the computer system 101 performs one or more operations corresponding to the combined activation of the keys or two or more operations corresponding to individual activation of the keys. Example operations performed in response to activation of keys are provided below in the description of method 1400 with reference to FIGS. 14A-14J.

Returning to FIG. 13B, in some embodiments, the computer system 101 activates the keys of soft keyboard 1314, including key 1322a, in response to direct inputs provided by the hands 1303c and 1303d of the user even if the movement of the hand (e.g., air gesture, touch input, or other hand input)s 1303c and 1303d does not correspond to movement of the keys to the backplane 1320 of the keyboard. In some embodiments, the computer system 101 activates other user interface elements, such as option 1308, in response to direct inputs that include movement of the user's hands that corresponds to movement of the user interface elements to reach the backplane of the user interface elements. As shown in legend 1305b FIG. 13B, the computer system 101 displays the option 1308 without visual separation from the user interface 1302 prior to detecting the beginning of an input directed to option 1308.

In FIG. 13C, the computer system 101 detects a hand 1303g of the user within a direct input threshold distance of option 1308. In some embodiments, in response to detecting the hand 1303g of the user in this manner, the computer system 101 displays the option 1308 with increased visual separation from the user interface 1302 (e.g., closer to the hand 1303g and/or the viewpoint of the user). In some embodiments, the computer system 101 displays the option 1308 with the visual separation from user interface 1302 shown in FIG. 13C in response to detecting the gaze and/or attention of the user directed to the user interface 1302 and/or the option 1308. As shown in FIG. 13C, the computer system 101 detects movement of hand 1303g towards option 1308 and user interface 1302. In some embodiments, the amount of movement of the hand (e.g., air gesture, touch input, or other hand input) 1303g corresponds to movement of the hand (e.g., air gesture, touch input, or other hand input) 1303g to the threshold distance from the user interface 1302. In some embodiments, the threshold distance is associated with activating a key of soft keyboard 1314 as described above with reference to FIGS. 13A-13B. In some embodiments, the threshold distance is greater than zero and the movement of hand 1303g does not cause the option 1308 to reach the location of the user interface 1302. As shown in FIG. 13D, in response to the input illustrated in FIG. 13C, the computer system forgoes activation of the option 1308 in response to the input illustrated in FIG. 13C.

FIG. 13D illustrates the computer system 101 updating display of the option 1308 without activating option 1308 in response to the input illustrated in FIG. 13D. In some embodiments, as shown in legend 1305b, the computer system 101 decreases the amount of visual separation between option 1308 and user interface 1302 (e.g., increases the amount of separation between option 1308 and the viewpoint of the user) in accordance with the movement of hand 1303g without the option 1308 reaching user interface 1302. As shown in FIG. 13D, the computer system 101 detects further movement of hand 1303g towards the option 1308 and user interface 1302. In some embodiments, the amount of movement of hand 1303g in FIG. 13D corresponds to moving the option 1308 to reach the user interface 1302. In some embodiments, in response to continuation of movement of hand 1303g in FIG. 13D, the computer system activates option 1308 as shown in FIG. 13E.

FIG. 13E illustrates how the computer system 101 updates the option 1308 in response to the continuation of the input described above with reference to FIG. 13D. In some embodiments, as shown in legend 1305b in FIG. 13E, the computer system 101 displays the option 1308 without visual separation from the user interface 1302 in response to the amount of movement of hand 1303g in FIG. 13D. In some embodiments, the computer system 101 performs an operation associated with the option in response to the input illustrated in FIG. 13D, such as performing a search with respect to the text 1326a provided to text entry field 1306 in response to the inputs described above with reference to FIGS. 13A-13C. In some embodiments, the computer system 101 activates other non-keyboard selectable options, such as one or more options included in user interface element 1316, in a manner similar to the manner of activating option 1308 described above with reference to FIGS. 13C-13E.

In some embodiments, the computer system 101 toggles between accepting inputs illustrated in FIGS. 13A-13C and described in more detail below with reference to method 1400 and accepting inputs according to method 1600 in response to detecting a change in the angle between the wrists and/or hands 1303h and 1303i of the user. In some embodiments, the change in the angle includes detecting the user change from their wrists being oriented towards the soft keyboard 1314 to the wrists being oriented towards each other (e.g., “Hand State D”). In response to detecting the change in orientation of the wrists, the computer system 101 displays cursors 1332a and 1332b at locations overlaid on the soft keyboard 1314 corresponding to the locations of hands 1303h and 1303i. As shown in legend 1305a of FIG. 13E, the cursors 1332a and 1332b are displayed with visual separation from keys 1322a and 1322b. In some embodiments, while displaying the soft keyboard 1314 with cursors 1332a and 1332b, the computer system 101 facilitates user interactions with the soft keyboard 1314 according to one or more steps of method 1600 described in more detail below. Additional descriptions regarding FIGS. 13A-13E are provided below in reference to method 1400 described with respect to FIGS. 13A-13E.

FIGS. 14A-14J is a flow diagram of methods of facilitating interactions with a soft keyboard in accordance with some embodiments. In some embodiments, method 1400 is performed at a computer system (e.g., computer system 101 in FIG. 1) including a display generation component (e.g., display generation component 120 in FIGS. 1, 3, and 4) (e.g., a heads-up display, a display, a touchscreen, and/or a projector) and one or more input devices. In some embodiments, the method 1400 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1400 are, optionally, combined and/or the order of some operations is, optionally, changed.

In some embodiments, method 1400 is performed at a computer system (e.g., 101) in communication with a display generation component (e.g., 120) and one or more input devices (e.g., 314), such as in FIG. 13A. In some embodiments, the computer system is the same as or similar to the computer system described above with reference to method(s) 800, 1000, and/or 1200. In some embodiments, the one or more input devices are the same as or similar to the one or more input devices described above with reference to method(s) 800, 1000, and/or 1200. In some embodiments, the display generation component is the same as or similar to the display generation component described above with reference to method(s) 800, 1000, and/or 1200.

In some embodiments, the computer system (e.g., 101) displays (1402a), via the display generation component (e.g., 120), a three-dimensional environment (e.g., 1301) including a keyboard (e.g., 1314) having a plurality of keys (e.g., 1322a and 1322b), wherein the keyboard (e.g., 1314) is displayed at a first location in the three-dimensional environment (e.g., 1301), and the plurality of keys (e.g., 1322a and 1322b) extends a first distance (e.g., 0.1, 0.2, 0.3, 0.5, 1, 2, 3, or 5 centimeters) away from a region corresponding to a surface (e.g., 1320) of the keyboard (e.g., 1314), such as in FIG. 13A. In some embodiments, the three-dimensional environment is the same as or similar to the three-dimensional environment described above with reference to method(s) 800, 1000, and/or 1200. In some embodiments, the region corresponding to the keyboard includes a backplane of the keys that is visually separated from the plurality of keys (e.g., the keys extend a certain distance from the backplane). In some embodiments, different keys correspond to different characters (e.g., letters, numbers, and/or special characters included in text). In some embodiments, the keyboard includes one or more details of the keyboard described with reference to method(s) 1200 and/or 1600.

In some embodiments, such as in FIG. 13A, while displaying the three-dimensional environment (e.g., 1301) including the keyboard (e.g., 1314) at the first location in the three-dimensional environment (e.g., 1301), the computer system (e.g., 101) receives (1402b), via the one or more input devices (e.g., 314), a first input including movement of a portion (e.g., 1303a) of a body of the user (e.g., a finger) toward a respective key (e.g., 1322a) of the plurality of keys of the keyboard (e.g., 1314). In some embodiments, the movement of the portion of the body of the user is in the direction from the keys to the backplane of the keys. In some embodiments, the amount of movement of the user's finger is less than the amount of visual separation between the respective key to which the input is directed and the backplane of the keyboard. In some embodiments, the second distance is greater than a threshold distance (e.g., 0.1, 0.2, 0.3, 0.5, 1, 2, 3, or 5 centimeters) corresponding to activation of the respective key. In some embodiments, the threshold distance is less than the first distance (e.g., the amount of visual separation between the respective key and the backplane of the keyboard).

In some embodiments, in response to receiving the first input, in accordance with a determination that the movement toward the respective key (e.g., 1322a) includes movement to a location that corresponds to a first key (e.g., 1322a) and is less than a threshold distance from the surface (e.g., 1320) of the keyboard (e.g., 1314), wherein the threshold distance is closer to the keyboard (e.g., 1314) than the first distance from the surface (e.g., 1320) of the keyboard (e.g., 1314) (1402c), the computer system (e.g., 101) moves (1402d) the first key (e.g., 1322a) a second distance (e.g., 0.1, 0.2, 0.3, 0.5, 1, 2, 3, or 5 centimeters), the second distance closer to the surface (e.g., 1320) of the keyboard (e.g., 1314) than the location, toward the surface (e.g., 1320) of the keyboard (e.g., 1314) at the first location in the three-dimensional environment (e.g., 1301), such as in FIG. 13B. In some embodiments, the second distance is less than the first distance. In some embodiments, the second distance is equal to the first distance. In some embodiments, the second distance is proportional to the amount of movement of the portion of the body of the user. For example, if the amount of movement of the portion of the body of the user is a first value, the second distance is a second value and if the amount of movement of the portion of the body of the user is a third value greater than the first value, the third distance is a fourth value greater than the third value. In some embodiments, the second distance is a respective value independent from the amount of movement of the portion of the body of the user. For example, the second distance is a respective value irrespective of whether the amount of movement of the portion of the body of the user is a first value or second value different from the first value. In some embodiments, the second distance is based on the speed, duration and/or acceleration of the movement of the portion of the body of the user.

In some embodiments, such as in FIG. 13B, the computer system (e.g., 101) performs (1402e) one or more operations corresponding to selection of the first key (e.g., 1322a). For example, in response to detecting selection of a key corresponding to a respective character, the computer system enters the respective character into a text entry field associated with the keyboard (e.g., a text entry field to which input focus of the keyboard is currently directed). As another example, in response to detecting selection of a key corresponding to whitespace (e.g., a space bar, a tab key, or an enter key), the computer system enters the respective whitespace into the text entry field. As another example, in response to detecting selection of a key that corresponds to updating the type of soft keyboard (e.g., lowercase characters, capital characters, numbers and symbols, images, language-specific keyboards, or alternative character layouts) being displayed, the computer system updates the type of soft keyboard being displayed. As another example, in response to detecting selection of a key corresponding to enabling or disabling caps lock, the computer system enables or disables caps lock, respectively. As another example, in response to detecting selection of a key that corresponds to a request to delete one or more characters from a text entry field, the computer system deletes the one or more characters from the text entry field. As another example, in response to detecting selection of a plurality of keys corresponding to a keyboard shortcut (e.g., a shortcut to copy, cut, or paste test, or a shortcut to save a document), the computer system performs the operation corresponding to the keyboard shortcut. Moving the one or more keys by the second distance in response to movement of the portion of the body of the user to the first location enhances user interactions with the computer system by enabling the user to select keys more efficiently and accurately.

In some embodiments, moving the first key (e.g., 1322a) the second distance toward the surface (e.g., 1320) of the keyboard (e.g., 1314) in response to receiving the first input, such as in FIG. 13B, and in accordance with the determination that the movement toward the respective key (e.g., 1322a) includes movement to the location that corresponds to the first key (e.g., 1322a) includes (1404a), while detecting a portion of the movement of the portion (e.g., 1303c) of the body of the user that includes movement to the threshold distance from the surface (e.g., 1320) of the keyboard (e.g., 1314), moving the first key (e.g., 1322a) in accordance with the portion of the movement toward the surface (e.g., 1320) of the keyboard (e.g., 1314) (1404b). In some embodiments, moving the first key in accordance with the portion of the movement to the threshold distance includes moving the first key by an amount corresponding to an amount of (e.g., speed, distance, and/or duration of) movement of the portion of the body of the user and/or in a direction corresponding to the direction of movement of the portion of the body of the user, and optionally not by an amount greater than the amount of movement of the portion of the body of the user.

In some embodiments, in response to the movement of the portion (e.g., 1303c) of the body of the user towards the first key (e.g., 1322a) reaching the threshold distance from the surface (e.g., 1320) of the keyboard (e.g., 1320), such as in FIG. 13B, the first key (e.g., 1322a) is moved a remainder of the second distance closer to the keyboard (e.g., 1314), wherein moving the first key (e.g., 1322a) the remainder of the second distance is independent of further movement (e.g., does not progress in accordance with a remainder of the movement) of the portion (e.g., 1303c) of the body of the user (1404c). In some embodiments, in response to detecting the movement of the portion of the body of the user that reaches the threshold distance, the computer system moves the first key the remainder of the second distance irrespective of additional distance of movement of the portion of the body of the user and/or irrespective of other characteristics of the movement of the portion of the body of the user, such as speed, duration, and/or distance. In some embodiments, the remainder of the second distance of movement of the key is less than an amount of movement of the portion of the body of the user past the threshold distance from the surface of the keyboard. In some embodiments, the remainder of the second distance of movement of the key is greater than an amount of movement of the portion of the body of the user past the threshold distance from the surface of the keyboard. Moving the first key in accordance with the portion of the movement of the body of the user to the threshold distance and moving the first key the remainder of the distance not in accordance with continued movement of the portion of the body of the user enhances user interactions with the computer system by performing an operation with fewer inputs (e.g., moving the first key the remainder of the second distance irrespective of continued movement of the portion of the body of the user).

In some embodiments, in response to receiving the first input, in accordance with a determination that the movement towards the respective key (e.g., 1322a in FIG. 13B) includes movement to a second location that corresponds to the first key (e.g., 1322a) and is greater than the threshold distance from the surface (e.g., 1320) of the keyboard (e.g., 1314) and less than the first distance from the surface of the keyboard (1406a), the computer system (e.g., 101) moves (1406b) the first key (e.g., 1322a) a third distance in accordance with the movement of the portion (e.g., 1303c) of the body of the user toward the surface (e.g., 1320) of the keyboard (e.g., 1314) at the first location in the three-dimensional environment (e.g., 1301). In some embodiments, moving the first key in accordance with the portion of the movement to the second location includes moving the first key by an amount corresponding to an amount of (e.g., speed, distance, and/or duration of) movement of the portion of the body of the user and/or in a direction corresponding to the direction of movement of the portion of the body of the user, and optionally not by an amount greater than the amount of movement of the portion of the body of the user.

In some embodiments, the computer system (e.g., 101) forgoes (1406c) performing the one or more operations corresponding to selection of the first key (e.g., 1322a in FIG. 13B). In some embodiments, the computer system forgoes moving the first key the remainder of the second distance in the manner described above in accordance with the determination that the movement of the portion of the body of the user to the second location that is greater than the threshold distance from the surface of the keyboard. Moving the first key without performing the one or more operations corresponding to selection of the first key in response to movement of the portion of the body of the user to a location greater than the threshold distance from the surface of the keyboard enhances user interactions with the computer system by providing enhanced visual feedback to the user.

In some embodiments, after detecting the movement of the portion (e.g., 1303c) of the body of the user included in the first input (1408a), such as in FIG. 13B, the computer system (e.g., 101) detects (1408b), via the one or more input devices (e.g., 314), second movement of the portion (e.g., 1303e) of the body of the user away from the respective key (e.g., 1322a), such as in FIG. 13C. In some embodiments, in response to detecting the second movement of the portion (e.g., 1303e) of the body of the user and in accordance with the determination that the movement towards the respective key includes movement to the second location that corresponds to the first key (e.g., 1322a), the computer system moves (1408c) the first key (e.g., 1322a) away from the surface (e.g., 1320) of the keyboard (e.g., 1314) in accordance with the second movement of the portion (e.g., 1303e) of the body of the user, such as in FIG. 13C. In some embodiments, moving the first key in accordance with the portion of the movement away from the respective key includes moving the first key by an amount corresponding to an amount of (e.g., speed, distance, and/or duration of) movement of the portion of the body of the user and/or in a direction corresponding to the direction of movement of the portion of the body of the user, and optionally not by an amount greater than or less than the amount of movement of the portion of the body of the user. Moving the first key away from the surface of the keyboard in accordance with the movement of the portion of the body of the user away from the respective key enhances user interactions with the computer system by providing enhanced visual feedback to the user.

In some embodiments, in response to receiving the first input, in accordance with a determination that the movement toward the respective key (e.g., 1322a in FIG. 13A) includes movement to a second location that is greater than the first distance from the surface (e.g., 1320) of the keyboard (e.g., 1314), the computer system (e.g., 101) forgoes (1410) moving the respective key (e.g., 1322a) toward the surface (e.g., 1320) of the keyboard (e.g., 1314). In some embodiments, if the portion of the body of the user does not reach the location in the three-dimensional environment corresponding to the respective key, the computer system does not move the respective key in accordance with movement of the portion of the body of the user. Forgoing moving the respective key in response to movement of the portion of the body of the user to the second location that is greater than the first distance from the surface of the keyboard enhances user interactions with the computer system by providing enhanced visual feedback to the user.

In some embodiments, in response to receiving the first input, in accordance with a determination that the movement toward the respective key (e.g., 1322b) includes movement to a second location that corresponds to a second key (e.g., 1322b) different from the first key (e.g., 1322a) and is less than the threshold distance from the surface (e.g., 1320) of the keyboard (e.g., 1314) (1412a), such as in FIG. 13B, the computer system (e.g., 101) moves (1412b) the second key (e.g., 1322b) the second distance toward the surface (e.g., 1320) of the keyboard (e.g., 1314) at the first location in the three-dimensional environment (e.g., 1301), such as in FIG. 13C. In some embodiments, the computer system moves the second key in response to the first input in a manner similar to the manner described above in which the computer system moves the first key the second distance in response to the first input.

In some embodiments, the computer system (e.g., 101) performs (1412c) one or more operations corresponding to selection of the second key (e.g., 1322b), such as in FIG. 13C. In some embodiments, the one or more operations corresponding to selection of the second key are one of the one or more operations described above as operations that could correspond to selection of the first key. In some embodiments, the one or more operations corresponding to selection of the second key are different from the one or more operations corresponding to selection of the first key. In some embodiments, in response to detecting concurrent selection of the first key and the second key, the computer system performs one or more operations associated with concurrent selection of the first key and the second key. Moving the second key by the second distance in response to movement of the portion of the body of the user to the second location enhances user interactions with the computer system by enabling the user to select keys more efficiently and accurately.

In some embodiments, in response to receiving the first input, in accordance with a determination that the movement towards the respective key (e.g., 1322b in FIG. 13B) includes movement to a second location that corresponds to a second key (e.g., 1322b) different from the first key (e.g., 1322a) and is greater than the threshold distance from the surface (e.g., 1320) of the keyboard (e.g., 1314) and less than the first distance from the surface (e.g., 1320) of the keyboard (1414a), the computer system (e.g., 101) moves (1414b) the second key (e.g., 1322b) a third distance in accordance with the movement of the portion (e.g., 1303d) of the body of the user toward the surface (e.g., 1320) of the keyboard (e.g., 1314) at the first location in the three-dimensional environment (e.g., 1301). In some embodiments, the computer system moves the second key the third distance in accordance with the movement of the portion of the body of the user in a manner similar to the manner in which the computer system moves the first key in accordance with the movement of the body of the user to the threshold distance described above. In some embodiments, the computer system (e.g., 101) forgoes (1414c) performing the one or more operations corresponding to selection of the second key (e.g., 1322b in FIG. 13B). Moving the second key without performing the one or more operations corresponding to selection of the second key in response to movement of the portion of the body of the user to a location greater than the threshold distance from the surface of the keyboard enhances user interactions with the computer system by providing enhanced visual feedback to the user.

In some embodiments, while displaying the keyboard (e.g., 1314) at the first location in the three-dimensional environment (e.g., 101) (1416a), the computer system (e.g., 101) displays (1416b), via the display generation component (e.g., 120), a selectable option (e.g., 1308) at a second location in the three-dimensional environment (e.g., 101), wherein the selectable option (e.g., 1308) extends a third distance from a backplane (e.g., 1302) that is different from the surface (e.g., 1320) of the keyboard (e.g., 1314), such as in FIG. 13C. In some embodiments, the backplane is a container user interface element, such as a window or other surface. In some embodiments, from the viewpoint of the user in the three-dimensional environment, the backplane is behind the selectable option. In some embodiments, the computer system displays the selectable option without visual separation from the backplane unless and until the computer system detects the attention of the user directed to the selectable option and/or backplane while detecting the ready state of a hand of the user. In some embodiments, the computer system displays the selectable option extended the third distance from the backplane in response to detecting the attention of the user directed to the selectable option and/or the backplane while detecting the ready state of the hand of the user.

In some embodiments, the computer system detects (1416c), via the one or more input devices (e.g., 314), a second input including movement of the portion (e.g., 1303g) of the body of the user toward the selectable option (e.g., 1308), such as in FIG. 13D. In some embodiments, the movement of the portion of the body of the user is detected while the portion of the body of the user is in a respective shape or pose, such as the hand of the user being in a pointing hand shape. In some embodiments, in response to receiving the second input (1416d), in accordance with a determination that the movement towards the selectable option (e.g., 1308) corresponds to movement of the selectable option (e.g., 1308) at least the third distance towards the backplane (e.g., 1302), such as in FIG. 13E, the computer system (e.g., 101) performs (1416e) one or more operations corresponding to selection of the selectable option (e.g., 1308). In some embodiments, the computer system displays movement of the third option in accordance with the movement of the portion of the body of the user (e.g., with a speed, distance, or duration corresponding to the speed, distance, and/or duration of the movement of the portion of the body of the user). In some embodiments, the computer system moves the selectable option and backplane in accordance with movement of the portion of the body of the user that corresponds to movement of the selectable option past the third distance. In some embodiments, the one or more operations corresponding to selection of the selectable option are one or more of an operation to play or pause a content item, navigate to a user interface, initiate communication with another computer system, adjust a setting of the computer system, and/or save, open, close, and/or share a file. In some embodiments, other operations are possible.

In some embodiments, in accordance with a determination that the movement toward the selectable option (e.g., 1308) corresponds to movement of the selectable option (e.g., 1308) less than the third distance towards the backplane (e.g., 1302) (e.g., to a location that is less than the threshold distance from the backplane without reaching the backplane), the computer system (e.g., 101) forgoes (14160 performing the one or more operations corresponding to selection of the selectable option (e.g., 1308), such as in FIG. 13D. In some embodiments, the computer system performs one or more operations corresponding to selection of a key of a keyboard in response to an input corresponding to movement of the key to a location that does not reach the surface of the keyboard, but does not perform the one or more operations corresponding to selection of a selectable option that is not a key of a keyboard in response to an input corresponding to movement of the selectable option to a location that does not reach the backplane of the selectable option. In some embodiments, the computer system moves the selectable option towards the backplane in accordance with movement of the portion of the body for the entire movement of the selectable option in response to the second input. Selectively performing the one or more operations corresponding to the selectable option depending on whether the first input corresponds to movement of the selectable option to the backplane of the selectable option enhances user interactions with the computer system by providing improved visual feedback to the user (e.g., using the backplane to indicate how far to move the selectable option back to cause selection of the option).

In some embodiments, displaying the three-dimensional environment (e.g., 1301) including the keyboard (e.g., 1314) includes (1418a), displaying, via the display generation component (e.g., 120), a simulated shadow (e.g., 1324a) corresponding to the portion (e.g., 1303a) of the body of the user (e.g., a finger of the user) overlaid on a second key (e.g., 1322a) of the plurality of keys of the keyboard (e.g., 1314) (1418b), such as in FIG. 13A. In some embodiments, in response to receiving the first input, the computer system directs the first input to the second key on which the simulated shadow is overlaid. In some embodiments, in accordance with a determination that a location of the portion (e.g., 1303b) of body of the user in the three-dimensional environment (e.g., 1301) corresponds to a third key (e.g., 1322b) of the plurality of keys of the keyboard, the simulated shadow (e.g., 1324b) is displayed overlaid on the third key (e.g., 1322b) (1418c), such as in FIG. 13A. In some embodiments, the second key is a key at a location corresponding to the location of the portion of the body of the user in the three-dimensional environment. In some embodiments, the second key is a key at a location over which the portion of the body of the user is hovering.

In some embodiments, in accordance with a determination that the location of the portion (e.g., 1303a) of body of the user in the three-dimensional environment (e.g., 1301) corresponds to a fourth key (e.g., 1322a) of the plurality of keys of the keyboard (e.g., 1314), the simulated shadow (e.g., 1324a) is displayed overlaid on the fourth key (e.g., 1322a) (1418d), such as in FIG. 13A. In some embodiments, in response to detecting movement of the portion of the body of the user from the location corresponding to the third key to the location corresponding to the fourth key, the computer system moves the simulated shadow from being overlaid on the third key to being overlaid on the fourth key. Displaying the simulated shadow overlaid on the key to which the location of the portion of the body of the user in the three-dimensional environment corresponds enhances user interactions with the computer system by providing enhanced visual feedback (e.g., indicating to which key an input provided by the portion of the body of the user will be directed).

In some embodiments, such as in FIG. 13A, displaying the three-dimensional environment (e.g., 1301) including the keyboard (e.g., 1320) includes (1420a), displaying, via the display generation component (e.g., 120), a simulated shadow (e.g., 1324a) of the portion (e.g., 1303a) of the body of the user overlaid on a second key (e.g., 1322a) of the plurality of keys of the keyboard (1420b). In some embodiments, the second key is a key that corresponds to a location in the three-dimensional environment of the portion of the body of the user, as described in more detail above. In some embodiments, in accordance with a determination that a location of the portion (e.g., 1303a) of body of the user in the three-dimensional environment (e.g., 1301) is a second distance from the second key (e.g., 1322a), the simulated shadow (e.g., 1324a) is displayed with a visual characteristic (e.g., size, translucency, intensity, color, darkness, saturation, and/or hue) having a first value (1420c), such as in FIG. 13A.

In some embodiments, such as in FIG. 13B, in accordance with a determination that the location of the portion (e.g., 1303c) of body of the user in the three-dimensional environment (e.g., 1301) is a third distance different from the second distance from the second key (e.g., 1322a), the simulated shadow (e.g., 1324c) is displayed with the visual characteristic having a second value different from the first value (1420d). In some embodiments, if the second distance is less than the third distance, displaying the simulated shadow with the visual characteristic having the first value includes displaying the simulated shadow at a smaller size, in a darker color, with more saturation, and/or with less translucency compared to displaying the simulated shadow with the visual characteristic having the second value. Displaying the simulated shadow with the visual characteristic having a value depending on the distance between the location of the portion of the body of the user in the three-dimensional environment and the location of the second key enhances user interactions with the computer system by providing enhanced visual feedback to the user.

In some embodiments, displaying the three-dimensional environment (e.g., 1301) including the keyboard (e.g., 1314) includes concurrently displaying, via the display generation component (e.g., 120) (1422a), a simulated shadow (e.g., 1324a) corresponding to the portion (e.g., 1303a) of the body of the user overlaid on a second key (e.g., 1322a) of the plurality of keys of the keyboard (e.g., 1314) (1422b), such as in FIG. 13A. In some embodiments, the second key is a key that corresponds to a location in the three-dimensional environment of the portion of the body of the user, as described in more detail above. In some embodiments, a simulated shadow (e.g., 1324b) corresponding to a second portion (e.g., 1303b) of the body of the user is overlaid on a third key (e.g., 1322b), different from the second key (e.g., 1322a), of the plurality of keys of the keyboard (e.g., 1314) (1422c), such as in FIG. 13A. In some embodiments, the second portion of the body of the use is a finger of a different hand than the hand including the finger corresponding to the portion of the body of the user. In some embodiments, the simulated shadow corresponding to the second portion of the body of the user has one or more characteristics in common with the simulated shadow corresponding to the portion of the body of the user described above. In some embodiments, the computer system receives and responds to inputs provided by the second portion of the body of the user in the same or similar manners to the manners of receiving and responding to inputs provided by the portion of the body of the user described above. Displaying a simulated shadow corresponding to each of the portion of the body of the user and the second portion of the body of the user enhances user interactions with the computer system by providing enhanced visual feedback to the user.

In some embodiments, in response to receiving the first input, in accordance with the determination that the movement toward the respective key (e.g., 1322a) includes movement to the location that corresponds to the first key (e.g., 1322a) (1424a), such as in FIG. 13B, the computer system (e.g., 101) displays (1424b), via the display generation component (e.g., 120), an animation of a first portion (e.g., 1328a) of the keyboard (e.g., 1314) including the first key (e.g., 1322a), the animation indicating that the first key (e.g., 1322a) was selected, without modifying display of a second portion of the keyboard (e.g., 1314) outside of the first portion (e.g., 1328a) of the keyboard (e.g., 1314), such as in FIG. 13B. In some embodiments, the animation includes a ripple expanding outward from the location of the first key including movement of portion(s) of keys within the first portion of the keyboard. In some embodiments, the first portion of the keyboard includes portion(s) of keys within a threshold distance (e.g., 0.3, 1, 2, 3, 5, or 10 centimeters) of the first key. In some embodiments, in response to detecting concurrent inputs directed to a plurality of keys, the computer system displays animations of multiple portions of the keyboard including the plurality of keys without modifying display of portions of the keyboard outside of the multiple portions of the keyboard including the plurality of keys to which the inputs were directed. Displaying the animation indicating that the first key was selected enhances user interactions with the computer system by providing enhanced visual feedback to the user (e.g., confirming selection of the first key and indicating which key was selected).

In some embodiments, while displaying the three-dimensional environment (e.g., 101) including the keyboard (e.g., 1314) at the first location in the three-dimensional environment (e.g., 101) (1426a), while detecting second movement of the portion (e.g., 1303c) of the body of the user towards a second key (e.g., 1322a), the computer system detects (1426b) movement of a second portion (e.g., 1303d) of the body of the user towards a third key (e.g., 1322b), such as in FIG. 13B. In some embodiments, the portion of the body of the user and the second portion of the body of the user are fingers on different hands of the user.

In some embodiments, in response to detecting the movement of the second portion (e.g., 13030 of the body of the user towards the third key (e.g., 1322b) while detecting the second movement of the portion (e.g., 1303e) of the body of the user (1426c), in accordance with a determination that the second movement of the portion (e.g., 1303e) of the body includes movement to a third location that corresponds to the second key (e.g., 1322a) and is less than the threshold distance from the surface (e.g., 1320) of the keyboard (e.g., 1314), and in accordance with a determination that the movement of the second portion (e.g., 13030 of the body of the user includes movement to a fourth location that corresponds to the third key (e.g., 1322b) and is less than the threshold distance from the surface (e.g., 1320) of the keyboard (1426d), the computer system (e.g., 101) moves (1426e) the second key (e.g., 1322a) and the third key (e.g., 1322b) the second distance toward the surface (e.g., 1320) of the keyboard (e.g., 1314) at the first location in the three-dimensional environment (e.g., 1301), such as in FIG. 13C. In some embodiments, the computer system moves the second key in accordance with the second movement of the portion of the body of the user and the computer system moves the third key in accordance with the movement of the second portion of the body of the user.

In some embodiments, the computer system (e.g., 101) performs (14260 one or more operations corresponding to (e.g., simultaneous or concurrent) selection of the second key (e.g., 1322a) and the third key (e.g., 1322b), such as in FIG. 13C. In some embodiments, the one or more operations include entering one or more characters corresponding to the first and second keys. For example, if the third key corresponds to a first character and the second key corresponds to a second character, the computer system enters the first and second characters in a text entry field. As another example, if the third key corresponds to one of two characters depending on whether the shift key is selected concurrently with the third key and the second key is the shift key, the computer system enters the character corresponding to selection of the third key concurrently with selection of the shift key (e.g., a capital letter or a symbol). In some embodiments, the one or more operations include performing an operation corresponding to a shortcut of the concurrent selection of the second and third keys. In some embodiments, the third key is a modifier key (e.g., control, alt, command, function, or option) other than shift that causes the computer system to perform an operation other than entering the character corresponding to the second key in response to detecting concurrent selection of the third key and the second key. For example, the third key is a command or control key and the second key is the “s” key and, in response to detecting concurrent selection of the third and second keys, the computer system saves a file to which the keyboard focus is directed. In some embodiments, in accordance with a determination that the second movement of the portion of the body of the user includes movement to a respective location further than the threshold distance from the surface of the keyboard and the movement of the second portion of the body of the user includes movement to the fourth location, the computer system performs an operation corresponding to selection of the third key without selection of the second key. In some embodiments, in accordance with a determination that the second movement of the portion of the body of the user includes movement to the third location and the movement of the second portion of the body of the user includes movement to a location greater than the threshold distance from the keyboard, the computer system performs an operation corresponding to selection of the second key without selection of the third key. In some embodiments, in accordance with a determination that the second movement and the movement of the second portion of the body of the user are to locations greater than the threshold distance from the surface of the keyboard, the computer system forgoes performing the functions corresponding to the second key, the third key, or concurrent selection of the second and third keys. Moving the second and third keys and performing the operation corresponding to concurrent selection of the second and third keys in response to detecting the second movement of the portion of the body of the user and the movement of the second portion of the body of the user enhances user interactions with the computer system by providing improved visual feedback to the user.

In some embodiments, the first input is detected while displaying the keyboard (e.g., 1314) in a first mode that does not include displaying a cursor overlaid on the keyboard (e.g., 1314) (1428a), such as in FIG. 13A. In some embodiments, the first mode is a mode for detecting inputs directed to the keyboard that include the user pressing the keys (e.g., while the hands are in pointing hand shapes) without displaying cursor(s) corresponding to the hand(s). In some embodiments, the second mode is a mode for detecting inputs directed to the keyboard that include the user performing gestures with their hands, which are remote from the keys/keyboard, to direct inputs to the keys corresponding to the location(s) of the cursor(s).

In some embodiments, while displaying the keyboard in the first mode, the computer system (e.g., 101) detects (1428b) that one or more criteria associated with displaying the keyboard (e.g., 1314) in a second mode different from the first mode are satisfied, such as in FIG. 13E. In some embodiments, the one or more criteria include a criterion that is satisfied when the computer system detects that an angle between the palms of the user's hands is in a predefined range, as described in more detail below with respect to one or more steps of method 1600. In some embodiments, in response to detecting that the one or more criteria associated with displaying the keyboard (e.g., 1314) in the second mode are satisfied, the computer system (e.g., 101) displays (1428c), via the display generation component (e.g., 120), the keyboard (e.g., 1314) in the three-dimensional environment (e.g., 1301) in the second mode, including displaying, via the display generation component (e.g., 120), a cursor (e.g., 1332a) overlaid on a second key (e.g., 1322a) of the plurality of keys of the keyboard (e.g., 1314) that corresponds to a location of the portion (e.g., 1303h) of the body of the user in the three-dimensional environment (e.g., 1301), such as in FIG. 13E. In some embodiments, the computer maintains display of the keyboard at the first location in the three-dimensional environment while displaying the keyboard in the second mode. In some embodiments, the computer system facilitates interactions with the keyboard in the second mode according to one or more steps of method 1600.

In some embodiments, while displaying the keyboard (e.g., 1314) in the second mode (1428d), such as in FIG. 13E, the computer system (e.g., 101) receives (1428e), via the one or more input devices (e.g., 314), a second input including a gesture performed with the portion (e.g., 1303i) of the body of the user, the second input satisfying one or more criteria. In some embodiments, the gesture is a pinch air gesture described above performed with a hand of the user while the hand is remote from the keys/keyboard. In some embodiments, the second input is an air gesture input described above including a pinch air gesture. In some embodiments, in response to receiving the second input (14280, in accordance with a determination that the second key (e.g., the key over which the cursor is overlaid) is a third key (e.g., 1322b in FIG. 13E) (1428g), the computer system moves (1428h) the third key (e.g., 1322b) toward the surface (e.g., 1320) of the keyboard (e.g., 1314). In some embodiments, the computer system moves the third key toward the surface of the keyboard in response to detecting a portion of the pinch gesture including the user touch their thumb to another finger. In some embodiments, the computer system moves the third key away from the surface of the keyboard in response to detecting a portion of the pinch gesture including the user move their thumb away from the other finger. In some embodiments, the computer system (e.g., 101) performs (1428i) one or more operations corresponding to selection of the third key (e.g., 1322b in FIG. 13E). In some embodiments, the one or more operations corresponding to selection of the third key are one or more of the operations described above with respect to one or more operations corresponding to selection of the first key.

In some embodiments, in accordance with a determination that the second key (e.g., the key over which the cursor is overlaid) is a fourth key (e.g., 1322a in FIG. 13E) (1428j), the computer system (e.g., 101) moves (1428k) the fourth key (e.g., 1322a) toward the surface (e.g., 1320) of the keyboard (e.g., 1314). In some embodiments, the computer system moves the fourth key toward the surface of the keyboard in response to detecting a portion of the pinch gesture including the user touch their thumb to another finger. In some embodiments, the computer system moves the fourth key away from the surface of the keyboard in response to detecting a portion of the pinch gesture including the user move their thumb away from the other finger. In some embodiments, the computer system (e.g., 101) performs (1428l) one or more operations corresponding to selection of the fourth key (e.g., 1322a in FIG. 13E). In some embodiments, the one or more operations corresponding to selection of the fourth key are one or more of the operations described above with respect to one or more operations corresponding to selection of the first key. Transitioning between the first and second keyboard modes as described above enhances user interactions with the computer system by providing additional control options without cluttering the user interface with additional displayed controls.

In some embodiments, displaying a second key (e.g., 1322a) of the plurality of keys of the keyboard (e.g., 1314) the first distance away from the surface (e.g., 1320) of the keyboard (e.g., 1314) is in accordance with a determination that a respective location of the portion (e.g., 1303e) of the body of the user does not satisfy one or more criteria associated with the second key (1322a), such as in FIG. 13C. In some embodiments, as described below, the one or more criteria include a criterion that is satisfied when the portion of the body of the user is within a respective threshold distance of the second key. In some embodiments, the computer system displays a plurality of keys of the keyboard that are greater than the respective threshold distance from the portion of the user at positions that are the first distance from the surface of the keyboard.

In some embodiments, such as in FIG. 13A, in accordance with a determination that the respective location of the portion (e.g., 1303a) of the body of the user satisfies the one or more criteria associated with the second key (e.g., 1322a), including a criterion that is satisfied when the respective location of the portion (e.g., 1303a) of the body of the user is within a threshold distance of a location corresponding to the second key (e.g., 1322a), the computer system (e.g., 101) updates (1430b) the keyboard (e.g., 1314) to display, via the display generation component (e.g., 101), the second key (e.g., 1322a) a third distance from the surface (e.g., 1320) of the keyboard (e.g., 1314), the third distance greater than the first distance. In some embodiments, in response to detecting the portion of the body of the user within the threshold distance of the second key, the computer system moves the second key further from the surface of the keyboard and closer to the portion of the body of the user. In some embodiments, the one or more criteria further include a criterion that is satisfied when the distance between a location corresponding to the second key and the portion of the body of the user is less than the distance between the portion of the body of the user and locations corresponding to a plurality of other keys of the keyboard. In some embodiments, the locations corresponding to the keys of the keyboard are locations having a same distance from the surface of the keyboard at positions within the plane that is the same distance from the surface of the keyboard that correspond to the respective keys. In some embodiments, the one or more criteria include a criterion that is satisfied when the hand of the user is in a predetermined hand shape, such as a pointing hand shape with one or more fingers extended and one or more fingers curled towards the palm or a pre-pinch hand shape in which the thumb is within a threshold distance (e.g., 0.1, 0.2, 0.3, 0.5, 1, 2, or 3 centimeters) of another finger without touching the other finger. Displaying the second key the third distance that is greater than the first distance from the surface of the keyboard in response to detecting the one or more criteria are satisfied enhances user interactions with the computer system by providing improved visual feedback to the user.

In some embodiments, in response to receiving the first input, in accordance with the determination that the movement toward the respective key (e.g., 1322a) includes movement to the location that corresponds to the first key (e.g., 1322a) (1432a), the computer system (e.g., 101) presents (1432b), via one or more output devices in communication with the computer system (e.g., 101), an audio indication (e.g., 1330a) of the selection of the first key, such as in FIG. 13B. In some embodiments, in response to an input that corresponds to selection of a second key different from the first key, as described in more detail above, the computer system presents an audio indication of selection of the second key. In some embodiments, the audio indication of selection of the first key and the audio indication of selection of the second key are the same audio indication. In some embodiments, the audio indication of selection of the first key and the audio indication of selection of the second key are different audio indications. Presenting the audio indication of the selection of the first key in response to the first input enhances user interactions with the computer system by providing enhanced feedback to the user.

In some embodiments, such as in FIG. 13B, the first input is received while the keyboard (e.g., 1314) is in a first mode (1434a). In some embodiments, the first mode (e.g., as described earlier) is a mode in which the computer system accepts inputs such as the first input described above to select keys of the keyboard. In some embodiments, while displaying the three-dimensional environment (e.g., 1501) including the keyboard (e.g., 1514) in a second mode different from the first mode, such as in FIG. 15D, the computer system (e.g., 101) receives (1434b), via the one or more input devices, a second input directed to the respective key (e.g., 1522a), the second input including a gesture performed with the portion (e.g., 1503g) of the body of the user and not including movement of the portion (e.g., 1503g) of the body of the user to a location that corresponds to the respective key (e.g., 1522a). In some embodiments, the second mode (e.g., as described earlier) is a mode in which the computer system accepts inputs directed to the keyboard in accordance with one or more steps of method 1600 described below. In some embodiments, the gesture performed with the portion of the body of the user is a pinch gesture performed with a hand of the user while the hand of the user is remote from the keys/keyboard. In some embodiments, the second input is an air gesture input.

In some embodiments, in response to receiving the second input, in accordance with a determination that the second input satisfies one or more criteria and that the second input is directed to the first key (e.g., 1522a) (1434c), the computer system (e.g., 101) moves (1434d) the first key (e.g., 1522a) toward the surface (e.g., 1520) of the keyboard (e.g., 1514), such as in FIG. 15D. In some embodiments, the second input is directed to the first key when the computer system displays a cursor overlaid on the first key as described above and below with more detail with respect to method 1600 while detecting the second input that satisfies the one or more criteria. In some embodiments, the second input satisfies the one or more criteria in accordance with one or more steps of method 1600. For example, the one or more criteria include detecting a pinch gesture performed with the hand of the user while the cursor is displayed overlaid on the keyboard. In some embodiments, the one or more criteria are satisfied or not satisfied irrespective of whether the portion of the body of the user moves towards the surface of the keyboard while providing the second input.

In some embodiments, the computer system (e.g., 101) performs (1434e) one or more operations corresponding to selection of the first key (e.g., 1522a), such as in FIG. 15D. In some embodiments, the one or more operations corresponding to selection of the first key are the one or more operations corresponding to the first key described above. In some embodiments, such as in FIG. 15D, the computer system (e.g., 101) presents (14340, via the one or more output devices (e.g., 314), a second audio indication (e.g., 1530) of the selection of the first key (e.g., 1522a) that is different from the audio indication of the selection of the first key, such as in FIG. 15D. In some embodiments, in response to detecting a third input in the second mode that satisfies the one or more criteria that is directed to a second key, the computer system presents a third audio indication of selection of the second key that is different from the audio indication of the selection of the first key in the first mode. In some embodiments, the third audio indication and the second audio indication are the same. In some embodiments, the third audio indication and the second indication are different. Presenting the second audio indication of the selection of the first key in response to the second input enhances user interactions with the computer system by providing improved feedback to the user.

In some embodiments, aspects/operations of methods 800, 1000, 1200, 1600, 1800, 2000, 2200, and/or 2400 may be interchanged, substituted, and/or added between these methods. For example, a computer system navigates content created and/or edited using a soft keyboard according to method 1400 by scrolling in accordance with method 800. For example, the computer system edits and/or creates content according to a combination of techniques including voice inputs according to method 1000 and using a soft keyboard according to method 1400. As another example, the computer system displays a soft keyboard in accordance with method 1200 and accepts inputs directed to the soft keyboard in accordance with method 1400. As another example, the computer system transitions between accepting inputs directed to a soft keyboard according to method 1400 and according to method 1600. For brevity, these details are not repeated here.

FIGS. 15A-15F illustrate example techniques of facilitating interactions with a soft keyboard in accordance with some embodiments. The user interfaces in FIGS. 15A-15F are used to illustrate the processes below, including the processes in FIGS. 16A-16K.

FIG. 15A illustrates a computer system 101 displaying, via a display generation component (e.g., display generation component 120 of FIG. 1), a three-dimensional environment 1501 from a viewpoint of the user. FIG. 15A also includes a side view of the three-dimensional environment 1501 in legend 1505. Legend 1505 includes the location of the computer system 101 in the three-dimensional environment 1501 which corresponds to the viewpoint of the user in the three-dimensional environment 1501. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

FIG. 15A illustrates the computer system 101 displaying a web browsing user interface 1502 and a soft keyboard 1514 in a three-dimensional environment 1501. In some embodiments, the web browsing user interface 1502 and soft keyboard 1514 are the same as or similar to web browsing user interfaces and soft keyboards described above with reference to methods 1200 and/or 1400. As shown in FIG. 15A, the web browsing user interface 1502 includes an indication 1504 of the website being displayed in the web browsing user interface 1502, a text entry field 1506 including a cursor 1526a, and an option 1508 to conduct a web search on text entered into the text entry field 1506. For example, the web site being displayed in the web browsing user interface 1502 is an internet search website. In some embodiments, the computer system 101 displays the cursor 1526a in response to a user input directed to the text entry field 1506 corresponding to a request to display the soft keyboard 1514.

In some embodiments, the soft keyboard 1514 includes a backplane 1520 and a plurality of keys, including keys 1522a, 1522b, and 1522c displayed with visual separation from the backplane 1520, as shown in legend 1505. In some embodiments, the computer system 101 displays a user interface element 1516 including a representation 1507 of the text entry field 1506, a repositioning option 1518a, and a resizing option 1518b in association with the soft keyboard 1514. In some embodiments, user interface element 1516 shares one or more characteristics with the user interface elements displayed in association with soft keyboards as described above with reference to methods 1200 and/or 1400.

In FIG. 15A, the computer system 101 is configured to accept direct inputs directed to soft keyboard 1514 in accordance with one or more steps of method 1400 described above. For example, the computer system 101 displays the soft keyboard 1514 without displaying cursors used for cursor-based interaction with the soft keyboard 1514, as will be described in more detail with reference to FIGS. 15B-15F. The computer system 101 displays simulated shadows 1524a and 1524b corresponding to hands 1503a and 1503b overlaid on soft keyboard 1514 in accordance with one or more steps of method 1400.

As described above with reference to method 1400, in some embodiments, in response to detecting the user change the orientation of their hands and/or wrists relative to each other, the computer system 101 initiates display of one or more cursors overlaid on the soft keyboard 1514 and accepts inputs directed to the soft keyboard 1514 that use the cursors. In FIG. 15A, the user changes the relative angles between their palms and/or wrists (e.g., “Hand State B”). For example, the user changes the angle between their palms and/or wrists from the palms and/or wrists being oriented towards the soft keyboard 1514 to being oriented towards each other. Examples of angles between the palms and/or wrists that cause the computer system 101 to transition between the direct input mode of method 1400 and the cursor-based mode of method 1600 are provided below in the descriptions of methods 1400 and 1600 with reference to FIGS. 14A-14J and 16A-16K, respectively. In some embodiments, the hands 1503a and 1503b are the same or a similar distance from the soft keyboard 1514 after the orientation of the wrists have changed (e.g., to provide inputs in accordance with method 1600) as the distance of the hands from the soft keyboard 1514 before the orientation of the wrists changed (e.g., to provide inputs in accordance with method 1400).

FIG. 15B illustrates the computer system 101 displaying the soft keyboard 1514 in the cursor-based input mode, including displaying cursors 1532a and 1532b overlaid on the soft keyboard 1514. In some embodiments, cursor 1532a is displayed in association with the location of hand 1503c over soft keyboard 1514 and cursor 1532b is displayed in association with the location of hand 1503d over soft keyboard 1514. In some embodiments, the computer system 101 displays the cursors 1532a and 1532b with simulated shadows on keys 1522a and 1522b, respectively, that indicate the visual separation between the cursors 1532a and 1532b and the keys 1522a and 1522b, respectively. As shown in legend 1505, the cursors 1532a and 1532b are displayed with visual separation from the keys 1522a and 1522b over which the cursors 1532a and 1532b are overlaid, respectively. Because the cursors 1532a and 1532b are overlaid on keys 1522a and 1522b, the computer system 101 displays keys 1522a and 1522b with increased visual separation from the backplane 1520 of the soft keyboard 1514, compared to the visual separation of other keys over which the cursors 1532a and 1532b are not overlaid, such as key 1522c. In some embodiments, displaying keys 1522a and 1522b with increased visual separation from the backplane 1520 of the soft keyboard 1514 compared to the visual separation of the other keys from the backplane 1520 of the soft keyboard 1514 includes displaying keys 1522a and 1522b at positions closer to the hands 1503c and 1503d and/or the viewpoint of the user than the positions of the other keys relative to the hands 1503c and 1503d and/or the viewpoint of the user. In some embodiments, the computer system 101 facilitates cursor-based interaction with the soft keyboard 1514 while the hands 1503c and 1503d of the user are within the direct input threshold distance described above of the soft keyboard 1514 in the three-dimensional environment 1501.

In some embodiments, the cursors 1532a and 1532b indicate the keys 1522a and 1522b to which input focus of hands 1503c and 1503d are directed, respectively. For example, if the computer system 101 were to detect a selection air gesture, such as a pinch air gesture performed with hand 1503c, the computer system 101 would activate key 1522a because cursor 1532a is displayed overlaid on key 1522a. As another example, if the computer system 101 were to detect a selection air gesture, such as a pinch air gesture performed with hand 1503d, the computer system 101 would activate key 1522b because cursor 1532b is displayed overlaid on key 1522b. In some embodiments, the computer system 101 updates the position(s) of cursor(s) 1532a and/or 1532b in accordance with movement of hand(s) 1503c and/or 1503d, respectively, independent from movement of the gaze of the user or the portion of the three-dimensional environment 1501 to which the gaze of the user is directed. For example, as shown in FIG. 15B, the computer system 101 detects movement of hand 1503d to the left. In response to detecting the movement of hand 1503d, the computer system 101 updates the position of cursor 1532b, as shown in FIG. 15C.

FIG. 15C illustrates the computer system 101 displaying the updated soft keyboard 1514 in accordance with the movement of hand 1503d shown in FIG. 15B. As shown in the legend 1505 of FIG. 15C, while displaying the cursor 1532b overlaid on key 1522d, the computer system 101 increases the visual separation between key 1522d and the backplane 1520 of the keyboard (e.g., updates the position of key 1522d to be closer to the hand 1503f and/or the viewpoint of the user). In some embodiments, because the cursor 1532b is no longer overlaid on key 1522b (e.g., the key over which cursor 1532b is overlaid in FIG. 15B), the computer system 101 decreases the visual separation between key 1522b and the backplane 1520 of the soft keyboard 1514 (e.g., updates the position of key 1522b to be further from hand 1503f and/or the viewpoint of the user).

FIG. 15D illustrates the computer system 101 detecting selection of keys 1522a and 1522b by hands 1503g and 1503h. In some embodiments, the selection input includes detecting a selection air gesture performed by hands 1503g and 1503h, such as a pinch. In some embodiments, the computer system 101 detects the pinch gestures while hands 1503g and 1503h are within the direct input threshold distance described above from the soft keyboard 1514 in the three-dimensional environment 1501. Although FIG. 15D illustrates simultaneous selection of keys 1522a and 1522d, in some embodiments, the computer system detects selection of keys one at a time. In some embodiments, in response to detecting simultaneous selection of keys, the computer system performs a shortcut operation associated with the simultaneous selection of the keys. In some embodiments, such as in FIG. 15D, the computer system enters a sequence of characters corresponding to the keys that are simultaneously selected in response to the selection of the keys.

For example, in FIG. 15D, the computer system enters text 1526c into the text entry field 1506 and displays a representation 1526d of the text in the representation 1507 of the text entry field 1506 in response to detecting the selection of keys 1522a and 1522d. In some embodiments, the text 1526c corresponds to the keys 1522a and 1522d. In some embodiments, in response to detecting the selection of keys 1522a and 1522d, the computer system 101 generates an audio output 1530 indicating selection of the keys 1522a and 1522d. In some embodiments, the audio output 1530 generated in response to cursor-based selection of the keys 1522a and 1522d is different from audio outputs generated in response to direct input selection of keys according to method 1400 described above. In some embodiments, in response to detecting the cursor-based selection of keys 1522a and 1522d, the computer system 101 displays an animation in regions 1528a and 1528b of the soft keyboard 1514, such as a ripple effect originating from keys 1522a and 1522d. In some embodiments, in response to detecting the cursor-based selection of keys 1522a and 1522d, the computer system 101 reduces the amount of visual separation between keys 1522a and 1522d and the backplane 1520 of the soft keyboard 1514, as shown in the legend 1505 of FIG. 15D.

As shown in FIGS. 15E-15F, in some embodiments, the computer system 101 enters a sequence of characters in response to detecting movement of the hand (e.g., air gesture, touch input, or other hand input) 1503d that moves the cursor over a sequence of keys corresponding to the characters. In some embodiments, the movement of the hand (e.g., air gesture, touch input, or other hand input) is detected while the hand 1503d is in a hand shape associated with selection (e.g., a pinch hand shape) (e.g., “Hand State D”) as shown in FIG. 1503d. In FIG. 15E, the computer system 101 detects movement of hand 1503d along a path that corresponds to the cursor 1532b moving over the characters “o,” “r,” “a,” “n,” “g,” and “e.” In some embodiments, while the hand moves over the keys, the computer system 101 increases visual separation between the key over which the cursor 1532b is currently overlaid and the backplane 1520 of the soft keyboard.

As shown in FIG. 15F, in response to the movement of hand 1503d in FIG. 15E, the computer system 101 enters the text “orange” that corresponds to the sequence of keys over which the hand 1503d moved the cursor 1532b into the text entry field 1506 and the representation 1507 of the text entry field 1506 in the user interface element 1516 associated with the soft keyboard 1514. In some embodiments, the computer system 101 becomes configured to enter a sequence of characters in response to movement of the hand (e.g., air gesture, touch input, or other hand input) 1503d in the manner described with reference to FIGS. 15E-15F in response to detecting movement of the hand (e.g., air gesture, touch input, or other hand input) 1503d from being oriented over a first respective key to being oriented over a second respective key (e.g., the beginning of the movement of the hand (e.g., air gesture, touch input, or other hand input) 1503d) while the hand 1503d is in a respective shape, such as the pinch hand shape. In some embodiments, the hand 1503d is the same or a similar distance from the soft keyboard 1514 while providing the input illustrated in FIG. 15E as the distance between hand 1503e and/or 1503f while providing the inputs illustrated in FIG. 15C. Additional descriptions regarding FIGS. 15A-15F are provided below in reference to method 1600 described with respect to FIGS. 15A-15F.

FIG. 16A-16K is a flow diagram of methods of facilitating interactions with a soft keyboard in accordance with some embodiments. In some embodiments, method 1600 is performed at a computer system (e.g., computer system 101 in FIG. 1) including a display generation component (e.g., display generation component 120 in FIGS. 1, 3, and 4) (e.g., a heads-up display, a display, a touchscreen, and/or a projector) and one or more input devices. In some embodiments, the method 1600 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1600 are, optionally, combined and/or the order of some operations is, optionally, changed.

In some embodiments, such as in FIG. 15A, method 1600 is performed at a computer system (e.g., 101) in communication with a display generation component (e.g., 120) and one or more input devices (e.g., 314). In some embodiments, the computer system is the same as or similar to the computer system described above with reference to method(s) 800, 1000, 1200, and/or 1400. In some embodiments, the one or more input devices are the same as or similar to the one or more input devices described above with reference to method(s) 800, 1000, 1200, and/or 1400. In some embodiments, the display generation component is the same as or similar to the display generation component described above with reference to method(s) 800, 1000, 1200, and/or 1400.

In some embodiments, the computer system (e.g., 101) displays (1602a), via the display generation component (e.g., 120), a three-dimensional environment (e.g., 1501) including a keyboard (e.g., 1514) having a plurality of keys (e.g., 1522a and 1522b), wherein the keyboard (e.g., 1514) is displayed at a first location in the three-dimensional environment (e.g., 1501), and the keyboard (e.g., 1514) is displayed without displaying a cursor for selecting one or more keys of the plurality of keys (e.g., 1522a and 1522b), such as in FIG. 15A. In some embodiments, the three-dimensional environment is the same as or similar to the three-dimensional environment described above with reference to method(s) 800, 1000, 1200, and/or 1400. In some embodiments, the keyboard includes one or more details of the keyboards described above with reference to methods 1200 and 1400. In some embodiments, when the keyboard is displayed with the cursor, the computer system moves the cursor in accordance with movement of one or more respective portions of the user of the computer system (e.g., the hand(s) or one or more fingers of the user) and, in response to detecting the user perform a respective gesture with the respective portions of the user (e.g., the pinch gesture), the computer system selects a key at the location of the cursor, as will be described in more detail below. In some embodiments, while displaying the keyboard without displaying the cursor, the computer system detects one or more user inputs directed to the keyboard as described above with reference to method 1400

In some embodiments, while displaying the three-dimensional environment (e.g., 1501) including the keyboard (e.g., 1514) at the first location in the three-dimensional environment (e.g., 1501) without displaying the cursor, such as in FIG. 15A, the computer system (e.g., 101) receives (1602b), via the one or more input devices (e.g., 314), a first input including a change in position of one or more respective portions (e.g., 1503a and 1503b) of a user (e.g., the hand(s) of the user) of the computer system (e.g., 101). In some embodiments, the computer system displays the keyboard without the cursor while the hands of the user are positioned with the palms facing the keyboard or facing down. In some embodiments, the computer system detects the position of the hands of the user change to positions in which the palms are facing each other. In some embodiments, the computer system detects the palms of the user transition from being oriented at an angle (e.g., 180 degrees while both palms face down) relative to each other that is greater than a threshold angle (e.g., 30, 35, 40, 45, 50, 55, or 60 degrees) to an angle (e.g., 0 degrees while both palms face each other and are parallel) relative to each other that is less than the threshold angle. In some embodiments, the computer system does not detect an additional input (e.g., directed to the keyboard) while detecting the change in the positions of the one or more respective portions of the user. In some embodiments, detecting the change in position of the one or more respective portions of the user includes detecting a change in pose and/or orientation of the one or more respective portions of the user without detecting a change in the distance between the one or more respective portions of the user and the keyboard, as will be described in more detail below.

In some embodiments, in response to receiving the first input (1602c), the computer system (e.g., 101) displays (1602d), via the display generation component (e.g., 120), the cursor (e.g., 1532a) overlaid on a portion (e.g., 1522a) of the plurality of keys (e.g., the cursor is displayed between the portion of the plurality of keys and a respective viewpoint of the three-dimensional environment of the user of the computer system) of the keyboard (e.g., 1514), wherein the cursor (e.g., 1532a) indicates a portion (e.g., 1522a) of the plurality of keys that currently has focus, such as in FIG. 15B. In some embodiments, the portion of the plurality of keys that currently has focus is a portion of the plurality of keys at which the user is looking (e.g., detected by an eye tracking device of the one or more input devices). In some embodiments, the portion of the plurality of keys that currently has focus is a portion of the plurality of keys that is closest to the respective portion of the user. In some embodiments, the computer system displays two cursors, including a cursor controlled by the right hand of the user and a cursor controlled by the left hand of the user as described in more detail below. In some embodiments, while displaying the keyboard with the cursor, the computer system detects one or more user inputs directed to the keyboard in manners different from the manners described above with reference to method 1400.

Displaying the cursor in response to detecting the change in position of the one or more respective portions of the user enhances user interactions with the computer system by providing additional control options without cluttering the user interface and providing enhanced visual feedback to the user.

In some embodiments, while displaying, via the display generation component (e.g., 120), the keyboard (e.g., 1514) in the three-dimensional environment (e.g., 1501) and the cursor (e.g., 1532a) overlaid on the portion (e.g., 1522a) of the keyboard (e.g., 1514) (1604a), the computer system (e.g., 101) receives (1604b), via the one or more input devices (e.g., 314), a second input directed to the keyboard (e.g., 1514), including input from the one or more respective portions (e.g., 1503e) of the user, such as in FIG. 15C. In some embodiments, the second input includes a gesture performed with one or more respective portions (e.g., hands) of the user as described in more detail below.

In some embodiments, while displaying, via the display generation component (e.g., 120), the keyboard (e.g., 1514) in the three-dimensional environment (e.g., 1501) and the cursor (e.g., 1532a) overlaid on the portion (e.g., 1522a) of the keyboard (e.g., 1514) (1604a), in response to receiving the second input (1604a), in accordance with a determination that the portion (e.g., 1522a) of the plurality of keys that currently has the focus is a first key (e.g., 1522a) of the plurality of keys (1604d), the computer system (e.g., 101) performs (1604e) a function associated with the first key (e.g., 1522a) of the plurality of keys, such as in FIG. 15D. For example, in response to detecting selection of a key corresponding to a respective character, the computer system enters the respective character into a text entry field associated with the keyboard (e.g., a text entry field to which input focus of the keyboard is currently directed). As another example, in response to detecting selection of a key corresponding to whitespace (e.g., a space bar, a tab key, or an enter key), the computer system enters the respective whitespace into the text entry field. As another example, in response to detecting selection of a plurality of keys corresponding to a keyboard shortcut (e.g., a shortcut to copy, cut, or paste test or a shortcut to save a document), the computer system performs the operation corresponding to the keyboard shortcut.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard (e.g., 1514) (1604a), in accordance with a determination that the portion (e.g., 1522d) of the plurality of keys that currently has the focus is a second key (e.g., 1522d) of the plurality of keys (16040, the computer system (e.g., 101) performs (1604g) a function associated with the second key (e.g., 1522d) of the plurality of keys, such as in FIG. 15D. In some embodiments, the function associated with the second key is one of the functions described above with reference to the function associated with the first key. Directing the second input to the first or second key based on which key currently has the focus enhances user interactions with the computer system by providing improved visual feedback to the user (e.g., by displaying the cursor over the key that currently has the focus).

In some embodiments, while displaying, via the display generation component (e.g., 120), the keyboard (e.g., 1524) in the three-dimensional environment (e.g., 1501) and the cursor (e.g., 1532a) overlaid on the portion (e.g., 1522a) of the keyboard, the portion (e.g., 1522a) of the keyboard (e.g., 1514) corresponding to a respective key (e.g., 1522a) of the plurality of keys (1606a), such as in FIG. 15C, the computer system (e.g., 101) receives (1606b), via the one or more input devices (e.g., 314), a second input directed to the keyboard (e.g., 1514), the second input including a gesture performed by the one or more respective portions (e.g., 1503e) of the user that satisfies one or more criteria, such as in FIG. 15C. In some embodiments, the gesture performed by the one or more respective portions of the user that satisfies the one or more criteria is a pinch gesture performed with the hand of the user while the hand is remote from the keys/keyboard. In some embodiments, the second input is an air gesture input.

In some embodiments, while displaying, via the display generation component (e.g., 120), the keyboard (e.g., 1524) in the three-dimensional environment (e.g., 1501) and the cursor (e.g., 1532a) overlaid on the portion (e.g., 1522a) of the keyboard, the portion (e.g., 1522a) of the keyboard (e.g., 1514) corresponding to a respective key (e.g., 1522a) of the plurality of keys (1606a), such as in FIG. 15C, in response to receiving the second input, the computer system (e.g., 101) performs (1606c) a function associated with the respective key (e.g., 1522a) of the plurality of keys that currently has the focus, such as in FIG. 15D. In some embodiments, as described above, if a first key currently has the focus, the computer system performs a function associated with the first key and if a second key currently has the focus, the computer system performs a function associated with the second key. In some embodiments, the function associated with the respective key is one of the functions described above. Performing the function associated with the respective key that currently has the focus in response to receiving the second input including the gesture performed by the one or more respective portions of the user enhances user interactions with the computer system by providing improved visual feedback to the user (e.g., by indicating the key that currently has the focus with the cursor).

In some embodiments, the cursor (e.g., 1532a) indicates the portion (e.g., 1522a) of the plurality of keys that currently has the focus based on a first portion (e.g., 1503e) of the one or more respective portions of the user, such as in FIG. 15C. In some embodiments, the position of the cursor in the three-dimensional environment corresponds to the position of the first portion of the user (e.g., one of the user's hands). In some embodiments, in response to detecting a selection input (e.g., air gesture, touch input, gaze input or other user input) provided by the first portion of the user, the computer system performs an action associated with a key corresponding to the location of the cursor, as described above.

In some embodiments, in response to receiving the first input (1608b), the computer system (e.g., 101) displays (1608c), via the display generation component (e.g., 120), a second cursor (e.g., 1632b) overlaid on a second portion (e.g., 1522d) of the plurality of keys of the keyboard (e.g., 1524), wherein the second cursor (e.g., 1532b) indicates a second portion (e.g., 1522d) of the plurality of keys that currently has a second focus based on a second portion (e.g., 15030 of the one or more respective portions of the user and the second cursor (e.g., 1532b) is displayed concurrently with the first cursor (e.g., 1532a), such as in FIG. 15C. In some embodiments, the position of the second cursor in the three-dimensional environment corresponds to the position of the second portion of the user (e.g., one of the user's hands different from the hand corresponding to the first portion of the user). In some embodiments, in response to detecting a selection input (e.g., air gesture, touch input, gaze input or other user input) provided by the second portion of the user, the computer system performs an action associated with a key corresponding to the location of the second cursor, in a manner similar to the manner described above with respect to the cursor. In some embodiments, the computer system displays the cursor and the second cursor simultaneously. Displaying the second cursor corresponding to the second portion of the user concurrently with the cursor corresponding to the first portion of the user enhances user interactions with the computer system by enabling the user to select a sequence of keys more quickly using two cursors.

In some embodiments, while displaying, via the display generation component (e.g., 120), the keyboard (e.g., 1514) in the three-dimensional environment (e.g., 1501) and the cursor (e.g., 1532a) overlaid on a first key (e.g., 1522a) of the plurality of keys and a second cursor (e.g., 1532b) overlaid on a second key (e.g., 1522b) of the plurality of keys (1610a), the computer system (e.g., 101) receives (1610b), via the one or more input devices (e.g., 314), a sequence of one or more inputs directed to a respective plurality of keys (e.g., 1522a and 1522d) of the keyboard, including concurrent selection of the first key (e.g., 1522a) and the second key (e.g., 1522d), such as in FIG. 15C. In some embodiments, the cursor corresponds to a first portion of the user and the second cursor corresponds to a second portion of the user as described above. In some embodiments, receiving the sequence of one or more inputs include detecting gestures performed with respective portions of the user as described above.

In some embodiments, while displaying, via the display generation component (e.g., 120), the keyboard (e.g., 1514) in the three-dimensional environment (e.g., 1501) and the cursor (e.g., 1532a) overlaid on a first key (e.g., 1522a) of the plurality of keys and a second cursor (e.g., 1532b) overlaid on a second key (e.g., 1522b) of the plurality of keys (1610a), in response to receiving the sequence of one or more inputs, the computer system (e.g., 101) performs (1610c) one or more functions associated with the respective plurality of keys (e.g., 1522a and 1522d) of the keyboard (e.g., 1514), such as in FIG. 15D. In some embodiments, in response to detecting selection of the first key and selection of the second key at different times, the computer system performs an operation associated with the first key and an operation associated with the second key at different times. In some embodiments, the operations associated with the first and second keys are operations described above. In some embodiments, in response to detecting concurrent selection of the first and second keys, the computer system performs an operation associated with concurrent selection of the first and second keys different from the operation corresponding to the first key and the operation corresponding to the second key. In some embodiments, an operation corresponding to concurrent selection of two or more keys is a keyboard shortcut or entry of a modified character in response to selection of the shift key concurrently with selection of a key corresponding to characters (e.g., a capital letter or a symbol).

Performing one or more functions associated with the respective plurality of keys in response to the sequence of one or more inputs enhances user interactions with the computer system by providing additional control options without cluttering the user interface with additional displayed controls (e.g., keyboard shortcuts or dual-purpose keys).

In some embodiments, the change in position of the one or more respective portions (e.g., 1503a and 1503b) of the user of the computer system (e.g., 101) included in the first input includes a change in a relative orientation between one or more wrists (e.g., one wrist or both wrists) of the user of the computer system (e.g., 101) (1612), such as in FIG. 15A. In some embodiments, the relative orientation between the two wrists of the user includes detecting the user orient their wrists within a threshold angle (e.g., 1, 2, 3, 5, 10, 15, or 30 degrees) of facing each other. In some embodiments, the relative orientation between the two wrists of the user is an orientation when the wrists are angled away from the keyboard by at least a second threshold angle (e.g., 30, 40, 45, 60, or 90 degrees). In some embodiments, detecting the change in relative orientation between the two wrists of the user includes detecting the user orient their wrists as described (e.g., facing each other or facing away from the keyboard) and then orienting the wrists to be facing the keyboard or not facing each other (e.g., within 1, 2, 3, 5, 10, or 15 degrees of parallel to the keyboard or within each other but not facing each other).

Initiating display of the cursor in response to detecting the change in relative orientation between two wrists of the user enhances user interactions with the computer system by providing additional control options without cluttering the user interface with additional displayed controls.

In some embodiments, in response to receiving the first input, the computer system (e.g., 101) displays (1614), via the display generation component (e.g., 120), a simulated shadow of the cursor (e.g., 1532a), wherein the simulated shadow of the cursor is displayed on the portion (e.g., 1522a) of the plurality of keys of the keyboard (e.g., 1514) that currently has focus, such as in FIG. 15B. In some embodiments, the simulated shadow has the same shape as the cursor or a similar shape. In some embodiments, the simulated shadow moves in accordance with movement of the cursor. In some embodiments, the simulated shadow is displayed with a visual characteristic corresponding to a distance between the cursor and the plurality of keys. For example, the further the cursor is from the plurality of keys, the smaller, darker, and/or less translucent the cursor is and the closer the cursor is from the plurality of keys, the larger, lighter, and/or more translucent the cursor is.

Displaying the simulated shadow at the portion of the plurality of keys of the keyboard that currently has focus enhances user interactions with the computer system by providing improved visual feedback to the user.

In some embodiments, while displaying the keyboard (e.g., 1514) and the cursor (e.g., 1532a), the computer system (e.g., 101) displays (1616a), via the display generation component (e.g., 120), a backplane (e.g., 1520) of the keyboard (e.g., 1514), wherein the plurality of keys (e.g., 1522a, 1522b, and 1522c) of the keyboard (e.g., 1514) are overlaid on the backplane (e.g., 1520) of the keyboard (e.g., 1514) in the three-dimensional environment (e.g., 1501), such as in FIG. 15B. In some embodiments, the backplane of the keyboard spans the footprint of the plurality of keys of the keyboard in the three-dimensional environment. In some embodiments, the backplane of the keyboard is the surface of the keyboard described above with reference to methods 1200 and/or 1400.

In some embodiments, in accordance with a determination that the cursor (e.g., 1532a) is overlaid on a first portion (e.g., 1522a) of the plurality of keys and not overlaid on a second portion (e.g., 1522c) of the plurality of keys (1616b), such as in FIG. 15B, the first portion (e.g., 1522a) of the plurality of keys is displayed with a first amount of visual separation from the backplane (e.g., 1520) of the keyboard (1514) (1616c). In some embodiments, the first portion of the plurality of keys are displayed between the viewpoint of the user and the backplane of the keyboard in the three-dimensional environment the first distance from the backplane of the keyboard. In some embodiments, the portion of the plurality of keys is one or more keys.

In some embodiments, in accordance with a determination that the cursor (e.g., 1532a) is overlaid on a first portion (e.g., 1522a) of the plurality of keys and not overlaid on a second portion (e.g., 1522c) of the plurality of keys (1616b), such as in FIG. 15B, the second portion (e.g., 1522c) of the plurality of keys is displayed with a second amount of visual separation from the backplane (e.g., 1520) of the keyboard (e.g., 1514), the second amount of visual separation less than the first amount of visual separation (1616d). In some embodiments, the second portion of the plurality of keys are displayed between the viewpoint of the user and the backplane of the keyboard in the three-dimensional environment the second distance from the backplane of the keyboard.

In some embodiments, in accordance with a determination that the cursor (e.g., 1532b) is overlaid on the second portion (e.g., 1522b) of the plurality of keys and not overlaid on the first portion (e.g., 1522c) of the plurality of keys (1616e), such as in FIG. 15B, the second portion (e.g., 1522b) of the plurality of keys is displayed with the first amount of visual separation from the backplane (e.g., 1520) of the keyboard (e.g., 1514) (16160. In some embodiments, the second portion of the plurality of keys are displayed between the viewpoint of the user and the backplane of the keyboard in the three-dimensional environment the first distance from the backplane of the keyboard.

In some embodiments, in accordance with a determination that the cursor (e.g., 1532b) is overlaid on the second portion (e.g., 1522b) of the plurality of keys and not overlaid on the first portion (e.g., 1522c) of the plurality of keys (1616e), such as in FIG. 15B, the first portion (e.g., 1522c) of the plurality of keys is displayed with the second amount of visual separation from the backplane (e.g., 1520) of the keyboard (e.g., 1514). In some embodiments, the first portion of the plurality of keys are displayed between the viewpoint of the user and the backplane of the keyboard in the three-dimensional environment the second distance from the backplane of the keyboard. In some embodiments, the computer system displays the portion of the keys over which the cursor is overlaid closer to the body of the user and further from the backplane of the keyboard in the three-dimensional environment, compared to display of a portion of keys over which the cursor is not overlaid.

Displaying the portion of the plurality of keys over which the cursor is overlaid further from the backplane of the keyboard compared to the portion of the plurality of keys over which the cursor is not overlaid enhances user interactions with the computer system by providing enhanced visual feedback to the user.

In some embodiments, the portion (e.g., 1522b) of the plurality of keys of the keyboard (e.g., 1514) is based on a location of the one or more respective portions (e.g., 1503d) (e.g., one or more hands) of the user in the three-dimensional environment (e.g., 1501), such as in FIG. 15B. In some embodiments, the cursor is displayed overlaid on a key that is closer to the one or more respective portions of the user than another portion of the plurality of keys. In some embodiments, the computer system updates the position of the cursor in accordance with movement of the portion of the user.

In some embodiments, while displaying the keyboard (e.g., 1514) and the cursor (e.g., 1532b) overlaid on the portion (e.g., 1522b) of the plurality of keys, the computer system (e.g., 101) detects (1618b) movement of the one or more respective portions (e.g., 1503d) of the user from a location in the three-dimensional environment (e.g., 1501) associated with the portion (e.g., 1522b) of the plurality of keys of the keyboard (e.g., 1514) to a location in the three-dimensional environment (e.g., 1501) associated with a second portion of the plurality of keys of the keyboard (e.g., 1514), such as in FIG. 15B. In some embodiments, the one or more respective portions of the user move from a position at which the portion of the plurality of keys are closer to the one or more respective portions of the user than the second portion of the plurality of keys are to a position at which the second portion of the plurality of keys are closer to the one or more respective portions of the user than the portion of the plurality of keys are.

In some embodiments, in response to detecting the movement of the one or more respective portions (e.g., 1503d) of the user, such as in FIG. 15B (1618c), the computer system (e.g., 101) updates (1618d) the three-dimensional environment (e.g., 1501) to display, via the display generation component (e.g., 120), the cursor (e.g., 1532b) overlaid on the second portion (e.g., 1522d) of the plurality of keys without displaying the cursor (e.g., 1532b) overlaid on the portion of the plurality of keys, such as in FIG. 15C. In some embodiments, the computer system updates the position of the cursor in the three-dimensional environment in accordance with movement of the one or more respective portions of the user. In some embodiments, movement of the cursor in accordance with movement of the one or more respective portions of the user is irrespective of a location in the three-dimensional environment at which the user is looking. Updating the location of the cursor in the three-dimensional environment in accordance with movement of the one or more respective portions of the user enhances user interactions with the computer system by providing additional control options without cluttering the user interface with additional displayed controls.

In some embodiments, while displaying, via the display generation component (e.g., 120), the keyboard (e.g., 1515) in the three-dimensional environment (e.g., 1501) and the cursor (e.g., 1532b) overlaid on the portion (e.g., 1522b) of the keyboard (e.g., 1514), such as in FIG. 15E (1620a), the computer system (e.g., 101) receives (1620b), via the one or more input devices (e.g., 314), a sequence of one or more inputs that includes detecting movement of the one or more respective portions (e.g., 1503d) of the user through a sequence of locations associated with a respective set of the plurality of keys while the one or more respective portions (e.g., 1503d) of the user are in a predefined shape, such as in FIG. 15E. In some embodiments, receiving the sequence of one or more inputs includes detecting the user make a pinch shape (e.g., touching another finger with the thumb of the hand) with their hand and move their hand through a sequence of locations corresponding to keys of the keyboard, followed by releasing their hand from the pinch shape (e.g., moving the thumb away from the other finger) while the hand is remote from the keys/keyboard. In some embodiments, the sequence of one or more inputs includes one or more air gesture inputs.

In some embodiments, while displaying, via the display generation component (e.g., 120), the keyboard (e.g., 1515) in the three-dimensional environment (e.g., 1501) and the cursor (e.g., 1532b) overlaid on the portion (e.g., 1522b) of the keyboard (e.g., 1514), such as in FIG. 15E (1620a), in response to receiving the second input, the computer system (e.g., 101) performs (1620c) an operation associated with the respective set of the plurality of keys, such as in FIG. 15F. In some embodiments, the computer system enters a sequence of characters corresponding to the respective set of the plurality of keys. In some embodiments, the sequence of characters is in an order corresponding to the order in which the one or more respective portions of the user moved to locations corresponding to respective keys in the respective set of the plurality of keys corresponding to the characters in the sequence. For example, if the user moves their hand in a pinch shape to cause movement of the cursor over the “c” key, then the “a” key, then the “t” key and then releases their hand from the pinch shape, the computer system enters “cat” into a text entry field to which the keyboard focus is directed. In some embodiments, the computer system determines a sequence of keys corresponding to the movement of the respective portion of the user based on timing and location of the movement of the respective portion of the user while providing the second input. For example, the computer system detects the respective portion of the user pausing at a sequence of locations corresponding to a plurality of keys of the soft keyboard while moving within a threshold distance (e.g., an air gesture threshold distance) of the soft keyboard and performs operations corresponding to the sequence of locations corresponding to the plurality of keys. In some embodiments, the computer system uses a language model based on previously-entered text, the context of the text entry field, and optionally other factors in addition to the location and timing of movement of the respective portion of the user to determine the sequence of operations to perform (e.g., a sequence of characters to input into a text entry field). For example, the computer system matches the movement of the respective portion of the user to multiple possible sequences of characters and inputs a sequence that satisfies one or more criteria, such as being a word included in a dictionary and/or having a relatively high likelihood of being input after previously-input text.

Performing the operation associated with the respective set of the plurality of keys at locations corresponding to the sequence of locations the one or more respective portions of the user moved through while in the predefined shape enhances user interactions with the computer system by providing additional control options without cluttering the user interface with additional displayed controls.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard, such as in FIG. 15C (1622a), the computer system (e.g., 101) receives (1622b), via the one or more input devices (e.g., 314), a second input directed to the portion (e.g., 1522d) of the plurality of keys of the keyboard (e.g., 1514), such as in FIG. 15C. In some embodiments, the second input corresponds to a request to select the portion of the plurality of keys of the keyboard according to one or more of the techniques disclosed above. In some embodiments, the computer system performs an operation associated with the portion of the plurality of keys of the keyboard in response to receiving the second input.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard, such as in FIG. 15C (1622a),

In response to receiving the second input, the computer system (e.g., 101) displays (1622c), via the display generation component (e.g., 120), an animation of a second portion (e.g., 1528b) of the keyboard including the portion (e.g., 1522d) of the plurality of keys of the keyboard (e.g., 1514), the animation indicating that the portion (e.g., 1522d) of the plurality of keys was selected, without modifying display of a third portion of the keyboard (e.g., 1514) outside of the second portion (e.g., 1528b) of the keyboard (e.g., 1514), such as in FIG. 15D. In some embodiments, the animation includes a ripple expanding outward from the location of the portion of the plurality of keys of the keyboard including movement of portion(s) of keys within the second portion of the keyboard. In some embodiments, the second portion of the keyboard includes portion(s) of keys within a threshold distance (e.g., 0.3, 1, 2, 3, 5, or 10 centimeters) of the portion of the plurality of keys of the keyboard. In some embodiments, the third portion of the keyboard includes portion(s) of the keys outside of the threshold distance of the portion of the plurality of keys of the keyboard. In some embodiments, in response to detecting concurrent inputs directed to multiple portions of the plurality of keys, the computer system displays animations of portions of the keyboard including the portions of the plurality of keys without modifying display of portions of the keyboard outside of the portions of the keyboard including the portions of the plurality of keys to which the inputs were directed.

Displaying the animation indicating that the portion of the plurality of keys was selected enhances user interactions with the computer system by providing enhanced visual feedback to the user (e.g., confirming selection of the portion of the plurality of keys and indicating which portion of the plurality of keys was selected).

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522b) of the keyboard, such as in FIG. 15B (1624a), the computer system (e.g., 101) receives (1624b), via the one or more input devices (e.g., 314), a second input corresponding to a request to change an input mode of the keyboard (e.g., 1514) from a cursor input mode to a non-cursor input mode, such as in FIG. 15A. In some embodiments, the one or more criteria for receiving the second input are the same as the one or more criteria for receiving the first input. For example, receiving the first input includes detecting a change in relative orientation between the user's wrists as described above and receiving the second input also includes detecting the change in relative orientation between the user's wrists. In some embodiments, the first input includes a change in orientation in a first direction, and the second input includes a change in orientation in a second direction (e.g., opposite the first direction). In some embodiments, the second input is an implicit input in which the user transitions from providing indirect air gesture inputs in the cursor input mode to providing direct air gesture inputs in the non-cursor input mode.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522b) of the keyboard, such as in FIG. 15B (1624a),

in response to receiving the second input, the computer system (e.g., 101) maintains (1624c) display, via the display generation component (e.g., 120), of the keyboard (e.g., 1514) and ceases display, via the display generation component (e.g., 120), of the cursor, such as in FIG. 15A. In some embodiments, while the computer system displays the keyboard without displaying the cursor, the computer system facilitates interactions with the keyboard according to one or more steps of method 1400 described above. Transitioning from displaying the keyboard with the cursor to displaying the keyboard without the cursor in response to detecting the second input enhances user interactions with the computer system by providing additional control options without cluttering the user interface with additional displayed controls.

In some embodiments, such as in FIG. 15A, receiving the second input includes detecting, via the one or more input devices (e.g., 314), a change in an orientation of one or more wrists of the user of the computer system (e.g., 101) (1626). In some embodiments, the change in the orientation of the wrist of the user included in the second input is the same as or similar to the change in relative orientation between two wrists of the user included in the first input described above. In some embodiments, the change in the orientation of the wrist included in the second input is a change from the wrists being more than a threshold angle (e.g., 530, 45, 60, or 80 degrees) relative to the keyboard to being less than the threshold angle relative to the keyboard. Transitioning from displaying the keyboard with the cursor to displaying the keyboard without the cursor in response to detecting the change in the orientation of the wrist of the user enhances user interactions with the computer system by providing additional control options without cluttering the user interface with additional displayed controls.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard (e.g., 1514), such as in FIG. 15C (1628a), the computer system (e.g., 101) receives (1624b), via the one or more input devices (e.g., 314), a second input directed to the keyboard (e.g., 314), such as in FIG. 15C. In some embodiments, the second input corresponds to a request to select the portion of the plurality of keys on which the cursor is overlaid as described above. For example, receiving the second input includes detecting a pinch gesture performed by a hand of the user.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard (e.g., 1514), such as in FIG. 15C (1628a), in response to receiving the second input (1628c), the computer system (e.g., 101) activates (1628d) the portion (e.g., 1522d) of the plurality of keys that currently has the focus, such as in FIG. 15D. In some embodiments, activating the portion of the plurality of keys that currently has the focus includes performing one or more operations associated with the portion of the plurality of keys and/or updating the position of the portion of the plurality of keys to move closer to a backplane of the keyboard.

In some embodiments, while displaying, via the display generation component (e.g., 120), the keyboard (e.g., 1514) in the three-dimensional environment (e.g., 1501) and the cursor (e.g., 1532b) overlaid on the portion (e.g., 1522d) of the keyboard (e.g., 1514), such as in FIG. 15C (1628a), in response to receiving the second input (1628c), the computer system (e.g., 101) generates (1628e), via one or more output devices in communication with the computer system (e.g., 101), a first audio indication (e.g., 1530) corresponding to selection of the portion (e.g., 1522d) of the plurality of keys, such as in FIG. 15D. In some embodiments, in response to detecting a third input corresponding to a request to activate a second portion of the plurality of keys while displaying the keyboard and the cursor, the computer system activates the second portion of the plurality of keys and generates a second audio indication. In some embodiments, the second audio indication is the same as the first audio indication. In some embodiments, the second audio indication is different from the first audio indication. Presenting the first audio indication in response to receiving the second input enhances user interactions with the computer system by providing enhanced feedback to the user.

In some embodiments, while displaying the keyboard (e.g., 1514) in the three-dimensional environment (e.g., 1501) without displaying the cursor, such as in FIG. 15A (1630a), the computer system (e.g., 101) detects (1630b), via the one or more input devices (e.g., 314), a third input directed to the portion (e.g., 1322a) of the plurality of keys of the keyboard (e.g., 1314), such as in FIG. 13A. In some embodiments, the third input is an input corresponding to a request to activate the portion of the plurality of keys according to one or more steps of method 1400. In some embodiments, the third input is a direct input for selecting a key, and not an input for selecting a key based on a cursor position corresponding to that key.

In some embodiments, while displaying the keyboard (e.g., 1514) in the three-dimensional environment (e.g., 1501) without displaying the cursor, such as in FIG. 15A (1630a), in response to receiving the third input (1630c), the computer system (e.g., 101) activates (1630d) the portion (e.g., 1322a) of the plurality of keys of the keyboard (e.g., 1314), such as in FIG. 13B. In some embodiments, activating the portion of the plurality of keys of the keyboard in response to the third input includes performing one or more functions associated with the plurality of keys (e.g., the same functions that would be performed in response to the second input described above) and moving the portion of the plurality of keys towards a backplane of the keyboard.

In some embodiments, while displaying the keyboard (e.g., 1514) in the three-dimensional environment (e.g., 1501) without displaying the cursor, such as in FIG. 15A (1630a), in response to receiving the third input (1630c), the computer system (e.g., 101) generates (1630e), via the one or more output devices in communication with the computer system (e.g., 101), a second audio indication (e.g., 1330a) different from the first audio indication corresponding to selection of the portion of the plurality of keys, such as in FIG. 13B. In some embodiments, in response to detecting a fourth input directed to a second portion of the plurality of keys corresponding to a request to activate the second portion of the plurality of keys while the computer system displays the keyboard without the cursor in the three-dimensional environment, the computer system generates a third audio indication different from the first audio indication corresponding to selection of the second portion of the plurality of keys. In some embodiments, the second audio indication and third audio indication are the same. In some embodiments, the second audio indication and the third audio indication are different.

Presenting the second audio indication in response to receiving the third input enhances user interactions with the computer system by providing enhanced feedback to the user.

In some embodiments, while displaying, via the display generation component (e.g., 120), the keyboard (e.g., 1514) in the three-dimensional environment (e.g., 1501) without displaying the cursor, such as in FIG. 15A (1632a), the computer system (e.g., 101) receives (1632b), via the one or more input devices, a second input directed to a second portion of the plurality of keys of the keyboard (e.g., 1514), the second input provided by the one or more respective portions (e.g., 1503a and 1503b) of the user. In some embodiments, while displaying the keyboard in the three-dimensional environment without displaying the cursor, the computer system facilitates interactions with the keyboard according to one or more steps of method 1400 described above.

In some embodiments, while displaying, via the display generation component (e.g., 120), the keyboard (e.g., 1514) in the three-dimensional environment (e.g., 1501) without displaying the cursor, such as in FIG. 15A (1632a), in response to receiving the second input (1632c), in accordance with a determination that the second input includes the one or more respective portions (e.g., 1503a or 1503b) of the user within a threshold distance (e.g., 0.5, 1, 2, 3, 5, 10, 15, or 30 centimeters) of the keyboard (e.g., 1514), the computer system (e.g., 101) performs (1632d) an operation associated with the second portion of the plurality of keys. In some embodiments, the second input is a direct input. In some embodiments, the threshold distance is a distance associated with direct inputs. In some embodiments, the operation associated with the second portion of the plurality of keys is one of the operations associated with keyboard keys described herein with respect to methods 1200, 1400, or 1600.

In some embodiments, while displaying, via the display generation component (e.g., 120), the keyboard (e.g., 1514) in the three-dimensional environment (e.g., 1501) without displaying the cursor, such as in FIG. 15A (1632a), in response to receiving the second input (1632c), in accordance with a determination that the second input includes the one or more respective portions (e.g., 1503a or 1503b) of the user further than the threshold distance from the keyboard (e.g., 1514), the computer system (e.g., 101) forgoes (1632e) performing the operation associated with the second portion of the plurality of keys. In some embodiments, the computer system forgoes performing interactions in response to direct inputs received while the one or more portions of the user are further than the threshold distance from the object to which the direct input is directed.

In some embodiments, while displaying, via the display generation component (e.g., 101), the keyboard (e.g., 1514) in the three-dimensional environment (e.g., 1501) with the cursor (e.g., 1532a) overlaid on the portion of the plurality of keys (15320, the computer system (e.g., 101) receives (1632g), via the one or more input devices (e.g., 314), a third input directed to the keyboard (e.g., 1514), the third input provided by the one or more respective portions (e.g., 1503e) of the user while the one or more respective portions (e.g., 1503e) of the user are within the threshold distance of the keyboard (e.g., 1514), such as in FIG. 15C. In some embodiments, the third input includes a pinch gesture performed with the user's hand, as described above.

In some embodiments, while displaying, via the display generation component (e.g., 101), the keyboard (e.g., 1514) in the three-dimensional environment (e.g., 1501) with the cursor (e.g., 1532a) overlaid on the portion of the plurality of keys (15320, in response to receiving the third input, the computer system (e.g., 101) performs (1632h) an operation associated with the portion (e.g., 1522a) of the plurality of keys of the keyboard (e.g., 1514), such as in FIG. 15D. In some embodiments, the operation associated with the portion of the plurality of keys of the keyboard is one of the operations associated with keyboard keys described herein with respect to methods 1200, 1400, or 1600. In some embodiments, while displaying the keyboard with the cursor, the computer system performs the operation associated with the portion of the plurality of keys of the keyboard in response to detecting a fourth input provided by the one or more respective portions of the user while the one or more respective portions of the user are further than the threshold distance from the keyboard. In some embodiments, while displaying the keyboard with the cursor, the computer system forgoes performing the operation associated with the portion of the plurality of keys of the keyboard in response to detecting a fourth input provided by the one or more respective portions of the user while the one or more respective portions of the user are further than the threshold distance from the keyboard. In some embodiments, the computer system accepts inputs directed to the keyboard via the cursor while the hands of the user are within the direct input threshold distance of the keyboard and/or keys. Performing the operation associated with the portion of the plurality of keys in response to receiving the third input provided by the one or more respective portions of the user while the one or more respective portions of the user are within the threshold distance of the keyboard while displaying the keyboard without the cursor enhances user interactions with the computer system by reducing the number of inputs needed to perform an operation.

In some embodiments, aspects/operations of methods 800, 1000, 1200, 1400, 1800, 2000, 2200, and/or 2400 may be interchanged, substituted, and/or added between these methods. For example, a computer system navigates content created and/or edited using a soft keyboard according to method 1600 by scrolling in accordance with method 800. For example, the computer system edits and/or creates content according to a combination of techniques including voice inputs according to method 1000 and using a soft keyboard according to method 1600. As another example, the computer system displays a soft keyboard in accordance with method 1200 and accepts inputs directed to the soft keyboard in accordance with method 1600. As another example, the computer system transitions between accepting inputs directed to a soft keyboard according to method 1400 and according to method 1600. For brevity, these details are not repeated here.

FIGS. 17A-17F illustrate examples of a computer system 101 facilitating interactions with a cursor in accordance with some embodiments. The user interfaces in FIGS. 17A-17F are used to illustrate the processes described below, including the processes in FIGS. 18A-18E.

FIG. 17A illustrates a computer system 101 displaying, via a display generation component (e.g., display generation component 120 of FIG. 1), a three-dimensional environment 1701 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

FIG. 17A illustrates a computer system 101 displaying a cursor 1704 in a user interface 1702. In some embodiments, the computer system 101 displays the cursor 1704 with a simulated shadow over the user interface 1702, indicating visual separation between the cursor and the user interface 1702 and optionally indicating that cursor 1704 is not currently being selected (or being used to make a selection input such as by using an air gesture). In some embodiments, the cursor 1704 is displayed within a region 1706a of the user interface 1702 to which the gaze 1713a of the user is directed. In some embodiments, the computer system 101 detects the location of the gaze 1713a of the user via one or more input devices (e.g., image sensors 314). In some embodiments, the computer system performs a smoothing algorithm on the location of the gaze to reduce jitter when controlling cursor 1704 movement based at least in part on the gaze 1713a of the user. In some embodiments, as will be described herein with reference to FIGS. 17A-17F, the user interface 1702 is a drawing user interface in which the user is able to create drawings based on movement of cursor 1704. In some embodiments, one or more techniques described herein apply to other types of user interfaces, such as user interfaces including selectable options that are selectable via the cursor 1704, such as communication user interfaces, content user interfaces, and the like.

As shown in FIG. 17A, the computer system detects movement of the hand (e.g., air gesture, touch input, or other hand input) 1703a of the user while the hand 1703a is in the ready state (e.g., “Hand State B”), such as an indirect ready state, or in another shape or pose not associated with making a selection with cursor 1704 while the gaze 1713a of the user is directed to the region 1706a of the user interface 1702 including the cursor 1704. In some embodiments, in response to the movement of hand 1703a and the gaze 1713a within region 1706a illustrated in FIG. 17A, the computer system 101 updates the position of cursor 1704 in accordance with the movement of the hand (e.g., air gesture, touch input, or other hand input) 1703a, as shown in FIG. 17B.

FIG. 17B illustrates the computer system 101 displaying the cursor 1704 at the updated position within region 1706a of the user interface 1702 in response to the input illustrated in FIG. 17A. In some embodiments, the computer system 101 moves the cursor 1704 within region 1706a because the gaze 1713a is directed to region 1706a while the movement of hand 1703a is detected. In some embodiments, if the movement of hand 1703a in FIG. 17A corresponded to moving the cursor 1704 past the boundary of region 1706a, the computer system 101 would display the cursor 1704 on or at the boundary of region 1706a (e.g., in the direction of the movement of hand 1703a).

As shown in FIG. 17B, while the computer system 101 displays the cursor 1704 in region 1706a of the user interface 1702, the computer system 101 detects the gaze 1713b of the user directed outside of the region 1706a without detecting movement of hand 1703b. In some embodiments, because the computer system 101 did not detect movement of the hand (e.g., air gesture, touch input, or other hand input) 1703b, the computer system 101 maintains display of the cursor 1704 at the location illustrated in FIG. 17B, as shown in FIG. 17C. In some embodiments, the computer system maintains display of the cursor 1704 at its respective location in the user interface 1702 in response to detecting movement of the hand (e.g., air gesture, touch input, or other hand input) 1703b that is less than a threshold amount of movement. Example threshold amounts of movement are provided below in the description of method 1800 with reference to FIGS. 18A-18E.

FIG. 17C illustrates the computer system 101 maintaining display of the cursor 1704 at the location at which the cursor was displayed in FIG. 17B. The computer system 101 detects the gaze 1713c of the user directed outside of the region 1706a of the user interface 1702 in which cursor 1704 is displayed and movement of the hand (e.g., air gesture, touch input, or other hand input) 1703c of the user in a direction that corresponds to the movement of the gaze 1713c of the user from region 1706a to the location shown in FIG. 17C. In some embodiments, the hand 1703c of the user is in the ready state (e.g., “Hand State B”) while the computer system 101 detects the movement of the hand (e.g., air gesture, touch input, or other hand input) shown in FIG. 17C. In some embodiments, because the hand 1703c of the user is in the ready state while moving, the computer system 101 updates the position of cursor 1704 as shown in FIG. 17D without making a drawing from the location of the cursor 1704 in FIG. 17C to the updated position of the cursor 1704 in FIG. 17D in the user interface 1702.

FIG. 17D illustrates the computer system 101 displaying the cursor 1704 at an updated position in the user interface 1702 in response to the input illustrated in FIG. 17D. The computer system 101 displays the cursor 1704 proximate to the location of the gaze 1713d of the user in the user interface 1702 and defines a new region 1706b in which the user is able to move the cursor 1704 based on hand movement (e.g., air gesture, touch input, or other hand input) in some embodiments. For example, in response to detecting a hand movement (e.g., air gesture, touch input, or other hand input) similar to the hand movement (e.g., air gesture, touch input, or other hand input) illustrated in FIG. 17A, the computer system 101 moves the cursor 1704 within the region 1706b in a manner similar to the manner illustrated in FIG. 17B with respect to region 1706a.

As shown in FIG. 17D, the computer system 101 detects movement of the hand (e.g., air gesture, touch input, or other hand input) 1703d of the user while the hand 1703d is in a selection hand shape (e.g., “Hand State C”), such as making a pinch hand shape in which the thumb touches or is within a threshold distance (e.g., 0.1, 0.2, 0.3, 0.5, 1 or 2 centimeters) of touching another finger on the hand 1703d while the gaze 1713d of the user is directed to the region 1706b of the user interface 1702 in which the cursor 1704 is displayed. In some embodiments, in response to detecting the input illustrated in FIG. 17D, the computer system 101 displays a drawing in the user interface 1702 that corresponds to the movement of hand 1703d, as shown in FIG. 17E.

FIG. 17E illustrates the computer system 101 displaying a drawing 1708 that corresponds to the movement of the cursor in response to the input illustrated in FIG. 17D. In some embodiments, the drawing 1708 includes contours corresponding to movement of the hand (e.g., air gesture, touch input, or other hand input) 1703d in FIG. 17D while the input is being provided. As shown in FIG. 17E, the computer system 101 displays the cursor 1704 without a virtual shadow, indicating reduced visual separation (e.g., no visual separation) between the cursor 1704 and the user interface 1702 while the drawing input is being provided. In some embodiments, reducing the visual separation between the cursor 1704 and the user interface 1702 includes updating the position of the cursor 1704 in the three-dimensional environment 1701 to be further from the hand 1703e and/or the viewpoint of the user than the position of the cursor 1704. In some embodiments, the computer system 101 moves the cursor 1704 by a smaller amount and/or applies a damping effect to the movement of the cursor 1704 while the user is providing a drawing input such as in FIG. 17D compared to the amount of movement of the cursor 1704 while moving the cursor 1704 without drawing such as in response to the input illustrated in FIG. 17A. For example, if the computer system 101 detects the same amount of movement of the hand (e.g., air gesture, touch input, or other hand input) of the user during a drawing input as the amount of movement of the hand (e.g., air gesture, touch input, or other hand input) during an input to move the cursor without drawing, the movement of the cursor in response to the drawing input will be less than the movement of the cursor in response to the non-drawing input.

As shown in FIG. 17E, the computer system 101 detects movement of the hand (e.g., air gesture, touch input, or other hand input) 1703e of the user while the hand 1703e is in the selection input shape described above (e.g., “Hand State C”) while the gaze 1713e of the user is directed outside of the region 1706b of the user interface 1702 in which the cursor 1704 is displayed. The movement of the hand (e.g., air gesture, touch input, or other hand input) 1703e in FIG. 17E is in the same direction as movement of the gaze 1713e of the user from the region 1706b of the cursor 1704 to the location of the gaze 1713e in FIG. 17E. In some embodiments, in response to the input illustrated in FIG. 17E, the computer system 101 updates the position of the cursor 1704 and displays a drawing including a portion of the drawing that connects the location of the cursor 1704 in FIG. 17E to the location of the cursor 1704 in FIG. 17F, as shown in FIG. 17F. In some embodiments, the computer system 101 forgoes moving the cursor 1704 outside of region 1706b and forgoes updating the drawing 1708 in response to the input illustrated in FIG. 17E and, more generally, does not move the cursor 1704 outside of region 1706b in response to inputs received while the user is drawing with the cursor 1704.

FIG. 17F illustrates the computer system 101 displaying the cursor 1704 at the updated location in the user interface 1702 and the updated drawing 1708 in response to the input illustrated in FIG. 17E. As shown in FIG. 17F, the drawing 1708 is updated to include a portion from the location of the cursor 1704 in FIG. 17E to the location of the cursor 1704 in FIG. 17F. In some embodiments, the computer system 101 updates the location of the cursor 1704 to a location proximate to the gaze 1713f of the user and defines a region 1706c of the user interface 1702 in which the user is able to move the cursor 1704 based on hand 1703f movement in a manner similar to the manner described above with reference to FIGS. 17A-17B. In some embodiments, the computer system 101 continues to add to drawing 1708 in response to movement of the hand (e.g., air gesture, touch input, or other hand input) 1703f while the hand 1703f is in the selection hand shape (e.g., “Hand State C”) and ceases updating the drawing 1708 in response to detecting the hand 1703f no longer making the selection hand shape. Additional descriptions regarding FIGS. 17A-17F are provided below in reference to method 1800 described with respect to FIGS. 17A-17F.

FIGS. 18A-18E is a flow diagram of methods of facilitating interactions with a cursor in accordance with some embodiments. In some embodiments, method 1800 is performed at a computer system (e.g., computer system 101 in FIG. 1) including a display generation component (e.g., display generation component 120 in FIGS. 1, 3, and 4) (e.g., a heads-up display, a display, a touchscreen, and/or a projector) and one or more cameras input devices. In some embodiments, the method 1800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 1800 are, optionally, combined and/or the order of some operations is, optionally, changed.

In some embodiments, such as in FIG. 17A, method 1800 is performed at a computer system (e.g., 101) in communication with a display generation component (e.g., 120) and one or more input devices (e.g., 314). In some embodiments, the computer system is the same as or similar to the computer system described above with reference to method(s) 800, 1000, 1200, 1400, and/or 1600. In some embodiments, the one or more input devices are the same as or similar to the one or more input devices described above with reference to method(s) 800, 1000, 1200, 1400, and/or 1600. In some embodiments, the display generation component is the same as or similar to the display generation component described above with reference to method(s) 800, 1000, 1200, 1400, and/or 1600.

In some embodiments, such as in FIG. 17A, the computer system (e.g., 101) displays (1802a), via the display generation component (e.g., 120), a three-dimensional environment (e.g., 1701) including a first region (e.g., 1706a) including a cursor (1704). In some embodiments, the three-dimensional environment is the same as or similar to the three-dimensional environment described above with reference to method(s) 800, 1000, 1200, 1400, and/or 1600. In some embodiments, the cursor includes one or more features of the cursor described above with reference to method 1600. In some embodiments, the computer system displays the cursor in the first region of the three-dimensional environment in accordance with a determination that the gaze of the user is directed to the first region. In some embodiments, the computer system updates the position of the cursor based on the position and/or movement of a respective portion of the user (e.g., the user's hand(s) and or finger(s)) and/or the gaze of the user, as described in more detail below).

In some embodiments, such as in FIG. 17A, the computer system (e.g., 101) detects (1802b), via the one or more input devices (e.g., 314), first movement of a respective portion (e.g., 1703a) of the user (e.g., hand(s) and/or finger(s) of the user); In some embodiments, the respective portion of the user is in a predefined shape while the movement is detected, such as the hand of the user being in the pinch hand shape or in a pre-pinch hand shape in which the thumb is within a threshold distance (e.g., 0.1, 0.2, 0.3, 0.5, 1, 2, 3, 4, or 5 centimeters) of, but not touching, another finger of the hand. In some embodiments, the first region and the cursor are within a user interface (e.g., of an application or of the operating system of the computer system) displayed in the three-dimensional environment.

In some embodiments, in response to detecting the first movement of the respective portion (e.g., 1703a) of the user (1802c), in accordance with a determination that attention (e.g., 1713a) of the user is directed to the first region (e.g., 1706a) of the three-dimensional environment (e.g., 1701) when the first movement of the respective portion (e.g., 1703a) of the user is detected, such as in FIG. 17A, the computer system (e.g., 101) moves (1802d) the cursor (e.g., 1704) in accordance with the first movement of the respective portion of the user while constraining movement of the cursor to the first region (e.g., 1706a), such as in FIG. 17B. In some embodiments, the direction of the movement of the cursor is based on the direction of the movement of the respective portion of the user. For example, in response to detecting movement of the respective portion of the user in a first direction, the computer system moves the cursor in the first direction and in response to detecting movement of the respective portion of the user in a second direction, the computer system moves the cursor in the second direction. In some embodiments, the amount of movement of the cursor is based on an amount (e.g., distance, duration, and/or speed) of movement of the respective portion of the user. For example, in response to detecting a first amount (e.g., distance, duration, and/or speed) of movement of the respective portion of the user, the computer system moves the cursor by a second amount and in response to detecting a third amount (e.g., distance, duration, and/or speed) of movement of the respective portion of the user less than the first amount, the computer system moves the cursor by a fourth amount that is less than the second amount. In some embodiments, displaying movement of the cursor includes displaying an animation of the cursor moving in accordance with the movement of the respective portion of the user. In some embodiments, displaying movement of the cursor includes ceasing to display the cursor at a first location and initiating display of the cursor at a second location in accordance with the movement of the respective portion of the user (e.g., at regular time intervals and/or in response to detecting the respective portion of the user stop moving).

In some embodiments, in response to detecting the first movement of the respective portion of the user (1802c), in accordance with a determination that one or more criteria are satisfied, including a criterion that is satisfied based on the attention (e.g., 1713c) of the user being directed to a second region of the three-dimensional environment (e.g., 1701) that is different from the first region (e.g., 1706a) of the three-dimensional environment (e.g., 1701) when the first movement of the respective portion (e.g., 1703c) of the user is detected, such as in FIG. 17C, (e.g., the criterion is satisfied if the hand of the user that was controlling the cursor before the gaze of the user moved to the second region moves at least a threshold amount (e.g., 0.1, 0.2, 0.5, 1, 2, 3, 5, 10, or 20 cm) after the gaze of the user becomes directed to the second region; in some embodiments, the criterion is not satisfied if the hand of the user does not move at least the threshold amount after the gaze of the user becomes directed to the second region), the computer system (e.g., 101) displays (1802e) the cursor (e.g., 1704) at a location that is within the second region (e.g., 1706b) and is outside of the first region. In some embodiments, the second region is distinct from the first region and the first and second regions do not overlap. In some embodiments, the first and second regions partially overlap (and partially do not overlap) and have different centroids. In some embodiments, the second region is part of a user interface of a different application than the application of the user interface in which the first region is located. In some embodiments, the first and second regions are parts of the same user interface of the same application. In some embodiments, the one or more criteria include a criterion that is satisfied when the second movement of the respective portion of the user and the movement of the gaze of the user are in the same direction. In some embodiments, the second movement of the respective portion of the user corresponds to moving the cursor by an amount that is less than the amount of movement of the cursor from the location in the first region to the location in the second region. In some embodiments, the computer system presents an animation of continuous motion of the cursor from the first region to the second region. In some embodiments, the computer system ceases display of the cursor while the cursor is displayed in the first region and, after ceasing display of the cursor, initiates display of the cursor in the second region after/in response to the end of the second movement of the respective portion of the user. In some embodiments, the areas of the first and second regions are the same. In some embodiments, the areas of the first and second regions are different. In some embodiments, the amount of first movement of the respective portion of the user is less than an amount of movement corresponding to moving the cursor from the location in the first region to the location within the second region and outside of the first region.

Moving the cursor from the first region to the second region in accordance with the gaze of the user and the movement of the respective portion of the user enhances user interactions with the computer system by reducing the number of inputs (e.g., provided via the respective portion of the user) needed to move the cursor to the current active location in the three-dimensional environment.

In some embodiments, the one or more criteria include a criterion that is satisfied when movement of the respective portion (e.g., 1703a) of the user exceeds a predefined threshold amount (e.g., of speed, duration, and/or distance) of movement (1804a), such as in FIG. 17A.

In some embodiments, in response to detecting the first movement of the respective portion (e.g., 1703c) of the user while the attention (e.g., 1713c) of the user is directed to the second region (1804b), such as in FIG. 17C, in accordance with the determination that the one or more criteria are satisfied, including the first movement of the respective portion of the user including an amount of movement that exceeds the predefined threshold amount, the computer system (e.g., 101) displays (1804c) the cursor (e.g., 1704) at the location that is within the second region (e.g., 1706b) and is outside of the first region. In some embodiments, the predefined threshold amount of movement is at least a duration of 0.1, 0.2, 0.3, 0.5, 1, 2, or 3 seconds. In some embodiments, the predefined threshold amount of movement is at least a distance of 0.5, 1, 2, 3, 5, or 10 centimeters. In some embodiments, the predefined threshold amount of movement is at least a speed of 0.1, 0.2, 0.5, 1, 2, 3, or 5 centimeters per second.

In some embodiments, in response to detecting the first movement of the respective portion (e.g., 1703c) of the user while the attention (e.g., 1713c) of the user is directed to the second region (1804b), such as in FIG. 17C, in accordance with a determination that the one or more criteria are not satisfied because the first movement of the respective portion (e.g., 1703c) of the user includes an amount of movement that is less than the predefined threshold amount, the computer system (e.g., 101) maintains (1804d) display of the cursor (e.g., 1704) in the first region (1706a), such as in FIG. 17C. In some embodiments, the computer system maintains display of the cursor in the first region irrespective of whether or not the first movement of the predefined portion of the user exceeds the threshold amount if the first movement is detected while the attention of the user is directed to the first region.

Maintaining display of the cursor in the first region in response to detecting the first movement of the respective portion of the user including an amount of movement that is less than the predefined threshold amount while the attention of the user is directly to the second region enhances user interactions with the computer system by reducing the number of inputs needed to perform an operation (e.g., the number of inputs to maintain display of the cursor in the first region in situations where the user does not intend to cause display of the cursor in the second region).

In some embodiments, such as in FIG. 17A, the one or more criteria include a criterion that is satisfied when the respective portion (e.g., 1703a) of the user is not providing an input to draw with the cursor (1704).

In some embodiments, in response to detecting the first movement of the respective portion (e.g., 1703c) of the user while the attention (e.g., 1713c) of the user is directed to the second region, in accordance with a determination that the one or more criteria are satisfied, including the respective portion (e.g., 1703c) of the user not providing the input to draw with the cursor, such as in FIG. 17C, the computer system (e.g., 101) displays (1806b) the cursor (e.g., 1704) at the location that is within the second region (e.g., 1706b) and is outside of the first region, such as in FIG. 17D, and in accordance with a determination that the one or more criteria are not satisfied because the respective portion (e.g., 1703d) of the user is providing the input to draw with the cursor (e.g., 1704), such as in FIG. 17D, the computer system (e.g., 101) maintains display of the cursor (e.g., 1704) in the first region (e.g., 1706b), such as in FIG. 17E. In some embodiments, the input to draw with the cursor includes a predefined shape of the respective portion of the user. For example, receiving an input corresponding to a request to draw with the cursor includes detecting an air pinch and drag gesture that optionally includes movement of the hand (e.g., air gesture, touch input, or other hand input) of the user while the hand is in a pinch shape. In some embodiments, in response to detecting the first movement of the respective portion of the user while the respective portion of the user is providing input to draw with the cursor, the computer system displays, via the display generation component, a drawing in accordance with the first movement of the respective portion of the user while maintaining display of the cursor and the drawing in the first region.

Maintaining display of the cursor in the first region in response to detecting the first movement of the respective portion of the user while the respective portion of the user is providing an input to draw with the cursor enhances user interactions with the computer system by reducing the number of inputs needed to perform an operation (e.g., the number of inputs to maintain display of the cursor in the first region in situations where the user does not intend to cause display of the cursor in the same region, such as while drawing with the cursor in the first region).

In some embodiments, in response to detecting the first movement of the respective portion of the user (1808a), in accordance with a determination that the cursor (e.g., 1704) is performing a drawing operation while the respective portion (e.g., 1703e) of the user is performing the first movement, the computer system (e.g., 101) moves (1808b) the cursor (e.g., 1704) in accordance with the first movement of the respective portion (e.g., 1703e) of the user includes moving the cursor (e.g., 1704) by a first amount, such as in FIG. 17E. In some embodiments, the first amount is proportional to an amount of the first movement of the respective portion of the user by a first magnitude.

In some embodiments, in response to detecting the first movement of the respective portion (e.g., 1703c) of the user (1808a), in accordance with a determination that the cursor (e.g., 1704) is not performing drawing operation while the respective portion (e.g., 1703c) of the user is performing the first movement, the computer system (e.g., 101) moves (1808c) the cursor (e.g., 1704) in accordance with the first movement of the respective portion (e.g., 1703c) of the user includes moving the cursor (e.g., 1704) by a second amount that is greater than the first amount, such as in FIG. 17C. In some embodiments, the second amount is proportional to the amount of the first movement of the respective portion of the user by a second magnitude that is greater than the first magnitude. In some embodiments, the computer system moves the cursor more slowly (e.g., 1, 2, 3, 5, 10, 15, or 20 percent less movement) while drawing than while moving the cursor without drawing.

Moving the cursor by a greater amount while the cursor is not being used to perform a drawing operation than while the cursor is being used to perform the drawing operation enhances user interactions with the computer system by reducing the number of inputs needed to perform an operation (e.g., facilitating faster movement of the cursor while not drawing or facilitating more precise movement of the cursor while drawing).

In some embodiments, in response to detecting the first movement of the respective portion (e.g., 1703e), of the user, in accordance with a determination that the respective portion (e.g., 1703e) of the user is in a respective shape while performing the first movement, the respective shape corresponding to a request to draw in the three-dimensional environment (e.g., 1701) with the cursor (e.g., 1704), the computer system (e.g., 101) displays (1810), via the display generation component (e.g., 120), a drawing (e.g., 1708) that has a profile corresponding to movement of the cursor (e.g., 1704). In some embodiments, in response to detecting the first movement of the respective portion of the user while the attention of the user is directed to the first region of the three-dimensional environment, the computer system displays the drawing with the profile corresponding to movement of the cursor in the first region. In some embodiments, in response to detecting the first movement of the respective portion of the use while the attention of the user is directed to the second region, the computer system displays a drawing including a path (e.g., a line) from the first region to the second region (e.g., based on the profile of the movement of the cursor from the first region to the second region). In some embodiments, the respective shape is a pinch hand shape. In some embodiments, the drawing has a profile corresponding to a portion of movement of the hand (e.g., air gesture, touch input, or other hand input) of the user that was detected while the hand was in the pinch shape and does not include a profile corresponding to (e.g., further or previous) movement of the hand (e.g., air gesture, touch input, or other hand input) while the hand was not in the pinch shape. Displaying the drawing with the profile corresponding to movement of the cursor in response to detecting the first movement of the respective portion of the user while the respective portion of the user has the respective shape enhances user interactions with the computer system by providing additional control options without cluttering the user interface with additional displayed controls.

In some embodiments, while displaying the cursor (e.g., 1704) in the three-dimensional environment (e.g., 1701) (1812a), such as in FIG. 17A, the computer system (e.g., 101) receives (1812a), via the one or more input devices (e.g., 314), a respective input corresponding to a request to make a selection with the cursor (e.g., 1704). In some embodiments, the respective input is provided by the respective portion of the user. In some embodiments, receiving the respective input includes detecting a pinch gesture performed by the hand of the user. In some embodiments, receiving the respective input includes detecting the gaze of the user directed to a region of the three-dimensional environment within a threshold distance (e.g., 0.1, 0.2, 0.3, 0.5, 1, 2, 3, 5 or 10 centimeters) of the cursor. In some embodiments, receiving the respective input includes detecting the gaze of the user directed to a container, window, region, or user interface in the three-dimensional environment including the cursor. In some embodiments, the location of the gaze of the user is detected via one or more of the input devices in communication with the computer system (e.g., an eye tracking device).

In some embodiments, while displaying the cursor (e.g., 1704) in the three-dimensional environment (e.g., 1701) (1812a), such as in FIG. 17A, in response to receiving the respective input, in accordance with a determination that the cursor (e.g., 1704) is within a threshold distance (e.g., 0.05, 0.1, 0.2, 0.3, 0.5, 1 or 2 centimeters) of a selectable user interface element (e.g., a hyperlink or a selectable option) in the three-dimensional environment (e.g., 1701) when the respective input is received, the computer system (e.g., 101) performs (1812c) an action in accordance with selection of the selectable user interface element. In some embodiments, the action is one of navigating to a user interface or webpage, adjusting a setting of the computing system, initiating or stopping playback of a content item, opening, saving, or closing a file or document, or initiating communication with another computer system. In some embodiments, in accordance with a determination that the cursor is further than the threshold distance from the selectable user interface element when the respective input is received, the computer system forgoes performing the action in accordance with selection of the selectable user interface element in response to receiving the respective input.

Performing the action in accordance with selection of the selectable user interface element in response to receiving the respective input to make the selection with the cursor enhances user interactions with the computer system by providing additional control options without cluttering the user interface with additional displayed controls.

In some embodiments, such as in FIG. 17A, attention of the user is determined by smoothing gaze (e.g., 1713a) data to remove one or more high frequency changes in gaze (e.g., 1713a) location over a respective period of time (e.g., 0.2, 0.3, 0.5, 1, or 2 seconds) (1814). In some embodiments, the gaze data is collected via an eye tracking device of the one or more input devices in communication with the computer system. In some embodiments, in accordance with a determination that an average (e.g., a time-weighted average, a median, or a mode) location in the three-dimensional environment to which the attention of the user is directed for a predetermined duration (e.g., 0.05, 0.1, 0.2, 0.3, 0.5, or 1 second) while detecting the first movement of the respective portion of the user is a first location, the second region is a first region of the three-dimensional environment including the first location, and In some embodiments, the computer system applies a smoothing algorithm to the detected location to which the user's attention is directed. In some embodiments, the computer system displays the cursor in the second region in response to detecting the attention of the user directed to locations in the three-dimensional environment within a predefined threshold distance (e.g., 0.5, 1, 2, 3, 4, 5, or 10 centimeters) for a predetermined time (e.g., 0.1, 0.2, 0.3, 0.5, 1, 2 or 3 seconds) and forgoes moving the cursor in accordance with a determination that the attention of the user has moved more than the threshold distance during the predetermined time. In some embodiments, the first location is the centroid of the first region. In some embodiments, the first location is not the centroid of the first region. In some embodiments, in accordance with a determination that the average location in the three-dimensional environment to which the attention of the user is directed for the predetermined duration while detecting the first movement of the respective portion of the user is a second location, the second region is a second region of the three-dimensional environment including the second location. In some embodiments, the second location is the centroid of the second region. In some embodiments, the second location is not the centroid of the second region.

Identifying the attention of the user by smoothing gaze data to remove one or more high frequency changes in gaze location over a respective period of time enhances user interactions with the computer system by reducing the number of inputs needed to perform an operation.

In some embodiments, in response to detecting the first movement of the respective portion (e.g., 1703e) of the user, in accordance with the determination that the one or more criteria are satisfied, in accordance with a determination that movement of the attention (e.g., 1713e) of the user (e.g., from the first region to the second region or within the first region) satisfies one or more respective criteria relative to the first movement of the respective portion (e.g., 1703e) of the user and in accordance with a determination that the respective portion (e.g., 1703e) of the user is in a respective shape while performing the first movement, the respective shape corresponding to a request to move the cursor (e.g., 1704) (e.g., while drawing with the cursor or without drawing with the cursor), such as in FIG. 17E, the computer system (e.g., 101) displays (1816), via the display generation component (e.g., 120), movement of the cursor (e.g., 1704) from a first location of the cursor in the first region of the three-dimensional environment (e.g., 1701) to a second location in the three-dimensional environment (e.g., 1701) (e.g., within the first region or within the second region and outside of the first region), such as in FIG. 17F, wherein the movement of the cursor (e.g., 1704) is based on the movement of the attention of the user and the movement of the respective portion of the user. In some embodiments, the one or more respective criteria include a criterion that is satisfied when the attention of the user is directed to a region that shares a spatial relationship with the movement of the respective portion of the user. In some embodiments, the one or more respective criteria include a criterion that is satisfied when movement of the attention of the user from the first region to the second region is in the same direction as movement of the respective portion of the user. In some embodiments, the respective portion of the user is in the respective shape when a hand of the user is in a pinch hand shape. In some embodiments, in accordance with a determination that the movement of the attention of the user from the first region to the second region does not satisfy one or more respective criteria relative to the first movement of the respective portion of the user, the computer system forgoes moving the cursor based on the movement of the attention of the user and the movement of the respective portion of the user. In some embodiments, the one or more respective criteria are not satisfied when the movement of the attention of the user from the first region to the second region is in a different direction than the movement of the respective portion of the user. In some embodiments, the one or more respective criteria are not satisfied when the portion of the user is not in the respective shape (e.g., the hand is not in a pinch hand shape). In some embodiments, in response to detecting the first movement of the respective portion of the user and in accordance with the determination that movement of the attention of the user from the first region to the second region satisfies the one or more respective criteria relative to the first movement of the respective portion of the user while the respective portion is not in the respective hand shape while performing the first movement, the computer system displays the cursor in the second region without displaying a drawing from the first location to the second location described in more detail below.

Displaying movement of the cursor from the first location in the first region to the second location in response to detecting the first movement of the respective portion of the user while the one or more respective criteria are satisfied enhances user interactions with the computer system by providing additional control options without cluttering the user interface with additional displayed controls.

In some embodiments, in response to detecting the first movement of the respective portion (e.g., 1703e) of the user, in accordance with the determination that the one or more criteria are satisfied, such as in FIG. 17E, in accordance with the determination that the movement of the attention (e.g., 1713e) of the user satisfies the one or more respective criteria relative to the first movement of the respective portion (e.g., 1703e) of the user and in accordance with a determination that the respective portion (e.g., 1703e) of the user is in a first shape while performing the first movement, such as in FIG. 17E, the first shape corresponding to a request to draw in the three-dimensional environment (e.g., 1701) with the cursor (e.g., 1704), the computer system (e.g., 101) displays (1818), via the display generation component (e.g., 120), a drawing (e.g., 1708) in the three-dimensional environment (e.g., 1701) from the first location of the cursor (e.g., 1704) in the first region of the three-dimensional environment (e.g., 1701) to the second location, such as in FIG. 17F. In some embodiments, the drawing includes a (e.g., straight) line from the location of the cursor in the first region to the location of the cursor in the second region. In some embodiments, the drawing has a profile based on the movement profile of the hand and/or cursor as the hand moves to cause the cursor to move from the first region to the second region. In some embodiments, displaying the drawing in accordance with the one or more respective criteria described above includes one or more techniques for drawing with the cursor described previously. In some embodiments, if the movement of the attention of the user does not satisfy the one or more respective criteria relative to the first movement of the respective portion of the user, the computer system does not display a drawing in accordance with movement of the portion of the body of the user. In some embodiments, if the movement of the attention of the user does not satisfy the one or more respective criteria relative to the first movement of the respective portion of the user, the computer system displays a drawing in accordance with movement of the portion of the body of the user within the first region.

Displaying the drawing from the first location of the cursor in the first region to the second location of the cursor in response to detecting the first movement of the respective portion of the user while the one or more respective criteria are satisfied enhances user interactions with the computer system by providing additional control options without cluttering the user interface with additional displayed controls.

In some embodiments, in response to detecting the first movement of the respective portion of the user, in accordance with the determination that the attention (e.g., 1713a) of the user is directed to the first region (e.g., 1706a) of the three-dimensional environment (e.g., 1701) when the first movement of the respective portion (e.g., 1703a) of the user is detected, such as in FIG. 17A, in accordance with a determination that an amount (e.g., of speed, duration, or distance) of the first movement of the respective portion of the user corresponds to movement of the cursor (e.g., 1704) outside of the first region of the three-dimensional environment (e.g., 1701), the computer system (e.g., 101) moves (1820) the cursor in accordance with the first movement of the respective portion of the user to a boundary of the first region in the three-dimensional environment. In some embodiments, while the gaze of the user is directed to the first region, the computer system moves the cursor within the first region (e.g., while drawing or while not drawing) even if movement of the respective portion corresponds to movement of the cursor beyond a boundary of the first region. In some embodiments, in response to movement of the respective portion of the user that corresponds to movement of the cursor beyond the boundary of the first region, the computer system displays the cursor on or proximate to the boundary of the first region at a location of the boundary that is closest to the location beyond the boundary of the first region that corresponds to the movement of the respective portion of the user. In some embodiments, in response to detecting the first movement of the respective portion of the user, in accordance with a determination that the attention of the user is directed outside of the first region of the three-dimensional environment when the first movement of the first portion of the user is detected, in accordance with a determination that the amount of the first movement of the respective portion of the user corresponds to movement of the cursor outside of the first region of the three-dimensional environment in a direction towards the location to which the attention of the user is directed, the computer system moves the cursor by an amount that is based on the amount of movement of the respective portion of the user and the distance between the cursor and the location to which the attention of the user is directed. In some embodiments, in response to detecting the first movement of the respective portion of the user, in accordance with a determination that the attention of the user is directed outside of the first region of the three-dimensional environment when the first movement of the first portion of the user is detected, in accordance with a determination that the amount of the first movement of the respective portion of the user corresponds to movement of the cursor outside of the first region of the three-dimensional environment in a direction not towards the location to which the attention of the user is directed, the computer system in accordance with the first movement of the respective portion of the user to a respective boundary of the first region in the three-dimensional environment.

Moving the cursor in accordance with the first movement of the respective portion of the user to the boundary of the first region in response to detecting the first movement of the respective portion of the user that corresponds to movement of the cursor beyond the boundary of the first region while the attention of the user is directed to the first boundary enhances user interactions with the computer system by reducing the number of inputs needed to perform an operation (e.g., to maintain the cursor within the first region).

In some embodiments, aspects/operations of methods 800, 1000, 1200, 1400, 1600, 2000, 2200, and/or 2400 may be interchanged, substituted, and/or added between these methods. For example, the computer system transitions between navigating content according to method 800 and according to method 1800. For brevity, these details are not repeated here.

FIGS. 19A-19G illustrate example techniques of entering text into a text entry field in response to receiving a speech input in accordance with some embodiments. The user interfaces in FIGS. 19A-19G are used to illustrate the processes described below, including the processes in FIGS. 20A-20M.

FIG. 19A illustrates a computer system 101 displaying, via a display generation component (e.g., display generation component 120 of FIG. 1), a three-dimensional environment 1901 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

In FIG. 19A, the computer system 101 displays a web browsing user interface 1902 that includes an indication 1904 of the URL of the website currently displayed in the web browsing user interface 1902, a text entry field 1906, and a selectable option 1908. For example, the text entry field 1906 is a search field of an internet search website and, in response to detecting selection of the selectable option 1908, the computer system 101 requests an internet search for text entered into the text entry field 1906. In some embodiments, the computer system 101 enters text into the text entry field using dictation, a soft keyboard, and/or a hardware keyboard as described herein with reference to methods 1000, 1200, 1400, 1600, 2000, and/or 2200.

As shown in FIG. 19A, the user directs their attention, including their gaze 1913a, to the text entry field 1906 included in the web browsing user interface 1902. In some embodiments, the computer system 101 detects the attention of the user directed to the text entry field 1906 using image sensors 314. In response to detecting the attention of the user, including their gaze 1913a, directed to the text entry field 1906 as shown in FIG. 19A, the computer system 101 displays a dictation user interface element 1910 shown in FIG. 19B.

FIG. 19B illustrates the computer system 101 displaying the dictation user interface element 1910 overlaid on the text entry field 1906 in response to detecting the attention of the user directed to the text entry field 1906 in FIG. 19A. In some embodiments, the dictation user interface element 1910 is displayed between the text entry field 1906 and a viewpoint of the user from which the environment 1901 is displayed. As shown in FIG. 19B, the dictation user interface element 1910 is at least partially translucent and the text entry field 1906 is at least partially visible through the dictation user interface element 1910. Prior to detecting a speech input corresponding to a request to enter text into the dictation user interface element 1910, the computer system 101 displays placeholder text 1912b in the dictation user interface element 1910. In some embodiments, the placeholder text 1912b instructs the user to provide a speech input to enter text using the dictation user interface element 1910. For example, as shown in FIG. 19B, the placeholder text 1912b reads “speak.” In some embodiments, the placeholder text 1912b includes additional text based on the context of the text entry field 1906, such as reading “speak to search” for a text entry field of a search user interface or “speak a message” for a text entry field of a messaging user interface.

The dictation user interface element 1910 includes a dictation icon 1912a. In some embodiments, in response to detecting the attention, including gaze 1913b, of the user directed to the dictation icon 1912a while detecting a speech input 1916a, the computer system 101 initiates a process to accept dictation input for entry of text into the text entry field 1906. In some embodiments, in response to detecting the attention, including gaze 1913b, of the user directed to the dictation user interface element 1910 (e.g., but not necessarily the dictation icon 1912a) while detecting a speech input 1916a, the computer system 101 initiates the process to accept dictation input for entry of text into the text entry field 1906. In some embodiments, the computer system 101 initiates a process to accept dictation input for entry of text into text entry field 1906 because the computer system 101 displayed the dictation user interface element 1910 in response to the attention of the user being directed to the text entry field 1906 as shown in FIG. 19A. In some embodiments, if the computer system 101 displayed the dictation user interface element 1910 in response to detecting the attention of the user directed to a different text entry field, then the computer system 101 would use the dictation user interface element 1910 to enter text into the different text entry field. In some embodiments, initiating the process to accept dictation input includes updating the dictation user interface element 1910 to include text corresponding to the speech input 1916a, as shown in FIG. 19C.

In some embodiments, if the computer system detects the attention of the user, including the gaze 1913c of the user, directed away from the dictation user interface element 1910 and/or away from the dictation icon 1912a (e.g., while still being directed to a portion of the dictation user interface element 1910) while detecting the speech input 1916a, the computer system 101 forgoes displaying text corresponding to the speech input 1916a in the dictation user interface element 1910. In some embodiments, the computer system 101 maintains display of the dictation user interface element 1910 without updating the dictation user interface element 1910 to include text corresponding to speech input 1916a in response to detecting the speech input 1916a while the attention of the user, including gaze 1913c, is directed away from the dictation user interface element 1910 and/or away from the dictation icon 1912a. In some embodiments, the computer system 101 ceases display of the dictation user interface element 1910 in response to detecting the speech input 1916a while the attention of the user, including gaze 1913c, is directed away from the dictation user interface element 1910 and/or away from the dictation icon 1912a.

FIG. 19C illustrates the computer system 101 displaying the dictation user interface element 1910 updated to include text 1912b corresponding to the speech input 1916a illustrated in FIG. 19B in response to detecting the speech input 1916a while detecting the attention of the user directed to the dictation user interface element 1910 and/or the dictation icon 1912a, as shown in FIG. 19B. In some embodiments, the computer system 101 expands the dictation user interface element 1910 to accommodate at least a portion of the text 1912b corresponding to the speech input 1916a in FIG. 19B in response to the input illustrated in FIG. 19B. In some embodiments, there is a maximum width to which the computer system 101 will expand the dictation user interface element 1910 and, in some embodiments, if the text 1912b corresponding to the speech input 1916a in FIG. 19B exceeds the maximum width, the computer system 101 displays the dictation user interface element 1910 at the maximum width and scrolls the text 1912b so that a portion of the text 1912b is visible in the dictation user interface element 1910.

In some embodiments, the computer system 101 displays the text 1912b in the dictation user interface element 1910 with an insertion marker 1914. The insertion marker 1914 is optionally displayed at a location within text 1912b at which further text would be inserted in response to detecting another speech input while the attention, including gaze, of the user is directed to the dictation user interface element 1910 and/or the dictation icon 1912a. In some embodiments, while the user is providing a speech input (e.g., speech input 1916a in FIG. 9B) directed to the dictation user interface element 1910, the computer system 101 modifies a visual characteristic of the insertion marker 1914 in accordance with audio levels of the speech input. For example, the insertion marker 1914 is displayed with a glow effect that changes in size, intensity, translucency, color, or another visual characteristic in response to changing audio levels of the speech input. In some embodiments, the changing visual characteristic of the insertion marker 1914 in response to the audio input acts as visual feedback to the user while the speech input is being provided.

In some embodiments, the computer system 101 enters the text 1912b in the dictation user interface element 1910 as shown in FIG. 19D into the text entry field 1906 in response to a user input confirming the text entry shown in FIG. 19C. In some embodiments, the user input confirming the text entry includes detecting the attention, including gaze 1913d, of the user directed to the dictation user interface element 1910 with or without detecting a speech input for at least a predetermined threshold period of time. Example threshold periods of time are included below with reference to method 2000. In some embodiments, the user input confirming the text entry includes detecting a speech input 1916b that includes a command associated with the text entry field 1906. For example, the text entry field 1906 is included in an internet search user interface, so the command is “search.” As another example, a text entry field associated with a messaging user interface is associated with the command “send” or “send it.” In some embodiments, the computer system enters the text 1912b from dictation user interface element 1910 into the text entry field 1906 in response to detecting the speech input 1916b including the command irrespective of whether the attention, including gaze 1913d, of the user is directed to the dictation user interface element 1910 or the attention, including gaze 1913e, is directed away from the dictation user interface element 1910. In some embodiments, the computer system enters the text 1912b from dictation user interface element 1910 into the text entry field 1906 in response to detecting the speech input 1916b including the command while the attention, including gaze 1913d, of the user is directed to the dictation user interface element 1910. In some embodiments, the computer system 101 forgoes entering the text 1912b from dictation user interface element 1910 into the text entry field 1906 if speech input 1916b is detected while the attention, including gaze 1913e, is directed away from the dictation user interface element 1910.

In some embodiments, the computer system 101 forgoes entering the text 1912b from the dictation user interface element 1910 into the text entry field 1906 in response to a threshold period of time passing without receiving an additional speech input corresponding to text to be added to the dictation user interface element 1910 and without receiving a user input confirming the text entry. Example threshold periods of time are included below in the description of method 2000. In some embodiments, forgoing entering the text 1912b into the text entry field 1906 includes continuing to display the dictation user interface element 1910 without text 1912b. For example, the computer system 101 updates the dictation user interface element 1910 to include the placeholder text 1912b included in FIG. 19B. In some embodiments, forgoing entering the text 1912b into the text entry field 1906 includes ceasing display of the dictation user interface element 1910 and displaying the user interface shown in FIG. 19A. In some embodiments, the computer system 101 continues to display the dictation user interface element 1910 until an input selecting a region of the environment 1901 other than the dictation user interface element 1910 is received.

FIG. 19D illustrates the computer system 101 displaying the text entry field 1906 updated to include text 1918 entered via the dictation user interface element 1910 in FIG. 19C. As described above, in some embodiments, the computer system 101 enters the text 1918 into the text entry field 1906 in response to an input confirming the text entry, such as the inputs described above with reference to FIG. 19C.

FIG. 19E illustrates the computer system 101 displaying the web browsing user interface 1902 described above with reference to FIGS. 19A-19D and a soft keyboard 1920. In some embodiments, the soft keyboard 1920 has one or more characteristics of other soft keyboards described herein with reference to methods 1200, 1400, 1600, and/or 2200. The soft keyboard 1920 optionally includes a backplane 1928 and a plurality of keys 1930. In some embodiments, the soft keyboard 1920 is displayed proximate to a user interface element 1924 that includes a dictation option 1922a, a text entry field 1922b with insertion marker 1922e, and predicted text 1922c and 1922d. In some embodiments, the text entry field 1922b in user interface element 1924 mirrors the text entry field 1906 to which the input focus of the soft keyboard 1920 is directed, as will be described in more detail below. In some embodiments, the soft keyboard 1920 is displayed proximate to an option 1926a to reposition the soft keyboard in the environment 1901 and an option 1926b to resize the soft keyboard 1920. As shown in FIG. 19E, the computer system 101 detects selection of the dictation option 1922a. In some embodiments, the selection input is an air gesture input (e.g., a direct or indirect input) described above that includes a gesture performed with hand 1903a and/or the attention of the user, including the gaze 1913f of the user, directed to the dictation option 1922. In response to detecting selection of the dictation option 1922a, the computer system 101 initiates a process to enter text to text entry field 1906 via dictation, as shown in FIG. 19F.

FIG. 19F illustrates the computer system 101 configured to accept dictation input to enter text to text entry field 1906 in response to the input described above with reference to FIG. 19E. In some embodiments, the computer system 101 indicates that it is configured to accept dictation inputs by displaying insertion marker 1922e in text entry field 1922b of user interface element 1924 with a visual characteristic that changes over time in response to variations in audio volume sensed at the computer system 101. In some embodiments, the visual characteristic is similar to the visual characteristics of an insertion marker described above with reference to FIG. 19C. In some embodiments, while the computer system 101 is configured to receive dictation inputs directed to text entry field 1906 while the soft keyboard 1920 is displayed, the computer system 101 receives a voice input 1916c provided by the user. In some embodiments, in response to receiving the voice input 1916c, the computer system 101 displays text corresponding to the voice input 1916c in text entry field 1906 and text entry field 1922b irrespective of whether the attention, optionally including gaze 1913g, of the user is directed to text entry field 1922b or whether attention (e.g., optionally including gaze 1913h) is directed away from the text entry field 1922b. The computer system 101 optionally displays text corresponding to speech input 1916c irrespective of the location in the environment 1901 to which the user is paying attention while the speech input 1916c is provided in response to receiving the speech input 1916c while the soft keyboard 1920 is displayed. In some embodiments, as discussed above with reference to FIGS. 19B-19C, the computer system 101 forgoes displaying text corresponding to a speech input received while the attention of the user is directed away from the dictation user interface element 1910 when the speech input is received while the computer system 101 is not displaying soft keyboard 1920. Because the computer system 101 is displaying the soft keyboard 1920 while the speech input 1916c is received in FIG. 19F, the computer system 101 displays the text representation of the speech input 1916c in the text entry field 1906 and text entry field 1922b in response to receiving the speech input 1916c, as shown in FIG. 19G.

FIG. 19G illustrates the computer system 101 displaying text 1934 in text entry field 1906 and a representation 1922h of the text in text entry field 1922b in response to the speech input 1916c illustrated in FIG. 19F. In some embodiments, the text 1934 is a text representation of the speech input 1916c. In some embodiments, the representation 1922h of the text corresponds to the text 1934 in text entry field 1906 as described above with reference to methods 1200, 1400 and/or 1600. In some embodiments, the computer system 101 updates the recommended text options 1922f and 1922g to include recommended text that corresponds to the text 1934 in the text entry field 1906 in response to entering the text 1934 into text entry field 1906.

FIGS. 20A-20M is a flow diagram of methods of entering text into a text entry field in response to receiving a speech input in accordance with some embodiments. In some embodiments, method 2000 is performed at a computer system (e.g., computer system 101 in FIG. 1) including a display generation component (e.g., display generation component 120 in FIGS. 1, 3, and 4). In some embodiments, the method 2000 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 2000 are, optionally, combined and/or the order of some operations is, optionally, changed.

In some embodiments, method 2000 is performed at a computer system (e.g., 101) in communication with a display generation component (e.g., 120) and one or more input devices (e.g., 314). In some embodiments, the computer system is the same as or similar to the electronic device(s) and/or computer system(s) described above with reference to method(s) 800, 1000, 1200, 1400, 1600 and/or 1800. In some embodiments, the one or more input devices are the same as or similar to the one or more input devices described above with reference to method(s) 800, 1000, 1200, 1400, 1600 and/or 1800. In some embodiments, the display generation component is the same as or similar to the display generation component described above with reference to method(s) 800, 1000, 1200, 1400, 1600 and/or 1800.

In some embodiments, such as in FIG. 19B, the computer system (e.g., 101) concurrently displays (2002a), via the display generation component (e.g., 120), a user interface (e.g., 1902) that includes a text entry field (e.g., 1906), and a text entry element (e.g., 1910) configured to enter text to the text entry field (e.g., 1906). In some embodiments, such as in FIG. 19B, the text entry element (e.g., 1910) is a text dictation user interface element displayed in response to an input corresponding to a request to initiate a process to dictate text input directed to the text entry field (e.g., 1906), as described in more detail below and/or as described above with reference to method 1000. In some embodiments, such as in FIG. 19B, the text entry element (e.g., 1910) is displayed at least partially overlaid on the text entry field (e.g., 1906). In some embodiments, such as in FIG. 19B, the text entry element (e.g., 1910) is displayed between the text entry field (e.g., 1906) of the user interface and the viewpoint of the user in a three-dimensional environment (e.g., 1901), such as a three-dimensional environment described above with reference to method(s) 800, 1000, 1200, 1400, 1600 and/or 1800. In some embodiments, as described in more detail below, the computer system displays the text entry element in response to detecting an input that includes detecting the attention of the user directed to the text entry field. In some embodiments, the text entry element is configured to enter text to the text entry field (e.g., without entering text to a second text entry field) in accordance with a determination that the attention of the user was directed to the text entry field while providing the input corresponding to the request to display the text entry element. In some embodiments, in response to detecting an input corresponding to a request to display the text entry element that includes the attention of the user directed to a second text entry field different from the text entry field, the computer system displays the text entry element configured to enter text to the second text entry element (e.g., without entering text to the text entry element). In some embodiments, the text entry element is a first text entry element configured to enter text to the first text entry field (e.g., without entering text to a second text entry field) and the computer system displays a second text entry element configured to enter text to the second text entry field (e.g., without entering text to the text entry field). In some embodiments, the text entry field and the text entry element are separate and distinct user interface elements. In some embodiments, the text entry element is included in the user interface that includes the text entry field. In some embodiments, the text entry element is separate from the user interface that includes the text entry field, such as being a system user interface element, or included in a second user interface different from the first user interface.

In some embodiments, such as in FIG. 19B, while concurrently displaying, via the display generation component (e.g., 120), the text entry element (e.g., 1910) and the user interface (e.g., 1902) (2002a), the computer system (e.g., 101) receives (2002c), via the one or more input devices (e.g., 314), a text entry input directed to the text entry element (e.g., 1910), wherein the text entry input includes a speech input (e.g., 1916a). In some embodiments, the text entry input satisfies one or more criteria. In some embodiments, such as in FIG. 19B, the one or more criteria include the attention (e.g., including gaze 1913b) of the user being directed to the text entry element (e.g., 1910) while the speech input (e.g., 1916a) is provided. In some embodiments, the one or more criteria include the attention of the user being directed to the text entry field while the speech input is being provided. In some embodiments, the one or more criteria include the attention of the user being directed to a user interface element associated with the text entry field while the speech input is being provided.

In some embodiments, such as in FIG. 19C, while concurrently displaying, via the display generation component (e.g., 120), the text entry element (e.g., 1910) and the user interface (e.g., 1902) (2002a), in response to receiving the text entry input, the computer system (e.g., 101) updates (2002d) display, via the display generation component (e.g., 120), of the text entry element (e.g., 1910) to include a text representation (e.g., 1912b) of the speech input without entering text into the text entry field. In some embodiments, in response to receiving the text entry input while displaying the text entry element with respective text (e.g., displayed in the text entry element in response to a prior speech input from the user), the computer system updates the text entry element to include both the text representation of the speech input and the respective text. For example, the computer system displays text corresponding to the speech input in addition to text that was already displayed in the text entry element while the text entry input was received. In some embodiments, in accordance with a determination that the speech input corresponds to first speech, the text representation includes first text corresponding to the first speech. In some embodiments, in accordance with a determination that the speech input corresponds to second speech, the text representation includes second text corresponding to the second speech. In some embodiments, in accordance with a determination the text entry input fails to satisfy the one or more criteria discussed above, the computer system forgoes updating display of the text entry element to include the text representation in response to the text entry input. Displaying the text representation of the speech input in the text entry element as described above enhances user interactions with the computer system by providing improved visual feedback to the user while the user is providing a text entry input including speech input and by improving user privacy.

In some embodiments, such as in FIG. 19B, the user interface (e.g., 1902) is a user interface of an application and the text entry field (e.g., 1906) is a text entry field of the application (2004a). In some embodiments, the application is installed on or otherwise accessible to the computer system. In some embodiments, the application is one of a plurality of applications installed on or otherwise accessible to the computer system.

In some embodiments, such as in FIG. 19B, the text entry element (e.g., 1910) is a system user interface element (2004b). In some embodiments, system user interface elements are independent from the one or more applications installed on or otherwise accessible to the computer system. In some embodiments, the computer system uses system user interface elements to control more than one of the applications installed on or otherwise accessible to the computer system. For example, the computer system uses the text entry element to provide text inputs to the application and to a second application installed on or otherwise accessible to the computer system.

In some embodiments, such as in FIG. 19C, while the computer system (e.g., 101) displays the text representation (e.g., 1912b) of the speech input included in the text entry element (e.g., 1910) without entering the text into the text entry field, the application does not have access to the text representation (e.g., 1912b) of the speech input (2004c). In some embodiments, the application does not have access to the text representation of the speech input unless and until the text is entered into the text entry field of the application, as described in more detail below. In some embodiments, the application does not have access to the speech input unless and until the text is entered into the text entry field of the application. In some embodiments, while the computer system displays the text representation of the speech input in the text entry element, the text entry element has access to the text of the speech input without the application having access to the text of the speech input. Forgoing allowing the application to access the text representation of the speech input while the text representation of the speech input is displayed in the text entry element without entering text into the text entry field enhances user interactions with the computer system by improving privacy.

In some embodiments, such as in FIG. 19B, the user interface (e.g., 1902) is a user interface of a first application and the text entry field (e.g., 1906) is a text entry field of the first application (2006a). In some embodiments, the first application is installed on or otherwise accessible to the computer system. In some embodiments, the first application is one of a plurality of applications installed on or otherwise accessible to the computer system.

In some embodiments, the computer system (e.g., 101) concurrently displays (2006b), via the display generation component (e.g., 120), a user interface of a second application different from the first application that includes a second text entry field of the second application, such as a second user interface similar to user interface 1902 that includes a text entry field similar to text entry field 1906 in FIG. 19B, and the text entry element (e.g., 1910), wherein the text entry element (e.g., 1910) is configured to enter text to the second text entry field. In some embodiments, the second application is installed on or otherwise accessible to the computer system. In some embodiments, the second application is one of a plurality of applications installed on or otherwise accessible to the computer system. In some embodiments, the user interface of the second application and the user interface of the first application are displayed concurrently. In some embodiments, the computer system forgoes display of the user interface of the first application while displaying the user interface of the second application. In some embodiments, the text entry element is configured to enter text to text entry fields of the first application and the second application and, optionally, one or more additional applications installed on or otherwise accessible to the computer system.

In some embodiments, while concurrently displaying, via the display generation component (e.g., 120), the text entry element (e.g., 1910) and the user interface (e.g., 1902), such as in FIG. 19B, the computer system (e.g., 101) receives (2006d), via the one or more input devices (e.g., 314), a second text entry input directed to the text entry element (e.g., 1910), wherein the second text entry input includes a second speech input (e.g., 1916a). In some embodiments, the second text entry input has one or more characteristics in common with the text entry input described above. In some embodiments, the second speech input has one or more characteristics in common with the speech input described above.

In some embodiments, while concurrently displaying, via the display generation component (e.g., 120), the text entry element (e.g., 1910) and the user interface (e.g., 1902), such as in FIG. 19B, in response to receiving the second text entry input, the computer system (e.g., 101) updates (2006e) display, via the display generation component (e.g., 120), of the text entry element (e.g., 1910) to include a text representation of the second speech input without entering text into the second text entry field, such as in FIG. 19C. In some embodiments, updating display of the text entry element in response to receiving the second text entry input has one or more characteristics of updating display of the text entry element in response to receiving the text entry input described above. In some embodiments, the computer system uses the text entry element to enter text into text entry fields of a plurality of applications installed on or otherwise accessible to the computer system.

Using the text entry element to enter text to text entry fields of the first application and the second application enhances user interactions with the computer system by enabling the user to use speech inputs to enter text to text entry fields of the first and second applications, thereby reducing the time and battery life needed to enter text to the text entry fields of the first and second applications and by improving user privacy.

In some embodiments, such as in FIG. 19B, the computer system (e.g., 101) displays, via the display generation component (e.g., 120), the user interface (e.g., 1902) and the text entry element (e.g., 1910) in an environment (e.g., 1901), and concurrently displaying the user interface (e.g., 1902) and the text entry element (e.g., 1910) includes displaying, via the display generation component (e.g., 120), the text entry element (e.g., 1910) between the text entry field (e.g., 1906) of the user interface (e.g., 1902) and a viewpoint of a user of the computer system (e.g., 101) in the environment (e.g., 1901) (2008a). In some embodiments, the computer system displays the environment from the viewpoint of the user. In some embodiments, such as in FIG. 19B, the text entry element (e.g., 1910) is closer to the viewpoint of the user than the distance between the user interface (e.g., 1902) and the viewpoint of the user. In some embodiments, such as in FIG. 19B, the text entry element (e.g., 1910) is at least partially overlapping the text entry field (e.g., 1906) of the user interface (e.g., 1902). Displaying the text entry element between the text entry field of the user interface and the viewpoint of the user in the environment enhances user interactions with the computer system by reducing the time needed to interact with the text entry element, thereby saving time and battery life.

In some embodiments, updating display of the text entry element (e.g., 1910) to include the text representation (e.g., 1912b) of the speech input, such as in FIG. 19C, includes (2010a), in response to detecting a first portion of the speech input corresponding to a first amount of text, displaying, via the display generation component (e.g., 101), the text entry element (e.g., 1910) with a first size in accordance with the first amount of text (2010b). In some embodiments, the first amount of text is a first number of characters and/or a width of the text when displayed via the display generation component. In some embodiments, the first size includes a width corresponding to the width of the text representation of the speech input. In some embodiments, the computer system displays, via the display generation component, the text entry element with a width that is between a minimum width and a maximum width that has a width that includes the text representation of the speech input.

In some embodiments, updating display of the text entry element (e.g., 1910) to include the text representation (e.g., 1912b) of the speech input, such as in FIG. 19C, includes (2010a) in response to detecting the first portion of the speech input and a second portion of the speech input corresponding to a second amount of text different from the first amount of text, displaying, via the display generation component (e.g., 120), the text entry element (e.g., 1910) with a second size different from the first size in accordance with the second amount of text (2010c). In some embodiments, in response to detecting the second portion of the speech input, the computer system increases the width of the text entry element to include space to present a text representation of the second portion of the speech input concurrently with the text representation of the first portion of the speech input. In some embodiments, the second amount of text is a second number of characters and/or a width of the text when displayed via the display generation component. In some embodiments, the second size includes a width corresponding to the width of the text representation of the speech input. In some embodiments, the computer system displays, via the display generation component, the text entry element with a width that is between a minimum width and a maximum width that has a width that includes the text representation of the speech input. Displaying the text entry element with a size in accordance with the amount of text in the text representation of the speech input enhances user interactions with the computer system by providing enhanced visual feedback to the user.

In some embodiments, such as in FIG. 19C, updating display of the text entry element (e.g., 1910) to include the text representation (e.g., 1912b) of the speech input includes (2012a), in response to detecting the first portion of the speech input (e.g., 1916a in FIG. 19B), in accordance with a determination that the first amount of text corresponds to displaying the text entry element with a third size that includes displaying the text entry element (e.g., 1910) past a boundary of the text entry field (e.g., 1906), displaying the text entry element (e.g., 1910) with a predetermined fourth size that includes displaying the text entry element (e.g., 1910) within the boundary of the text entry field (e.g., 1906) (2012b), such as in FIG. 19C. In some embodiments, such as in FIG. 19C, the computer system (e.g., 101) increases the size of the text entry element (e.g., 1910) as the user continues to provide the speech input to accommodate the text representation (e.g., 1912b) of the speech input until the text entry element (e.g., 1910) reaches the fourth predetermined size (e.g., a maximum size). In some embodiments, such as in FIG. 19C, the fourth predetermined size corresponds to displaying the text entry element (e.g., 1910) with a width that does not overlap a boundary of the text entry field (e.g., 1906). For example, such as in FIG. 19C, the width of the text entry element (e.g., 1910) expands until the text entry element (e.g., 1910) reaches a maximum width that does not cross a respective one of the vertical boundaries of the text entry field (e.g., 1906) (e.g., the right or left boundary).

In some embodiments, such as in FIG. 19C, updating display of the text entry element (e.g., 1910) to include the text representation (e.g., 1912b) of the speech input includes (2012a), in response to detecting the first portion and the second portion of the speech input (e.g., 1916a in FIG. 19B), in accordance with a determination that the second amount of text corresponds to displaying the text entry element (e.g., 1910) with a fifth size that includes displaying the text entry element past the boundary of the text entry field (e.g., 1906), displaying the text entry element (e.g., 1910) with the predetermined fourth size within the boundary of the text entry field (e.g., 1906) (2012c). In some embodiments, the computer system displays the text entry element with the predetermined fourth size irrespective of the amount by which the text representation of the speech input exceeds the size corresponding to the fourth size of the text entry element. Displaying the text entry element with the predetermined fourth size in response to the amount of text of the text representation of the speech input corresponding to displaying the text entry element at a size greater than the fourth predetermined size enhances user interactions with the computer system by avoiding occluding other content of the user interface including the text entry field.

In some embodiments, while displaying the text representation (e.g., 1912b) of the speech input (e.g., 1916b) in the text entry element (e.g., 1910) in response to receiving the text entry input, such as in FIG. 19C, the computer system (e.g., 101) detects (2014a), via the one or more input devices (e.g., 314), a user of the computer system (e.g., 101) cease to provide the text entry input. In some embodiments, the computer system determines a predetermined time threshold (e.g., 0.1, 0.2, 0.3, 0.5, 1, or 2 seconds) has passed since detecting an end of the user speaking the speech input.

In some embodiments, in response to detecting the user cease to provide the text entry input, the computer system (e.g., 101) enters (2014b) the text representation of the speech input into the text entry field (e.g., 1906), such as in FIG. 19D. In some embodiments, entering the text representation (e.g., 1912b) of the speech input in to the text entry field (e.g., 1906) in response to detecting the user cease to provide the text entry input is in accordance with a determination that the attention (e.g., including gaze 1913d) of the user is directed to the text entry element (e.g., 1910), the text entry field (e.g., 1906), or the user interface (e.g., 1902), such as in FIG. 19C. In some embodiments, in response to detecting the user cease to provide the text entry input while the attention (e.g., including gaze 1913e) of the user is not directed to the text entry element (e.g., 1910), the text entry field (e.g., 1906), or the user interface (e.g., 1902), such as in FIG. 19C, the computer system (e.g., 101) forgoes entering the text representation (e.g., 1912b) of the speech input into the text entry field (e.g., 1906). Entering the text representation of the speech input into the text entry field in response to detecting the user cease to provide the text entry input enhances user interactions with the computer system by reducing the number of inputs needed to enter the text representation of the speech input into the text entry field and by improving user privacy.

In some embodiments, while displaying the text entry element (e.g., 1910) including the text representation (e.g., 1912b) of the speech input (2016a), such as in FIG. 19C, in accordance with a determination that one or more criteria are satisfied, including a criterion that is satisfied in response to detecting, via the one or more input devices, a text commit input (e.g., 1916b), such as in FIG. 19C, the computer system (e.g., 101) enters (2016b) the text representation (e.g., 1912b) of the speech input into the text entry field (e.g., 1906), such as in FIG. 19D. In some embodiments, such as in FIG. 19C, the commit input includes a second speech input (e.g., 1916b), as described in more detail below. In some embodiments, such as in FIG. 19C, the commit input includes detecting the that the attention (e.g., 1913d) of the user is directed to the text entry element (e.g., 1910), as described in more detail below. In some embodiments, in accordance with the determination that the one or more criteria are satisfied, the computer system further ceases to display the text entry element.

In some embodiments, while displaying the text entry element (e.g., 1910) including the text representation (e.g., 1912b) of the speech input (2016a), such as in FIG. 19C, in accordance with a determination that the one or more criteria are not satisfied, the computer system (e.g., 101) forgoes (2016c) entering the text representation (e.g., 1912b) of the speech input into the text entry field (e.g., 1906). In some embodiments, the one or more criteria require a predetermined time threshold (e.g., 0.1, 0.2, 0.5, 1, 2, 3, 4, 5, or 10 seconds) passing after detecting the speech input without detecting the commit input. In some embodiments, in accordance with the one or more criteria being satisfied, the computer system ceases display of the text entry element with the text representation of the speech input without entering the text representation of the speech input into the text entry field. In some embodiments, the computer system forgoes entering the text representation of the speech input into the text entry field unless and until the computer system detects the commit input. In some embodiments, the application of the text entry field does not have access to the text representation of the speech input or the speech input unless and until the computer system enters the text representation of the speech input into the text entry field, as described above. Forgoing entering the text representation of the speech input into the text entry field unless and until the commit input is detected enhances user interactions with the computer system by enhancing user privacy.

In some embodiments, such as in FIG. 19C, detecting the commit input includes detecting attention (e.g., including gaze 1913d) of the user directed to the text representation (e.g., 1912b) of the speech input in the text entry element (e.g., 1910) (2018a). In some embodiments, in accordance with a determination that the attention, including the gaze (e.g., 1913d) of the user, is directed to the text representation (e.g., 1912b) of the speech input while the computer system (e.g., 101) displays the text representation (e.g., 1912b) of the speech input and after the user finishes providing the speech input, such as in FIG. 19C, the computer system (e.g., 101) enters the text (e.g., 1918) into the text entry field (e.g., 1906), such as in FIG. 19D. Entering the text into the text entry field based on attention of the user enhances user interactions with the computer system by providing additional control options without cluttering the user interface with additional displayed controls.

In some embodiments, detecting the commit input includes detecting a second speech input (e.g., 1916b) that satisfies one or more second criteria (2020a), such as in FIG. 19C. In some embodiments, the one or more second criteria include a criterion that is satisfied when the second speech input (e.g., 1916b) includes one or more predetermined words, such as in FIG. 19C. In some embodiments, such as in FIG. 19C, the one or more predetermined words are associated with the application of the text entry field (e.g., 1906) and/or the context of the text entry field, such as in FIG. 19C. For example, if the application is a messages application, the predetermined one or more words are “send it.” As another example, if the application is a web browsing application and the text entry field is a navigation field, the one or more predetermined words is “go.” As another example, if the application is a web browsing application and the text entry field (e.g., 1906) is a search field of a web searching website presented via the web browsing application, the one or more predetermined words is “search,” such as in FIG. 19C. Entering the text into the text entry field based on detecting a second speech input enhances user interactions with the computer system by providing interaction options without cluttering the user interface with additional displayed controls.

In some embodiments, while concurrently displaying the text entry element (e.g., 1910) and the user interface (e.g., 1902), such as in FIG. 19C, the computer system (e.g., 101) displays (2022a), via the display generation component (e.g., 120), a text entry option, such as a selectable option displayed in user interface 1902 or text entry element 1910 in FIG. 19C. In some embodiments, the text entry option is displayed in the text entry element In some embodiments, the text entry option is displayed outside of the text entry element in the user interface that includes the text entry field.

In some embodiments, the one or more second criteria include a criterion that is satisfied when the computer system (e.g., 101) detects, via the one or more input devices, the attention of the user directed to the text entry option while detecting the second speech input (e.g., 1916b in FIG. 19C). In some embodiments, detecting the attention of the user directed to the text entry option while detecting the second speech input includes detecting the gaze of the user directed to the text entry option while detecting the second speech input. For example, the text entry option is a “send” option included in a messaging user interface. As another example, the text entry option is a “search” option included in a web search webpage presented by an internet browsing application. Entering the text into the text entry field in response to detecting the second speech input while the gaze of the user is directed to the option enhances user interactions with the computer system by prevent accidental entry of text into the text entry field, which enhances user privacy.

In some embodiments, in accordance with the determination that the one or more criteria are not satisfied, the computer system (e.g., 101) ceases (2024a) display of the text representation (e.g., 1912b) of the speech input in the text entry element (e.g., 1910), such as in FIG. 19A or FIG. 19B. In some embodiments, such as in FIG. 19B, the computer system (e.g., 101) maintains display of the text entry element (e.g., 1910) without the text representation of the speech input. In some embodiments, such as in FIG. 19A, the computer system (e.g., 101) ceases display of the text entry element when it ceases display of the text representation of the speech input. Ceasing display of the text representation of the speech input in the text entry element in accordance with the determination that the one or more criteria are not satisfied enhances user interactions with the computer system by providing improved visual feedback to the user.

In some embodiments, such as in FIG. 19A, the user interface (e.g., 1902) is a user interface of an application and the text entry field (e.g., 1906) is a text entry field of the application (2026a). In some embodiments, the application is installed on or otherwise accessible to the computer system. In some embodiments, the application is one of a plurality of applications installed on or otherwise accessible to the computer system.

In some embodiments, such as in FIG. 19D, entering the text representation (e.g., 1918) of the speech input into the text entry field (e.g., 1906) includes providing the application with access to the text representation (e.g., 1918) of the speech input (2026b). In some embodiments, providing the application with access to the text representation of the speech input enables the application to store and/or process the text representation of the speech input.

In some embodiments, such as in FIG. 19A or FIG. 19B, forgoing entering the text representation of the speech input into the text entry field (e.g., 1906) includes forgoing providing the application with access to the text representation of the speech input (2026c). In some embodiments, the application does not have access to the speech input and/or the text representation of the speech input unless and until the text representation of the speech input is entered into the text entry field, as described above. Forgoing providing the application with access to the text representation of the speech input when forgoing entering the text representation of the speech input into the text entry field enhances user interactions with the computer system by improving user privacy.

In some embodiments, such as in FIG. 19B, while concurrently displaying the user interface (e.g., 1902) that includes the text entry field (e.g., 1906) and the text entry element (e.g., 1910), in accordance with a determination that one or more criteria are satisfied, the computer system (e.g., 101) displays (2028a), via the display generation component (e.g., 120), a visual indication (e.g., 1912b) that the computer system (e.g., 101) is configured to enter text in response to the speech input (e.g., 1916a). In some embodiments, the one or more criteria include a criterion that is satisfied in response to detecting the attention, including gaze (e.g., 1913b), of the user directed to the text entry field (e.g., 1906) and/or the text entry element (e.g., 1910) for a least a predetermined threshold amount of time (e.g., 0.1, 0.2, 0.5, 1, or 2 seconds), such as in FIG. 19B. In some embodiments, such as in FIG. 19B, the visual indication (e.g., 1912a) is an icon, such as an icon of a microphone or a person speaking, displayed with a glowing visual effect. In some embodiments, such as in FIG. 19C, the visual indication is the application of the glowing visual effect to an insertion marker (e.g., 1914) in the text entry element (e.g., 1910). In some embodiments, the glowing visual effect has a characteristic (e.g., size, color, or translucency) that changes over time in accordance with a characteristic (e.g., pitch, loudness, volume) of a speech input provided by the user. In some embodiments, in response to detecting the speech input while the one or more criteria are satisfied, the computer system is configured to accept dictation inputs to enter text in the text entry field, including presenting the text representation of the speech input in the text entry element.

In some embodiments, such as in FIG. 19A, in accordance with a determination that the one or more criteria are not satisfied, the computer system (e.g., 101) forgoes (2028b) display of the visual indication that the computer system (e.g., 101) is configured to enter the text in response to the speech input. In some embodiments, such as in FIG. 19A, if the one or more criteria are not satisfied, the computer system (e.g., 101) displays the user interface (e.g., 1902) with the text entry field (e.g., 1906) without displaying the text entry element. In some embodiments, in response to detecting the speech input while the one or more criteria are not satisfied, the computer system forgoes configuration to accept dictation inputs to enter text into the text entry field, including forgoing presenting the text representation of the speech input in the text entry element. Displaying the visual indication that the computer system is configured to enter text in response to the speech input enhances user interactions with the computer system by providing improved visual feedback to the user.

In some embodiments, such as in FIG. 19C, the one or more criteria include a criterion that is satisfied in response to detecting an input state corresponding to a user of the computer system (e.g., 101) intending to dictate text to be entered into the text entry field (e.g., 1906) (2030a). In some embodiments, such as in FIG. 19C, the criterion includes detecting the attention (e.g., including gaze 1913d) of the user directed to the text entry field (e.g., 1906) and/or text entry element (e.g., 1910) for the predetermined threshold time described above. In some embodiments, such as in FIG. 19B, the criterion includes detecting the speech input (e.g., 1916a) from the user. In some embodiments, the criterion includes detecting a ready state of the user, such as one or more hands in the pre-pinch hand shape and/or the user's body being in contact with a hardware input device without providing an input with the hardware input device (e.g., the user's finger resting on a trackpad without applying enough pressure to make a selection with the trackpad). Displaying the visual indication that the computer system is configured to enter text in response to the speech input in accordance with detecting the input state corresponding to the user of the computer system intending to dictate text to be entered into the text entry field enhances user interactions with the computer system by providing improved visual feedback to the user.

In some embodiments, such as in FIG. 19B, detecting the input state includes detecting attention (e.g., including gaze 1913b) of the user of the computer system (e.g., 101) directed to the visual indication (e.g., 1912a) that the computer system (e.g., 1010) is configured to enter the text in response to the speech input (e.g., 1916a) (2032a). In some embodiments, such as in FIG. 19B, detecting the input state includes detecting the attention (e.g., including gaze 1913b) of the user directed to the visual indication (e.g., 1912a) for at least a predetermined threshold amount of time, such as 0.1, 0.2, 0.3, 0.5, 1, 2, or 3 seconds. In some embodiments, such as in FIG. 19B, detecting the input state includes detecting the attention (e.g., including gaze 1913b) of the user directed to the visual indication (e.g., 1912a) for any amount of time. In some embodiments, once the computer system (e.g., 101) displays the visual indication (e.g., 1912a) that the computer system (e.g., 101) is configured to enter the text in response to the speech input, such as in FIG. 19B, the computer system (e.g., 101) continues to display the indication (e.g., 1912a) in accordance with a determination that the attention (e.g., including gaze 1913b) of the user is directed to the visual indication (e.g., 1912a). In some embodiments, in response to detecting the attention (e.g., including gaze 1913c) of the user directed away from the visual indication (e.g., 1912a), such as in FIG. 19B, the computer system (e.g., 101) ceases to display the visual indication (e.g., 1912a) and/or the text entry element (e.g., 1910), such as in FIG. 19A. Detecting the intention of the user to dictate text to the text entry field based on the attention of the user being directed to a visual indication that the computer system is configured to enter text in response to the speech input enhances user interactions with the computer system by reducing the likelihood of accidentally entering text spoken by the user to the text entry element, which improves user privacy.

In some embodiments, the visual indication is a visual characteristic with a value that changes over time in accordance with changes in a characteristic of the speech input (2034a), such as a glow effect around icon 1912a and/or insertion marker 1914 in FIG. 19C. In some embodiments, the visual characteristic is applied to an icon (e.g., 1912a) associated with dictation, such as an image of a microphone or an image of a person talking, such as in FIG. 19C. In some embodiments, the visual characteristic is applied to an insertion marker (e.g., 1914) displayed in the text entry element (e.g., 1910) at a location in text at which text corresponding to the speech input will be entered, such as in FIG. 19C. In some embodiments, the visual characteristic is initially applied to the icon (e.g., 1912a) in response to detecting attention (e.g., including gaze 1913b) of the user directed to the text entry field (e.g., 1906) of the user interface (e.g., 1902), such as in FIG. 19B, and, in response to detecting the speech input (e.g., 1916a) while displaying the text entry element (e.g., 1910) and icon (e.g., 1912a) while attention (e.g., 1913b) of the user is directed to the icon (e.g., 1912a), such as in FIG. 19B, the computer system (e.g., 101) displays the insertion marker (e.g., 1914) with the visual characteristic, such as in FIG. 19C. In some embodiments, the visual characteristic is a glow or highlight effect applied to the icon (e.g., 1912a) and/or insertion marker (e.g., 1914), such as in FIG. 19C. In some embodiments, the characteristic of the speech input is the volume or pitch of the speech input. In some embodiments, the computer system changes the size, color, intensity, or other value of the visual characteristic in accordance with the characteristic of the speech input. In some embodiments, the magnitude of the change in the value of the visual characteristic corresponds to magnitude of the change of the characteristic of the speech input. Displaying the visual characteristic with the value that changes over time in accordance with changes in the characteristic of the speech input enhances user interactions with the computer system by providing improved visual feedback to the user.

In some embodiments, such as in FIG. 19B, displaying the text entry element (e.g., 1910) includes displaying at least a portion of the text entry element (e.g., 1910) with at least partial translucency (e.g., 2036a). In some embodiments, such as in FIG. 19B, at least a portion of the text entry field (e.g., 1906) is visible through the portion of the text entry field (e.g., 1910) that is at least partially translucent. Displaying the text entry element with at least a portion being at least partially translucent enhances user interactions with the computer system by enabling the user to see at least part of the text entry field through the text entry element, which reduces the time it takes to view both the text entry field and text entry element.

In some embodiments, such as in FIG. 19C, displaying the text representation (e.g., 1912b) of the speech input in the text entry element (e.g., 1910) includes (2038a) displaying a cursor (e.g., 1914) at a predefined location relative to the text representation (e.g., 1912b) of the speech input (2038b). In some embodiments, such as in FIG. 19C, the cursor (e.g., 1914) is an insertion marker. In some embodiments, such as in FIG. 19C, the cursor (e.g., 1914) is displayed after text (e.g., 1912b) displayed in the text entry element (e.g., 1910), such as the text representation (e.g., 1912b) of the speech input. For example, for languages read left to right, the cursor is displayed to the right of the text representation of the speech input and for languages read right to left, the cursor is displayed to the left of the text representation of the speech input.

In some embodiments, such as in FIG. 19C, displaying the text representation (e.g., 1912b) of the speech input in the text entry element (e.g., 1910) includes (2038a) in response to receiving a first portion of the text entry input, displaying the cursor (e.g., 1914) at a first location in the text entry element (e.g., 1910) (2038c). In some embodiments, such as in FIG. 19C, the first location is after the text representation (e.g., 1912b) of the first portion of the text entry input in the text entry element (e.g., 1910).

In some embodiments, such as in FIG. 19C, displaying the text representation (e.g., 1912b) of the speech input in the text entry element (e.g., 1910) includes (2038a) in response to receiving the first portion of the text entry input and a second portion of the text entry input, displaying the cursor (e.g., 1914) at a second location different from the first location in the text entry element (e.g., 1910) (2038d). In some embodiments, such as in FIG. 19C, the second location is after the text representation (e.g., 1912b) of the second portion of the text entry input. In some embodiments, as the computer system continues to detect portions of the speech input, the computer system updates the text entry region to include text representations of the portions of the speech input with the cursor displayed after the most recently added text. In some embodiments, the cursor indicates a location within the text displayed in the text entry element at which text representations of the next portion of the speech input will be added in response to detecting the next portion of the speech input. Updating the position of the cursor in accordance with detecting additional portions of the speech input enhances user interactions with the computer system by providing improved visual feedback to the user.

In some embodiments, such as in FIG. 19C, displaying the cursor (e.g., 1914) includes displaying the cursor (e.g., 1914) with a visual indication that the computer system (e.g., 101) is configured to enter text into the text entry element (e.g., 1910) in response to receiving the speech input (2040a). In some embodiments, the visual indication is a visual characteristic that changes over time in accordance with a characteristic of the speech input, as described above. For example, the visual indication is a glow effect that changes in accordance with the volume and/or pitch of the speech input, as described in more detail above. Displaying the cursor with the visual indication that the computer system is configured to enter text into the text entry element in response to receiving the speech input enhances user interactions with the computer system by providing improved visual feedback to the user while dictating text to the text entry element.

In some embodiments, such as in FIG. 19C, the visual indication is an animated visual characteristic with a value that changes over time in accordance with a characteristic of the speech input (e.g., 1916b) (2042a). In some embodiments, the visual indication includes a glow and/or highlight effect and a size, color, intensity, opacity, and/or blur of the glow and/or highlight effect changes with the visual characteristic of the speech input, as described above. In some embodiments, the characteristic of the speech input is the volume and/or pitch of the speech input, as described above. Displaying an animated visual characteristic with a value that changes over time in accordance with the characteristic of the speech input enhances user interactions with the computer system by providing improved visual feedback to the user.

In some embodiments, while displaying the user interface (e.g., 1902) that includes the text entry field (e.g., 1906), without displaying the text entry element (e.g., 1910), the computer system (e.g., 101) detects (2044a), via the one or more input devices (e.g., 314), that attention (e.g., including gaze 1913a) of a user of the computer system (e.g., 101) is directed to the text entry field (e.g., 1906) and one or more criteria are satisfied, such as in FIG. 19A. In some embodiments, such as in FIG. 19A, detecting that attention of the user is directed to the text entry field (e.g., 1906) includes detecting that the gaze (e.g., 1913a) of the user is directed to the text entry field (e.g., 1906). In some embodiments, such as in FIG. 19A, the one or more criteria include a criterion that is satisfied when the attention (e.g., including gaze 1913a) the user is directed to text entry field (e.g., 1906) for at least a threshold amount of time (e.g., 0.1, 0.2, 0.3, 0.5, 1, 2, or 3 seconds). In some embodiments, the one or more criteria are satisfied when the computer system detects a ready state of the user. In some embodiments, the one or more criteria include a criterion that is satisfied when the hands of the user are in a respective hand shape, such as a pre pinch hand shape.

In some embodiments, in response to detecting the attention (e.g., including gaze 1913a) of the user is directed to the text entry field (e.g., 1906) and the one or more criteria are satisfied, such as in FIG. 19B, the computer system (e.g., 101) concurrently displays (2044b), via the display generation component (e.g., 101), the text entry element (e.g., 1910) and the user interface (e.g., 1902), such as in FIG. 19B.

In some embodiments, while concurrently displaying the text entry element (e.g., 1910) and the user interface (e.g., 1902), such as in FIG. 19B, in response to receiving the text entry input, in accordance with a determination that the attention (e.g., including gaze 1913c) of the user is not directed to the text entry element (e.g., 1910) while the text entry input is detected, such as in FIG. 19B, the computer system (e.g., 101) forgoes (2044c) updating display of the text entry element (e.g., 1910) to include the text representation of the speech input, wherein updating display of the text entry element (e.g., 1910) to include the text representation (e.g., 1912b) of the speech input without entering text into the text entry field (e.g., 1906) in response to receiving the text entry input, such as in FIG. 19C is in accordance with a determination that the attention (e.g., including gaze 1913b) of the user is directed to the text entry element (e.g., 1910) while the text entry input is detected, such as in FIG. 19B. In some embodiments, in accordance with the determination that the attention (e.g., including gaze 1913c) of the user is not directed to the text entry element (e.g., 1910) (e.g., for any amount of time or for a predetermined threshold time of 0.1, 0.2, 0.3, 0.5, 1, 2, or 3 seconds), such as in FIG. 19B, the computer system (e.g., 101) ceases display of the text entry element (e.g., 1910) and is not configured to enter text to the text entry field (e.g., 1906) via dictation, such as in FIG. 19A. Forgoing displaying the text representation of the speech input when the speech input is received while attention of the user is not directed to the text entry element enhances user interactions with the computer system by improving user privacy.

In some embodiments, while displaying the user interface (e.g., 1902) that includes the text entry field (e.g., 1906), without displaying the text entry element (e.g., 1902), such as in FIG. 19A, the computer system (e.g., 101) detects (2046a), via the one or more input devices (e.g., 314), that attention (e.g., 1913a) of a user of the computer system (e.g., 101) is directed to the text entry field (e.g., 1906) and one or more criteria are satisfied.

In some embodiments, in response to detecting the attention (e.g., 1913a) of the user is directed to the text entry field (e.g., 1906) and the one or more criteria are satisfied, such as in FIG. 19A, the computer system (e.g., 1010 concurrently displays (2046b), via the display generation component (e.g., 120), the text entry element (e.g., 1910) and the user interface (e.g., 1902), such as in FIG. 19B. In some embodiments, the one or more criteria are the one or more criteria described above with respect to causing the computer system to concurrently display the text entry element and the user interface in response to detecting the attention of the user directed to the text entry field and the one or more criteria.

In some embodiments, while concurrently displaying the text entry element (e.g., 1910) and the user interface (e.g., 1902), the computer system (e.g., 101) detects (2046c) that the attention (e.g., including gaze 1913c) of the user is directed away from the text entry field (e.g., 1906) and one or more second criteria are satisfied, such as in FIG. 19B. In some embodiments, such as in FIG. 19B, the one or more second criteria include a criterion that is satisfied when the computer system (e.g., 101) detects that the attention (e.g., including gaze 1913c) of the user is directed away from the text entry field (e.g., 1906) for a threshold amount of time, such as 0.1, 0.2, 0.3, 0.5, 1, 2, or 3 seconds. In some embodiments, the one or more second criteria include a criterion that is satisfied when the computer system detects that the attention (e.g., including gaze 1913b) of the user is directed away from the text entry field (e.g., 1906) for any amount of time, such as in FIG. 19B. In some embodiments, the one or more second criteria include a criterion that is satisfied when the computer system detects a ready state of the user.

In some embodiments, in response to detecting that the attention (e.g., including gaze 1913c) of the user is directed away from the text entry field (e.g., 1906) and the one or more second criteria are satisfied, such as in FIG. 19B, the computer system (e.g., 101) ceases (2046d) display of the text entry element (e.g., 1910). In some embodiments, if the text entry element (e.g., 1910) includes the text representation (e.g., 1912b) of the speech input while the computer system (e.g., 101) detects the attention (e.g., including gaze 1913e) of the user directed away from the text entry field (e.g., 1906) and the one or more second criteria being satisfied, such as in FIG. 19C, the computer system (e.g., 101) ceases display of the text representation (e.g., 1912b) of the speech input without entering the text representation (e.g., 1912b) of the speech input into the text entry field (e.g., 1906), such as in FIG. 19A or FIG. 19B. In some embodiments, such as in FIG. 19A, the computer system (e.g., 101) maintains display of the user interface (e.g., 1902) with the text entry field (e.g., 1906) when ceasing display of the text entry element (e.g., 1910). Ceasing display of the text input element in response to detecting the attention of the user away from the text entry field and that the one or more second criteria are satisfied enhances user interactions with the computer system by reducing the number of inputs needed to cancel dictation input, which saves time and battery life.

In some embodiments, while displaying the text representation (e.g., 1912b) of the speech input in the text entry element (e.g., 1910) in response to detecting the text entry input, such as in FIG. 19C, the computer system (e.g., 101) detects (2048a) that the attention (e.g., including gaze 1913e) of the user is directed away from the text entry field (e.g., 1906) and the one or more second criteria are satisfied. In some embodiments, the computer system displays the text entry element in response to detecting the attention (e.g., including gaze) of the user directed to the text entry field, optionally while providing the speech input.

In some embodiments, in response to detecting that the attention (e.g., 1913e) of the user is directed away from the text entry field (e.g., 1906) and the one or more second criteria are satisfied, such as in FIG. 19C, the computer system (e.g., 101) ceases (2048b) display of the text entry element (e.g., 1910) and the text representation (e.g., 1912b) of the speech input without entering the text into the text entry field (e.g., 1906), such as in FIG. 19A or FIG. 19B. In some embodiments, after ceasing display of the text entry element (e.g., 1910), in response to detecting the attention (e.g., including gaze 1913a) of the user directed to the text entry field (e.g., 1906) and one or more criteria being satisfied as described above, such as in FIG. 19A, the computer system (e.g., 101) displays the text entry element (e.g., 1910) without displaying the text representation of the speech input, such as in FIG. 19B. As described above, in some embodiments, the computer system does not share the text representation of the speech input and/or the speech input itself with the application associated with the text entry field unless and until the text is entered. Ceasing display of the text entry element and the text representation of the speech input without entering the text into the text entry field in response to detecting the attention of the user directed away from the text entry field and the one or more second criteria being satisfied enhances user interactions with the computer system by improving user privacy.

In some embodiments, the computer system (e.g., 101) concurrently displays (2050a), via the display generation component (e.g., 120), the user interface (e.g., 1902) that includes the text entry field (e.g., 1906) and a soft keyboard (e.g., 1920) including a text dictation element (1922a), such as in FIG. 19E. In some embodiments, the soft keyboard has one or more characteristics of the soft keyboard(s) described above with reference to method(s) 1200, 1400, and/or 1600. In some embodiments, the computer system initiates display of the soft keyboard according to one or more steps of method(s) 1200, 1400, and/or 1600. In some embodiments, such as in FIG. 19E, the dictation element (e.g., 1922a) is a selectable option that, when selected, causes the computer system (e.g., 101) to initiate a process to accept dictation input directed to a text entry field (e.g., 1906) that has the current focus of the soft keyboard (e.g., 1920).

In some embodiments, while concurrently displaying, via the display generation component (e.g., 120), the user interface (e.g., 1902) and the soft keyboard (e.g., 1920) (2050b), such as in FIG. 19E, the computer system (e.g., 101) receives (2050c), via the one or more input devices (e.g., 314), a second text entry input directed to the dictation element (e.g., 1922a), wherein the second text entry input includes a second speech input (e.g., 1916c), such as in FIGS. 19E and 19F. In some embodiments, the second text entry input includes selection of the dictation element (e.g., 1922a), such as in FIG. 19E, and the speech input (e.g., 1916c), such as in FIG. 19F. In some embodiments, such as in FIG. 19E, the selection input includes an air gesture as described above.

In some embodiments, while concurrently displaying, via the display generation component (e.g., 120), the user interface (e.g., 1902) and the soft keyboard (e.g., 1920) (2050b), such as in FIG. 19E, in response to receiving the second text entry input, the computer system (e.g., 101) displays (2050d), via the display generation component (e.g., 120), a text representation (e.g., 1922h) of the second speech input. In some embodiments, the computer system (e.g., 101) displays the text representation (e.g., 1922H) of the second speech input in a user interface element (e.g., 1924) displayed in association with the soft keyboard (e.g., 1920), such as in FIG. 19G. In some embodiments, such as in FIG. 19G, the user interface element (e.g., 1920) includes a text preview region (e.g., 1922b) that mirrors text entered (e.g., 1934) into the text entry field (e.g., 1906) that has the current focus of the soft keyboard (e.g., 1920), the dictation element (e.g., 1922a), one or more text entry recommendations (e.g., 1922f and/or 1922g), and/or one or more other selectable options for editing the text in the text entry field (e.g., 1906) that has the current focus of the soft keyboard (e.g., 1920). In some embodiments, the user interface element has one or more characteristics in common with user interface elements displayed in association with soft keyboards according to one or more of methods 1200, 1400, and/or 1600. In some embodiments, such as in FIG. 19G, the computer system (e.g., 101) concurrently displays the text representation (e.g., 1922h) in the user interface element and in the text entry field (e.g., 1906) that has the current focus of the soft keyboard (e.g., 1920). In some embodiments, while displaying the text representation (e.g., 1922h) of the second speech input, the computer system (e.g., 101) maintains display of the soft keyboard (e.g., 1920), such as in FIG. 19G.

In some embodiments, while displaying the user interface (e.g., 1902) that includes the text entry field (e.g., 1906) without displaying the soft keyboard (e.g., 1920) and without displaying the text entry element (e.g., 1910), the computer system (e.g., 101) receives (2050e), via the one or more input devices (e.g., 314), an input corresponding to a request to dictate text to the text entry field, such as in FIG. 19A.

In some embodiments, concurrently displaying the user interface (e.g., 1902) and the text entry element (e.g., 1910), such as in FIG. 19B, is in response to the input corresponding to the request to dictate the text to the text entry field (e.g., 1906), and concurrently displaying the user interface (e.g., 1902) and the text entry element (e.g., 1910) is without displaying the soft keyboard (e.g., 1910). In some embodiments, the text entry input described above is an input corresponding to a request to dictate text to the text entry field. In some embodiments, if the input corresponding to a request to dictate text (e.g., the text entry input including the speech input) is detected while the computer system is not displaying the keyboard, the computer system initiates dictation without displaying the soft keyboard. In some embodiments, if the input corresponding to the request to dictate text (e.g., the second text entry input) is detected while the computer system is displaying the soft keyboard, the computer system maintains display of the soft keyboard while initiating dictation. Forgoing display of the soft keyboard in response to receiving the input corresponding to the request to dictate text to the text entry field while the soft keyboard is not displayed enhances user interactions with the computer system by providing text entry options without cluttering the user interface with displaying a soft keyboard.

In some embodiments, while concurrently displaying, via the display generation component (e.g., 120), the text entry field (e.g., 1906) with the text representation (e.g., 1912b) of the speech input and the user interface (e.g., 1902) without displaying the soft keyboard (e.g., 1920), such as in FIG. 19C, the computer system (e.g., 101) detects (2052a), via the one or more input devices (e.g., 314), that one or more criteria are satisfied, including a criterion that is satisfied when attention (e.g., including gaze 1913e) of the user of the computer system (e.g., 101) is directed away from the text entry field (e.g., 1906). In some embodiments, such as in FIG. 19C, detecting the attention away from the text entry field (e.g., 1906) includes detecting the gaze (e.g., 1913e) away from the text entry field (e.g., 1906). In some embodiments, the one or more criteria include a criterion that is satisfied when the attention of the user is directed away from the text entry field for at least a threshold amount of time, such as 0.1, 0.2, 0.3, 0.5, 1, 2, or 3 seconds. In some embodiments the one or more criteria include a criterion that is satisfied when the attention of the user is directed away from the text entry field for any amount of time.

In some embodiments, in response to detecting that the one or more criteria are satisfied, the computer system (e.g., 101) ceases (2052b) display of the text representation (e.g., 1912b) of the speech input, such as in FIG. 19A or FIG. 19B. In some embodiments, such as in FIG. 19A, the computer system (e.g., 101) also ceases display of the text entry element (e.g., 1910). In some embodiments, such as in FIG. 19A or FIG. 19B, the computer system (e.g., 101) forgoes entering the text into the text entry region (e.g., 1906). In some embodiments, such as in FIG. 19A or FIG. 19B, in addition to ceasing display of the text representation (e.g., 1912b) of the speech input, the computer system (e.g., 101) forgoes adding the text representation of the speech input to the text entry field (e.g., 1906).

In some embodiments, while concurrently displaying, via the display generation component (e.g., 120), the soft keyboard (e.g., 1920), the user interface (e.g., 1902), and the text representation (e.g., 1922h) of the second speech input (2052c), such as in FIG. 19G, the computer system (e.g., 101) detects (2052d), via the one or more input devices (e.g., 314), that the one or more criteria are satisfied.

In some embodiments, while concurrently displaying, via the display generation component (e.g., 120), the soft keyboard (e.g., 1920), the user interface (e.g., 1902), and the text representation (e.g., 1922h) of the second speech input (2052c), such as in FIG. 19G, in response to detecting the one or more criteria are satisfied, the computer system (e.g., 101) maintains (2052e) display of the text representation (e.g., 1922h) of the second speech input. In some embodiments, while the computer system is configured for dictation without displaying the soft keyboard, the computer system ceases dictation in response to detecting the attention of the user directed away from the text entry field and the one or more criteria being satisfied, but if the computer system is configured for dictation while displaying the soft keyboard, the computer system remains configured for dictation in response to detecting the attention of the user directed away from the text entry field and the one or more criteria being satisfied. In some embodiments, while the computer system is concurrently displaying the soft keyboard and the text representation of the second speech input, in response to detecting a third speech input, the computer system displays a text representation of the third speech input after the text representation of the second speech input. In some embodiments, the computer system additionally enters the text representation of the speech input to the text entry field. In some embodiments, in accordance with one or more second criteria being satisfied (e.g., detecting of a commit input described above, a predetermined threshold time (e.g., 0.1, 0.2, 0.5, 1, 2, or 3 seconds) passing since detecting the speech input), the computer system enters the text representation of the speech input to the text entry field. Ceasing dictation in response to detecting the attention of the user directed away from the text entry field while soft keyboard is not displayed enhances user interactions with the computer system by improving user privacy. Continuing dictation in response to detecting the attention of the user directed away from the text entry field while the soft keyboard is displayed enhances user interactions with the computer system by reducing the number of inputs and time needed to dictate text to the text entry field.

In some embodiments, aspects/operations of methods 800, 1000, 1200, 1400, 1600, 1200, 2200, and/or 2400 may be interchanged, substituted, and/or added between these methods. For example, the computer system enters text in response to speech input in accordance with methods 1000 and 2000. For brevity, these details are not repeated here.

FIGS. 21A-21G illustrate example techniques of revising text included in a text entry field in accordance with some embodiments. The user interfaces in FIGS. 21A-21G are used to illustrate the processes described below, including the processes in FIGS. 22A-22H.

FIG. 21A illustrates a computer system 101 displaying, via a display generation component (e.g., display generation component 120 of FIG. 1), a three-dimensional environment 2101 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

In FIG. 21A, the computer system 101 concurrently displays a user interface 2102 including text entry fields 2104a, 2104b, and 2104c and soft keyboard 2128. For example, the user interface 2102 is a user interface of an e-mail application. In this example, the user interface 2102 includes a text entry field 2104a for the recipients of an e-mail, a text entry field 2104b for the subject of the e-mail, and a text entry field 2104c for the body of the e-mail and a selectable option 2106 that, when selected, causes the computer system 101 to send the e-mail to the e-mail addresses and/or contacts included in the text entry field 2104a for the e-mail recipients. In some embodiments, soft keyboard 2128 includes a plurality of keys, including a first key 2130a, a second key 2130b, and a delete key 2132c. The computer system 101 optionally displays a selectable option 2126a that, when selected, initiates a process to reposition the soft keyboard 2128; a selectable option 2126b that, when selected, initiates a process to resize the soft keyboard 2128; and a user interface element 2124 proximate to the location in the environment 2101 at which the soft keyboard 2128 is displayed. In some embodiments, the computer system 101 repositions and/or resizes the soft keyboard 2128 in response to an input directed to option 2126a or option 2126b, respectively, in accordance with one or more steps of method 1200 described above. In some embodiments, the user interface element 2124 is similar to user interface elements displayed in association with soft keyboards according to one or more steps of method(s) 1200, 1400, 1600, and/or 2000 described above. In FIG. 21A, the user interface element 2124 includes a selectable option 2122a that, when selected, causes the computer system 101 to initiate a process to accept dictation input to enter text; a text entry field 2122b that optionally mirrors a text entry field that has the current focus of the soft keyboard 2128, and selectable options 2122f and 2122g that, when selected, cause the computer system 101 to insert suggested text into the text entry field that has the current focus of the soft keyboard 2128. In some embodiments, the selectable option 2122a for initiating dictation is included in the soft keyboard 2128 itself, in addition or as an alternative to the option 2122a being displayed in user interface element 2124.

In FIG. 21A, text entry field 2104b has the current focus of the soft keyboard 2128. In some embodiments, the computer system 101 displays the text entry field 2104b with a different visual characteristic than the visual characteristics of the other text entry fields 2104a and 2104c, such as displaying the text entry field 2104b with a bold or highlighted outline, to indicate that the text entry field 2104b has the current focus. Additionally or alternatively in some embodiments, the computer system 101 displays an insertion marker 2108 in the text entry field 2104b that has the current focus of the soft keyboard 2128 at a location at which text will be inserted in response to one or more inputs directed to the soft keyboard 2128. In some embodiments, the computer system 101 enters text into the text entry field 2104b in response to one or more inputs selecting one or more keys (e.g., key 2130a and/or 2130b) of the soft keyboard 2128, such as according to one or more steps of method(s) 1200, 1400, and/or 1600 described above and/or in response to dictation input initiated in response to detecting selection of option 2122a according to one or more steps of method 2000 described above.

In FIG. 21A, the computer system 101 detects a plurality of inputs selecting keys, including keys 2130a and 2130b of soft keyboard. Detecting the inputs optionally includes detecting air gesture inputs, such as direct and/or indirect air gesture inputs, performed with hands 2103a and 2103b, as described in more detail above. In some embodiments, while the user interacts with the soft keyboard 2128 using hands 2103a and 2103b, the computer system 101a displays simulated shadows 2132a and 2132b overlaid on keys 2130a and 2130b in a manner similar to one or more steps of method(s) 1200, 1400 and/or 1600. In some embodiments, in response to detecting a sequence of inputs including the inputs illustrated in FIG. 21A, the computer system 101a updates the text entry field 2104b and text entry field 2122b to include text corresponding to the received inputs as shown in FIG. 21B. In some embodiments, while entering the text, the computer system 101 updates the positions of the insertion marker 2108 in text entry field 2104b and the insertion marker 2122e in text entry field 2122b in accordance with the addition of text. For example, the computer system maintains display of the insertion markers 2108 and 2122e to the right of the inserted text for languages read from left to right or to the left of the inserted text for languages read from right to left.

FIG. 21B illustrates the computer system 101 displaying text 2122h and text 2110 in response to the sequence of inputs described above with reference to FIG. 21A. As shown in FIG. 21B, the computer system 101 displays text 2110 and insertion marker in text entry field 2104b and displays text 2122h and insertion marker 21223 in text entry field 2122b. In some embodiments, in response to inserting text 2110 into text entry field 2104b and inserting text 2122h into text entry field 2122b, the computer system updates the recommended text associated with options 2122f and 2122g included in user interface element 2124.

In some embodiments, the computer system 101 detects the attention of the user (e.g., including gaze 2113a) directed to a portion of text entry field 2122b and, in response, displays a selectable option 2122i that, when selected, causes the computer system 101 to delete one or more characters from text entry field 2122b. In some embodiments, the computer system 101 displays the option 2122i in response to detecting the attention of the user directed to any portion of the text entry field 2122b. In some embodiments, the computer system 101 displays the option 2122i in response to detecting the attention of the user directed to the insertion marker 2122e in the text entry field 2122b. In some embodiments, the computer system 101 displays the option 2122i in response to detecting the attention of the user directed to a portion of text 2122h at the end of the text 2122h in the text entry field 2122b. In some embodiments, when the computer system deletes one or more characters from text entry field 2122b in response to selection of option 2122i (or in response to selection of option 2132c), the computer system 101 also deletes corresponding characters from the text 2110 in text entry field 2104b.

In FIG. 21B, the computer system 101 detects an input corresponding to a request to delete one or more characters from text 2122h and text 2110. In some embodiments, the input includes selection of option 2122i. In some embodiments, the input includes selection of the insertion marker 2122e. The selection input is optionally an air gesture input provided with hand 2103b. For example, the air gesture input is a direct input provided by hand 2103b. As another example, the air gesture input is an indirect input provided by hand 2103b and attention of the user (e.g., including gaze 2113a). In some embodiments, the air gesture input includes a pinch gesture or a pressing gesture. In some embodiments, if the user performs the pinch or pressing gesture more than one time, the computer system 101 deletes a plurality of characters from text 2110 and text 2122h that corresponds to the number of times the computer system 101 detected the pinch or press gesture. In some embodiments, if the user holds a pinch hand shape as part of a pinch gesture or holds their hand forward as part of a pressing gesture, the computer system 101 continuously deletes characters from the text 2110 and text 2122h while the pinch hand shape or forward position is maintained. In some embodiments, in FIG. 21B, the computer system 101 detects an input corresponding to a request to delete one character from text 2110 and text 2122h, as shown in FIG. 21C.

In some embodiments, when the computer system 101 adds or deletes text from text entry field 2122b as described above, the computer system 101 updates the position of option 2122i and/or insertion marker 2122e within the text entry field 2122b. For example, in response to an input to add text, the computer system 101 updates the position of the insertion marker 2122e to be after the inserted text and updates the position of the option 2122i to be after the insertion marker 2122e. As another example, in response to an input to delete text, the computer system 101 updates the position of the insertion marker 2122e to be after the text that was positioned before the deleted text and updates the position of the option 2122i to be after the insertion marker 2122e. In some embodiments, because the computer system 101 updates position of the option 2122i and insertion marker 2122e in response to deleting text, the location within the text entry field 2122b at which the user must look to delete text by interacting with option 2122i or insertion marker 2122e changes each time text is deleted.

FIG. 21C illustrates the computer system 101 displaying the text 2110 and text 2122h updated in response to the input illustrated in FIG. 21B. In response to the input corresponding to a request to delete the character from text 2110 and text 2122h, the computer system 101 optionally deletes the character that is to the left of insertion marker 2108 and insertion marker 2122e, respectively, for languages read from left to right. If the language in FIG. 21C was a language read from right to left, the computer system 101 would optionally delete the character to the right of the insertion marker 2108 and insertion marker 2122e. In some embodiments, in response to deleting the character from text 2110 and text 2122h, the computer system 101 updates the recommended text associated with options 2122f and 2122g included in the user interface element 2124.

As shown in FIG. 21C, the computer system 101 detects another air gesture input provided by hand 2103b that corresponds to a request to delete another character from text 2110 and text 2122h. For example, the input is a direct air gesture input including a gesture performed with hand 2103b or the input is an indirect air gesture input including a gesture performed with hand 2103b while the attention (e.g., optionally including gaze 2113b) of the user is directed to the text entry field 2122b as described above. In some embodiments, in response to the input corresponding to the request to delete the character from text 2110 and text 2122b, the computer system 101 updates the text 2110 and text 2122b to delete the character. For example, the computer system 101 updates the text “Howd” to read “How.”

As shown in FIG. 21C, the computer system 101 further detects a sequence of inputs, including an input provided by hand 2103a, corresponding to a request to add additional characters to text 2110 and text 2122h. For example, the computer system 101 detects hand 2103a provide an input directed to the space bar of keyboard 2128 followed by detecting selection of one or more additional keys of the keyboard 2128. In some embodiments, the computer system 101 updates text 2110 and text 2122h in accordance with the sequence of inputs directed to the keyboard 2128. FIG. 21D illustrates text 2110 and text 2122h updated in accordance with a sequence of inputs including the inputs illustrated in FIG. 21C.

In FIG. 21D, the computer system 101 displays the text 2110 and text 2122h updated in response to a sequence of inputs including the inputs illustrated in FIG. 21C. In some embodiments, updating the text 2110 and text 2122h in FIG. 21D includes deleting a character displayed in FIG. 21C and adding characters to the text 2110 and text 2122h. In some embodiments, the computer system 101 further detects an input corresponding to a request to reposition insertion marker 2122e in text entry field 2122b and to reposition insertion marker 2108 in text entry field 2104b in a corresponding manner In response to the input, in some embodiments, the computer system 101 displays insertion markers 2108 and 2122e at the locations illustrated in FIG. 21D. In some embodiments, the computer system 101 updates the options 2122f and 2122g that, when selected, cause the computer system 101 to insert recommended text in accordance with the updated text 2110 and text 2122h and the positions of insertion markers 2108 and 2122e.

As shown in FIG. 21D, the computer system 101 displays a portion of text 2122h that is the right of the insertion marker 2122e (for a language read left to right) with a lighter color than the portion of the text 2122h that is to the left of the insertion marker 2122e. In some embodiments, in response to an input to add text at the location of insertion marker 2122e, the computer system 101 will update the portion of text to the right of the insertion marker 2122e to make space for the inserted text, so displaying the portion of text to the right of the insertion marker 2122e in the lighter color may make it more comfortable for the user to view the text entry field 2122b while adding text. In some embodiments, the computer system 101 alters a visual characteristic of text 2122h other than color. As shown in FIG. 21D, in some embodiments, the computer system 101 displays text 2110 with one color, such as displaying the portion of text 2110 to the right of insertion marker 2108 with the same color as the portion of text 2110 to the left of insertion marker 2108. In some embodiments, the computer system 101 displays the portions of text 2110 on either side of insertion marker 2108 with one or more additional visual characteristics other than color in common. In some embodiments, the computer system 101 displays the portions of text 2110 on either side of the insertion marker 2108 with different visual characteristics in a manner similar to the way in which the computer system 101 displays the text 2122h.

In some embodiments, as shown in FIG. 21D, the computer system 101 receives a sequence of inputs provided by hands 2103a and 2103b directed to soft keyboard 2128. In some embodiments, the sequence of inputs corresponds to a request to update text 2110 and text 2122h in accordance with the keys to which the inputs in the sequence of inputs are directed. In some embodiments, in response to detecting the sequence of inputs including the inputs illustrated in FIG. 21D, the computer system 101 updates text 2110 and text 2122h as shown in FIG. 21E.

In FIG. 21E, the computer system 101 displays text 2110 and text 2122h updated in accordance with the sequence of inputs including the inputs illustrated in FIG. 21D. For example, the computer system 101 inserted “your day” between “How's” and “going” in text 2110 and text 2122h. In some embodiments, after inserting the text, the computer system 101 detected an input selecting a portion (e.g., “your day”) of text 2110 and 2122h. In some embodiments, the computer system 101 indicates selection of a portion of text 2122h with highlighting 2112 and indicates selection of a corresponding portion of text 2110 with highlighting 2122j. As shown in FIG. 21E, in some embodiments, text entry field 2122b is smaller than the length of text 2122h, so a portion of text 2122h at the beginning of text 2122h is not displayed in text entry field 2122b. In some embodiments, the text entry field 2122b is scrollable to selectively hide and reveal portions of text 2122h as requested by the user. In some embodiments, the computer system 101 displays a portion of the text 2122h that is proximate to the portion of the text 2122h that is not displayed with a lighter color and/or increased translucency compared to the rest of the text 2122h. In some embodiments, the highlighting 2122j is also displayed with a lighter color and/or increased translucency towards the edge of text entry field 2122b. In some embodiments, if there is additional text to the left of text entry field 2122b, such as in FIG. 21E, the computer system displays the text 2122h and highlighting 2122j at the left edge with the lighter color and/or increased translucency and/or if there is additional text to the right of text entry field 2122b, the computer system displays the text 2122h and highlighting 2122j at the right edge with the lighter color and/or increased translucency.

In some embodiments, in response to receiving an input corresponding to a request to add to text 2110 and text 2122h while a portion of text 2110 and text 2122h is highlighted, the computer system 101 replaces the highlighted portion of text 2110 and text 2122h with text corresponding to the input. In some embodiments, the input corresponding to the request to add text is one or more inputs selecting one or more keys of soft keyboard 2128, such as one of the inputs described above with reference to FIGS. 21A, 21C, and/or 21D. In some embodiments, the input corresponding to the request to add text is a sequence of inputs to dictate text to the text entry field. In some embodiments, the computer system 101 enters text to text entry fields 2104b and 2122b via dictation while keyboard 2128 is displayed according to one or more steps of method 2000.

In some embodiments, the computer system initiates the process to accept dictation input in response to detecting selection of option 2122a. For example, the computer system 101 detects an air gesture input including attention (e.g., optionally including gaze 2113d) directed to the option 2122a while detecting the user perform a gesture (e.g., a pinch air gesture) with hand 2103b. In some embodiments, the computer system 101 detects selection of option 2122a via direct or indirect air gesture input. In some embodiments, after detecting selection of option 2122a or while attention of the user (e.g., including gaze 2113d) is directed to option 2122a (e.g., optionally without previously detecting selection of option 2122a), the computer system 101a detects a speech input 2116. In some embodiments, the attention of the user, optionally including gaze 2113d, is directed to the option 2122a while the computer system 101 detects the speech input 2116. In some embodiments, the attention of the user, optionally including gaze 2113d, is directed to the text entry field 2104b while the computer system 101 detects the speech input 2116. In some embodiments, irrespective of the location in the environment 2101 to which attention of the user is directed while the computer system 101 detects the speech input 2116 while displaying the soft keyboard 2128i, the computer system 101 enters text corresponding to the speech input 2116 in response to the speech input 2116, as described above with reference to method 2000 and as shown in FIG. 21F.

In some embodiments, after detecting the speech input 2116 described above, the computer system 101 detects selection of text entry field 2104c while text entry field 2104b has the current focus of the soft keyboard 2128. In some embodiments, the selection input selecting the text entry field 2104c is an air gesture input provided via hand 2103b optionally while detecting the attention, optionally including gaze 2113c, of the user directed to the text entry field 2104c. In some embodiments, in response to detecting selection of text entry field 2104c, the computer system 101 updates the current focus of the soft keyboard 2128 from text entry field 2104b to text entry field 2104c, as shown in FIG. 21F.

FIG. 21F illustrates the computer system 101 displaying the environment 2101 updated in response to the sequence of inputs described above with referenced to FIG. 21E. In some embodiments, in response to the speech input illustrated in FIG. 21E, the computer system 101 updates text 2110 to include a text representation of the speech input (e.g., “it”). In some embodiments, while text entry field 2104b has the current focus of soft keyboard 2128, as was the case in FIGS. 21A-21E, the computer system 101 displays text in text entry field 2122b corresponding to the text in text entry field 2104b, including the updated text 2110 shown in FIG. 21F.

In FIG. 21F, text entry field 2104c has the current focus of the soft keyboard 2128 in response to the input illustrated in FIG. 21E. While text entry field 2104c has the current focus of soft keyboard 2128, the computer system 101 displays text in text entry field 2122b corresponding to the contents of text entry field 2104c. In FIG. 21F, because there is no text in text entry field 2104c, the computer system 101 displays text entry field 2122b without text as well. Thus, in some embodiments, in response to the input illustrated in FIG. 21E corresponding to the request to move the current focus of soft keyboard 2128, the computer system 101 ceases to display text corresponding to the text in text entry field 2104b in text entry field 2122b. In some embodiments, if the computer system 101 were to detect one or more inputs corresponding to a request to enter text into text entry field 2104c, the computer system 101 would enter the text into text entry field 2104c and enter a representation of the text in text entry field 2104c in text entry field 2122b.

In FIG. 21F, the computer system 101 detects selection of option 2106 included in user interface 2102. In some embodiments, the input is an air gesture input provided by hand 2103b optionally while attention (e.g., optionally including gaze 2113e) of the user is directed to the selectable option 2106. In some embodiments, in response to detecting selection of any portion of environment 2101 that does not include a text entry field, the computer system 101 ceases to display the soft keyboard 2128, as shown in FIG. 21G. In some embodiments, in response to the input illustrated in FIG. 21F, the computer system 101 sends the e-mail shown in the user interface 2102. In some embodiments, the computer system 101 forgoes sending the e-mail in response to the input illustrated in FIG. 21F, but would send the e-mail in response to detecting selection of option 2106 while the computer system 101 is not displaying the soft keyboard 2128.

FIG. 21G illustrates the computer system 101 displaying the environment 2101 without the soft keyboard in response to the input illustrated in FIG. 21F. In some embodiments, if the computer system 101 were to detect selection of one of the text entry fields 2104a, 2104b, or 2104c, the computer system 101 would initiate display of the soft keyboard as shown in FIGS. 21A-21F.

FIGS. 22A-22H is a flow diagram of methods of revising text included in a text entry field in accordance with some embodiments. In some embodiments, method 2200 is performed at a computer system (e.g., computer system 101 in FIG. 1) including a display generation component (e.g., display generation component 120 in FIGS. 1, 3, and 4). In some embodiments, the method 2200 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 2200 are, optionally, combined and/or the order of some operations is, optionally, changed.

In some embodiments, method 2200 is performed at a computer system (e.g., 101) in communication with a display generation component (e.g., 120) and one or more input devices (e.g., 314). In some embodiments, the computer system is the same as or similar to the electronic device(s) and/or computer system(s) described above with reference to method(s) 800, 1000, 1200, 1400, 1600, 1800, and/or 2000. In some embodiments, the one or more input devices are the same as or similar to the one or more input devices described above with reference to method(s) 800, 1000, 1200, 1400, 1600, 1800, and/or 2000. In some embodiments, the display generation component is the same as or similar to the display generation component described above with reference to method(s) 800, 1000, 1200, 1400, 1600, 1800, and/or 2000.

In some embodiments, such as in FIG. 21B, the computer system (e.g., 101) concurrently displays (2202a), via the display generation component (e.g., 120), a soft keyboard (e.g., 2128) including a plurality of keys (e.g., 2130a and/or 2130b) and a user interface element (e.g., 2124) including a representation of text (e.g., 2122h), wherein the representation of the text (e.g., 2122h) corresponds to text included in a text entry field (e.g., 2104b) (e.g., that was entered into the text entry field via the text entry element such as described with reference to method 2000, via the soft keyboard, via a hardware keyboard, or in response to an indication of the text provided by another computer system). In some embodiments, the computer system (e.g., 101) displays the text entry field (e.g., 2104b) concurrently with the soft keyboard (e.g., 2128) and the user interface element (e.g., 2124) including the representation of the text (e.g., 2122h). In some embodiments, such as in FIG. 21B, the text entry field (e.g., 2104b) has the current focus of the soft keyboard (e.g., 2128) (e.g., selection of keys detected at the soft keyboard (e.g., 2128) will cause corresponding text to be entered into the text entry field (e.g., 2104b) and not entered into a different text entry field (e.g., 2104a or 2104b) that is optionally being displayed). In some embodiments, the representation of text is displayed in a representation of a portion of a user interface including the text entry field according to one or more steps of method 1200 described above. In some embodiments, such as in FIG. 21B, the representation of text (e.g., 2122h) includes (all or a portion of the) text (e.g., 2110) included in the text entry field (e.g., 2104b).

In some embodiments, while displaying the soft keyboard (e.g., 2128) and the user interface element (e.g., 2124) (2202b), the computer system (e.g., 101) receives (2202c), via the one or more input devices (e.g., 314), a selection input, such as in FIG. 21A or FIG. 21B. In some embodiments, the selection input is provided via an air gesture described above, such as a direct input or an indirect input. For example, detecting the selection input includes detecting the user perform an air pinch gesture or air tap gesture with their hand while their attention is directed to a respective user interface element. As another example, detecting the selection input includes detecting the user perform a pressing or tapping gesture with their hand (e.g., the tip of their index finger) optionally while the attention of the user is directed to a respective user interface element.

In some embodiments, while displaying the soft keyboard (e.g., 2128) and the user interface element (e.g., 2124) (2202b), in response to receiving the selection input (e.g., air gesture, touch input, gaze input or other user input) (2202d), in accordance with a determination that the selection input includes attention of the user directed to a first key (e.g., 2130a) of the plurality of keys of the soft keyboard (e.g., 2128) (e.g., the selection input is directed to the first key, the selection input does not include detecting the attention of the user directed to a second key of the soft keyboard or to a portion of the user interface element), such as in FIG. 21A, the computer system (e.g., 101) updates (2202e) display, via the display generation component (e.g., 120), of the representation of the text (e.g., 2122h) to include a first character corresponding to the first key (e.g., without updating the text to include characters corresponding other keys in the plurality of keys of the soft keyboard, such as a character corresponding to the second key), such as in FIG. 21B. In some embodiments, the first character is a letter, number, or special character. In some embodiments, the computer system additionally or alternatively updates the text entry field to include the first character in response to receiving the selection input in accordance with the determination that the selection input includes the attention of the user directed to the first key. In some embodiments, the first character is displayed in the user interface element at a location adjacent to an insertion marker in the user interface element that indicates the location within the representation of text at which additional characters will be entered. In some embodiments, when the first character is entered, the location of the insertion marker is updated (e.g., to be after the first character in the representation of text). In some embodiments, the computer system displays a second insertion marker in the text entry field at a position in the text displayed in the text entry field that corresponds to the position of the insertion marker in the representation of text and updates the location of the second insertion marker in the text entry field when the first character is entered.

In some embodiments, while displaying the soft keyboard (e.g., 2128) and the user interface element (e.g., 2124) (2202b), in response to receiving the selection input (e.g., air gesture, touch input, gaze input or other user input) (2202d), in accordance with a determination that the selection input includes the attention of the user directed to a second key (e.g., 2130b) different from the first key (e.g., 2130a) of the plurality of keys of the soft keyboard (e.g., 2128) (e.g., the selection input is directed to the second key, the selection input does not include detecting the attention of the user directed to the first key of the soft keyboard or to a portion of the user interface element), such as in FIG. 21A, the computer system (e.g., 101) updates (2202g) display, via the display generation component (e.g., 120), of the representation (e.g., 2122h) of the text to include a second character corresponding to the second key, the second character different from the first character (e.g., without updating the text to include characters of other keys in the plurality of keys of the soft keyboard, such as a character corresponding to the first key), such as in FIG. 21B. In some embodiments, the second character is a letter, number, or special character. In some embodiments, the computer system additionally or alternatively updates the text entry field to include the second character in response to receiving the selection input in accordance with the determination that the selection input includes the attention of the user directed to the second key. In some embodiments, the second character is displayed in the user interface element at a location adjacent to the insertion marker in the user interface element. In some embodiments, when the second character is entered, the location of the insertion marker is updated (e.g., to be after the second character in the representation of text). In some embodiments, the computer system displays a second insertion marker in the text entry field at a position in the text displayed in the text entry field that corresponds to the position of the insertion marker in the representation of text and updates the location of the second insertion marker in the text entry field when the second character is entered.

In some embodiments, while displaying the soft keyboard (e.g., 2128) and the user interface element (e.g., 2124) (2202b), in response to receiving the selection input (e.g., air gesture, touch input, gaze input or other user input) (2202d), in accordance with a determination that the selection input includes the attention of the user directed to a portion of the user interface element (e.g., 2124) (e.g., the selection input is directed to the user interface element, the selection input does not include detecting the attention of the user directed to the first key of the soft keyboard or the second key of the soft keyboard), such as in FIG. 21B, the computer system (e.g., 101) updates (2202g) display, via the display generation component (e.g., 120), of the representation (e.g., 2122h) of the text to delete one or more characters from the representation of the text (e.g., 2122h), such as in FIG. 21C (e.g., without updating the text to include characters of other keys in the plurality of keys of the soft keyboard, such as a character corresponding to the first key and/or the second key). In some embodiments, in response to detecting the attention of the user directed to the end of the representation of text and/or the insertion marker in the user interface element, the computer system displays a visual indication of a deletion operation (e.g., in the user interface element). In some embodiments, in response to detecting selection of the end of the representation of text (e.g., 2122h) and/or the insertion marker (e.g., 2122e) in the user interface element (e.g., 2124) (e.g., while the visual indication of the deletion operation is displayed), such as in FIG. 21C, the computer system (e.g., 101) ceases display of one or more characters in the representation of text (e.g., 2122h). In some embodiments, the computer system (e.g., 101) additionally or alternatively deletes one or more characters from the text entry field (e.g., 2104b) (e.g., one or more characters corresponding to the one or more characters deleted from the representation of the text (e.g., 2122h)) when the computer system (e.g., 101) deletes the one or more characters from the representation of text (e.g., 2122h), such as in FIG. 21C. In some embodiments, the one or more characters are at the end of the representation of text (e.g., 2122h) or adjacent to (e.g., to the left or right of) the insertion marker (e.g., 2122e), such as in FIG. 21C. Adding or deleting characters from the representation of text in accordance with the element to which attention of the user is directed enhances user interactions with the computer system by reducing the number of inputs needed to perform an operation.

In some embodiments, such as in FIG. 21B, the portion of the user interface element (e.g., 2124) is an end of the representation of the text (e.g., 2122h) (2204a). In some embodiments, such as in FIG. 21B, the portion of the user interface element (e.g., 2124) is the end of a portion of the representation (e.g., 2122h) of the text displayed in the user interface element (e.g., 2124). For example, if the text is scrolled so that the end of the representation of the text is not displayed in the user interface element, in response to detecting the selection input including the attention (e.g., gaze) of the user directed to the end of the portion of the representation of the text that is displayed in the user interface element, the computer system deletes the one or more characters. In some embodiments, for languages read left to right, the end of the representation of the text is a portion of the text on the right side of the representation of the text. In some embodiments, for languages read right to left, the end of the representation of the text is a portion of the text on the left side of the representation of the text. In some embodiments, the one or more characters that are deleted in response to the computer system receiving the input are at the end of the representation of the text. Deleting the one or more characters in response to receiving the selection input while attention of the user is directed to the end of the representation of the text enhances user interactions with the computer system by enabling the user to look at the characters they are about to delete when providing the selection input, thereby providing enhanced visual feedback to the user.

In some embodiments, such as in FIG. 21B, the user interface element (e.g., 2124) includes a cursor (e.g., 2122e) displayed in association with the representation (e.g., 2122h) of the text, and the portion of the user interface element (e.g., 2124) is the cursor (e.g., 2122e) (2206a). In some embodiments, such as in FIG. 21B, the cursor (e.g., 2122e) indicates a location in the text preview (e.g., 2122h) at which additional text will be entered in response to receiving an input to enter text, such as receiving the selection input (e.g., air gesture, touch input, gaze input or other user input) including the attention of the user directed to the first, second, or another key of the keyboard as described above. In some embodiments, such as in FIG. 21B, the cursor (e.g., 2122e) is displayed at the end of the text preview (e.g., 2122h) described above. In some embodiments, such as in FIG. 21D, the cursor (e.g., 2122e) is displayed at a location in the text preview (e.g., 2122h) other than the end of the text preview (e.g., 2122h). In some embodiments, in response to detecting the selection input including the attention (e.g., including gaze 2113a) of the user directed to the cursor (e.g., 2122e), such as in FIG. 21B, the computer system (e.g., 101) deletes one or more characters ahead of the cursor (e.g., 2122e) (e.g., one or more characters to the left of the cursor for languages read left to right or one or more characters to the right of the cursor for languages read right to left). Deleting the one or more characters in response to receiving the selection input while attention of the user is directed to the cursor enhances user interactions with the computer system by enabling the user to look at the characters they are about to delete when providing the selection input, thereby providing enhanced visual feedback to the user.

In some embodiments, prior to receiving the selection input, the computer system (e.g., 101) detects (2208a), via the one or more input devices (e.g., 314), that the attention (e.g., including gaze 2113a) of the user is directed to the portion of the user interface element (e.g., 2124). In some embodiments, the computer system detects the attention of the user directed to the portion of the user interface element for at least a threshold time of 0.1, 0.2, 0.5, 1, 2, or 3 seconds. In some embodiments, the computer system detects the attention of the user directed to the portion of the user interface element without detecting a ready state of the user as described in more detail above. In some embodiments, the computer system detects the attention of the user directed to the portion of the user interface element while detecting a ready state of the user as described in more detail above.

In some embodiments, in response to detecting that the attention (e.g., including gaze 2113a) of the user is directed to the portion of the user interface element (e.g., 2124), such as in FIG. 21B, the computer system (e.g., 101) displays (2208b), via the display generation component (e.g., 120), a visual indication (e.g., 2122i) indicating that selection of the portion of the user interface element (e.g., 2124) will cause deletion of the one or more characters from the representation of the text (e.g., 2122h), such as in FIG. 21B. In some embodiments, the computer system displays the visual indication in response to detecting the attention of the user directed to the portion of the user interface element plus one or more of the additional criteria described above, such as detecting the attention of the user directed to the portion of the user interface for the threshold time described above, detecting the ready state, or not detecting the ready state. In some embodiments, such as in FIG. 21B, the computer system (e.g., 101) displays the visual indication (e.g., 2122i) in the user interface element (e.g., 2124). For example, the computer system (e.g., 101) displays the visual indication (e.g., 2122i) proximate to the one or more characters that will be deleted in response to receiving the interaction input including the attention (e.g., including gaze 2113a) of the user directed to the portion of the user interface element (e.g., 2124), such as in FIG. 21B. In some embodiments, the computer system (e.g., 101) updates the representation (e.g., 2122h) of the text to delete the one or more characters from the representation (e.g., 2122h) of the text in response to detecting the selection input (e.g., air gesture, touch input, gaze input or other user input) while the attention (e.g., including gaze 2113a) of the user is directed to the portion of the user interface element (e.g., 2124) while the visual indication (e.g., 2122i) is displayed, such as in FIG. 21B. In some embodiments, in response to detecting the selection input (e.g., air gesture, touch input, gaze input or other user input) while the attention of the user is directed to the portion of the user interface element while the visual indication is not displayed, the computer system forgoes updating the representation of text to delete the one or more characters. Displaying the visual indication in response to detecting the attention of the user directed to the portion of the user interface element enhances user interactions with the computer system by providing enhanced visual feedback to the user.

In some embodiments, in response to receiving the selection input (e.g., air gesture, touch input, gaze input or other user input), in accordance with a determination that the selection input includes the attention of the user directed to a delete key (e.g., 2132c) included in the plurality of keys of the soft keyboard (e.g., 2128), the computer system (e.g., 101) updates (2210a) display, via the display generation component (e.g., 120), of the representation (e.g., 2122h) of the text to delete the one or more characters from the representation (e.g., 2122h) of the text, such as in FIG. 21C. In some embodiments, such as in FIG. 21B, the delete key (e.g., 2132c) is a backspace key. In some embodiments, in response to detecting selection of the delete key, the computer system deletes one or more characters ahead of a cursor included in the text representation from the text representation. In some embodiments, in response to detecting selection of the delete key, the computer system deletes one or more characters after a cursor included in the text representation from the text representation. In some embodiments, in response to detecting selection of the delete key, the computer system deletes one or more characters from the end of the text representation irrespective of a position of the cursor in the text representation. Deleting the one or more characters in response to receiving the selection input (e.g., air gesture, touch input, gaze input or other user input) while attention of the user is directed to the delete key included in the soft keyboard enhances user interactions with the computer system by providing an additional way to delete one or more characters from the text representation, enabling the user to use the computer system more quickly and efficiently.

In some embodiments, after updating display of the representation of the text to delete one or more characters from the representation (e.g., 2122h) of the text in accordance with the determination that the selection input includes the attention of the user directed to a portion of the user interface element (e.g., 2124) in response to receiving the selection input, such as in FIG. 21C, the computer system (e.g., 101) receives (2212a), via the one or more input devices (e.g., 314), a second selection input that includes the attention of the user directed to the portion of the user interface element (e.g., 2124), such as in FIG. 21C. In some embodiments, the second selection input has one or more features in common with the selection input described in more detail above.

In some embodiments, in response to receiving the second selection input (e.g., air gesture, touch input, gaze input or other user input), the computer system (e.g., 101) updates (2212b) display, via the display generation component (e.g., 120), of the representation (e.g., 2122h) of the text to delete one or more additional characters from the representation of the text (e.g., 2122h), such as in FIG. 21D. In some embodiments, such as in FIG. 21C, after the one or more characters are deleted from the representation of the text (e.g., 2124), the one or more additional characters are displayed proximate to the cursor (e.g., 2122e) in the representation of the text (e.g., 2122h). In some embodiments, in response to the second selection input, the computer system (e.g., 101) deletes the one or more additional characters that are proximate to the cursor (e.g., 2122e), such as in FIG. 21D, as described in more detail above. In some embodiments, such as in FIG. 21C, after the one or more characters are deleted from the representation of the text (e.g., 2122h), the one or more additional characters are displayed at the end of the representation of the text (e.g., 2122h). In some embodiments, in response to the second selection input, the computer system deletes the one or more additional characters that are at the end of the representation of text as described in more detail above. Deleting the one or more additional characters from the representation of the text in response to the second selection input after having deleted the one or more characters from the representation of the text enhances user interactions with the computer system by providing additional controls for deleting the one or more additional characters without cluttering the user interface with additional displayed controls.

In some embodiments, in response to receiving the selection input (e.g., air gesture, touch input, gaze input or other user input), in accordance with a determination that the selection input includes the attention (e.g., including gaze 2113c) of the user directed away from the soft keyboard (e.g., 2128) (and/or away from the user interface element and/or the text entry field), such as in FIG. 21E, the computer system (e.g., 101) ceases (2214a) display, via the display generation component (e.g., 101), of the representation of the text, such as in FIG. 21F. In some embodiments, the computer system (e.g., 101) ceases to display the user interface element (e.g., 2124), such as in FIG. 21G, in response to receiving the selection input in accordance with the determination that the selection input includes the attention (e.g., including gaze 2113e) of the user directed away from the soft keyboard (e.g., 2128), such as in FIG. 21F. In some embodiments, the computer system ceases display of the representation of the text in response to receiving the selection input in accordance with a determination that the selection input includes the attention of the user directed to the text entry field. In some embodiments, the computer system (e.g., 101) ceases display of the representation of the text (e.g., 2122h), such as in FIG. 21G, in response to receiving the selection input in accordance with a determination that the selection input includes the attention (e.g., including gaze 2113e) of the user directed to the user interface (e.g., 2102) that includes the text entry field (e.g., 2104c), such as in FIG. 21F. In some embodiments, such as in FIG. 21G, ceasing display of the representation (e.g., 2122h) of the text includes forgoing updating the representation of the text (e.g., 2122h), such as to include the first character or second character or to delete one or more characters. Ceasing display of the representation of the text in response to receiving the selection input in accordance with the determination that the selection input includes the attention of the user directed away from the soft keyboard enhances user interactions with the computer system by providing a control option to cease display of the representation of the text without cluttering the user interface with additional displayed controls.

In some embodiments, in response to receiving the selection input (e.g., air gesture, touch input, gaze input or other user input), in accordance with a determination that the selection input includes the attention (e.g., including gaze 2113e) of the user directed to a portion of a user interface (e.g., 2102) that is empty of text entry fields (e.g., 2104a, 2104b, or 2104c), such as in FIG. 21F, the computer system (e.g., 101) ceases (2216a) display, via the display generation component (e.g., 120), of the soft keyboard (e.g., 2128), wherein the user interface (e.g., 2102) includes the text entry field (e.g., 2104c), such as in FIG. 21G. In some embodiments, in response to receiving the selection input, in accordance with a determination that the selection input includes the attention (e.g., including gaze 2113e) of the user directed to a portion of a user interface (e.g., 2102) that is empty of text entry fields (e.g., 2104a, 2104b, and/or 2104c), such as in FIG. 21F, the computer system (e.g., 101) further ceases display of the representation of the text, such as in FIG. 21G. Ceasing display of the soft keyboard in response to receiving the selection input in accordance with a determination that the selection input includes the attention of the user directed to a portion of a user interface that is empty of text entry fields enhances user interactions with the computer system by providing an option to cease display of the soft keyboard without cluttering the user interface with additional displayed controls.

In some embodiments, in response to receiving the selection input (e.g., air gesture, touch input, gaze input or other user input), in accordance with a determination that the selection input includes the attention (e.g., 2113c) of the user directed to a second text entry field (e.g., 2104c), such as in FIG. 21E, the computer system (e.g., 101) ceases (2218a) display, via the display generation component (e.g., 120), of the representation (e.g., 2122h) of the text while maintaining display, via the display generation component (e.g., 120), of the soft keyboard (e.g., 2128), such as in FIG. 21F. In some embodiments, in response to receiving the selection input, in accordance with the determination that the selection input includes the attention (e.g., including gaze 2113c) of the user directed to the second text entry field (e.g., 2104c), such as in FIG. 21E, the computer system (e.g., 101) displays, in the user interface element (e.g., 2124), a representation of text included in the second text entry field (e.g., 2104c), such as in FIG. 21F, if there is any text displayed in the second text entry field. In some embodiments, if the second text entry field (e.g., 2104c) is blank, such as in FIG. 21F, the computer system (e.g., 101) displays a representation (e.g., 2122b) of the empty text entry field in the user interface element (e.g., 2124) in response to receiving the selection input, in accordance with the determination that the selection input includes the attention (e.g., including gaze 2113c) of the user directed to the second text entry field (e.g., 2104c), such as in FIG. 21E. In some embodiments, after receiving the selection input including the attention (e.g., including gaze 2113c) of the user directed to the second text entry field (e.g., 2104c), such as in FIG. 21E, the computer system (e.g., 101) directs the focus of the soft keyboard (e.g., 2128) to the second text entry field (e.g., 2104c), such as in FIG. 21F. In some embodiments, while the focus of the soft keyboard is directed to the second text entry field, in response to detecting an input directed to the soft keyboard that corresponds to a request to enter text, the computer system enters the text into the second text entry field and updates a representation of the text in the second text entry field. In some embodiments, in response to receiving the selection input, in accordance with the determination that the selection input includes the attention of the user directed to the second text entry field, the computer system ceases display of the representation of text of the text entry field without displaying a representation of text of the second text entry field. Ceasing display of the representation of text while maintaining display of the soft keyboard in response to receiving the selection input, in accordance with the determination that the selection input includes the attention of the user directed to the second text entry field enhances user interactions with the computer system by reducing the number of inputs needed to provide text to the second text entry field via the soft keyboard.

In some embodiments, updating display of the representation of the text (e.g., 2122h) to include the first character corresponding to the first key includes, in accordance with a determination that space between the representation of the text (e.g., 2122h) and a predefined boundary in the user interface element (e.g., 2124) is insufficient to display the first character, scrolling the representation of the text (2220a), such as in FIG. 21E. In some embodiments, such as in FIG. 21E, the predefined boundary in the user interface element (e.g., 2124) is a boundary of a region (e.g., 2122b) of the user interface element in which the computer system is able to display the representation (e.g., 2122h) of text. In some embodiments, the space is between an end of the representation of text and the predefined boundary. In some embodiments, scrolling the representation of the text includes ceasing display of one or more characters included in the representation of the text and shifting one or more characters included in the representation of text away from the predefined boundary. In some embodiments, in accordance with a determination that the space between the representation of the text and the predefined boundary in the user interface element is sufficient to display the first character, the computer system displays the second character without scrolling the representation of the text.

In some embodiments, updating display of the representation (e.g., 2122h) of the text to include the second character corresponding to the second key includes, in accordance with a determination that the space between the representation (e.g., 2122h) of the text and the predefined boundary in the user interface element (e.g., 2124) is insufficient to display the second character, scrolling the representation of the text, such as in FIG. 21E. In some embodiments, in accordance with a determination that the space between the representation of the text and the predefined boundary in the user interface element is sufficient to display the second character, the computer system displays the second character without scrolling the representation of the text. Scrolling the representation of text in accordance with a determination that the space between the representation of the text and the predefined boundary in the user interface element is insufficient to display a character to be entered in response to the selection input enhances user interactions with the computer system by providing enhanced visual feedback to the user that includes displaying the character entered in response to the selection input.

In some embodiments, while displaying the soft keyboard (e.g., 2128), the user interface element (e.g., 2124), and the text (e.g., 2110) included in the text entry field (2104b) (2222a), such as in FIG. 21F, the computer system (e.g., 101) receives (2222b) via the one or more input devices (e.g., 314), a second input that corresponds to a request to select a portion of the text (e.g., 2110) included in the text entry field (e.g., 2104b). In some embodiments, the request to select the portion of the text included in the text entry field includes one or more selection inputs. For example, the computer system detects an input selecting a cursor displayed in the text entry field and/or within the representation of text. In this example, after detecting selection of the cursor, the computer system detects an input corresponding to a request to move the cursor within the text and/or the representation of text and selects one or more characters between the location at which the cursor was selected and the location to which the cursor was dragged.

In some embodiments, while displaying the soft keyboard (e.g., 2128), the user interface element (e.g., 2124), and the text (e.g., 2110) included in the text entry field (2104b) (2222a), in response to receiving the second input (2222d), the computer system (e.g., 101) updates (2222d) display of the portion of the text (e.g., 2110) included in the text entry field (e.g., 2104b) to be displayed with a first visual characteristic having a first value, such as in FIG. 21E, wherein prior to detecting the second input, the portion of the text (e.g., 2110) included in the text entry field (e.g., 2104b) was displayed with the first visual characteristic having a second value, different from the first value, such as in FIG. 21D. In some embodiments, such as in FIG. 21E, the computer system (e.g., 101) changes a visual indication of the selected portion of text (e.g., 2110), such as by highlighting or changing another visual characteristic (e.g., size, color, translucency, and/or font) of the selected portion of text (e.g., 2110) compared to the visual characteristic of the selected portion of the text prior to the portion of the text being selected.

In some embodiments, while displaying the soft keyboard (e.g., 2128), the user interface element (e.g., 2124), and the text (e.g., 2110) included in the text entry field (2104b) (2222a), in response to receiving the second input (2222d), the computer system (e.g., 101) updates (2222e) display of a portion of the representation (e.g., 2122h) of text that corresponds to the portion of the text (e.g., 2110) included in the text entry field (e.g., 2104b) to be displayed with a second visual characteristic having a third value, such as in FIG. 21E, wherein prior to detecting the second input, the portion of the representation (e.g., 2122h) of text was displayed with the second visual characteristic having a fourth value, different from the third value, such as in FIG. 21D. In some embodiments, such as in FIG. 21E, the computer system (e.g., 101) updates the same visual characteristics of the selected portion of text (e.g., 2110) in the text entry field (e.g., 2104b) and the selected portion of text in the representation (e.g., 2122h) of text. In some embodiments, the computer system updates different visual characteristics of the selected portion of text in the text entry field and the selected portion of text in the representation of text. In some embodiments, the second visual characteristic is one or more of highlighting, size, color, translucency, and/or font. Updating display of the portion of the representation of text and the portion of text in the text entry field that is selected enhances user interactions with the computer system by providing enhanced visual feedback to the user.

In some embodiments, displaying the representation (e.g., 2122h) of the text includes displaying a portion (e.g., 2122k) of the representation of text that is within a threshold distance of a boundary of the user interface element (e.g., 2122b) with a visual characteristic having a first value and displaying a portion (e.g., 2122j) of the representation (e.g., 2122h) of text that is further than the threshold distance from the boundary of the user interface element (e.g., 2122b) with the visual characteristic having a second value, different from the first value (2224a), such as in FIG. 21E. In some embodiments, such as in FIG. 21E, the computer system (e.g., 101) displays text (e.g., 2122k) that is within a threshold distance (e.g., 0.1, 0.2, 0.3, 0.5, 1, 2, or 3 centimeters) of one or more displayed boundaries (e.g., left and/or right boundaries and/or top and/or bottom boundaries) of a region (e.g., 2122b) of the user interface element (e.g., 2124) including the representation (e.g., 2122h) of the text with the visual characteristic having the first value and displays text (e.g., 2122j) that is further than the threshold distance of the one or more displayed boundaries of the region (e.g., 2122b) with the visual characteristic having the second value. In some embodiments, such as in FIG. 21E, the visual characteristic is an amount of translucency, a color, a size, and/or a font of the text. For example, the computer system displays the portion of text at the edge of the representation of text with increased translucency compared to the rest of the representation of text. In some embodiments, in accordance with a determination that the representation of text is scrolled such that there is additional text in the representation of text in a first direction past the boundary of the region of the user interface element, the computer system displays text of the representation of text that is within the threshold distance of the boundary in the first direction with the visual characteristic having the first value. In some embodiments, in accordance with a determination that the representation of text is not scrolled such that there is additional text in the representation of text in the first direction past the boundary of the region of the user interface element, the computer system displays text of the representation of text that is within the threshold distance of the boundary in the first direction with the visual characteristic having the second value. Displaying the portion of the representation of the text that is within the threshold distance of the boundary of the user interface element with the visual characteristic having the first value and displaying the portion of the representation of the text that is further than the threshold distance from the boundary of the user interface element with the visual characteristic having the second value, different from the first value, enhances user interactions with the computer system by providing improved visual feedback to the user while using the soft keyboard to provide text to the text entry field.

In some embodiments, such as in FIG. 21E, displaying the representation (e.g., 2122h) of the text further includes (2226a), in accordance with a determination that the portion (e.g., 2122k) of the text that is within the threshold distance of the boundary of the user interface is currently selected, displaying the portion (e.g., 2122k) of the text that is within the threshold distance of the boundary of the user interface element with a visual indication of being currently selected, the visual indication displayed with the visual characteristic having the first value (2226b), such as in FIG. 21E. In some embodiments, the computer system selects text and displays the visual indication of being currently selected as described in more detail above. In some embodiments, the visual indication of being currently selected includes highlighting, bolding, underlining, or another modification to the text that is currently selected. In some embodiments, as described above, the visual characteristic is an amount of visual emphasis and the first value corresponds to decreased visual emphasis compared to a portion of selected text that is displayed with the visual indication of being currently selected that is displayed with the visual characteristic having the second value. For example, the selected text is displayed with highlighting that is more translucent at locations within the threshold distance of the boundary of the user interface element than the translucency of the highlighting of selected text that is more than the threshold distance from the boundary of the user interface element.

In some embodiments, such as in FIG. 21E, displaying the representation (e.g., 2122h) of the text further includes (2226a), in accordance with a determination that the portion (e.g., 2122j) of the text that is further than the threshold distance from the boundary of the user interface element is currently selected, displaying the portion (e.g., 2122j) of the text that is further than the threshold distance of the boundary of the user interface element with the visual indication of being currently selected, the visual indication displayed with the visual characteristic having the second value, such as in FIG. 21E. In some embodiments, portions of the text that are not currently selected are displayed without the visual indication of being currently selected with the visual characteristic having a value corresponding to the distance of the portion of text from the boundary of the user interface element. Displaying the visual indication of being currently selected that is within the threshold distance of the boundary of the user interface element with the visual characteristic having the first value and displaying the visual indication of being currently selected that is further than the threshold distance from the boundary of the user interface element with the visual characteristic having the second value, different from the first value, enhances user interactions with the computer system by providing improved visual feedback to the user while using the soft keyboard to provide text to the text entry field.

In some embodiments, such as in FIG. 21D, displaying the representation (e.g., 2122h) of text includes displaying a portion of the representation of text that has a first orientation relative to an insertion marker (e.g., 2122e) included in the user interface element with a visual characteristic having a first value and displaying a portion of the representation (e.g., 2122h) of text that has a second orientation relative to the insertion marker (e.g., 2122e) with the visual characteristic having a second value different from the first value (2228a). In some embodiments, such as in FIG. 21D, the insertion marker (e.g., 2122e) is a cursor. In some embodiments, in response to detecting an input corresponding to a request to add text to the text in the text entry field (e.g., the selection input including attention of the user directed to the first or second key of the keyboard), the computer system inserts the corresponding text at a location of the insertion marker. In some embodiments, the visual characteristic is an amount of visual emphasis, such as one of the visual emphasis examples described above. In some embodiments, text that is after the insertion marker (e.g., text that will be shifted in response to a request to insert more text at the location of the insertion marker) is displayed with less visual emphasis than text before the insertion marker. In some embodiments, the text that is before the insertion marker does not shift in response to an input to add text at the location of the insertion marker. In some embodiments, text that is before the insertion marker scrolls in response to the input to add text at the location of the insertion marker, as described above. Displaying the text in the representation of the text with the visual characteristic having different values depending on the spatial relationship of the text and the insertion marker enhances user interactions with the computer system by providing improved visual feedback to the user while providing text to the text entry field with the soft keyboard.

In some embodiments, such as in FIG. 11E, the computer system (e.g., 101) receives (2230a), via the one or more input devices, a text entry input that includes a speech input (e.g., 2116) and the attention (e.g., including gaze 2113d) of the user directed to the representation of the text or the text entry field. In some embodiments, the text entry input corresponds to a request to dictate text to the text entry field according to one or more steps of method(s) 1000 and/or 2000. In some embodiments, the text entry input includes satisfying one or more sets of criteria described in more detail above with reference to one or more of methods 1000 and/or 2000.

In some embodiments, in response to receiving the text entry input (2230b), the computer system (e.g., 101) updates (2230c) display, via the display generation component (e.g., 120), of the representation (e.g., 2122h) of the text to include a first text representation of the speech input, such as in FIG. 21F. In some embodiments, the computer system ceases display of text included in the representation of the text displayed while the text entry input was detected in response to receiving the text entry input. In some embodiments, the computer system maintains display of text included in the representation of the text displayed while the text entry input was detected in response to receiving the text entry input and updates the representation to further include the first text representation of the speech input in response to receiving the text entry input. In some embodiments, the first text representation of the speech input is inserted into the representation of text at a location at which a cursor is displayed in the representation of text and/or in the text included in the text entry field, as described above.

In some embodiments, in response to receiving the text entry input (2230b), the computer system (e.g., 101) updates (2230d) display, via the display generation component (e.g., 120), of the text (e.g., 2110) included in the text entry field (e.g., 2104b) to include a second text representation of the speech input. In some embodiments, the computer system ceases display of the text included in the text entry field displayed while the text entry input was detected in response to receiving the text entry input. In some embodiments, the computer system maintains display of text included in the text entry field displayed while the text entry input was detected in response to receiving the text entry input and updates the text included in the text entry field to further include the second text representation of the speech input in response to receiving the text entry input. In some embodiments, the second text representation of the speech input is inserted into the text included in the text entry field at a location at which a cursor is displayed in the representation of text and/or in the text included in the text entry field, as described above. In some embodiments, the first text representation of the speech input and the second representation of the speech input have one or more characters in common. Displaying the text representation of the speech inputs in the text entry field and representation of text in response to the text entry input including the speech input enhances user interactions with the computer system by providing efficient controls for entering and/or editing text.

In some embodiments, the computer system (e.g., 101) receives (2232a), via the one or more input devices (e.g., 314), a text entry input that includes a speech input (e.g., 2116), such as in FIG. 21E. In some embodiments, the text entry input including the speech input is similar to the text entry input including the speech input described above and/or described with reference the one or more of method(s) 1000 and/or 2000, except for the differences described below.

In some embodiments, in response to receiving the text entry input (2232b), in accordance with a determination that the text entry input includes the attention (e.g., including gaze 2113d) of the user directed to the text entry field (e.g., 2104b) (2232c), such as in FIG. 21E, the computer system (e.g., 101) updates (2232d) display, via the display generation component, of the representation (e.g., 2122h) of the text to include a first text representation of the speech input. In some embodiments, updating display of the representation of the text to include the first text representation of the speech input in response to the text entry input is similar to updating display of the representation of the text to include the first text representation of the speech input as described above.

In some embodiments, in response to receiving the text entry input (2232b), in accordance with a determination that the text entry input includes the attention (e.g., including gaze 2113d) of the user directed to the text entry field (e.g., 2104b) (2232c), such as in FIG. 21E, the computer system (e.g., 101) updates (2232e) display, via the display generation component (e.g., 101), of the text (e.g., 2110) included in the text entry field to include a second text representation of the speech input, such as in FIG. 21F. In some embodiments, updating display of the text in the text entry field to include the second text representation of the speech input in response to the text entry input is similar to updating display of the text in the text entry field to include the second text representation of the speech input as described above.

In some embodiments, in response to receiving the text entry input (2232b), in accordance with a determination that the text entry input includes the attention of the user directed to the representation of the text (e.g., 2122h) (22320, the computer system (e.g., 101) forgoes updating display, via the display generation component (e.g., 101), of the representation (e.g., 2122h) of the text to include the first text representation of the speech input, such as in FIG. 21E.

In some embodiments, in response to receiving the text entry input (2232b), in accordance with a determination that the text entry input includes the attention of the user directed to the representation of the text (e.g., 2122h) (22320, the computer system (e.g., 101) forgoes (2232h) updating display, via the display generation component (e.g., 101), of the text (e.g., 2110) included in the text entry field (e.g., 2104b) to include the second text representation of the speech input. In some embodiments, the computer system initiates dictation of text in response to detecting the text entry input while the attention of the user is directed to the text entry field, but not in response to detecting the text entry input while the attention of the user is directed to the text representation of the speech input. Displaying the text representation of the speech input in the text entry field and representation of text in response to the text entry input including the speech input while the attention of the user is directed to the text entry field enhances user interactions with the computer system by providing efficient controls for entering and/or editing text and enhances user privacy by entering the text when it is clear the user intends the text to be entered into the text entry field.

In some embodiments, aspects/operations of methods 800, 1000, 1200, 1400, 1600, 1200, 2000, and/or 2400 may be interchanged, substituted, and/or added between these methods. For example, the computer system displays a soft keyboard in accordance with methods 1200, 1400, 1600 and/or 2200. For brevity, these details are not repeated here.

FIGS. 23A-23I illustrate example techniques of updating user interface elements in accordance with a status of a hardware input device in communication with the computer system 101 in accordance with some embodiments. The user interfaces in FIGS. 23A-23I are used to illustrate the processes described below, including the processes in FIGS. 24A-24I.

FIG. 23A illustrates a computer system 101 displaying, via a display generation component (e.g., display generation component 120 of FIG. 1), a three-dimensional environment 2301 from a viewpoint of the user. As described above with reference to FIGS. 1-6, the computer system 101 optionally includes a display generation component (e.g., a touch screen) and a plurality of image sensors 314 (e.g., image sensors 314 of FIG. 3). The image sensors 314 optionally include one or more of a visible light camera, an infrared camera, a depth sensor, or any other sensor the computer system 101 would be able to use to capture one or more images of a user or a part of the user (e.g., one or more hands of the user) while the user interacts with the computer system 101. In some embodiments, the user interfaces illustrated and described below could also be implemented on a head-mounted display that includes a display generation component that displays the user interface or three-dimensional environment to the user, and sensors to detect the physical environment and/or movements of the user's hands (e.g., external sensors facing outwards from the user) such as movements that are interpreted by the computer system as gestures such as air gestures, and/or gaze of the user (e.g., internal sensors facing inwards towards the face of the user). It should be understood that, in some embodiments, one or more techniques described herein are applied to two-dimensional environments without departing from the scope of the disclosure.

In FIG. 23A, the computer system 101 presents an environment 2301 that includes a representation 2307 of a desk in the physical environment of the computer system and user interfaces 2306 and 2312. For example, user interface 2306 is a messaging user interface that includes indications 2308a and 2308b of messages in a messaging conversation and a text entry field 2310 for composing a message to add to the conversation. As another example, user interface 2312 is a web browsing user interface that includes a text entry field 2326 for entering a URL or a search term to navigate the web browsing application. In some embodiments, the computer system 101 adds text to text entry field 2310 and/or text entry field 2326 in accordance with one or more steps of method(s) 1000, 1200, 1400, 1600, 2000, and/or 2200 and/or with a hardware input device, as described with reference to FIGS. 23A-23I and/or method 2400.

As will be described below at least with reference to FIG. 23B, in response to detecting a hardware input device (e.g., a keyboard) in the physical vicinity of the computer system 101 that is in communication with the computer system 101, the computer system 101 displays one or more user interface elements associated with the hardware input device. In FIG. 23A, because the computer system 101 does not detect a hardware input device in the physical vicinity of the computer system 101 that is in communication with the computer system 101, the computer system 101 does not display the one or more user interface elements associated with the hardware input device.

In FIG. 23B, the computer system 101 detects a hardware input device 2302 in the physical vicinity of the computer system 101 that is in communication with the computer system 101. In some embodiments, the computer system 101 detects the hardware input device 2302 in the vicinity of the computer system 101 using image sensors 314. In some embodiments, the computer system 101 is in communication with the hardware input device 2302 via a wireless connection such as Bluetooth and/or Wi-Fi. As shown in FIG. 23B, in some embodiments, the hardware input device 2302 is a hardware keyboard. In some embodiments, the computer system 101 uses one or more techniques similar to those described herein with reference to the hardware keyboard for interactions with other hardware input devices, such as trackpads, mice, remote controls, and/or video game controllers.

In response to detecting the hardware input device 2302 that is in communication with the computer system 101, the computer system 101 displays user interface element 2316 and indication 2322. For example, indication 2322 indicates the battery life of the hardware input device 2302. In some embodiments, in response to a change in the battery life of the hardware input device 2302, the computer system 101 updates the indication 2322 to reflect the updated battery life of hardware input device 2302. In some embodiments, the computer system 101 displays additional or alternative indications of the status of hardware input device 2302. In FIG. 23B, text entry field 2310 has the current focus of the hardware input device 2302, so the computer system 101 is configured to enter text to text entry field 2310 in response to inputs directed to the hardware input device 2302. For example, because text entry field 2310 has the current focus of the hardware input device 2302, the computer system 101 displays an insertion marker 2314a in text entry field 2310.

As shown in FIG. 23B, the user interface element 2316 includes text entry field 2318, soft keyboard option 2320a, options 2320b and 2320c for entering suggested text to text entry field 2310, and a dictation option 2320d. In some embodiments, the computer system 101 presents a representation of text corresponding to the text in the text entry field 2310 that has the current focus of the hardware input device in text entry field 2318 in a manner similar to the manner in which the computer system 101 displays representations of text in a user interface element associated with a soft keyboard according to one or more steps of method(s) 1200, 1400, 1600, and/or 2200. In some embodiments, the computer system 101 displays a soft keyboard according to one or more steps of method(s) 1200, 1400, 1600, 2000, and/or 2200 in response to detecting selection of soft keyboard option 2320a. In some embodiments, the computer system 101 enters text corresponding to one of options 2320b or 2320c into text entry field 2310 in response to detecting selection of one of the options 2320b or 2320c, respectively. In some embodiments, the computer system 101 initiates a process to accept dictation input to text entry field 2310 in a manner similar to one or more steps of method(s) 1000 and/or 2000.

In some embodiments, the entirety of hardware input device 2302 is in the field of view of the computer system 101. In some embodiments, a portion of the hardware input device 2302 is in the field of view of the computer system 101. In some embodiments, techniques for displaying user interface element 2316 and indication 2322 with a predefined spatial relationship relative to hardware input device 2302 apply to situations in which the entire hardware input device 2302 is in the field of view of the computer system 101 and situations in which a portion of the hardware input device 2302 is in the field of view of the computer system 101. In some embodiments, the computer system 101 displays a portion of user interface element 2316 and/or indication 2322 in order to maintain the spatial relationship between the user interface element 2316 and/or indication 2322 relative to the hardware input device 2302. In some embodiments, the computer system 101 forgoes display of user interface element 2316 and/or indication 2322 when only a portion of the hardware input device 2302 is in the field of view of the computer system 101.

In FIG. 23B, the computer system 101 detects an input via hardware input device 2302. For example, the user uses hands 2303a and 2303b to press a plurality of keys 2304 included in the hardware input device 2302. In response to the input illustrated in FIG. 23B, the computer system 101 enters text corresponding to the pressed keys 2304 into text entry field 2310, as shown in FIG. 23C.

FIG. 23C illustrates the computer system 101 displaying text 2324a in text entry field 2310 in response to the input illustrated in FIG. 23B. The computer system 101 also updates text entry field 2318 to include text 2324b corresponding to text 2324a in text entry field 2310. The computer system 101 enters the text 2324a into text entry field 2310 because text entry field 2310 had the current focus of the hardware input device 2302 while the input in FIG. 23B was received. In FIG. 23C, the computer system 101 receives an input provided by hand 2303b that corresponds to a request to select text entry field 2326. In some embodiments, the input provided by hand 2303b is an air gesture input, such as a direct air gesture input or an indirect air gesture input. In response to detecting selection of text entry field 2326 as shown in FIG. 23C, the computer system 101 updates the current focus of the hardware input device 2302 from being directed to text entry field 2310 to being directed to text entry field 2326, as shown in FIG. 23D.

FIG. 23D illustrates the computer system 101 displaying the environment 2301 updated with the current focus of the hardware input device 2302 directed to text entry field 2326. In some embodiments, the computer system 101 maintains display of text 2324a in text entry field 2310 even though text entry field 2310 no longer has the current focus of the hardware input device 2302, but ceases display of the insertion marker in text entry field 2310. As shown in FIG. 23D, because text entry field 2326 has the current focus of the hardware input device 2302, the computer system 101 displays the insertion marker 2314a in text entry field 2326. In some embodiments, the insertion marker 2314a indicates the position within text 2324c at which additional text will be entered in response to an input received via the hardware input device 2302. In some embodiments, in response to the input focus of the hardware input device 2302 moving from text entry field 2310 to text entry field 2326, the computer system 101 updates the text entry field 2318 included in user interface element 2316 from including a representation of the text 2324a in text entry field 2310 to including a representation 2324d of text 2324c included in text entry field 2326.

As described above, in some embodiments, the computer system 101 enters text into the text entry field 2326 that has the current focus of the hardware input device 2302 in response to detecting selection of one of the options 2320g or 2320h. In some embodiments, while the computer system 101 does not detect a portion of the user (e.g., one of the user's hands 2303a or 2303b) in a position corresponding to providing an input via the hardware input device 2302, the computer system 101 enters the text in response to a direct air gesture input or an indirect air gesture input directed to one of the options 2320g or 2320h. For example, detecting the portion of the user in a position corresponding to providing an input via the hardware input device 2302 includes detecting the user press one or more keys 2304 with hand 2303a or detecting the user resting their hand 2303a on the keys 2304 without pressing the keys 2304. As shown in FIG. 23D, because the computer system 101 detects hand 2303a in the position corresponding to providing an input via the hardware input device 2302, the computer system 101 will accept direct air gesture inputs directed to option 2320g and 2320h, but not indirect air gesture inputs directed to option 2320g and 2320h. For example, in FIG. 23D, hand 2303b provides an air gesture input directed to option 2320h while hand 2303a is in the position corresponding to providing an input via the hardware input device 2302. In some embodiments, if hand 2303b provides an indirect air gesture input selecting option 2320h, the computer system 101 forgoes updating text 2324c in response to the input. In some embodiments, if hand 2303b provides a direct air gesture input selecting option 2320h, the computer system 101 updates text 2324c as shown in FIG. 23E.

FIG. 23E illustrates the computer system 101 displaying the environment 2301 with updated text 2324c in response to the input in FIG. 23D. As shown in FIG. 23E, the computer system 101 updates text 2324c to add the text corresponding to option 2320h, which was selected in FIG. 23D. In some embodiments, the computer system 101 updates the text 2324d in text entry field 2318 to correspond to the updated text 2324c in text entry field 2326. As shown in FIG. 23F, because the entirety of text 2324c exceeds the size of text entry field 2326, the computer system 101 scrolls the text 2324c to hide a portion of the beginning of the text 2324c while maintaining display of the location of the insertion marker 2314a at the end of the text 2324c. In FIG. 23F, the computer system 101 also scrolls text 2324d in text entry field 2318 to hide the beginning of text 2324d, while maintaining display of insertion marker 2314d at the end of text 2324d because the size of the entirety of text 2324d exceeds the size of the text entry field 2318.

As described above, in some embodiments, while the computer system 101 does not detect a hand at a location corresponding to providing an input with the hardware input device 2302, the computer system accepts direct air gesture inputs and indirect air gesture inputs directed to options 2320i and 2320j. In FIG. 23E, the computer system 101 detects an air gesture input provided by hand 2303b that corresponds to selection of option 2320i without detecting another hand of the user at a location corresponding to providing input with the hardware input device 2302. Because the computer system does not detect another hand of the user at a location corresponding to providing input with the hardware input device 2302 while detecting the input provided by hand 2303b, the computer system 101 enters text corresponding to option 2320i in response to the input, as shown in FIG. 23F, irrespective of whether the input provided by hand 2303b is an indirect air gesture input or a direct air gesture input.

FIG. 23F illustrates the computer system 101 displaying the environment 2301 after updating the text 2324c in text entry field 2326 in response to the input illustrated in FIG. 23E. As shown in FIG. 23F, the computer system 101 updates the text 2324c in text entry field 2326 to include text corresponding to the option 2320i selected in FIG. 23E and updates the text 2324d in text entry field 2318 to correspond to the text 2324c in text entry field 2326 as described above. In some embodiments, the computer system 101 scrolls text 2324c in text entry field 2326 and scrolls the text 2324d in text entry field 2318 as described above.

As shown in FIG. 23F, the computer system 101 detects the user move the hardware input device 2302 (e.g., using hands 2303a and 2303b). In some embodiments, in response to detecting movement of the hardware input device 2302, the computer system 101 updates the position of the user interface element 2316 and indication 2322 in the environment 2301 to maintain the spatial relationship of the user interface element 2316 and indication 2322 relative to the hardware input device 2302, as shown in FIG. 23G.

FIG. 23G illustrates the computer system 101 displaying the environment 2301 updated in response to detecting movement of the hardware input device 2302 in FIG. 23F. The computer system 101 updates the position of the user interface element 2316 and indication 2322 in FIG. 23G to maintain the same spatial relationship of the user interface element 2316, indication 2322, and the hardware input device 2302 as the spatial relationship in FIG. 23F prior to the computer system 101 detecting the movement of the hardware input device 2302. In some embodiments, the computer system 101 uses a different portion of the display generation component 120 in FIG. 23G to display the user interface element 2316 and the indication 2322 than the portion of the display generation component 120 used to display the user interface element 2316 and indication 2322 in FIG. 23F.

In some embodiments, in response to detecting movement of the viewpoint of the user, the computer system 101, and/or the display generation component 120 without detecting movement of the hardware input device 2302, the computer system 101 updates the display of the environment 2301 to maintain the location of the user interface element 2316 and indication 2322 in the environment 2301. For example, in FIG. 23G, the computer system 101 detects movement of the computer system 101 and display generation component 120, which corresponds to movement of the viewpoint of the user in the environment 2301. In response to detecting the movement of the computer system 101 and display generation component 120, the computer system 101 updates the viewpoint of the user while maintaining the location of the user interface element 2316 and indication 2322 in FIG. 23H.

FIG. 23H illustrates the computer system 101 displaying the environment 2301 from the updated viewpoint of the user in response to the movement of the computer system 101 and display generation component 120 in FIG. 23G. In FIG. 23H, the computer system 101 displays a different portion of the environment 2301 via the display generation component 120 while maintaining the locations of the user interfaces 2306 and 2312, user interface element 2316, and indication 2322, which includes maintaining the same spatial relationship between the user interface element 2316, indication 2322, and hardware input device 2302 as the spatial relationship in FIG. 23G.

In some embodiments, in response to detecting movement of an object in the environment 2301 other than the hardware input device 2302 in response to a user input, the computer system 101 maintains the location of user interface element 2316 and indication 2322 in the environment. For example, in FIG. 23H, the computer system 101 detects an input provided by hand 2303b corresponding to a request to move user interface 2312 in the environment. In some embodiments, the input provided by hand 2303b is an air gesture input (e.g., a direct input or an indirect input). In response to the input illustrated in FIG. 23H, the computer system 101 updates the position of the user interface 2312 without updating the position of the user interface element 2316 and the indication 2322 as shown in FIG. 23I.

FIG. 23I illustrates the computer system 101 displaying the environment 2301 updated in response to the input in FIG. 23H. As shown in FIG. 23I, the computer system 101 updates the position of user interface 2312 in accordance with the input in FIG. 23H without updating the position of other elements in the environment 2301, including user interface element 2316 and indication 2322.

FIGS. 24A-24I is a flow diagram of methods of updating user interface elements in accordance with a status of a hardware input device in communication with the computer system 101 in accordance with some embodiments. In some embodiments, method 2400 is performed at a computer system (e.g., computer system 101 in FIG. 1) including a display generation component (e.g., display generation component 120 in FIGS. 1, 3, and 4). In some embodiments, the method 2400 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 2400 are, optionally, combined and/or the order of some operations is, optionally, changed.

In some embodiments, method 2400 is performed at a computer system in communication with a display generation component and one or more input devices. In some embodiments, the computer system is the same as or similar to the electronic device(s) and/or computer system(s) described above with reference to method(s) 800, 1000, 1200, 1400, 1600, 1800, 2000, and/or 2200. In some embodiments, the one or more input devices are the same as or similar to the one or more input devices described above with reference to method(s) 800, 1000, 1200, 1400, 1600, 1800, 2000, and/or 2200. In some embodiments, the display generation component is the same as or similar to the display generation component described above with reference to method(s) 800, 1000, 1200, 1400, 1600, 1800, 2000, and/or 2200.

In some embodiments, such as in FIG. 23B, the computer system (e.g., 101) displays (2402a), via the display generation component (e.g., 120), a user interface element (e.g., 2316) including a text entry field (e.g., 2318) in an environment (e.g., 2301). In some embodiments, the user interface element shares one or more characteristics with user interface elements displayed proximate to soft keyboards in one or more of method(s) 1200, 1400, 1600, and/or 2200.

In some embodiments, in accordance with a determination that a hardware input device (e.g., 2302) of the one or more input devices has a first location relative to the environment (e.g., 2301), such as in FIG. 23B, the user interface element (e.g., 2316) is displayed at a second location in the environment (e.g., 2301) with a first spatial relationship relative to the hardware input device (e.g., 2302) (2402b). In some embodiments, such as in FIG. 23A, the environment (e.g., 2301) corresponds to a physical environment surrounding the display generation component (e.g., 120) and/or the computer system (e.g., 101) and/or a virtual environment. In some embodiments, the computer system displays a three-dimensional environment, such as a three-dimensional environment as described with reference to methods 800, 1000, 1200, 1400, 1600, 1800, 2000, and/or 2200. In some embodiments, the hardware input device is a hardware (e.g., physical) keyboard (e.g., different from a soft keyboard displayed via the display generation component). In some embodiments, the hardware input device is visible in the environment via the display generation component. In some embodiments, the display generation component displays a representation of the hardware keyboard at a location in the environment that corresponds to a physical location of the hardware input device in the physical environment of the computer system and/or display generation component (e.g., video or virtual passthrough). In some embodiments, the hardware input device is visible through a transparent portion of the display generation component (e.g., true or real passthrough) so that the user is able to see the hardware input device while viewing the environment including objects (e.g., the user interface and text entry field and user interface element described below) displayed via the display generation component. In some embodiments, the user interface element includes the representation of the text and one or more selectable options, described in more detail below, that, when selected, cause the computer system to perform a corresponding operation related to text entry to the text entry field that has the current focus of the hardware input device. In some embodiments, displaying the user interface element in the first spatial relationship relative to the hardware input device includes displaying the user interface element at a respective location relative to the hardware input device irrespective of the location of the hardware input device relative to the environment. For example, the computer system displays the user interface element along the top and/or middle edge of the hardware keyboard.

In some embodiments, in accordance with a determination that the hardware input device (e.g., 2302) has a third location relative to the environment (e.g., 2301), such as in FIG. 23G, different from the first location relative to the environment (e.g., 2301), the user interface element (e.g., 2316) is displayed at a fourth location in the environment (e.g., 2301) with the first spatial relationship relative to the hardware input device (e.g., 2302). In some embodiments, in response to detecting movement of the hardware input device (e.g., 2302), such as in FIG. 23F, the display generation component updates display of the user interface element (e.g., 2316) to maintain the first spatial relationship between the hardware input device (e.g., 2302) and the user interface element (e.g., 2316). In some embodiments, the computer system maintains the first spatial relationship of the user interface element and hardware input device while detecting movement of the hardware input device. In some embodiments, while detecting movement of the hardware input device above a threshold amount (e.g., speed, distance, or duration, such as 0.1, 0.5, 1, 2, or 3 meters/second; 1, 2, 3, 5, or 10 centimeters; or 0.1, 0.5, 1, or 2 seconds), the computer system ceases displaying the user interface element and resumes display of the user interface element in response to detecting movement of the keyboard by less than the threshold amount for a predetermined amount of time (e.g., 0.1, 0.5, 1, 2, or 5 seconds).

In some embodiments, while displaying the user interface element (e.g., 2316) in the environment (e.g., 2301) in the first spatial relationship relative to the hardware input device (e.g., 2302), the computer system (e.g., 101) receives (2402e), via the hardware input device (2302), a text entry input, such as in FIG. 23B. In some embodiments, receiving the text entry input includes detecting interaction with (e.g., activation of, pressing, tapping, or pushing) one or more hardware keys of the hardware keyboard.

In some embodiments, while displaying the user interface element (e.g., 2316) in the environment (e.g., 2301) in the first spatial relationship relative to the hardware input device (e.g., 2302), in response to receiving the text entry input, the computer system (e.g., 101) updates (24020 the text entry field (e.g., 2318) to include text (e.g., 2324b) corresponding to the text entry input, such as in FIG. 23C. In some embodiments, updating the text entry field to include text corresponding to the text entry input includes, in accordance with a determination that a hardware input device of the one or more input devices has a first location relative to the environment, the text entry field is updated at the second location in the environment with the first spatial relationship relative to the hardware input device, and in accordance with a determination that the hardware input device has the third location relative to the environment, different from the first location relative to the environment, the text entry field is updated the fourth location in the environment with the first spatial relationship relative to the hardware input device. In some embodiments, the text includes characters corresponding to one or more keys of the hardware keyboard that were activated and the order in which the one or more keys were activated as part of the text entry input. In some embodiments, if a first sequence of one or more keys were activated, the computer system displays first text in the text entry field and if a second sequence of one or more keys were activated, the computer system displays second text in the text entry field. In some embodiments, the computer system also displays the text in a different text entry field (e.g., different from the text entry field in the user interface element) in the environment that has the current focus of the hardware input device. In some embodiments, the text entry field that has the current focus is displayed in user interface displayed via the display generation component in the environment. In some embodiments, the text entry field that has the current focus is displayed in the environment at a location independent of the hardware input device and/or the user interface element. In some embodiments, if a second text entry field included in the environment has the current focus of the hardware input device, the computer system would update the second text entry field to include the text, optionally in addition to displaying the text in the text entry field included in the user interface element. In some embodiments, if a third text entry field included in the environment has the current focus of the hardware input device, the computer system would update the third text entry field to include the text, optionally in addition to displaying the text in the text entry field included in the user interface element. Displaying the user interface with the first spatial relationship relative to the hardware input device enhances user interactions with the computer system by providing improved visual feedback to the user while the user is providing the text entry input via the hardware input device.

In some embodiments, displaying the user interface element (e.g., 2316) including the text entry field (e.g., 2318) includes displaying a selectable option (e.g., 2320a, 2320e, 2320f, and/or 2320d) included in the user interface element (e.g., 2316) (2404a), such as in FIG. 23B. In some embodiments, such as in FIG. 23B, the computer system (e.g., 101) displays the selectable option (e.g., 2320a, 2320e, 2320f, and/or 2320d) in the same user interface element (e.g., 2316) (e.g., window or other container) as the text entry field (e.g., 2318). In some embodiments, the user interface element includes two or more selectable options corresponding to two or more of the operations described in more detail below.

In some embodiments, such as in FIG. 23D, the computer system (e.g., 101) receives (2404b), via the one or more input devices (e.g., 314), an input corresponding to selection of the selectable option (e.g., 2320h). In some embodiments, the input is an air gesture input, such as an indirect input or a direct input described above and as described in more details below. In some embodiments, the input is detected via the hardware input device, as described in more detail below.

In some embodiments, in response to receiving the input corresponding to selection of the selectable option (e.g., 2320h in FIG. 23D), the computer system (e.g., 101) performs (2404c) an operation in accordance with the selectable option, such as in FIG. 23E. In some embodiments, the operation is an operation related to adding and/or editing the text in the text entry field. In some embodiments, the operating is one of the operations described in more detail below. Displaying the selectable option in the user interface element including the text entry field enhances user interactions with the computer system by displaying the selectable option at a location associated with the hardware input device, which makes it easier for the user to locate the selectable option, thereby enabling the user to use the computer system quickly and efficiently.

In some embodiments, such as in FIG. 23D, the selectable option (e.g., 2320h) includes an indication of first text (2406a). In some embodiments, the first text is text suggested by the computer system for entry to the text entry field. In some embodiments, the computer system suggests the first text based on text already entered into the text entry field, one or more natural language models, one or more dictionaries, the context of the text entry field and/or one or more additional criteria.

In some embodiments, performing the operation in accordance with the selectable option (e.g., 2320h in FIG. 23D) includes updating the text entry field (e.g., 2318) to include the first text, such as in FIG. 23E. In some embodiments, such as in FIG. 23E, updating the text entry field (e.g., 2318) to include the first text includes adding the first text to existing text in the text entry field. In some embodiments, updating the text entry field to include the first text includes replacing the existing text in the text entry field with the first text. In some embodiments, after updating the text entry field to include the first text, the computer system updates the selectable option to include an indication of second text suggested by the computer system and, in response to detecting selection of the indication of second text, the computer system updates the text entry system to include the second text in a manner similar to the above-described manner of updating the text entry field to include the first text. Updating the text entry field to include the first text in response to detecting selection of the selectable option enhances user interactions with the computer system by reducing the number of inputs needed to enter the first text in the text entry field.

In some embodiments, performing the operation in accordance with the selectable option (e.g., 2320d) includes configuring the computer system (e.g., 101) to accept dictation input directed to the text entry field (e.g., 2318) (2408a), such as in FIG. 23B. In some embodiments, while the computer system enters text corresponding to one or more speech inputs into the text entry field in response to receiving text entry inputs including speech inputs while the computer system is configured to accept dictation input. In some embodiments, the computer system performs dictation according to one or more of method(s) 1000 and/or 2000 described above.

In some embodiments, the computer system (e.g., 101) receives (2408b), via the one or more input devices, a speech input according to one or more steps of method(s) 1000 and/or 2000. In some embodiments, the speech input is part of a text entry input that satisfies one or more additional criteria described above with reference to method(s) 1000 and/or 2000.

In some embodiments, in response to receiving the speech input (2408c), in accordance with a determination that the computer system is configured to accept the dictation input directed to the text entry field (e.g., 2318 in FIG. 23B) (e.g., in response to detecting selection of the selectable option for configuring the computer system to accept dictation input), the computer system (e.g., 101) updates (2408d) the text entry field to include a text representation of the speech input. In some embodiments, the computer system updates the text in the text entry field to further include the text representation of the speech input. In some embodiments, the computer system replaces the text in the text entry field with the text representation of the speech input.

In some embodiments, in response to receiving the speech input (2408c), in accordance with a determination that the computer system (e.g., 101) is not configured to accept the dictation input directed to text entry field (e.g., 2318 in FIG. 23B) (e.g., without having detected selection of the selectable option for configuring the computer system to accept the diction input), the computer system (e.g., 101) forgoes (2408e) updating the text entry field (e.g., 2318) to include the text representation of the speech input. In some embodiments, in response to receiving the speech input without first receiving selection of the selectable option or another sequence of inputs corresponding to a request to initiate dictation according to one or more steps of method(s) 1000 and/or 2000, the computer system forgoes entering the text representation of the speech input into the text entry field in response to the speech input. Accepting dictation input to input text to the text entry field enhances user interactions with the computer system by enabling the user to enter text quickly and efficiently with fewer inputs.

In some embodiments, performing the operation in accordance with the selectable option (e.g., 2320a in FIG. 23B) includes displaying, via the display generation component, a soft keyboard in the environment (e.g., 2301) (2410a). In some embodiments, the computer system displays the soft keyboard and/or facilitates entry of text using the soft keyboard in accordance with one or more steps of method(s) 1200, 1400, 1600, and/or 2200. In some embodiments, the computer system maintains display of the user interface element at the location in the first spatial arrangement with the hardware input device while displaying the soft keyboard. In some embodiments, the computer system ceases display of the user interface element at the location in the first spatial arrangement with the hardware input device while displaying the soft keyboard. In some embodiments, when the computer system initiates display of the soft keyboard, the current focus of the soft keyboard is the same text entry field that has the current focus of the hardware input device. Displaying the soft keyboard in response to detecting selection of the selectable option enhances user interactions with the computer system by providing an efficient way of switching from using the hardware input device to using the soft keyboard to enter text to the text entry field.

In some embodiments, such as in FIG. 23D, receiving the input corresponding to selection of the selectable option (e.g., 2320h) includes detecting, via the one or more input devices, a predefined portion (e.g., 2303b) of the user perform a predefined gesture while the predefined portion of the user is within a threshold distance (e.g., 0.1, 0.2, 0.5, 1, 2, 3, or 5 centimeters) of a location corresponding to the selectable option (e.g., 2320h) (2412a). In some embodiments, the input corresponding to selection of the selectable option is a direct air gesture input described in more detail above. In some embodiments, the direct air gesture input includes an air tap gesture and/or an air pinch gesture performed with the hand of the user. In some embodiments, the computer system performs the operation associated with the selectable option in response to receiving the direct air gesture input irrespective of whether or not the attention (e.g., including gaze) of the user is directed to the selectable option while the direct air gesture input is received. In some embodiments, the computer system performs the operation associated with the selectable option in response to receiving the direct air gesture input if the attention (e.g., including gaze) of the user is directed to the selectable option while the direct air gesture input is detected and forgoes performing the operation associated with the selectable option in response to receiving the direct air gesture input if the attention (e.g., including gaze) of the user is not directed to the selectable option while the direct air gesture input is received. Performing the operation associated with the selectable option in response to the direct air gesture input enhances user interactions with the computer system by providing an efficient way of interacting with the selectable option.

In some embodiments, such as in FIG. 23D, receiving the input corresponding to selection of the selectable option (2320h) includes detecting, via the one or more input devices, a predefined portion (e.g., 2303b) of the user perform a predefined gesture while the predefined portion (e.g., 2303b) of the user is further than a threshold distance of a location corresponding to the selectable option (e.g., 2320h) while attention of the user of the computer system is directed to the selectable option (e.g., 2320h). In some embodiments, the threshold distance is the same as the threshold distance described above. In some embodiments, the input corresponding to selection of the selectable option is an indirect air gesture input described in more detail above. In some embodiments, the indirect air gesture input includes an air tap gesture and/or an air pinch gesture performed with the hand of the user while the attention (e.g., including gaze) of the user is directed to the selectable option. In some embodiments, if the attention of the user is not directed to the selectable option while the air tap gesture and/or air pinch gesture is detected, the computer system forgoes performing the operation associated with the selectable option. Performing the operation associated with the selectable option in response to the indirect air gesture input enhances user interactions with the computer system by providing an efficient way of interacting with the selectable option.

In some embodiments, the computer system (e.g., 101) receives (2416a), via the one or more input devices (e.g., 314), a selection input that includes a predefined portion (e.g., 2303b) of the user perform a predefined gesture while the predefined portion (e.g., 2303b) of the user is further than a threshold distance of a location corresponding to the selectable option (e.g., 2320h) while attention of the user of the computer system (e.g., 101) is directed to the selectable option (e.g., 2320h), such as in FIG. 23D. In some embodiments, the threshold distance is the same as the threshold distance described above. In some embodiments, the input corresponding to selection of the selectable option is an indirect air gesture input described in more detail above. In some embodiments, the indirect air gesture input includes an air tap gesture and/or an air pinch gesture performed with the hand of the user while the attention (e.g., including gaze) of the user is directed to the selectable option.

In some embodiments, in response to receiving the selection input (e.g., air gesture, touch input, gaze input or other user input) (2416b), in accordance with a determination that the selection input was received while the hardware input device (e.g., 2302) does not detect an input, such as in FIG. 23E, the computer system (e.g., 101) performs (2416c) the operation in accordance with the selectable option (e.g., 2320i), such as in FIG. 23F. In some embodiments, the hardware input device does not detect an input if the hardware input device does not detect activation of any of the keys, buttons, and/or switches of the hardware input device. In some embodiments, the hardware input device does not detect an input if the hardware input device does not sense the user's body in contact with or hovering proximate to (e.g., within 0.5, 1, 2, 3, 5, or 10 centimeters) the hardware input device.

In some embodiments, such as in FIG. 23D, in response to receiving the selection input (e.g., air gesture, touch input, gaze input or other user input) (2416b), in accordance with a determination that the selection input was received while the hardware input device (e.g., 2302) detects the input, the computer system (e.g., 101) forgoes (2416d) performing the operation in accordance with the selectable option (e.g., 2320h). In some embodiments, the computer system does not perform the operation corresponding to the selectable option in response to receiving an indirect air gesture input selecting the selectable option while the hardware input device detects an input. In some embodiments, the computer system performs the operation corresponding to the selectable option in response to detecting a direct air gesture input selecting the selectable option regardless of whether or not the hardware input device detects an input while the direct air gesture input is received. Forgoing performing the operation in accordance with the selectable option in response to receiving the selection input in accordance with the determination that the selection input was received while the hardware input device detects the input enhances user interactions with the computer system by forgoing performing the operation in situations where it is likely the indirect input was detected by mistake, which avoids errors that will have to be corrected with additional time and inputs.

In some embodiments, receiving the input corresponding to selection of the selectable option (e.g., 2320a, 2320b, 2320c, and/or 2320d in FIG. 23B) includes detecting activation of an element (e.g., a button, key, or switch) of the hardware input device (e.g., 2302) while attention (e.g., including gaze) of the user directed to the selectable option (e.g., 2418a). In some embodiments, the computer system enters suggested text in response to detecting the attention (e.g., including gaze) of the user directed to the indication of text (e.g., the first indication of text described in more detail above) while detecting activation of the element of the hardware input device (e.g., an arrow key of a hardware keyboard). In some embodiments, in response to detecting activation of a second element of the hardware input device different from the element of the hardware input device while the attention (e.g., including gaze) of the user is directed to the selectable option, the computer system forgoes performing the operation in accordance with the selectable option. Performing the operation in accordance with the selectable option in response to detecting activation of the element of the hardware input device while attention of the user is directed to the selectable option enhances user interactions with the computer system by reducing the time it takes to select the selectable option while providing inputs (e.g., to enter text to the text entry field) with the hardware input device.

In some embodiments, such as in FIG. 23B, a surface of the hardware input device (e.g., 2302) has a first orientation relative to a viewpoint of a user of the computer system (e.g., 101) in the environment (e.g., 2301), and displaying the user interface element (e.g., 2316) in the environment (e.g., 2301) includes displaying the user interface element (e.g., 2316) with an orientation angle relative to the viewpoint, the second orientation different from the first orientation (e.g., 2420a). In some embodiments, the surface is a surface of a hardware keyboard (e.g., a surface along the tops of the keys or a surface of a backplane of the keys). In some embodiments, the surface is the surface of a trackpad. In some embodiments, the second angle is an angle that is normal to a line to the viewpoint and/or face of the user of the computer system so that the user interface element is turned to face the viewpoint and/or face of the user. Displaying the user interface element with the second angle enhances user interactions with the computer system by providing enhanced visual feedback to the user that improves legibility of the user interface element.

In some embodiments, such as in FIG. 23B, in accordance with a determination, via the one or more input devices (e.g., 314), that the hardware input device (e.g., 2302) has been detected in a predefined region of the environment (e.g., 2301) and detecting the hardware input device (e.g., 2302) in communication with the computer system, the computer system (e.g., 101) displays (2422a) the user interface element (e.g., 2316). In some embodiments, the predefined region of the environment is a region in the physical environment of the computer system and/or display generation component that is within range of a camera or other optical sensor in communication with the computer system. In some embodiments, the predefined region of the environment is a region of the environment that is within a field of view of the display generation component that is displayed via the display generation component when the display generation component displays the environment from the viewpoint of the user.

In some embodiments, such as in FIG. 23A, in accordance with a failure to detect, via the one or more input devices (e.g., 314), the hardware input device in the predefined region of the environment and in communication with the computer system (e.g., 101), the computer system (e.g., 101) forgoes (2422b) display of the user interface element. In some embodiments, even if the hardware input device is in communication with the computer system, if the computer system does not detect the hardware input device in the predefined region of the environment, the computer system forgoes display of the user interface element. In some embodiments, even if the hardware input device is in the predefined region of the environment, if the hardware input device is not in communication with the computer system, the computer system forgoes display of the user interface element. In some embodiments, in accordance with not detecting the hardware input device in the predefined region of the environment and not detecting the hardware input device in communication with the computer system, the computer system forgoes display of the user interface element. In some embodiments, the computer system forgoes display of the user interface element unless and until the computer system detects the hardware input device in the predefined region of the environment and detects the hardware input device in communication with the computer system. In some embodiments, the computer system displays a status indicator of the computer system (described in more detail below) irrespective of whether or not the hardware input device is in the predefined region and/or irrespective of whether or not the hardware input device is in communication with the computer system. Selectively displaying the user interface element in accordance with detecting the hardware input device in the predefined region of the environment and detecting the hardware input device in communication with the computer system enhances user interactions with the computer system by preserving display area for other elements in situations when the hardware input device is unlikely to be used to provide inputs to the computer system.

In some embodiments, such as in FIG. 23B the computer system (e.g., 101) displays (2424a) a visual indication (e.g., 2322) of a status (e.g., battery life and/or status of connectivity to the computer system) of the hardware input device (e.g., 2302).

In some embodiments, in accordance with the determination that the hardware input device (e.g., 2302) has the first location relative to the environment (e.g., 2301), the visual indication (e.g., 2322) is displayed at a fifth location in the environment with a second spatial relationship relative to the hardware input device (e.g., 2302) (2424b), such as in FIG. 23B. In some embodiments, such as in FIG. 23B, the location of the indication (e.g., 2322) of the status is proximate to the location of the user interface element (e.g., 2316) and/or the hardware input device (e.g., 2302) in the environment.

In some embodiments, such as in FIG. 23G, in accordance with the determination that the hardware input device (e.g., 2302) has the third location relative to the environment (e.g., 2301), the visual indication (e.g., 2322) is displayed at a sixth location different from the fifth location in the environment (e.g., 2301) with the second spatial relationship relative to the hardware input device (e.g., 2302) (2424c). In some embodiments, the computer system maintains the second spatial relationship of the visual indication of the status of the hardware input device to the hardware input device irrespective of the location of the hardware input device in the environment. Maintaining the second spatial relationship of the visual indication and the hardware input device enhances user interactions with the computer system by providing improved visual feedback to the user.

In some embodiments, such as in FIG. 23G, while displaying, via the display generation component (e.g., 101), the user interface element (e.g., and the text entry field) at a fifth location in the environment (e.g., 2301) from a first viewpoint of a user of the computer system while the hardware input device (e.g., 2302) has a sixth location relative to the environment (e.g., 2301), the fifth location having the first spatial relationship relative to the hardware input device (e.g., 2302), the computer system (e.g., 101) detects (2426a) movement of a viewpoint of the user from the first viewpoint to a second viewpoint different from the first viewpoint. In some embodiments, such as in FIG. 23G, detecting movement of the viewpoint of the user includes detecting movement of one or more of the computer system (e.g., 101), the display generation component (e.g., 120), and/or the user's body. In some embodiments, such as in FIG. 23H, the computer system (e.g., 101) updates the display of the environment (e.g., 2301) in accordance with updating the viewpoint from the first viewpoint to the second viewpoint, such as by changing the perspective from which the environment (e.g., 2301) is displayed, ceasing display of one or more portions of one or more elements in the environment (e.g., 2301) and/or initiating display of one or more portions of one or more elements in the environment (e.g., 2301).

In some embodiments, in response to detecting the movement of the viewpoint of the user from the first viewpoint to the second viewpoint, in accordance with a determination that the hardware input device (e.g., 2302) has the sixth location relative to the environment (e.g., 2301), such as in FIG. 23H, the computer system (e.g., 101) maintains (2426a) display, via the display generation component (e.g., 120), of the user interface element (e.g., 2316) (e.g., and the text entry field) at the fifth location in the environment (e.g., 2301). In some embodiments, such as in FIG. 23H, the computer system (e.g., 101) displays the user interface element (e.g., 2316) using a different portion of the display generation component (e.g., 120) while displaying the environment from the second viewpoint than was the case while displaying the environment (e.g., 2301) from the first viewpoint because movement of the viewpoint causes a change in the spatial relationship between the user interface element and the viewpoint of the user. In some embodiments, in response to detecting movement of the hardware input device, the computer system updates the location of the user interface element to maintain the second spatial relationship between the user interface element and the hardware input device. Maintaining display of the user interface element in response to detecting the movement of the viewpoint of the user enhances user interactions with the computer system by reducing the time and inputs needed to locate the user interface element.

In some embodiments, such as in FIG. 23C, while displaying the user interface element (e.g., 2316) including the text entry field (e.g., 2318), the computer system (e.g., 101) displays (2428a), via the display generation component (e.g., 120), a user interface (e.g., 2306) that includes a second text entry field (e.g., 2310) that has a current focus of the hardware input device (e.g., 2302). In some embodiments, such as in FIG. 23C, the second text entry field (e.g., 2310) is included in a user interface (e.g., 2306), such as a system user interface and/or a user interface of an application of the computer system. For example, the text entry field is a message field of a messaging application, an address field of an internet browsing application, a document of a word processing application, or a search field of an application.

In some embodiments, such as in FIG. 23C, in response to receiving the text entry input, the computer system (e.g., 101) updates (2428b) the second text entry field (e.g., 2310) to include the text (e.g., 2324a) corresponding to the text entry input. In some embodiments, such as in FIG. 23C, the text (e.g., 2324b) in the text entry field (e.g., 2318) mirrors the text (e.g., 2324a) in the second text entry field (e.g., 2310). In some embodiments, the second text entry field has the current focus of the hardware input device. In some embodiments, the computer system displays a representation of text included in the text entry field with the current focus in the text entry field included in the user interface element in a manner similar to one or more steps of method(s) 1200, 1400, 1600, and/or 2000. Updating the second text entry field to include the text corresponding to the text entry input when updating the text entry field to include the text corresponding to the text entry input enhances user interactions with the computer system by providing improved visual feedback to the user.

In some embodiments, while displaying, via the display generation component (e.g., 101), the user interface element (e.g., 2316) at a fifth location in the environment (e.g., 2301), and the user interface that includes the second text entry field (e.g., 2326) (2430a), the computer system (e.g., 101) receives (2430b), via the one or more input devices (e.g., 314), an input corresponding to a request to update a location of the user interface (e.g., 2312) that includes the second text entry field (e.g., 2326), such as in FIG. 23H. In some embodiments, the input includes selection of a repositioning option associated with the user interface. In some embodiments, the input includes a predefined air gesture performed by a predefined portion (e.g., hand(s)) of the user. In some embodiments, the input includes a movement component (e.g., movement of the predefined portion of the user or a directional input provided via a hardware input device), and the computer system updates the location of the user interface in accordance with an amount (e.g., of speed, distance, and/or duration) and direction(s) of the movement component.

In some embodiments, while displaying, via the display generation component (e.g., 101), the user interface element (e.g., 2316) at a fifth location in the environment (e.g., 2301), and the user interface that includes the second text entry field (e.g., 2326) (2430a), in response to receiving the input corresponding to the request to update the location of the user interface (e.g., 2312) that includes the second text entry field (e.g., 2326), the computer system (e.g., 101) updates (2430c) a location of the user interface (e.g., 2312) that includes the second text entry field (e.g., 2326) while maintaining display of the user interface element (e.g., 2316) at the fifth location in the environment, such as in FIG. 23I. In some embodiments, in response to detecting movement of the user interface including the text entry field that has the current focus of the hardware input device, the computer system forgoes updating the position of the user interface element including the text entry field if the location of the hardware input device does not change to maintain the first spatial relationship of the user interface element to the hardware input device. Maintaining display of the user interface element in response to detecting the movement of the user interface that includes the second text entry field enhances user interactions with the computer system by reducing the time and inputs needed to locate the user interface element.

In some embodiments, while displaying, via the display generation component (e.g., 120), the user interface element (e.g., 2316) at a fifth location in the environment (e.g., 2301) and while the second text entry field (e.g., 2310) has the current focus of the hardware input device (e.g., 2316), such as in FIG. 23C, the computer system (e.g., 101) receives (2432a), via the one or more input devices (e.g., 314), an input corresponding to a request to update the current focus of the hardware input device (e.g., 2302) from the second text entry field (e.g., 2310) to a third text entry field (e.g., 2326). In some embodiments, such as in FIG. 23C, the input is or includes selection of the third text entry field (e.g., 2326). In some embodiments, the input is or includes an air gesture input (e.g., a direct or indirect air gesture input). In some embodiments, the input is detected via a hardware input device.

In some embodiments, in response to receiving the input corresponding to the request to update the current focus of the hardware input device (e.g., 2302) from the second text entry field (e.g., 2310) to the third text entry field (e.g., 2326), the computer system (e.g., 101) updates (2432b) the current focus of the hardware input device (e.g., 2302) from the second text entry field (e.g., 2310) to the third text entry field (e.g., 2326) while maintaining display of the user interface element (e.g., 2316) at the fifth location. In some embodiments, in response to detecting a text entry input via the hardware input device, in accordance with a determination that the second text entry field has the current focus of the hardware input device, the computer system displays the text in the second text entry field and, in accordance with a determination that the third text entry field has the current focus of the hardware input device, the computer system displays the text in the third text entry field. In some embodiments, the computer system does not update the position of the user interface element in response to changing the input focus of the hardware input device unless the position of the hardware input device changes. Maintaining display of the user interface element in response to detecting the change in the current focus of the hardware input device from the second text entry field to the third text entry field enhances user interactions with the computer system by reducing the time and inputs needed to locate the user interface element.

In some embodiments, aspects/operations of methods 800, 1000, 1200, 1400, 1600, 1200, 2000, and/or 2200 may be interchanged, substituted, and/or added between these methods. For example, the computer system enters text in accordance with methods 800, 1000, 1200, 1400, 1600, 2000, 2200, and/or 2400. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, e-mail addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

1. A method, comprising:
at a computer system in communication with a display generation component and one or more input devices:
displaying, via the display generation component, a user interface including scrollable content;
detecting, via the one or more input devices, a gaze of the user directed to the scrollable content; and
in response to detecting the gaze of the user directed to the scrollable content:
in accordance with a determination that the gaze of the user is directed to a first region of the scrollable content, maintaining display of the scrollable content without scrolling the scrollable content;
in accordance with a determination that the gaze of the user is directed to a second region, different from the first region, of the scrollable content and a respective portion of the user meets respective criteria, scrolling the scrollable content in accordance with the gaze of the user; and
in accordance with a determination that the gaze of the user is directed to the second region and the respective portion of the user does not meet the respective criteria, maintaining display of the scrollable content without scrolling the scrollable content.

2. The method of claim 1, wherein the respective criteria include a criterion that is satisfied when the respective portion of the user is not detected in a predefined pose.

3. The method of claim 1, further comprising:
while displaying the user interface including the scrollable content:
detecting, via the one or more input devices, an input directed to a respective user interface element, wherein detecting the input includes detecting gaze of the user directed to the respective user interface element and detecting the user perform a respective gesture with the respective portion of the user; and
in response to detecting the input directed to the respective user interface element, performing an operation associated with the respective user interface element.

4. The method of claim 1, wherein the second region of the scrollable content includes an edge of the scrollable content.

5. The method of claim 1, wherein the computer system scrolls the scrollable content in a first direction in accordance with the determination that the gaze of the user is directed to the second region, and the method further comprises:
while displaying, via the display generation component, the user interface including the scrollable content:
in response to detecting the gaze of the user directed to the scrollable content:
in accordance with a determination that the gaze of the user is directed to a third region of the scrollable content, the third region different from the second region and different from the first region, and the respective portion of the user meets the respective criteria, scrolling the scrollable content in a second direction different from the first direction in accordance with the gaze of the user, wherein the second region and the third region have different sizes.

6. The method of claim 5, wherein:
the second region of the scrollable content is located at a bottom of the scrollable content and has a first size, and
the third region of the scrollable content is located at a top of the scrollable content and has a second size smaller than the first size.

7. The method of claim 1, wherein scrolling the scrollable content in accordance with the gaze of the user includes:
in accordance with a determination that the gaze of the user is directed to a location that is a first distance from a respective position of the scrollable content, scrolling the scrollable content with a first speed in accordance with the gaze of the user, and
in accordance with a determination that the gaze of the user is directed to a location that is a second distance from the respective position of the scrollable content different from the first distance, scrolling the scrollable content with a second speed different from the first speed in accordance with the gaze of the user.

8. The method of claim 1, further comprising:
while the gaze of the user is directed to the second region of the scrollable content and the respective portion of the user meets the respective criteria, and while scrolling the scrollable content in accordance with the gaze of the user, detecting, via the one or more input devices, the gaze of the user directed away from the second region of the scrollable content; and
in response to detecting the gaze of the user directed away from the second region of the scrollable content, decreasing a speed at which the scrollable content is scrolling until the scrolling of the scrollable content is ceased.

9. The method of claim 1, wherein scrolling the scrollable content in accordance with the gaze of the user in accordance with the determination that the gaze of the user is directed to the second region and the respective portion of the user meets the respective criteria in response to detecting the gaze of the user directed to the scrollable content includes:
gradually increasing a speed of scrolling the scrollable content while the gaze of the user is directed to the second region and the respective portion of the user meets the respective criteria.

10. The method of claim 1, further comprising:
while displaying the user interface including the scrollable content:
detecting, via the one or more input devices, the respective portion of the user perform a respective gesture that includes movement of a hand of the user while the hand of the user is in a pinch hand shape, wherein the respective portion of the user does not meet the respective criteria while performing the respective gesture; and
in response to detecting the respective portion of the user perform the respective gesture and in accordance with a determination that one or more criteria are satisfied, scrolling the scrollable content in accordance with the movement of the hand of the user.

11. The method of claim 10, wherein the movement of the respective portion of the user has a respective magnitude, and:
in accordance with a determination that the movement of the respective portion of the user is in a first direction, the computer system scrolls the scrollable content by a first amount in a second direction in response to detecting the respective portion of the user perform the respective gesture, and
in accordance with a determination that the movement of the respective portion of the user is in a third direction different from the first direction, the computer system scrolls the scrollable content by a second amount different from the first amount in a fourth direction in response to detecting the respective portion of the user perform the respective gesture, wherein the fourth direction is different from the second direction.

12. The method of claim 10, wherein the movement of the hand of the user includes movement of the hand from a first location to a second location, wherein the hand of the user maintains the pinch hand shape while moving from the first location to the second location, and scrolling the scrollable content in response to detecting the respective portion of the user perform the respective gesture includes:
in accordance with a determination that a distance between the first location and the second location is a first distance, scrolling the scrollable content at a first speed; and
in accordance with a determination that a distance between the first location and the second location is a second distance greater than the first distance, scrolling the scrollable content at a second speed greater than the first speed.

13. The method of claim 10, wherein the one or more criteria include a criterion that is satisfied when the hand of the user moves at least a threshold amount while maintaining the pinch hand shape, the method further comprising:
in response to detecting the respective portion of the user perform the respective gesture, in accordance with a determination that the movement of the hand of the user does not satisfy the one or more criteria, maintaining display of the scrollable content without scrolling the scrollable content.

14. The method of claim 10, wherein the one or more criteria are not satisfied when a speed of the movement of the hand of the user is greater than a threshold speed and a direction of the movement of the hand of the user is downward, the method further comprising:
in response to detecting the respective portion of the user perform the respective gesture, in accordance with a determination that the one or more criteria are not satisfied, maintaining display of the scrollable content without scrolling the scrollable content.

15. The method of claim 1, wherein in response to detecting the gaze of the user directed to the scrollable content, and in accordance with the determination that the gaze of the user is directed to the second region of the scrollable content and the respective portion of the user meets the respective criteria, the computer system scrolls the scrollable content in a first direction in accordance with the gaze of the user, and the method further comprises:
while displaying, via the display generation component, the user interface including the scrollable content:
in response to detecting the gaze of the user directed to the scrollable content:
in accordance with a determination that the gaze of the user is directed to a third region of the scrollable content, the third region different from the second region, and the respective portion of the user meets the respective criteria, scrolling the scrollable content in a second direction opposite the first direction in accordance with the gaze of the user.

16. The method of claim 15, wherein:
in response to detecting the gaze of the user directed to the scrollable content and in accordance with the determination that the gaze of the user is directed to the second region of the scrollable content and the respective portion of the user meets the respective criteria, scrolling the scrollable content in the first direction in accordance with the gaze of the user includes scrolling the scrollable content with first acceleration, and
in response to detecting the gaze of the user directed to the scrollable content and in accordance with the determination that the gaze of the user is directed to the third region of the scrollable content and the respective portion of the user meets the respective criteria, scrolling the scrollable content in the second direction in accordance with the gaze of the user includes scrolling the scrollable content with second acceleration different from the first acceleration.

17. The method of claim 1, wherein the scrollable content includes text content and other content, and the method further comprises:
while displaying the text content of the scrollable content without displaying the other content of the scrollable content:
detecting, via the one or more input devices, movement of the gaze of the user; and
in response to detecting the movement of the gaze of the user:
in accordance with a determination that the movement of the gaze of the user satisfies one or more criteria, including a criterion that is satisfied based on movement of the gaze of the user relative to a line of text in the text content, scrolling the text content; and
in accordance with a determination that the movement of the gaze of the user does not satisfy the one or more criteria, maintaining display of the text content without scrolling the text content.

18. The method of claim 17, wherein scrolling the text content in response to detecting the movement of the gaze of the user that satisfies the one or more criteria is independent of whether the respective portion of the user is detected in a predefined pose.

19. The method of claim 17, further comprising:
while displaying the text content of the scrollable content without the other content of the scrollable content:
detecting, via the one or more input devices, the gaze of the user directed to the text content; and
in response to detecting the gaze of the user directed to the text content:
in accordance with a determination that the gaze of the user is directed to a first region of the text content and the movement of the gaze of the user does not satisfy the one or more criteria, maintaining display of the text content without scrolling the text content; and
in accordance with a determination that the gaze of the user is directed to a second region of the text content different from the first region of the text content, and the respective portion of the user meets the respective criteria, and the movement of the gaze of the user does not satisfy the one or more criteria, scrolling the text content in accordance with the gaze of the user; and
in accordance with a determination that the gaze of the user is directed to the first region of the text content and the movement of the gaze of the user satisfies the one or more criteria, scrolling the text content.

20. The method of claim 1, further comprising:
while displaying the scrollable content, in response to detecting the gaze of the user directed to the scrollable content:
in accordance with a determination that the gaze of the user is directed to a word included in the first region of the scrollable content for at least a threshold time, displaying, via the display generation component, a definition of the word included in the scrollable content.

21-23. (canceled)

24. A non-transitory computer-readable storage medium storing one or more programs configured to be executed by one or more processors of a computer system that is in communication with a display generation component and one or more input devices, the one or more programs including instructions for:
displaying, via the display generation component, a user interface including scrollable content;
detecting, via the one or more input devices, a gaze of the user directed to the scrollable content; and
in response to detecting the gaze of the user directed to the scrollable content:
in accordance with a determination that the gaze of the user is directed to a first region of the scrollable content, maintaining display of the scrollable content without scrolling the scrollable content;
in accordance with a determination that the gaze of the user is directed to a second region, different from the first region, of the scrollable content and a respective portion of the user meets respective criteria, scrolling the scrollable content in accordance with the gaze of the user; and
in accordance with a determination that the gaze of the user is directed to the second region and the respective portion of the user does not meet the respective criteria, maintaining display of the scrollable content without scrolling the scrollable content.

25. A computer system that is in communication with a display generation component and one or more input devices, the computer system comprising:
one or more processors; and
memory storing one or more programs configured to be executed by the one or more processors, the one or more programs including instructions for:
displaying, via the display generation component, a user interface including scrollable content;
detecting, via the one or more input devices, a gaze of the user directed to the scrollable content; and
in response to detecting the gaze of the user directed to the scrollable content:
in accordance with a determination that the gaze of the user is directed to a first region of the scrollable content, maintaining display of the scrollable content without scrolling the scrollable content;
in accordance with a determination that the gaze of the user is directed to a second region, different from the first region, of the scrollable content and a respective portion of the user meets respective criteria, scrolling the scrollable content in accordance with the gaze of the user; and
in accordance with a determination that the gaze of the user is directed to the second region and the respective portion of the user does not meet the respective criteria, maintaining display of the scrollable content without scrolling the scrollable content.

26-234. (canceled)
